(19) United States
(12) Patent Application Publication
(10) Pub. No.: US 2023/0295197 A1
(43) Pub. Date: Sep. 21, 2023

(54) STAT5 and STAT6 Degraders and Uses Thereof

(71) Applicant: REGENTS OF THE UNIVERSITY OF MICHICAN, Ann Arbor, MI (US)

(72) Inventors: Shaomeng Wang, Superior Township, MI (US); Atsunori Kaneshige, Ann Arbor, MI (US); Longchuan Bai, Ann Arbor, MI (US); Mi Wang, Ann Arbor, MI (US); Jeanne Stuckey, Fenton, MI (US); Donna McEachern, Grass Lake, MI (US); Mingliang Wang, Ann Arbor, MI (US); Renqi Xu, Ann Arbor, MI (US)

(21) Appl. No.: 18/185,209

(22) Filed: Mar. 16, 2023

Related U.S. Application Data
(60) Provisional application No. 63/320,849, filed on Mar. 17, 2022.

(51) Int. Cl. C07F 9/30

(52) U.S. Cl. CPC C07F 9/30

(57) ABSTRACT

Described herein are compounds of Formula I and pharmaceutically acceptable salts, solvates, or stereoisomers thereof, as well as their uses as STAT5 and/or STAT6 degraders.

This application claims the benefit of and priority to U.S. Provisional Application No. 63/320,849, filed Mar. 17, 2022, the contents of which are incorporated herein by reference in their entireties.

### BACKGROUND

The signal transducer and activator of transcription (STAT) proteins play important roles in biological processes. For example, the abnormal activation of STAT signaling pathways is implicated in cancer, autoimmune diseases, rheumatoid arthritis, asthma, diabetes, and other human diseases. See, e.g., Miklossy et al., Nat Rev Drug Discov 12:611-629 (2013).

The STAT protein family is composed of seven members: STAT1, STAT2, STAT3, STAT4, STAT5A, STAT5B, and STAT6. Structurally, they share five domains: an amino-terminal domain, a coiled-coil domain, a DNA-binding domain, an SH2 domain, and a carboxy-terminal transactivation domain. The transactivation domain contains one or two amino acid residues that are crucial for the activity of the STAT protein. In particular, phosphorylation of a particular tyrosine residue promotes dimerization, whereas phosphorylation of a particular serine residue enhances transcriptional activation.

STAT proteins promote fundamental cellular processes, including cell growth and differentiation, development, apoptosis, immune responses, and inflammation. In particular, STAT5/STAT6 function may be abnormal in the context of cancer, and this abnormality represents an underlying mechanism of STAT5/STAT6 for promoting malignant transformation and progression. Constitutively active STAT5/STAT6 is detected in numerous malignancies, including breast, melanoma, prostate, head and neck squamous cell carcinoma (HNSCC), multiple myeloma, pancreatic, ovarian, and brain tumors. Aberrant STAT5/STAT6 signaling promotes tumorigenesis and tumor progression partly through dysregulating the expression of critical genes that control cell growth and survival, angiogenesis, migration, invasion, or metastasis. These genes include those that encode p21^{WAF1/CIP2}, cyclin D1, MYC, BCL-X, BCL-2, vascular endothelial growth factor (VEGF), matrix metalloproteinase 1 (MMP1), MMP7 and MMP9, and survivin. STAT5/STAT6 may also play a role in the suppression of tumor immune surveillance. Consequently, the genetic and pharmacological modulation of persistently active STAT5/STAT6 was shown to control the tumor phenotype and to lead to tumor regression in vivo.

There exists a need in the art for STAT5/STAT6 inhibitors and STAT5/STAT6 degraders having physical and pharmacological properties that allow them to be used in therapeutic applications for treating disease.

### SUMMARY

In certain aspects, the present disclosure provides compounds of Formula I:

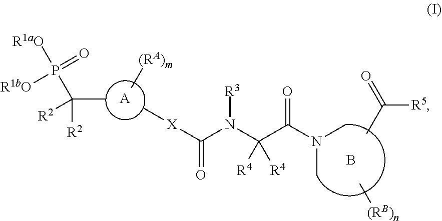

and pharmaceutically acceptable salts, solvates, or stereoisomers thereof, wherein each of the variables in Formula I, is described, embodied, and exemplified herein.

In certain aspects, the present disclosure provides methods of degrading a STAT5 and/or STAT6 protein in a subject or biological sample, comprising administering a compound disclosed herein to the subject or contacting a compound disclosed herein with the biological sample (e.g., in a therapeutically effective amount).

In certain aspects, the present disclosure provides methods of degrading a STAT5 protein in a subject or biological sample, comprising administering a compound disclosed herein to the subject or contacting a compound disclosed herein with the biological sample (e.g., in a therapeutically effective amount).

In certain aspects, the present disclosure provides methods of degrading a STAT6 protein in a subject or biological sample, comprising administering a compound disclosed herein to the subject or contacting a compound disclosed herein with the biological sample (e.g., in a therapeutically effective amount).

In certain aspects, the present disclosure provides uses of a compound disclosed herein in the manufacture of a medicament for degrading a STAT5 and/or STAT6 protein in a subject or biological sample.

In certain aspects, the present disclosure provides uses of a compound disclosed herein in the manufacture of a medicament for degrading a STAT5 protein in a subject or biological sample.

In certain aspects, the present disclosure provides uses of a compound disclosed herein in the manufacture of a medicament for degrading a STAT6 protein in a subject or biological sample.

In certain aspects, the present disclosure provides compounds disclosed herein for use in degrading a STAT5 and/or STAT6 protein in a subject or biological sample.

In certain aspects, the present disclosure provides compounds disclosed herein for use in degrading a STAT5 protein in a subject or biological sample.

In certain aspects, the present disclosure provides compounds disclosed herein for use in degrading a STAT6 protein in a subject or biological sample.

In certain aspects, the present disclosure provides methods of treating or preventing a disease or disorder in a subject, comprising administering a compound disclosed herein to the subject (e.g., in a therapeutically effective amount).

In certain aspects, the present disclosure provides uses of a compound disclosed herein in the manufacture of a medicament for treating or preventing a disease or disorder.

In certain aspects, the present disclosure provides compounds disclosed herein for use in treating or preventing a disease or disorder.

In certain aspects, the present disclosure provides methods of treating a disease or disorder in a patient, comprising administering a compound disclosed herein to the subject (e.g., in a therapeutically effective amount).

In certain aspects, the present disclosure provides uses of a compound disclosed herein in the manufacture of a medicament for treating a disease or disorder.

In certain aspects, the present disclosure provides compounds disclosed herein for use in treating a disease or disorder.

### DETAILED DESCRIPTION

In certain aspect, the present disclosure provides compounds of Formula I:

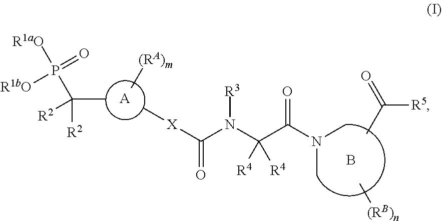

or a pharmaceutically acceptable salt, solvate, or stereoisomer thereof, wherein:
R^{1a} and R^{1b} are independently hydrogen, C₁₋₆ alkyl, or a hydroxyl protecting group;
each R² is independently hydrogen or halogen; or
Ring A is C₆₋₁₀ aryl or 5- to 10-membered heteroaryl;
each R^{A} is independently halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};
m is an integer selected from 0 to 6;
Ring B is 3- to 12-membered heterocyclyl;
each R^{B} is independently

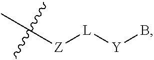

oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{B-1}; or
two vicinal R^{B}, together with atoms to which they are bonded, form C₆ aryl or 5- to 6-membered heteroaryl, wherein the aryl, or heteroaryl is optionally substituted with one or more R^{B-1};
each R^{B-1} is independently

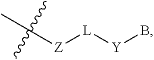

oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};
n is an integer selected from 0 to 6;
X is —CR^{X}═CR^{X}— or absent;
each R^{X} is independently hydrogen, halogen, or C₁₋₆ alkyl;
R³ is hydrogen, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, or 3- to 12-membered heterocyclyl, wherein the alkyl, alkoxy, alkylamino, alkenyl, alkynyl, aryl, heteroaryl, carbocyclyl, or heterocyclyl is optionally substituted with one or more R^{u};
each R⁴ independently is hydrogen, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{4a}; or
R⁴ and R^{B}, together with the intervening atoms, form 3- to 12-membered heterocyclyl optionally substituted with one or more R^{4b}; or
two R⁴, together with the carbon atom to which they are attached, form C₃₋₆ carbocyclyl or 3- to 6-membered heterocyclyl, wherein the carbocyclyl or heterocyclyl is optionally substituted with one or more R^{u};
each R^{4a} is independently halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};
each R^{4b} is independently

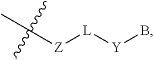

oxo, halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};

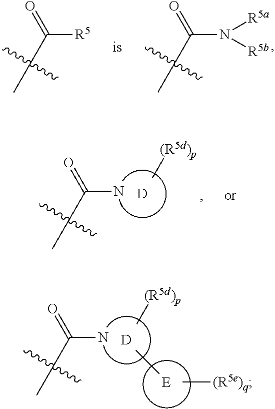

each R^{5a} and R^{5b} are independently

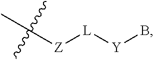

hydrogen, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), or —(C₁₋₆ alkyl)-(3- to 12-membered heterocyclyl), wherein the alkyl, alkoxy, alkylamino, alkenyl, alkynyl, aryl, heteroaryl, carbocyclyl, or heterocyclyl is optionally substituted with one or more R^{5c};
each R^{5c} is independently halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), or —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};
Ring D is 3- to 12-membered heterocyclyl;
Ring E is C₆₋₁₀ aryl, 5- to 10-membered heteroaryl, C₃₋₁₂ carbocyclyl, or 3- to 12-membered heterocyclyl;
each R^{5d} and R^{5e} is independently

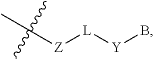

oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}; and
p and q independently are integers selected from 0 to 6;
provided that:
one of R^{B}, R^{B-1}, R^{4b}, R^{5a}, R^{5b}, and R^{5d}, and R^{5e} is

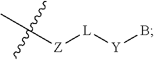

wherein:
Z is —CH₂—, —O—, —N(R^{Z0})—, —OC(═O)—, —C(═O)NR^{Z1}—, —C(═O)—, —CH₂C(═O)NR^{Z2}, —CH₂CH₂C(═O)NR^{Z3}—, —CH₂CH₂(C═O)N(CH₂)₂CH—, —OCH₂C(═O)NR^{Z4}—, or —C(═O)CH₂C(═O)NR^{Z5}—;
each occurrence of R^{Z0}, R^{Z1}, R^{Z2}, R^{Z3}, R^{Z4}, and R^{Z5} is independently hydrogen or C₁₋₆ alkyl;
L is C₁₋₁₈ alkylene or C₁₋₁₂ heteroalkylene, wherein the alkylene or heteroalkylene is optionally substituted with one or more R^{u}; or
L is -A-(CH₂)_{m′}—W—(CH₂)_{n′}— or —(CH₂)_{r′}—W—(CH₂)_{u′}—O—(CH₂)_{v′};
A is absent; or
A is 5- to 10-membered heteroarylene; wherein the heteroarylene is optionally substituted with one or more R^{u};
W is phenylene, 5- to 10-membered heteroarylene, 3- to 12-membered heterocyclylene, or C₃₋₁₂ carbocyclylene; wherein the phenylene, heteroarylene, heterocyclylene, or carbocyclylene is optionally substituted with one or more R^{u};
m′ is an integer from 0 to 7;
n′ is an integer from 0 to 8;
r′ is an integer from 0 to 3;
u′ is an integer from 0 to 3; and
v′ is an integer from 1 to 4;
Y is —C≡C—, —CH═CH—, —CH₂—, —O—, —N(R^{Y1})—, —C(═O)—, —C(═O)N(R^{Y2})—, —N(R^{Y3})C(═O)CH₂O—, or —N(R^{Y3})C(═O)CH₂N(R^{Y4})—; or
Y is absent;
each occurrence of R^{Y1}, R^{Y2}, R^{Y3}, and R^{Y4} is independently hydrogen or C₁₋₆ alkyl; and
B is

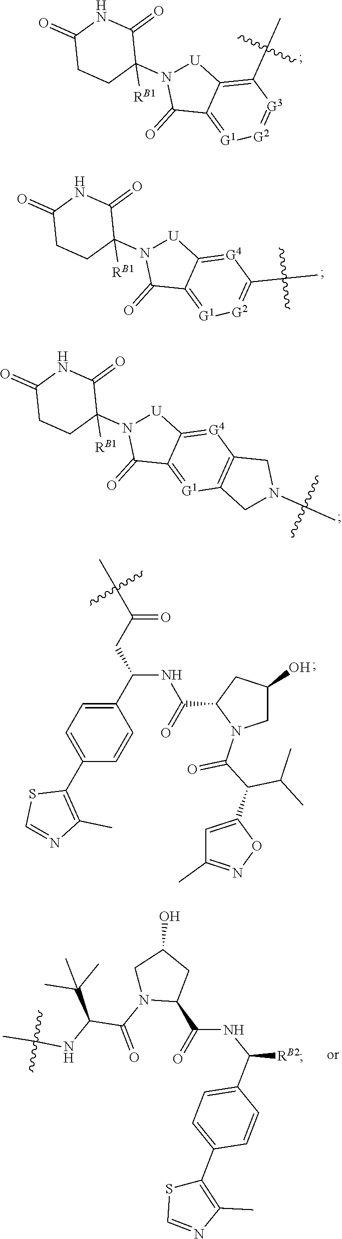

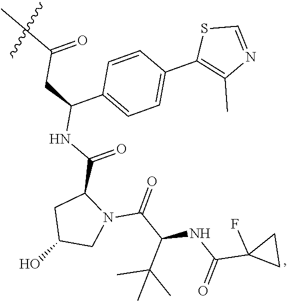

wherein:
G¹, G², G³, and G⁴ are independently —C(R^{G})═ or —N═;
U is —CH₂— or
R^{B1} is hydrogen, deuterium, methyl, or fluoro;
R^{B2} is hydrogen or methyl; and
each R^{G} is independently hydrogen, halo, or C₁₋₄ alkyl,
   wherein:
each R^{u} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}; wherein the alkyl, alkoxy, alkylamino, alkenyl, alkynyl, carbocyclyl, heterocyclyl, aryl, or heteroaryl is optionally substituted with one or more substituents selected from oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, and 3- to 6-membered heterocyclyl; or
two R^{u}, together with the one or more intervening atoms, form C₃₋₆ carbocyclyl, 3- to 6-membered heterocyclyl, C₆ aryl, or 5- to 6-membered heteroaryl, wherein the carbocyclyl, heterocyclyl, aryl, or heteroaryl is optionally substituted with one or more R^{z};
each R^{a} is independently C₁₋₆ alkyl, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl;
each R^{b} is independently hydrogen, C₁₋₆ alkyl, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl; and
R^{c} and R^{d} are independently hydrogen, C₁₋₆ alkyl, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl; or
R^{c} and R^{d}, together with the nitrogen atom to which they are attached, form 3- to 12-membered heterocyclyl, wherein the heterocyclyl is optionally substituted with one or more R^{z}, wherein each occurrence of R^{a}, R^{b}, R^{c}, and R^{d} is independently and optionally substituted with one or more R^{z}; and
each R^{z} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl.

In certain embodiments, the compound is a compound of Formula I-a or I-b:

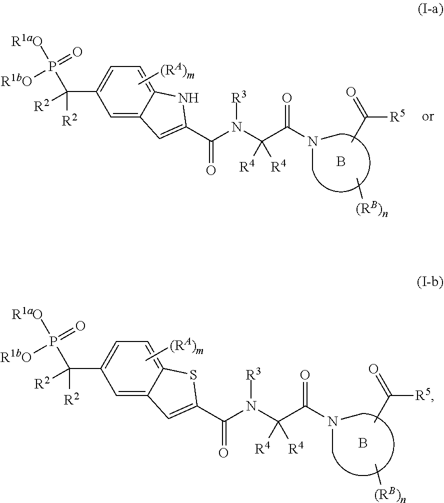

or a pharmaceutically acceptable salt, solvate, or stereoisomer thereof.

In certain embodiments, the compound is a compound of Formula I-a-i to I-b-iii

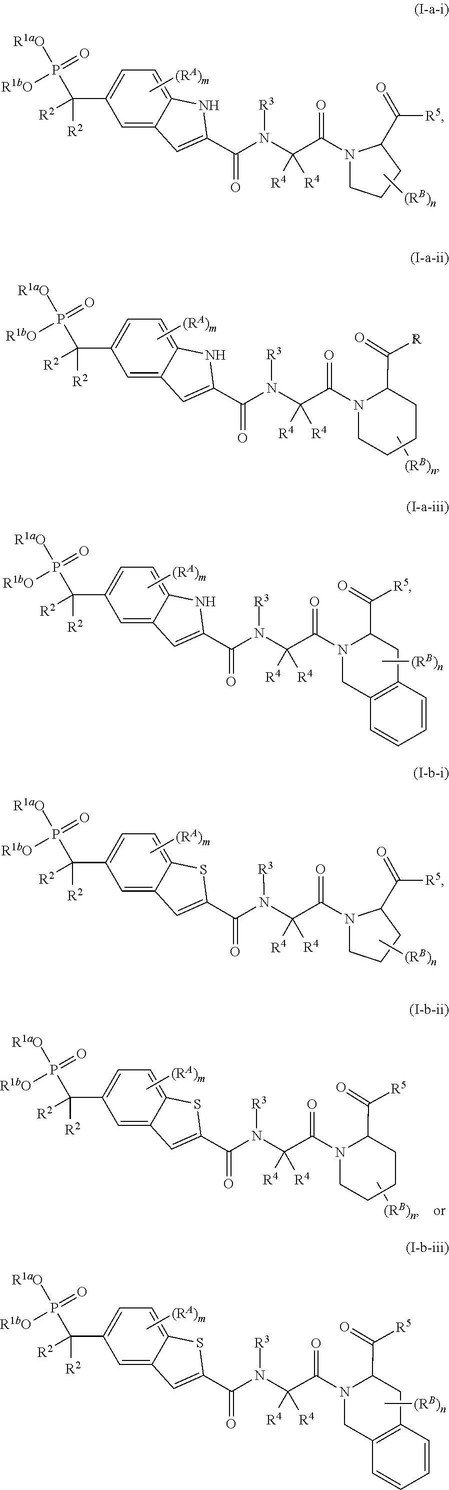

or a pharmaceutically acceptable salt, solvate, or stereoisomer thereof.

In certain embodiments, the compound is a compound of Formula I-a-iv, I-a-v, I-b-iv, or I-b-v

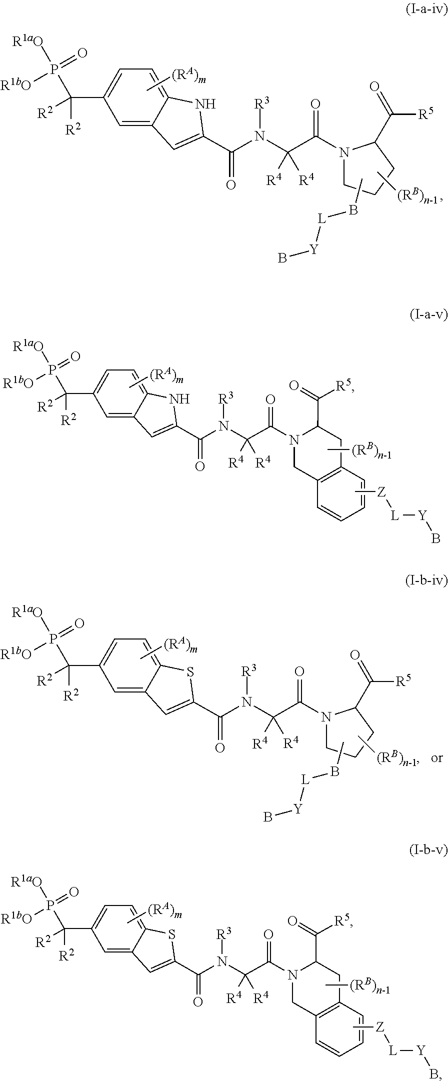

or a pharmaceutically acceptable salt, solvate, or stereoisomer thereof.

In certain embodiments, the compound is a compound of Formula I-a-i-1, I-a-i-2, I-b-i-1, or I-b-i-2

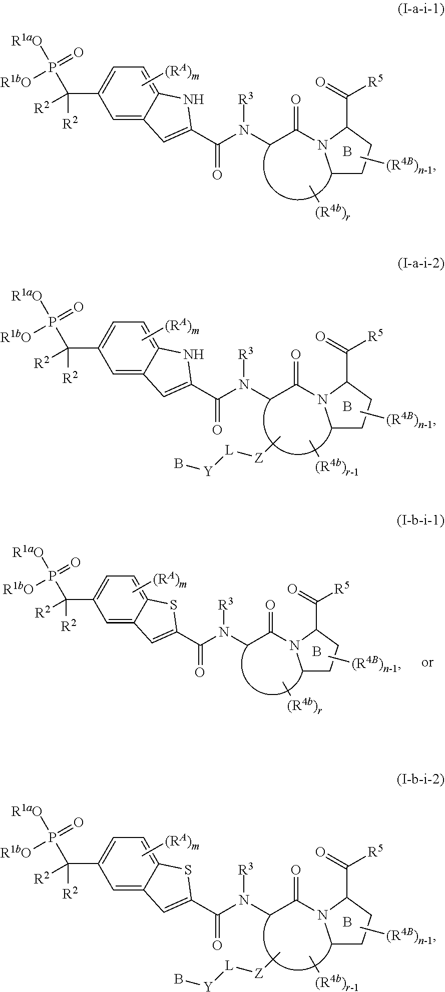

or a pharmaceutically acceptable salt, solvate, or stereoisomer thereof, wherein r is an integer from 0 to 10, as valency permits.

In certain embodiments, r is an integer from 0 to 10, as valency permits. In certain embodiments, r is 0. In certain embodiments, r is 1. In certain embodiments, r is 2. In certain embodiments, r is 3. In certain embodiments, r is 4. In certain embodiments, r is 5. In certain embodiments, r is 6. In certain embodiments, r is 7. In certain embodiments, r is 8. In certain embodiments, r is 9. In certain embodiments, r is 10.

In certain embodiments, the compound is a compound of Formula I-a-i-3, I-a-i-4, I-b-i-3, or I-b-i-4,

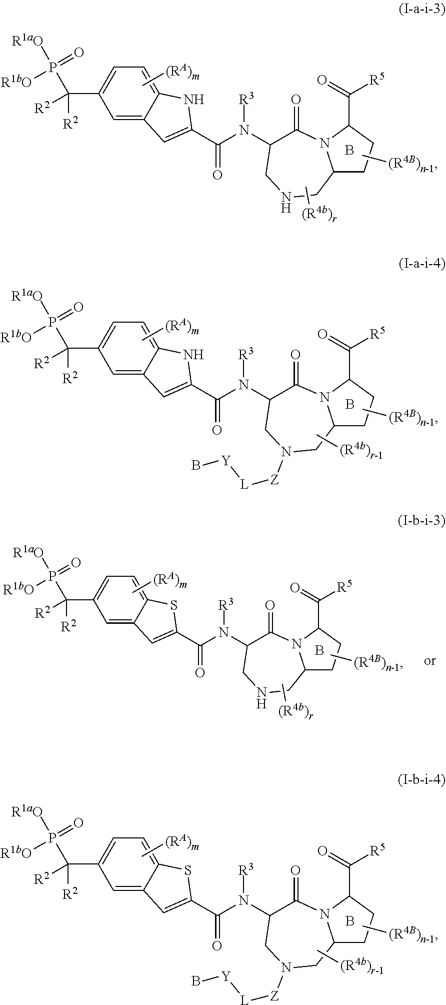

or a pharmaceutically acceptable salt, solvate, or stereoisomer thereof.

In certain embodiments, the compound is a compound of Formula (II):

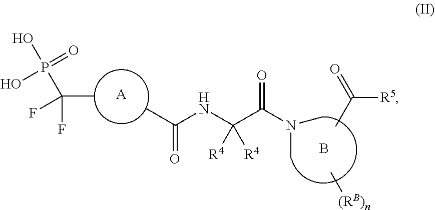

or a pharmaceutically acceptable salt, solvate, or stereoisomer thereof.

In certain embodiments, when one of R^{5a} and R^{5b} is hydrogen, then the other one of R^{5a} and R^{5b} is not:

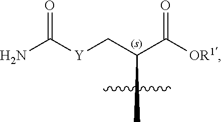

wherein:
Y is —O—, —NH—, or —CH₂—; and
R^{1′} is H or benzyl.

In certain embodiments, R^{5a} and/or R^{5b} are not:

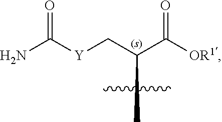

wherein:
Y is —O—, —NH—, or —CH₂—; and
R^{1′} is H or benzyl.

In certain embodiments, R^{1a} is hydrogen, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), or a hydroxyl protecting group.

In certain embodiments, R^{1b} is hydrogen, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), or a hydroxyl protecting group.

In certain embodiments, each R² is independently hydrogen or halogen (e.g., —F, —Cl, —Br, or —I).

In certain embodiments, two R², together with the carbon atom to which they are attached, form C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S).

In certain embodiments, Ring A is C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S).

In certain embodiments, each R^{A} is independently halogen (e.g., —F, —Cl, —Br, or —I), —CN, —NO₂, —OH, —NH₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-1-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{A} is independently halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{A} is independently halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{A} is independently halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl, or heterocyclyl is optionally substituted with one or more R^{u}.

In certain embodiments, each R^{A} is independently halogen, —CN, —NO₂, —OH, —NH₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{u}.

In certain embodiments, m is an integer selected from 0 to 6. In certain embodiments, m is 0. In certain embodiments, m is 1. In certain embodiments, m is 2. In certain embodiments, m is 3. In certain embodiments, m is 4. In certain embodiments, m is 5. In certain embodiments, m is 6.

In certain embodiments, Ring B is 3- to 12-membered heterocyclyl (e.g., heterocyclyl comprising one or two 3- to 8-membered rings and 1-5 heteroatoms selected from N, O, and S).

In certain embodiments, each R^{B} is independently

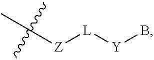

oxo, halogen (e.g., —F, —Cl, —Br, or —I), —CN, —NO₂, —OH, —NH₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-1-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{B} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{B} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{B} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl, or heterocyclyl is optionally substituted with one or more R^{u}.

In certain embodiments, each R^{B} is independently oxo, halogen, —CN, —NO₂, —OH, —NH₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{u}.

In certain embodiments, one R^{B} is

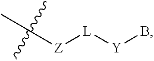

In certain embodiments, two vicinal R^{B}, together with atoms to which they are bonded, form C₆ aryl or 5- to 6-membered heteroaryl (e.g., heteroaryl comprising one 5- or 6-membered ring and 1-5 heteroatoms selected from N, O, and S), wherein the aryl or heteroaryl is optionally substituted with one or more R^{B-1}.

In certain embodiments, each R^{B-1} is independently

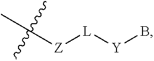

oxo, halogen (e.g., —F, —Cl, —Br, or —I), —CN, —NO₂, —OH, —NH₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-1-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{B-1} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{B-1} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{B-1} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl, or heterocyclyl is optionally substituted with one or more R^{u}.

In certain embodiments, each R^{B-1} is independently oxo, halogen, —CN, —NO₂, —OH, —NH₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{u}.

In certain embodiments, one R^{B-1} is

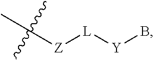

In certain embodiments, n is an integer selected from 0 to 6. In certain embodiments, n is 0. In certain embodiments, n is 1. In certain embodiments, n is 2. In certain embodiments, n is 3. In certain embodiments, n is 4. In certain embodiments, n is 5. In certain embodiments, n is 6.

In certain embodiments, X is —CR^{X}═CR^{X}— or absent.

In certain embodiments, each R^{X} is independently hydrogen, halogen (e.g., —F, —Cl, —Br, or —I), or C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)).

In certain embodiments, R³ is hydrogen, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), or 5- to 10-membered heteroaryl (e.g., heteroaryl comprising one or two 5- or 6-membered rings and 1-5 heteroatoms selected from N, O, and S), wherein the alkyl, alkenyl, alkynyl, carbocyclyl, heterocyclyl, aryl, or heteroaryl is optionally substituted with one or more R^{u}.

In certain embodiments, R³ is hydrogen, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkenyl, alkynyl, carbocyclyl, heterocyclyl, aryl, or heteroaryl is optionally substituted with one or more R^{u}.

In certain embodiments, R³ is hydrogen, C₁₋₆ alkyl, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkenyl, alkynyl, carbocyclyl, heterocyclyl, aryl, or heteroaryl is optionally substituted with one or more R^{u}.

In certain embodiments, R³ is hydrogen, C₁₋₆ alkyl, C₂₋₆ alkenyl, C₂₋₆ alkynyl, C₃₋₆ carbocyclyl, or 3- to 6-membered heterocyclyl, wherein the alkyl, alkenyl, alkynyl, carbocyclyl, or heterocyclyl is optionally substituted with one or more R^{u}.

In certain embodiments, R³ is hydrogen, C₁₋₆ alkyl, C₃₋₆ carbocyclyl, or 3- to 6-membered heterocyclyl, wherein the alkyl, carbocyclyl, or heterocyclyl is optionally substituted with one or more R^{u}.

In certain embodiments, each R⁴ is independently oxo, halogen (e.g., —F, —Cl, —Br, or —I), —CN, —NO₂, —OH, —NH₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-1-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{4a}.

In certain embodiments, each R⁴ is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more R^{4a}.

In certain embodiments, each R⁴ is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more R^{4a}.

In certain embodiments, each R⁴ is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl, or heterocyclyl is optionally substituted with one or more R^{4a}.

In certain embodiments, each R⁴ is independently oxo, halogen, —CN, —NO₂, —OH, —NH₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{4a}.

In certain embodiments, R⁴ and R^{B}, together with the intervening atoms, form 3- to 12-membered heterocyclyl (e.g., heterocyclyl comprising one or two 3- to 8-membered rings and 1-5 heteroatoms selected from N, O, and S) optionally substituted with one or more R^{4b}.

In certain embodiments, two R⁴, together with the carbon atom to which they are attached, form C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), wherein the carbocyclyl or heterocyclyl is optionally substituted with one or more R^{u}.

In certain embodiments, each R^{4a} is independently halogen (e.g., —F, —Cl, —Br, or —I), —CN, —NO₂, —OH, —NH₂, —B(OH)₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-1-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{4a} is independently halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{4a} is independently halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{4a} is independently halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl, or heterocyclyl is optionally substituted with one or more R^{u}.

In certain embodiments, each R^{4a} is independently halogen, —CN, —NO₂, —OH, —NH₂, —B(OH)₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{u}.

In certain embodiments, each R^{4b} is independently

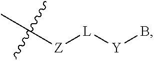

oxo, halogen (e.g., —F, —Cl, —Br, or —I), —CN, —NO₂, —OH, —NH₂, —B(OH)₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-1-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{4b} is independently oxo, halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{4b} is independently oxo, halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{4b} is independently oxo, halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl, or heterocyclyl is optionally substituted with one or more R^{u}.

In certain embodiments, each R^{4b} is independently oxo, halogen, —CN, —NO₂, —OH, —NH₂, —B(OH)₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{u}.

In certain embodiments, one R^{4b} is

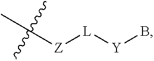

In certain embodiments,

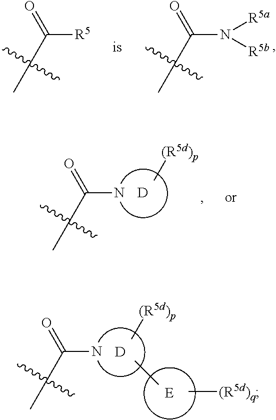

In certain embodiments, R^{5a} and R^{5b} are independently

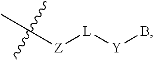

hydrogen, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), or —(C₁₋₆ alkyl)-(3- to 12-membered heterocyclyl), wherein the alkyl, alkenyl, alkynyl, carbocyclyl, heterocyclyl, aryl, or heteroaryl is optionally substituted with one or more R^{5c}.

In certain embodiments, R^{5a} and R^{5b} are independently hydrogen, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkenyl, alkynyl, carbocyclyl, heterocyclyl, aryl, or heteroaryl is optionally substituted with one or more R^{5c}.

In certain embodiments, R^{5a} and R^{5b} are independently hydrogen, C₁₋₆ alkyl, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkenyl, alkynyl, carbocyclyl, heterocyclyl, aryl, or heteroaryl is optionally substituted with one or more R^{5c}.

In certain embodiments, R^{5a} and R^{5b} are independently hydrogen, C₁₋₆ alkyl, C₂₋₆ alkenyl, C₂₋₆ alkynyl, C₃₋₆ carbocyclyl, or 3- to 6-membered heterocyclyl, wherein the alkyl, alkenyl, alkynyl, carbocyclyl, or heterocyclyl is optionally substituted with one or more R^{5c}.

In certain embodiments, R^{5a} and R^{5b} are independently hydrogen, C₁₋₆ alkyl, C₃₋₆ carbocyclyl, or 3- to 6-membered heterocyclyl, wherein the alkyl, carbocyclyl, or heterocyclyl is optionally substituted with one or more R^{5c}.

In certain embodiments, one of R^{5a} and R^{5b} is

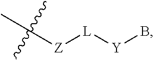

In certain embodiments, each R^{5c} is independently halogen (e.g., —F, —Cl, —Br, or —I), —CN, —NO₂, —OH, —NH₂, —B(OH)₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-1-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —(C₁₋₆ alkyl)-(5- to 10-membered heteroaryl), —(C₁₋₆ alkyl)-(C₃₋₁₂ carbocyclyl), or —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{5c} is independently halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{5c} is independently halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{5c} is independently halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl, or heterocyclyl is optionally substituted with one or more R^{u}.

In certain embodiments, each R^{5c} is independently halogen, —CN, —NO₂, —OH, —NH₂, —B(OH)₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{u}.

In certain embodiments, Ring D is 3- to 12-membered heterocyclyl (e.g., heterocyclyl comprising one or two 3- to 8-membered rings and 1-5 heteroatoms selected from N, O, and S).

In certain embodiments, each R^{5d} is independently

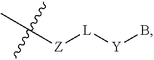

oxo, halogen (e.g., —F, —Cl, —Br, or —I), —CN, —NO₂, —OH, —NH₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-1-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{5d} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{5d} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{5d} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl, or heterocyclyl is optionally substituted with one or more R^{u}.

In certain embodiments, each R^{5d} is independently oxo, halogen, —CN, —NO₂, —OH, —NH₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{u}.

In certain embodiments, one R^{5d} is

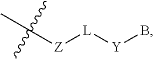

In certain embodiments, p is an integer selected from 0 to 6. In certain embodiments, p is 0. In certain embodiments, p is 1. In certain embodiments, p is 2. In certain embodiments, p is 3. In certain embodiments, p is 4. In certain embodiments, p is 5. In certain embodiments, p is 6.

In certain embodiments, Ring E is C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S).

In certain embodiments, each R^{5e} is independently

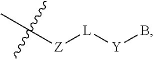

oxo, halogen (e.g., —F, —Cl, —Br, or —I), —CN, —NO₂, —OH, —NH₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-1-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{5c} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{5c} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more R^{u}.

In certain embodiments, each R^{5c} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl, or heterocyclyl is optionally substituted with one or more R^{u}.

In certain embodiments, each R^{5c} is independently oxo, halogen, —CN, —NO₂, —OH, —NH₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{u}.

In certain embodiments, one R^{5c} is

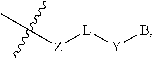

In certain embodiments, q is an integer selected from 0 to 6. In certain embodiments, q is 0. In certain embodiments, q is 1. In certain embodiments, q is 2. In certain embodiments, q is 3. In certain embodiments, q is 4. In certain embodiments, q is 5. In certain embodiments, q is 6.

In certain embodiments, one of R^{B}, R^{B-1}, R^{4b}, R^{5a}, R^{5b}, and R^{5d}, and R^{5e} is

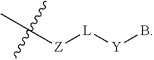

In certain embodiments, Z is —CH₂—, —O—, —N(R^{Z0})—, —OC(═O)—, —C(═O)NR^{Z1}—, —C(═O)—, —CH₂C(═O)NR^{Z2}—, —CH₂CH₂C(═O)NR^{Z3}—, —CH₂CH₂(C═O)N(CH₂)₂CH—, —OCH₂C(═O)NR^{Z4}— or —C(═O)CH₂C(═O)NR^{Z5}—.

In certain embodiments, each occurrence of R^{Z0}, R^{Z1}, R^{Z2}, R^{Z3}, R^{Z4}, and R^{Z5} is independently hydrogen or C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)).

In certain embodiments, L is C₁₋₁₈ alkylene or C₁₋₁₂ heteroalkylene (e.g., C₁₋₁₂ alkylene comprising 1-5 heteroatoms selected from N, O, and S), wherein the alkylene or heteroalkylene is optionally substituted with one or more R^{u}.

In certain embodiments, L is -A-(CH₂)_{m′}—W—(CH₂)_{n′}— or —(CH₂)_{r′}—W—(CH₂)_{u′}—O—(CH₂)_{v′}—.

In certain embodiments, A is absent.

In certain embodiments, A is 5- to 10-membered heteroarylene (e.g., heteroarylene comprising one or two 5- or 6-membered rings and 1-5 heteroatoms selected from N, O, and S) optionally substituted with one or more R^{u}.

In certain embodiments, W is phenylene, 5- to 10-membered heteroarylene (e.g., heteroaryl comprising one or two 5- or 6-membered rings and 1-5 heteroatoms selected from N, O, and S), 3- to 12-membered heterocyclylene (e.g., heterocyclylene comprising one or two 3- to 8-membered rings and 1-5 heteroatoms selected from N, O, and S), or C₃₋₁₂ carbocyclylene (e.g., cyclopropylene (C₃), cyclopropenylene (C₃), cyclobutylene (C₄), cyclobutenylene (C₄), cyclopentylene (C₅), cyclopentenylene (C₅), cyclohexylene (C₆), cyclohexenylene (C₆), cyclohexadienylene (C₆), cycloheptylene (C₇), cycloheptenylene (C₇), cycloheptadienylene (C₇), cycloheptatrienylene (C₇), cyclooctylene (C₈), cyclooctenylene (C₈), bicyclo[2.2.1]heptanylene (C₇), bicyclo[2.2.2]octanylene (C₈), cyclononylene (C₉), cyclononenylene (C₉), cyclodecylene (C₁₀), cyclodecenylene (C₁₀), octahydro-1H-indenylene (C₉), decahydronaphthalenylene (C₁₀), or spiro[4.5]decanylene (C₁₀)); wherein the phenylene, heteroarylene, heterocyclylene, or carbocyclylene is optionally substituted with one or more R^{u}.

In certain embodiments, m′ is an integer from 0 to 7. In certain embodiments, m′ is 0. In certain embodiments, m′ is 1. In certain embodiments, m′ is 2. In certain embodiments, m′ is 3. In certain embodiments, m′ is 4. In certain embodiments, m′ is 5. In certain embodiments, m′ is 6. In certain embodiments, m′ is 7.

In certain embodiments, n′ is an integer from 0 to 8. In certain embodiments, n′ is 0. In certain embodiments, n′ is 1. In certain embodiments, n′ is 2. In certain embodiments, n′ is 3. In certain embodiments, n′ is 4. In certain embodiments, n′ is 5. In certain embodiments, n′ is 6. In certain embodiments, n′ is 7. In certain embodiments, n′ is 8.

In certain embodiments, r′ is an integer from 0 to 3. In certain embodiments, r′ is 0. In certain embodiments, r′ is 1. In certain embodiments, r′ is 2. In certain embodiments, r′ is 3.

In certain embodiments, u′ is an integer from 0 to 3. In certain embodiments, u′ is 0. In certain embodiments, u′ is 1. In certain embodiments, u′ is 2. In certain embodiments, u′ is 3.

In certain embodiments, v′ is an integer from 1 to 4. In certain embodiments, v′ is 1. In certain embodiments, v′ is 2. In certain embodiments, v′ is 3. In certain embodiments, v′ is 4.

In certain embodiments, Y is —C≡C—, —CH═CH—, —CH₂—, —O—, —N(R^{Y1})—, —C(═O)—, —C(═O)N(R^{Y2})—, —N(R^{Y3})C(═O)CH₂O—, or —N(R^{Y3})C(═O)CH₂N(R^{Y4})—.

In certain embodiments, each occurrence of R^{Y1}, R^{Y2}, R^{Y3}, and R^{Y4} is independently hydrogen or C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)).

In certain embodiments, Y is absent.

In certain embodiments, B is

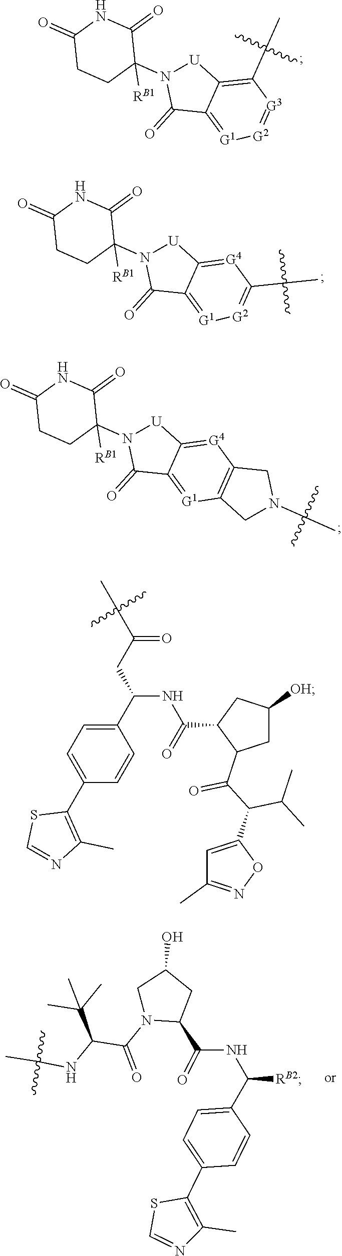

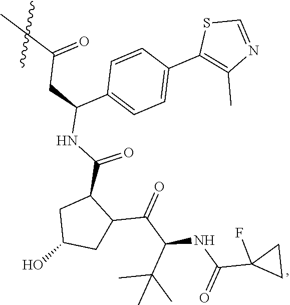

wherein:
G¹, G², G³, and G⁴ are independently —C(R^{G})═ or —N═;
U is —CH₂— or —C(═O)—;
R^{B1} is hydrogen, deuterium, methyl, or fluoro;
R^{B2} is hydrogen or methyl; and
each R^{G} is independently hydrogen, halo, or C₁₋₄ alkyl (e.g., methyl (C₁), ethyl (C₂), n-propyl (C₃), i-propyl (C₃), n-butyl (C₄), i-butyl (C₄), s-butyl (C₄), or t-butyl (C₄)).

In certain aspects, the present disclosure provides compounds of Formula I:

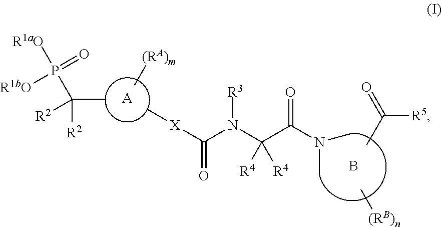

or pharmaceutically acceptable salts, solvates, or stereoisomers thereof, wherein:
R^{1a} is hydrogen or C₁₋₆ alkyl;
R^{1b} is hydrogen or C₁₋₆ alkyl;
each R² is independently hydrogen or halogen; or
two R², together with the carbon atom to which they are attached, form a C₃₋₁₀ carbocyclyl or 3- to 10-membered heterocyclyl;
Ring A is C₆₋₁₄ aryl or 5- to 14-membered heteroaryl;
Ring B is 3- to 10-membered heterocyclyl;
each R^{A} is independently halogen, —CN, —NO₂, C₁₋₆ alkyl, C₁₋₆haloalkyl, C₁₋₆hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u};
each R^{B} is independently

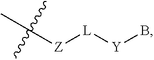

halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{B-1};
each R^{B-1} is independently halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u};
m and n independently are integers selected from 0 to 6;
X is —CR^{X}═CR^{X}— or absent;
each R^{X} is independently hydrogen, halogen, or C₁₋₆ alkyl;
R³ is hydrogen, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, or 3- to 10-membered heterocyclyl, wherein the alkyl, haloalkyl, hydroxyalkyl, aminoalkyl, alkenyl, alkynyl, aryl, heteroaryl, carbocyclyl, or heterocyclyl is optionally substituted with one or more R^{u};
each R⁴ independently is hydrogen, halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), —(C₁₋₆ alkyl)-(C₃₋₁₀ carbocyclyl), —(C₁₋₆ alkyl)-(3- to 10-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{4a}; or
R⁴ and R^{B}, together with the intervening atoms, form a 3- to 10-membered heterocyclyl, wherein the heterocyclyl is optionally substituted with one or more R^{4b}; or
two R⁴, together with the carbon atom to which they are attached, form C₃₋₁₀ carbocyclyl or 3- to 10-membered heterocyclyl;
each R^{4a} is independently halogen, —CN, —NO₂, —B(OH)₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), —(C₁₋₆ alkyl)-(C₃₋₁₀ carbocyclyl), —(C₁₋₆ alkyl)-(3- to 10-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u};
each R^{4b} is independently

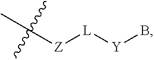

halogen, —CN, —NO₂, —B(OH)₂, C₁₋₆ alkyl, C₁₋₆haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u};

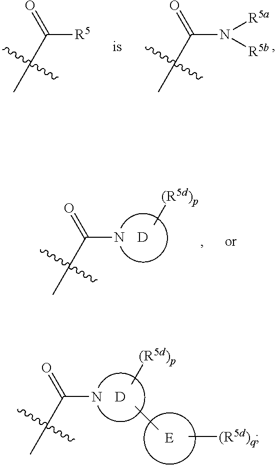

each R^{5a} and R^{5b} are independently

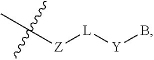

hydrogen, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), —(C₁₋₆ alkyl)-(C₃₋₁₀ carbocyclyl), or —(C₁₋₆ alkyl)-(3- to 10-membered heterocyclyl), wherein the alkyl, haloalkyl, hydroxyalkyl, aminoalkyl, alkenyl, alkynyl, aryl, heteroaryl, carbocyclyl, or heterocyclyl is optionally substituted with one or more R^{5c};
each R^{5c} is independently halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(5- to 14-membered heteroaryl), —(C₁₋₆ alkyl)-(C₃₋₁₀ carbocyclyl), or —(C₁₋₆ alkyl)-(3- to 10-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u};
Ring D is 3- to 12-membered heterocyclyl;
Ring E is C₆₋₁₄ aryl, 5- to 14-membered heteroaryl, C₃₋₁₀ carbocyclyl, or 3- to 10-membered heterocyclyl;
each R^{5d} and R^{5c} is independently

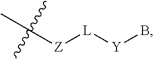

oxo, halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u}; and
p and q independently are integers selected from 0 to 6;
provided that:
one of R^{B}, R^{4b}, R^{5a}, R^{5b}, and R^{5d}, and R^{5e} is

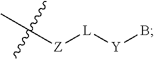

wherein:
Z is —CH₂—, —O—, —N(R^{Z0})—, —OC(═O)—, —C(═O)NR^{Z1}—, —C(═O)—, —CH₂C(═O)NR^{Z2}—, —CH₂CH₂C(═O)NR^{Z3}—, —CH₂CH₂(C═O)N(CH₂)₂CH—, —OCH₂C(═O)NR^{Z4}—, or —C(═O)CH₂C(═O)NR_{Z5}—;
each of R^{Z0}, R^{Z1}, R^{Z2}, R^{Z3}, R^{Z4}, and R^{Z5} is independently hydrogen or C₁₋₆ alkyl;
L is C₁₋₁₈ alkylene or C₁₋₁₂ heteroalkylene, wherein the alkylene or heteroalkylene is optionally substituted with one or more R^{u}; or
L is -A-(CH₂)_{m′}—W—(CH₂)_{n′}— or —(CH₂)_{r′}—W—(CH₂)_{u′}—O—(CH₂)_{v′};
A is absent; or
A is 5- to 10-membered heteroarylene; wherein the heteroarylene is optionally substituted with one or more R^{u};
W is phenylene, 5- to 10-membered heteroarylene, 3- to 10-membered heterocyclylene, or C₃₋₁₀ carbocyclylene; wherein the phenylene, heteroarylene, heterocyclylene, or carbocyclylene is optionally substituted with one or more R^{u};
m′ is an integer from 0 to 7;
n′ is an integer from 0 to 8;
r′ is an integer from 0 to 3;
u′ is an integer from 0 to 3; and
v′ is an integer from 1 to 4;
Y is —C≡C—, —CH═CH—, —CH₂—, —O—, —N(R^{Y1})—, —C(═O)—, —C(═O)N(R^{Y2})—, —N(R^{Y3})C(═O)CH₂O—, or —N(R^{Y3})C(═O)CH₂N(R^{Y4})—; or
Y is absent;
each of R^{Y1}, R^{Y2}, R^{Y3}, and R^{Y4} is independently hydrogen or C₁₋₆ alkyl; and
B is

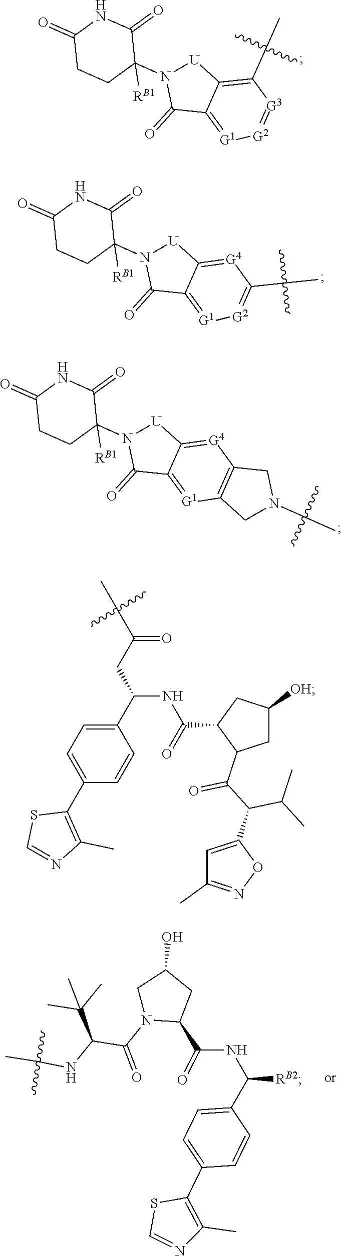

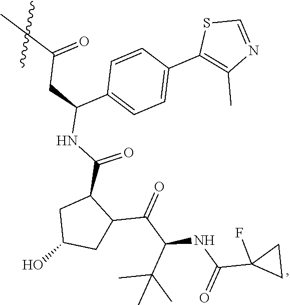

wherein:
G¹, G², G³, and G⁴ are independently —C(R^{G})═ or —N═;
U is —CH₂— or —C(═O)—;
R^{B1} is hydrogen, deuterium, methyl, or fluoro;
R^{B2} is hydrogen or methyl; and
each R^{G} is independently hydrogen, halogen, or C₁₋₄ alkyl,
   wherein:
each R^{u} is independently oxo, halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), —(C₁₋₆ alkyl)-(C₃₋₁₀ carbocyclyl), —(C₁₋₆ alkyl)-(3- to 10-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more oxo, halogen, —CN, —OH, —O(C₁₋₆ alkyl), —O(C═O)(C₁₋₆ alkyl), —NH₂, —NH(C₁₋₆ alkyl), —N(C₁₋₆ alkyl)₂, —NH(C═O)(C₁₋₆ alkyl), —N(C═O)(C₁₋₆ alkyl)₂, C₁₋₆ alkyl, C₁₋₆ haloalkyl, —C(═O)(C₁₋₆ alkyl), —C(═O)OH, —C(═O)O(C₁₋₆ alkyl), —C(═O)NH₂, —C(═O)NH(C₁₋₆ alkyl), or —C(═O)N(C₁₋₆ alkyl)₂; or
two R^{u}, together with the one or more intervening atoms, form a C₆₋₁₄ aryl, 5- to 14-membered heteroaryl, C₃₋₁₀ carbocyclyl or 3- to 10-membered heterocyclyl;
two R^{u}, together with the one or more intervening atoms, form C₆₋₁₀ aryl, 5- to 10-membered heteroaryl, C₃₋₁₀ carbocyclyl or 3- to 10-membered heterocyclyl;
each R^{a} is independently C₁₋₆ alkyl, C₂₋₆ alkenyl, C₂₋₆ alkynyl, C₃₋₁₀ carbocyclyl, 3- to 10-membered heterocyclyl, C₆₋₁₀ aryl, or 5- to 10-membered heteroaryl;
each R^{b} is independently hydrogen, C₁₋₆ alkyl, C₂₋₆ alkenyl, C₂₋₆ alkynyl, C₃₋₁₀ carbocyclyl, 3- to 10-membered heterocyclyl, C₆₋₁₀ aryl, or 5- to 10-membered heteroaryl; and
each R^{c} and R^{d} is independently hydrogen, C₁₋₆ alkyl, C₂₋₆ alkenyl, C₂₋₆ alkynyl, C₃₋₁₀ carbocyclyl, 3- to 10-membered heterocyclyl, C₆₋₁₀ aryl, or 5- to 10-membered heteroaryl; or
R^{c} and R^{d}, together with the nitrogen atom to which they are attached, form 3- to 10-membered heterocyclyl, wherein each of R^{a}, R^{b}, R^{c}, and R^{d} is independently and optionally substituted with one or more R^{z}; and
each R^{z} is independently oxo, halogen, —CN, —NO₂, —OH, —NH₂, C₁₋₆ alkyl, C₁₋₆ alkoxy, C₁₋₆ alkylamino, C₃₋₁₀ carbocyclyl, or 3- to 6-membered heterocyclyl,
In certain embodiments, when one of R^{5a} and R^{5b} is hydrogen, then the other one of R^{5a} and R^{5b} is not:

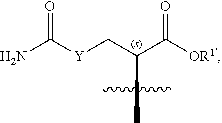

wherein:
Y is —O—, —NH—, or —CH₂—; and
R^{1′} is H or benzyl.

In certain embodiments, R^{1a} and R^{1b} are both hydrogen.

In certain embodiments, each R² is independently halogen.

In certain embodiments, wherein each R² is fluoride.

In certain embodiments, Ring A is 5- to 14-membered heteroaryl.

In certain embodiments, Ring A is

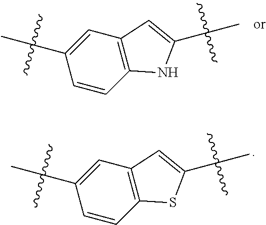 [SMILES: *c1ccc2[nH]c(*)cc2c1 ; *c1ccc2sc(*)cc2c1]

In certain embodiments, the compound is a compound of Formula I-a or I-b:

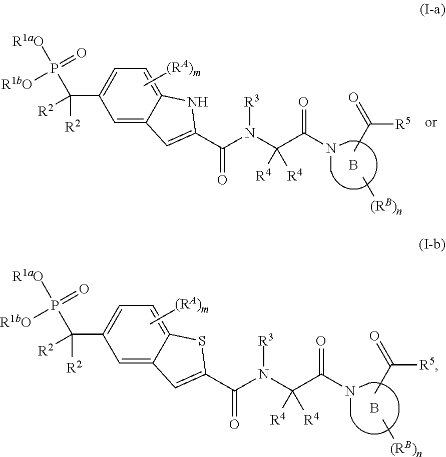

or a pharmaceutically acceptable salt, solvate, or stereoisomer thereof.

In certain embodiments, each R^{A} is independently halogen, —CN, —NO₂, C₁₋₆ alkyl, C₁₋₆ haloalkyl, C₁₋₆ hydroxyalkyl, C₁₋₆ aminoalkyl, C₃₋₁₀ carbocyclyl, or 3- to 10-membered heterocyclyl, wherein the alkyl, haloalkyl, hydroxyalkyl, aminoalkyl, alkenyl, alkynyl, carbocyclyl, heterocyclyl, aryl, or heteroaryl is optionally substituted with one or more R^{u}.

In certain embodiments, each R^{A} is independently —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}.

In certain embodiments, m is 0. In certain embodiments, m is 1. In certain embodiments, m is 2. In certain embodiments, m is 3. In certain embodiments, m is 4. In certain embodiments, m is 5. In certain embodiments, m is 6. In certain preferred embodiments, m is 0.

In certain embodiments, X is —CR^{X}═CR^{X}—. In certain embodiments, X is absent.

In certain embodiments, R³ is hydrogen, C₁₋₆ alkyl, C₁₋₆ haloalkyl, C₁₋₆ hydroxyalkyl, C₁₋₆ aminoalkyl, C₃₋₁₀ carbocyclyl, or 3- to 10-membered heterocyclyl. In certain embodiments, R³ is hydrogen or C₁₋₆ alkyl. In certain embodiments, R³ is hydrogen. In certain embodiments, R³ is C₁₋₆ alkyl.

In certain embodiments, Ring B is 5- to 8-membered heterocyclyl. In certain embodiments, Ring B is 5-membered heterocyclyl. In certain embodiments, Ring B is 6-membered heterocyclyl.

In certain embodiments, each R^{B} is independently halogen, —CN, —NO₂, C₁₋₆ alkyl, C₁₋₆ haloalkyl, C₁₋₆ hydroxyalkyl, C₁₋₆ aminoalkyl, C₃₋₁₀ carbocyclyl, or 3- to 10-membered heterocyclyl.

In certain embodiments, each R^{B} is independently —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}.

In certain embodiments, each R^{B} is independently halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{B-1}.

In certain embodiments, each R^{B} is independently halogen, —CN, —NO₂, 5- to 14-membered heteroaryl, —NR^{c}R^{d}, —OR^{b}, —C(═O)R^{a}, or —C(═O)OR^{b}, wherein the heteroaryl is optionally substituted with one or more R^{B-1}.

In certain embodiments, each R^{B-1} is independently halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u}.

In certain embodiments, each R^{B-1} is independently C₁₋₆ alkyl, —C(═O)OR^{b}, or —C(═O)NR^{c}R^{d}, wherein the alkyl is optionally substituted with one or more R^{u}.

In certain embodiments, n is 0. In certain embodiments, n is 1. In certain embodiments, n is 2. In certain embodiments, n is 3. In certain embodiments, n is 4. In certain embodiments, n is 5. In certain embodiments, n is 6. In certain preferred embodiments, n is 0.

In certain embodiments, the compound is a compound of Formula I-a-i, I-a-ii, I-a-iii, I-b-i, I-b-ii, or I-b-iii,

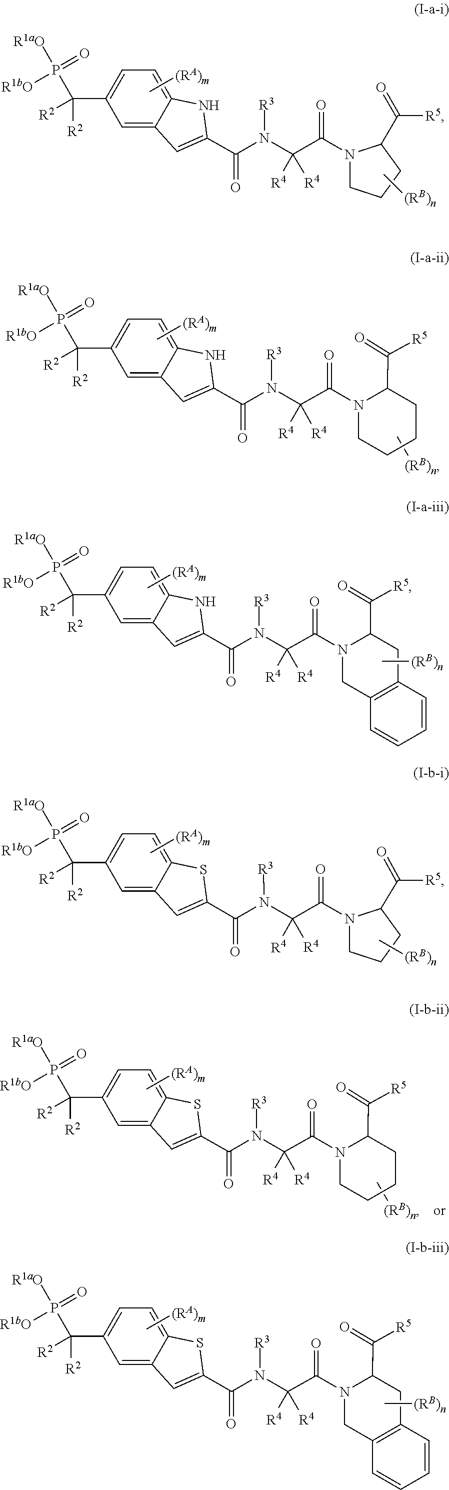

or a pharmaceutically acceptable salt, solvate, or stereoisomer thereof.

In certain embodiments, the compound is a compound of Formula I-a-iv, I-a-v, I-b-iv, or I-b-v

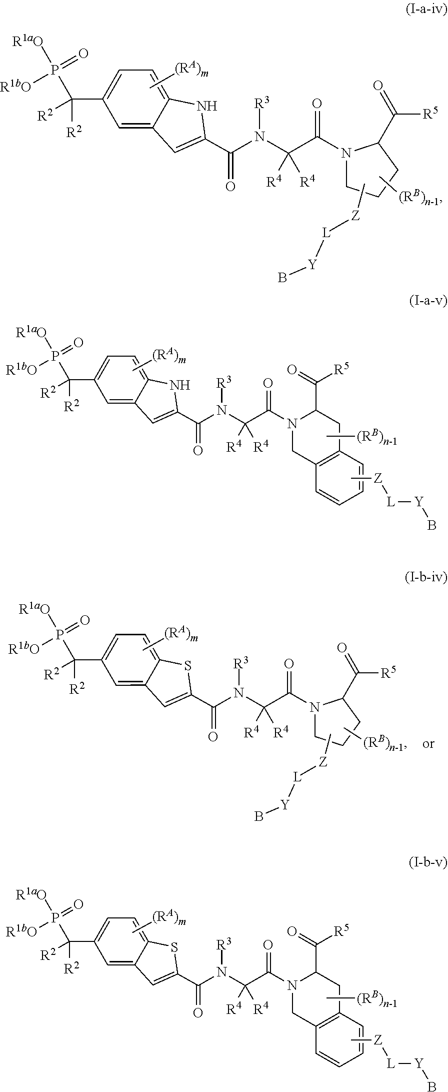

or a pharmaceutically acceptable salt, solvate, or stereoisomer thereof.

In certain embodiments, each R⁴ is independently hydrogen, halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), —(C₁₋₆ alkyl)-(C₃₋₁₀ carbocyclyl), —(C₁₋₆ alkyl)-(3- to 10-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{4a}.

In certain embodiments, each R⁴ is independently hydrogen, halogen, —CN, —NO₂, C₁₋₆ alkyl, C₁₋₆ haloalkyl, C₁₋₆ hydroxyalkyl, C₁₋₆ aminoalkyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), —(C₁₋₆ alkyl)-(C₃₋₁₀ carbocyclyl), or —(C₁₋₆ alkyl)-(3- to 10-membered heterocyclyl), wherein the alkyl, haloalkyl, hydroxyalkyl, aminoalkyl, alkenyl, alkynyl, carbocyclyl, heterocyclyl, aryl, or heteroaryl is optionally substituted with one or more R^{4a}.

In certain embodiments, each R⁴ is independently C₁₋₆ alkyl, C₁₋₆ hydroxyalkyl, C₁₋₆ aminoalkyl, C₆₋₁₄ aryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), or —(C₁₋₆ alkyl)-(3- to 10-membered heterocyclyl), wherein the alkyl, hydroxyalkyl, aminoalkyl, carbocyclyl, heterocyclyl, or aryl is optionally substituted with one or more R^{4a}.

In certain embodiments, each R^{4a} is independently halogen, —CN, —NO₂, —B(OH)₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), —(C₁₋₆ alkyl)-(C₃₋₁₀ carbocyclyl), —(C₁₋₆ alkyl)-(3- to 10-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u}.

In certain embodiments, each R^{4a} is independently halogen, —CN, —NO₂, —B(OH)₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), —(C₁₋₆ alkyl)-(C₃₋₁₀ carbocyclyl), —(C₁₋₆ alkyl)-(3- to 10-membered heterocyclyl), —NR^{b}C(═O)R^{a}, —OR^{b}, —C(═O)R^{a}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u}.

In certain embodiments, each R^{4a} is independently halogen, —CN, —NO₂, —B(OH)₂, C₁₋₆ alkyl, C₁₋₆ haloalkyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(C₃₋₁₀ carbocyclyl), —NR^{b}C(═O)R^{a}, —OR^{b}, —C(═O)R^{a}, or —C(═O)NR^{c}R^{d}, wherein the alkyl, haloalkyl, alkynyl, carbocyclyl, heterocyclyl, aryl, or heteroaryl is optionally substituted with one or more R^{u}.

In certain embodiments, one R⁴ is hydrogen, and the other R⁴ is tert-butyl.

In certain embodiments, one R⁴ and one R^{B}, together with the intervening atoms, form a 3- to 10-membered heterocyclyl, wherein the heterocyclyl is optionally substituted with one or more R^{4b}.

In certain embodiments, the compound is a compound of Formula I-a-i-1, I-a-i-2, I-b-i-1, or I-b-i-2

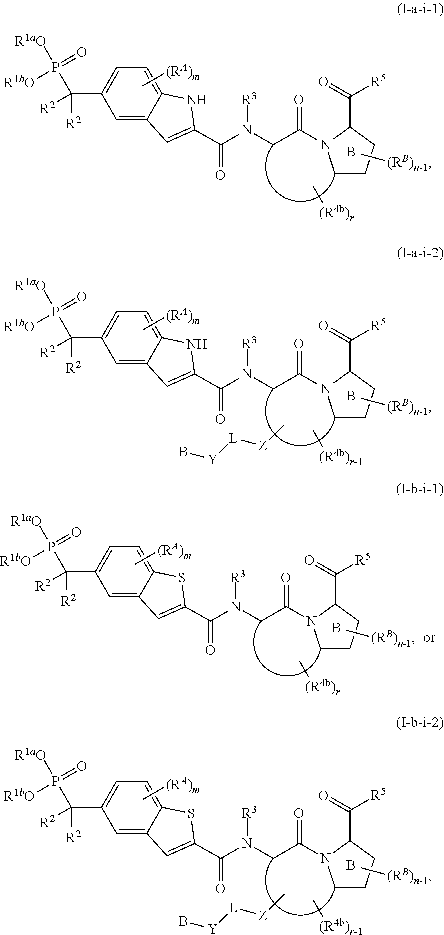

or a pharmaceutically acceptable salt, solvate, or stereoisomer thereof, wherein r is an integer from 0 to 10, as valency permits.

The compound of claim 30, wherein the compound is a compound of Formula I-a-i-3, I-a-i-4, I-b-i-3, or I-b-i-4,

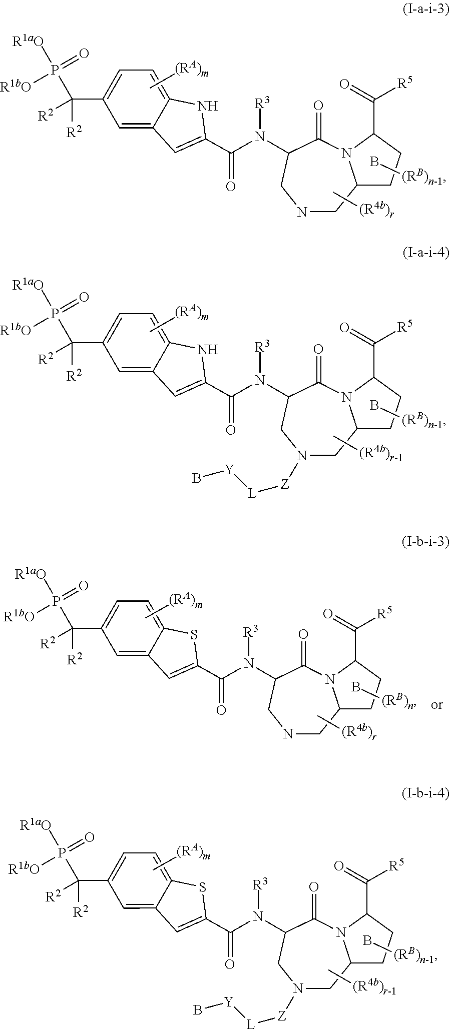

or a pharmaceutically acceptable salt, solvate, or stereoisomer thereof.

In certain embodiments, each R^{4b} is independently halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, or 3- to 10-membered heterocyclyl, wherein the alkyl, haloalkyl, hydroxyalkyl, aminoalkyl, alkenyl, alkynyl, carbocyclyl, heterocyclyl, aryl, or heteroaryl is optionally substituted with one or more R^{u}.

In certain embodiments, each R^{4b} is independently —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}.

In certain embodiments, at least one R^{4b} is ethyl or acetyl.

In certain embodiments, two R⁴, together with the carbon atom to which they are attached, form C₃₋₁₀ carbocyclyl or 3- to 10-membered heterocyclyl. In certain embodiments, two R⁴, together with the carbon atom to which they are attached, form C₃₋₁₀ carbocyclyl. In certain embodiments, two R⁴, together with the carbon atom to which they are attached, form 3- to 10-membered heterocyclyl.

In certain embodiments,

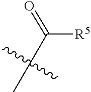

is

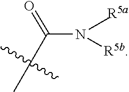

In certain embodiments, R^{5a} and R^{5b} are independently hydrogen, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(C₆₋₁₄ aryl), —(C₁₋₆ alkyl)-(5- to 14-membered heteroaryl), —(C₁₋₆ alkyl)-(C₃₋₁₀ carbocyclyl), or —(C₁₋₆ alkyl)-(3- to 10-membered heterocyclyl), wherein the alkyl, haloalkyl, hydroxyalkyl, aminoalkyl, alkenyl, alkynyl, aryl, heteroaryl, carbocyclyl, or heterocyclyl is optionally substituted with one or more R^{5c}.

In certain embodiments, R^{5a} and R^{5b} are independently hydrogen, C₁₋₆ alkyl, C₆₋₁₄ aryl, 5- to 14-membered heteroaryl, C₃₋₁₀ carbocyclyl, 3- to 10-membered heterocyclyl, or —(C₁₋₆ alkyl)-(C₆₋₁₄ aryl), wherein the alkyl, aryl, heteroaryl, carbocyclyl, or heterocyclyl is optionally substituted with one or more R^{5c}.

In certain embodiments, each R^{5c} is independently halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —(C₁₋₆ alkyl)-(5- to 14-membered heteroaryl), —(C₁₋₆ alkyl)-(C₃₋₁₀ carbocyclyl), or —(C₁₋₆ alkyl)-(3- to 10-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u}.

In certain embodiments, each R^{5c} is independently halogen, —CN, C₁₋₆ alkyl, C₁₋₆ haloalkyl, C₁₋₆ hydroxyalkyl, C₆₋₁₄ aryl, 5- to 14-membered heteroaryl, C₃₋₁₀ carbocyclyl, 3- to 10-membered heterocyclyl, —(C₁₋₆ alkyl)-(5- to 14-membered heteroaryl), —S(═O)₂R^{a}, —C(═O)OR^{b}, or —C(═O)NR^{c}R^{d}, wherein the alkyl, haloalkyl, hydroxyalkyl, carbocyclyl, heterocyclyl, aryl, or heteroaryl is optionally substituted with one or more R^{u}.

In certain embodiments, one of R^{5a} and R^{5b} is hydrogen, and the other one of R^{5a} and R^{5b} is 5- to 14-membered heteroaryl substituted with C₆₋₁₄ aryl, wherein the aryl is optionally substituted with one or more R^{u}.

In certain embodiments, one of R^{5a} and R^{5b} is hydrogen, and the other one of R^{5a} and R^{5b} is thiazolyl substituted with phenyl.

In certain embodiments,

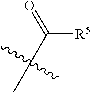

is

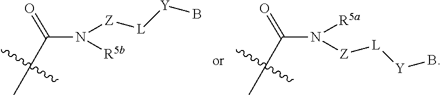

In certain embodiments,

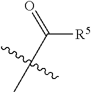

is

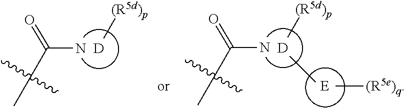

In certain embodiments,

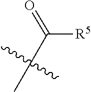

is

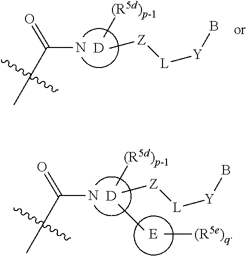

In certain embodiments, Ring D is 3- to 12-membered heterocyclyl. In certain embodiments, Ring D is 5- or 6-membered heterocyclyl. In certain embodiments, Ring D is 5-membered heterocyclyl. In certain embodiments, Ring D is 6-membered heterocyclyl.

In certain embodiments, Ring D is morpholinyl or piperidinyl.

In certain embodiments, each R^{5d} is independently oxo, halogen, —CN, —NO₂, C₁₋₆ alkyl, C₁₋₆haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u}.

In certain embodiments, each R^{5d} is independently oxo, halogen, C₁₋₆ alkyl, C₁₋₆ haloalkyl, C₆₋₁₄ aryl, 5- to 14-membered heteroaryl, C₃₋₁₀ carbocyclyl, —S(═O)₂R^{a}, —OR^{b}, —C(═O)R^{a}, —C(═O)OR^{b}, or —C(═O)NR^{c}R^{d}, wherein the alkyl, haloalkyl, carbocyclyl, heterocyclyl, or aryl is optionally substituted with one or more R^{u}.

In certain embodiments, p is 0. In certain embodiments, p is 1. In certain embodiments, p is 2. In certain embodiments, p is 3. In certain embodiments, p is 4. In certain embodiments, p is 5. In certain embodiments, p is 6.

In certain embodiments, Ring E is C₆₋₁₄ aryl, 5- to 14-membered heteroaryl, or C₃₋₁₀ carbocyclyl. In certain embodiments, Ring E is C₆₋₁₄ aryl or C₃₋₁₀ carbocyclyl. In certain embodiments, Ring E is phenyl.

In certain embodiments, each R^{5c} is independently halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, haloalkyl, hydroxyalkyl, aminoalkyl, alkenyl, alkynyl, carbocyclyl, heterocyclyl, aryl, or heteroaryl is optionally substituted with one or more R^{u}.

In certain embodiments, each R^{5c} is independently halogen, C₁₋₆ alkyl, C₆₋₁₄ aryl, 5- to 14-membered heteroaryl, wherein the alkyl, aryl, or heteroaryl is optionally substituted with one or more R^{u}.

In certain embodiments, q is 0. In certain embodiments, q is 1. In certain embodiments, q is 2. In certain embodiments, q is 3. In certain embodiments, q is 4. In certain embodiments, q is 5. In certain embodiments, q is 6.

In certain embodiments, Z is —CH₂—, —O—, —C(═O)NR^{Z1}—, —C(═O)—, —CH₂C(═O)NR^{Z2}—, —CH₂CH₂C(═O)NR^{Z3}—, —CH₂CH₂(C═O)N(CH₂)₂CH—, —OCH₂C(═O)NR^{Z4}—, or —C(═O)CH₂C(═O)NR^{Z5}—.

In certain embodiments, each of R^{Z1}, R^{Z2}, R^{Z3}, R^{Z4}, and R^{Z5} is independently hydrogen. In certain embodiments, at least one of R^{Z1}, R^{Z2}, R^{Z3}, R^{Z4}, and R^{Z5} is hydrogen. In certain embodiments, at least two of R^{Z1}, R^{Z2}, R^{Z3}, R^{Z4}, and R^{Z5} are hydrogen. In certain embodiments, at least three of R^{Z1}, R^{Z2}, R^{Z3}, R^{Z4}, and R^{Z5} are hydrogen.

In certain embodiments, L is C₁₋₁₈ alkylene or C₁₋₁₂ heteroalkylene. In certain embodiments, L is -A-(CH₂)_{m′}—W—(CH₂)_{n′}—. In certain embodiments, L is —(CH₂)_{r′}—W—(CH₂)_{u′}—O—(CH₂)_{v′}—.

In certain embodiments, A is absent.

In certain embodiments, A is 5- to 10-membered heteroarylene; wherein the heteroarylene is optionally substituted with one or more R^{u}. In certain embodiments, A is 5-membered heteroarylene; wherein the heteroarylene is optionally substituted with one or more R^{u}. In certain embodiments, A is 6-membered heteroarylene; wherein the heteroarylene is optionally substituted with one or more R^{u}.

In certain embodiments, W is phenylene, 5- to 10-membered heteroarylene, 3- to 10-membered heterocyclylene, or C₃₋₁₀ carbocyclylene; wherein the phenylene, heteroarylene, heterocyclylene, or carbocyclylene is optionally substituted with one or more R^{u}.

In certain embodiments, W is phenylene, wherein the phenylene is optionally substituted with one or more R^{u}.

In certain embodiments, W is 5- to 10-membered heteroarylene, wherein the heteroarylene is optionally substituted with one or more R^{u}. In certain embodiments, W is 5-membered heteroarylene, wherein the heteroarylene is optionally substituted with one or more R^{u}. In certain embodiments, W is 6-membered heteroarylene, wherein the heteroarylene is optionally substituted with one or more R^{u}.

In certain embodiments, W is 3- to 10-membered heterocyclylene, wherein the heterocyclylene, is optionally substituted with one or more R^{u}. In certain embodiments, W is 4- to 6-membered heterocyclylene, wherein the heterocyclylene, is optionally substituted with one or more R^{u}. In certain embodiments, W is 4-membered heterocyclylene, wherein the heterocyclylene, is optionally substituted with one or more R^{u}. In certain embodiments, W is 5-membered heterocyclylene, wherein the heterocyclylene, is optionally substituted with one or more R^{u}. In certain embodiments, W is 6-membered heterocyclylene, wherein the heterocyclylene, is optionally substituted with one or more R^{u}.

In certain embodiments, W is C₃₋₁₀ carbocyclylene; wherein the carbocyclylene is optionally substituted with one or more R^{u}. In certain embodiments, W is C₃₋₆ carbocyclylene; wherein the carbocyclylene is optionally substituted with one or more R^{u}. In certain embodiments, W is C₅₋₆ carbocyclylene; wherein the carbocyclylene is optionally substituted with one or more R^{u}. In certain embodiments, W is C₃ carbocyclylene; wherein the carbocyclylene is optionally substituted with one or more R^{u}. In certain embodiments, W is C₄ carbocyclylene; wherein the carbocyclylene is optionally substituted with one or more R^{u}. In certain embodiments, W is C₅ carbocyclylene; wherein the carbocyclylene is optionally substituted with one or more R^{u}. In certain embodiments, W is C₆ carbocyclylene; wherein the carbocyclylene is optionally substituted with one or more R^{u}.

In certain embodiments, m′ is 0. In certain embodiments, m′ is 1. In certain embodiments, m′ is 2. In certain embodiments, m′ is 3. In certain embodiments, m′ is 4. In certain embodiments, m′ is 5. In certain embodiments, m′ is 6. In certain embodiments, m′ is 7.

In certain embodiments, n′ is 0. In certain embodiments, n′ is 1. In certain embodiments, n′ is 2. In certain embodiments, n′ is 3. In certain embodiments, n′ is 4. In certain embodiments, n′ is 5. In certain embodiments, n′ is 6. In certain embodiments, m′ is 7. In certain embodiments, n′ is 8.

In certain embodiments, r′ is 0. In certain embodiments, r′ is 1. In certain embodiments, r′ is 2. In certain embodiments, r′ is 3.

In certain embodiments, u′ is 0. In certain embodiments, u′ is 1. In certain embodiments, u′ is 2. In certain embodiments, u′ is 3.

In certain embodiments, v′ is 1. In certain embodiments, v′ is 2. In certain embodiments, v′ is 3. In certain embodiments, v′ is 4.

In certain embodiments, W is phenylene or 3- to 10-membered heterocyclylene. In certain embodiments, W is 6-membered heterocyclylene.

In certain embodiments, Y is —C≡C—, —CH═CH—, —CH₂—, —O—, —N(R^{Y1})—, —C(═O)—, —C(═O)N(R^{Y2})—, —N(R^{Y3})C(═O)CH₂O—, or —N(R^{Y3})C(═O)CH₂N(R^{Y4})—.

In certain embodiments, Y is —C≡C—, —N(R^{Y1})—, or —C(═O)—. In certain embodiments, Y is absent.

In certain embodiments, each of R^{Y1}, R^{Y2}, R^{Y3}, and R^{Y4} is hydrogen. In certain embodiments, at least one of R^{Y1}, R^{Y2}, R^{Y3}, and R^{Y4} is hydrogen. In certain embodiments, at least two of R^{Y1}, R^{Y2}, R^{Y3}, and R^{Y4} are hydrogen. In certain embodiments, at least three of R^{Y1}, R^{Y2}, R^{Y3}, and R^{Y4} are hydrogen.

In certain embodiments, B is

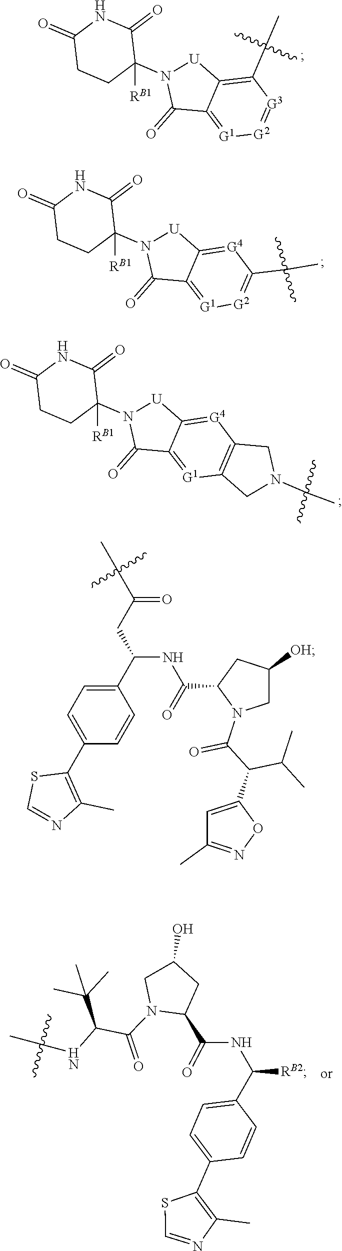

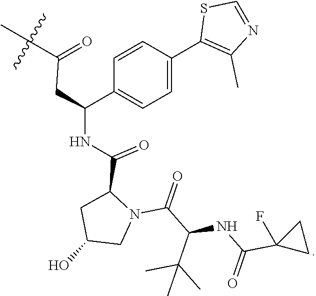 [SMILES: *C(=O)C[C@H](NC(=O)[C@@H]1C[C@@H](O)CN1C(=O)[C@@H](NC(=O)C1(F)CC1)C(C)(C)C)c1ccc(-c2scnc2C)cc1]

In certain embodiments, B is

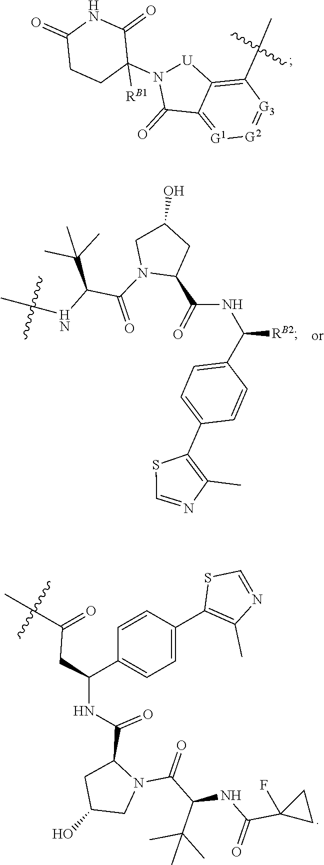

In certain embodiments, G¹, G², G³, and G⁴ are independently —C(R^{G})═ or —N═.

In certain embodiments, U is —CH₂— or —C(═O)—. In certain embodiments, U is —C(═O)—.

In certain embodiments, U is —CH₂—.

In certain embodiments, R^{B1} is hydrogen. In certain embodiments, R^{B1} is deuterium. In certain embodiments, R^{B1} is methyl. In certain embodiments, R^{B1} is fluoro.

In certain embodiments, R^{B2} is hydrogen or methyl. In certain embodiments, R^{B2} is methyl. In certain embodiments, R^{B2} is hydrogen.

In certain embodiments, each R^{G} is independently hydrogen, halogen, or C₁₋₄ alkyl. In certain embodiments, each R^{G} is independently hydrogen or halogen. In certain embodiments,
each R^{G} is independently hydrogen or C₁₋₄ alkyl.

In certain embodiments, each R^{G} is hydrogen. In certain embodiments, at least one R^{G} is hydrogen. In certain embodiments, at least two R^{G} are hydrogen. In certain embodiments, each R^{G} is halogen. In certain embodiments, at least one R^{G} is halogen. In certain embodiments, at least two R^{G} are halogen. In certain embodiments, each R^{G} is C₁₋₄ alkyl. In certain embodiments, at least one R^{G} is C₁₋₄ alkyl. In certain embodiments, at least two R^{G} are C₁₋₄ alkyl.

In certain embodiments, each R^{a} is independently C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), or 5- to 10-membered heteroaryl (e.g., heteroaryl comprising one or two 5- or 6-membered rings and 1-5 heteroatoms selected from N, O, and S), wherein the alkyl, alkenyl, alkynyl, carbocyclyl, heterocyclyl, aryl, or heteroaryl is optionally substituted with one or more R^{u}.

In certain embodiments, each R^{a} is independently C₁₋₆ alkyl, C₂₋₆ alkenyl, C₂₋₆ alkynyl, C₃₋₆ carbocyclyl, 3- to 6-membered heterocyclyl, C₆ aryl, or 5- to 6-membered heteroaryl.

In certain embodiments, each R^{a} is independently C₁₋₆ alkyl, C₂₋₆ alkenyl, C₂₋₆ alkynyl, C₃₋₆ carbocyclyl, or 3- to 6-membered heterocyclyl.

In certain embodiments, each R^{a} is independently C₁₋₆ alkyl, C₃₋₆ carbocyclyl, or 3- to 6-membered heterocyclyl, wherein the alkyl, carbocyclyl, or heterocyclyl is optionally substituted with one or more R^{u}.

In certain embodiments, each R^{b} is independently hydrogen, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), or 5- to 10-membered heteroaryl (e.g., heteroaryl comprising one or two 5- or 6-membered rings and 1-5 heteroatoms selected from N, O, and S), wherein the alkyl, alkenyl, alkynyl, carbocyclyl, heterocyclyl, aryl, or heteroaryl is optionally substituted with one or more R^{u}.

In certain embodiments, each R^{b} is independently hydrogen, C₁₋₆ alkyl, C₂₋₆ alkenyl, C₂₋₆ alkynyl, C₃₋₆ carbocyclyl, 3- to 6-membered heterocyclyl, C₆ aryl, or 5- to 6-membered heteroaryl.

In certain embodiments, each R^{b} is independently hydrogen, C₁₋₆ alkyl, C₂₋₆ alkenyl, C₂₋₆ alkynyl, C₃₋₆ carbocyclyl, or 3- to 6-membered heterocyclyl.

In certain embodiments, each R^{b} is independently hydrogen, C₁₋₆ alkyl, C₃₋₆ carbocyclyl, or 3- to 6-membered heterocyclyl, or C₂₋₆ alkynyl, wherein the alkyl, carbocyclyl, or heterocyclyl is optionally substituted with one or more R^{u}.

In certain embodiments, each R^{c} and each R^{d} is independently hydrogen, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, O, and S), C₆₋₁₀ aryl (e.g., phenyl or naphthyl), or 5- to 10-membered heteroaryl (e.g., heteroaryl comprising one or two 5- or 6-membered rings and 1-5 heteroatoms selected from N, O, and S), wherein the alkyl, alkenyl, alkynyl, carbocyclyl, heterocyclyl, aryl, or heteroaryl is optionally substituted with one or more R^{u}.

In certain embodiments, each R^{c} and each R^{d} is independently hydrogen, C₁₋₆ alkyl, C₃₋₆ carbocyclyl, or 3- to 6-membered heterocyclyl, wherein the alkyl, carbocyclyl, or heterocyclyl is optionally substituted with one or more R^{u}.

In certain embodiments, R^{c} and R^{d}, together with the nitrogen atom to which they are attached, form 3- to 12-membered heterocyclyl (e.g., heterocyclyl comprising one or two 3- to 8-membered rings and 1-5 heteroatoms selected from N, O, and S), wherein the heterocyclyl is optionally substituted with one or more R^{z}.

In certain embodiments, R^{a}, R^{b}, R^{c}, and R^{d} is independently and optionally substituted with one or more R^{z}.

In certain embodiments, R^{z} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl.

In certain embodiments, each R^{u} is independently oxo, halogen, —CN, —NO₂, —OH, —NH₂, C₁₋₆ alkyl (e.g., methyl (C₁), ethyl (C₂), n-propyl (C₃), i-propyl (C₃), n-butyl (C₄), i-butyl (C₄), s-butyl (C₄), t-butyl (C₄), pentyl (C₅), or hexyl (C₆)), C₁₋₆ alkoxy (e.g., methoxy (C₁), ethoxy (C₂), propoxy (C₃), i-propoxy (C₃), n-butoxy (C₄), i-butoxy (C₄), s-butoxy (C₄), t-butoxy (C₄), pentoxy (C₅), or hexoxy (C₆)), C₁₋₆ alkylamino (e.g., dimethylamino, diethylamino, di-n-propylamino, di-i-propylamino, di-n-butylamino, di-i-butylamino, di-s-butylamino, di-t-butylamino, dipentylamino, dihexylamino, methylethylamino, methyl-n-propylamino, methyl-i-propylamino, methyl-n-butylamino, methyl-1-butylamino, methyl-s-butylamino, methyl-t-butylamino, methylpentylamino, methylhexylamino, ethyl-n-propylamino, ethyl-1-propylamino, ethyl-n-butylamino, ethyl-s-butylamino, ethyl-1-butylamino, ethyl-t-butylamino, ethylpentylamino, ethylhexylamino, propyl-n-butylamino, propyl-1-butylamino, propyl-s-butylamino, propyl-t-butylamino, propylpentylylamino, propylhexylamino, n-butylpentylamino, i-butylpentylamino, s-butylpentylamino, t-butylpentylamino, n-butylhexylamino, i-butylhexylamino, s-butylhexylamino, t-butylhexylamino, or pentylhexylamino), C₂₋₆ alkenyl (e.g., ethenyl (C₂), 1-propenyl (C₃), 2-propenyl (C₃), 1-butenyl (C₄), 2-butenyl (C₄), butadienyl (C₄), pentenyl (C₅), pentadienyl (C₅), or hexenyl (C₆)), C₂₋₆ alkynyl (e.g., ethynyl (C₂), 1-propynyl (C₃), 2-propynyl (C₃), 1-butynyl (C₄), 2-butynyl (C₄), pentynyl (C₅), or hexynyl (C₆)), C₃₋₁₂ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), cyclononyl (C₉), cyclononenyl (C₉), cyclodecyl (C₁₀), cyclodecenyl (C₁₀), octahydro-1H-indenyl (C₉), decahydronaphthalenyl (C₁₀), or spiro[4.5]decanyl (C₁₀)), 3- to 12-membered heterocyclyl (e.g., heterocyclyl comprising one or two 3- to 8-membered rings and 1-5 heteroatoms selected from N, 0, and S), C₆₋₁₀ aryl (e.g., phenyl or naphthyl), 5- to 10-membered heteroaryl (e.g., heteroaryl comprising one or two 5- or 6-membered rings and 1-5 heteroatoms selected from N, O, and S), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}; wherein the alkyl, alkoxy, alkylamino, alkenyl, alkynyl, carbocyclyl, heterocyclyl, aryl, or heteroaryl is optionally substituted with one or more substituents selected from oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, and 3- to 6-membered heterocyclyl.

In certain embodiments, each R^{u} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl, wherein the alkyl, alkoxy, alkylamino, alkenyl, alkynyl, carbocyclyl, heterocyclyl, aryl, or heteroaryl is optionally substituted with one or more substituents selected from oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, and 3- to 6-membered heterocyclyl.

In certain embodiments, each R^{u} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, 3- to 6-membered heterocyclyl, C₆ aryl, or 5- to 6-membered heteroaryl, wherein the alkyl, alkoxy, alkylamino, alkenyl, alkynyl, carbocyclyl, heterocyclyl, aryl, or heteroaryl is optionally substituted with one or more substituents selected from oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, and 3- to 6-membered heterocyclyl.

In certain embodiments, each R^{u} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl, wherein the alkyl, alkoxy, alkylamino, alkenyl, alkynyl, carbocyclyl or heterocyclyl is optionally substituted with one or more substituents selected from oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, and 3- to 6-membered heterocyclyl.

In certain embodiments, each R^{u} is independently oxo, halogen, —CN, —NO₂, —OH, —NH₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl or heterocyclyl is optionally substituted with one or more substituents selected from oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, and 3- to 6-membered heterocyclyl.

In certain embodiments, two R^{u}, together with the carbon atom(s) to which they are attached, form C₃₋₆ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), or cyclohexadienyl (C₆)) or 3- to 6-membered heterocyclyl (e.g., heterocyclyl comprising one 3- to 6-membered ring and 1-3 heteroatoms selected from N, O, and S).

In certain embodiments, two geminal R^{u}, together with the carbon atom to which they are attached, form C₃₋₆ carbocyclyl (e.g., cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), or cyclohexadienyl (C₆)) or 3- to 6-membered heterocyclyl (e.g., heterocyclyl comprising one 3- to 6-membered ring and 1-3 heteroatoms selected from N, O, and S).

Embodiments of the variables in any of the Formulae described herein, e.g., Formulae I and I′, as applicable, are described below. Any of the variables can be any moiety as described in the embodiments below. In addition, the combination of any moieties described for any of the variables, as applicable, with any moieties described for any of the remaining variables, is also contemplated.

Without wishing to be limited by this statement, while various options for variables are described herein, it is understood that the present disclosure intends to encompass operable embodiments having combinations of the options. The disclosure may be interpreted as excluding the non-operable embodiments caused by certain combinations of the options.

When a range of values is listed, each discrete value and sub-range within the range are also contemplated. For example, “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

TABLE 1

| Cpd. | | |
|---|---|---|
| No. | Structure | Name |
| 1 | 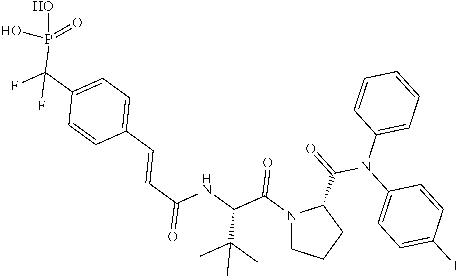 [SMILES: CC(C)(C)[C@H](NC(=O)/C=C/c1ccc(C(F)(F)P(=O)(O)O)cc1)C(=O)N1CCC[C@H]1C(=O)N(c1ccccc1)c1ccc(I)cc1] | (difluoro(4-((E)-3-(((S)-1-((S)-2- ((4- iodophenyl)(phenyl)carbamoyl) pyrrolidin-1-yl)-3,3-dimethyl-1- oxobutan-2-yl)amino)-3-oxoprop-1- en-1-yl)phenyl)methyl)phosphonic acid |
| 2 | 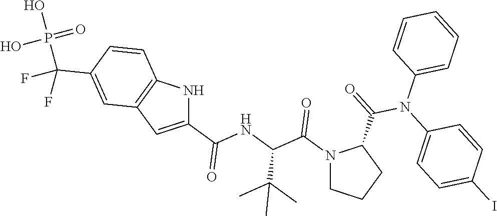 [SMILES: CC(C)(C)[C@H](NC(=O)c1cc2cc(C(F)(F)P(=O)(O)O)ccc2[nH]1)C(=O)N1CCC[C@H]1C(=O)N(c1ccccc1)c1ccc(I)cc1] | (difluoro(2-(((S)-1-((S)-2-((4- iodophenyl)(phenyl)carbamoyl) pyrrolidin-1-yl)-3,3-dimethyl-1- oxobutan-2-yl)carbamoyl)-1H- indol-5-yl)methyl)phosphonic acid |
| 3 | 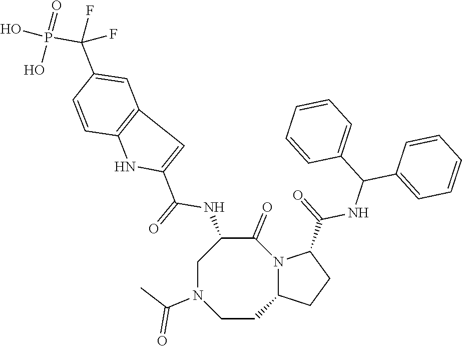 [SMILES: CC(=O)N1CC[C@H]2CC[C@@H](C(=O)NC(c3ccccc3)c3ccccc3)N2C(=O)[C@@H](NC(=O)c2cc3cc(C(F)(F)P(=O)(O)O)ccc3[nH]2)C1] | ((2-(((5S,8S,10aR)-3-acetyl-8- (benzhydrylcarbamoyl)-6- oxodecahydropyrrolo[1,2- a][1,5]diazocin-5-yl)carbamoyl)- 1H-indol-5- yl)difluoromethyl)phosphonic acid |
| 4 | 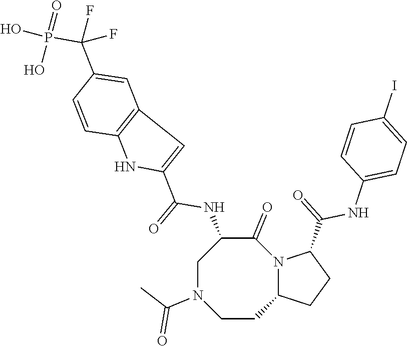 [SMILES: CC(=O)N1CC[C@H]2CC[C@@H](C(=O)Nc3ccc(I)cc3)N2C(=O)[C@@H](NC(=O)c2cc3cc(C(F)(F)P(=O)(O)O)ccc3[nH]2)C1] | ((3-(((5S,8S,10aR)-3-acetyl-8-((4- iodophenyl)carbamoyl)-6- oxodecahydropyrrolo[1,2- a][1,5]diazocin-5-yl)carbamoyl)- 1H-indol-5- yl)difluoromethyl)phosphonic acid |
| 5 | 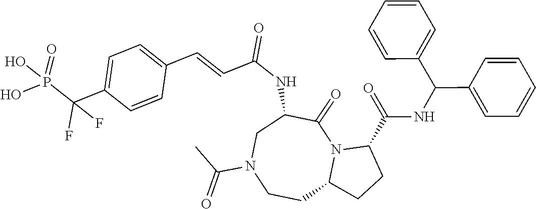 [SMILES: CC(=O)N1CC[C@H]2CC[C@@H](C(=O)NC(c3ccccc3)c3ccccc3)N2C(=O)[C@@H](NC(=O)/C=C/c2ccc(C(F)(F)P(=O)(O)O)cc2)C1] | ((4-((E)-3-(((5S,8S,10aR)-3-acetyl- 8-(benzhydrylcarbamoyl)-6- oxodecahydropyrrolo[1,2- a][1,5]diazocin-5-yl)amino)-3- oxoprop-1-en-1- yl)phenyl)difluoromethyl)phosphonic acid |
| 6 | 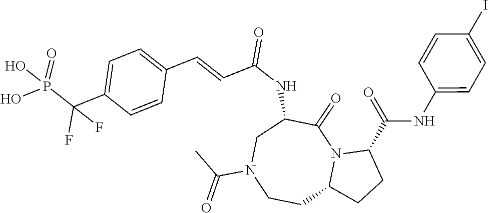 [SMILES: CC(=O)N1CC[C@H]2CC[C@@H](C(=O)Nc3ccc(I)cc3)N2C(=O)[C@@H](NC(=O)/C=C/c2ccc(C(F)(F)P(=O)(O)O)cc2)C1] | ((4-((E)-3-(((5S,8S,10aR)-3-acetyl- 8-((4-iodophenyl)carbamoyl)-6- oxodecahydropyrrolo[1,2- a][1,5]diazocin-5-yl)amino)-3- oxoprop-1-en-1- yl)phenyl)difluoromethyl)phosphonic acid |
| 7 | 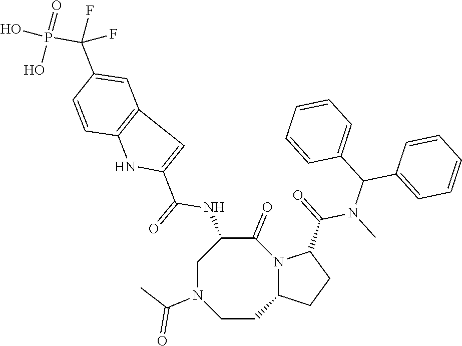 | ((2-(((5S,8S,10aR)-3-acetyl-8- (benzhydryl(methyl)carbamoyl)-6- oxodecahydropyrrolo[1,2- a][1,5]diazocin-5-yl)carbamoyl)- 1H-indol-5- yl)difluoromethyl)phosphonic acid |
| 8 | 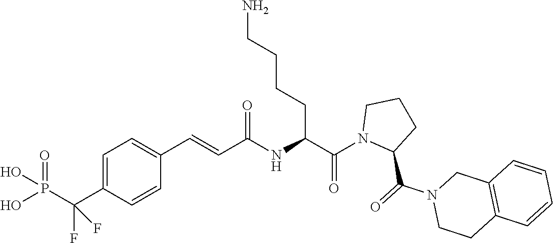 [SMILES: NCCCC[C@H](NC(=O)/C=C/c1ccc(C(F)(F)P(=O)(O)O)cc1)C(=O)N1CCC[C@H]1C(=O)N1CCc2ccccc2C1] | ((4-((E)-3-(((S)-6-amino-1-oxo-1- ((S)-2-(1,2,3,4- tetrahydroisoquinoline-2- carbonyl)pyrrolidin-1-yl)hexan-2- yl)amino)-3-oxoprop-1-en-1- yl)phenyl)difluoromethyl)phosphonic acid |
| 9 | 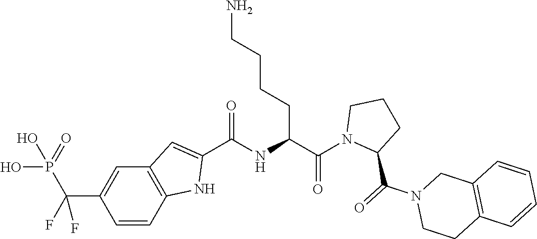 [SMILES: NCCCC[C@H](NC(=O)c1cc2cc(C(F)(F)P(=O)(O)O)ccc2[nH]1)C(=O)N1CCC[C@H]1C(=O)N1CCc2ccccc2C1] | ((2-(((S)-6-amino-1-oxo-1-((S)-2- (1,2,3,4-tetrahydroisoquinoline-2- carbonyl)pyrrolidin-1-yl)hexan-2- yl)carbamoyl)-1H-indol-5- yl)difluoromethyl)phosphonic acid |
| 10 | 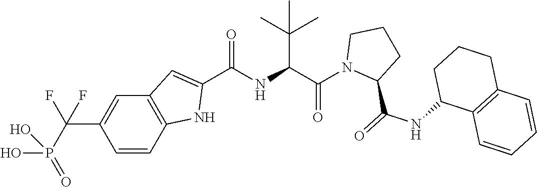 | ((2-(((S)-3,3-dimethyl-1-oxo-1-((S)- 2-(((R)-1,2,3,4- tetrahydronaphthalen-1- yl)carbamoyl)pyrrolidin-1-yl)butan- 2-yl)carbamoyl)-1H-indol-5- yl)difluoromethyl)phosphonic acid |
| 11 | 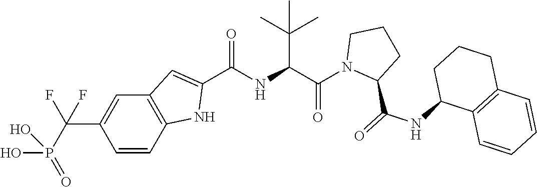 [SMILES: CC(C)(C)[C@H](NC(=O)c1cc2cc(C(F)(F)P(=O)(O)O)ccc2[nH]1)C(=O)N1CCC[C@H]1C(=O)N[C@H]1CCCc2ccccc21] | ((2-(((S)-3,3-dimethyl-1-oxo-1-((S)- 2-(((S)-1,2,3,4- tetrahydronaphthalen-1- yl)carbamoyl)pyrrolidin-1-yl)butan- 2-yl)carbamoyl)-1H-indol-5- yl)difluoromethyl)phosphonic acid |
| 12 | 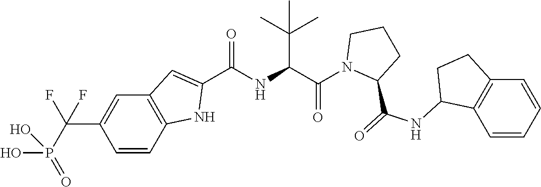 [SMILES: CC(C)(C)[C@H](NC(=O)c1cc2cc(C(F)(F)P(=O)(O)O)ccc2[nH]1)C(=O)N1CCC[C@H]1C(=O)NC1CCc2ccccc21] | ((2-(((2S)-1-((2S)-2-((2,3-dihydro- 1H-inden-1- yl)carbamoyl)pyrrolidin-1-yl)-3,3- dimethyl-1-oxobutan-2- yl)carbamoyl)-1H-indol-5- yl)difluoromethyl)phosphonic acid |
| 13 | 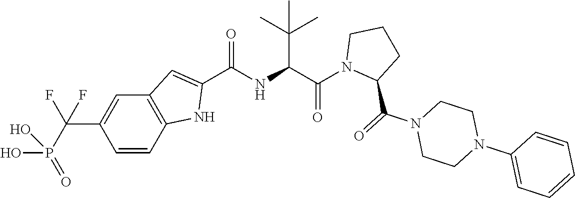 [SMILES: CC(C)(C)[C@H](NC(=O)c1cc2cc(C(F)(F)P(=O)(O)O)ccc2[nH]1)C(=O)N1CCC[C@H]1C(=O)N1CCN(c2ccccc2)CC1] | ((2-(((S)-3,3-dimethyl-1-oxo-1-((S)- 2-(4-phenylpiperazine-1- carbonyl)pyrrolidin-1-yl)butan-2- yl)carbamoyl)-1H-indol-5- yl)difluoromethyl)phosphonic acid |
| 14 | 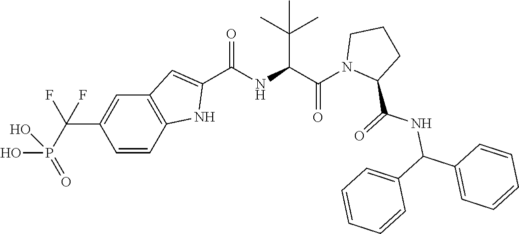 [SMILES: CC(C)(C)[C@H](NC(=O)c1cc2cc(C(F)(F)P(=O)(O)O)ccc2[nH]1)C(=O)N1CCC[C@H]1C(=O)NC(c1ccccc1)c1ccccc1] | ((2-(((S)-1-((S)-2- (benzhydrylcarbamoyl)pyrrolidin-1- yl)-3,3-dimethyl-1-oxobutan-2- yl)carbamoyl)-1H-indol-5- yl)difluoromethyl)phosphonic acid |
| 15 | 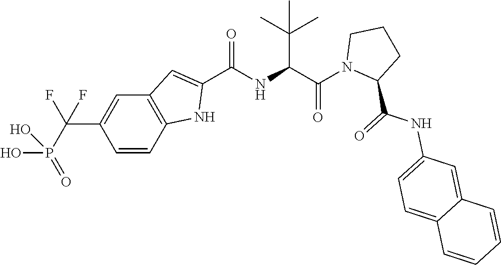 [SMILES: CC(C)(C)[C@H](NC(=O)c1cc2cc(C(F)(F)P(=O)(O)O)ccc2[nH]1)C(=O)N1CCC[C@H]1C(=O)Nc1ccc2ccccc2c1] | ((2-(((S)-3,3-dimethyl-1-((S)-2- (naphthalen-2- ylcarbamoyl)pyrrolidin-1-yl)-1- oxobutan-2-yl)carbamoyl)-1H- indol-5- yl)difluoromethyl)phosphonic acid |
| 16 | 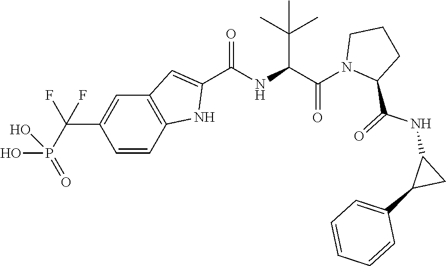 | ((2-(((S)-3,3-dimethyl-1-oxo-1-((S)- 2-(((1R,2S)-2- phenylcyclopropyl)carbamoyl) pyrrolidin-1-yl)butan-2-yl)carbamoyl)- 1H-indol-5- yl)difluoromethyl)phosphonic acid |
| 17 | 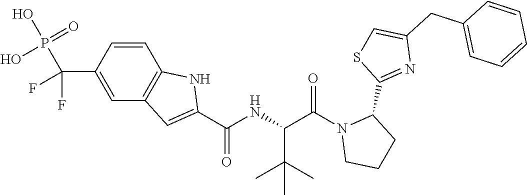 [SMILES: CC(C)(C)[C@H](NC(=O)c1cc2cc(C(F)(F)P(=O)(O)O)ccc2[nH]1)C(=O)N1CCC[C@H]1c1nc(Cc2ccccc2)cs1] | ((2-(((S)-1-((S)-2-(4-benzylthiazol- 2-yl)pyrrolidin-1-yl)-3,3-dimethyl- 1-oxobutan-2-yl)carbamoyl)-1H- indol-5- yl)difluoromethyl)phosphonic acid |
| 18 | 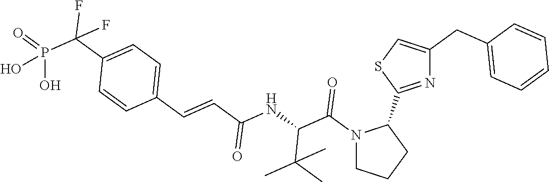 [SMILES: CC(C)(C)[C@H](NC(=O)/C=C/c1ccc(C(F)(F)P(=O)(O)O)cc1)C(=O)N1CCC[C@H]1c1nc(Cc2ccccc2)cs1] | ((4-((E)-3-(((S)-1-((S)-2-(4- benzylthiazol-2-yl)pyrrolidin-1-yl)- 3,3-dimethyl-1-oxobutan-2- yl)amino)-3-oxoprop-1-en-1- yl)phenyl)difluoromethyl)phosphonic acid |
| 19 | 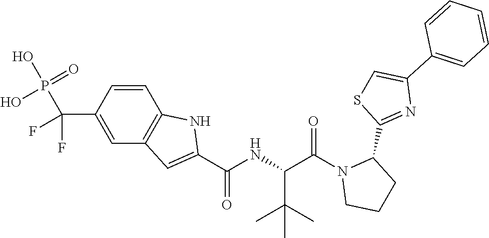 [SMILES: CC(C)(C)[C@H](NC(=O)c1cc2cc(C(F)(F)P(=O)(O)O)ccc2[nH]1)C(=O)N1CCC[C@H]1c1nc(-c2ccccc2)cs1] | ((2-(((S)-3,3-dimethyl-1-oxo-1-((S)- 2-(4-phenylthiazol-2-yl)pyrrolidin- 1-yl)butan-2-yl)carbamoyl)-1H- indol-5- yl)difluoromethyl)phosphonic acid |
| 20 | 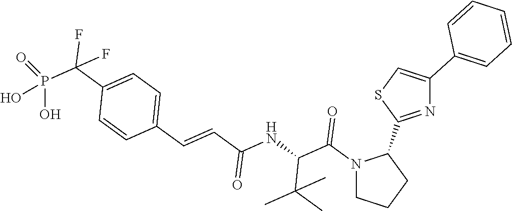 [SMILES: CC(C)(C)[C@H](NC(=O)/C=C/c1ccc(C(F)(F)P(=O)(O)O)cc1)C(=O)N1CCC[C@H]1c1nc(-c2ccccc2)cs1] | ((4-((E)-3-(((S)-3,3-dimethyl-1-oxo- 1-((S)-2-(4-phenylthiazol-2- yl)pyrrolidin-1-yl)butan-2- yl)amino)-3-oxoprop-1-en-1- yl)phenyl)difluoromethyl)phosphonic acid |
| 21 | 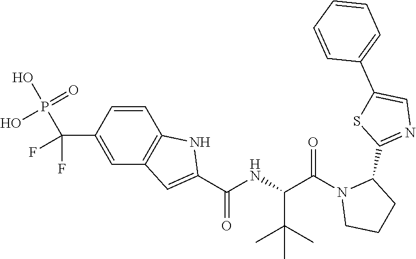 [SMILES: CC(C)(C)[C@H](NC(=O)c1cc2cc(C(F)(F)P(=O)(O)O)ccc2[nH]1)C(=O)N1CCC[C@H]1c1ncc(-c2ccccc2)s1] | ((2-(((S)-3,3-dimethyl-1-oxo-1-((S)- 2-(5-phenylthiazol-2-yl)pyrrolidin- 1-yl)butan-2-yl)carbamoyl)-1H- indol-5- yl)difluoromethyl)phosphonic acid |
| 22 | 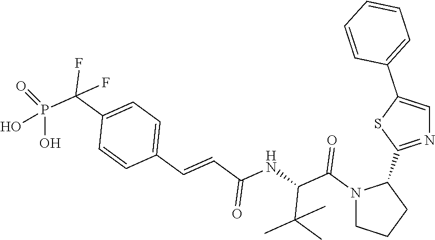 [SMILES: CC(C)(C)[C@H](NC(=O)/C=C/c1ccc(C(F)(F)P(=O)(O)O)cc1)C(=O)N1CCC[C@H]1c1ncc(-c2ccccc2)s1] | ((4-((E)-3-(((S)-3,3-dimethyl-1-oxo- 1-((S)-2-(5-phenylthiazol-2- yl)pyrrolidin-1-yl)butan-2- yl)amino)-3-oxoprop-1-en-1- yl)phenyl)difluoromethyl)phosphonic acid |
| 23 | 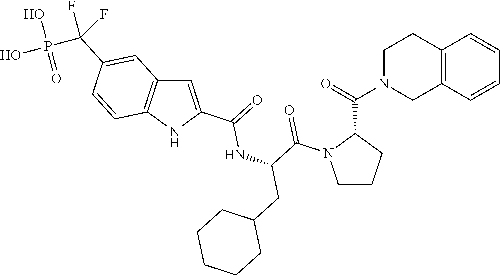 [SMILES: O=C(N[C@@H](CC1CCCCC1)C(=O)N1CCC[C@H]1C(=O)N1CCc2ccccc2C1)c1cc2cc(C(F)(F)P(=O)(O)O)ccc2[nH]1] | ((2-(((S)-3-cyclohexyl-1-oxo-1-((S)- 2-(1,2,3,4-tetrahydroisoquinoline-2- carbonyl)pyrrolidin-1-yl)propan-2- yl)carbamoyl)-1H-indol-5- yl)difluoromethyl)phosphonic acid |
| 24 | 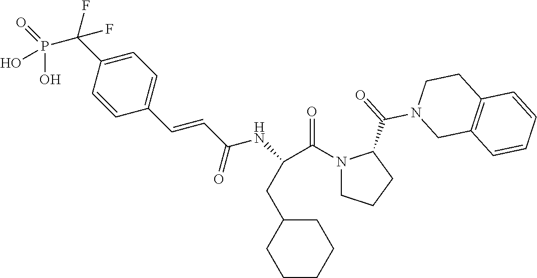 [SMILES: O=C(/C=C/c1ccc(C(F)(F)P(=O)(O)O)cc1)N[C@@H](CC1CCCCC1)C(=O)N1CCC[C@H]1C(=O)N1CCc2ccccc2C1] | ((4-((E)-3-(((S)-3-cyclohexyl-1-oxo- 1-((S)-2-(1,2,3,4- tetrahydroisoquinoline-2- carbonyl)pyrrolidin-1-yl)propan-2- yl)amino)-3-oxoprop-1-en-1- yl)phenyl)difluoromethyl)phosphonic acid |
| 25 | 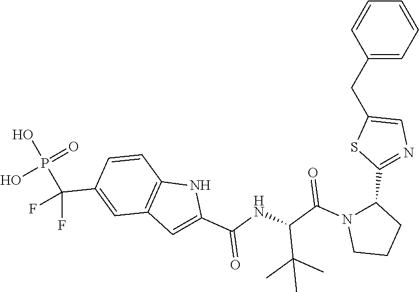 [SMILES: CC(C)(C)[C@H](NC(=O)c1cc2cc(C(F)(F)P(=O)(O)O)ccc2[nH]1)C(=O)N1CCC[C@H]1c1ncc(Cc2ccccc2)s1] | ((2-(((S)-1-((S)-2-(5-benzylthiazol- 2-yl)pyrrolidin-1-yl)-3,3-dimethyl- 1-oxobutan-2-yl)carbamoyl)-1H- indol-5- yl)difluoromethyl)phosphonic acid |
| 26 | 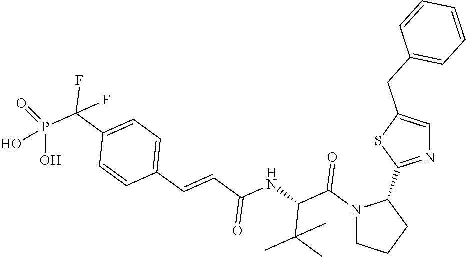 [SMILES: CC(C)(C)[C@H](NC(=O)/C=C/c1ccc(C(F)(F)P(=O)(O)O)cc1)C(=O)N1CCC[C@H]1c1ncc(Cc2ccccc2)s1] | ((4-((E)-3-(((S)-1-((S)-2-(5- benzylthiazol-2-yl)pyrrolidin-1-yl)- 3,3-dimethyl-1-oxobutan-2- yl)amino)-3-oxoprop-1-en-1- yl)phenyl)difluoromethyl)phosphonic acid |
| 27 | 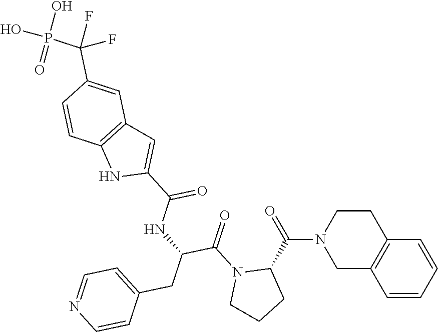 [SMILES: O=C(N[C@@H](Cc1ccncc1)C(=O)N1CCC[C@H]1C(=O)N1CCc2ccccc2C1)c1cc2cc(C(F)(F)P(=O)(O)O)ccc2[nH]1] | (difluoro(2-(((S)-1-oxo-3-(pyridin- 4-yl)-1-((S)-2-(1,2,3,4- tetrahydroisoquinoline-2- carbonyl)pyrrolidin-1-yl)propan-2- yl)carbamoyl)-1H-indol-5- yl)methyl)phosphonic acid |
| 28 | 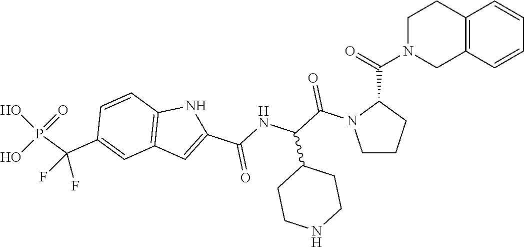 [SMILES: O=C(NC(C(=O)N1CCC[C@H]1C(=O)N1CCc2ccccc2C1)C1CCNCC1)c1cc2cc(C(F)(F)P(=O)(O)O)ccc2[nH]1] | (difluoro(2-((2-oxo-1-(piperidin-4- yl)-2-((S)-2-(1,2,3,4- tetrahydroisoquinoline-2- carbonyl)pyrrolidin-1- yl)ethyl)carbamoyl)-1H-indol-5- yl)methyl)phosphonic acid |
| 29 | 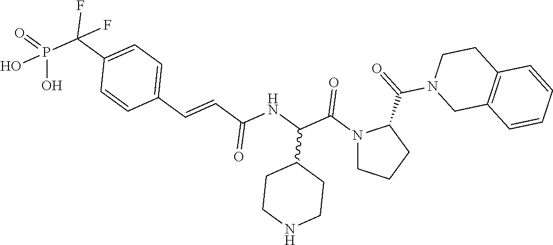 [SMILES: O=C(/C=C/c1ccc(C(F)(F)P(=O)(O)O)cc1)NC(C(=O)N1CCC[C@H]1C(=O)N1CCc2ccccc2C1)C1CCNCC1] | (difluoro(4-((E)-3-oxo-3-((2-oxo-1- (piperidin-4-yl)-2-((S)-2-(1,2,3,4- tetrahydroisoquinoline-2- carbonyl)pyrrolidin-1- yl)ethyl)amino)prop-1-en-1- yl)phenyl)methyl)phosphonic acid |
| 30 | 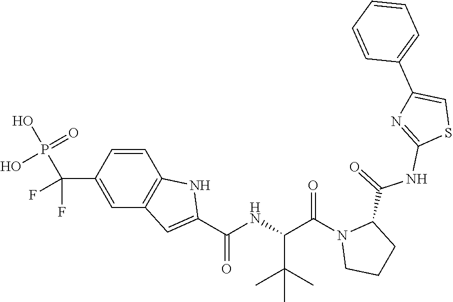 [SMILES: CC(C)(C)[C@H](NC(=O)c1cc2cc(C(F)(F)P(=O)(O)O)ccc2[nH]1)C(=O)N1CCC[C@H]1C(=O)Nc1nc(-c2ccccc2)cs1] | ((2-(((S)-3,3-dimethyl-1-oxo-1-((S)- 2-((4-phenylthiazol-2- yl)carbamoyl)pyrrolidin-1-yl)butan- 2-yl)carbamoyl)-1H-indol-5- yl)difluoromethyl)phosphonic acid |
| 31 | 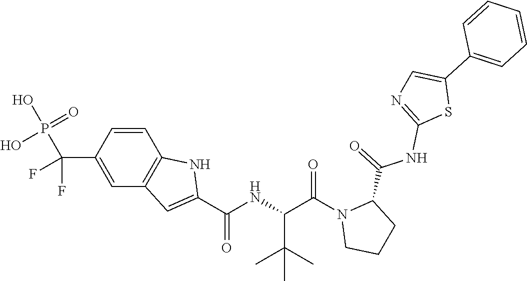 [SMILES: CC(C)(C)[C@H](NC(=O)c1cc2cc(C(F)(F)P(=O)(O)O)ccc2[nH]1)C(=O)N1CCC[C@H]1C(=O)Nc1ncc(-c2ccccc2)s1] | ((2-(((S)-3,3-dimethyl-1-oxo-1-((S)- 2-((5-phenylthiazol-2- yl)carbamoyl)pyrrolidin-1-yl)butan- 2-yl)carbamoyl)-1H-indol-5- yl)difluoromethyl)phosphonic acid |
| 32 | 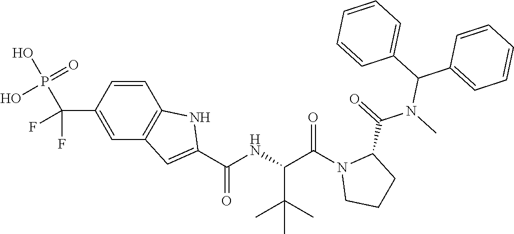 [SMILES: CN(C(=O)[C@@H]1CCCN1C(=O)[C@@H](NC(=O)c1cc2cc(C(F)(F)P(=O)(O)O)ccc2[nH]1)C(C)(C)C)C(c1ccccc1)c1ccccc1] | ((2-(((S)-1-((S)-2- (benzhydryl(methyl)carbamoyl) pyrrolidin-1-yl)-3,3-dimethyl-1- oxobutan-2-yl)carbamoyl)-1H- indol-5- yl)difluoromethyl)phosphonic acid |
| 33 | 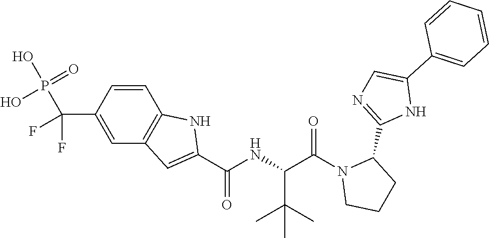 [SMILES: CC(C)(C)[C@H](NC(=O)c1cc2cc(C(F)(F)P(=O)(O)O)ccc2[nH]1)C(=O)N1CCC[C@H]1c1ncc(-c2ccccc2)[nH]1] | ((2-(((S)-3,3-dimethyl-1-oxo-1-((S)- 2-(5-phenyl-1H-imidazol-2- yl)pyrrolidin-1-yl)butan-2- yl)carbamoyl)-1H-indol-5- yl)difluoromethyl)phosphonic acid |
| 34 | 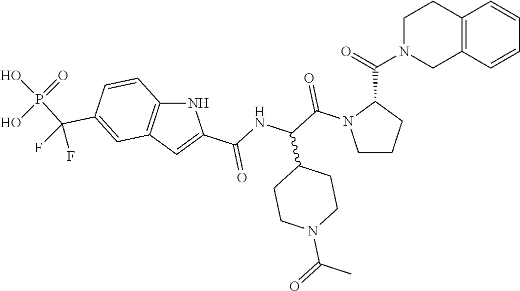 [SMILES: CC(=O)N1CCC(C(NC(=O)c2cc3cc(C(F)(F)P(=O)(O)O)ccc3[nH]2)C(=O)N2CCC[C@H]2C(=O)N2CCc3ccccc3C2)CC1] | ((2-((1-(1-acetylpiperidin-4-yl)-2- oxo-2-((S)-2-(1,2,3,4- tetrahydroisoquinoline-2- carbonyl)pyrrolidin-1- yl)ethyl)carbamoyl)-1H-indol-5- yl)difluoromethyl)phosphonic acid |
| 35 | 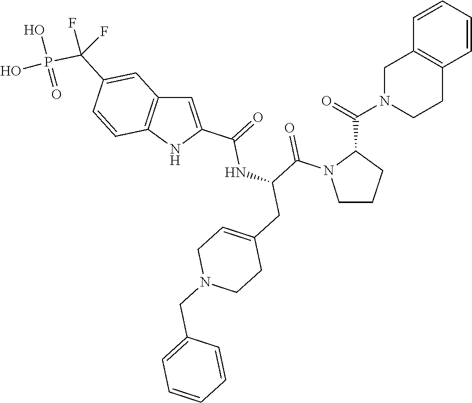 [SMILES: O=C(N[C@@H](CC1=CCN(Cc2ccccc2)CC1)C(=O)N1CCC[C@H]1C(=O)N1CCc2ccccc2C1)c1cc2cc(C(F)(F)P(=O)(O)O)ccc2[nH]1] | ((2-(((S)-3-(1-benzyl-1,2,3,6- tetrahydropyridin-4-yl)-1-oxo-1- ((S)-2-(1,2,3,4- tetrahydroisoquinoline-2- carbonyl)pyrrolidin-1-yl)propan-2- yl)carbamoyl)-1H-indol-5- yl)difluoromethyl)phosphonic acid |
| 36 | 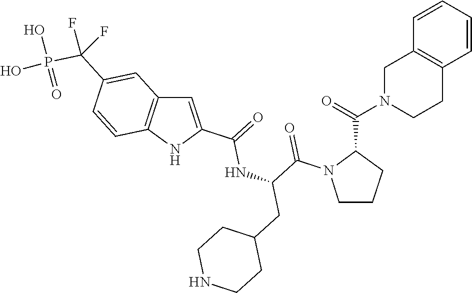 [SMILES: O=C(N[C@@H](CC1CCNCC1)C(=O)N1CCC[C@H]1C(=O)N1CCc2ccccc2C1)c1cc2cc(C(F)(F)P(=O)(O)O)ccc2[nH]1] | (difluoro(2-(((S)-1-oxo-3-(piperidin- 4-yl)-1-((S)-2-(1,2,3,4- tetrahydroisoquinoline-2- carbonyl)pyrrolidin-1-yl)propan-2- yl)carbamoyl)-1H-indol-5- yl)methyl)phosphonic acid |
| 37 | 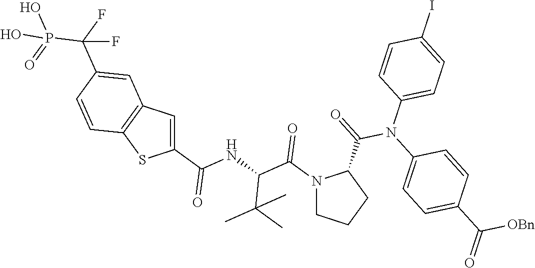 [SMILES: CC(C)(C)[C@H](NC(=O)c1cc2cc(C(F)(F)P(=O)(O)O)ccc2s1)C(=O)N1CCC[C@H]1C(=O)N(c1ccc(I)cc1)c1ccc(C(=O)OCc2ccccc2)cc1] | ((2-(((S)-1-((S)-2-((4- ((benzyloxy)carbonyl)phenyl)(4- iodophenyl)carbamoyl)pyrrolidin-1- yl)-3,3-dimethyl-1-oxobutan-2- yl)carbamoyl)benzo[b]thiophen-5- yl)difluoromethyl)phosphonic acid |
| 38 | 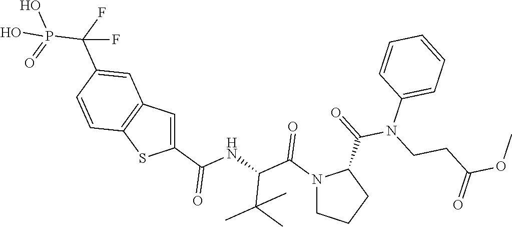 [SMILES: COC(=O)CCN(C(=O)[C@@H]1CCCN1C(=O)[C@@H](NC(=O)c1cc2cc(C(F)(F)P(=O)(O)O)ccc2s1)C(C)(C)C)c1ccccc1] | (difluoro(2-(((S)-1-((S)-2-((3- methoxy-3- oxopropyl)(phenyl)carbamoyl) pyrrolidin-1-yl)-3,3-dimethyl-1- oxobutan-2- yl)carbamoyl)benzo[b]thiophen-5- yl)methyl)phosphonic acid |
| 39 | 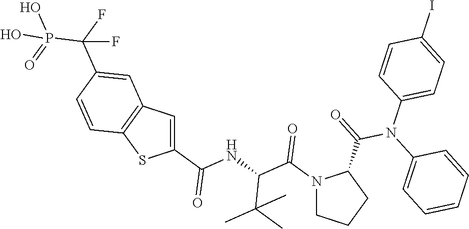 [SMILES: CC(C)(C)[C@H](NC(=O)c1cc2cc(C(F)(F)P(=O)(O)O)ccc2s1)C(=O)N1CCC[C@H]1C(=O)N(c1ccccc1)c1ccc(I)cc1] | (difluoro(2-(((S)-1-((S)-2-((4- iodophenyl)(phenyl)carbamoyl) pyrrolidin-1-yl)-3,3-dimethyl-1- oxobutan-2- yl)carbamoyl)benzo[b]thiophen-5- yl)methyl)phosphonic acid |
| 40 | 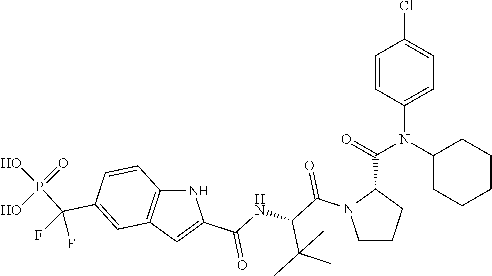 [SMILES: CC(C)(C)[C@H](NC(=O)c1cc2cc(C(F)(F)P(=O)(O)O)ccc2[nH]1)C(=O)N1CCC[C@H]1C(=O)N(c1ccc(Cl)cc1)C1CCCCC1] | ((2-(((S)-1-((S)-2-((4- chlorophenyl)(cyclohexyl)carbamoyl) pyrrolidin-1-yl)-3,3-dimethyl-1- oxobutan-2-yl)carbamoyl)-1H- indol-5- yl)difluoromethyl)phosphonic acid |
| 41 | 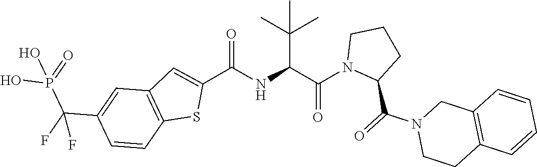 [SMILES: CC(C)(C)[C@H](NC(=O)c1cc2cc(C(F)(F)P(=O)(O)O)ccc2s1)C(=O)N1CCC[C@H]1C(=O)N1CCc2ccccc2C1] | ((2-(((S)-3,3-dimethyl-1-oxo-1-((S)- 2-(1,2,3,4-tetrahydroisoquinoline-2- carbonyl)pyrrolidin-1-yl)butan-2- yl)carbamoyl)benzo[b]thiophen-5- yl)difluoromethyl)phosphonic acid |
| 42 | 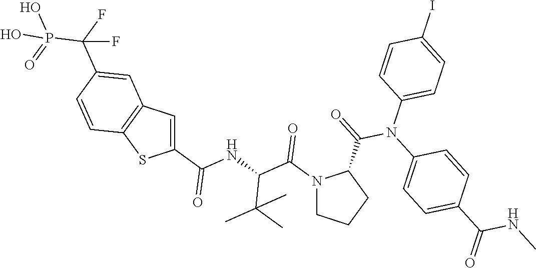 [SMILES: CNC(=O)c1ccc(N(C(=O)[C@@H]2CCCN2C(=O)[C@@H](NC(=O)c2cc3cc(C(F)(F)P(=O)(O)O)ccc3s2)C(C)(C)C)c2ccc(I)cc2)cc1] | (difluoro(2-(((S)-1-((S)-2-((4- iodophenyl)(4- (methylcarbamoyl)phenyl)carbamoyl) pyrrolidin-1-yl)-3,3-dimethyl-1- oxobutan-2- yl)carbamoyl)benzo[b]thiophen-5- yl)methyl)phosphonic acid |
| 43 | 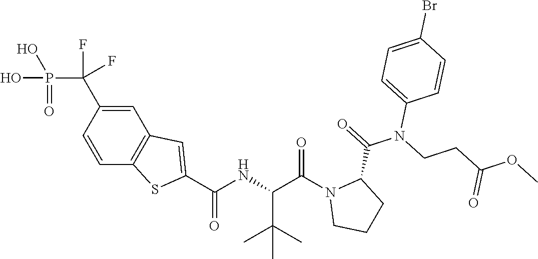 [SMILES: COC(=O)CCN(C(=O)[C@@H]1CCCN1C(=O)[C@@H](NC(=O)c1cc2cc(C(F)(F)P(=O)(O)O)ccc2s1)C(C)(C)C)c1ccc(Br)cc1] | N-((3R,6S,9S,12R)-6-ethyl-12- methyl-2,5,8,11-tetraoxo-3-phenyl- 9-((pyridin-2-ylamino)methyl)- 1,4,7,10-tetraazacyclotetradecan-12- yl)isobutyramide |
| 44 | 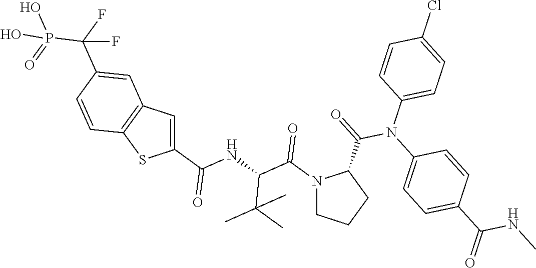 [SMILES: CNC(=O)c1ccc(N(C(=O)[C@@H]2CCCN2C(=O)[C@@H](NC(=O)c2cc3cc(C(F)(F)P(=O)(O)O)ccc3s2)C(C)(C)C)c2ccc(Cl)cc2)cc1] | ((2-(((S)-1-((S)-2-((4- chlorophenyl)(4- (methylcarbamoyl)phenyl)carbamoyl) pyrrolidin-1-yl)-3,3-dimethyl-1- oxobutan-2- yl)carbamoyl)benzo[b]thiophen-5- yl)difluoromethyl)phosphonic acid |
| 45 | 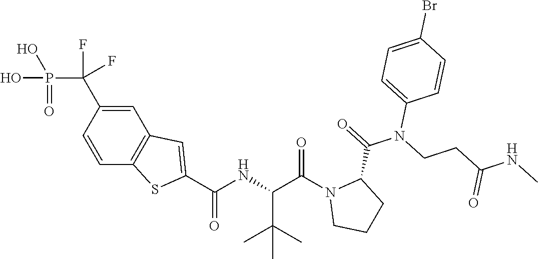 [SMILES: CNC(=O)CCN(C(=O)[C@@H]1CCCN1C(=O)[C@@H](NC(=O)c1cc2cc(C(F)(F)P(=O)(O)O)ccc2s1)C(C)(C)C)c1ccc(Br)cc1] | ((2-(((S)-1-((S)-2-((4- bromophenyl)(3-(methylamino)-3- oxopropyl)carbamoyl)pyrrolidin-1- yl)-3,3-dimethyl-1-oxobutan-2- yl)carbamoyl)benzo[b]thiophen-5- yl)difluoromethyl)phosphonic acid |
| 46 | 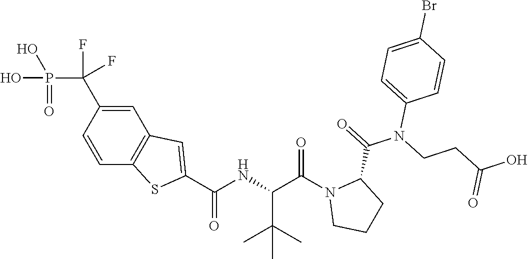 [SMILES: CC(C)(C)[C@H](NC(=O)c1cc2cc(C(F)(F)P(=O)(O)O)ccc2s1)C(=O)N1CCC[C@H]1C(=O)N(CCC(=O)O)c1ccc(Br)cc1] | 3-((S)-N-(4-bromophenyl)-1-((S)-2- (5- (difluoro(phosphono)methyl)benzo [b]thiophene-2-carboxamido)-3,3- dimethylbutanoyl)pyrrolidine-2- carboxamido)propanoic acid |
| 47 | 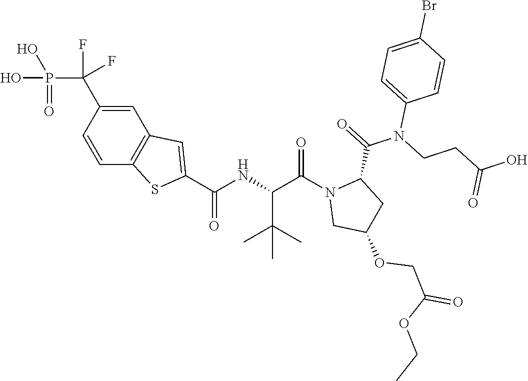 [SMILES: CCOC(=O)CO[C@H]1C[C@@H](C(=O)N(CCC(=O)O)c2ccc(Br)cc2)N(C(=O)[C@@H](NC(=O)c2cc3cc(C(F)(F)P(=O)(O)O)ccc3s2)C(C)(C)C)C1] | 3-((2S,4S)-N-(4-bromophenyl)-1- ((S)-2-(5- (difluoro(phosphono)methyl)benzo [b]thiophene-2-carboxamido)-3,3- dimethylbutanoyl)-4-(2-ethoxy-2- oxoethoxy)pyrrolidine-2- carboxamido)propanoic acid |
| 48 | 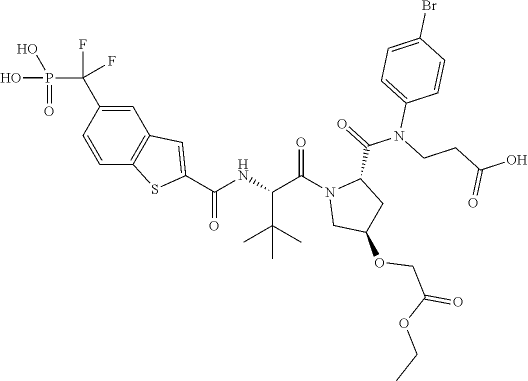 [SMILES: CCOC(=O)CO[C@@H]1C[C@@H](C(=O)N(CCC(=O)O)c2ccc(Br)cc2)N(C(=O)[C@@H](NC(=O)c2cc3cc(C(F)(F)P(=O)(O)O)ccc3s2)C(C)(C)C)C1] | 3-((2S,4R)-N-(4-bromophenyl)-1- ((S)-2-(5- (difluoro(phosphono)methyl)benzo [b]thiophene-2-carboxamido)-3,3- dimethylbutanoyl)-4-(2-ethoxy-2- oxoethoxy)pyrrolidine-2- carboxamido)propanoic acid |
| 49 | 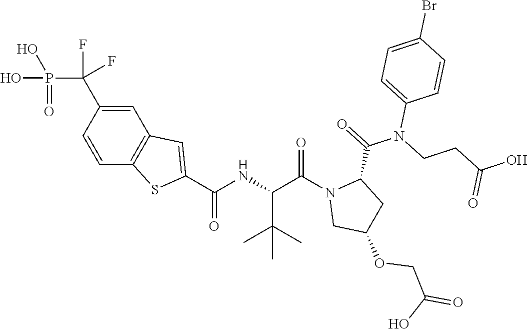 [SMILES: CC(C)(C)[C@H](NC(=O)c1cc2cc(C(F)(F)P(=O)(O)O)ccc2s1)C(=O)N1C[C@@H](OCC(=O)O)C[C@H]1C(=O)N(CCC(=O)O)c1ccc(Br)cc1] | 3-((2S,4S)-N-(4-bromophenyl)-4- (carboxymethoxy)-1-((S)-2-(5- (difluoro(phosphono)methyl)benzo [b]thiophene-2-carboxamido)-3,3- dimethylbutanoyl)pyrrolidine-2- carboxamido)propanoic acid |
| 50 | 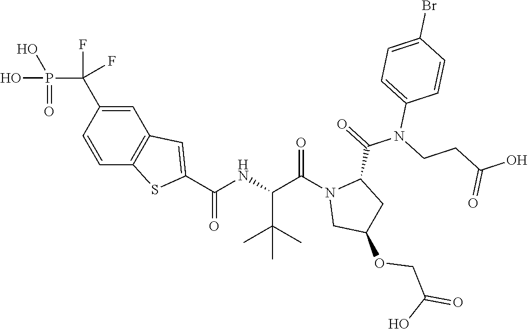 [SMILES: CC(C)(C)[C@H](NC(=O)c1cc2cc(C(F)(F)P(=O)(O)O)ccc2s1)C(=O)N1C[C@H](OCC(=O)O)C[C@H]1C(=O)N(CCC(=O)O)c1ccc(Br)cc1] | 3-((2S,4R)-N-(4-bromophenyl)-4- (carboxymethoxy)-1-((S)-2-(5- (difluoro(phosphono)methyl)benzo [b]thiophene-2-carboxamido)-3,3- dimethylbutanoyl)pyrrolidine-2- carboxamido)propanoic acid |
| 51 | 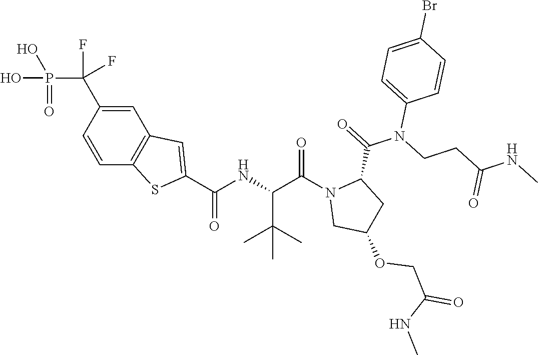 [SMILES: CNC(=O)CCN(C(=O)[C@@H]1C[C@H](OCC(=O)NC)CN1C(=O)[C@@H](NC(=O)c1cc2cc(C(F)(F)P(=O)(O)O)ccc2s1)C(C)(C)C)c1ccc(Br)cc1] | ((2-(((S)-1-((2S,4S)-2-((4- bromophenyl)(3-(methylamino)-3- oxopropyl)carbamoyl)-4-(2- (methylamino)-2- oxoethoxy)pyrrolidin-1-yl)-3,3- dimethyl-1-oxobutan-2- yl)carbamoyl)benzo[b]thiophen-5- yl)difluoromethyl)phosphonic acid |
| 52 | 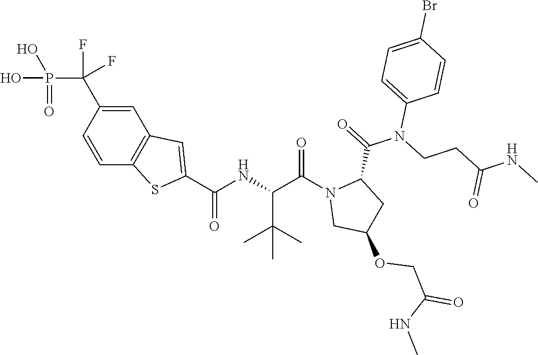 [SMILES: CNC(=O)CCN(C(=O)[C@@H]1C[C@@H](OCC(=O)NC)CN1C(=O)[C@@H](NC(=O)c1cc2cc(C(F)(F)P(=O)(O)O)ccc2s1)C(C)(C)C)c1ccc(Br)cc1] | ((2-(((S)-1-((2S,4R)-2-((4- bromophenyl)(3-(methylamino)-3- oxopropyl)carbamoyl)-4-(2- (methylamino)-2- oxoethoxy)pyrrolidin-1-yl)-3,3- dimethyl-1-oxobutan-2- yl)carbamoyl)benzo[b]thiophen-5- yl)difluoromethyl)phosphonic acid |
| 53 | 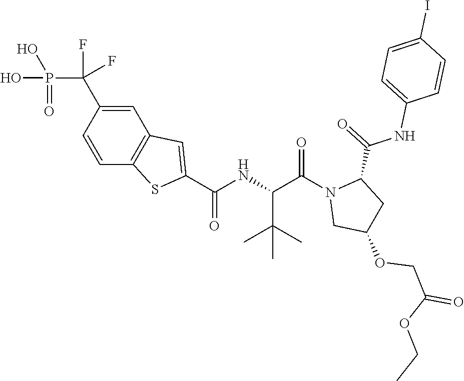 [SMILES: CCOC(=O)CO[C@H]1C[C@@H](C(=O)Nc2ccc(I)cc2)N(C(=O)[C@@H](NC(=O)c2cc3cc(C(F)(F)P(=O)(O)O)ccc3s2)C(C)(C)C)C1] | ((2-(((S)-1-((2S,4S)-4-(2-ethoxy-2- oxoethoxy)-2-((4- iodophenyl)carbamoyl)pyrrolidin-1- yl)-3,3-dimethyl-1-oxobutan-2- yl)carbamoyl)benzo[b]thiophen-5- yl)difluoromethyl)phosphonic acid |
| 54 | 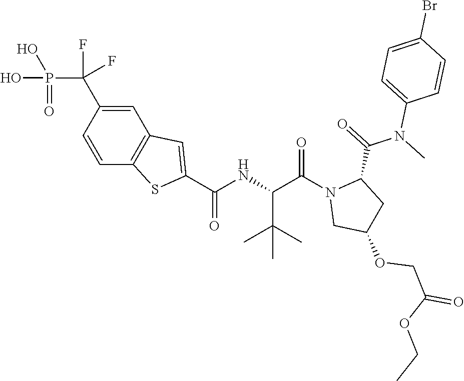 [SMILES: CCOC(=O)CO[C@H]1C[C@@H](C(=O)N(C)c2ccc(Br)cc2)N(C(=O)[C@@H](NC(=O)c2cc3cc(C(F)(F)P(=O)(O)O)ccc3s2)C(C)(C)C)C1] | ((2-(((S)-1-((2S,4S)-2-((4- bromophenyl)(methyl)carbamoyl)- 4-(2-ethoxy-2- oxoethoxy)pyrrolidin-1-yl)-3,3- dimethyl-1-oxobutan-2- yl)carbamoyl)benzo[b]thiophen-5- yl)difluoromethyl)phosphonic acid |
| 55 | 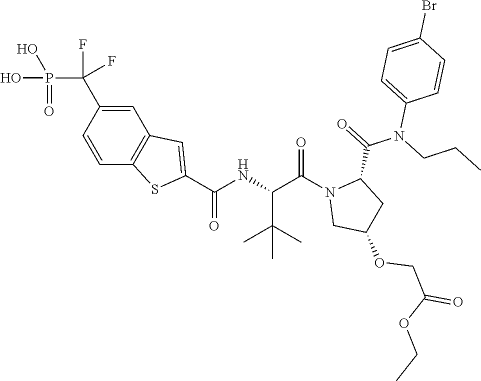 [SMILES: CCCN(C(=O)[C@@H]1C[C@H](OCC(=O)OCC)CN1C(=O)[C@@H](NC(=O)c1cc2cc(C(F)(F)P(=O)(O)O)ccc2s1)C(C)(C)C)c1ccc(Br)cc1] | ((2-(((S)-1-((2S,4S)-2-((4- bromophenyl)(propyl)carbamoyl)-4- (2-ethoxy-2-oxoethoxy)pyrrolidin- 1-yl)-3,3-dimethyl-1-oxobutan-2- yl)carbamoyl)benzo[b]thiophen-5- yl)difluoromethyl)phosphonic acid |
| 56 | 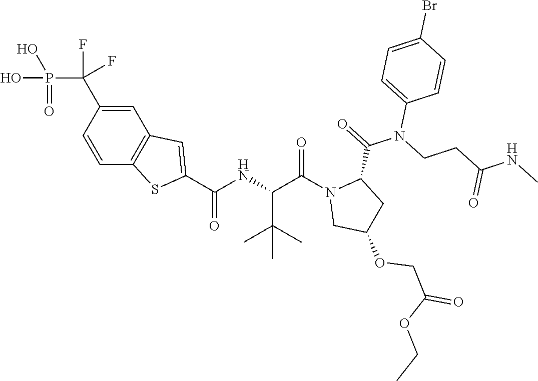 [SMILES: CCOC(=O)CO[C@H]1C[C@@H](C(=O)N(CCC(=O)NC)c2ccc(Br)cc2)N(C(=O)[C@@H](NC(=O)c2cc3cc(C(F)(F)P(=O)(O)O)ccc3s2)C(C)(C)C)C1] | ((2-(((S)-1-((2S,4S)-2-((4- bromophenyl)(3-(methylamino)-3- oxopropyl)carbamoyl)-4-(2-ethoxy- 2-oxoethoxy)pyrrolidin-1-yl)-3,3- dimethyl-1-oxobutan-2- yl)carbamoyl)benzo[b]thiophen-5- yl)difluoromethyl)phosphonic acid |
| 57 | 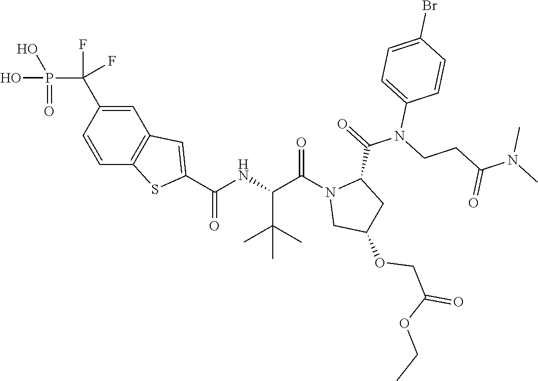 [SMILES: CCOC(=O)CO[C@H]1C[C@@H](C(=O)N(CCC(=O)N(C)C)c2ccc(Br)cc2)N(C(=O)[C@@H](NC(=O)c2cc3cc(C(F)(F)P(=O)(O)O)ccc3s2)C(C)(C)C)C1] | ((2-(((S)-1-((2S,4S)-2-((4- bromophenyl)(3-(dimethylamino)-3- oxopropyl)carbamoyl)-4-(2-ethoxy- 2-oxoethoxy)pyrrolidin-1-yl)-3,3- dimethyl-1-oxobutan-2- yl)carbamoyl)benzo[b]thiophen-5- yl)difluoromethyl)phosphonic acid |
| 58 | 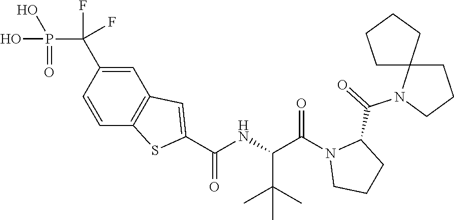 [SMILES: CC(C)(C)[C@H](NC(=O)c1cc2cc(C(F)(F)P(=O)(O)O)ccc2s1)C(=O)N1CCC[C@H]1C(=O)N1CCCC12CCCC2] | ((2-(((S)-1-((S)-2-(1- azaspiro[4.4]nonane-1- carbonyl)pyrrolidin-1-yl)-3,3- dimethyl-1-oxobutan-2- yl)carbamoyl)benzo[b]thiophen-5- yl)difluoromethyl)phosphonic acid |
| 59 | 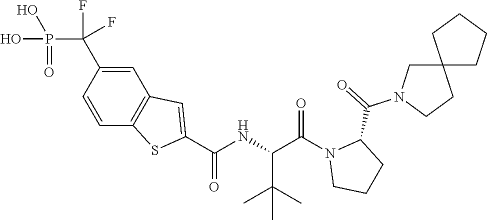 [SMILES: CC(C)(C)[C@H](NC(=O)c1cc2cc(C(F)(F)P(=O)(O)O)ccc2s1)C(=O)N1CCC[C@H]1C(=O)N1CCC2(CCCC2)C1] | ((2-(((S)-1-((S)-2-(2- azaspiro[4.4]nonane-2- carbonyl)pyrrolidin-1-yl)-3,3- dimethyl-1-oxobutan-2- yl)carbamoyl)benzo[b]thiophen-5- yl)difluoromethyl)phosphonic acid |
| 60 | 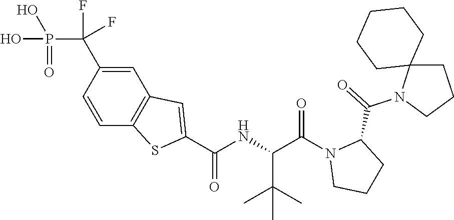 [SMILES: CC(C)(C)[C@H](NC(=O)c1cc2cc(C(F)(F)P(=O)(O)O)ccc2s1)C(=O)N1CCC[C@H]1C(=O)N1CCCC12CCCCC2] | ((2-(((S)-1-((S)-2-(1- azaspiro[4.5]decane-1- carbonyl)pyrrolidin-1-yl)-3,3- dimethyl-1-oxobutan-2- yl)carbamoyl)benzo[b]thiophen-5- yl)difluoromethyl)phosphonic acid |
| 61 | 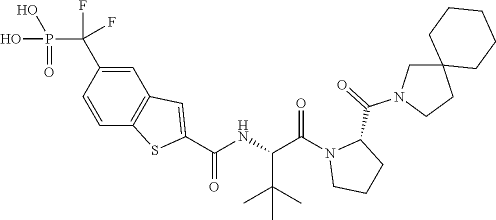 [SMILES: CC(C)(C)[C@H](NC(=O)c1cc2cc(C(F)(F)P(=O)(O)O)ccc2s1)C(=O)N1CCC[C@H]1C(=O)N1CCC2(CCCCC2)C1] | ((2-(((S)-1-((S)-2-(2- azaspiro[4.5]decane-2- carbonyl)pyrrolidin-1-yl)-3,3- dimethyl-1-oxobutan-2- yl)carbamoyl)benzo[b]thiophen-5- yl)difluoromethyl)phosphonic acid |
| 62 | 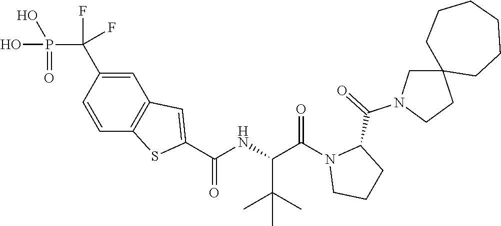 [SMILES: CC(C)(C)[C@H](NC(=O)c1cc2cc(C(F)(F)P(=O)(O)O)ccc2s1)C(=O)N1CCC[C@H]1C(=O)N1CCC2(CCCCCC2)C1] | ((2-(((S)-1-((S)-2-(2- azaspiro[4.6]undecane-2- carbonyl)pyrrolidin-1-yl)-3,3- dimethyl-1-oxobutan-2- yl)carbamoyl)benzo[b]thiophen-5- yl)difluoromethyl)phosphonic acid |
| 63 | 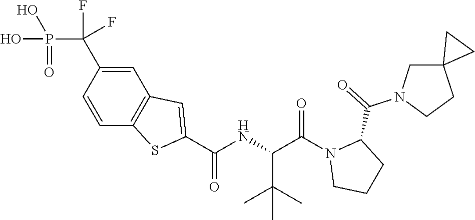 [SMILES: CC(C)(C)[C@H](NC(=O)c1cc2cc(C(F)(F)P(=O)(O)O)ccc2s1)C(=O)N1CCC[C@H]1C(=O)N1CCC2(CC2)C1] | ((2-(((S)-1-((S)-2-(5- azaspiro[2.4]heptane-5- carbonyl)pyrrolidin-1-yl)-3,3- dimethyl-1-oxobutan-2- yl)carbamoyl)benzo[b]thiophen-5- yl)difluoromethyl)phosphonic acid |
| 64 | 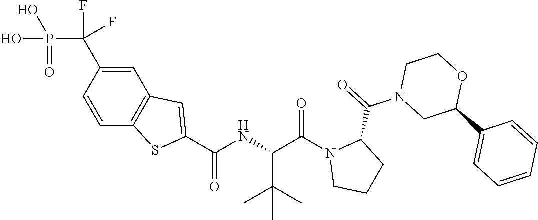 [SMILES: CC(C)(C)[C@H](NC(=O)c1cc2cc(C(F)(F)P(=O)(O)O)ccc2s1)C(=O)N1CCC[C@H]1C(=O)N1CCO[C@@H](c2ccccc2)C1] | ((2-(((S)-3,3-dimethyl-1-oxo-1-((S)- 2-((S)-2-phenylmorpholine-4- carbonyl)pyrrolidin-1-yl)butan-2- yl)carbamoyl)benzo[b]thiophen-5- yl)difluoromethyl)phosphonic acid |
| 65 | 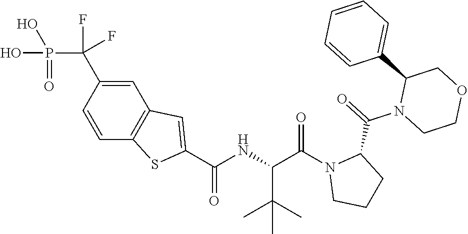 [SMILES: CC(C)(C)[C@H](NC(=O)c1cc2cc(C(F)(F)P(=O)(O)O)ccc2s1)C(=O)N1CCC[C@H]1C(=O)N1CCOC[C@@H]1c1ccccc1] | ((2-(((S)-3,3-dimethyl-1-oxo-1-((S)- 2-((S)-3-phenylmorpholine-4- carbonyl)pyrrolidin-1-yl)butan-2- yl)carbamoyl)benzo[b]thiophen-5- yl)difluoromethyl)phosphonic acid |
| 66 | 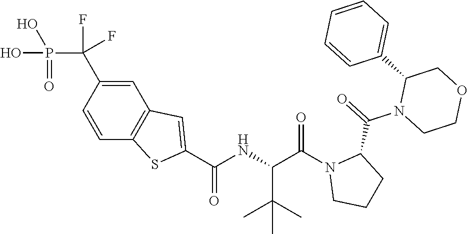 [SMILES: CC(C)(C)[C@H](NC(=O)c1cc2cc(C(F)(F)P(=O)(O)O)ccc2s1)C(=O)N1CCC[C@H]1C(=O)N1CCOC[C@H]1c1ccccc1] | ((2-(((S)-3,3-dimethyl-1-oxo-1-((S)- 2-((R)-3-phenylmorpholine-4- carbonyl)pyrrolidin-1-yl)butan-2- yl)carbamoyl)benzo[b]thiophen-5- yl)difluoromethyl)phosphonic acid |
| 67 | 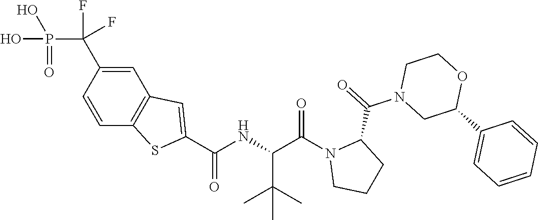 [SMILES: CC(C)(C)[C@H](NC(=O)c1cc2cc(C(F)(F)P(=O)(O)O)ccc2s1)C(=O)N1CCC[C@H]1C(=O)N1CCO[C@H](c2ccccc2)C1] | ((2-(((S)-3,3-dimethyl-1-oxo-1-((S)- 2-((R)-2-phenylmorpholine-4- carbonyl)pyrrolidin-1-yl)butan-2- yl)carbamoyl)benzo[b]thiophen-5- yl)difluoromethyl)phosphonic acid |
| 68 | 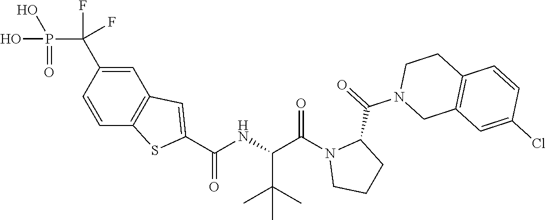 [SMILES: CC(C)(C)[C@H](NC(=O)c1cc2cc(C(F)(F)P(=O)(O)O)ccc2s1)C(=O)N1CCC[C@H]1C(=O)N1CCc2ccc(Cl)cc2C1] | ((2-(((S)-1-((S)-2-(7-chloro-1,2,3,4- tetrahydroisoquinoline-2- carbonyl)pyrrolidin-1-yl)-3,3- dimethyl-1-oxobutan-2- yl)carbamoyl)benzo[b]thiophen-5- yl)difluoromethyl)phosphonic acid |
| 69 | 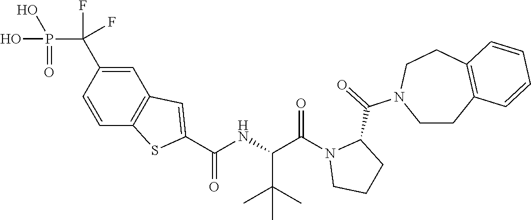 [SMILES: CC(C)(C)[C@H](NC(=O)c1cc2cc(C(F)(F)P(=O)(O)O)ccc2s1)C(=O)N1CCC[C@H]1C(=O)N1CCc2ccccc2CC1] | ((2-(((S)-3,3-dimethyl-1-oxo-1-((S)- 2-(2,3,4,5-tetrahydro-1H- benzo[d]azepine-3- carbonyl)pyrrolidin-1-yl)butan-2- yl)carbamoyl)benzo[b]thiophen-5- yl)difluoromethyl)phosphonic acid |
| 70 | 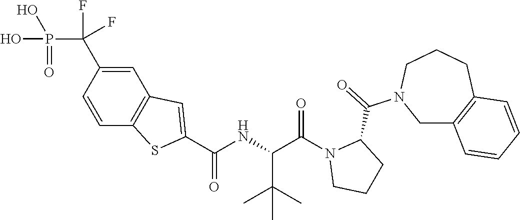 [SMILES: CC(C)(C)[C@H](NC(=O)c1cc2cc(C(F)(F)P(=O)(O)O)ccc2s1)C(=O)N1CCC[C@H]1C(=O)N1CCCc2ccccc2C1] | ((2-(((S)-3,3-dimethyl-1-oxo-1-((S)- 2-(2,3,4,5-tetrahydro-1H- benzo[c]azepine-2- carbonyl)pyrrolidin-1-yl)butan-2- yl)carbamoyl)benzo[b]thiophen-5- yl)difluoromethyl)phosphonic acid |
| 71 | 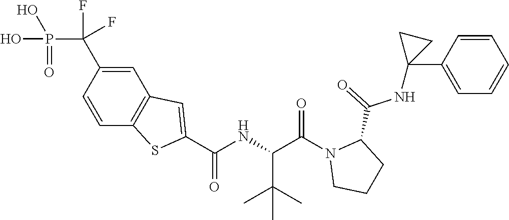 [SMILES: CC(C)(C)[C@H](NC(=O)c1cc2cc(C(F)(F)P(=O)(O)O)ccc2s1)C(=O)N1CCC[C@H]1C(=O)NC1(c2ccccc2)CC1] | ((2-(((S)-3,3-dimethyl-1-oxo-1-((S)- 2-((1- phenylcyclopropyl)carbamoyl) pyrrolidin-1-yl)butan-2- yl)carbamoyl)benzo[b]thiophen-5- yl)difluoromethyl)phosphonic acid |
| 72 | 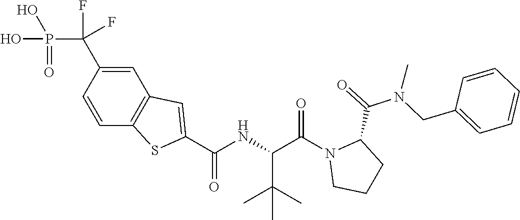 [SMILES: CN(Cc1ccccc1)C(=O)[C@@H]1CCCN1C(=O)[C@@H](NC(=O)c1cc2cc(C(F)(F)P(=O)(O)O)ccc2s1)C(C)(C)C] | ((2-(((S)-1-((S)-2- (benzyl(methyl)carbamoyl)pyrrolidin- 1-yl)-3,3-dimethyl-1-oxobutan-2- yl)carbamoyl)benzo[b]thiophen-5- yl)difluoromethyl)phosphonic acid |
| 73 | 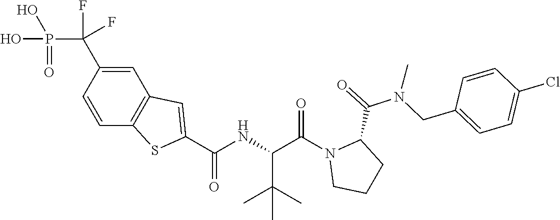 [SMILES: CN(Cc1ccc(Cl)cc1)C(=O)[C@@H]1CCCN1C(=O)[C@@H](NC(=O)c1cc2cc(C(F)(F)P(=O)(O)O)ccc2s1)C(C)(C)C] | ((2-(((S)-1-((S)-2-((4- chlorobenzyl)(methyl)carbamoyl) pyrrolidin-1-yl)-3,3-dimethyl-1- oxobutan-2- yl)carbamoyl)benzo[b]thiophen-5- yl)difluoromethyl)phosphonic acid |
| 74 | 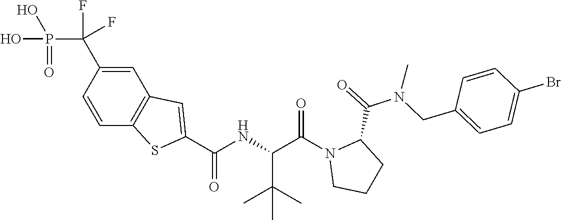 [SMILES: CN(Cc1ccc(Br)cc1)C(=O)[C@@H]1CCCN1C(=O)[C@@H](NC(=O)c1cc2cc(C(F)(F)P(=O)(O)O)ccc2s1)C(C)(C)C] | ((2-(((S)-1-((S)-2-((4- bromobenzyl)(methyl)carbamoyl) pyrrolidin-1-yl)-3,3-dimethyl-1- oxobutan-2- yl)carbamoyl)benzo[b]thiophen-5- yl)difluoromethyl)phosphonic acid |
| 75 | 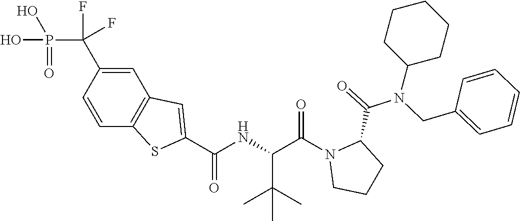 [SMILES: CC(C)(C)[C@H](NC(=O)c1cc2cc(C(F)(F)P(=O)(O)O)ccc2s1)C(=O)N1CCC[C@H]1C(=O)N(Cc1ccccc1)C1CCCCC1] | ((2-(((S)-1-((S)-2- (benzyl(cyclohexyl)carbamoyl) pyrrolidin-1-yl)-3,3-dimethyl-1- oxobutan-2- yl)carbamoyl)benzo[b]thiophen-5- yl)difluoromethyl)phosphonic acid |
| 76 | 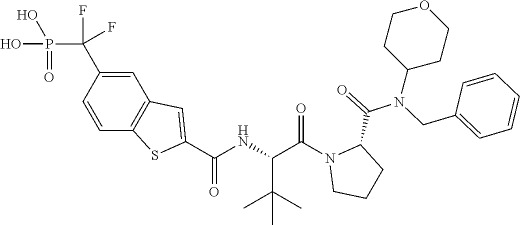 [SMILES: CC(C)(C)[C@H](NC(=O)c1cc2cc(C(F)(F)P(=O)(O)O)ccc2s1)C(=O)N1CCC[C@H]1C(=O)N(Cc1ccccc1)C1CCOCC1] | ((2-(((S)-1-((S)-2- (benzyl(tetrahydro-2H-pyran-4- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 77 | 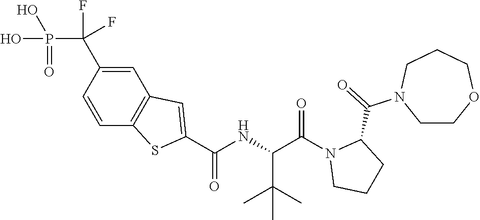 [SMILES: CC(C)(C)[C@H](NC(=O)c1cc2cc(C(F)(F)P(=O)(O)O)ccc2s1)C(=O)N1CCC[C@H]1C(=O)N1CCCOCC1] | ((2-(((S)-1-((S)-2-(1,4-oxazepane-4- carbonyl)pyrrolidin-1-yl)-3,3- dimethyl-1-oxobutan-2- yl)carbamoyl)benzo[b]thiophen-5- yl)difluoromethyl)phosphonic acid |
| 78 | 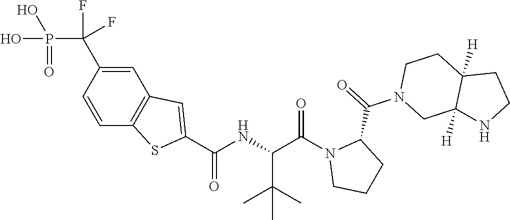 [SMILES: CC(C)(C)[C@H](NC(=O)c1cc2cc(C(F)(F)P(=O)(O)O)ccc2s1)C(=O)N1CCC[C@H]1C(=O)N1CC[C@H]2CCN[C@H]2C1] | ((2-(((S)-3,3-dimethyl-1-((S)-2- ((3aR,7aR)-octahydro-1H- pyrrolo[2,3-c]pyridine-6- carbonyl)pyrrolidin-1-yl)-1- oxobutan-2- yl)carbamoyl)benzo[b]thiophen-5- yl)difluoromethyl)phosphonic acid |
| 79 | 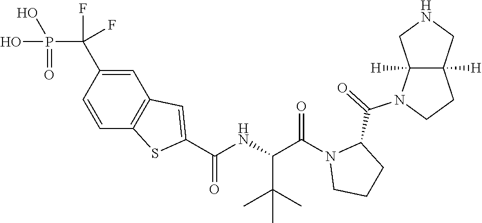 [SMILES: CC(C)(C)[C@H](NC(=O)c1cc2cc(C(F)(F)P(=O)(O)O)ccc2s1)C(=O)N1CCC[C@H]1C(=O)N1CC[C@@H]2CNC[C@@H]21] | ((2-(((S)-3,3-dimethyl-1-((S)-2- ((3aR,6aR)-octahydropyrrolo[3,4- b]pyrrole-1-carbonyl)pyrrolidin-1- yl)-1-oxobutan-2- yl)carbamoyl)benzo[b]thiophen-5- yl)difluoromethyl)phosphonic acid |
| 80 | 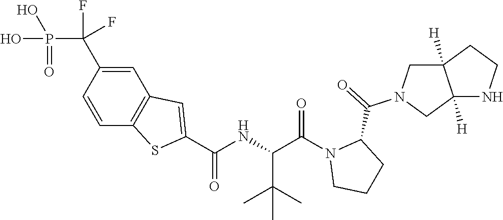 [SMILES: CC(C)(C)[C@H](NC(=O)c1cc2cc(C(F)(F)P(=O)(O)O)ccc2s1)C(=O)N1CCC[C@H]1C(=O)N1C[C@H]2CCN[C@H]2C1] | ((2-(((S)-3,3-dimethyl-1-((S)-2- ((3aR,6aR)-octahydropyrrolo[3,4- b]pyrrole-5-carbonyl)pyrrolidin-1- yl)-1-oxobutan-2- yl)carbamoyl)benzo[b]thiophen-5- yl)difluoromethyl)phosphonic acid |
| 81 | 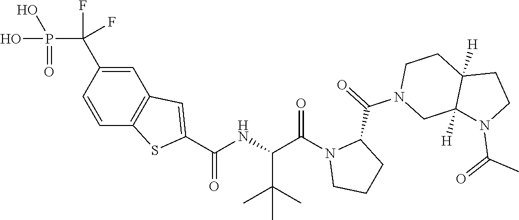 [SMILES: CC(=O)N1CC[C@@H]2CCN(C(=O)[C@@H]3CCCN3C(=O)[C@@H](NC(=O)c3cc4cc(C(F)(F)P(=O)(O)O)ccc4s3)C(C)(C)C)C[C@@H]21] | ((2-(((S)-1-((S)-2-((3aS,7aR)-1- acetyloctahydro-1H-pyrrolo[2,3- c]pyridine-6-carbonyl)pyrrolidin-1- yl)-3,3-dimethyl-1-oxobutan-2- yl)carbamoyl)benzo[b]thiophen-5- yl)difluoromethyl)phosphonic acid |
| 82 | 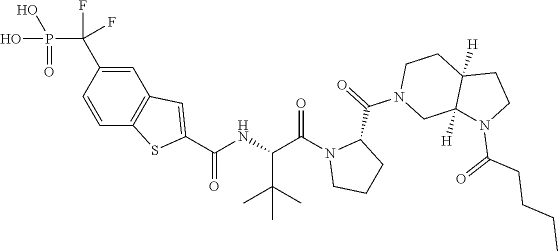 [SMILES: CCCCC(=O)N1CC[C@@H]2CCN(C(=O)[C@@H]3CCCN3C(=O)[C@@H](NC(=O)c3cc4cc(C(F)(F)P(=O)(O)O)ccc4s3)C(C)(C)C)C[C@@H]21] | ((2-(((S)-3,3-dimethyl-1-oxo-1-((S)- 2-((3aS,7aR)-1-pentanoyloctahydro- 1H-pyrrolo[2,3-c]pyridine-6- carbonyl)pyrrolidin-1-yl)butan-2- yl)carbamoyl)benzo[b]thiophen-5- yl)difluoromethyl)phosphonic acid |
| 83 | 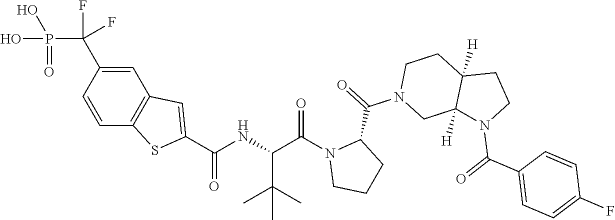 [SMILES: CC(C)(C)[C@H](NC(=O)c1cc2cc(C(F)(F)P(=O)(O)O)ccc2s1)C(=O)N1CCC[C@H]1C(=O)N1CC[C@H]2CCN(C(=O)c3ccc(F)cc3)[C@H]2C1] | (difluoro(2-(((S)-1-((S)-2- ((3aS,7aR)-1-(4- fluorobenzoyl)octahydro-1H- pyrrolo[2,3-c]pyridine-6- carbonyl)pyrrolidin-1-yl)-3,3- dimethyl-1-oxobutan-2- yl)carbamoyl)benzo[b]thiophen-5- yl)methyl)phosphonic acid |
| 84 | 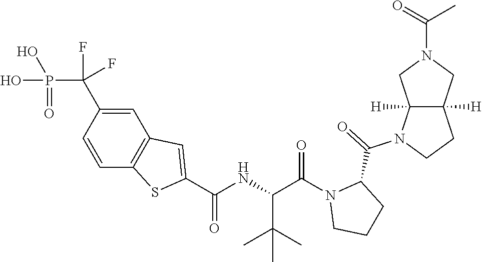 [SMILES: CC(=O)N1C[C@H]2CCN(C(=O)[C@@H]3CCCN3C(=O)[C@@H](NC(=O)c3cc4cc(C(F)(F)P(=O)(O)O)ccc4s3)C(C)(C)C)[C@H]2C1] | ((2-(((S)-1-((S)-2-((3aR,6aR)-5- acetyloctahydropyrrolo[3,4- b]pyrrole-1-carbonyl)pyrrolidin-1- yl)-3,3-dimethyl-1-oxobutan-2- yl)carbamoyl)benzo[b]thiophen-5- yl)difluoromethyl)phosphonic acid |
| 85 | 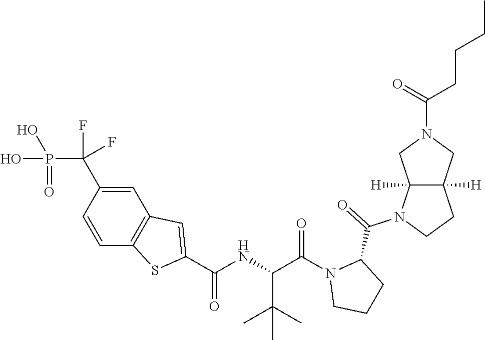 [SMILES: CCCCC(=O)N1C[C@H]2CCN(C(=O)[C@@H]3CCCN3C(=O)[C@@H](NC(=O)c3cc4cc(C(F)(F)P(=O)(O)O)ccc4s3)C(C)(C)C)[C@H]2C1] | ((2-(((S)-3,3-dimethyl-1-oxo-1-((S)- 2-((3aR,6aR)-5- pentanoyloctahydropyrrolo[3,4- b]pyrrole-1-carbonyl)pyrrolidin-1- yl)butan-2- yl)carbamoyl)benzo[b]thiophen-5- yl)difluoromethyl)phosphonic acid |
| 86 | 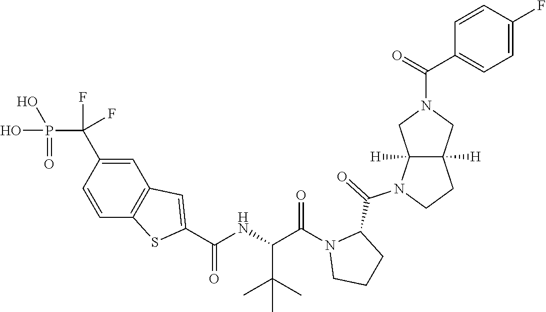 [SMILES: CC(C)(C)[C@H](NC(=O)c1cc2cc(C(F)(F)P(=O)(O)O)ccc2s1)C(=O)N1CCC[C@H]1C(=O)N1CC[C@@H]2CN(C(=O)c3ccc(F)cc3)C[C@@H]21] | (difluoro(2-(((S)-1-((S)-2- ((3aR,6aR)-5-(4- fluorobenzoyl)octahydropyrrolo[3,4- b]pyrrole-1-carbonyl)pyrrolidin-1- yl)-3,3-dimethyl-1-oxobutan-2- yl)carbamoyl)benzo[b]thiophen-5- yl)methyl)phosphonic acid |
| 87 | 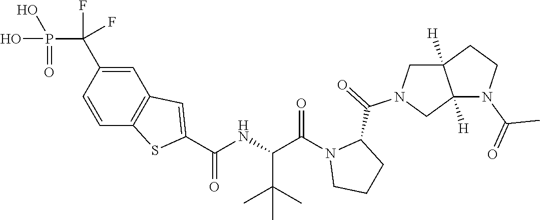 [SMILES: CC(=O)N1CC[C@@H]2CN(C(=O)[C@@H]3CCCN3C(=O)[C@@H](NC(=O)c3cc4cc(C(F)(F)P(=O)(O)O)ccc4s3)C(C)(C)C)C[C@@H]21] | ((2-(((S)-1-((S)-2-((3aR,6aR)-1- acetyloctahydropyrrolo[3,4- b]pyrrole-5-carbonyl)pyrrolidin-1- yl)-3,3-dimethyl-1-oxobutan-2- yl)carbamoyl)benzo[b]thiophen-5- yl)difluoromethyl)phosphonic acid |
| 88 | 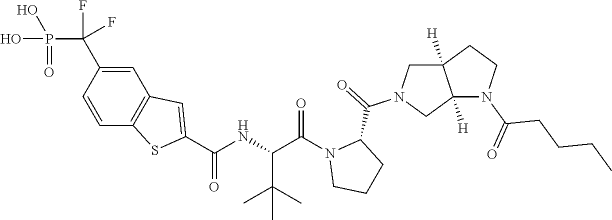 [SMILES: CCCCC(=O)N1CC[C@@H]2CN(C(=O)[C@@H]3CCCN3C(=O)[C@@H](NC(=O)c3cc4cc(C(F)(F)P(=O)(O)O)ccc4s3)C(C)(C)C)C[C@@H]21] | ((2-(((S)-3,3-dimethyl-1-oxo-1-((S)- 2-((3aR,6aR)-1- pentanoyloctahydropyrrolo[3,4- b]pyrrole-5-carbonyl)pyrrolidin-1- yl)butan-2- yl)carbamoyl)benzo[b]thiophen-5- yl)difluoromethyl)phosphonic acid |
| 89 | 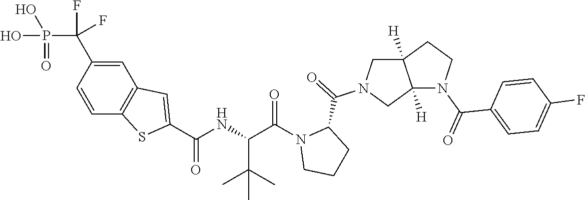 [SMILES: CC(C)(C)[C@H](NC(=O)c1cc2cc(C(F)(F)P(=O)(O)O)ccc2s1)C(=O)N1CCC[C@H]1C(=O)N1C[C@H]2CCN(C(=O)c3ccc(F)cc3)[C@H]2C1] | (difluoro(2-(((S)-1-((S)-2- ((3aR,6aR)-1-(4- fluorobenzoyl)octahydropyrrolo[3,4- b]pyrrole-5-carbonyl)pyrrolidin-1- yl)-3,3-dimethyl-1-oxobutan-2- yl)carbamoyl)benzo[b]thiophen-5- yl)methyl)phosphonic acid |
| 90 | 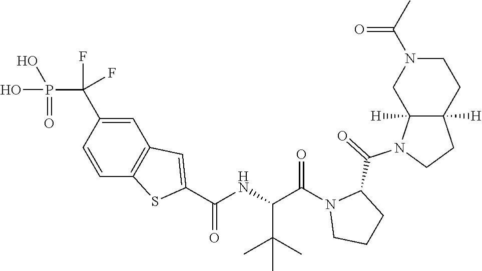 [SMILES: CC(=O)N1CC[C@H]2CCN(C(=O)[C@@H]3CCCN3C(=O)[C@@H](NC(=O)c3cc4cc(C(F)(F)P(=O)(O)O)ccc4s3)C(C)(C)C)[C@H]2C1] | ((2-(((S)-1-((S)-2-((3aS,7aR)-6- acetyloctahydro-1H-pyrrolo[2,3- c]pyridine-1-carbonyl)pyrrolidin-1- yl)-3,3-dimethyl-1-oxobutan-2- yl)carbamoyl)benzo[b]thiophen-5- yl)difluoromethyl)phosphonic acid |
| 91 | 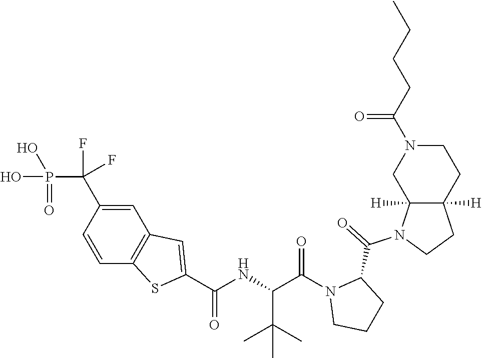 [SMILES: CCCCC(=O)N1CC[C@H]2CCN(C(=O)[C@@H]3CCCN3C(=O)[C@@H](NC(=O)c3cc4cc(C(F)(F)P(=O)(O)O)ccc4s3)C(C)(C)C)[C@H]2C1] | ((2-(((S)-3,3-dimethyl-1-oxo-1-((S)- 2-((3aS,7aR)-6-pentanoyloctahydro- 1H-pyrrolo[2,3-c]pyridine-1- carbonyl)pyrrolidin-1-yl)butan-2- yl)carbamoyl)benzo[b]thiophen-5- yl)difluoromethyl)phosphonic acid |
| 92 | 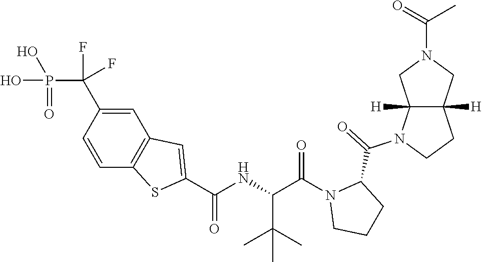 [SMILES: CC(=O)N1C[C@@H]2CCN(C(=O)[C@@H]3CCCN3C(=O)[C@@H](NC(=O)c3cc4cc(C(F)(F)P(=O)(O)O)ccc4s3)C(C)(C)C)[C@@H]2C1] | ((2-(((S)-1-((S)-2-((3aS,6aS)-5- acetyloctahydropyrrolo[3,4- b]pyrrole-1-carbonyl)pyrrolidin-1- yl)-3,3-dimethyl-1-oxobutan-2- yl)carbamoyl)benzo[b]thiophen-5- yl)difluoromethyl)phosphonic acid |
| 93 | 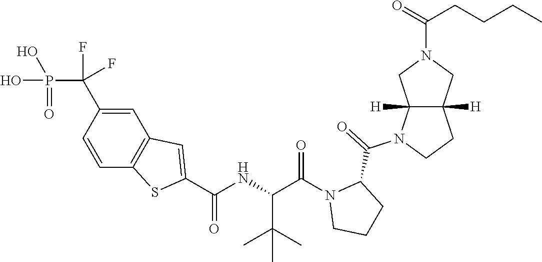 [SMILES: CCCCC(=O)N1C[C@@H]2CCN(C(=O)[C@@H]3CCCN3C(=O)[C@@H](NC(=O)c3cc4cc(C(F)(F)P(=O)(O)O)ccc4s3)C(C)(C)C)[C@@H]2C1] | ((2-(((S)-3,3-dimethyl-1-oxo-1-((S)- 2-((3aS,6aS)-5- pentanoyloctahydropyrrolo[3,4- b]pyrrole-1-carbonyl)pyrrolidin-1- yl)butan-2- yl)carbamoyl)benzo[b]thiophen-5- yl)difluoromethyl)phosphonic acid |
| 94 | 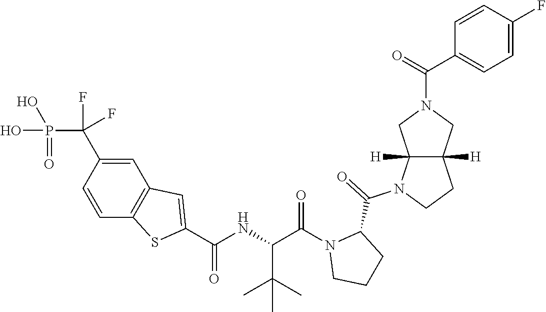 [SMILES: CC(C)(C)[C@H](NC(=O)c1cc2cc(C(F)(F)P(=O)(O)O)ccc2s1)C(=O)N1CCC[C@H]1C(=O)N1CC[C@H]2CN(C(=O)c3ccc(F)cc3)C[C@H]21] | (difluoro(2-(((S)-1-((S)-2- ((3aS,6aS)-5-(4- fluorobenzoyl)octahydropyrrolo[3,4- b]pyrrole-1-carbonyl)pyrrolidin-1- yl)-3,3-dimethyl-1-oxobutan-2- yl)carbamoyl)benzo[b]thiophen-5- yl)methyl)phosphonic acid |
| 95 | 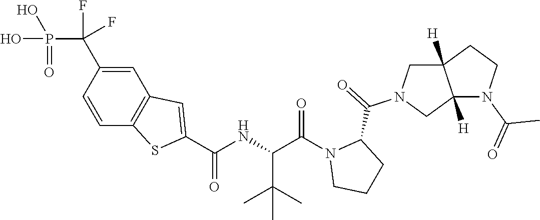 [SMILES: CC(=O)N1CC[C@H]2CN(C(=O)[C@@H]3CCCN3C(=O)[C@@H](NC(=O)c3cc4cc(C(F)(F)P(=O)(O)O)ccc4s3)C(C)(C)C)C[C@H]21] | ((2-(((S)-1-((S)-2-((3aS,6aS)-1- acetyloctahydropyrrolo[3,4- b]pyrrole-5-carbonyl)pyrrolidin-1- yl)-3,3-dimethyl-1-oxobutan-2- yl)carbamoyl)benzo[b]thiophen-5- yl)difluoromethyl)phosphonic acid |
| 96 | 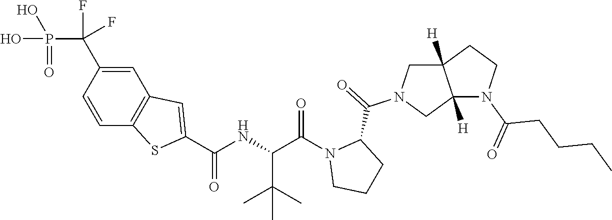 [SMILES: CCCCC(=O)N1CC[C@H]2CN(C(=O)[C@@H]3CCCN3C(=O)[C@@H](NC(=O)c3cc4cc(C(F)(F)P(=O)(O)O)ccc4s3)C(C)(C)C)C[C@H]21] | ((2-(((S)-3,3-dimethyl-1-oxo-1-((S)- 2-((3aS,6aS)-1- pentanoyloctahydropyrrolo[3,4- b]pyrrole-5-carbonyl)pyrrolidin-1- yl)butan-2- yl)carbamoyl)benzo[b]thiophen-5- yl)difluoromethyl)phosphonic acid |
| 97 | 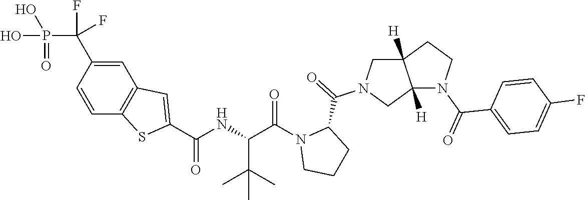 [SMILES: CC(C)(C)[C@H](NC(=O)c1cc2cc(C(F)(F)P(=O)(O)O)ccc2s1)C(=O)N1CCC[C@H]1C(=O)N1C[C@@H]2CCN(C(=O)c3ccc(F)cc3)[C@@H]2C1] | (difluoro(2-(((S)-1-((S)-2- ((3aS,6aS)-1-(4- fluorobenzoyl)octahydropyrrolo[3,4- b]pyrrole-5-carbonyl)pyrrolidin-1- yl)-3,3-dimethyl-1-oxobutan-2- yl)carbamoyl)benzo[b]thiophen-5- yl)methyl)phosphonic acid |
| 98 | 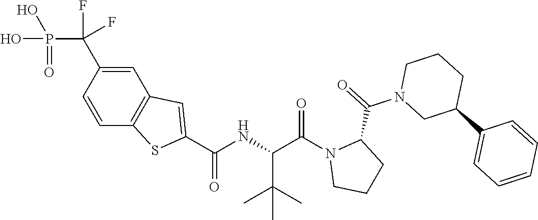 [SMILES: CC(C)(C)[C@H](NC(=O)c1cc2cc(C(F)(F)P(=O)(O)O)ccc2s1)C(=O)N1CCC[C@H]1C(=O)N1CCC[C@@H](c2ccccc2)C1] | ((2-(((S)-3,3-dimethyl-1-oxo-1-((S)- 2-((S)-3-phenylpiperidine-1- carbonyl)pyrrolidin-1-yl)butan-2- yl)carbamoyl)benzo[b]thiophen-5- yl)difluoromethyl)phosphonic acid |
| 99 | 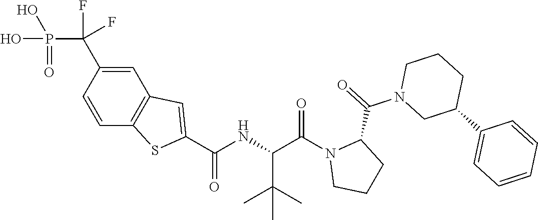 [SMILES: CC(C)(C)[C@H](NC(=O)c1cc2cc(C(F)(F)P(=O)(O)O)ccc2s1)C(=O)N1CCC[C@H]1C(=O)N1CCC[C@H](c2ccccc2)C1] | ((2-(((S)-3,3-dimethyl-1-oxo-1-((S)- 2-((R)-3-phenylpiperidine-1- carbonyl)pyrrolidin-1-yl)butan-2- yl)carbamoyl)benzo[b]thiophen-5- yl)difluoromethyl)phosphonic acid |
| 100 | 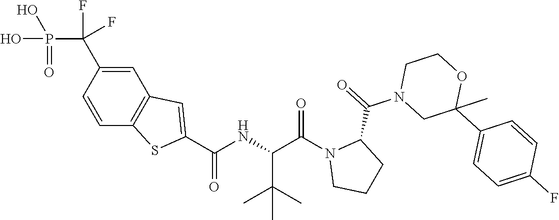 [SMILES: CC1(c2ccc(F)cc2)CN(C(=O)[C@@H]2CCCN2C(=O)[C@@H](NC(=O)c2cc3cc(C(F)(F)P(=O)(O)O)ccc3s2)C(C)(C)C)CCO1] | (difluoro(2-(((2S)-1-((2S)-2-(2-(4- fluorophenyl)-2-methylmorpholine- 4-carbonyl)pyrrolidin-1-yl)-3,3- dimethyl-1-oxobutan-2- yl)carbamoyl)benzo[b]thiophen-5- yl)methyl)phosphonic acid |
| 101 | 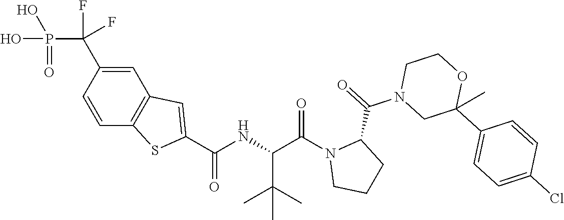 [SMILES: CC1(c2ccc(Cl)cc2)CN(C(=O)[C@@H]2CCCN2C(=O)[C@@H](NC(=O)c2cc3cc(C(F)(F)P(=O)(O)O)ccc3s2)C(C)(C)C)CCO1] | ((2-(((2S)-1-((2S)-2-(2-(4- chlorophenyl)-2-methylmorpholine- 4-carbonyl)pyrrolidin-1-yl)-3,3- dimethyl-1-oxobutan-2- yl)carbamoyl)benzo[b]thiophen-5- yl)difluoromethyl)phosphonic acid |
| 102 | 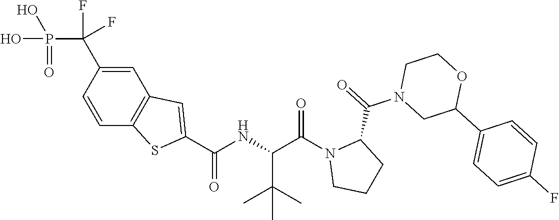 [SMILES: CC(C)(C)[C@H](NC(=O)c1cc2cc(C(F)(F)P(=O)(O)O)ccc2s1)C(=O)N1CCC[C@H]1C(=O)N1CCOC(c2ccc(F)cc2)C1] | (difluoro(2-(((2S)-1-((2S)-2-(2-(4- fluorophenyl)morpholine-4- carbonyl)pyrrolidin-1-yl)-3,3- dimethyl-1-oxobutan-2- yl)carbamoyl)benzo[b]thiophen-5- yl)methyl)phosphonic acid |
| 103 | 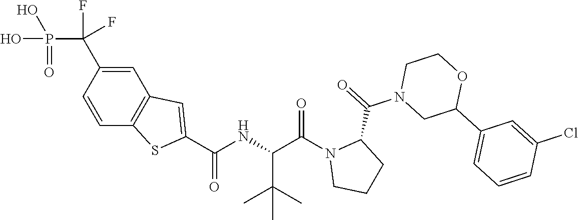 [SMILES: CC(C)(C)[C@H](NC(=O)c1cc2cc(C(F)(F)P(=O)(O)O)ccc2s1)C(=O)N1CCC[C@H]1C(=O)N1CCOC(c2cccc(Cl)c2)C1] | ((2-(((2S)-1-((2S)-2-(2-(3- chlorophenyl)morpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 104 | 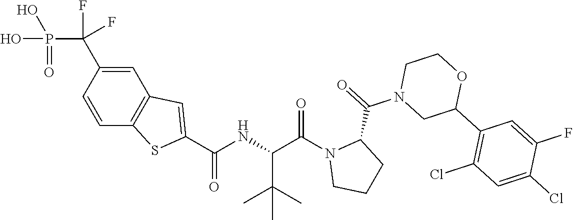 [SMILES: CC(C)(C)[C@H](NC(=O)c1cc2cc(C(F)(F)P(=O)(O)O)ccc2s1)C(=O)N1CCC[C@H]1C(=O)N1CCOC(c2cc(F)c(Cl)cc2Cl)C1] | ((2-(((2S)-1-((2S)-2-(2-(2,4- dichloro-5- fluorophenyl)morpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 105 | 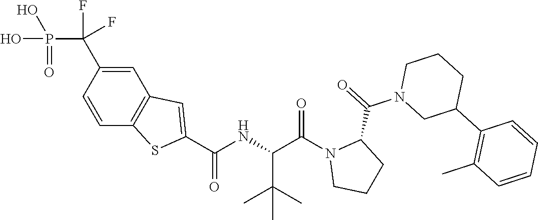 [SMILES: Cc1ccccc1C1CCCN(C(=O)[C@@H]2CCCN2C(=O)[C@@H](NC(=O)c2cc3cc(C(F)(F)P(=O)(O)O)ccc3s2)C(C)(C)C)C1] | ((2-(((2S)-3,3-dimethyl-1-oxo-1- ((2S)-2-(3-(o-tolyl)piperidine-1- carbonyl)pyrrolidin-1-yl)butan-2- yl)carbamoyl)benzo[b]thiophen-5- yl)difluoromethyl)phosphonic acid |
| 106 | 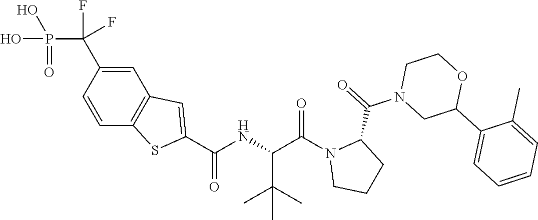 [SMILES: Cc1ccccc1C1CN(C(=O)[C@@H]2CCCN2C(=O)[C@@H](NC(=O)c2cc3cc(C(F)(F)P(=O)(O)O)ccc3s2)C(C)(C)C)CCO1] | ((2-(((2S)-3,3-dimethyl-1-oxo-1- ((2S)-2-(2-(o-tolyl)morpholine-4- carbonyl)pyrrolidin-1-yl)butan-2- yl)carbamoyl)benzo[b]thiophen-5- yl)difluoromethyl)phosphonic acid |
| 107 | 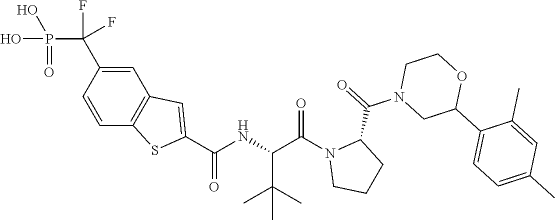 [SMILES: Cc1ccc(C2CN(C(=O)[C@@H]3CCCN3C(=O)[C@@H](NC(=O)c3cc4cc(C(F)(F)P(=O)(O)O)ccc4s3)C(C)(C)C)CCO2)c(C)c1] | ((2-(((2S)-1-((2S)-2-(2-(2,4- dimethylphenyl)morpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 108 | 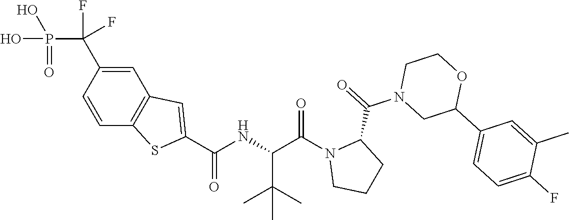 [SMILES: Cc1cc(C2CN(C(=O)[C@@H]3CCCN3C(=O)[C@@H](NC(=O)c3cc4cc(C(F)(F)P(=O)(O)O)ccc4s3)C(C)(C)C)CCO2)ccc1F] | (difluoro(2-(((2S)-1-((2S)-2-(2-(4- fluoro-3-methylphenyl)morpholine- 4-carbonyl)pyrrolidin-1-yl)-3,3- dimethyl-1-oxobutan-2- yl)carbamoyl)benzo[b]thiophen-5- yl)methyl)phosphonic acid |
| 109 | 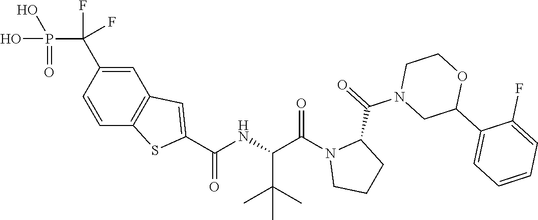 [SMILES: CC(C)(C)[C@H](NC(=O)c1cc2cc(C(F)(F)P(=O)(O)O)ccc2s1)C(=O)N1CCC[C@H]1C(=O)N1CCOC(c2ccccc2F)C1] | (difluoro(2-(((2S)-1-((2S)-2-(2-(2- fluorophenyl)morpholine-4- carbonyl)pyrrolidin-1-yl)-3,3- dimethyl-1-oxobutan-2- yl)carbamoyl)benzo[b]thiophen-5- yl)methyl)phosphonic acid |
| 110 | 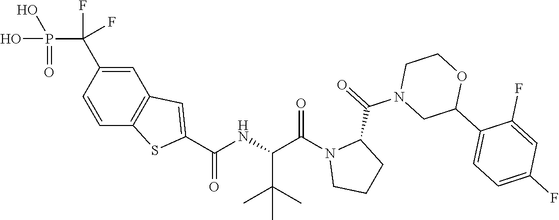 [SMILES: CC(C)(C)[C@H](NC(=O)c1cc2cc(C(F)(F)P(=O)(O)O)ccc2s1)C(=O)N1CCC[C@H]1C(=O)N1CCOC(c2ccc(F)cc2F)C1] | ((2-(((2S)-1-((2S)-2-(2-(2,4- difluorophenyl)morpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 111 | 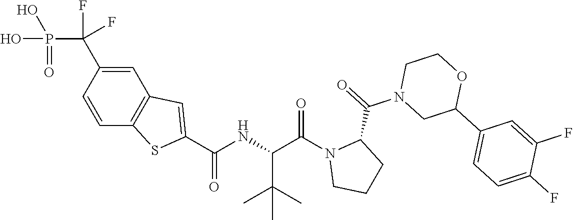 [SMILES: CC(C)(C)[C@H](NC(=O)c1cc2cc(C(F)(F)P(=O)(O)O)ccc2s1)C(=O)N1CCC[C@H]1C(=O)N1CCOC(c2ccc(F)c(F)c2)C1] | ((2-(((2S)-1-((2S)-2-(2-(3,4- difluorophenyl)morpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 112 | 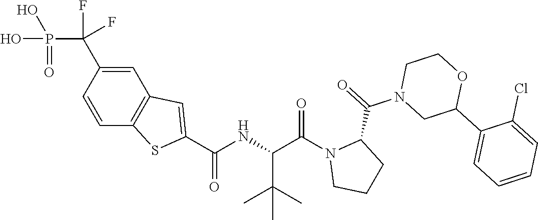 [SMILES: CC(C)(C)[C@H](NC(=O)c1cc2cc(C(F)(F)P(=O)(O)O)ccc2s1)C(=O)N1CCC[C@H]1C(=O)N1CCOC(c2ccccc2Cl)C1] | ((2-(((2S)-1-((2S)-2-(2-(2- chlorophenyl)morpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 113 | 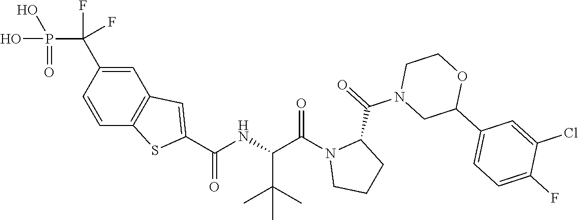 [SMILES: CC(C)(C)[C@H](NC(=O)c1cc2cc(C(F)(F)P(=O)(O)O)ccc2s1)C(=O)N1CCC[C@H]1C(=O)N1CCOC(c2ccc(F)c(Cl)c2)C1] | ((2-(((2S)-1-((2S)-2-(2-(3-chloro-4- fluorophenyl)morpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 114 | 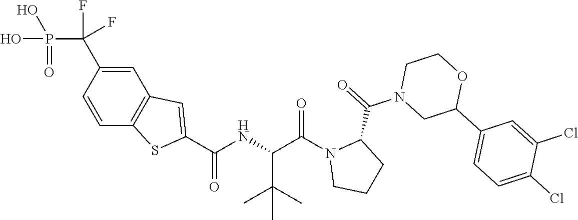 [SMILES: CC(C)(C)[C@H](NC(=O)c1cc2cc(C(F)(F)P(=O)(O)O)ccc2s1)C(=O)N1CCC[C@H]1C(=O)N1CCOC(c2ccc(Cl)c(Cl)c2)C1] | ((2-(((2S)-1-((2S)-2-(2-(3,4- dichlorophenyl)morpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 115 | 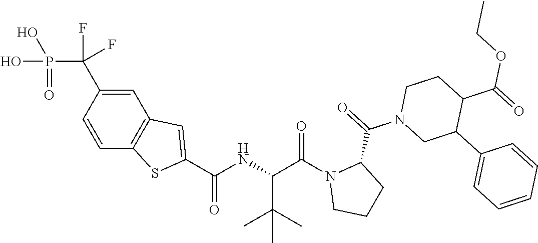 [SMILES: CCOC(=O)C1CCN(C(=O)[C@@H]2CCCN2C(=O)[C@@H](NC(=O)c2cc3cc(C(F)(F)P(=O)(O)O)ccc3s2)C(C)(C)C)CC1c1ccccc1] | ((2-(((2S)-1-((2S)-2-(4- (ethoxycarbonyl)-3- phenylpiperidine-1- carbonyl)pyrrolidin-1-yl)-3,3- dimethyl-1-oxobutan-2- yl)carbamoyl)benzo[b]thiophen-5- yl)difluoromethyl)phosphonic acid |
| 116 | 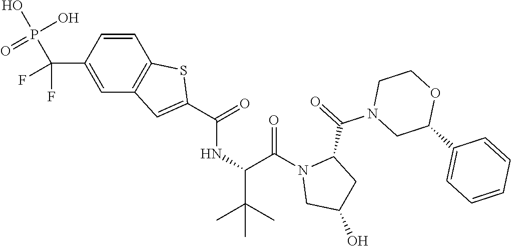 [SMILES: CC(C)(C)[C@H](NC(=O)c1cc2cc(C(F)(F)P(=O)(O)O)ccc2s1)C(=O)N1C[C@@H](O)C[C@H]1C(=O)N1CCO[C@H](c2ccccc2)C1] | (difluoro(2-(((S)-1-((2S,4S)-4- hydroxy-2-((R)-2- phenylmorpholine-4- carbonyl)pyrrolidin-1-yl)-3,3- dimethyl-1-oxobutan-2- yl)carbamoyl)benzo[b]thiophen-5- yl)methyl)phosphonic acid |
| 117 | 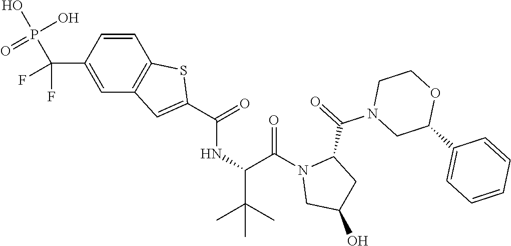 [SMILES: CC(C)(C)[C@H](NC(=O)c1cc2cc(C(F)(F)P(=O)(O)O)ccc2s1)C(=O)N1C[C@H](O)C[C@H]1C(=O)N1CCO[C@H](c2ccccc2)C1] | (difluoro(2-(((S)-1-((2S,4R)-4- hydroxy-2-((R)-2- phenylmorpholine-4- carbonyl)pyrrolidin-1-yl)-3,3- dimethyl-1-oxobutan-2- yl)carbamoyl)benzo[b]thiophen-5- yl)methyl)phosphonic acid |
| 118 | 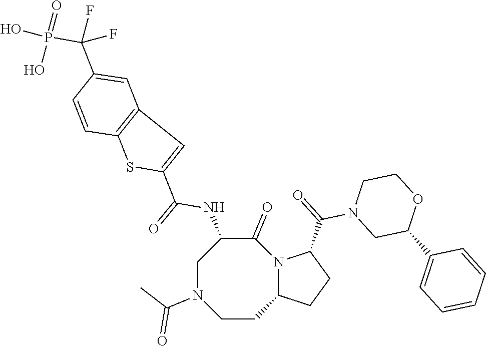 [SMILES: CC(=O)N1CC[C@H]2CC[C@@H](C(=O)N3CCO[C@H](c4ccccc4)C3)N2C(=O)[C@@H](NC(=O)c2cc3cc(C(F)(F)P(=O)(O)O)ccc3s2)C1] | ((2-(((5S,8S,10aR)-3-acetyl-6-oxo- 8-((R)-2-phenylmorpholine-4- carbonyl)decahydropyrrolo[1,2- a][1,5]diazocin-5- yl)carbamoyl)benzo[b]thiophen-5- yl)difluoromethyl)phosphonic acid |
| 119 | 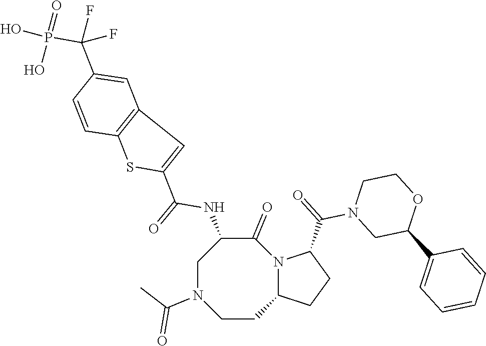 [SMILES: CC(=O)N1CC[C@H]2CC[C@@H](C(=O)N3CCO[C@@H](c4ccccc4)C3)N2C(=O)[C@@H](NC(=O)c2cc3cc(C(F)(F)P(=O)(O)O)ccc3s2)C1] | ((2-(((5S,8S,10aR)-3-acetyl-6-oxo- 8-((S)-2-phenylmorpholine-4- carbonyl)decahydropyrrolo[1,2- a][1,5]diazocin-5- yl)carbamoyl)benzo[b]thiophen-5- yl)difluoromethyl)phosphonic acid |
| 120 | 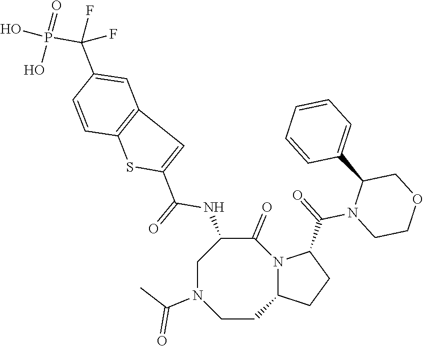 [SMILES: CC(=O)N1CC[C@H]2CC[C@@H](C(=O)N3CCOC[C@@H]3c3ccccc3)N2C(=O)[C@@H](NC(=O)c2cc3cc(C(F)(F)P(=O)(O)O)ccc3s2)C1] | ((2-(((5S,8S,10aR)-3-acetyl-6-oxo- 8-((S)-3-phenylmorpholine-4- carbonyl)decahydropyrrolo[1,2- a][1,5]diazocin-5- yl)carbamoyl)benzo[b]thiophen-5- yl)difluoromethyl)phosphonic acid |
| 121 | 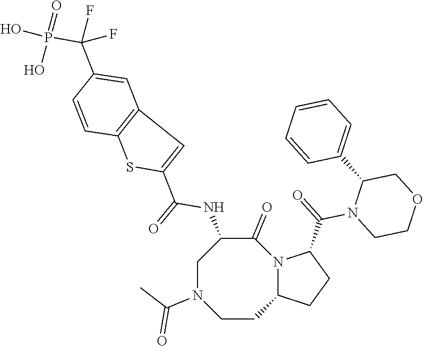 [SMILES: CC(=O)N1CC[C@H]2CC[C@@H](C(=O)N3CCOC[C@H]3c3ccccc3)N2C(=O)[C@@H](NC(=O)c2cc3cc(C(F)(F)P(=O)(O)O)ccc3s2)C1] | ((2-(((5S,8S,10aR)-3-acetyl-6-oxo- 8-((R)-3-phenylmorpholine-4- carbonyl)decahydropyrrolo[1,2- a][1,5]diazocin-5- yl)carbamoyl)benzo[b]thiophen-5- yl)difluoromethyl)phosphonic acid |
| 122 | 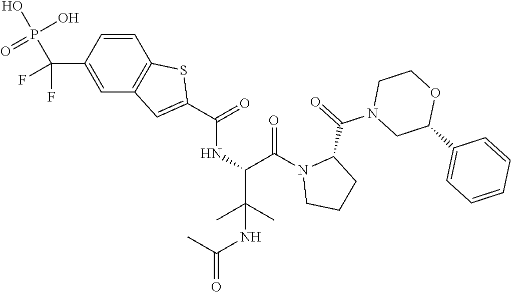 [SMILES: CC(=O)NC(C)(C)[C@H](NC(=O)c1cc2cc(C(F)(F)P(=O)(O)O)ccc2s1)C(=O)N1CCC[C@H]1C(=O)N1CCO[C@H](c2ccccc2)C1] | ((2-(((S)-3-acetamido-3-methyl-1- oxo-1-((S)-2-((R)-2- phenylmorpholine-4- carbonyl)pyrrolidin-1-yl)butan-2- yl)carbamoyl)benzo[b]thiophen-5- yl)difluoromethyl)phosphonic acid |
| 123 | 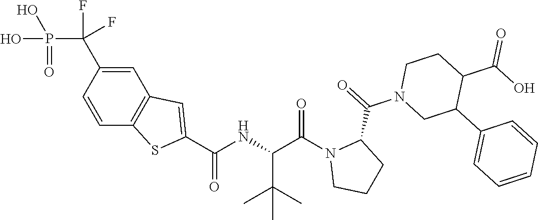 [SMILES: CC(C)(C)[C@H](NC(=O)c1cc2cc(C(F)(F)P(=O)(O)O)ccc2s1)C(=O)N1CCC[C@H]1C(=O)N1CCC(C(=O)O)C(c2ccccc2)C1] | 1-(((S)-2-(5- (difluoro(phosphono)methyl)benzo [b]thiophene-2-carboxamido)-3,3- dimethylbutanoyl)-L-prolyl)-3- phenylpiperidine-4-carboxylic acid |
| 124 | 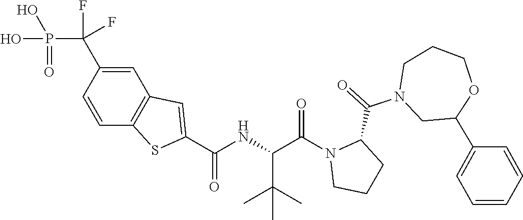 [SMILES: CC(C)(C)[C@H](NC(=O)c1cc2cc(C(F)(F)P(=O)(O)O)ccc2s1)C(=O)N1CCC[C@H]1C(=O)N1CCCOC(c2ccccc2)C1] | ((2-(((2S)-3,3-dimethyl-1-oxo-1- ((2S)-2-(2-phenyl-1,4-oxazepane-4- carbonyl)pyrrolidin-1-yl)butan-2- yl)carbamoyl)benzo[b]thiophen-5- yl)difluoromethyl)phosphonic acid |
| 125 | 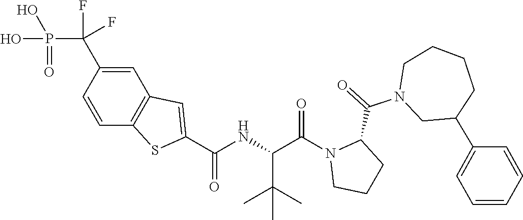 [SMILES: CC(C)(C)[C@H](NC(=O)c1cc2cc(C(F)(F)P(=O)(O)O)ccc2s1)C(=O)N1CCC[C@H]1C(=O)N1CCCCC(c2ccccc2)C1] | ((2-(((2S)-3,3-dimethyl-1-oxo-1- ((2S)-2-(3-phenylazepane-1- carbonyl)pyrrolidin-1-yl)butan-2- yl)carbamoyl)benzo[b]thiophen-5- yl)difluoromethyl)phosphonic acid |
| 126 | 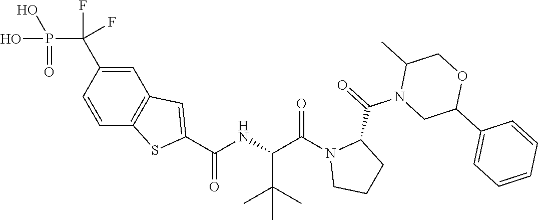 [SMILES: CC1COC(c2ccccc2)CN1C(=O)[C@@H]1CCCN1C(=O)[C@@H](NC(=O)c1cc2cc(C(F)(F)P(=O)(O)O)ccc2s1)C(C)(C)C] | ((2-(((2S)-3,3-dimethyl-1-((2S)-2- (5-methyl-2-phenylmorpholine-4- carbonyl)pyrrolidin-1-yl)-1- oxobutan-2- yl)carbamoyl)benzo[b]thiophen-5- yl)difluoromethyl)phosphonic acid |
| 127 | 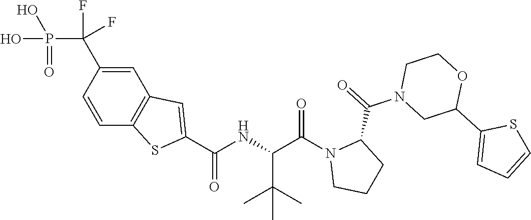 [SMILES: CC(C)(C)[C@H](NC(=O)c1cc2cc(C(F)(F)P(=O)(O)O)ccc2s1)C(=O)N1CCC[C@H]1C(=O)N1CCOC(c2cccs2)C1] | ((2-(((2S)-3,3-dimethyl-1-oxo-1- ((2S)-2-(2-(thiophen-2- yl)morpholine-4- carbonyl)pyrrolidin-1-yl)butan-2- yl)carbamoyl)benzo[b]thiophen-5- yl)difluoromethyl)phosphonic acid |
| 128 | 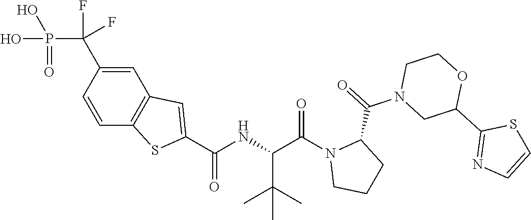 [SMILES: CC(C)(C)[C@H](NC(=O)c1cc2cc(C(F)(F)P(=O)(O)O)ccc2s1)C(=O)N1CCC[C@H]1C(=O)N1CCOC(c2nccs2)C1] | ((2-(((2S)-3,3-dimethyl-1-oxo-1- ((2S)-2-(2-(thiazol-2-yl)morpholine- 4-carbonyl)pyrrolidin-1-yl)butan-2- yl)carbamoyl)benzo[b]thiophen-5- yl)difluoromethyl)phosphonic acid |
| 129 | 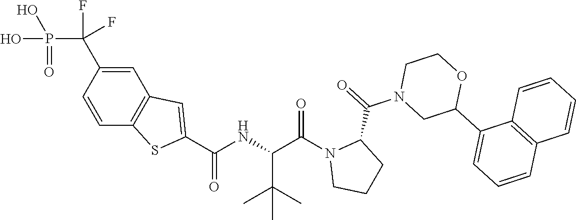 [SMILES: CC(C)(C)[C@H](NC(=O)c1cc2cc(C(F)(F)P(=O)(O)O)ccc2s1)C(=O)N1CCC[C@H]1C(=O)N1CCOC(c2cccc3ccccc23)C1] | ((2-(((2S)-3,3-dimethyl-1-((2S)-2- (2-(naphthalen-1-yl)morpholine-4- carbonyl)pyrrolidin-1-yl)-1- oxobutan-2- yl)carbamoyl)benzo[b]thiophen-5- yl)difluoromethyl)phosphonic acid |
| 130 | 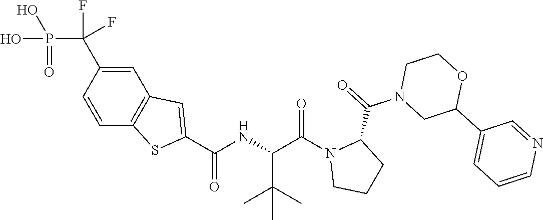 [SMILES: CC(C)(C)[C@H](NC(=O)c1cc2cc(C(F)(F)P(=O)(O)O)ccc2s1)C(=O)N1CCC[C@H]1C(=O)N1CCOC(c2cccnc2)C1] | ((2-(((2S)-3,3-dimethyl-1-oxo-1- ((2S)-2-(2-(pyridin-3- yl)morpholine-4- carbonyl)pyrrolidin-1-yl)butan-2- yl)carbamoyl)benzo[b]thiophen-5- yl)difluoromethyl)phosphonic acid |
| 131 | 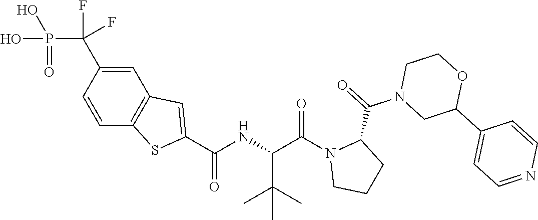 [SMILES: CC(C)(C)[C@H](NC(=O)c1cc2cc(C(F)(F)P(=O)(O)O)ccc2s1)C(=O)N1CCC[C@H]1C(=O)N1CCOC(c2ccncc2)C1] | ((2-(((2S)-3,3-dimethyl-1-oxo-1- ((2S)-2-(2-(pyridin-4- yl)morpholine-4- carbonyl)pyrrolidin-1-yl)butan-2- yl)carbamoyl)benzo[b]thiophen-5- yl)difluoromethyl)phosphonic acid |
| 132 | 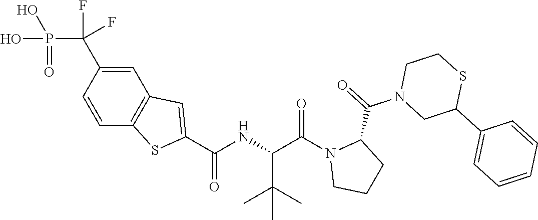 [SMILES: CC(C)(C)[C@H](NC(=O)c1cc2cc(C(F)(F)P(=O)(O)O)ccc2s1)C(=O)N1CCC[C@H]1C(=O)N1CCSC(c2ccccc2)C1] | ((2-(((2S)-3,3-dimethyl-1-oxo-1- ((2S)-2-(2-phenylthiomorpholine-4- carbonyl)pyrrolidin-1-yl)butan-2- yl)carbamoyl)benzo[b]thiophen-5- yl)difluoromethyl)phosphonic acid |
| 133 | 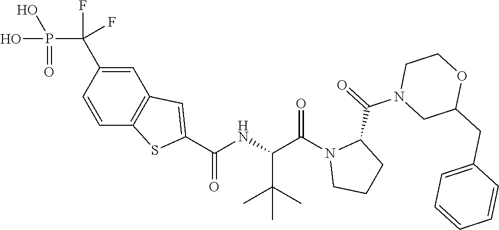 [SMILES: CC(C)(C)[C@H](NC(=O)c1cc2cc(C(F)(F)P(=O)(O)O)ccc2s1)C(=O)N1CCC[C@H]1C(=O)N1CCOC(Cc2ccccc2)C1] | ((2-(((2S)-1-((2S)-2-(2- benzylmorpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 134 | 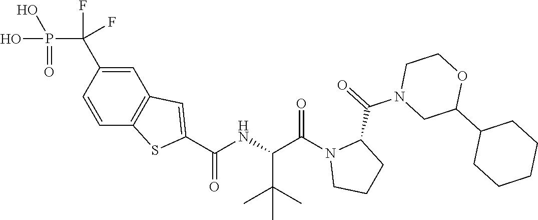 [SMILES: CC(C)(C)[C@H](NC(=O)c1cc2cc(C(F)(F)P(=O)(O)O)ccc2s1)C(=O)N1CCC[C@H]1C(=O)N1CCOC(C2CCCCC2)C1] | ((2-(((2S)-1-((2S)-2-(2- cyclohexylmorpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 135 | 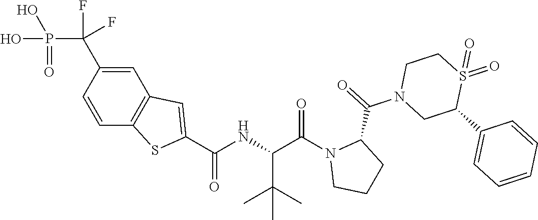 [SMILES: CC(C)(C)[C@H](NC(=O)c1cc2cc(C(F)(F)P(=O)(O)O)ccc2s1)C(=O)N1CCC[C@H]1C(=O)N1CCS(=O)(=O)[C@H](c2ccccc2)C1] | ((2-(((S)-1-((S)-2-((R)-1,1-dioxido- 2-phenylthiomorpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 136 | 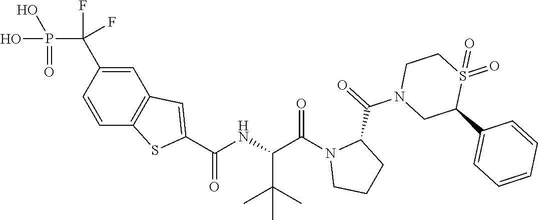 [SMILES: CC(C)(C)[C@H](NC(=O)c1cc2cc(C(F)(F)P(=O)(O)O)ccc2s1)C(=O)N1CCC[C@H]1C(=O)N1CCS(=O)(=O)[C@@H](c2ccccc2)C1] | ((2-(((S)-1-((S)-2-((S)-1,1-dioxido- 2-phenylthiomorpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 137 | 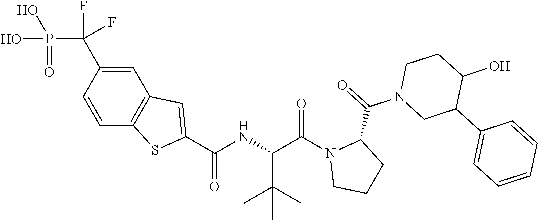 [SMILES: CC(C)(C)[C@H](NC(=O)c1cc2cc(C(F)(F)P(=O)(O)O)ccc2s1)C(=O)N1CCC[C@H]1C(=O)N1CCC(O)C(c2ccccc2)C1] | (difluoro(2-(((2S)-1-((2S)-2-(4- hydroxy-3-phenylpiperidine-1- carbonyl)pyrrolidin-1-yl)-3,3- dimethyl-1-oxobutan-2- yl)carbamoyl)benzo[b]thiophen-5- yl)methyl)phosphonic acid |
| 138 | 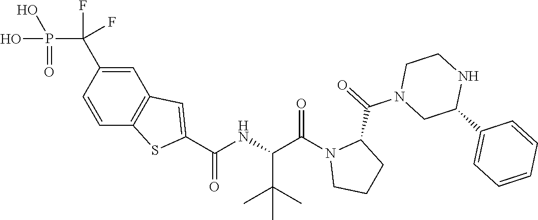 [SMILES: CC(C)(C)[C@H](NC(=O)c1cc2cc(C(F)(F)P(=O)(O)O)ccc2s1)C(=O)N1CCC[C@H]1C(=O)N1CCN[C@H](c2ccccc2)C1] | ((2-(((S)-3,3-dimethyl-1-oxo-1-((S)- 2-((R)-3-phenylpiperazine-1- carbonyl)pyrrolidin-1-yl)butan-2- yl)carbamoyl)benzo[b]thiophen-5- yl)difluoromethyl)phosphonic acid |
| 139 | 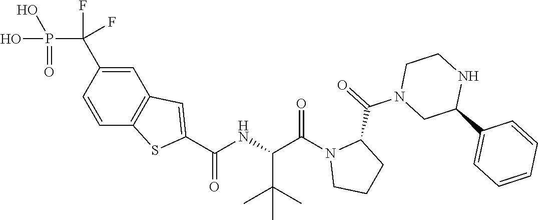 [SMILES: CC(C)(C)[C@H](NC(=O)c1cc2cc(C(F)(F)P(=O)(O)O)ccc2s1)C(=O)N1CCC[C@H]1C(=O)N1CCN[C@@H](c2ccccc2)C1] | ((2-(((S)-3,3-dimethyl-1-oxo-1-((S)- 2-((S)-3-phenylpiperazine-1- carbonyl)pyrrolidin-1-yl)butan-2- yl)carbamoyl)benzo[b]thiophen-5- yl)difluoromethyl)phosphonic acid |
| 140 | 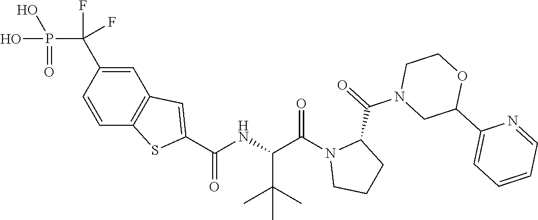 [SMILES: CC(C)(C)[C@H](NC(=O)c1cc2cc(C(F)(F)P(=O)(O)O)ccc2s1)C(=O)N1CCC[C@H]1C(=O)N1CCOC(c2ccccn2)C1] | ((2-(((2S)-3,3-dimethyl-1-oxo-1- ((2S)-2-(2-(pyridin-2- yl)morpholine-4- carbonyl)pyrrolidin-1-yl)butan-2- yl)carbamoyl)benzo[b]thiophen-5- yl)difluoromethyl)phosphonic acid |
| 141 | 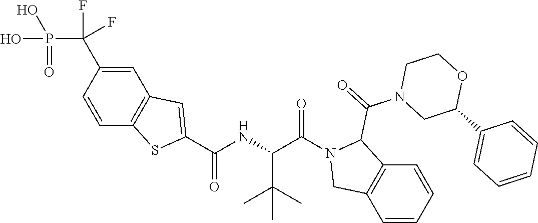 [SMILES: CC(C)(C)[C@H](NC(=O)c1cc2cc(C(F)(F)P(=O)(O)O)ccc2s1)C(=O)N1Cc2ccccc2C1C(=O)N1CCO[C@H](c2ccccc2)C1] | ((2-(((2S)-3,3-dimethyl-1-oxo-1-(1- ((R)-2-phenylmorpholine-4- carbonyl)isoindolin-2-yl)butan-2- yl)carbamoyl)benzo[b]thiophen-5- yl)difluoromethyl)phosphonic acid |
| 142 | 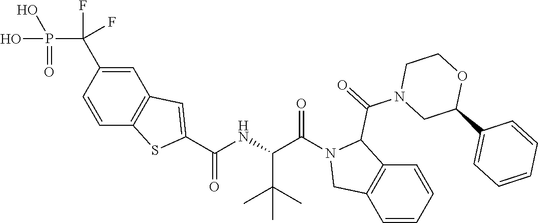 [SMILES: CC(C)(C)[C@H](NC(=O)c1cc2cc(C(F)(F)P(=O)(O)O)ccc2s1)C(=O)N1Cc2ccccc2C1C(=O)N1CCO[C@@H](c2ccccc2)C1] | ((2-(((2S)-3,3-dimethyl-1-oxo-1-(1- ((S)-2-phenylmorpholine-4- carbonyl)isoindolin-2-yl)butan-2- yl)carbamoyl)benzo[b]thiophen-5- yl)difluoromethyl)phosphonic acid |
| 143 | 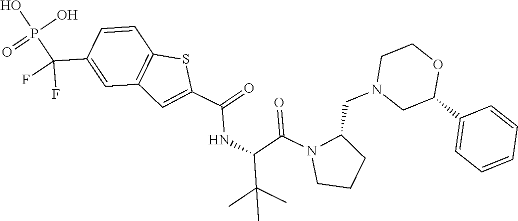 [SMILES: CC(C)(C)[C@H](NC(=O)c1cc2cc(C(F)(F)P(=O)(O)O)ccc2s1)C(=O)N1CCC[C@H]1CN1CCO[C@H](c2ccccc2)C1] | ((2-(((S)-3,3-dimethyl-1-oxo-1-((S)- 2-(((R)-2- phenylmorpholino)methyl)pyrrolidin- 1-yl)butan-2- yl)carbamoyl)benzo[b]thiophen-5- yl)difluoromethyl)phosphonic acid |
| 144 | 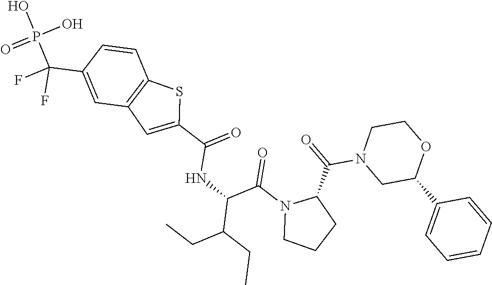 [SMILES: CCC(CC)[C@H](NC(=O)c1cc2cc(C(F)(F)P(=O)(O)O)ccc2s1)C(=O)N1CCC[C@H]1C(=O)N1CCO[C@H](c2ccccc2)C1] | ((2-(((S)-3-ethyl-1-oxo-1-((S)-2- ((R)-2-phenylmorpholine-4- carbonyl)pyrrolidin-1-yl)pentan-2- yl)carbamoyl)benzo[b]thiophen-5- yl)difluoromethyl)phosphonic acid |
| 145 | 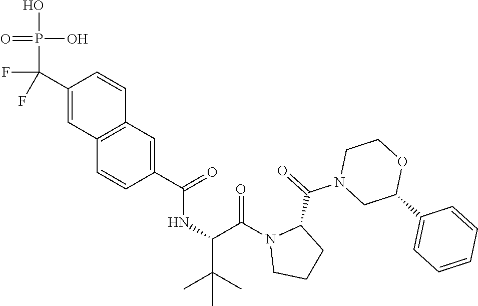 [SMILES: CC(C)(C)[C@H](NC(=O)c1ccc2cc(C(F)(F)P(=O)(O)O)ccc2c1)C(=O)N1CCC[C@H]1C(=O)N1CCO[C@H](c2ccccc2)C1] | ((6-(((S)-3,3-dimethyl-1-oxo-1-((S)- 2-((R)-2-phenylmorpholine-4- carbonyl)pyrrolidin-1-yl)butan-2- yl)carbamoyl)naphthalen-2- yl)difluoromethyl)phosphonic acid |
| 146 | 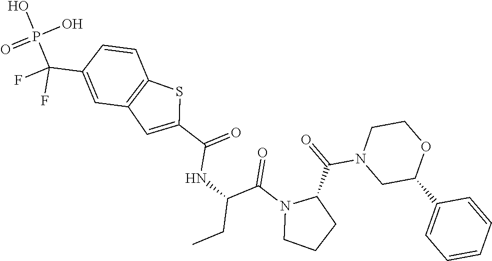 [SMILES: CC[C@H](NC(=O)c1cc2cc(C(F)(F)P(=O)(O)O)ccc2s1)C(=O)N1CCC[C@H]1C(=O)N1CCO[C@H](c2ccccc2)C1] | (difluoro(2-(((S)-1-oxo-1-((S)-2- ((R)-2-phenylmorpholine-4- carbonyl)pyrrolidin-1-yl)butan-2- yl)carbamoyl)benzo[b]thiophen-5- yl)methyl)phosphonic acid |
| 147 | 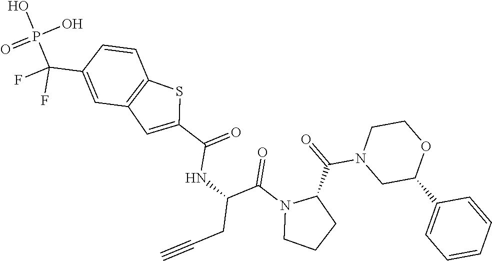 [SMILES: C#CC[C@H](NC(=O)c1cc2cc(C(F)(F)P(=O)(O)O)ccc2s1)C(=O)N1CCC[C@H]1C(=O)N1CCO[C@H](c2ccccc2)C1] | (difluoro(2-(((S)-1-oxo-1-((S)-2- ((R)-2-phenylmorpholine-4- carbonyl)pyrrolidin-1-yl)pent-4-yn- 2-yl)carbamoyl)benzo[b]thiophen-5- yl)methyl)phosphonic acid |
| 148 | 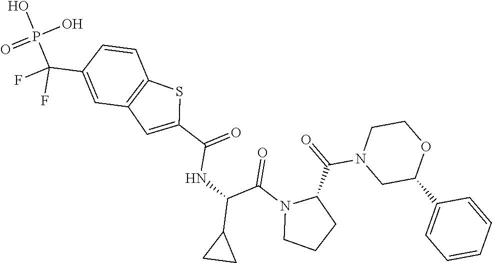 [SMILES: O=C(N[C@H](C(=O)N1CCC[C@H]1C(=O)N1CCO[C@H](c2ccccc2)C1)C1CC1)c1cc2cc(C(F)(F)P(=O)(O)O)ccc2s1] | ((2-(((S)-1-cyclopropyl-2-oxo-2- ((S)-2-((R)-2-phenylmorpholine-4- carbonyl)pyrrolidin-1- yl)ethyl)carbamoyl)benzo[b]thiophen- 5-yl)difluoromethyl)phosphonic acid |
| 149 | 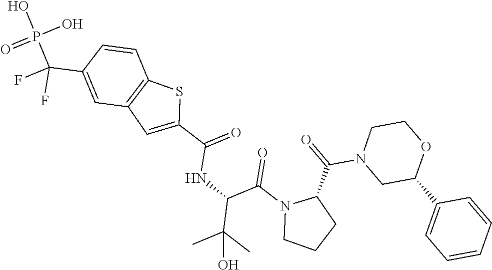 [SMILES: CC(C)(O)[C@H](NC(=O)c1cc2cc(C(F)(F)P(=O)(O)O)ccc2s1)C(=O)N1CCC[C@H]1C(=O)N1CCO[C@H](c2ccccc2)C1] | (difluoro(2-(((S)-3-hydroxy-3- methyl-1-oxo-1-((S)-2-((R)-2- phenylmorpholine-4- carbonyl)pyrrolidin-1-yl)butan-2- yl)carbamoyl)benzo[b]thiophen-5- yl)methyl)phosphonic acid |
| 150 | 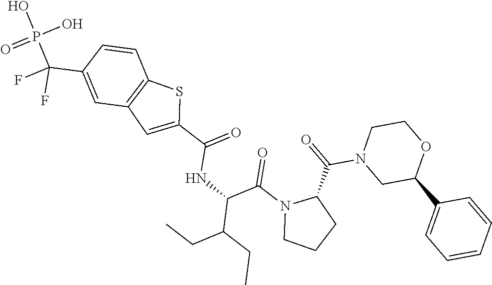 [SMILES: CCC(CC)[C@H](NC(=O)c1cc2cc(C(F)(F)P(=O)(O)O)ccc2s1)C(=O)N1CCC[C@H]1C(=O)N1CCO[C@@H](c2ccccc2)C1] | ((2-(((S)-3-ethyl-1-oxo-1-((S)-2- ((S)-2-phenylmorpholine-4- carbonyl)pyrrolidin-1-yl)pentan-2- yl)carbamoyl)benzo[b]thiophen-5- yl)difluoromethyl)phosphonic acid |
| 151 | 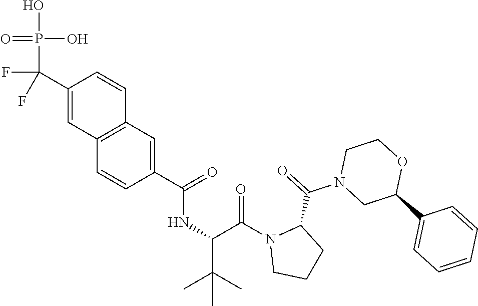 [SMILES: CC(C)(C)[C@H](NC(=O)c1ccc2cc(C(F)(F)P(=O)(O)O)ccc2c1)C(=O)N1CCC[C@H]1C(=O)N1CCO[C@@H](c2ccccc2)C1] | ((6-(((S)-3,3-dimethyl-1-oxo-1-((S)- 2-((S)-2-phenylmorpholine-4- carbonyl)pyrrolidin-1-yl)butan-2- yl)carbamoyl)naphthalen-2- yl)difluoromethyl)phosphonic acid |
| 152 | 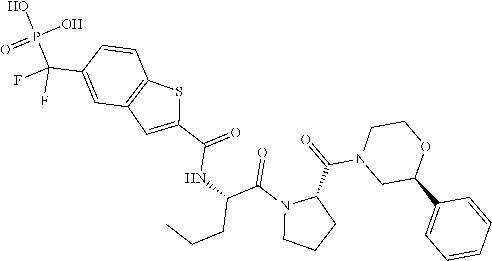 [SMILES: CCC[C@H](NC(=O)c1cc2cc(C(F)(F)P(=O)(O)O)ccc2s1)C(=O)N1CCC[C@H]1C(=O)N1CCO[C@@H](c2ccccc2)C1] | (difluoro(2-(((S)-1-oxo-1-((S)-2- ((S)-2-phenylmorpholine-4- carbonyl)pyrrolidin-1-yl)pentan-2- yl)carbamoyl)benzo[b]thiophen-5- yl)methyl)phosphonic acid |
| 153 | 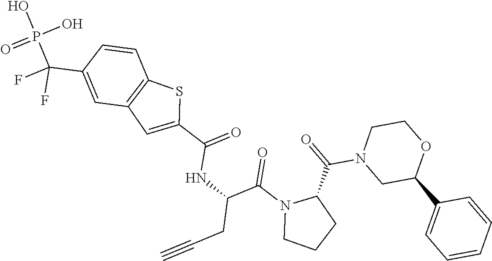 [SMILES: C#CC[C@H](NC(=O)c1cc2cc(C(F)(F)P(=O)(O)O)ccc2s1)C(=O)N1CCC[C@H]1C(=O)N1CCO[C@@H](c2ccccc2)C1] | (difluoro(2-(((S)-1-oxo-1-((S)-2- ((S)-2-phenylmorpholine-4- carbonyl)pyrrolidin-1-yl)pent-4-yn- 2-yl)carbamoyl)benzo[b]thiophen-5- yl)methyl)phosphonic acid |
| 154 | 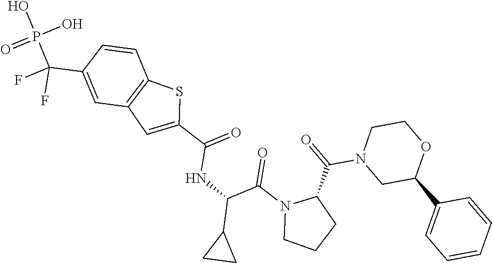 [SMILES: O=C(N[C@H](C(=O)N1CCC[C@H]1C(=O)N1CCO[C@@H](c2ccccc2)C1)C1CC1)c1cc2cc(C(F)(F)P(=O)(O)O)ccc2s1] | ((2-(((S)-1-cyclopropyl-2-oxo-2- ((S)-2-((S)-2-phenylmorpholine-4- carbonyl)pyrrolidin-1- yl)ethyl)carbamoyl)benzo[b]thiophen- 5-yl)difluoromethyl)phosphonic acid |
| 155 | 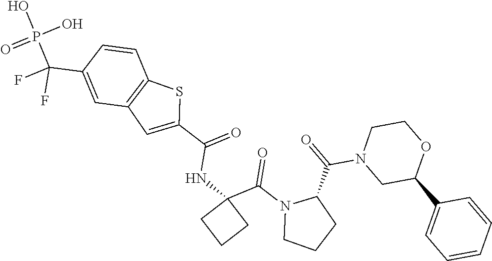 | (difluoro(2-((1-((S)-2-((S)-2- phenylmorpholine-4- carbonyl)pyrrolidine-1- carbonyl)cyclobutyl)carbamoyl) benzo[b]thiophen-5- yl)methyl)phosphonic acid |
| 156 | 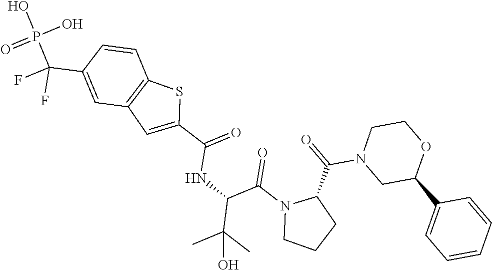 [SMILES: CC(C)(O)[C@H](NC(=O)c1cc2cc(C(F)(F)P(=O)(O)O)ccc2s1)C(=O)N1CCC[C@H]1C(=O)N1CCO[C@@H](c2ccccc2)C1] | (difluoro(2-(((S)-3-hydroxy-3- methyl-1-oxo-1-((S)-2-((S)-2- phenylmorpholine-4- carbonyl)pyrrolidin-1-yl)butan-2- yl)carbamoyl)benzo[b]thiophen-5- yl)methyl)phosphonic acid |
| 157 | 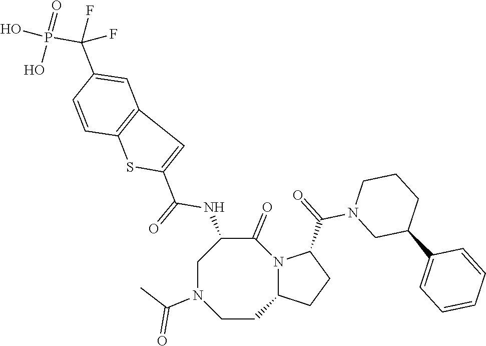 [SMILES: CC(=O)N1CC[C@H]2CC[C@@H](C(=O)N3CCC[C@@H](c4ccccc4)C3)N2C(=O)[C@@H](NC(=O)c2cc3cc(C(F)(F)P(=O)(O)O)ccc3s2)C1] | ((2-(((5S,8S,10aR)-3-acetyl-6-oxo- 8-((S)-3-phenylpiperidine-1- carbonyl)decahydropyrrolo[1,2- a][1,5]diazocin-5- yl)carbamoyl)benzo[b]thiophen-5- yl)difluoromethyl)phosphonic acid |
| 158 | 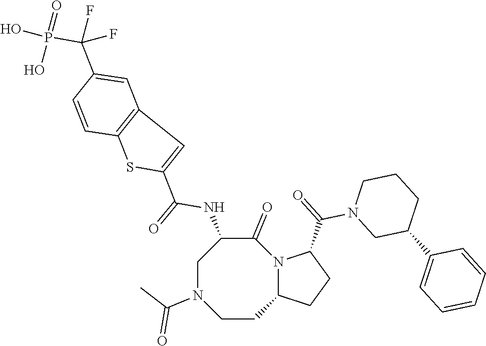 [SMILES: CC(=O)N1CC[C@H]2CC[C@@H](C(=O)N3CCC[C@H](c4ccccc4)C3)N2C(=O)[C@@H](NC(=O)c2cc3cc(C(F)(F)P(=O)(O)O)ccc3s2)C1] | ((2-(((5S,8S,10aR)-3-acetyl-6-oxo- 8-((R)-3-phenylpiperidine-1- carbonyl)decahydropyrrolo[1,2- a][1,5]diazocin-5- yl)carbamoyl)benzo[b]thiophen-5- yl)difluoromethyl)phosphonic acid |
| 159 | 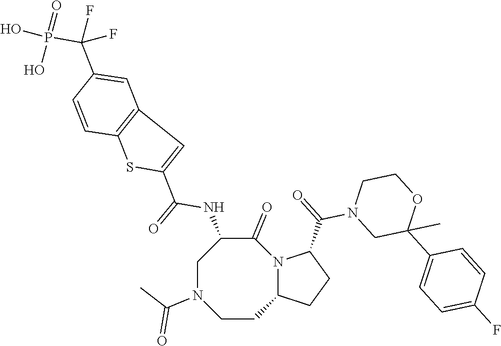 [SMILES: CC(=O)N1CC[C@H]2CC[C@@H](C(=O)N3CCOC(C)(c4ccc(F)cc4)C3)N2C(=O)[C@@H](NC(=O)c2cc3cc(C(F)(F)P(=O)(O)O)ccc3s2)C1] | ((2-(((5S,8S,10aR)-3-acetyl-8-(2-(4- fluorophenyl)-2-methylmorpholine- 4-carbonyl)-6- oxodecahydropyrrolo[1,2- a][1,5]diazocin-5- yl)carbamoyl)benzo[b]thiophen-5- yl)difluoromethyl)phosphonic acid |
| 160 | 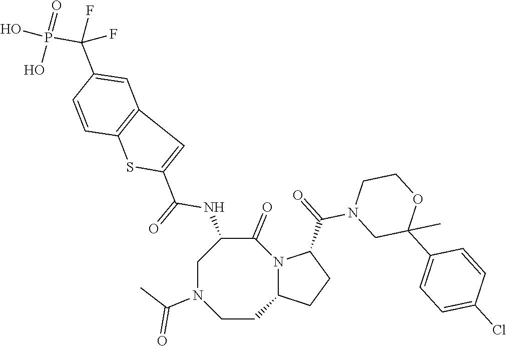 [SMILES: CC(=O)N1CC[C@H]2CC[C@@H](C(=O)N3CCOC(C)(c4ccc(Cl)cc4)C3)N2C(=O)[C@@H](NC(=O)c2cc3cc(C(F)(F)P(=O)(O)O)ccc3s2)C1] | ((2-(((5S,8S,10aR)-3-acetyl-8-(2-(4- chlorophenyl)-2-methylmorpholine- 4-carbonyl)-6- oxodecahydropyrrolo[1,2- a][1,5]diazocin-5- yl)carbamoyl)benzo[b]thiophen-5- yl)difluoromethyl)phosphonic acid |
| 161 | 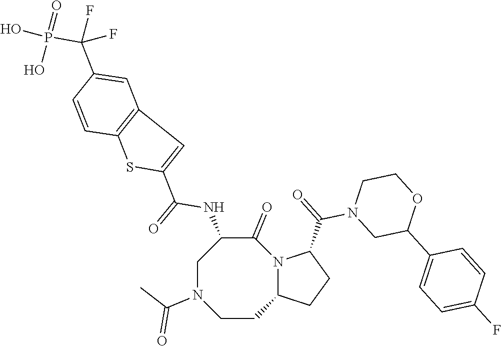 [SMILES: CC(=O)N1CC[C@H]2CC[C@@H](C(=O)N3CCOC(c4ccc(F)cc4)C3)N2C(=O)[C@@H](NC(=O)c2cc3cc(C(F)(F)P(=O)(O)O)ccc3s2)C1] | ((2-(((5S,8S,10aR)-3-acetyl-8-(2-(4- fluorophenyl)morpholine-4- carbonyl)-6- oxodecahydropyrrolo[1,2- a][1,5]diazocin-5- yl)carbamoyl)benzo[b]thiophen-5- yl)difluoromethyl)phosphonic acid |
| 162 | 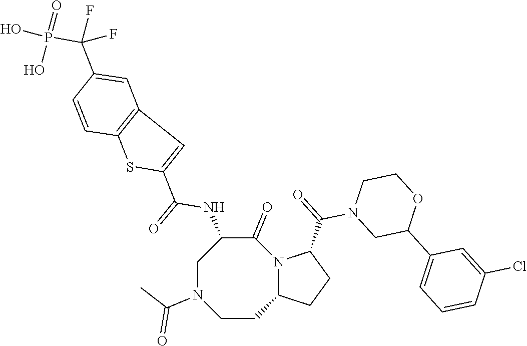 [SMILES: CC(=O)N1CC[C@H]2CC[C@@H](C(=O)N3CCOC(c4cccc(Cl)c4)C3)N2C(=O)[C@@H](NC(=O)c2cc3cc(C(F)(F)P(=O)(O)O)ccc3s2)C1] | ((2-(((5S,8S,10aR)-3-acetyl-8-(2-(3- chlorophenyl)morpholine-4- carbonyl)-6- oxodecahydropyrrolo[1,2- a][1,5]diazocin-5- yl)carbamoyl)benzo[b]thiophen-5- yl)difluoromethyl)phosphonic acid |
| 163 | 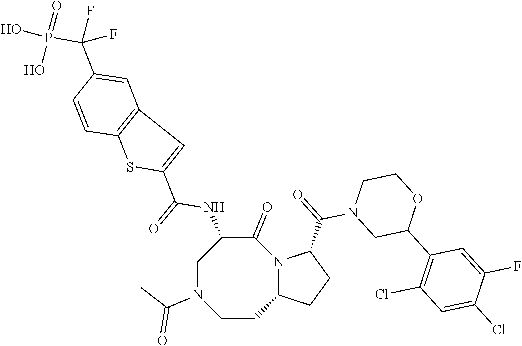 [SMILES: CC(=O)N1CC[C@H]2CC[C@@H](C(=O)N3CCOC(c4cc(F)c(Cl)cc4Cl)C3)N2C(=O)[C@@H](NC(=O)c2cc3cc(C(F)(F)P(=O)(O)O)ccc3s2)C1] | ((2-(((5S,8S,10aR)-3-acetyl-8-(2- (2,4-dichloro-5- fluorophenyl)morpholine-4- carbonyl)-6- oxodecahydropyrrolo[1,2- a][1,5]diazocin-5- yl)carbamoyl)benzo[b]thiophen-5- yl)difluoromethyl)phosphonic acid |
| 164 | 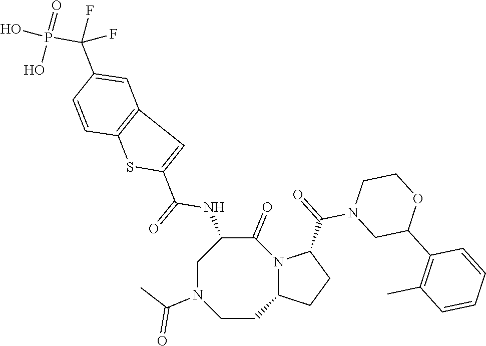 [SMILES: CC(=O)N1CC[C@H]2CC[C@@H](C(=O)N3CCOC(c4ccccc4C)C3)N2C(=O)[C@@H](NC(=O)c2cc3cc(C(F)(F)P(=O)(O)O)ccc3s2)C1] | ((2-(((5S,8S,10aR)-3-acetyl-6-oxo- 8-(2-(o-tolyl)morpholine-4- carbonyl)decahydropyrrolo[1,2- a][1,5]diazocin-5- yl)carbamoyl)benzo[b]thiophen-5- yl)difluoromethyl)phosphonic acid |
| 165 | 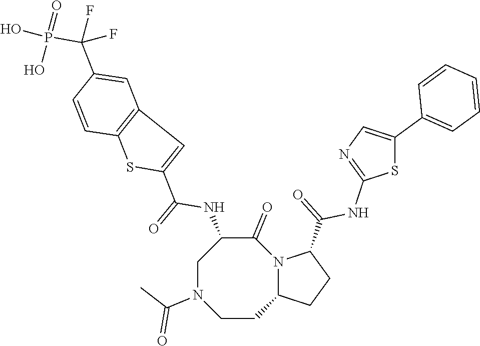 [SMILES: CC(=O)N1CC[C@H]2CC[C@@H](C(=O)Nc3ncc(-c4ccccc4)s3)N2C(=O)[C@@H](NC(=O)c2cc3cc(C(F)(F)P(=O)(O)O)ccc3s2)C1] | ((2-(((5S,8S,10aR)-3-acetyl-6-oxo- 8-((5-phenylthiazol-2- yl)carbamoyl)decahydropyrrolo[1,2- a][1,5]diazocin-5- yl)carbamoyl)benzo[b]thiophen-5- yl)difluoromethyl)phosphonic acid |
| 166 | 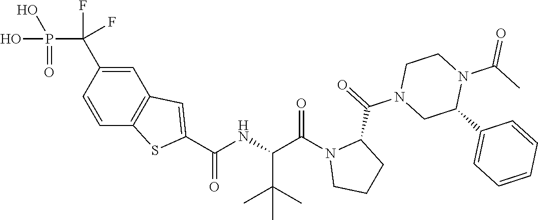 [SMILES: CC(=O)N1CCN(C(=O)[C@@H]2CCCN2C(=O)[C@@H](NC(=O)c2cc3cc(C(F)(F)P(=O)(O)O)ccc3s2)C(C)(C)C)C[C@H]1c1ccccc1] | ((2-(((S)-1-((S)-2-((R)-4-acetyl-3- phenylpiperazine-1- carbonyl)pyrrolidin-1-yl)-3,3- dimethyl-1-oxobutan-2- yl)carbamoyl)benzo[b]thiophen-5- yl)difluoromethyl)phosphonic acid |
| 167 | 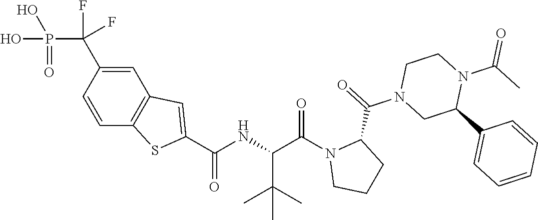 [SMILES: CC(=O)N1CCN(C(=O)[C@@H]2CCCN2C(=O)[C@@H](NC(=O)c2cc3cc(C(F)(F)P(=O)(O)O)ccc3s2)C(C)(C)C)C[C@@H]1c1ccccc1] | ((2-(((S)-1-((S)-2-((S)-4-acetyl-3- phenylpiperazine-1- carbonyl)pyrrolidin-1-yl)-3,3- dimethyl-1-oxobutan-2- yl)carbamoyl)benzo[b]thiophen-5- yl)difluoromethyl)phosphonic acid |
| 168 | 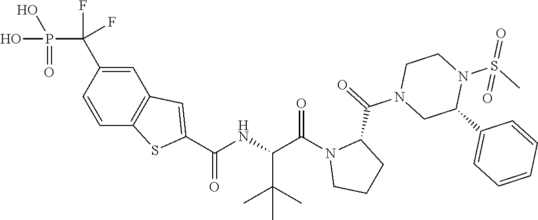 [SMILES: CC(C)(C)[C@H](NC(=O)c1cc2cc(C(F)(F)P(=O)(O)O)ccc2s1)C(=O)N1CCC[C@H]1C(=O)N1CCN(S(C)(=O)=O)[C@H](c2ccccc2)C1] | ((2-(((S)-3,3-dimethyl-1-((S)-2-((R)- 4-(methylsulfonyl)-3- phenylpiperazine-1- carbonyl)pyrrolidin-1-yl)-1- oxobutan-2- yl)carbamoyl)benzo[b]thiophen-5- yl)difluoromethyl)phosphonic acid |
| 169 | 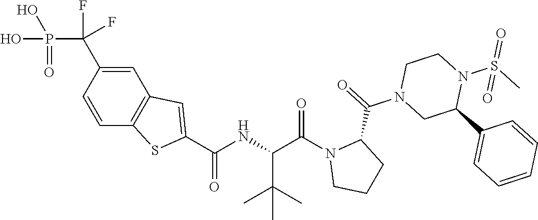 [SMILES: CC(C)(C)[C@H](NC(=O)c1cc2cc(C(F)(F)P(=O)(O)O)ccc2s1)C(=O)N1CCC[C@H]1C(=O)N1CCN(S(C)(=O)=O)[C@@H](c2ccccc2)C1] | ((2-(((S)-3,3-dimethyl-1-((S)-2-((S)- 4-(methylsulfony])-3- phenylpiperazine-1- carbonyl)pyrrolidin-1-yl)-1- oxobutan-2- yl)carbamoyl)benzo[b]thiophen-5- yl)difluoromethyl)phosphonic acid |
| 170 | 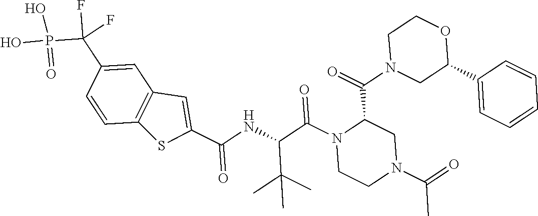 [SMILES: CC(=O)N1CCN(C(=O)[C@@H](NC(=O)c2cc3cc(C(F)(F)P(=O)(O)O)ccc3s2)C(C)(C)C)[C@H](C(=O)N2CCO[C@H](c3ccccc3)C2)C1] | ((2-(((S)-1-((S)-4-acetyl-2-((R)-2- phenylmorpholine-4- carbonyl)piperazin-1-yl)-3,3- dimethyl-1-oxobutan-2- yl)carbamoyl)benzo[b]thiophen-5- yl)difluoromethyl)phosphonic acid |
| 171 | 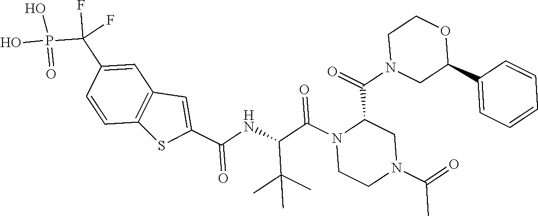 [SMILES: CC(=O)N1CCN(C(=O)[C@@H](NC(=O)c2cc3cc(C(F)(F)P(=O)(O)O)ccc3s2)C(C)(C)C)[C@H](C(=O)N2CCO[C@@H](c3ccccc3)C2)C1] | ((2-(((S)-1-((S)-4-acetyl-2-((S)-2- phenylmorpholine-4- carbonyl)piperazin-1-yl)-3,3- dimethyl-1-oxobutan-2- yl)carbamoyl)benzo[b]thiophen-5- yl)difluoromethyl)phosphonic acid |
| 172 | 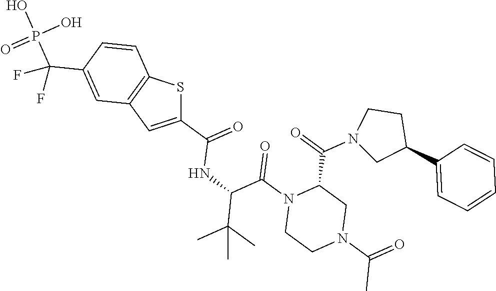 [SMILES: CC(=O)N1CCN(C(=O)[C@@H](NC(=O)c2cc3cc(C(F)(F)P(=O)(O)O)ccc3s2)C(C)(C)C)[C@H](C(=O)N2CC[C@@H](c3ccccc3)C2)C1] | ((2-(((S)-1-((S)-4-acetyl-2-((S)-3- phenylpyrrolidine-1- carbonyl)piperazin-1-yl)-3,3- dimethyl-1-oxobutan-2- yl)carbamoyl)benzo[b]thiophen-5- yl)difluoromethyl)phosphonic acid |
| 173 | 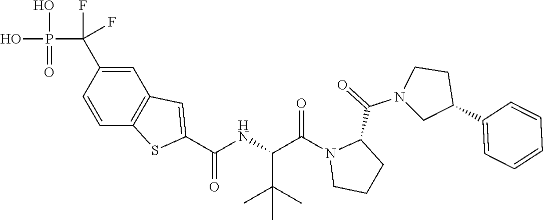 [SMILES: CC(C)(C)[C@H](NC(=O)c1cc2cc(C(F)(F)P(=O)(O)O)ccc2s1)C(=O)N1CCC[C@H]1C(=O)N1CC[C@H](c2ccccc2)C1] | ((2-(((S)-3,3-dimethyl-1-oxo-1-((S)- 2-((R)-3-phenylpyrrolidine-1- carbonyl)pyrrolidin-1-yl)butan-2- yl)carbamoyl)benzo[b]thiophen-5- yl)difluoromethyl)phosphonic acid |
| 174 | 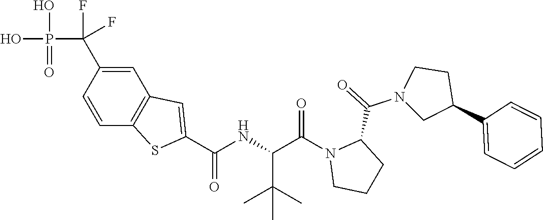 [SMILES: CC(C)(C)[C@H](NC(=O)c1cc2cc(C(F)(F)P(=O)(O)O)ccc2s1)C(=O)N1CCC[C@H]1C(=O)N1CC[C@@H](c2ccccc2)C1] | ((2-(((S)-3,3-dimethyl-1-oxo-1-((S)- 2-((S)-3-phenylpyrrolidine-1- carbonyl)pyrrolidin-1-yl)butan-2- yl)carbamoyl)benzo[b]thiophen-5- yl)difluoromethyl)phosphonic acid |
| 175 | 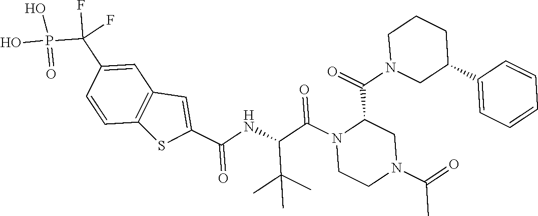 [SMILES: CC(=O)N1CCN(C(=O)[C@@H](NC(=O)c2cc3cc(C(F)(F)P(=O)(O)O)ccc3s2)C(C)(C)C)[C@H](C(=O)N2CCC[C@H](c3ccccc3)C2)C1] | ((2-(((S)-1-((S)-4-acetyl-2-((R)-3- phenylpiperidine-1- carbonyl)piperazin-1-yl)-3,3- dimethyl-1-oxobutan-2- yl)carbamoyl)benzo[b]thiophen-5- yl)difluoromethyl)phosphonic acid |
| 176 | 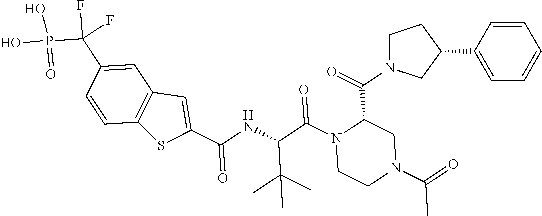 [SMILES: CC(=O)N1CCN(C(=O)[C@@H](NC(=O)c2cc3cc(C(F)(F)P(=O)(O)O)ccc3s2)C(C)(C)C)[C@H](C(=O)N2CC[C@H](c3ccccc3)C2)C1] | ((2-(((S)-1-((S)-4-acetyl-2-((R)-3- phenylpyrrolidine-1- carbonyl)piperazin-1-yl)-3,3- dimethyl-1-oxobutan-2- yl)carbamoyl)benzo[b]thiophen-5- yl)difluoromethyl)phosphonic acid |
| 177 | 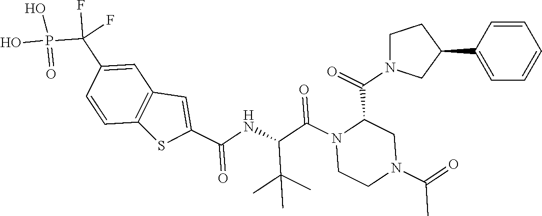 [SMILES: CC(=O)N1CCN(C(=O)[C@@H](NC(=O)c2cc3cc(C(F)(F)P(=O)(O)O)ccc3s2)C(C)(C)C)[C@H](C(=O)N2CC[C@@H](c3ccccc3)C2)C1] | ((2-(((S)-1-((S)-4-acetyl-2-((S)-3- phenylpyrrolidine-1- carbonyl)piperazin-1-yl)-3,3- dimethyl-1-oxobutan-2- yl)carbamoyl)benzo[b]thiophen-5- yl)difluoromethyl)phosphonic acid |
| 178 | 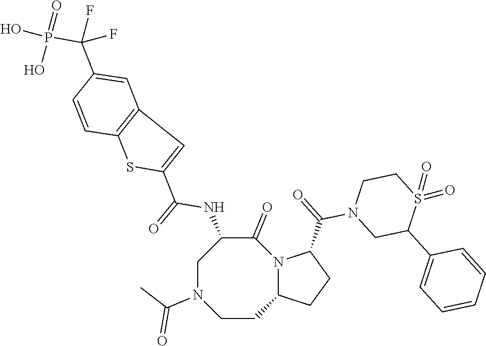 [SMILES: CC(=O)N1CC[C@H]2CC[C@@H](C(=O)N3CCS(=O)(=O)C(c4ccccc4)C3)N2C(=O)[C@@H](NC(=O)c2cc3cc(C(F)(F)P(=O)(O)O)ccc3s2)C1] | ((2-(((5S,8S,10aR)-3-acetyl-8-(1,1- dioxido-2-phenylthiomorpholine-4- carbonyl)-6- oxodecahydropyrrolo[1,2- a][1,5]diazocin-5- yl)carbamoyl)benzo[b]thiophen-5- yl)difluoromethyl)phosphonic acid |
| 179 | 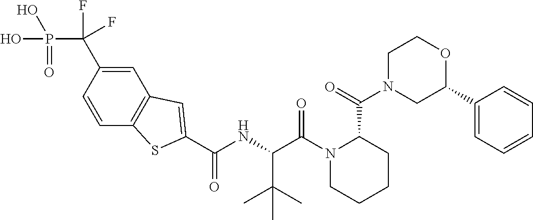 [SMILES: CC(C)(C)[C@H](NC(=O)c1cc2cc(C(F)(F)P(=O)(O)O)ccc2s1)C(=O)N1CCCC[C@H]1C(=O)N1CCO[C@H](c2ccccc2)C1] | ((2-(((S)-3,3-dimethyl-1-oxo-1-((S)- 2-((R)-2-phenylmorpholine-4- carbonyl)piperidin-1-yl)butan-2- yl)carbamoyl)benzo[b]thiophen-5- yl)difluoromethyl)phosphonic acid |
| 180 | 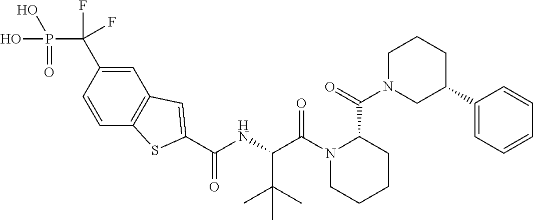 [SMILES: CC(C)(C)[C@H](NC(=O)c1cc2cc(C(F)(F)P(=O)(O)O)ccc2s1)C(=O)N1CCCC[C@H]1C(=O)N1CCC[C@H](c2ccccc2)C1] | ((2-(((S)-3,3-dimethyl-1-oxo-1-((S)- 2-((R)-3-phenylpiperidine-1- carbonyl)piperidin-1-yl)butan-2- yl)carbamoyl)benzo[b]thiophen-5- yl)difluoromethyl)phosphonic acid |
| 181 | 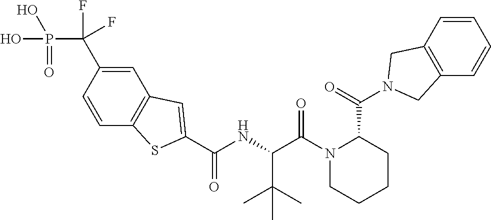 [SMILES: CC(C)(C)[C@H](NC(=O)c1cc2cc(C(F)(F)P(=O)(O)O)ccc2s1)C(=O)N1CCCC[C@H]1C(=O)N1Cc2ccccc2C1] | (difluoro(2-(((S)-1-((S)-2- (isoindoline-2-carbonyl)piperidin-1- yl)-3,3-dimethyl-1-oxobutan-2- yl)carbamoyl)benzo[b]thiophen-5- yl)methyl)phosphonic acid |
| 182 | 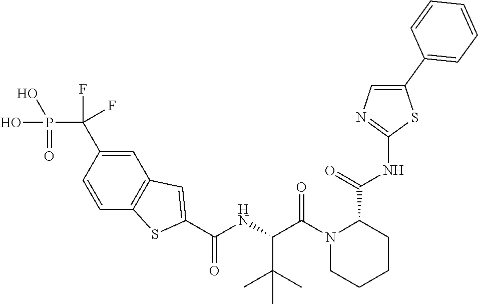 [SMILES: CC(C)(C)[C@H](NC(=O)c1cc2cc(C(F)(F)P(=O)(O)O)ccc2s1)C(=O)N1CCCC[C@H]1C(=O)Nc1ncc(-c2ccccc2)s1] | ((2-(((S)-3,3-dimethyl-1-oxo-1-((S)- 2-((5-phenylthiazol-2- yl)carbamoyl)piperidin-1-yl)butan- 2-yl)carbamoyl)benzo[b]thiophen-5- yl)difluoromethyl)phosphonic acid |
| 183 | 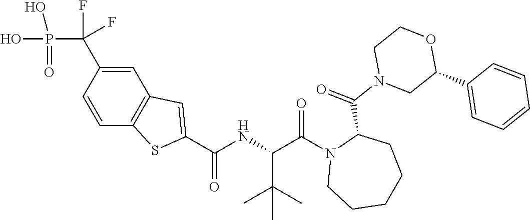 [SMILES: CC(C)(C)[C@H](NC(=O)c1cc2cc(C(F)(F)P(=O)(O)O)ccc2s1)C(=O)N1CCCCC[C@H]1C(=O)N1CCO[C@H](c2ccccc2)C1] | ((2-(((S)-3,3-dimethyl-1-oxo-1-((S)- 2-((R)-2-phenylmorpholine-4- carbonyl)azepan-1-yl)butan-2- yl)carbamoyl)benzo[b]thiophen-5- yl)difluoromethyl)phosphonic acid |
| 184 | 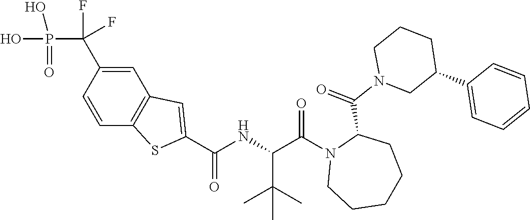 [SMILES: CC(C)(C)[C@H](NC(=O)c1cc2cc(C(F)(F)P(=O)(O)O)ccc2s1)C(=O)N1CCCCC[C@H]1C(=O)N1CCC[C@H](c2ccccc2)C1] | ((2-(((S)-3,3-dimethyl-1-oxo-1-((S)- 2-((R)-3-phenylpiperidine-1- carbonyl)azepan-1-yl)butan-2- yl)carbamoyl)benzo[b]thiophen-5- yl)difluoromethyl)phosphonic acid |
| 185 | 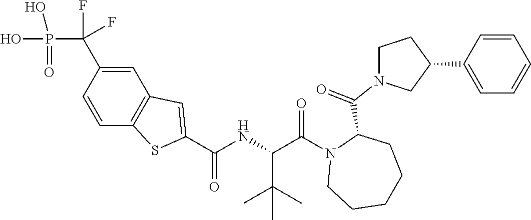 [SMILES: CC(C)(C)[C@H](NC(=O)c1cc2cc(C(F)(F)P(=O)(O)O)ccc2s1)C(=O)N1CCCCC[C@H]1C(=O)N1CC[C@H](c2ccccc2)C1] | ((2-(((S)-3,3-dimethyl-1-oxo-1-((S)- 2-((R)-3-phenylpyrrolidine-1- carbonyl)azepan-1-yl)butan-2- yl)carbamoyl)benzo[b]thiophen-5- yl)difluoromethyl)phosphonic acid |
| 186 | 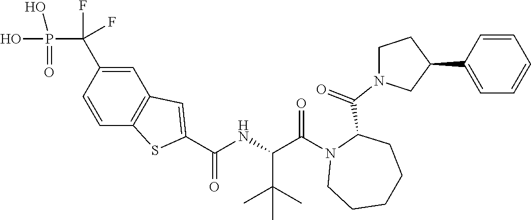 [SMILES: CC(C)(C)[C@H](NC(=O)c1cc2cc(C(F)(F)P(=O)(O)O)ccc2s1)C(=O)N1CCCCC[C@H]1C(=O)N1CC[C@@H](c2ccccc2)C1] | ((2-(((S)-3,3-dimethyl-1-oxo-1-((S)- 2-((S)-3-phenylpyrrolidine-1- carbonyl)azepan-1-yl)butan-2- yl)carbamoyl)benzo[b]thiophen-5- yl)difluoromethyl)phosphonic acid |
| 187 | 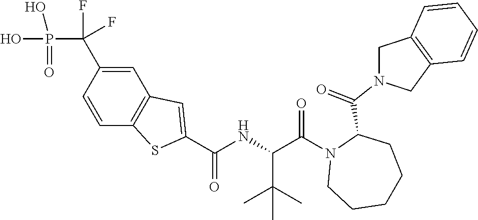 [SMILES: CC(C)(C)[C@H](NC(=O)c1cc2cc(C(F)(F)P(=O)(O)O)ccc2s1)C(=O)N1CCCCC[C@H]1C(=O)N1Cc2ccccc2C1] | (difluoro(2-(((S)-1-((S)-2- (isoindoline-2-carbonyl)azepan-1- yl)-3,3-dimethyl-1-oxobutan-2- yl)carbamoyl)benzo[b]thiophen-5- yl)methyl)phosphonic acid |
| 188 | 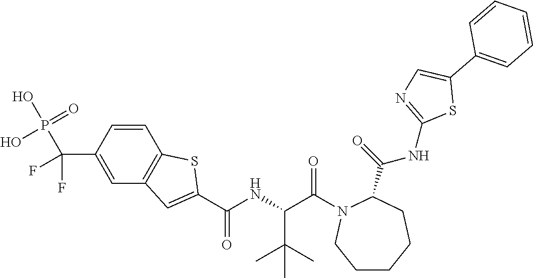 [SMILES: CC(C)(C)[C@H](NC(=O)c1cc2cc(C(F)(F)P(=O)(O)O)ccc2s1)C(=O)N1CCCCC[C@H]1C(=O)Nc1ncc(-c2ccccc2)s1] | ((2-(((S)-3,3-dimethyl-1-oxo-1-((S)- 2-((5-phenylthiazol-2- yl)carbamoyl)azepan-1-yl)butan-2- yl)carbamoyl)benzo[b]thiophen-5- yl)difluoromethyl)phosphonic acid |
| 189 | 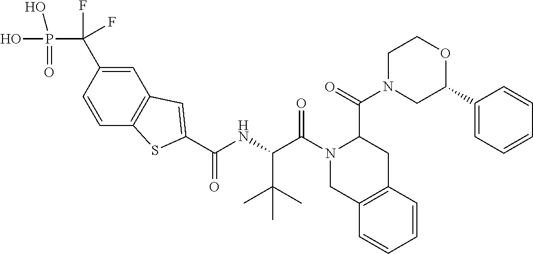 [SMILES: CC(C)(C)[C@H](NC(=O)c1cc2cc(C(F)(F)P(=O)(O)O)ccc2s1)C(=O)N1Cc2ccccc2CC1C(=O)N1CCO[C@H](c2ccccc2)C1] | ((2-(((2S)-3,3-dimethyl-1-oxo-1-(3- ((R)-2-phenylmorpholine-4- carbonyl)-3,4-dihydroisoquinolin- 2(1H)-yl)butan-2- yl)carbamoyl)benzo[b]thiophen-5- yl)difluoromethyl)phosphonic acid |
| 190 | 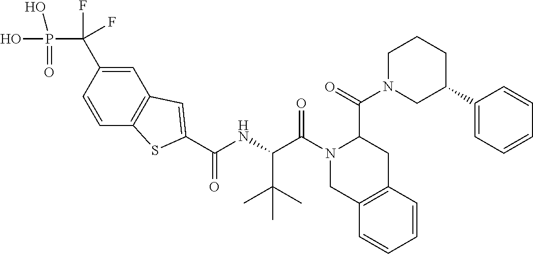 [SMILES: CC(C)(C)[C@H](NC(=O)c1cc2cc(C(F)(F)P(=O)(O)O)ccc2s1)C(=O)N1Cc2ccccc2CC1C(=O)N1CCC[C@H](c2ccccc2)C1] | ((2-(((2S)-3,3-dimethyl-1-oxo-1-(3- ((R)-3-phenylpiperidine-1- carbonyl)-3,4-dihydroisoquinolin- 2(1H)-yl)butan-2- yl)carbamoyl)benzo[b]thiophen-5- yl)difluoromethyl)phosphonic acid |
| 191 | 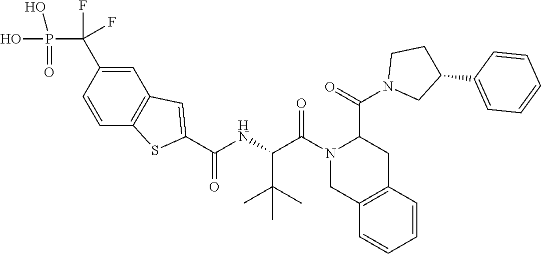 [SMILES: CC(C)(C)[C@H](NC(=O)c1cc2cc(C(F)(F)P(=O)(O)O)ccc2s1)C(=O)N1Cc2ccccc2CC1C(=O)N1CC[C@H](c2ccccc2)C1] | ((2-(((2S)-3,3-dimethyl-1-oxo-1-(3- ((R)-3-phenylpyrrolidine-1- carbonyl)-3,4-dihydroisoquinolin- 2(1H)-yl)butan-2- yl)carbamoyl)benzo[b]thiophen-5- yl)difluoromethyl)phosphonic acid |
| 192 | 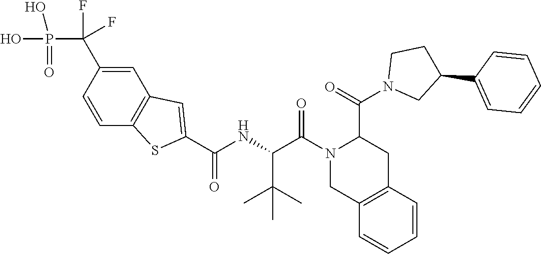 [SMILES: CC(C)(C)[C@H](NC(=O)c1cc2cc(C(F)(F)P(=O)(O)O)ccc2s1)C(=O)N1Cc2ccccc2CC1C(=O)N1CC[C@@H](c2ccccc2)C1] | ((2-(((2S)-3,3-dimethyl-1-oxo-1-(3- ((S)-3-phenylpyrrolidine-1- carbonyl)-3,4-dihydroisoquinolin- 2(1H)-yl)butan-2- yl)carbamoyl)benzo[b]thiophen-5- yl)difluoromethyl)phosphonic acid |
| 193 | 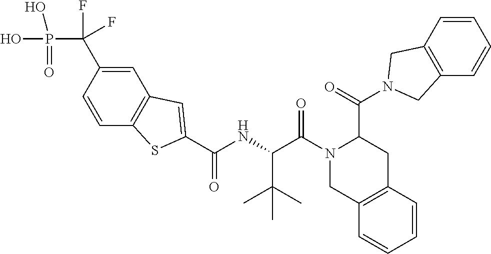 [SMILES: CC(C)(C)[C@H](NC(=O)c1cc2cc(C(F)(F)P(=O)(O)O)ccc2s1)C(=O)N1Cc2ccccc2CC1C(=O)N1Cc2ccccc2C1] | (difluoro(2-(((2S)-1-(3-(isoindoline- 2-carbonyl)-3,4-dihydroisoquinolin- 2(1H)-yl)-3,3-dimethyl-1-oxobutan- 2-yl)carbamoyl)benzo[b]thiophen-5- yl)methyl)phosphonic acid |
| 194 | 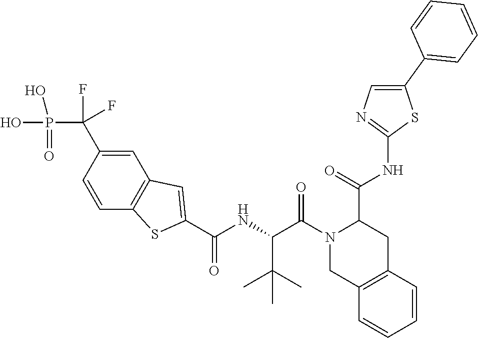 [SMILES: CC(C)(C)[C@H](NC(=O)c1cc2cc(C(F)(F)P(=O)(O)O)ccc2s1)C(=O)N1Cc2ccccc2CC1C(=O)Nc1ncc(-c2ccccc2)s1] | ((2-(((2S)-3,3-dimethyl-1-oxo-1-(3- ((5-phenylthiazol-2-yl)carbamoyl)- 3,4-dihydroisoquinolin-2(1H)- yl)butan-2- yl)carbamoyl)benzo[b]thiophen-5- yl)difluoromethyl)phosphonic acid |
| 195 | 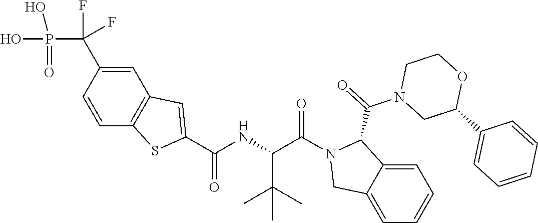 [SMILES: CC(C)(C)[C@H](NC(=O)c1cc2cc(C(F)(F)P(=O)(O)O)ccc2s1)C(=O)N1Cc2ccccc2[C@H]1C(=O)N1CCO[C@H](c2ccccc2)C1] | ((2-(((S)-3,3-dimethyl-1-oxo-1-((S)- 1-((R)-2-phenylmorpholine-4- carbonyl)isoindolin-2-yl)butan-2- yl)carbamoyl)benzo[b]thiophen-5- yl)difluoromethyl)phosphonic acid |
| 196 | 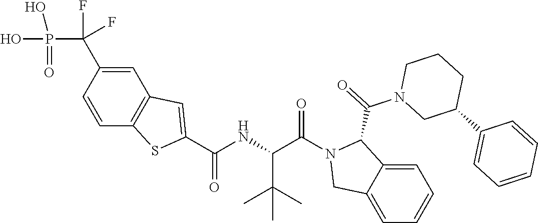 [SMILES: CC(C)(C)[C@H](NC(=O)c1cc2cc(C(F)(F)P(=O)(O)O)ccc2s1)C(=O)N1Cc2ccccc2[C@H]1C(=O)N1CCC[C@H](c2ccccc2)C1] | ((2-(((S)-3,3-dimethyl-1-oxo-1-((S)- 1-((R)-3-phenylpiperidine-1- carbonyl)isoindolin-2-yl)butan-2- yl)carbamoyl)benzo[b]thiophen-5- yl)difluoromethyl)phosphonic acid |
| 197 | 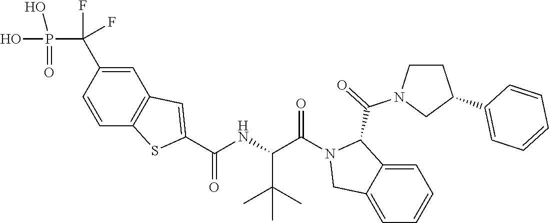 [SMILES: CC(C)(C)[C@H](NC(=O)c1cc2cc(C(F)(F)P(=O)(O)O)ccc2s1)C(=O)N1Cc2ccccc2[C@H]1C(=O)N1CC[C@H](c2ccccc2)C1] | ((2-(((S)-3,3-dimethyl-1-oxo-1-((S)- 1-((R)-3-phenylpyrrolidine-1- carbonyl)isoindolin-2-yl)butan-2- yl)carbamoyl)benzo[b]thiophen-5- yl)difluoromethyl)phosphonic acid |
| 198 | 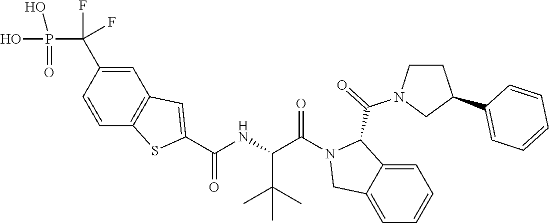 [SMILES: CC(C)(C)[C@H](NC(=O)c1cc2cc(C(F)(F)P(=O)(O)O)ccc2s1)C(=O)N1Cc2ccccc2[C@H]1C(=O)N1CC[C@@H](c2ccccc2)C1] | ((2-(((S)-3,3-dimethyl-1-oxo-1-((S)- 1-((S)-3-phenylpyrrolidine-1- carbonyl)isoindolin-2-yl)butan-2- yl)carbamoyl)benzo[b]thiophen-5- yl)difluoromethyl)phosphonic acid |
| 199 | 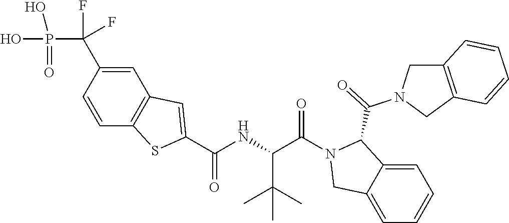 [SMILES: CC(C)(C)[C@H](NC(=O)c1cc2cc(C(F)(F)P(=O)(O)O)ccc2s1)C(=O)N1Cc2ccccc2[C@H]1C(=O)N1Cc2ccccc2C1] | (difluoro(2-(((S)-1-((S)-1- (isoindoline-2-carbonyl)isoindolin- 2-yl)-3,3-dimethyl-1-oxobutan-2- yl)carbamoyl)benzo[b]thiophen-5- yl)methyl)phosphonic acid |
| 200 | 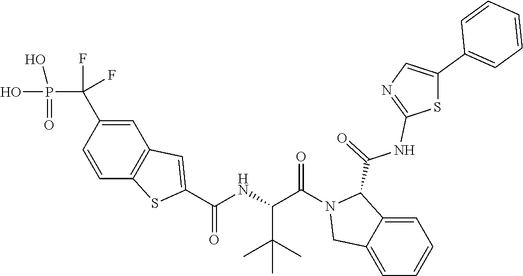 [SMILES: CC(C)(C)[C@H](NC(=O)c1cc2cc(C(F)(F)P(=O)(O)O)ccc2s1)C(=O)N1Cc2ccccc2[C@H]1C(=O)Nc1ncc(-c2ccccc2)s1] | ((2-(((S)-3,3-dimethyl-1-oxo-1-((S)- 1-((5-phenylthiazol-2- yl)carbamoyl)isoindolin-2-yl)butan- 2-yl)carbamoyl)benzo[b]thiophen-5- yl)difluoromethyl)phosphonic acid |
| 201 | 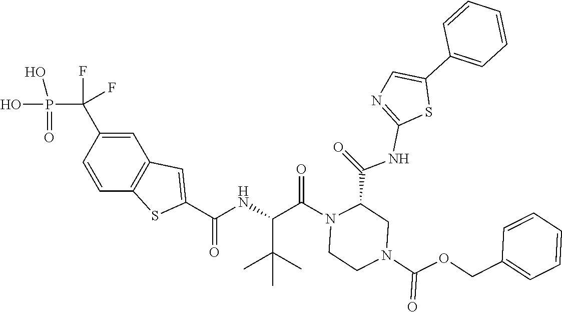 [SMILES: CC(C)(C)[C@H](NC(=O)c1cc2cc(C(F)(F)P(=O)(O)O)ccc2s1)C(=O)N1CCN(C(=O)OCc2ccccc2)C[C@H]1C(=O)Nc1ncc(-c2ccccc2)s1] | ((2-(((S)-1-((S)-4- ((benzyloxy)carbonyl)-2-((5- phenylthiazol-2- yl)carbamoyl)piperazin-1-yl)-3,3- dimethyl-1-oxobutan-2- yl)carbamoyl)benzo[b]thiophen-5- yl)difluoromethyl)phosphonic acid |
| 202 | 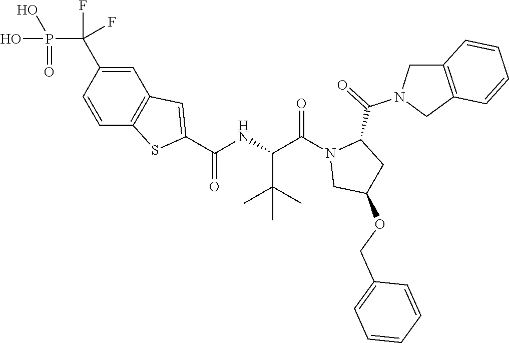 [SMILES: CC(C)(C)[C@H](NC(=O)c1cc2cc(C(F)(F)P(=O)(O)O)ccc2s1)C(=O)N1C[C@H](OCc2ccccc2)C[C@H]1C(=O)N1Cc2ccccc2C1] | ((2-(((S)-1-((2S,4R)-4-(benzyloxy)- 2-(isoindoline-2- carbonyl)pyrrolidin-1-yl)-3,3- dimethyl-1-oxobutan-2- yl)carbamoyl)benzo[b]thiophen-5- yl)difluoromethyl)phosphonic acid |
| 203 | 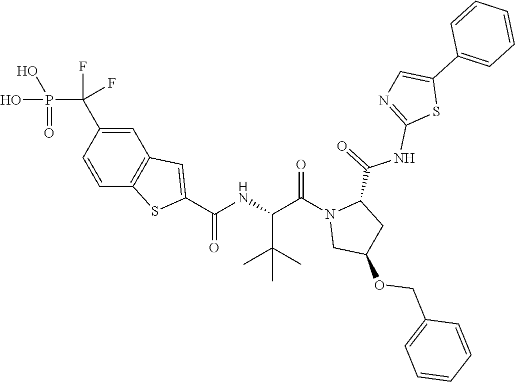 [SMILES: CC(C)(C)[C@H](NC(=O)c1cc2cc(C(F)(F)P(=O)(O)O)ccc2s1)C(=O)N1C[C@H](OCc2ccccc2)C[C@H]1C(=O)Nc1ncc(-c2ccccc2)s1] | ((2-(((S)-1-((2S,4R)-4-(benzyloxy)- 2-((5-phenylthiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 204 | 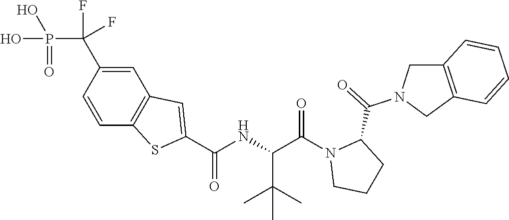 [SMILES: CC(C)(C)[C@H](NC(=O)c1cc2cc(C(F)(F)P(=O)(O)O)ccc2s1)C(=O)N1CCC[C@H]1C(=O)N1Cc2ccccc2C1] | (difluoro(2-(((S)-1-((S)-2- (isoindoline-2-carbonyl)pyrrolidin- 1-yl)-3,3-dimethyl-1-oxobutan-2- yl)carbamoyl)benzo[b]thiophen-5- yl)methyl)phosphonic acid |
| 205 | 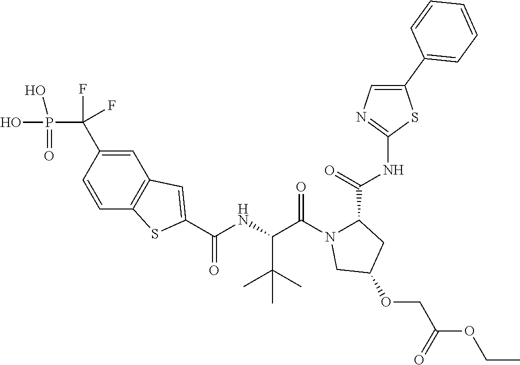 [SMILES: CCOC(=O)CO[C@H]1C[C@@H](C(=O)Nc2ncc(-c3ccccc3)s2)N(C(=O)[C@@H](NC(=O)c2cc3cc(C(F)(F)P(=O)(O)O)ccc3s2)C(C)(C)C)C1] | ((2-(((S)-1-((2S,4S)-4-(2-ethoxy-2- oxoethoxy)-2-((5-phenylthiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 206 | 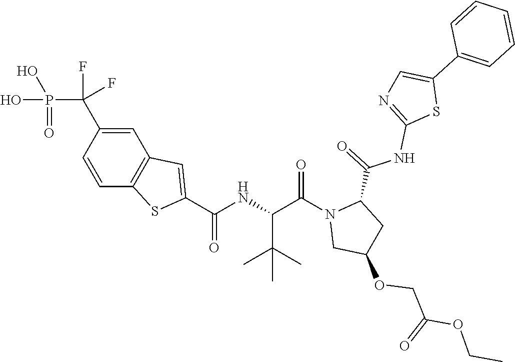 [SMILES: CCOC(=O)CO[C@@H]1C[C@@H](C(=O)Nc2ncc(-c3ccccc3)s2)N(C(=O)[C@@H](NC(=O)c2cc3cc(C(F)(F)P(=O)(O)O)ccc3s2)C(C)(C)C)C1] | ((2-(((S)-1-((2S,4R)-4-(2-ethoxy-2- oxoethoxy)-2-((5-phenylthiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 207 | 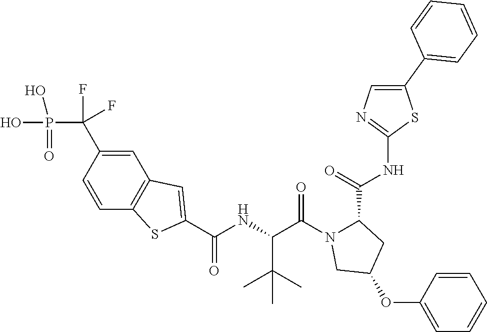 [SMILES: CC(C)(C)[C@H](NC(=O)c1cc2cc(C(F)(F)P(=O)(O)O)ccc2s1)C(=O)N1C[C@@H](Oc2ccccc2)C[C@H]1C(=O)Nc1ncc(-c2ccccc2)s1] | ((2-(((S)-3,3-dimethyl-1-oxo-1- ((2S,4S)-4-phenoxy-2-((5- phenylthiazol-2- yl)carbamoyl)pyrrolidin-1-yl)butan- 2-yl)carbamoyl)benzo[b]thiophen-5- yl)difluoromethyl)phosphonic acid |
| 208 | 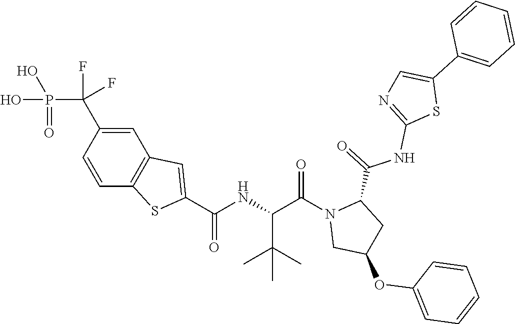 [SMILES: CC(C)(C)[C@H](NC(=O)c1cc2cc(C(F)(F)P(=O)(O)O)ccc2s1)C(=O)N1C[C@H](Oc2ccccc2)C[C@H]1C(=O)Nc1ncc(-c2ccccc2)s1] | ((2-(((S)-3,3-dimethyl-1-oxo-1- ((2S,4R)-4-phenoxy-2-((5- phenylthiazol-2- yl)carbamoyl)pyrrolidin-1-yl)butan- 2-yl)carbamoyl)benzo[b]thiophen-5- yl)difluoromethyl)phosphonic acid |
| 209 | 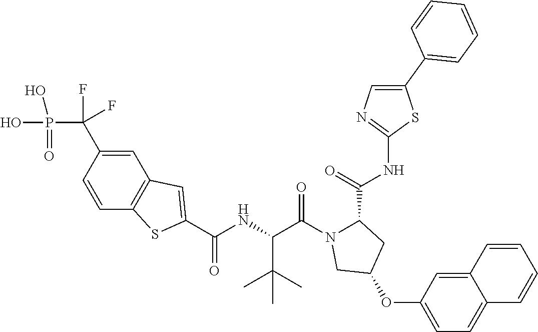 [SMILES: CC(C)(C)[C@H](NC(=O)c1cc2cc(C(F)(F)P(=O)(O)O)ccc2s1)C(=O)N1C[C@@H](Oc2ccc3ccccc3c2)C[C@H]1C(=O)Nc1ncc(-c2ccccc2)s1] | ((2-(((S)-3,3-dimethyl-1-((2S,4S)-4- (naphthalen-2-yloxy)-2-((5- phenylthiazol-2- yl)carbamoyl)pyrrolidin-1-yl)-1- oxobutan-2- yl)carbamoyl)benzo[b]thiophen-5- yl)difluoromethyl)phosphonic acid |
| 210 | 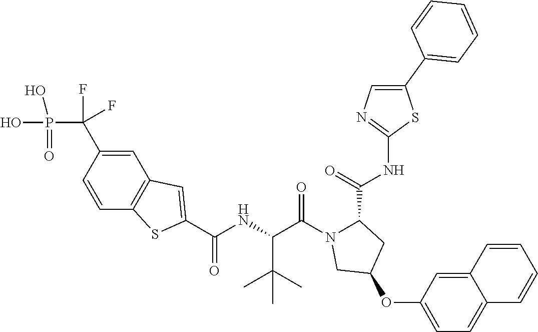 [SMILES: CC(C)(C)[C@H](NC(=O)c1cc2cc(C(F)(F)P(=O)(O)O)ccc2s1)C(=O)N1C[C@H](Oc2ccc3ccccc3c2)C[C@H]1C(=O)Nc1ncc(-c2ccccc2)s1] | ((2-(((S)-3,3-dimethyl-1-((2S,4R)-4- (naphthalen-2-yloxy)-2-((5- phenylthiazol-2- yl)carbamoyl)pyrrolidin-1-yl)-1- oxobutan-2- yl)carbamoyl)benzo[b]thiophen-5- yl)difluoromethyl)phosphonic acid |
| 211 | 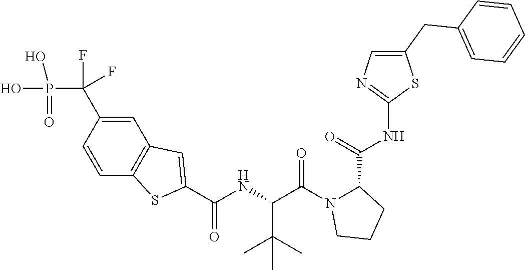 [SMILES: CC(C)(C)[C@H](NC(=O)c1cc2cc(C(F)(F)P(=O)(O)O)ccc2s1)C(=O)N1CCC[C@H]1C(=O)Nc1ncc(Cc2ccccc2)s1] | ((2-(((S)-1-((S)-2-((5-benzylthiazol- 2-yl)carbamoyl)pyrrolidin-1-yl)-3,3- dimethyl-1-oxobutan-2- yl)carbamoyl)benzo[b]thiophen-5- yl)difluoromethyl)phosphonic acid |
| 212 | 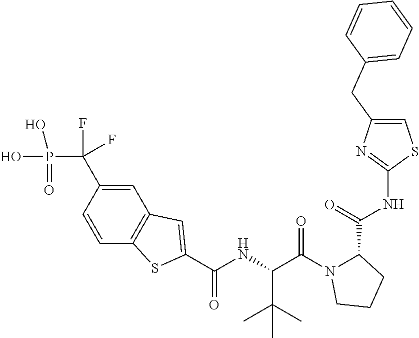 [SMILES: CC(C)(C)[C@H](NC(=O)c1cc2cc(C(F)(F)P(=O)(O)O)ccc2s1)C(=O)N1CCC[C@H]1C(=O)Nc1nc(Cc2ccccc2)cs1] | ((2-(((S)-1-((S)-2-((4-benzylthiazol- 2-yl)carbamoyl)pyrrolidin-1-yl)-3,3- dimethyl-1-oxobutan-2- yl)carbamoyl)benzo[b]thiophen-5- yl)difluoromethyl)phosphonic acid |
| 213 | 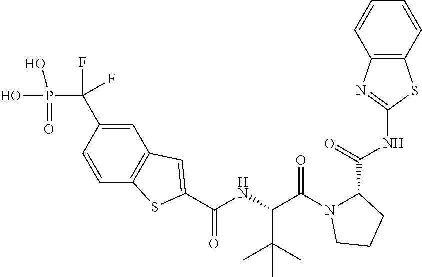 [SMILES: CC(C)(C)[C@H](NC(=O)c1cc2cc(C(F)(F)P(=O)(O)O)ccc2s1)C(=O)N1CCC[C@H]1C(=O)Nc1nc2ccccc2s1] | ((2-(((S)-1-((S)-2-(benzo[d]thiazol- 2-ylcarbamoyl)pyrrolidin-1-yl)-3,3- dimethyl-1-oxobutan-2- yl)carbamoyl)benzo[b]thiophen-5- yl)difluoromethyl)phosphonic acid |
| 214 | 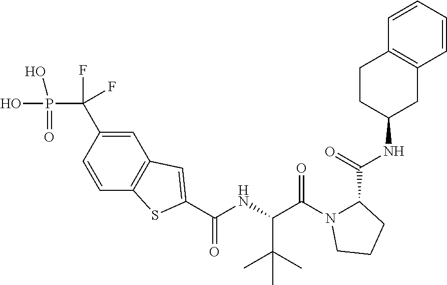 [SMILES: CC(C)(C)[C@H](NC(=O)c1cc2cc(C(F)(F)P(=O)(O)O)ccc2s1)C(=O)N1CCC[C@H]1C(=O)N[C@H]1CCc2ccccc2C1] | ((2-(((S)-3,3-dimethyl-1-oxo-1-((S)- 2-(((S)-1,2,3,4- tetrahydronaphthalen-2- yl)carbamoyl)pyrrolidin-1-yl)butan- 2-yl)carbamoyl)benzo[b]thiophen-5- yl)difluoromethyl)phosphonic acid |
| 215 | 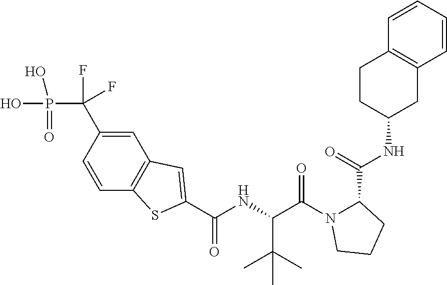 [SMILES: CC(C)(C)[C@H](NC(=O)c1cc2cc(C(F)(F)P(=O)(O)O)ccc2s1)C(=O)N1CCC[C@H]1C(=O)N[C@@H]1CCc2ccccc2C1] | ((2-(((S)-3,3-dimethyl-1-oxo-1-((S)- 2-(((R)-1,2,3,4- tetrahydronaphthalen-2- yl)carbamoyl)pyrrolidin-1-yl)butan- 2-yl)carbamoyl)benzo[b]thiophen-5- yl)difluoromethyl)phosphonic acid |
| 216 | 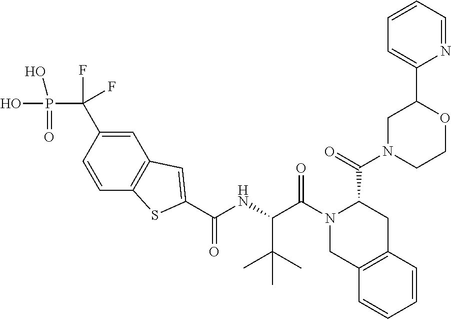 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccccn2)C1] | ((2-(((2S)-3,3-dimethyl-1-oxo-1- ((3S)-3-(2-(pyridin-2- yl)morpholine-4-carbonyl)-3,4- dihydroisoquinolin-2(1H)-yl)butan- 2-yl)carbamoyl)benzo[b]thiophen-5- yl)difluoromethyl)phosphonic acid |
| 217 | 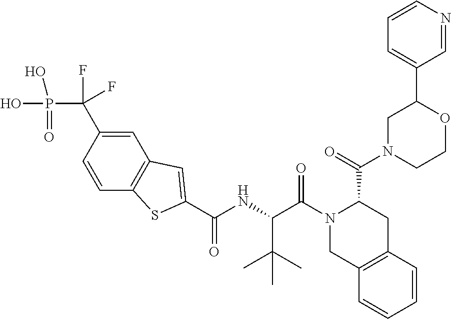 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2cccnc2)C1] | ((2-(((2S)-3,3-dimethyl-1-oxo-1- ((3S)-3-(2-(pyridin-3- yl)morpholine-4-carbonyl)-3,4- dihydroisoquinolin-2(1H)-yl)butan- 2-yl)carbamoyl)benzo[b]thiophen-5- yl)difluoromethyl)phosphonic acid |
| 218 | 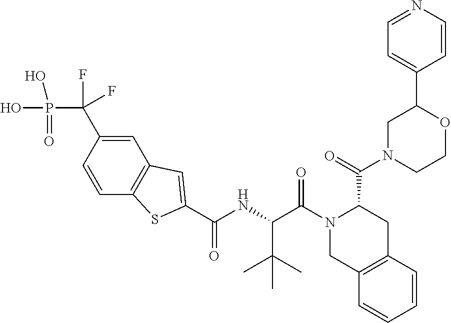 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccncc2)C1] | ((2-(((2S)-3,3-dimethyl-1-oxo-1- ((3S)-3-(2-(pyridin-4- yl)morpholine-4-carbonyl)-3,4- dihydroisoquinolin-2(1H)-yl)butan- 2-yl)carbamoyl)benzo[b]thiophen-5- yl)difluoromethyl)phosphonic acid |
| 219 | 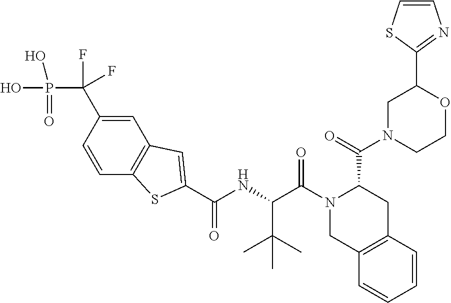 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2nccs2)C1] | ((2-(((2S)-3,3-dimethyl-1-oxo-1- ((3S)-3-(2-(thiazol-2-yl)morpholine- 4-carbonyl)-3,4-dihydroisoquinolin- 2(1H)-yl)butan-2- yl)carbamoyl)benzo[b]thiophen-5- yl)difluoromethyl)phosphonic acid |
| 220 | 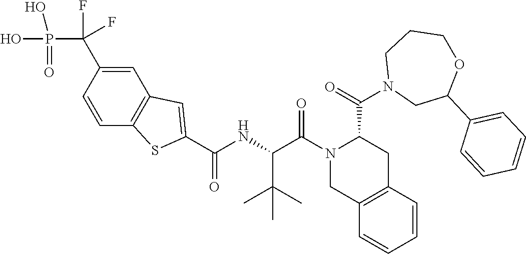 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCCOC(c2ccccc2)C1] | ((2-(((2S)-3,3-dimethyl-1-oxo-1- ((3S)-3-(2-phenyl-1,4-oxazepane-4- carbonyl)-3,4-dihydroisoquinolin- 2(1H)-yl)butan-2- yl)carbamoyl)benzo[b]thiophen-5- yl)difluoromethyl)phosphonic acid |
| 221 | 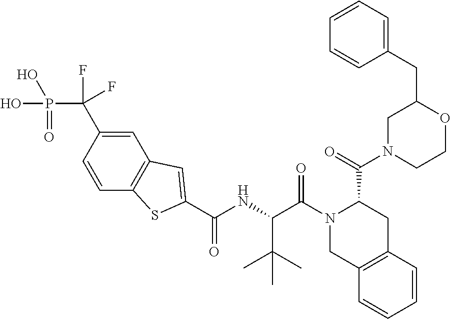 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(Cc2ccccc2)C1] | ((2-(((2S)-1-((3S)-3-(2- benzylmorpholine-4-carbonyl)-3,4- dihydroisoquinolin-2(1H)-yl)-3,3- dimethyl-1-oxobutan-2- yl)carbamoyl)benzo[b]thiophen-5- yl)difluoromethyl)phosphonic acid |
| 222 | 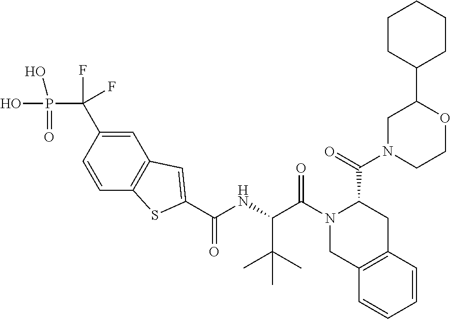 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(C2CCCCC2)C1] | ((2-(((2S)-1-((3S)-3-(2- cyclohexylmorpholine-4-carbonyl)- 3,4-dihydroisoquinolin-2(1H)-yl)- 3,3-dimethyl-1-oxobutan-2- yl)carbamoyl)benzo[b]thiophen-5- yl)difluoromethyl)phosphonic acid |
| 223 | 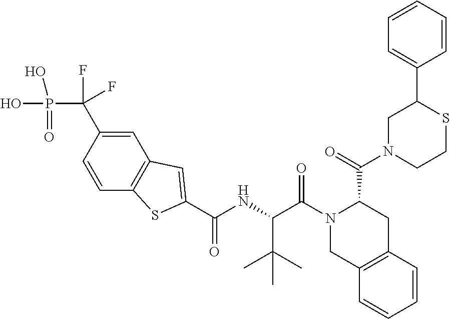 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCSC(c2ccccc2)C1] | ((2-(((2S)-3,3-dimethyl-1-oxo-1- ((3S)-3-(2-phenylthiomorpholine-4- carbonyl)-3,4-dihydroisoquinolin- 2(1H)-yl)butan-2- yl)carbamoyl)benzo[b]thiophen-5- yl)difluoromethyl)phosphonic acid |
| 224 | 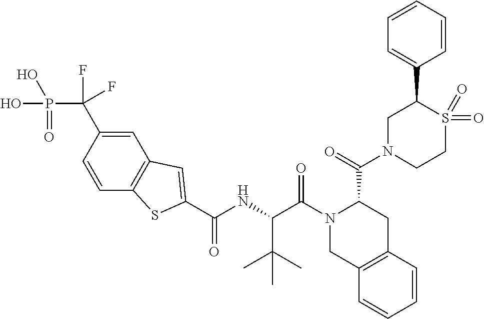 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCS(=O)(=O)[C@H](c2ccccc2)C1] | ((2-(((S)-1-((S)-3-((R)-1,1-dioxido- 2-phenylthiomorpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 225 | 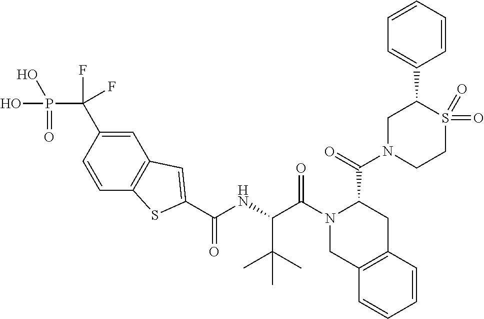 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCS(=O)(=O)[C@@H](c2ccccc2)C1] | ((2-(((S)-1-((S)-3-((S)-1,1-dioxido- 2-phenylthiomorpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 226 | 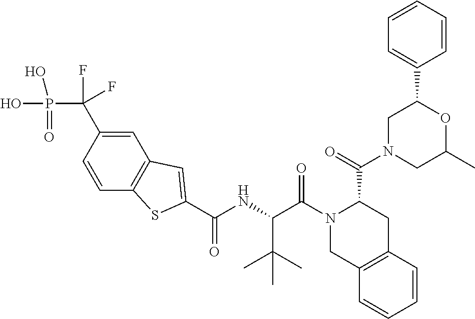 [SMILES: CC1CN(C(=O)[C@@H]2Cc3ccccc3CN2C(=O)[C@@H](NC(=O)c2cc3cc(C(F)(F)P(=O)(O)O)ccc3s2)C(C)(C)C)C[C@H](c2ccccc2)O1] | ((2-(((2S)-3,3-dimethyl-1-((3S)-3- (2-methyl-6-phenylmorpholine-4- carbonyl)-3,4-dihydroisoquinolin- 2(1H)-yl)-1-oxobutan-2- yl)carbamoyl)benzo[b]thiophen-5- yl)difluoromethyl)phosphonic acid |
| 227 | 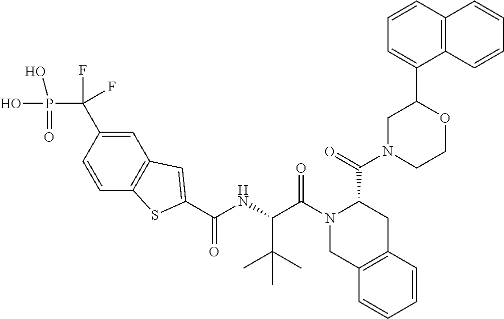 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2cccc3ccccc23)C1] | ((2-(((2S)-3,3-dimethyl-1-((3S)-3- (2-(naphthalen-1-yl)morpholine-4- carbonyl)-3,4-dihydroisoquinolin- 2(1H)-yl)-1-oxobutan-2- yl)carbamoyl)benzo[b]thiophen-5- yl)difluoromethyl)phosphonic acid |
| 228 | 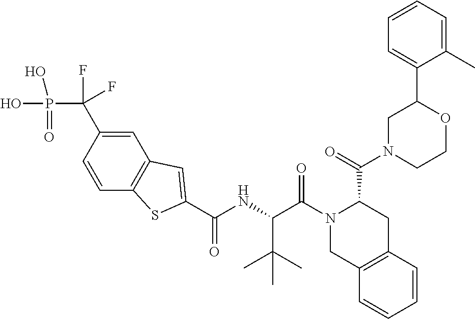 [SMILES: Cc1ccccc1C1CN(C(=O)[C@@H]2Cc3ccccc3CN2C(=O)[C@@H](NC(=O)c2cc3cc(C(F)(F)P(=O)(O)O)ccc3s2)C(C)(C)C)CCO1] | ((2-(((2S)-3,3-dimethyl-1-oxo-1- ((3S)-3-(2-(o-tolyl)morpholine-4- carbonyl)-3,4-dihydroisoquinolin- 2(1H)-yl)butan-2- yl)carbamoyl)benzo[b]thiophen-5- yl)difluoromethyl)phosphonic acid |
| 229 | 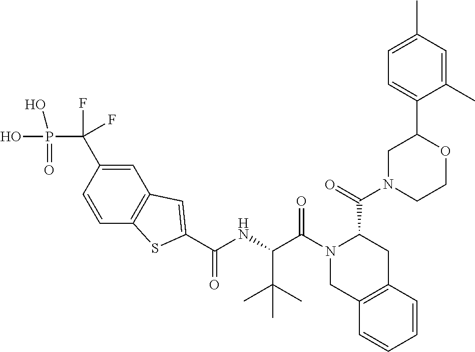 [SMILES: Cc1ccc(C2CN(C(=O)[C@@H]3Cc4ccccc4CN3C(=O)[C@@H](NC(=O)c3cc4cc(C(F)(F)P(=O)(O)O)ccc4s3)C(C)(C)C)CCO2)c(C)c1] | ((2-(((2S)-1-((3S)-3-(2-(2,4- dimethylphenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 230 | 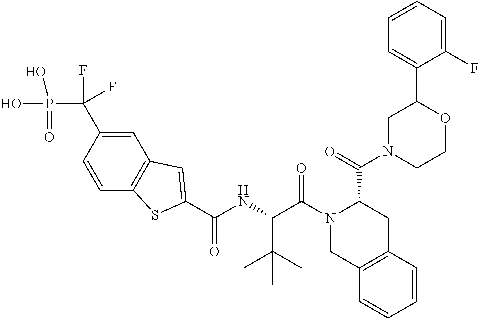 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccccc2F)C1] | (difluoro(2-(((2S)-1-((3S)-3-(2-(2- fluorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)methyl)phosphonic acid |
| 231 | 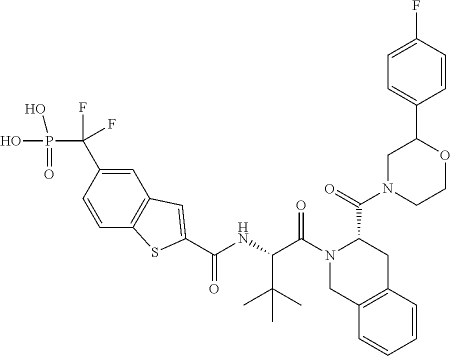 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccc(F)cc2)C1] | (difluoro(2-(((2S)-1-((3S)-3-(2-(4- fluorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)methyl)phosphonic acid |
| 232 | 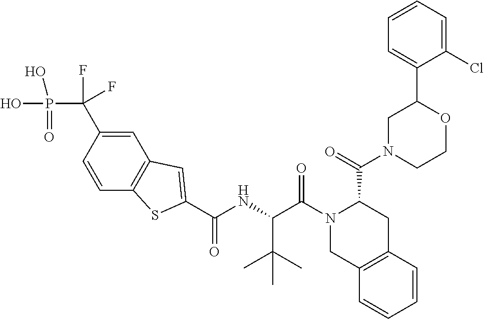 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccccc2Cl)C1] | ((2-(((2S)-1-((3S)-3-(2-(2- chlorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 233 | 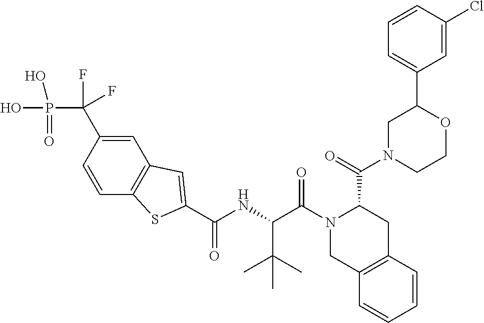 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2cccc(Cl)c2)C1] | ((2-(((2S)-1-((3S)-3-(2-(3- chlorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 234 | 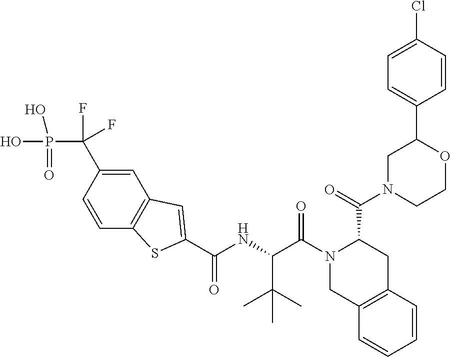 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccc(Cl)cc2)C1] | ((2-(((2S)-1-((3S)-3-(2-(4- chlorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 235 | 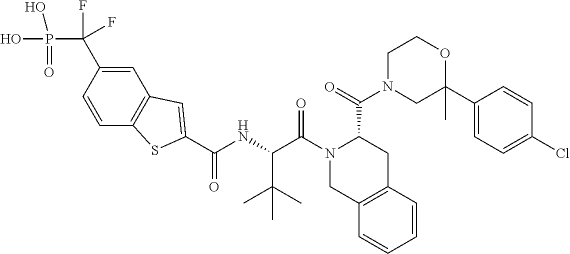 [SMILES: CC1(c2ccc(Cl)cc2)CN(C(=O)[C@@H]2Cc3ccccc3CN2C(=O)[C@@H](NC(=O)c2cc3cc(C(F)(F)P(=O)(O)O)ccc3s2)C(C)(C)C)CCO1] | ((2-(((2S)-1-((3S)-3-(2-(4- chlorophenyl)-2-methylmorpholine- 4-carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 236 | 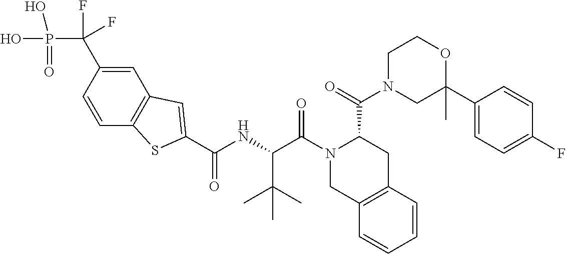 [SMILES: CC1(c2ccc(F)cc2)CN(C(=O)[C@@H]2Cc3ccccc3CN2C(=O)[C@@H](NC(=O)c2cc3cc(C(F)(F)P(=O)(O)O)ccc3s2)C(C)(C)C)CCO1] | (difluoro(2-(((2S)-1-((3S)-3-(2-(4- fluorophenyl)-2-methylmorpholine- 4-carbonyl)-3,4-dihydroisoquinolin- 2(1H)-yl)-3,3-dimethyl-1-oxobutan- 2-yl)carbamoyl)benzo[b]thiophen-5- yl)methyl)phosphonic acid |
| 237 | 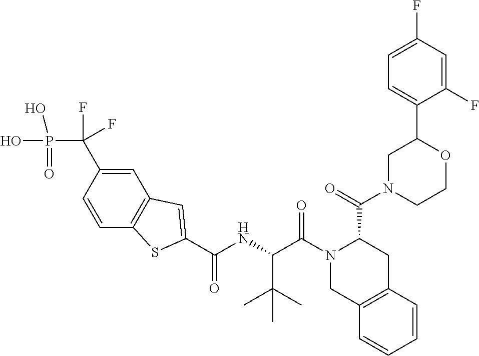 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccc(F)cc2F)C1] | ((2-(((2S)-1-((3S)-3-(2-(2,4- difluorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 238 | 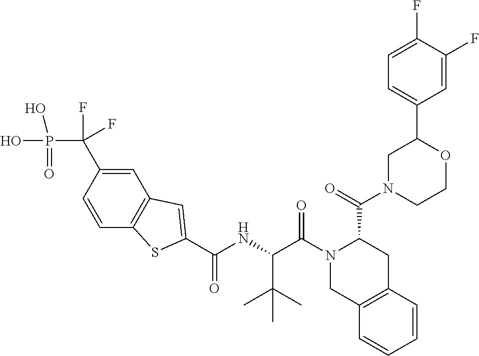 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccc(F)c(F)c2)C1] | ((2-(((2S)-1-((3S)-3-(2-(3,4- difluorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 239 | 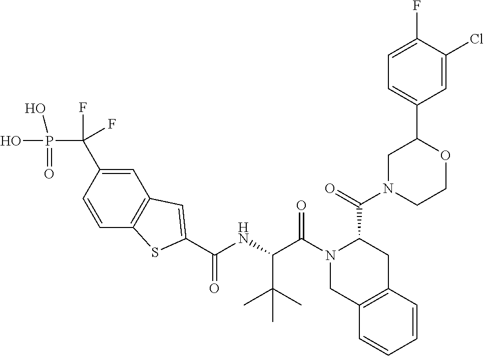 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccc(F)c(Cl)c2)C1] | ((2-(((2S)-1-((3S)-3-(2-(3-chloro-4- fluorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 240 | 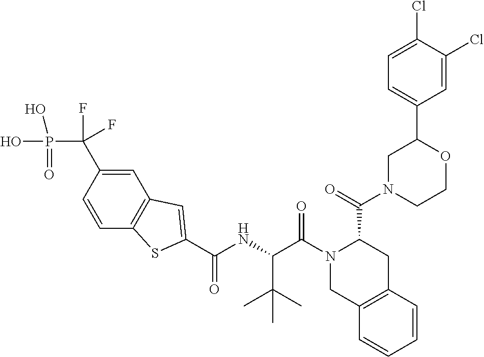 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2ccc(Cl)c(Cl)c2)C1] | ((2-(((2S)-1-((3S)-3-(2-(3,4- dichlorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 241 | 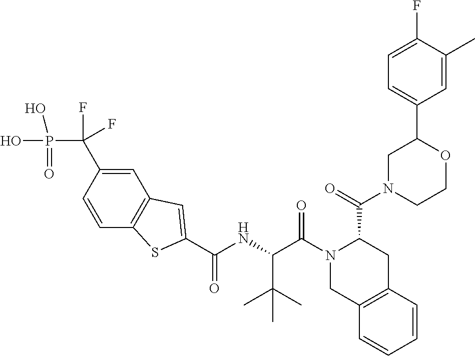 [SMILES: Cc1cc(C2CN(C(=O)[C@@H]3Cc4ccccc4CN3C(=O)[C@@H](NC(=O)c3cc4cc(C(F)(F)P(=O)(O)O)ccc4s3)C(C)(C)C)CCO2)ccc1F] | (difluoro(2-(((2S)-1-((3S)-3-(2-(4- fluoro-3-methylphenyl)morpholine- 4-carbonyl)-3,4-dihydroisoquinolin- 2(1H)-yl)-3,3-dimethyl-1-oxobutan- 2-yl)carbamoyl)benzo[b]thiophen-5- yl)methyl)phosphonic acid |
| 242 | 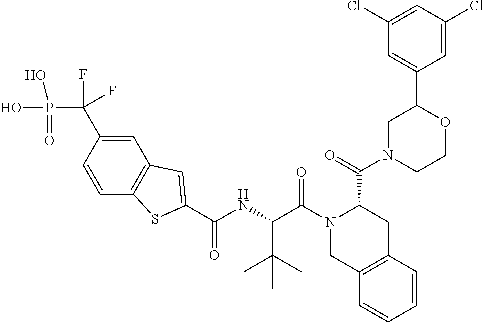 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2cc(Cl)cc(Cl)c2)C1] | ((2-(((2S)-1-((3S)-3-(2-(3,5- dichlorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 243 | 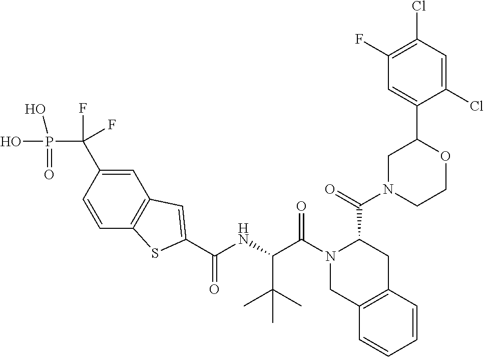 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCOC(c2cc(F)c(Cl)cc2Cl)C1] | ((2-(((2S)-1-((3S)-3-(2-(2,4- dichloro-5- fluorophenyl)morpholine-4- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 244 | 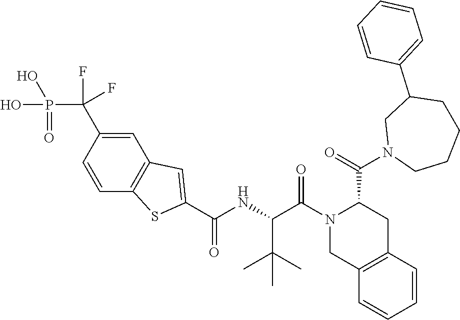 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCCCC(c2ccccc2)C1] | ((2-(((2S)-3,3-dimethyl-1-oxo-1- ((3S)-3-(3-phenylazepane-1- carbonyl)-3,4-dihydroisoquinolin- 2(1H)-yl)butan-2- yl)carbamoyl)benzo[b]thiophen-5- yl)difluoromethyl)phosphonic acid |
| 245 | 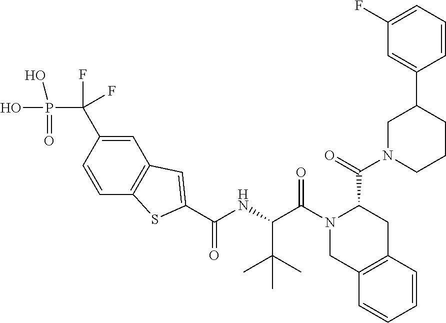 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCCC(c2cccc(F)c2)C1] | (difluoro(2-(((2S)-1-((3S)-3-(3-(3- fluorophenyl)piperidine-1- carbonyl)-3,4-dihydroisoquinolin- 2(1H)-yl)-3,3-dimethyl-1-oxobutan- 2-yl)carbamoyl)benzo[b]thiophen-5- yl)methyl)phosphonic acid |
| 246 | 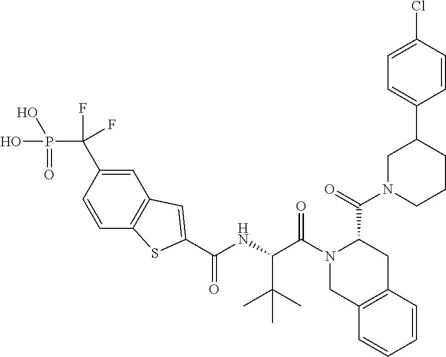 [SMILES: CC(C)(C)[C@H](NC(=O)c1cc2cc(C(F)(F)P(=O)(O)O)ccc2s1)C(=O)N1Cc2ccccc2C[C@H]1C(=O)N1CCCC(c2ccc(Cl)cc2)C1] | ((2-(((2S)-1-((3S)-3-(3-(4- chlorophenyl)piperidine-1- carbonyl)-3,4-dihydroisoquinolin- 2(1H)-yl)-3,3-dimethyl-1-oxobutan- 2-yl)carbamoyl)benzo[b]thiophen-5- yl)difluoromethyl)phosphonic acid |
| 247 | 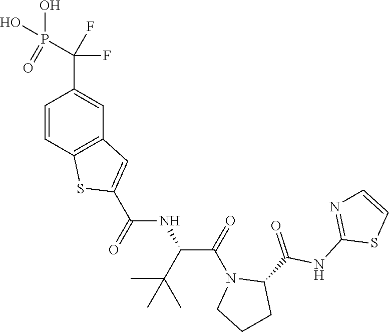 [SMILES: CC(C)(C)[C@H](NC(=O)c1cc2cc(C(F)(F)P(=O)(O)O)ccc2s1)C(=O)N1CCC[C@H]1C(=O)Nc1nccs1] | ((2-(((S)-3,3-dimethyl-1-oxo-1-((S)- 2-(thiazol-2-ylcarbamoyl)pyrrolidin- 1-yl)butan-2- yl)carbamoyl)benzo[b]thiophen-5- yl)difluoromethyl)phosphonic acid |
| 248 | 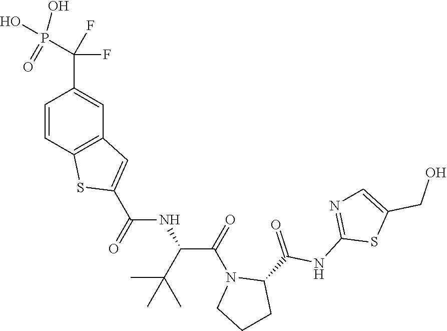 [SMILES: CC(C)(C)[C@H](NC(=O)c1cc2cc(C(F)(F)P(=O)(O)O)ccc2s1)C(=O)N1CCC[C@H]1C(=O)Nc1ncc(CO)s1] | (difluoro(2-(((S)-1-((S)-2-((5- (hydroxymethyl)thiazol-2- yl)carbamoyl)pyrrolidin-1-yl)-3,3- dimethyl-1-oxobutan-2- yl)carbamoyl)benzo[b]thiophen-5- yl)methyl)phosphonic acid |
| 249 | 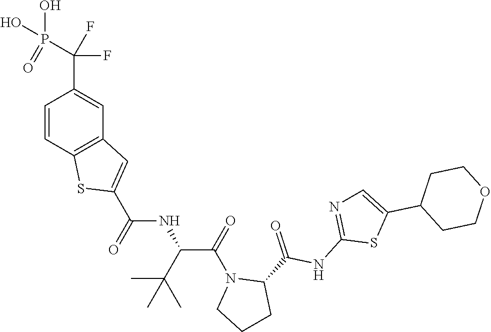 [SMILES: CC(C)(C)[C@H](NC(=O)c1cc2cc(C(F)(F)P(=O)(O)O)ccc2s1)C(=O)N1CCC[C@H]1C(=O)Nc1ncc(C2CCOCC2)s1] | ((2-(((S)-3,3-dimethyl-1-oxo-1-((S)- 2-((5-(tetrahydro-2H-pyran-4- yl)thiazol-2- yl)carbamoyl)pyrrolidin-1-yl)butan- 2-yl)carbamoyl)benzo[b]thiophen-5- yl)difluoromethyl)phosphonic acid |
| 250 | 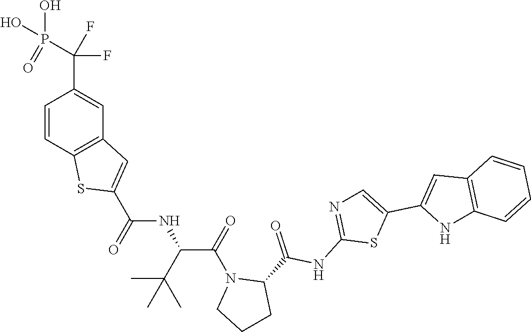 [SMILES: CC(C)(C)[C@H](NC(=O)c1cc2cc(C(F)(F)P(=O)(O)O)ccc2s1)C(=O)N1CCC[C@H]1C(=O)Nc1ncc(-c2cc3ccccc3[nH]2)s1] | ((2-(((S)-1-((S)-2-((5-(1H-indol-2- yl)thiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 251 | 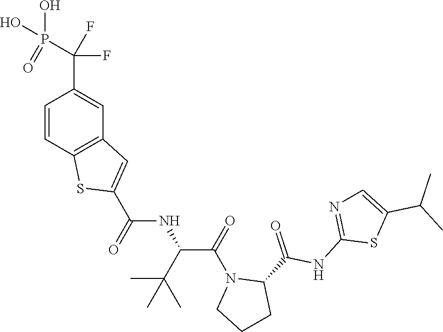 [SMILES: CC(C)c1cnc(NC(=O)[C@@H]2CCCN2C(=O)[C@@H](NC(=O)c2cc3cc(C(F)(F)P(=O)(O)O)ccc3s2)C(C)(C)C)s1] | (difluoro(2-(((S)-1-((S)-2-((5- isopropylthiazol-2- yl)carbamoyl)pyrrolidin-1-yl)-3,3- dimethyl-1-oxobutan-2- yl)carbamoyl)benzo[b]thiophen-5- yl)methyl)phosphonic acid |
| 252 | 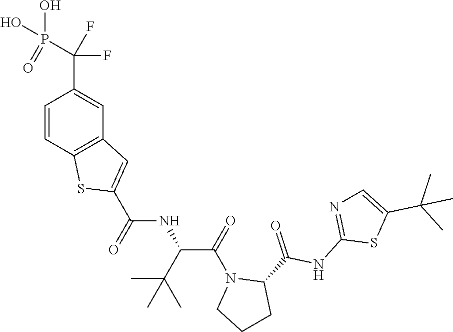 [SMILES: CC(C)(C)c1cnc(NC(=O)[C@@H]2CCCN2C(=O)[C@@H](NC(=O)c2cc3cc(C(F)(F)P(=O)(O)O)ccc3s2)C(C)(C)C)s1] | ((2-(((S)-1-((S)-2-((5-(tert- butyl)thiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 253 | 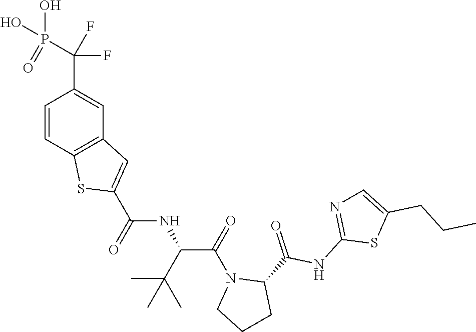 [SMILES: CCCc1cnc(NC(=O)[C@@H]2CCCN2C(=O)[C@@H](NC(=O)c2cc3cc(C(F)(F)P(=O)(O)O)ccc3s2)C(C)(C)C)s1] | ((2-(((S)-3,3-dimethyl-1-oxo-1-((S)- 2-((5-propylthiazol-2- yl)carbamoyl)pyrrolidin-1-yl)butan- 2-yl)carbamoyl)benzo[b]thiophen-5- yl)difluoromethyl)phosphonic acid |
| 254 | 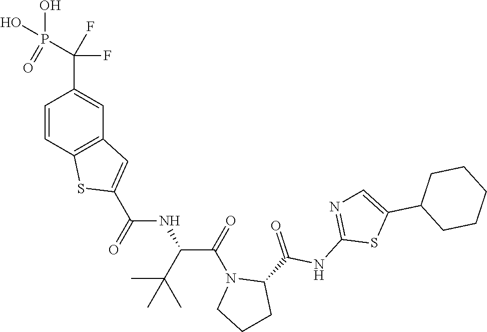 [SMILES: CC(C)(C)[C@H](NC(=O)c1cc2cc(C(F)(F)P(=O)(O)O)ccc2s1)C(=O)N1CCC[C@H]1C(=O)Nc1ncc(C2CCCCC2)s1] | ((2-(((S)-1-((S)-2-((5- cyclohexylthiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 255 | 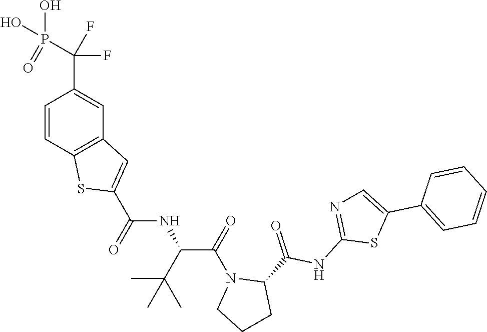 [SMILES: CC(C)(C)[C@H](NC(=O)c1cc2cc(C(F)(F)P(=O)(O)O)ccc2s1)C(=O)N1CCC[C@H]1C(=O)Nc1ncc(-c2ccccc2)s1] | ((2-(((S)-3,3-dimethyl-1-oxo-1-((S)- 2-((5-phenylthiazol-2- yl)carbamoyl)pyrrolidin-1-yl)butan- 2-yl)carbamoyl)benzo[b]thiophen-5- yl)difluoromethyl)phosphonic acid |
| 256 | 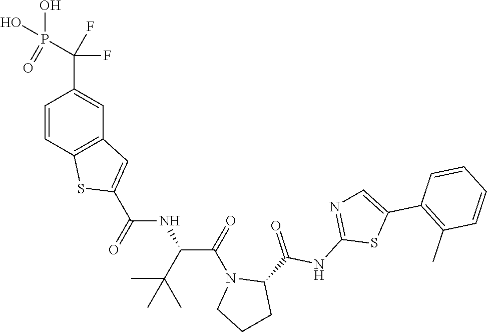 [SMILES: Cc1ccccc1-c1cnc(NC(=O)[C@@H]2CCCN2C(=O)[C@@H](NC(=O)c2cc3cc(C(F)(F)P(=O)(O)O)ccc3s2)C(C)(C)C)s1] | ((2-(((S)-3,3-dimethyl-1-oxo-1-((S)- 2-((5-(o-tolyl)thiazol-2- yl)carbamoyl)pyrrolidin-1-yl)butan- 2-yl)carbamoyl)benzo[b]thiophen-5- yl)difluoromethyl)phosphonic acid |
| 257 | 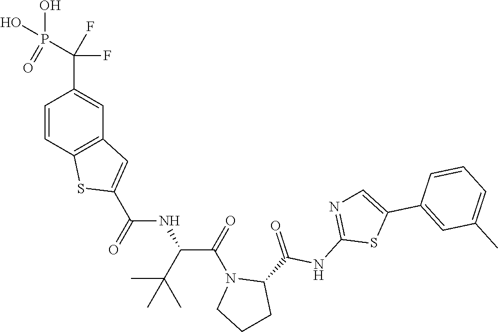 [SMILES: Cc1cccc(-c2cnc(NC(=O)[C@@H]3CCCN3C(=O)[C@@H](NC(=O)c3cc4cc(C(F)(F)P(=O)(O)O)ccc4s3)C(C)(C)C)s2)c1] | ((2-(((S)-3,3-dimethyl-1-oxo-1-((S)- 2-((5-(m-tolyl)thiazol-2- yl)carbamoyl)pyrrolidin-1-yl)butan- 2-yl)carbamoyl)benzo[b]thiophen-5- yl)difluoromethyl)phosphonic acid |
| 258 | 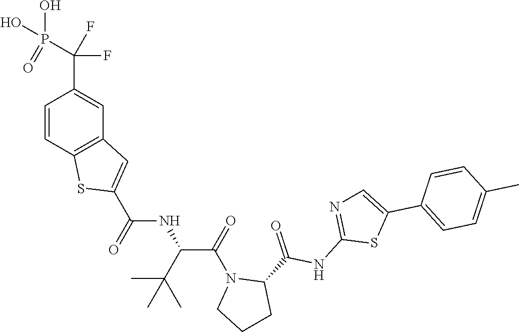 [SMILES: Cc1ccc(-c2cnc(NC(=O)[C@@H]3CCCN3C(=O)[C@@H](NC(=O)c3cc4cc(C(F)(F)P(=O)(O)O)ccc4s3)C(C)(C)C)s2)cc1] | ((2-(((S)-3,3-dimethyl-1-oxo-1-((S)- 2-((5-(p-tolyl)thiazol-2- yl)carbamoyl)pyrrolidin-1-yl)butan- 2-yl)carbamoyl)benzo[b]thiophen-5- yl)difluoromethyl)phosphonic acid |
| 259 | 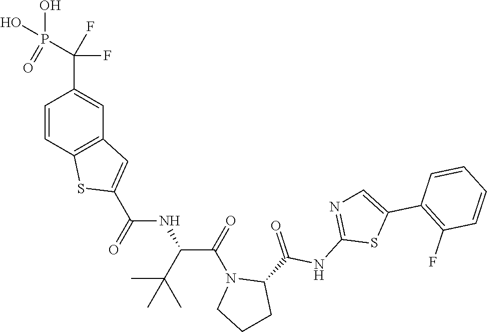 [SMILES: CC(C)(C)[C@H](NC(=O)c1cc2cc(C(F)(F)P(=O)(O)O)ccc2s1)C(=O)N1CCC[C@H]1C(=O)Nc1ncc(-c2ccccc2F)s1] | (difluoro(2-(((S)-1-((S)-2-((5-(2- fluorophenyl)thiazol-2- yl)carbamoyl)pyrrolidin-1-yl)-3,3- dimethyl-1-oxobutan-2- yl)carbamoyl)benzo[b]thiophen-5- yl)methyl)phosphonic acid |
| 260 | 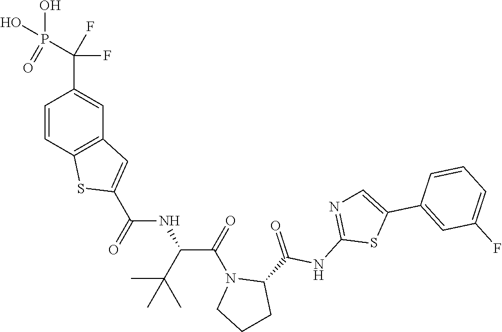 [SMILES: CC(C)(C)[C@H](NC(=O)c1cc2cc(C(F)(F)P(=O)(O)O)ccc2s1)C(=O)N1CCC[C@H]1C(=O)Nc1ncc(-c2cccc(F)c2)s1] | (difluoro(2-(((S)-1-((S)-2-((5-(3- fluorophenyl)thiazol-2- yl)carbamoyl)pyrrolidin-1-yl)-3,3- dimethyl-1-oxobutan-2- yl)carbamoyl)benzo[b]thiophen-5- yl)methyl)phosphonic acid |
| 261 | 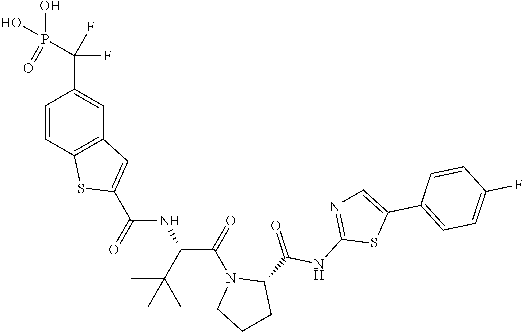 [SMILES: CC(C)(C)[C@H](NC(=O)c1cc2cc(C(F)(F)P(=O)(O)O)ccc2s1)C(=O)N1CCC[C@H]1C(=O)Nc1ncc(-c2ccc(F)cc2)s1] | (difluoro(2-(((S)-1-((S)-2-((5-(4- fluorophenyl)thiazol-2- yl)carbamoyl)pyrrolidin-1-yl)-3,3- dimethyl-1-oxobutan-2- yl)carbamoyl)benzo[b]thiophen-5- yl)methyl)phosphonic acid |
| 262 | 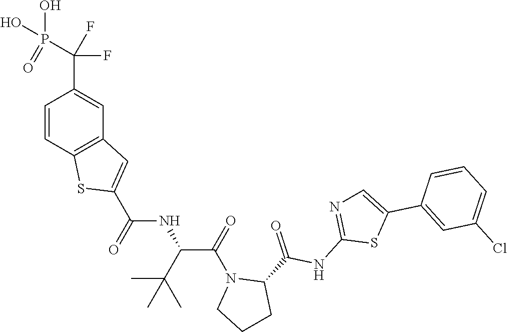 [SMILES: CC(C)(C)[C@H](NC(=O)c1cc2cc(C(F)(F)P(=O)(O)O)ccc2s1)C(=O)N1CCC[C@H]1C(=O)Nc1ncc(-c2cccc(Cl)c2)s1] | ((2-(((S)-1-((S)-2-((5-(3- chlorophenyl)thiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 263 | 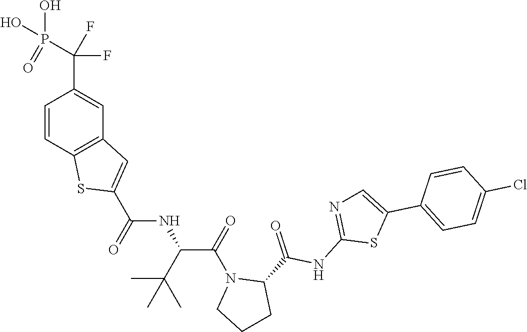 [SMILES: CC(C)(C)[C@H](NC(=O)c1cc2cc(C(F)(F)P(=O)(O)O)ccc2s1)C(=O)N1CCC[C@H]1C(=O)Nc1ncc(-c2ccc(Cl)cc2)s1] | ((2-(((S)-1-((S)-2-((5-(4- chlorophenyl)thiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 264 | 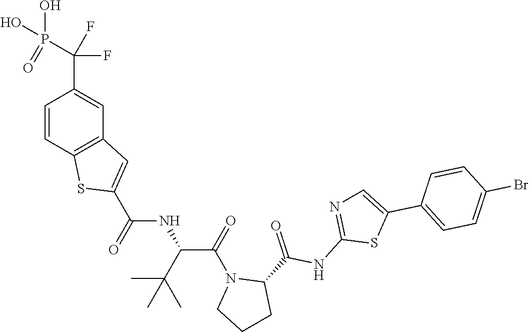 [SMILES: CC(C)(C)[C@H](NC(=O)c1cc2cc(C(F)(F)P(=O)(O)O)ccc2s1)C(=O)N1CCC[C@H]1C(=O)Nc1ncc(-c2ccc(Br)cc2)s1] | ((2-(((S)-1-((S)-2-((5-(4- bromophenyl)thiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 265 | 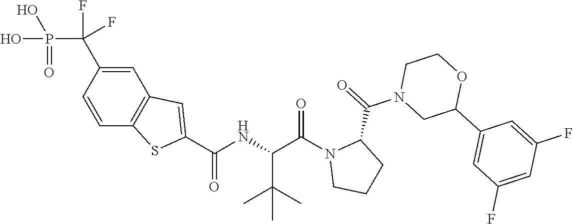 [SMILES: CC(C)(C)[C@H](NC(=O)c1cc2cc(C(F)(F)P(=O)(O)O)ccc2s1)C(=O)N1CCC[C@H]1C(=O)N1CCOC(c2cc(F)cc(F)c2)C1] | ((2-(((2S)-1-((2S)-2-(2-(3,5- difluorophenyl)morpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 266 | 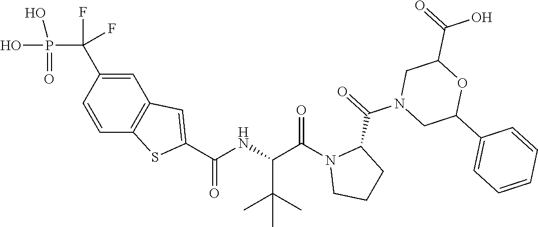 [SMILES: CC(C)(C)[C@H](NC(=O)c1cc2cc(C(F)(F)P(=O)(O)O)ccc2s1)C(=O)N1CCC[C@H]1C(=O)N1CC(C(=O)O)OC(c2ccccc2)C1] | 1-(((S)-2-(5- (difluoro(phosphono)methyl)benzo [b]thiophene-2-carboxamido)-3,3- dimethylbutanoyl)-L-prolyl)-5- phenylpiperidine-3-carboxylic acid |
| 267 | 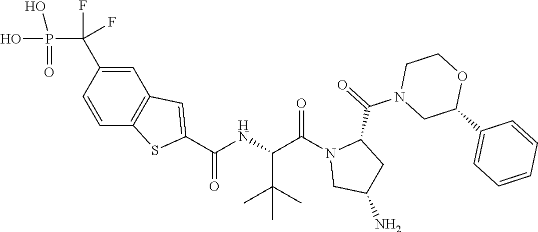 [SMILES: CC(C)(C)[C@H](NC(=O)c1cc2cc(C(F)(F)P(=O)(O)O)ccc2s1)C(=O)N1C[C@@H](N)C[C@H]1C(=O)N1CCO[C@H](c2ccccc2)C1] | ((2-(((S)-1-((2S,4S)-4-amino-2-((R)- 2-phenylmorpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 268 | 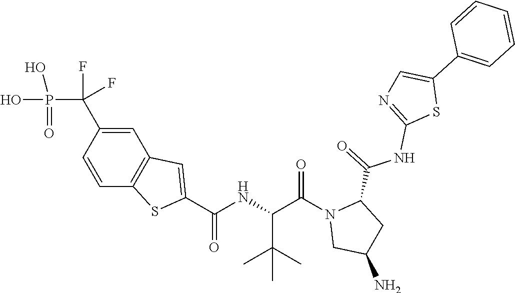 [SMILES: CC(C)(C)[C@H](NC(=O)c1cc2cc(C(F)(F)P(=O)(O)O)ccc2s1)C(=O)N1C[C@H](N)C[C@H]1C(=O)Nc1ncc(-c2ccccc2)s1] | ((2-(((S)-1-((2S,4R)-4-amino-2-((5- phenylthiazol-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 269 | 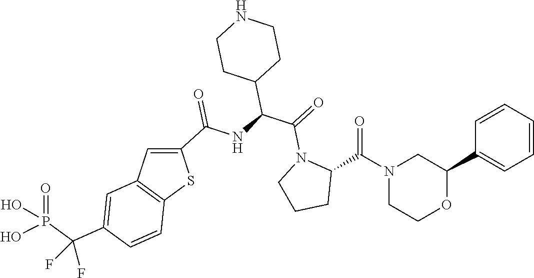 [SMILES: O=C(N[C@H](C(=O)N1CCC[C@H]1C(=O)N1CCO[C@H](c2ccccc2)C1)C1CCNCC1)c1cc2cc(C(F)(F)P(=O)(O)O)ccc2s1] | (difluoro(2-(((S)-2-oxo-2-((S)-2- ((R)-2-phenylmorpholine-4- carbonyl)pyrrolidin-1-yl)-1- (piperidin-4- yl)ethyl)carbamoyl)benzo[b]thiophen- 5-yl)methyl)phosphonic acid |
| 270 | 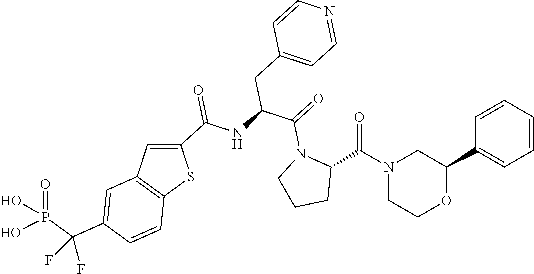 [SMILES: O=C(N[C@@H](Cc1ccncc1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-1-oxo-1-((S)-2- ((R)-2-phenylmorpholine-4- carbonyl)pyrrolidin-1-yl)-3- (pyridin-4-yl)propan-2- yl)carbamoyl)benzo[b]thiophen-5- yl)methyl)phosphonic acid |
| 271 | 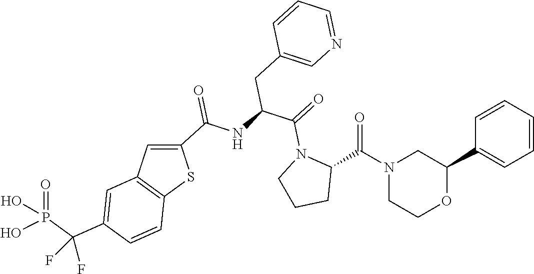 [SMILES: O=C(N[C@@H](Cc1cccnc1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-1-oxo-1-((S)-2- ((R)-2-phenylmorpholine-4- carbonyl)pyrrolidin-1-yl)-3- (pyridin-3-yl)propan-2- yl)carbamoyl)benzo[b]thiophen-5- yl)methyl)phosphonic acid |
| 272 | 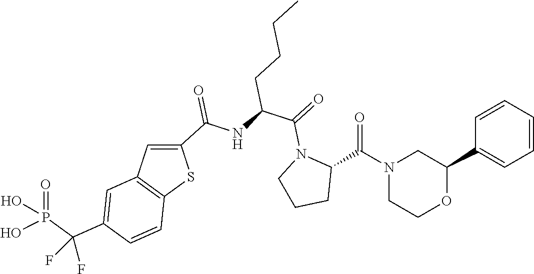 [SMILES: CCCC[C@H](NC(=O)c1cc2cc(C(F)(F)P(=O)(O)O)ccc2s1)C(=O)N1CCC[C@H]1C(=O)N1CCO[C@H](c2ccccc2)C1] | (difluoro(2-(((S)-1-oxo-1-((S)-2- ((R)-2-phenylmorpholine-4- carbonyl)pyrrolidin-1-yl)hexan-2- yl)carbamoyl)benzo[b]thiophen-5- yl)methyl)phosphonic acid |
| 273 | 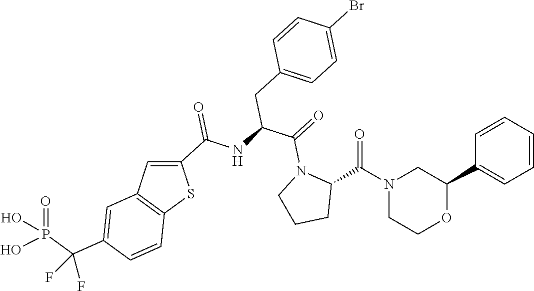 [SMILES: O=C(N[C@@H](Cc1ccc(Br)cc1)C(=O)N1CCC[C@H]1C(=O)N1CCO[C@H](c2ccccc2)C1)c1cc2cc(C(F)(F)P(=O)(O)O)ccc2s1] | ((2-(((S)-3-(4-bromophenyl)-1-oxo- 1-((S)-2-((R)-2-phenylmorpholine- 4-carbonyl)pyrrolidin-1-yl)propan- 2-yl)carbamoyl)benzo[b]thiophen-5- yl)difluoromethyl)phosphonic acid |
| 274 | 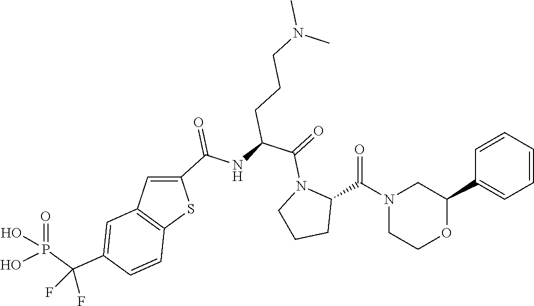 [SMILES: CN(C)CCC[C@H](NC(=O)c1cc2cc(C(F)(F)P(=O)(O)O)ccc2s1)C(=O)N1CCC[C@H]1C(=O)N1CCO[C@H](c2ccccc2)C1] | ((2-(((S)-5-(dimethylamino)-1-oxo- 1-((S)-2-((R)-2-phenylmorpholine- 4-carbonyl)pyrrolidin-1-yl)pentan- 2-yl)carbamoyl)benzo[b]thiophen-5- yl)difluoromethyl)phosphonic acid |
| 275 | 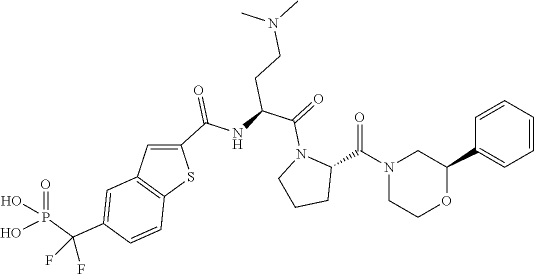 [SMILES: CN(C)CC[C@H](NC(=O)c1cc2cc(C(F)(F)P(=O)(O)O)ccc2s1)C(=O)N1CCC[C@H]1C(=O)N1CCO[C@H](c2ccccc2)C1] | ((2-(((S)-4-(dimethylamino)-1-oxo- 1-((S)-2-((R)-2-phenylmorpholine- 4-carbonyl)pyrrolidin-1-yl)butan-2- yl)carbamoyl)benzo[b]thiophen-5- yl)difluoromethyl)phosphonic acid |
| 276 | 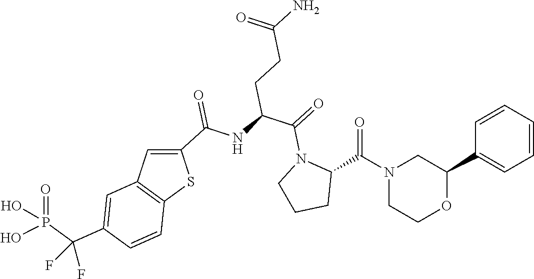 [SMILES: NC(=O)CC[C@H](NC(=O)c1cc2cc(C(F)(F)P(=O)(O)O)ccc2s1)C(=O)N1CCC[C@H]1C(=O)N1CCO[C@H](c2ccccc2)C1] | ((2-(((S)-5-amino-1,5-dioxo-1-((S)- 2-((R)-2-phenylmorpholine-4- carbonyl)pyrrolidin-1-yl)pentan-2- yl)carbamoyl)benzo[b]thiophen-5- yl)difluoromethyl)phosphonic acid |
| 277 | 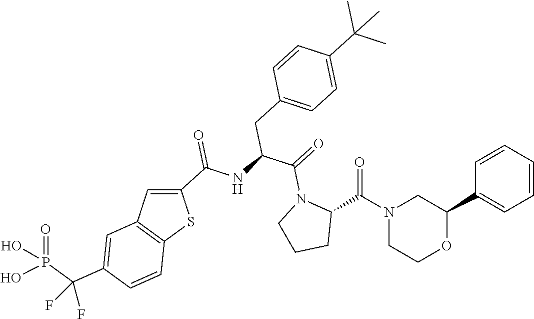 [SMILES: CC(C)(C)c1ccc(C[C@H](NC(=O)c2cc3cc(C(F)(F)P(=O)(O)O)ccc3s2)C(=O)N2CCC[C@H]2C(=O)N2CCO[C@H](c3ccccc3)C2)cc1] | ((2-(((S)-3-(4-(tert-butyl)phenyl)-1- oxo-1-((S)-2-((R)-2- phenylmorpholine-4- carbonyl)pyrrolidin-1-yl)propan-2- yl)carbamoyl)benzo[b]thiophen-5- yl)difluoromethyl)phosphonic acid |
| 278 | 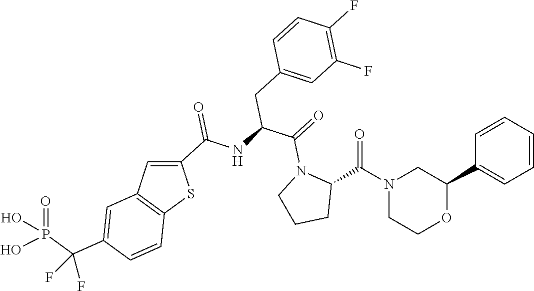 [SMILES: O=C(N[C@@H](Cc1ccc(F)c(F)c1)C(=O)N1CCC[C@H]1C(=O)N1CCO[C@H](c2ccccc2)C1)c1cc2cc(C(F)(F)P(=O)(O)O)ccc2s1] | ((2-(((S)-3-(3,4-difluorophenyl-1- oxo-1-((S)-2-((R)-2- phenylmorpholine-4- carbonyl)pyrrolidin-1-yl)propan-2- yl)carbamoyl)benzo[b]thiophen-5- yl)difluoromethyl)phosphonic acid |
| 279 | 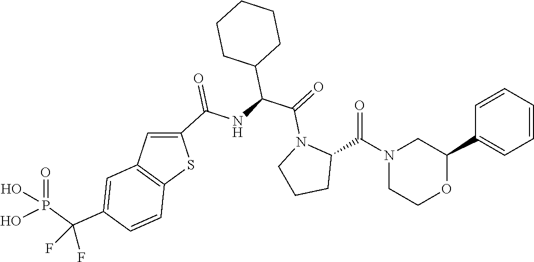 [SMILES: O=C(N[C@H](C(=O)N1CCC[C@H]1C(=O)N1CCO[C@H](c2ccccc2)C1)C1CCCCC1)c1cc2cc(C(F)(F)P(=O)(O)O)ccc2s1] | ((2-(((S)-1-cyclohexyl-2-oxo-2-((S)- 2-((R)-2-phenylmorpholine-4- carbonyl)pyrrolidin-1- yl)ethyl)carbamoyl)benzo[b]thiophen- 5-yl)difluoromethyl)phosphonic acid |
| 280 | 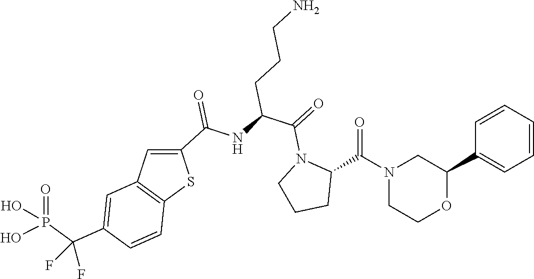 [SMILES: NCCC[C@H](NC(=O)c1cc2cc(C(F)(F)P(=O)(O)O)ccc2s1)C(=O)N1CCC[C@H]1C(=O)N1CCO[C@H](c2ccccc2)C1] | ((2-(((S)-5-amino-1-oxo-1-((S)-2- ((R)-2-phenylmorpholine-4- carbonyl)pyrrolidin-1-yl)pentan-2- yl)carbamoyl)benzo[b]thiophen-5- yl)difluoromethyl)phosphonic acid |
| 281 | 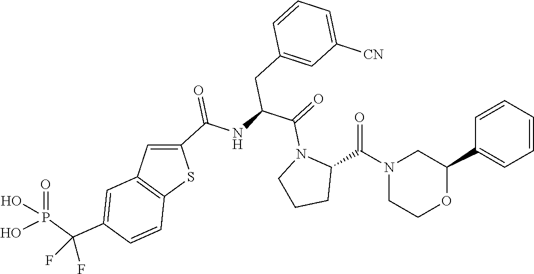 [SMILES: N#Cc1cccc(C[C@H](NC(=O)c2cc3cc(C(F)(F)P(=O)(O)O)ccc3s2)C(=O)N2CCC[C@H]2C(=O)N2CCO[C@H](c3ccccc3)C2)c1] | ((2-(((S)-3-(3-cyanophenyl)-1-oxo- 1-((S)-2-((R)-2-phenylmorpholine- 4-carbonyl)pyrrolidin-1-yl)propan- 2-yl)carbamoyl)benzo[b]thiophen-5- yl)difluoromethyl)phosphonic acid |
| 282 | 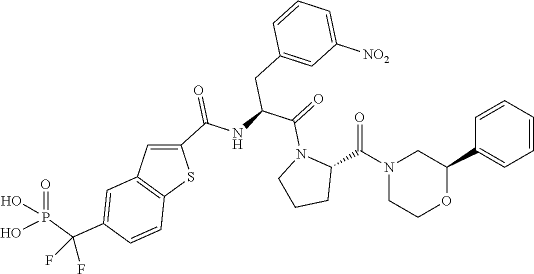 [SMILES: O=C(N[C@@H](Cc1cccc([N+](=O)[O-])c1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-3-(3-nitrophenyl)- 1-oxo-1-((S)-2-((R)-2- phenylmorpholine-4- carbonyl)pyrrolidin-1-yl)propan-2- yl)carbamoyl)benzo[b]thiophen-5- yl)methyl)phosphonic acid |
| 283 | 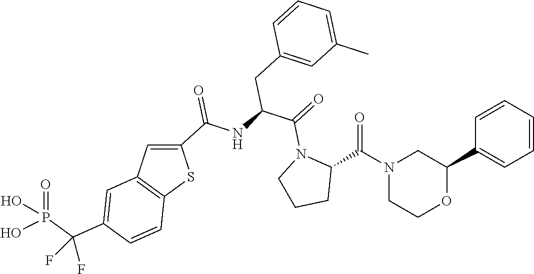 [SMILES: Cc1cccc(C[C@H](NC(=O)c2cc3cc(C(F)(F)P(=O)(O)O)ccc3s2)C(=O)N2CCC[C@H]2C(=O)N2CCO[C@H](c3ccccc3)C2)c1] | (difluoro(2-(((S)-1-oxo-1-((S)-2- ((R)-2-phenylmorpholine-4- carbonyl)pyrrolidin-1-yl)-3-(m- tolyl)propan-2- yl)carbamoyl)benzo[b]thiophen-5- yl)methyl)phosphonic acid |
| 284 | 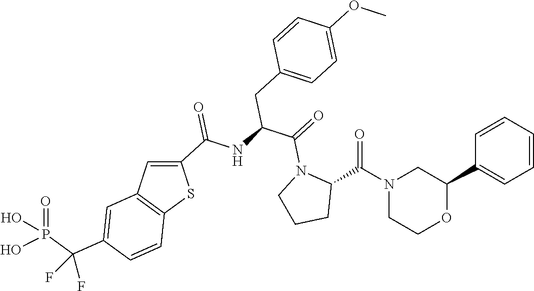 [SMILES: COc1ccc(C[C@H](NC(=O)c2cc3cc(C(F)(F)P(=O)(O)O)ccc3s2)C(=O)N2CCC[C@H]2C(=O)N2CCO[C@H](c3ccccc3)C2)cc1] | (difluoro(2-(((S)-3-(4- methoxyphenyl)-1-oxo-1-((S)-2- ((R)-2-phenylmorpholine-4- carbonyl)pyrrolidin-1-yl)propan-2- yl)carbamoyl)benzo[b]thiophen-5- yl)methyl)phosphonic acid |
| 285 | 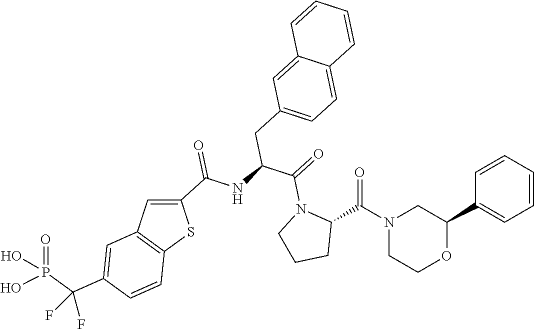 [SMILES: O=C(N[C@@H](Cc1ccc2ccccc2c1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-3-(naphthalen-2- yl)-1-oxo-1-((S)-2-((R)-2- phenylmorpholine-4- carbonyl)pyrrolidin-1-yl)propan-2- yl)carbamoyl)benzo[b]thiophen-5- yl)methyl)phosphonic acid |
| 286 | 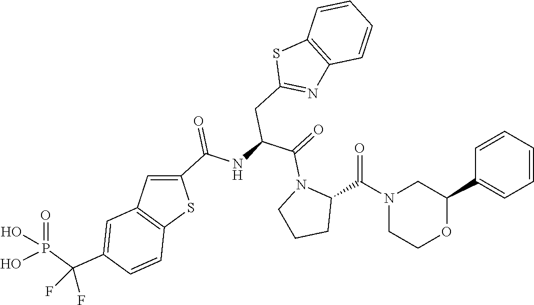 [SMILES: O=C(N[C@@H](Cc1nc2ccccc2s1)C(=O)N1CCC[C@H]1C(=O)N1CCO[C@H](c2ccccc2)C1)c1cc2cc(C(F)(F)P(=O)(O)O)ccc2s1] | ((2-(((S)-3-(benzo[d]thiazol-2-y])-1- oxo-1-((S)-2-((R)-2- phenylmorpholine-4- carbonyl)pyrrolidin-1-yl)propan-2- yl)carbamoyl)benzo[b]thiophen-5- yl)difluoromethyl)phosphonic acid |
| 287 | 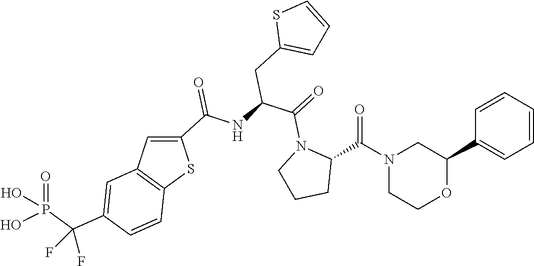 [SMILES: O=C(N[C@@H](Cc1cccs1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-1-oxo-1-((S)-2- ((R)-2-phenylmorpholine-4- carbonyl)pyrrolidin-1-yl)-3- (thiophen-2-yl)propan-2- yl)carbamoyl)benzo[b]thiophen-5- yl)methyl)phosphonic acid |
| 288 | 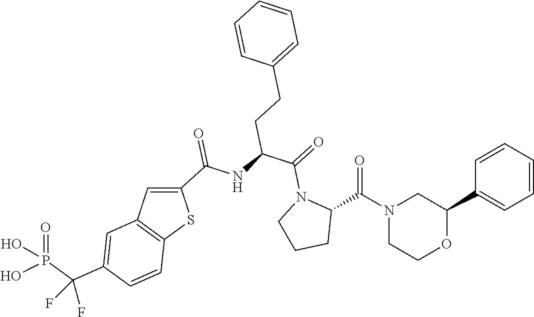 [SMILES: O=C(N[C@@H](CCc1ccccc1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-1-oxo-4-phenyl-1- ((S)-2-((R)-2-phenylmorpholine-4- carbonyl)pyrrolidin-1-yl)butan-2- yl)carbamoyl)benzo[b]thiophen-5- yl)methyl)phosphonic acid |
| 289 | 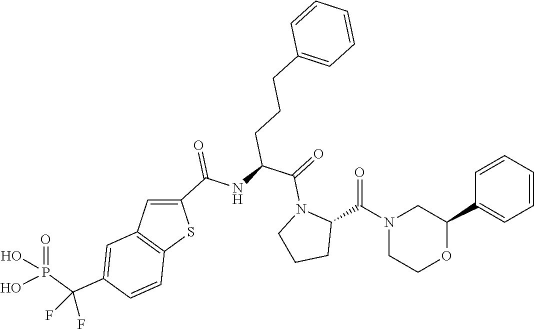 [SMILES: O=C(N[C@@H](CCCc1ccccc1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-1-oxo-5-phenyl-1- ((S)-2-((R)-2-phenylmorpholine-4- carbonyl)pyrrolidin-1-yl)pentan-2- yl)carbamoyl)benzo[b]thiophen-5- yl)methyl)phosphonic acid |
| 290 | 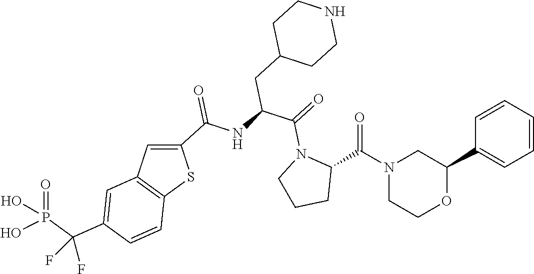 [SMILES: O=C(N[C@@H](CC1CCNCC1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-1-oxo-1-((S)-2- ((R)-2-phenylmorpholine-4- carbonyl)pyrrolidin-1-yl)-3- (piperidin-4-yl)propan-2- yl)carbamoyl)benzo[b]thiophen-5- yl)methyl)phosphonic acid |
| 291 | 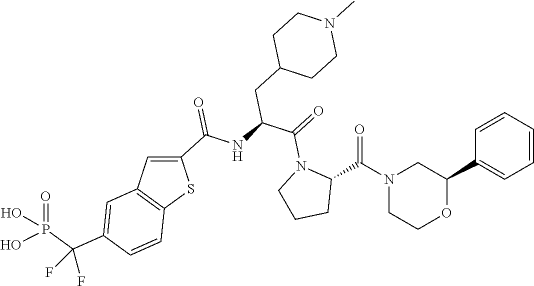 [SMILES: CN1CCC(C[C@H](NC(=O)c2cc3cc(C(F)(F)P(=O)(O)O)ccc3s2)C(=O)N2CCC[C@H]2C(=O)N2CCO[C@H](c3ccccc3)C2)CC1] | (difluoro(2-(((S)-3-(1- methylpiperidin-4-yl)-1-oxo-1-((S)- 2-((R)-2-phenylmorpholine-4- carbonyl)pyrrolidin-1-yl)propan-2- yl)carbamoyl)benzo[b]thiophen-5- yl)methyl)phosphonic acid |
| 292 | 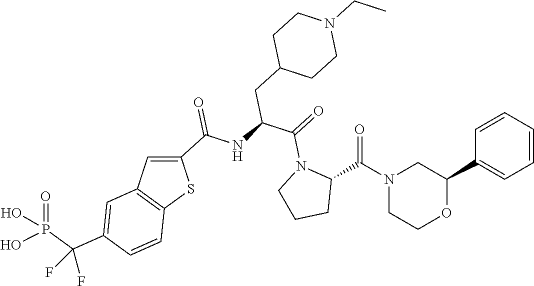 [SMILES: CCN1CCC(C[C@H](NC(=O)c2cc3cc(C(F)(F)P(=O)(O)O)ccc3s2)C(=O)N2CCC[C@H]2C(=O)N2CCO[C@H](c3ccccc3)C2)CC1] | ((2-(((S)-3-(1-ethylpiperidin-4-yl- 1-oxo-1-((S)-2-((R)-2- phenylmorpholine-4- carbonyl)pyrrolidin-1-yl)propan-2- yl)carbamoyl)benzo[b]thiophen-5- yl)difluoromethyl)phosphonic acid |
| 293 | 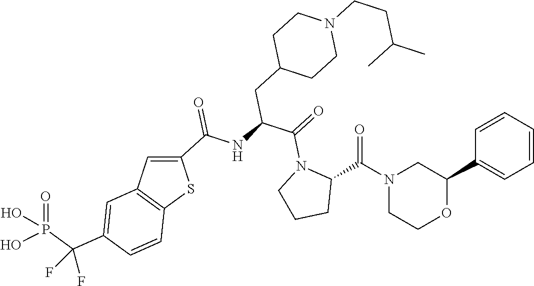 [SMILES: CC(C)CCN1CCC(C[C@H](NC(=O)c2cc3cc(C(F)(F)P(=O)(O)O)ccc3s2)C(=O)N2CCC[C@H]2C(=O)N2CCO[C@H](c3ccccc3)C2)CC1] | (difluoro(2-(((S)-3-(1- isopentylpiperidin-4-yl)-1-oxo-1- ((S)-2-((R)-2-phenylmorpholine-4- carbonyl)pyrrolidin-1-yl)propan-2- yl)carbamoyl)benzo[b]thiophen-5- yl)methyl)phosphonic acid |
| 294 | 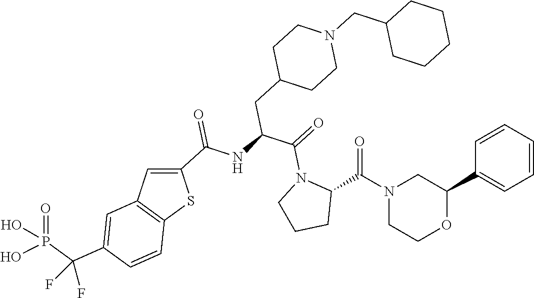 [SMILES: O=C(N[C@@H](CC1CCN(CC2CCCCC2)CC1)C(=O)N1CCC[C@H]1C(=O)N1CCO[C@H](c2ccccc2)C1)c1cc2cc(C(F)(F)P(=O)(O)O)ccc2s1] | ((2-(((S)-3-(1- (cyclohexylmethyl)piperidin-4-yl)- 1-oxo-1-((S)-2-((R)-2- phenylmorpholine-4- carbonyl)pyrrolidin-1-yl)propan-2- yl)carbamoyl)benzo[b]thiophen-5- yl)difluoromethyl)phosphonic acid |
| 295 | 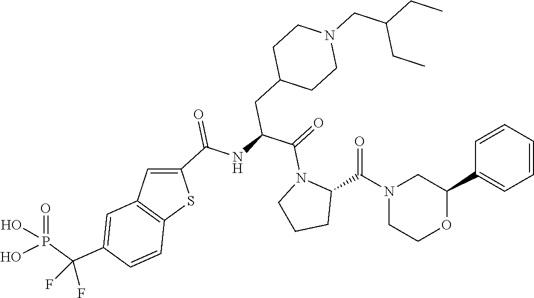 [SMILES: CCC(CC)CN1CCC(C[C@H](NC(=O)c2cc3cc(C(F)(F)P(=O)(O)O)ccc3s2)C(=O)N2CCC[C@H]2C(=O)N2CCO[C@H](c3ccccc3)C2)CC1] | ((2-(((S)-3-(1-(2- ethylbutyl)piperidin-4-yl)-1-oxo-1- ((S)-2-((R)-2-phenylmorpholine-4- carbonyl)pyrrolidin-1-yl)propan-2- yl)carbamoyl)benzo[b]thiophen-5- yl)difluoromethyl)phosphonic acid |
| 296 | 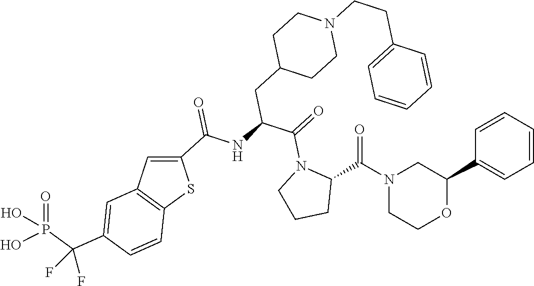 [SMILES: O=C(N[C@@H](CC1CCN(CCc2ccccc2)CC1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-1-oxo-3-(1- phenethylpiperidin-4-yl)-1-((S)-2- ((R)-2-phenylmorpholine-4- carbonyl)pyrrolidin-1-yl)propan-2- yl)carbamoyl)benzo[b]thiophen-5- yl)methyl)phosphonic acid |
| 297 | 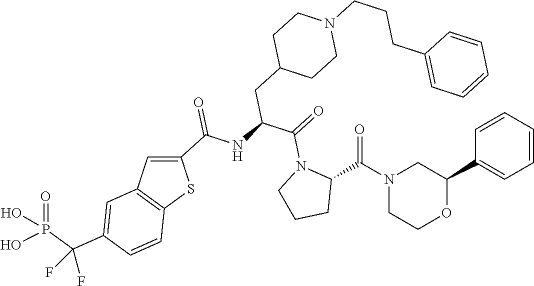 [SMILES: O=C(N[C@@H](CC1CCN(CCCc2ccccc2)CC1)C(=O)N1CCC[C@H]1C(=O)N1CCO[C@H](c2ccccc2)C1)c1cc2cc(C(F)(F)P(=O)(O)O)ccc2s1] | (difluoro(2-(((S)-1-oxo-1-((S)-2- ((R)-2-phenylmorpholine-4- carbonyl)pyrrolidin-1-yl)-3-(1-(3- phenylpropyl)piperidin-4-yl)propan- 2-yl)carbamoyl)benzo[b]thiophen-5- yl)methyl)phosphonic acid |
| 298 | 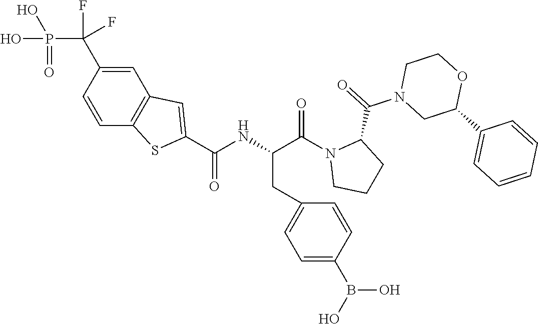 [SMILES: O=C(N[C@@H](Cc1ccc(B(O)O)cc1)C(=O)N1CCC[C@H]1C(=O)N1CCO[C@H](c2ccccc2)C1)c1cc2cc(C(F)(F)P(=O)(O)O)ccc2s1] | ((2-(((S)-3-(4-boronophenyl)-1-oxo- 1-((S)-2-((R)-2-phenylmorpholine- 4-carbonyl)pyrrolidin-1-yl)propan- 2-yl)carbamoyl)benzo[b]thiophen-5- yl)difluoromethyl)phosphonic acid |
| 299 | 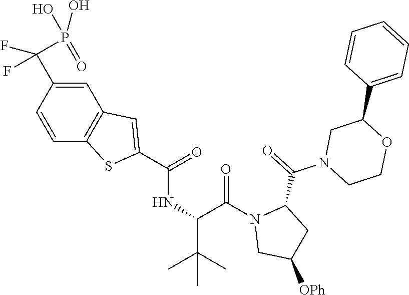 [SMILES: CC(C)(C)[C@H](NC(=O)c1cc2cc(C(F)(F)P(=O)(O)O)ccc2s1)C(=O)N1C[C@H](Oc2ccccc2)C[C@H]1C(=O)N1CCO[C@H](c2ccccc2)C1] | ((2-(((S)-3,3-dimethyl-1-oxo-1- ((2S,4R)-4-phenoxy-2-((R)-2- phenylmorpholine-4- carbonyl)pyrrolidin-1-yl)butan-2- yl)carbamoyl)benzo[b]thiophen-5- yl)difluoromethyl)phosphonic acid |
| 300 | 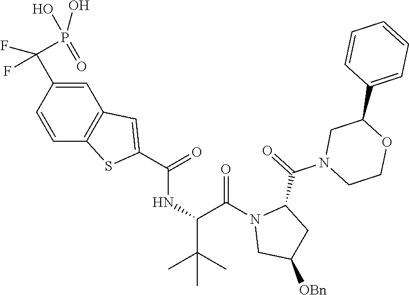 [SMILES: CC(C)(C)[C@H](NC(=O)c1cc2cc(C(F)(F)P(=O)(O)O)ccc2s1)C(=O)N1C[C@H](OCc2ccccc2)C[C@H]1C(=O)N1CCO[C@H](c2ccccc2)C1] | ((2-(((S)-1-((2S,4R)-4-(benzyloxy)- 2-((R)-2-phenylmorpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 301 | 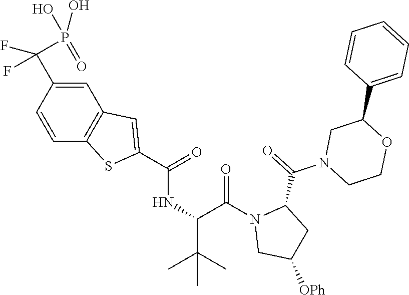 [SMILES: CC(C)(C)[C@H](NC(=O)c1cc2cc(C(F)(F)P(=O)(O)O)ccc2s1)C(=O)N1C[C@@H](Oc2ccccc2)C[C@H]1C(=O)N1CCO[C@H](c2ccccc2)C1] | ((2-(((S)-3,3-dimethyl-1-oxo-1- ((2S,4S)-4-phenoxy-2-((R)-2- phenylmorpholine-4- carbonyl)pyrrolidin-1-yl)butan-2- yl)carbamoyl)benzo[b]thiophen-5- yl)difluoromethyl)phosphonic acid |
| 302 | 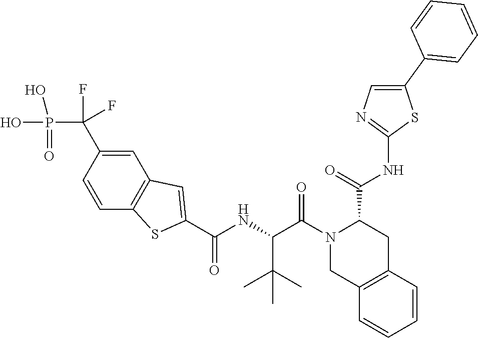 [SMILES: CC(C)(C)[C@H](NC(=O)c1cc2cc(C(F)(F)P(=O)(O)O)ccc2s1)C(=O)N1Cc2ccccc2C[C@H]1C(=O)Nc1ncc(-c2ccccc2)s1] | ((2-(((S)-3,3-dimethyl-1-oxo-1-((S)- 2-((5-phenylthiazol-2- yl)carbamoyl)azepan-1-yl)butan-2- yl)carbamoyl)benzo[b]thiophen-5- yl)difluoromethyl)phosphonic acid |
| 303 | 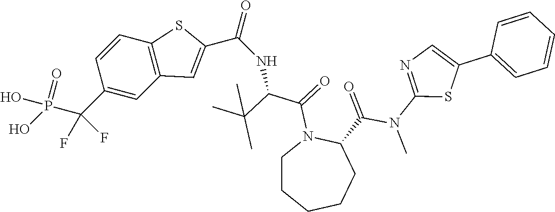 [SMILES: CN(C(=O)[C@@H]1CCCCCN1C(=O)[C@@H](NC(=O)c1cc2cc(C(F)(F)P(=O)(O)O)ccc2s1)C(C)(C)C)c1ncc(-c2ccccc2)s1] | ((2-(((S)-3,3-dimethyl-1-((S)-2- (methyl(5-phenylthiazol-2- yl)carbamoyl)azepan-1-yl)-1- oxobutan-2- yl)carbamoyl)benzo[b]thiophen-5- yl)difluoromethyl)phosphonic acid |
| 304 | 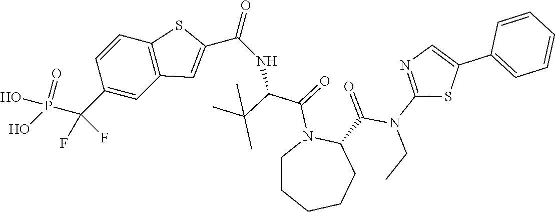 [SMILES: CCN(C(=O)[C@@H]1CCCCCN1C(=O)[C@@H](NC(=O)c1cc2cc(C(F)(F)P(=O)(O)O)ccc2s1)C(C)(C)C)c1ncc(-c2ccccc2)s1] | ((2-(((S)-1-((S)-2-(ethyl(5- phenylthiazol-2- yl)carbamoyl)azepan-1-yl)-3,3- dimethyl-1-oxobutan-2- yl)carbamoyl)benzo[b]thiophen-5- yl)difluoromethyl)phosphonic acid |
| 305 | 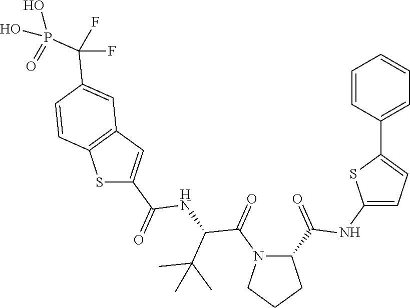 [SMILES: CC(C)(C)[C@H](NC(=O)c1cc2cc(C(F)(F)P(=O)(O)O)ccc2s1)C(=O)N1CCC[C@H]1C(=O)Nc1ccc(-c2ccccc2)s1] | ((2-(((S)-3,3-dimethyl-1-oxo-1-((S)- 2-((5-phenylthiophen-2- yl)carbamoyl)pyrrolidin-1-yl)butan- 2-yl)carbamoyl)benzo[b]thiophen-5- yl)difluoromethyl)phosphonic acid |
| 306 | 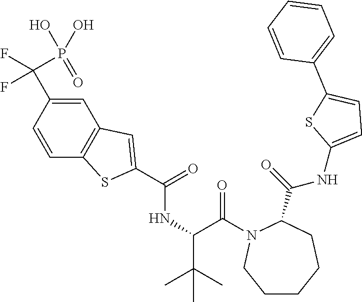 [SMILES: CC(C)(C)[C@H](NC(=O)c1cc2cc(C(F)(F)P(=O)(O)O)ccc2s1)C(=O)N1CCCCC[C@H]1C(=O)Nc1ccc(-c2ccccc2)s1] | ((2-(((S)-3,3-dimethyl-1-oxo-1-((S)- 2-((5-phenylthiophen-2- yl)carbamoyl)azepan-1-yl)butan-2- yl)carbamoyl)benzo[b]thiophen-5- yl)difluoromethyl)phosphonic acid |
| 307 | 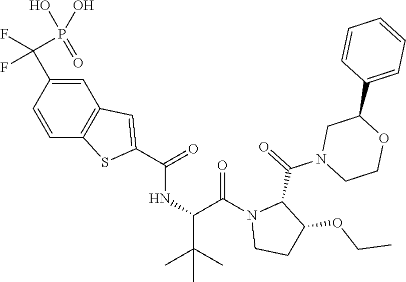 [SMILES: CCO[C@@H]1CCN(C(=O)[C@@H](NC(=O)c2cc3cc(C(F)(F)P(=O)(O)O)ccc3s2)C(C)(C)C)[C@@H]1C(=O)N1CCO[C@H](c2ccccc2)C1] | ((2-(((S)-1-((2S,3R)-3-ethoxy-2- ((R)-2-phenylmorpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 308 | 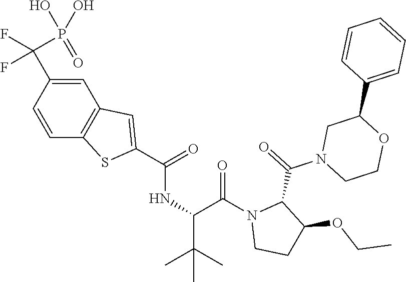 [SMILES: CCO[C@H]1CCN(C(=O)[C@@H](NC(=O)c2cc3cc(C(F)(F)P(=O)(O)O)ccc3s2)C(C)(C)C)[C@@H]1C(=O)N1CCO[C@H](c2ccccc2)C1] | ((2-(((S)-1-((2S,3S)-3-ethoxy-2- ((R)-2-phenylmorpholine-4- carbonyl)pyrrolidin-1-yl)-3,3- dimethyl-1-oxobutan-2- yl)carbamoyl)benzo[b]thiophen-5- yl)difluoromethyl)phosphonic acid |
| 309 | 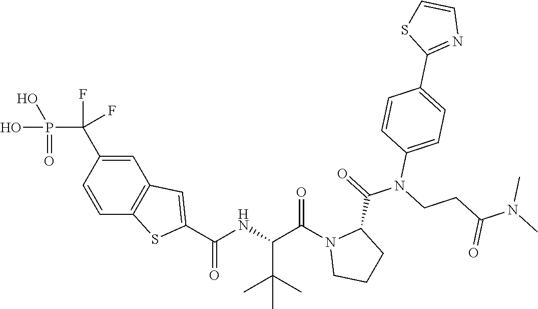 [SMILES: CN(C)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc(-c2nccs2)cc1] | ((2-(((S)-1-((S)-2-((3- (dimethylamino)-3-oxopropyl)(4- (thiazol-2- yl)phenyl)carbamoyl)pyrrolidin-1- yl)-3,3-dimethyl-1-oxobutan-2- yl)carbamoyl)benzo[b]thiophen-5- yl)difluoromethyl)phosphonic acid |
| 310 | 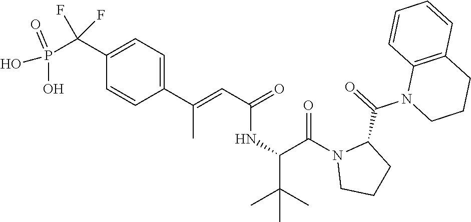 [SMILES: C/C(=C\C(=O)N[C@H](C(=O)N1CCC[C@H]1C(=O)N1CCCc2ccccc21)C(C)(C)C)c1ccc(C(F)(F)P(=O)(O)O)cc1] | ((4-((E)-4-(((S)-3,3-dimethyl-1-oxo- 1-((S)-2-(1,2,3,4- tetrahydroquinoline-1- carbonyl)pyrrolidin-1-yl)butan-2- yl)amino)-4-oxobut-2-en-2- yl)phenyl)difluoromethyl)phosphonic acid |
| 311 | 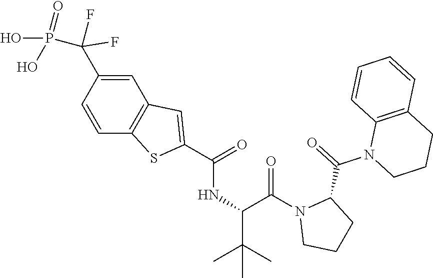 [SMILES: CC(C)(C)[C@H](NC(=O)c1cc2cc(C(F)(F)P(=O)(O)O)ccc2s1)C(=O)N1CCC[C@H]1C(=O)N1CCCc2ccccc21] | ((2-(((S)-3,3-dimethyl-1-oxo-1-((S)- 2-(1,2,3,4-tetrahydroquinoline-1- carbonyl)pyrrolidin-1-yl)butan-2- yl)carbamoyl)benzo[b]thiophen-5- yl)difluoromethyl)phosphonic acid |
| 312 | 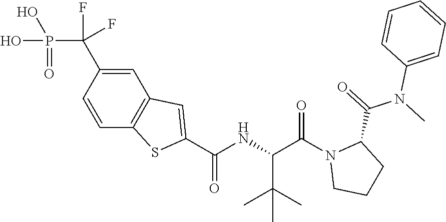 [SMILES: CN(C(=O)[C@@H]1CCCN1C(=O)[C@@H](NC(=O)c1cc2cc(C(F)(F)P(=O)(O)O)ccc2s1)C(C)(C)C)c1ccccc1] | ((2-(((S)-3,3-dimethyl-1-((S)-2- (methyl(phenyl)carbamoyl)pyrrolidin- 1-yl)-1-oxobutan-2- yl)carbamoyl)benzo[b]thiophen-5- yl)difluoromethyl)phosphonic acid |
| 313 | 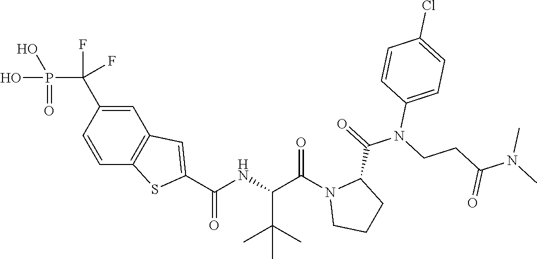 [SMILES: CN(C)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc(Cl)cc1] | ((2-(((S)-1-((S)-2-((4- chlorophenyl)(3-(dimethylamino)-3- oxopropyl)carbamoyl)pyrrolidin-1- yl)-3,3-dimethyl-1-oxobutan-2- yl)carbamoyl)benzo[b]thiophen-5- yl)difluoromethyl)phosphonic acid |
| 314 | 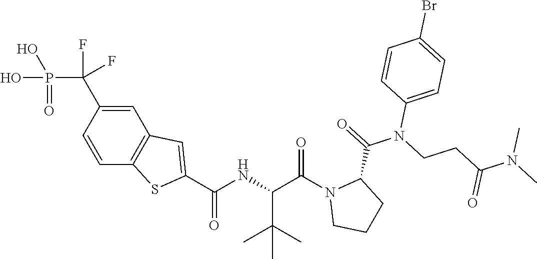 [SMILES: CN(C)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc(Br)cc1] | ((2-(((S)-1-((S)-2-((4- bromophenyl)(3-(dimethylamino)-3- oxopropyl)carbamoyl)pyrrolidin-1- yl)-3,3-dimethyl-1-oxobutan-2- yl)carbamoyl)benzo[b]thiophen-5- yl)difluoromethyl)phosphonic acid |
| 315 | 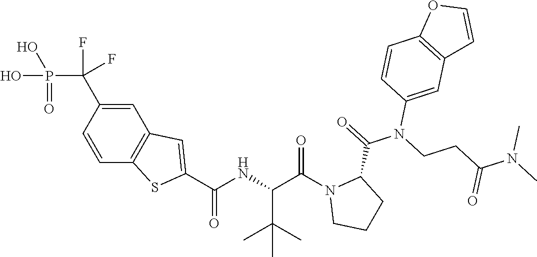 [SMILES: CN(C)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc2occc2c1] | ((2-(((S)-1-((S)-2-(benzofuran-5- yl(3-(dimethylamino)-3- oxopropyl)carbamoyl)pyrrolidin-1- yl)-3,3-dimethyl-1-oxobutan-2- yl)carbamoyl)benzo[b]thiophen-5- yl)difluoromethyl)phosphonic acid |
| 316 | 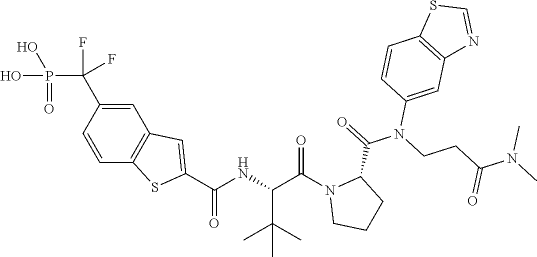 [SMILES: CN(C)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc2scnc2c1] | ((2-(((S)-1-((S)-2-(benzo[d]thiazol- 5-yl(3-(dimethylamino)-3- oxopropyl)carbamoyl)pyrrolidin-1- yl)-3,3-dimethyl-1-oxobutan-2- yl)carbamoyl)benzo[b]thiophen-5- yl)difluoromethyl)phosphonic acid |
| 317 | 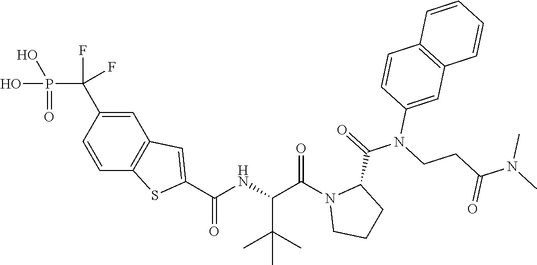 [SMILES: CN(C)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc2ccccc2c1] | ((2-(((S)-1-((S)-2-((3- (dimethylamino)-3- oxopropyl)(naphthalen-2- yl)carbamoyl)pyrrolidin-1-yl)-3,3- dimethyl-1-oxobutan-2- yl)carbamoyl)benzo[b]thiophen-5- yl)difluoromethyl)phosphonic acid |
| 318 | 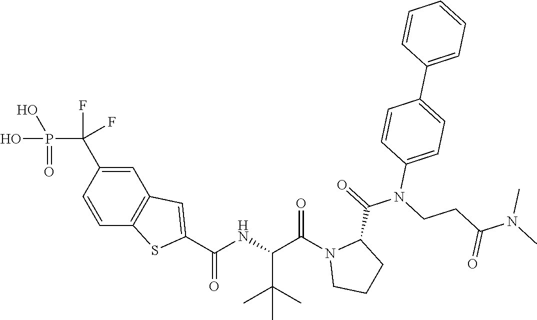 [SMILES: CN(C)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc(-c2ccccc2)cc1] | ((2-(((S)-1-((S)-2-([1,1′-biphenyl]-4- yl(3-(dimethylamino)-3- oxopropyl)carbamoyl)pyrrolidin-1- yl)-3,3-dimethyl-1-oxobutan-2- yl)carbamoyl)benzo[b]thiophen-5- yl)difluoromethyl)phosphonic acid |
| 319 | 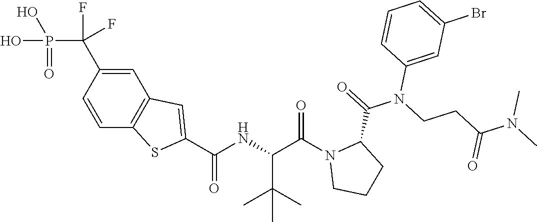 [SMILES: CN(C)C(=O)CCN(C(=O)[C@@H]1CCCN1C(=O)[C@@H](NC(=O)c1cc2cc(C(F)(F)P(=O)(O)O)ccc2s1)C(C)(C)C)c1cccc(Br)c1] | ((2-(((S)-1-((S)-2-((3- bromophenyl)(3-(dimethylamino)-3- oxopropyl)carbamoyl)pyrrolidin-1- yl)-3,3-dimethyl-1-oxobutan-2- yl)carbamoyl)benzo[b]thiophen-5- yl)difluoromethyl)phosphonic acid |
| 320 | 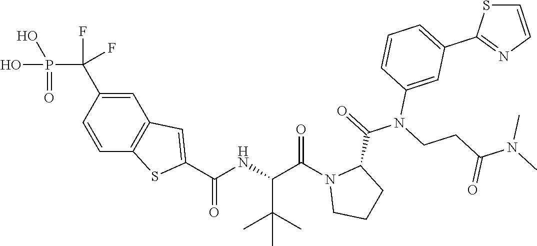 [SMILES: CN(C)C(=O)CCN(C(=O)[C@@H]1CCCN1C(=O)[C@@H](NC(=O)c1cc2cc(C(F)(F)P(=O)(O)O)ccc2s1)C(C)(C)C)c1cccc(-c2nccs2)c1] | ((2-(((S)-1-((S)-2-((3- (dimethylamino)-3-oxopropyl)(3- (thiazol-2- yl)phenyl)carbamoyl)pyrrolidin-1- yl)-3,3-dimethyl-1-oxobutan-2- yl)carbamoyl)benzo[b]thiophen-5- yl)difluoromethyl)phosphonic acid |
| 321 | 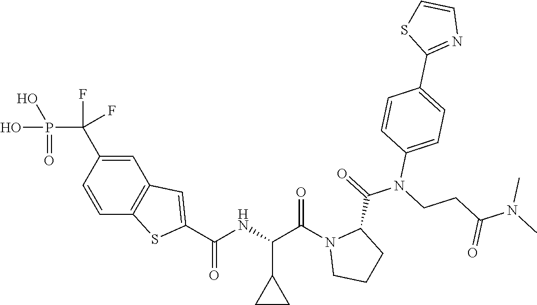 [SMILES: CN(C)C(=O)CCN(C(=O)[C@@H]1CCCN1C(=O)[C@@H](NC(=O)c1cc2cc(C(F)(F)P(=O)(O)O)ccc2s1)C1CC1)c1ccc(-c2nccs2)cc1] | ((2-(((S)-1-cyclopropyl-2-((S)-2-((3- (dimethylamino)-3-oxopropyl)(4- (thiazol-2- yl)phenyl)carbamoyl)pyrrolidin-1- yl)-2- oxoethyl)carbamoyl)benzo[b]thiophen- 5-yl)difluoromethyl)phosphonic acid |
| 322 | 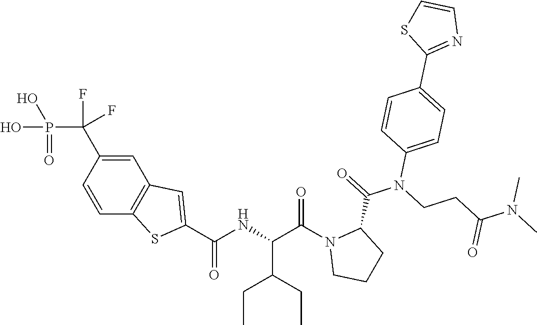 [SMILES: CCC(CC)[C@H](NC(=O)c1cc2cc(C(F)(F)P(=O)(O)O)ccc2s1)C(=O)N1CCC[C@H]1C(=O)N(CCC(=O)N(C)C)c1ccc(-c2nccs2)cc1] | ((2-(((S)-1-((S)-2-((3- (dimethylamino)-3-oxopropyl)(4- (thiazol-2- yl)phenyl)carbamoyl)pyrrolidin-1- yl)-3-ethyl-1-oxopentan-2- yl)carbamoyl)benzo[b]thiophen-5- yl)difluoromethyl)phosphonic acid |
| 323 | 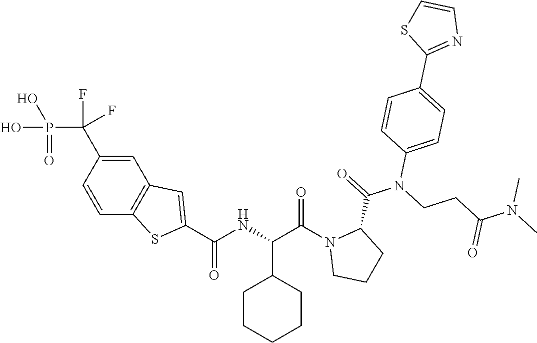 [SMILES: CN(C)C(=O)CCN(C(=O)[C@@H]1CCCN1C(=O)[C@@H](NC(=O)c1cc2cc(C(F)(F)P(=O)(O)O)ccc2s1)C1CCCCC1)c1ccc(-c2nccs2)cc1] | ((2-(((S)-1-cyclohexyl-2-((S)-2-((3- (dimethylamino)-3-oxopropyl)(4- (thiazol-2- yl)phenyl)carbamoyl)pyrrolidin-1- yl)-2- oxoethyl)carbamoyl)benzo[b]thiophen- 5-yl)difluoromethyl)phosphonic acid |
| 324 | 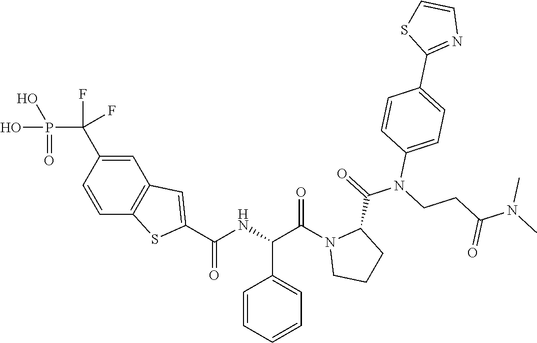 [SMILES: CN(C)C(=O)CCN(C(=O)[C@@H]1CCCN1C(=O)[C@@H](NC(=O)c1cc2cc(C(F)(F)P(=O)(O)O)ccc2s1)c1ccccc1)c1ccc(-c2nccs2)cc1] | ((2-(((S)-2-((S)-2-((3- (dimethylamino)-3-oxopropyl)(4- (thiazol-2- yl)phenyl)carbamoyl)pyrrolidin-1- yl)-2-oxo-1- phenylethyl)carbamoyl)benzo[b] thiophen-5- yl)difluoromethyl)phosphonic acid |
| 325 | 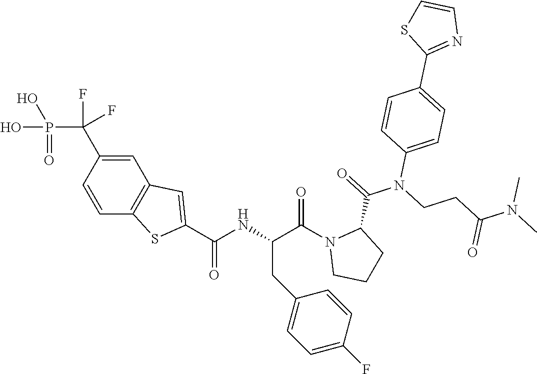 [SMILES: CN(C)C(=O)CCN(C(=O)[C@@H]1CCCN1C(=O)[C@H](Cc1ccc(F)cc1)NC(=O)c1cc2cc(C(F)(F)P(=O)(O)O)ccc2s1)c1ccc(-c2nccs2)cc1] | ((2-(((S)-1-((S)-2-((3- (dimethylamino)-3-oxopropyl)(4- (thiazol-2- yl)phenyl)carbamoyl)pyrrolidin-1- yl)-3-(4-fluorophenyl)-1-oxopropan- 2-yl)carbamoyl)benzo[b]thiophen-5- yl)difluoromethyl)phosphonic acid |
| 326 | 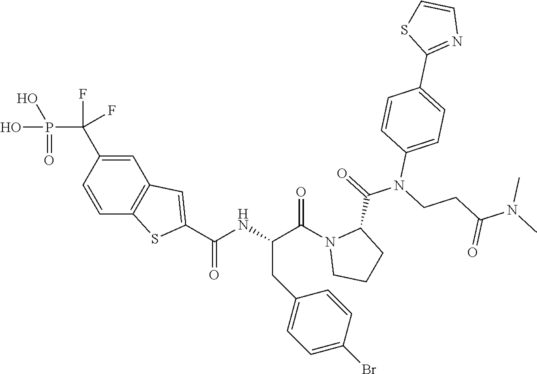 [SMILES: CN(C)C(=O)CCN(C(=O)[C@@H]1CCCN1C(=O)[C@H](Cc1ccc(Br)cc1)NC(=O)c1cc2cc(C(F)(F)P(=O)(O)O)ccc2s1)c1ccc(-c2nccs2)cc1] | ((2-(((S)-3-(4-bromopheny])-1-((S)- 2-((3-(dimethylamino)-3- oxopropyl)(4-(thiazol-2- yl)phenyl)carbamoyl)pyrrolidin-1- yl)-1-oxopropan-2- yl)carbamoyl)benzo[b]thiophen-5- yl)difluoromethyl)phosphonic acid |
| 327 | 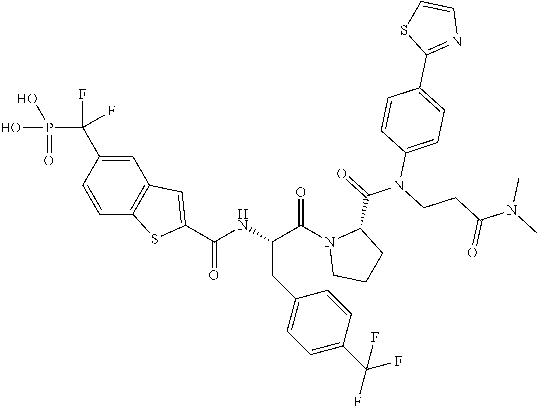 [SMILES: CN(C)C(=O)CCN(C(=O)[C@@H]1CCCN1C(=O)[C@H](Cc1ccc(C(F)(F)F)cc1)NC(=O)c1cc2cc(C(F)(F)P(=O)(O)O)ccc2s1)c1ccc(-c2nccs2)cc1] | ((2-(((S)-1-((S)-2-((3- (dimethylamino)-3-oxopropyl)(4- (thiazol-2- yl)phenyl)carbamoyl)pyrrolidin-1- yl)-1-oxo-3-(4- (trifluoromethyl)phenyl)propan-2- yl)carbamoyl)benzo[b]thiophen-5- yl)difluoromethyl)phosphonic acid |
| 328 | 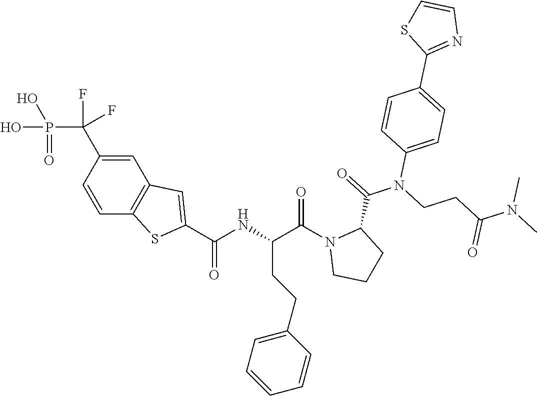 [SMILES: CN(C)C(=O)CCN(C(=O)[C@@H]1CCCN1C(=O)[C@H](CCc1ccccc1)NC(=O)c1cc2cc(C(F)(F)P(=O)(O)O)ccc2s1)c1ccc(-c2nccs2)cc1] | ((2-(((S)-1-((S)-2-((3- (dimethylamino)-3-oxopropyl)(4- (thiazol-2- yl)phenyl)carbamoyl)pyrrolidin-1- yl)-1-oxo-4-phenylbutan-2- yl)carbamoyl)benzo[b]thiophen-5- yl)difluoromethyl)phosphonic acid |
| 329 | 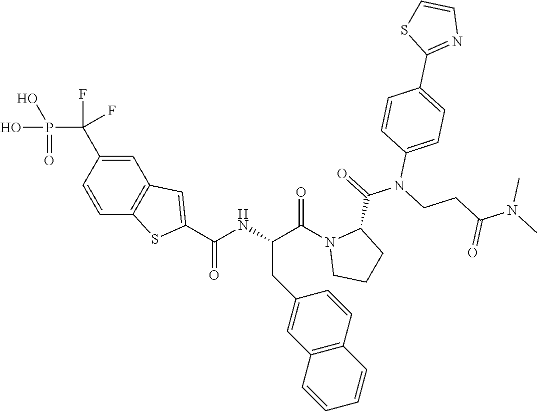 [SMILES: CN(C)C(=O)CCN(C(=O)[C@@H]1CCCN1C(=O)[C@H](Cc1ccc2ccccc2c1)NC(=O)c1cc2cc(C(F)(F)P(=O)(O)O)ccc2s1)c1ccc(-c2nccs2)cc1] | ((2-(((S)-1-((S)-2-((3- (dimethylamino)-3-oxopropyl)(4- (thiazol-2- yl)phenyl)carbamoyl)pyrrolidin-1- yl)-3-(naphthalen-2-y])-1- oxopropan-2- yl)carbamoyl)benzo[b]thiophen-5- yl)difluoromethyl)phosphonic acid |
| 330 | 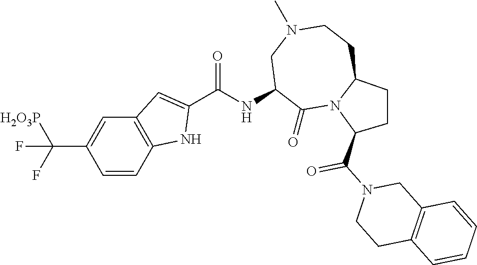 | (difluoro(2-(((5S,8S,10aR)-3- methyl-6-oxo-8-(1,2,3,4- tetrahydroisoquinoline-2- carbonyl)decahydropyrrolo[1,2- a][1,5]diazocin-5-yl)carbamoyl)- 1H-indol-5-yl)methyl)phosphonic acid |
| 331 | 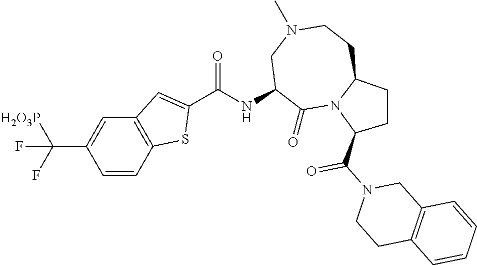 | (difluoro(2-(((5S,8S,10aR)-3- methyl-6-oxo-8-(1,2,3,4- tetrahydroisoquinoline-2- carbonyl)decahydropyrrolo[1,2- a][1,5]diazocin-5- yl)carbamoyl)benzo[b]thiophen-5- yl)methyl)phosphonic acid |
| 332 | 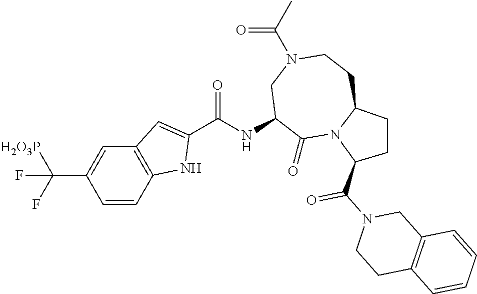 | ((2-(((5S,8S,10aR)-3-acetyl-6-oxo- 8-(1,2,3,4-tetrahydroisoquinoline-2- carbonyl)decahydropyrrolo[1,2- a][1,5]diazocin-5-yl)carbamoyl)- 1H-indol-5- yl)difluoromethyl)phosphonic acid |
| 333 | 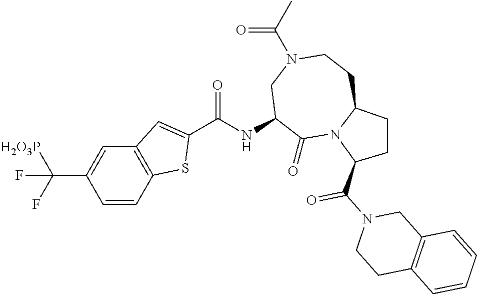 | ((2-(((5S,8S,10aR)-3-acetyl-6-oxo- 8-(1,2,3,4-tetrahydroisoquinoline-2- carbonyl)decahydropyrrolo[1,2- a][1,5]diazocin-5- yl)carbamoyl)benzo[b]thiophen-5- yl)difluoromethyl)phosphonic acid |
| 334 | 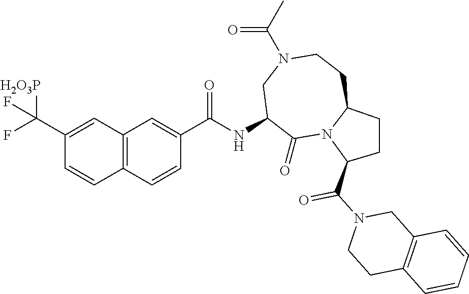 | ((7-(((5S,8S,10aR)-3-acetyl-6-oxo- 8-(1,2,3,4-tetrahydroisoquinoline-2- carbonyl)decahydropyrrolo[1,2- a][1,5]diazocin-5- yl)carbamoyl)naphthalen-2- yl)difluoromethyl)phosphonic acid |
| 335 | 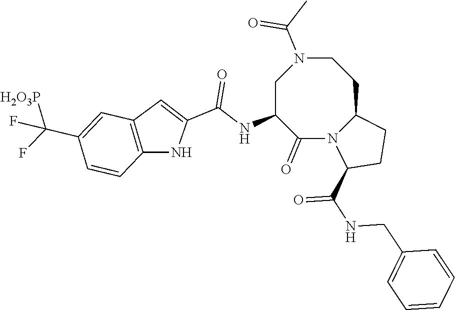 | ((2-(((5S,8S,10aR)-3-acetyl-8- (benzylcarbamoyl)-6- oxodecahydropyrrolo[1,2- a][1,5]diazocin-5-yl)carbamoyl)- 1H-indol-5- yl)difluoromethyl)phosphonic acid |
| 336 | 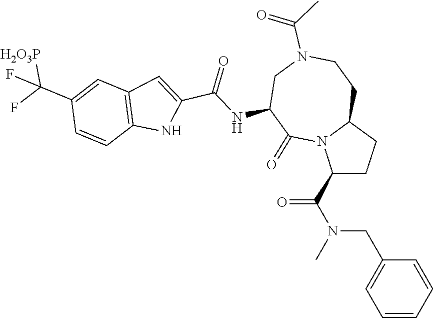 | ((2-(((5S,8S,10aR)-3-acetyl-8- (benzyl(methyl)carbamoyl)-6- oxodecahydropyrrolo[1,2- a][1,5]diazocin-5-yl)carbamoyl)- 1H-indol-5- yl)difluoromethyl)phosphonic acid |
| 337 | 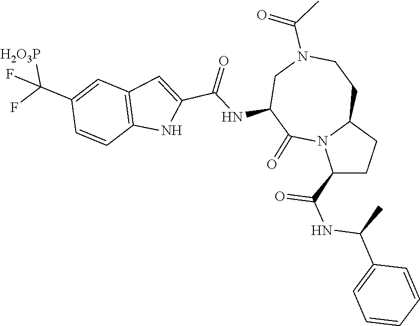 | ((2-(((5S,8S,10aR)-3-acetyl-6-oxo- 8-(((S)-1- phenylethyl)carbamoyl)decahydro pyrrolo[1,2-a][1,5]diazocin-5- yl)carbamoyl)-1H-indol-5- yl)difluoromethyl)phosphonic acid |
| 338 | 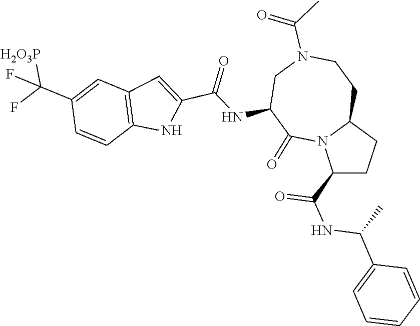 | ((2-(((5S,8S,10aR)-3-acetyl-6-oxo- 8-(((R)-1- phenylethyl)carbamoyl)decahydro pyrrolo[1,2-a][1,5]diazocin-5- yl)carbamoyl)-1H-indol-5- yl)difluoromethyl)phosphonic acid |
| 339 | 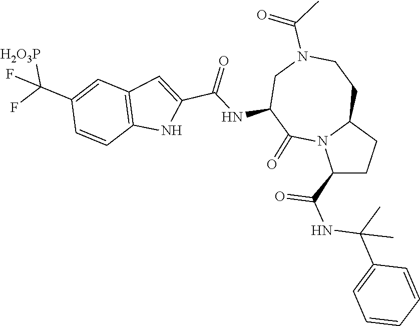 | ((2-(((5S,8S,10aR)-3-acetyl-6-oxo- 8-((2-phenylpropan-2- yl)carbamoyl)decahydropyrrolo[1,2- a][1,5]diazocin-5-yl)carbamoyl)- 1H-indol-5- yl)difluoromethyl)phosphonic acid |
| 340 | 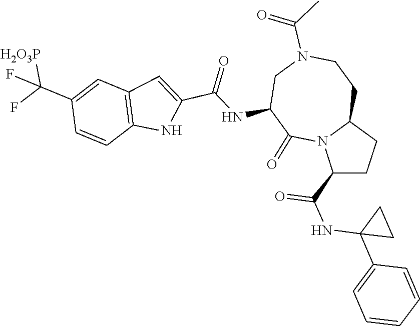 | ((2-(((5S,8S,10aR)-3-acetyl-6-oxo- 8-((1- phenylcyclopropyl)carbamoyl) decahydropyrrolo[1,2-a][1,5] diazocin-5-yl)carbamoyl)-1H-indol-5- yl)difluoromethyl)phosphonic acid |
| 341 | 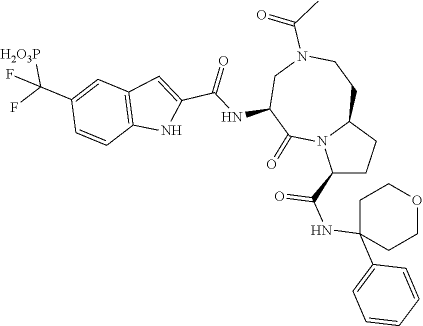 | ((2-(((5S,8S,10aR)-3-acetyl-6-oxo- 8-((4-phenyltetrahydro-2H-pyran-4- yl)carbamoyl)decahydropyrrolo[1,2- a][1,5]diazocin-5-yl)carbamoyl)- 1H-indol-5- yl)difluoromethyl)phosphonic acid |
| 342 | 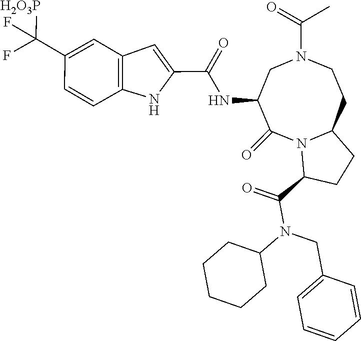 | ((2-(((5S,8S,10aR)-3-acetyl-8- (benzyl(cyclohexyl)carbamoyl)-6- oxodecahydropyrrolo[1,2- a][1,5]diazocin-5-yl)carbamoyl)- 1H-indol-5- yl)difluoromethyl)phosphonic acid |
| 343 | 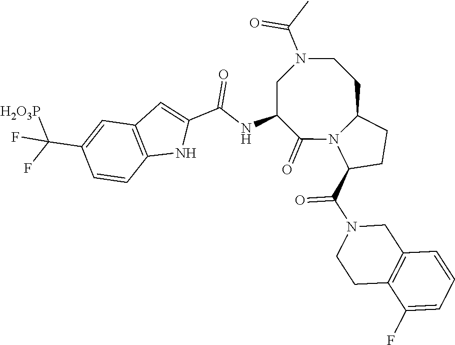 | ((2-(((5S,8S,10aR)-3-acetyl-8-(5- fluoro-1,2,3,4- tetrahydroisoquinoline-2-carbonyl)- 6-oxodecahydropyrrolo[1,2- a][1,5]diazocin-5-yl)carbamoyl)- 1H-indol-5- yl)difluoromethyl)phosphonic acid |
| 344 | 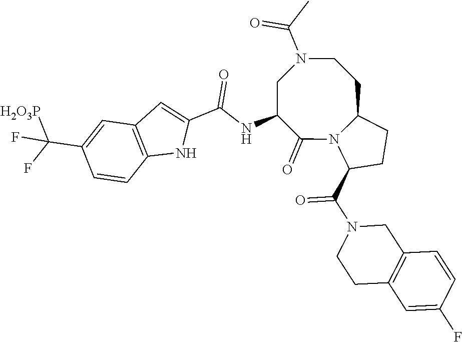 | ((2-(((5S,8S,10aR)-3-acetyl-8-(6- fluoro-1,2,3,4- tetrahydroisoquinoline-2-carbonyl)- 6-oxodecahydropyrrolo[1,2- a][1,5]diazocin-5-yl)carbamoyl)- 1H-indol-5- yl)difluoromethyl)phosphonic acid |
| 355 | 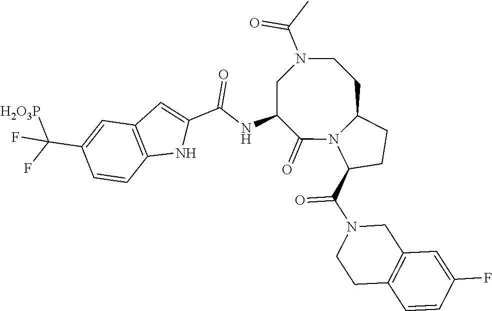 | ((2-(((5S,8S,10aR)-3-acetyl-8-(7- fluoro-1,2,3,4- tetrahydroisoquinoline-2-carbonyl)- 6-oxodecahydropyrrolo[1,2- a][1,5]diazocin-5-yl)carbamoyl)- 1H-indol-5- yl)difluoromethyl)phosphonic acid |
| 356 | 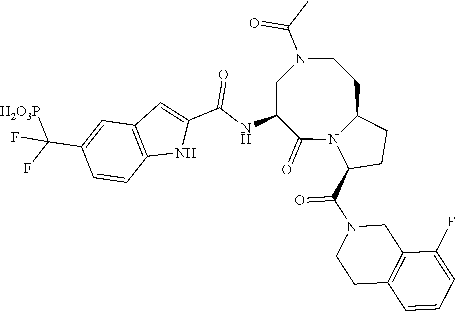 | ((2-(((5S,8S,10aR)-3-acetyl-8-(8- fluoro-1,2,3,4- tetrahydroisoquinoline-2-carbonyl)- 6-oxodecahydropyrrolo[1,2- a][1,5]diazocin-5-yl)carbamoyl)- 1H-indol-5- yl)difluoromethyl)phosphonic acid |
| 357 | 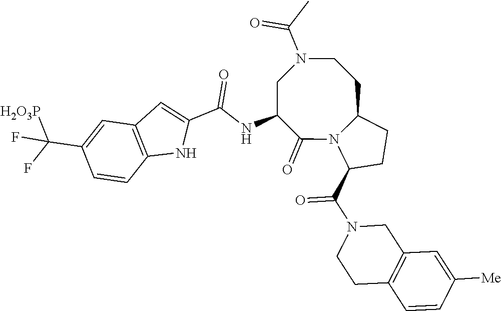 | ((2-(((5S,8S,10aR)-3-acetyl-8-(7- methyl-1,2,3,4- tetrahydroisoquinoline-2-carbonyl)- 6-oxodecahydropyrrolo[1,2- a][1,5]diazocin-5-yl)carbamoyl)- 1H-indol-5- yl)difluoromethyl)phosphonic acid |
| 358 | 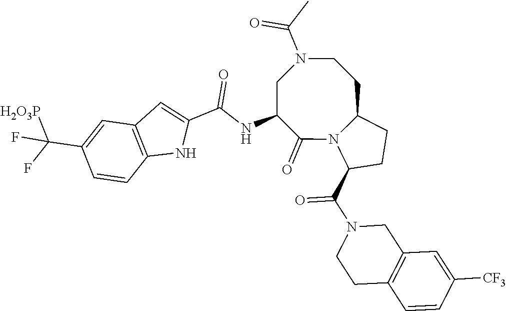 | ((2-(((5S,8S,10aR)-3-acetyl-6-oxo- 8-(7-(trifluoromethyl)-1,2,3,4- tetrahydroisoquinoline-2- carbonyl)decahydropyrrolo[1,2- a][1,5]diazocin-5-yl)carbamoyl)- 1H-indol-5- yl)difluoromethyl)phosphonic acid |
| 359 | 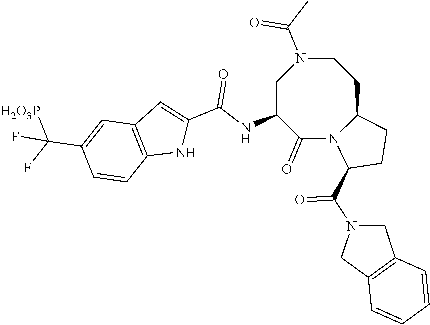 | ((2-(((5S,8S,10aR)-3-acetyl-8- (isoindoline-2-carbonyl)-6- oxodecahydropyrrolo[1,2- a][1,5]diazocin-5-yl)carbamoyl)- 1H-indol-5- yl)difluoromethyl)phosphonic acid |
| 360 | 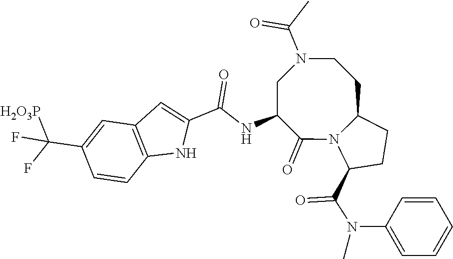 | ((2-(((5S,8S,10aR)-3-acetyl-8- (methyl(phenyl)carbamoyl)-6- oxodecahydropyrrolo[1,2- a][1,5]diazocin-5-yl)carbamoyl)- 1H-indol-5- yl)difluoromethyl)phosphonic acid |
| 361 | 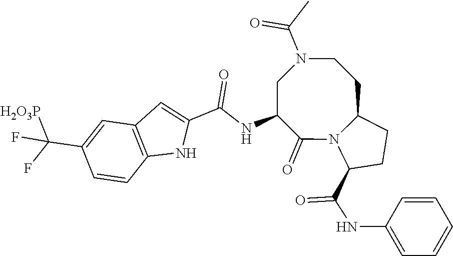 | ((2-(((5S,8S,10aR)-3-acetyl-6-oxo- 8- (phenylcarbamoyl)decahydropyrrolo [1,2-a][1,5]diazocin-5- yl)carbamoyl)-1H-indol-5- yl)difluoromethyl)phosphonic acid |
| 362 | 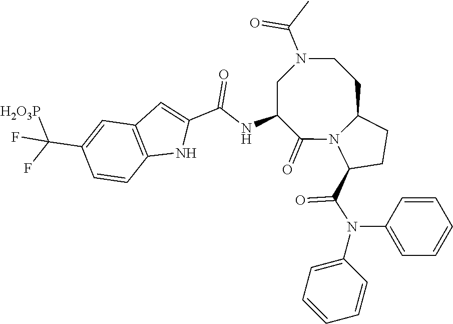 | ((2-(((5S,8S,10aR)-3-acetyl-8- (diphenylcarbamoyl)-6- oxodecahydropyrrolo[1,2- a][1,5]diazocin-5-yl)carbamoyl)- 1H-indol-5- yl)difluoromethyl)phosphonic acid |
| 363 | 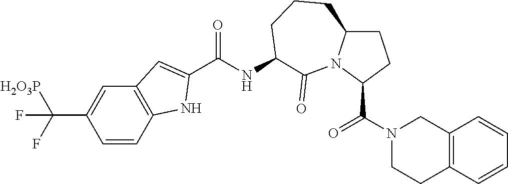 | (difluoro(2-(((3S,6S,9aS)-5-oxo-3- (1,2,3,4-tetrahydroisoquinoline-2- carbonyl)octahydro-1H-pyrrolo[1,2- alazepin-6-yl)carbamoyl)-1H-indol- 5-yl)methyl)phosphonic acid |
| 364 | 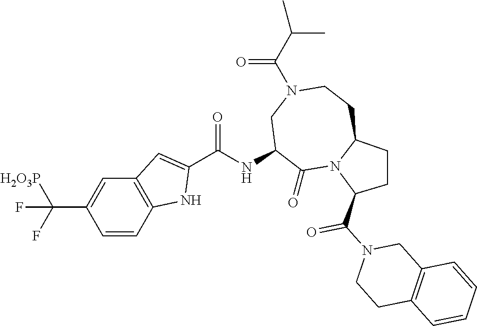 | (difluoro(2-(((5S,8S,10aR)-3- isobutyryl-6-oxo-8-(1,2,3,4- tetrahydroisoquinoline-2- carbonyl)decahydropyrrolo[1,2- a][1,5]diazocin-5-yl)carbamoyl)- 1H-indol-5-yl)methyl)phosphonic acid |
| 365 | 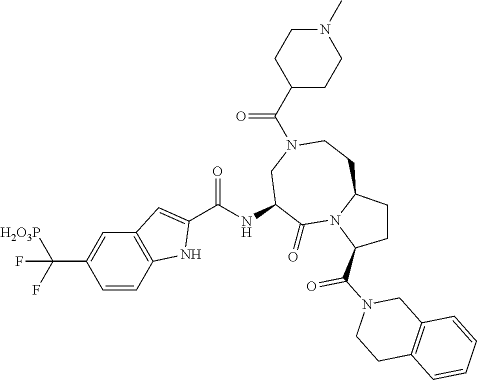 | (difluoro(2-(((5S,8S,10aR)-3-(1- methylpiperidine-4-carbonyl)-6- oxo-8-(1,2,3,4- tetrahydroisoquinoline-2- carbonyl)decahydropyrrolo[1,2- a][1,5]diazocin-5-yl)carbamoyl)- 1H-indol-5-yl)methyl)phosphonic acid |
| 366 | 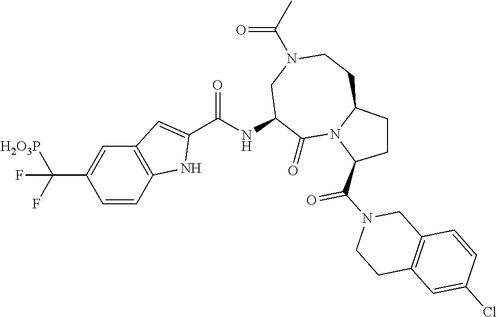 | ((2-(((5S,8S,10aR)-3-acetyl-8-(6- chloro-1,2,3,4- tetrahydroisoquinoline-2-carbonyl)- 6-oxodecahydropyrrolo[1,2- a][1,5]diazocin-5-yl)carbamoyl)- 1H-indol-5- yl)difluoromethyl)phosphonic acid |
| 367 | 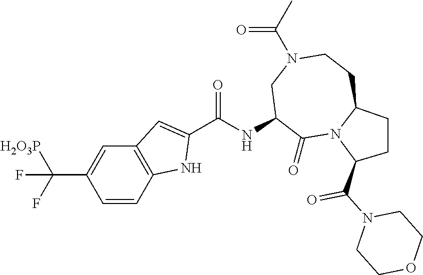 | ((2-(((5S,8S,10aR)-3-acetyl-8- (morpholine-4-carbonyl)-6- oxodecahydropyrrolo[1,2- a][1,5]diazocin-5-yl)carbamoyl)- 1H-indol-5- yl)difluoromethyl)phosphonic acid |
| 368 | 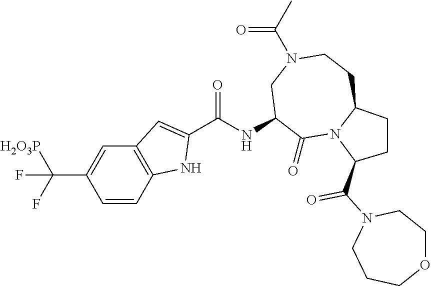 | ((2-(((5S,8S,10aR)-3-acetyl-8-(1,4- oxazepane-4-carbonyl)-6- oxodecahydropyrrolo[1,2- a][1,5]diazocin-5-yl)carbamoyl)- 1H-indol-5- yl)difluoromethyl)phosphonic acid |
| 369 | 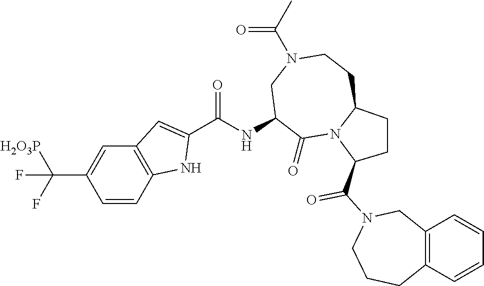 | ((2-(((5S,8S,10aR)-3-acetyl-6-oxo- 8-(2,3,4,5-tetrahydro-1H- benzo[c]azepine-2- carbonyl)decahydropyrrolo[1,2- a][1,5]diazocin-5-yl)carbamoyl)- 1H-indol-5- yl)difluoromethyl)phosphonic acid |
| 370 | 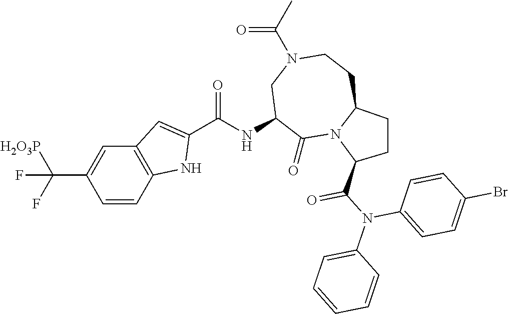 | ((2-(((5S,8S,10aR)-3-acetyl-8-((4- bromophenyl)(phenyl)carbamoyl)- 6-oxodecahydropyrrolo[1,2- a][1,5]diazocin-5-yl)carbamoyl)- 1H-indol-5- yl)difluoromethyl)phosphonic acid |
| 371 | 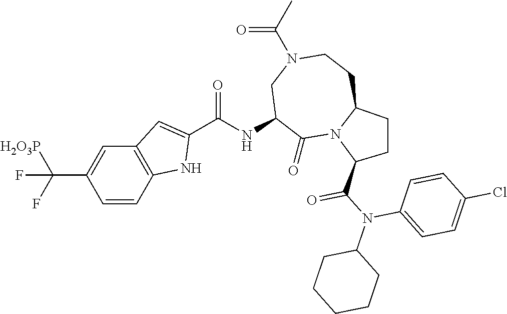 | ((2-(((5S,8S,10aR)-3-acetyl-8-((4- chlorophenyl)(cyclohexyl)carbamoyl)- 6-oxodecahydropyrrolo[1,2- a][1,5]diazocin-5-yl)carbamoyl)- 1H-indol-5- yl)difluoromethyl)phosphonic acid |
| 372 | 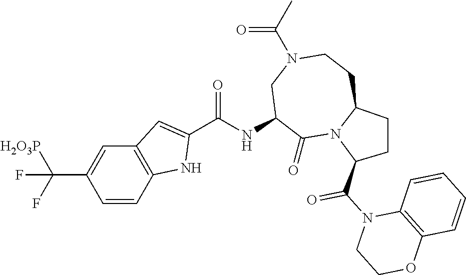 | ((2-(((5S,8S,10aR)-3-acetyl-8-(3,4- dihydro-2H-benzo[b][1,4]oxazine-4- carbonyl)-6- oxodecahydropyrrolo[1,2- a][1,5]diazocin-5-yl)carbamoyl)- 1H-indol-5- yl)difluoromethyl)phosphonic acid |
| 373 | 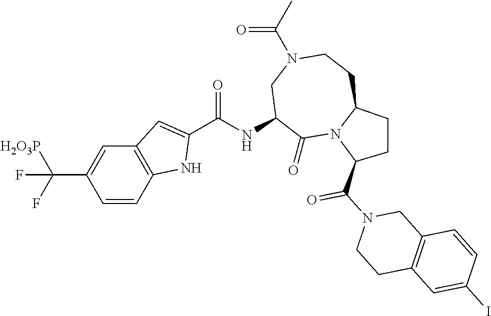 | ((2-(((5S,8S,10aR)-3-acetyl-8-(6- iodo-1,2,3,4-tetrahydroisoquinoline- 2-carbonyl)-6- oxodecahydropyrrolo[1,2- a][1,5]diazocin-5-yl)carbamoyl)- 1H-indol-5- yl)difluoromethyl)phosphonic acid |
| 374 | 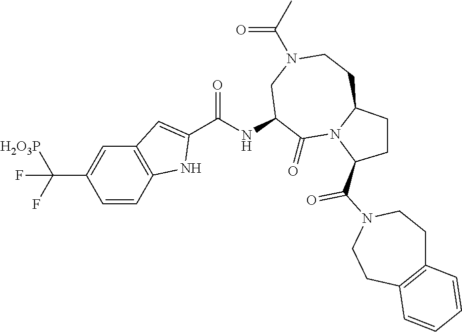 | ((2-(((5S,8S,10aR)-3-acetyl-6-oxo- 8-(2,3,4,5-tetrahydro-1H- benzo[d]azepine-3- carbonyl)decahydropyrrolo[1,2- a][1,5]diazocin-5-yl)carbamoyl)- 1H-indol-5- yl)difluoromethyl)phosphonic acid |
| 375 | 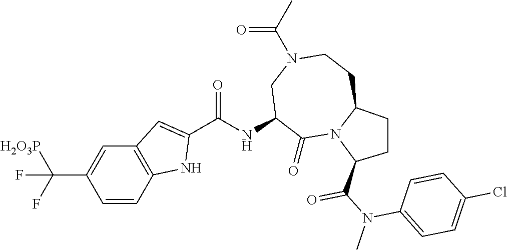 | ((2-(((5S,8S,10aR)-3-acetyl-8-((4- chlorophenyl)(methyl)carbamoyl)- 6-oxodecahydropyrrolo[1,2- a][1,5]diazocin-5-yl)carbamoyl)- 1H-indol-5- yl)difluoromethyl)phosphonic acid |
| 376 | 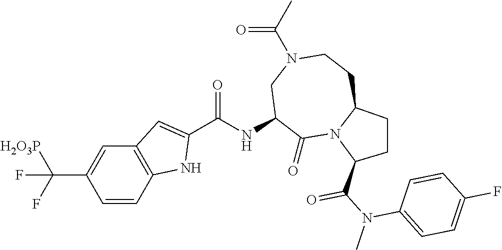 | ((2-(((5S,8S,10aR)-3-acetyl-8-((4- fluorophenyl)(methyl)carbamoyl)-6- oxodecahydropyrrolo[1,2- a][1,5]diazocin-5-yl)carbamoyl)- 1H-indol-5- yl)difluoromethyl)phosphonic acid |
| 377 | 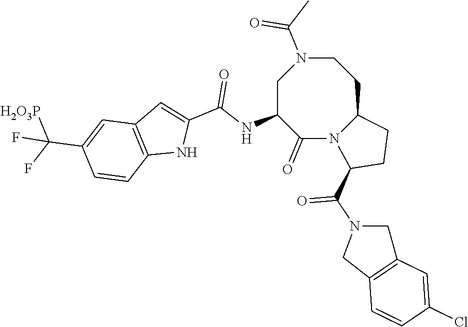 | ((2-(((5S,8S,10aR)-3-acetyl-8-(5- chloroisoindoline-2-carbonyl)-6- oxodecahydropyrrolo[1,2- a][1,5]diazocin-5-yl)carbamoyl)- 1H-indol-5- yl)difluoromethyl)phosphonic acid |
| 378 | 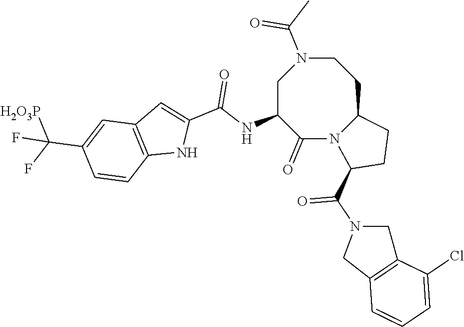 | ((2-(((5S,8S,10aR)-3-acetyl-8-(4- chloroisoindoline-2-carbonyl)-6- oxodecahydropyrrolo[1,2- a][1,5]diazocin-5-yl)carbamoyl)- 1H-indol-5- yl)difluoromethyl)phosphonic acid |
| 379 | 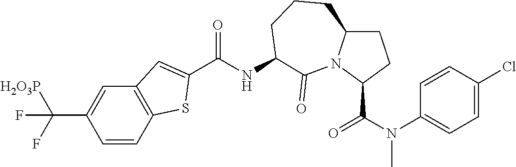 | ((2-(((3S,6S,9aS)-3-((4- chlorophenyl)(methyl)carbamoyl)- 5-oxooctahydro-1H-pyrrolo[1,2- a]azepin-6- yl)carbamoyl)benzo[b]thiophen-5- yl)difluoromethyl)phosphonic acid |
| 380 | 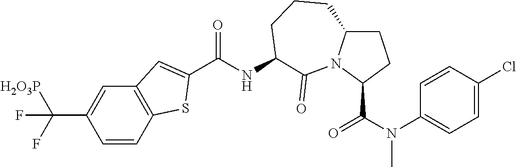 | ((2-(((3S,6S,9aR)-3-((4- chlorophenyl)(methyl)carbamoyl)- 5-oxooctahydro-1H-pyrrolo[1,2- a]azepin-6- yl)carbamoyl)benzo[b]thiophen-5- yl)difluoromethyl)phosphonic acid |
| 381 | 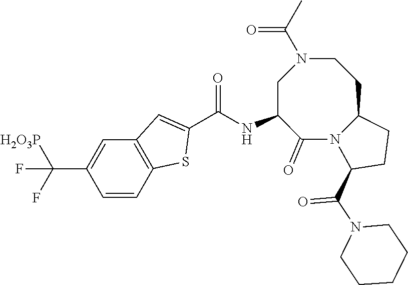 | ((2-(((5S,8S,10aR)-3-acetyl-6-oxo- 8-(piperidine-1- carbonyl)decahydropyrrolo[1,2- a][1,5]diazocin-5- yl)carbamoyl)benzo[b]thiophen-5- yl)difluoromethyl)phosphonic acid |
| 382 | 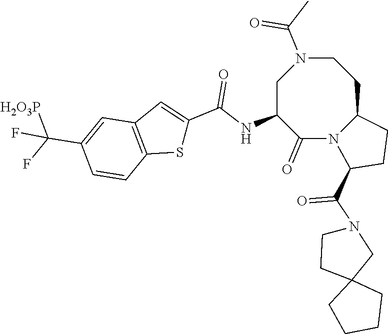 | ((2-(((5S,8S,10aR)-3-acetyl-6-oxo- 8-(2-azaspiro[4.4]nonane-2- carbonyl)decahydropyrrolo[1,2- a][1,5]diazocin-5- yl)carbamoyl)benzo[b]thiophen-5- yl)difluoromethyl)phosphonic acid |
| 383 | 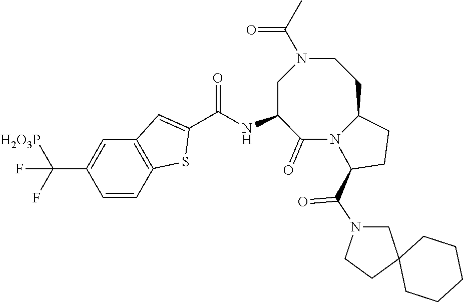 | ((2-(((5S,8S,10aR)-3-acetyl-6-oxo- 8-(2-azaspiro[4.5]decane-2- carbonyl)decahydropyrrolo[1,2- a][1,5]diazocin-5- yl)carbamoyl)benzo[b]thiophen-5- yl)difluoromethyl)phosphonic acid |
| 384 | 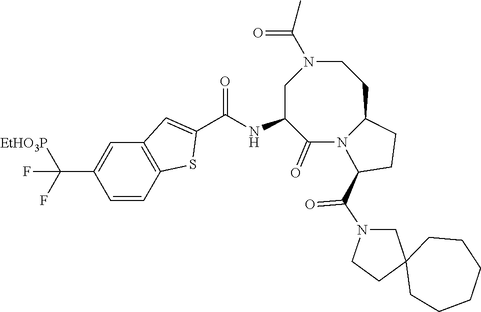 | ethyl hydrogen ((2-(((5S,8S,10aR)- 3-acetyl-6-oxo-8-(2- azaspiro[4.6]undecane-2- carbonyl)decahydropyrrolo[1,2- a][1,5]diazocin-5- yl)carbamoyl)benzo[b]thiophen-5- yl)difluoromethyl)phosphonate |
| 385 | 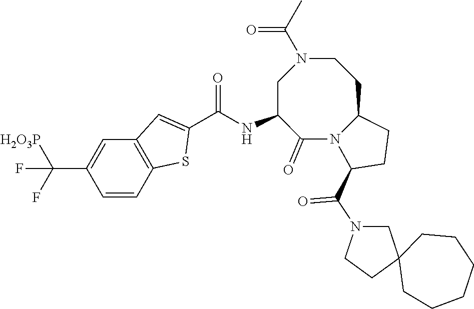 | ((2-(((5S,8S,10aR)-3-acetyl-6-oxo- 8-(2-azaspiro[4.6]undecane-2- carbonyl)decahydropyrrolo[1,2- a][1,5]diazocin-5- yl)carbamoyl)benzo[b]thiophen-5- yl)difluoromethyl)phosphonic acid |
| 386 | 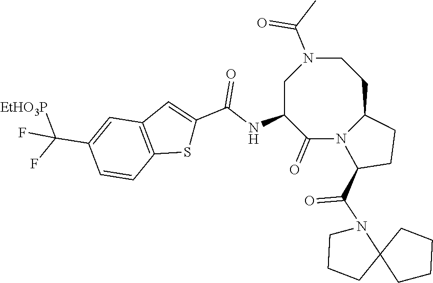 | ethyl hydrogen ((2-(((5S,8S,10aR)- 3-acetyl-6-oxo-8-(1- azaspiro[4.4]nonane-1- carbonyl)decahydropyrrolo[1,2- a][1,5]diazocin-5- yl)carbamoyl)benzo[b]thiophen-5- yl)difluoromethyl)phosphonate |
| 387 | 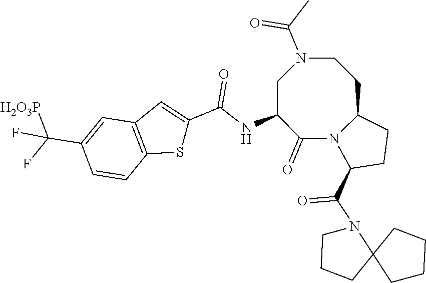 | ((2-(((5S,8S,10aR)-3-acetyl-6-oxo- 8-(1-azaspiro[4.4]nonane-1- carbonyl)decahydropyrrolo[1,2- a][1,5]diazocin-5- yl)carbamoyl)benzo[b]thiophen-5- yl)difluoromethyl)phosphonic acid |
| 388 | 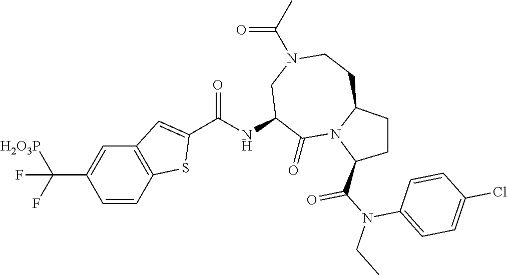 | ((2-(((5S,8S,10aR)-3-acetyl-8-((4- chlorophenyl)(ethyl)carbamoyl)-6- oxodecahydropyrrolo[1,2- a][1,5]diazocin-5- yl)carbamoyl)benzo[b]thiophen-5- yl)difluoromethyl)phosphonic acid |
| 389 | 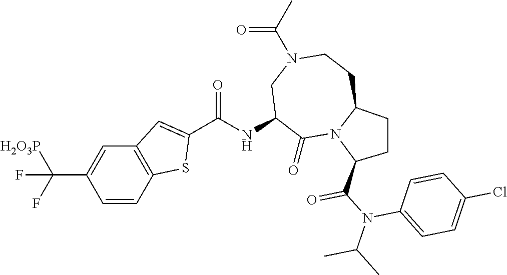 | ((2-(((5S,8S,10aR)-3-acetyl-8-((4- chlorophenyl)(isopropyl)carbamoyl)- 6-oxodecahydropyrrolo[1,2- a][1,5]diazocin-5- yl)carbamoyl)benzo[b]thiophen-5- yl)difluoromethyl)phosphonic acid |
| 390 | 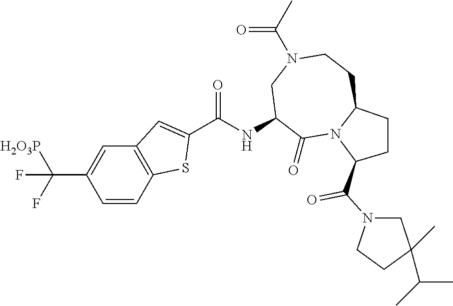 | ((2-(((5S,8S,10aR)-3-acetyl-8-(3- isopropyl-3-methylpyrrolidine-1- carbonyl)-6- oxodecahydropyrrolo[1,2- a][1,5]diazocin-5- yl)carbamoyl)benzo[b]thiophen-5- yl)difluoromethyl)phosphonic acid |
| 391 | 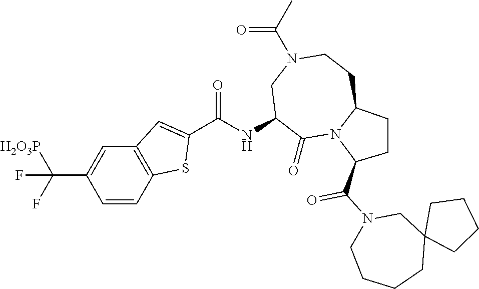 | ((2-(((5S,8S,10aR)-3-acetyl-6-oxo- 8-(7-azaspiro[4.6]undecane-7- carbonyl)decahydropyrrolo[1,2- a][1,5]diazocin-5- yl)carbamoyl)benzo[b]thiophen-5- yl)difluoromethyl)phosphonic acid |
| 392 | 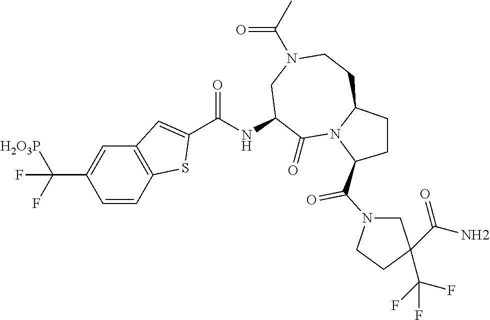 | ((2-(((5S,8S,10aR)-3-acetyl-8-(3- carbamoyl-3- (trifluoromethyl)pyrrolidine-1- carbonyl)-6- oxodecahydropyrrolo[1,2- a][1,5]diazocin-5- yl)carbamoyl)benzo[b]thiophen-5- yl)difluoromethyl)phosphonic acid |
| 393 | 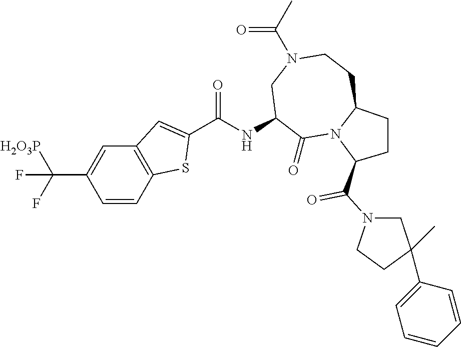 | ((2-(((5S,8S,10aR)-3-acetyl-8-(3- methyl-3-phenylpyrrolidine-1- carbonyl)-6- oxodecahydropyrrolo[1,2- a][1,5]diazocin-5- yl)carbamoyl)benzo[b]thiophen-5- yl)difluoromethyl)phosphonic acid |
| 394 | 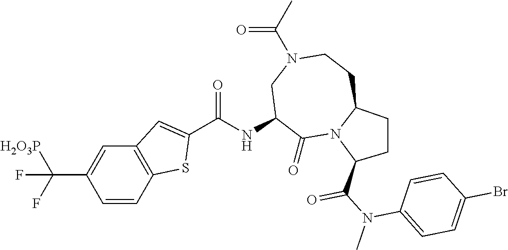 | ((2-(((5S,8S,10aR)-3-acetyl-8-((4- bromophenyl)(methyl)carbamoyl)- 6-oxodecahydropyrrolo[1,2- a][1,5]diazocin-5- yl)carbamoyl)benzo[b]thiophen-5- yl)difluoromethyl)phosphonic acid |
| 395 | 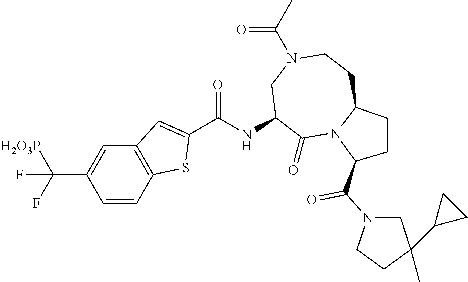 | ((2-(((5S,8S,10aR)-3-acetyl-8-(3- cyclopropyl-3-methylpyrrolidine-1- carbonyl)-6- oxodecahydropyrrolo[1,2- a][1,5]diazocin-5- yl)carbamoyl)benzo[b]thiophen-5- yl)difluoromethyl)phosphonic acid |

In certain embodiments, the compound is selected from compounds described in Table 2 and pharmaceutically acceptable salts, solvates, or stereoisomers thereof.

TABLE 2

| Cpd. No. | Structure | Name |
|---|---|---|
| 396 | 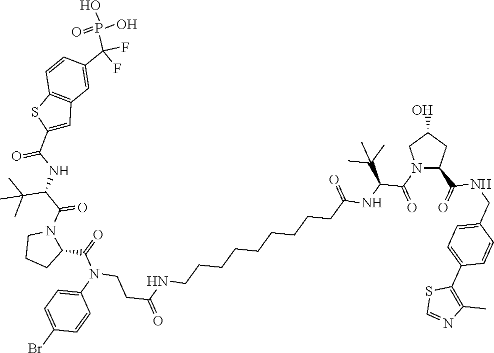 [SMILES: Cc1ncsc1-c1ccc(CNC(=O)[C@@H]2C[C@@H](O)CN2C(=O)[C@@H](NC(=O)CCCCCCCCCNC(=O)CCN(C(=O)[C@@H]2CCCN2C(=O)[C@@H](NC(=O)c2cc3cc(C(F)(F)P(=O)(O)O)ccc3s2)C(C)(C)C)c2ccc(Br)cc2)C(C)(C)C)cc1] | ((2-(((S)-1-((S)-2-((4-bromophenyl)(3-((10-(((S)-1-((2S,4R)-4- hydroxy-2-((4-(5-methyl-3H-pyrrol-4- yl)benzyl)carbamoyl)pyrrolidin-1-yl)-3,3-dimethyl-1- oxobutan-2-yl)amino)-10-oxodecyl)amino)-3- oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 397 | 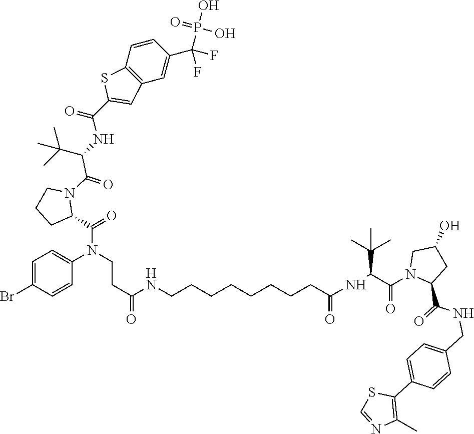 [SMILES: Cc1ncsc1-c1ccc(CNC(=O)[C@@H]2C[C@@H](O)CN2C(=O)[C@@H](NC(=O)CCCCCCCCNC(=O)CCN(C(=O)[C@@H]2CCCN2C(=O)[C@@H](NC(=O)c2cc3cc(C(F)(F)P(=O)(O)O)ccc3s2)C(C)(C)C)c2ccc(Br)cc2)C(C)(C)C)cc1] | ((2-(((S)-1-((S)-2-((4-bromophenyl)(3-((9-(((S)-1-((2S,4R)-4- hydroxy-2-((4-(5-methyl-3H-pyrrol-4- yl)benzyl)carbamoyl)pyrrolidin-1-yl)-3,3-dimethyl-1- oxobutan-2-yl)amino)-9-oxononyl)amino)-3- oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 398 | 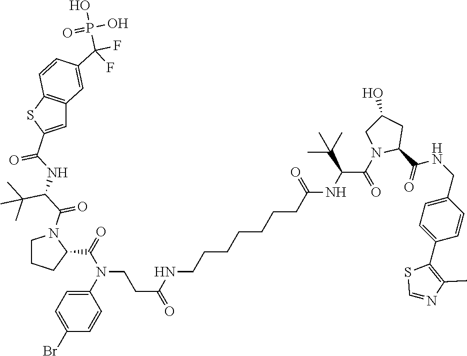 [SMILES: Cc1ncsc1-c1ccc(CNC(=O)[C@@H]2C[C@@H](O)CN2C(=O)[C@@H](NC(=O)CCCCCCCNC(=O)CCN(C(=O)[C@@H]2CCCN2C(=O)[C@@H](NC(=O)c2cc3cc(C(F)(F)P(=O)(O)O)ccc3s2)C(C)(C)C)c2ccc(Br)cc2)C(C)(C)C)cc1] | ((2-(((S)-1-((S)-2-((4-bromophenyl)(3-((8-(((S)-1-((2S,4R)-4- hydroxy-2-((4-(5-methyl-3H-pyrrol-4- yl)benzyl)carbamoyl)pyrrolidin-1-yl)-3,3-dimethyl-1- oxobutan-2-yl)amino)-8-oxooctyl)amino)-3- oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 399 | 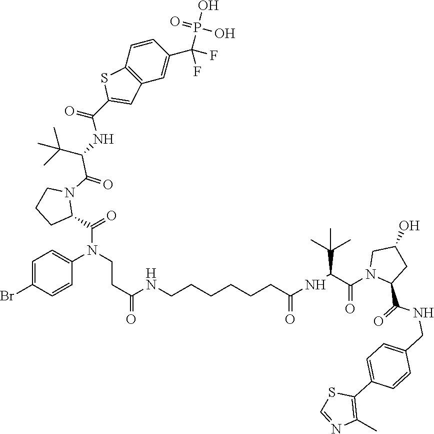 [SMILES: Cc1ncsc1-c1ccc(CNC(=O)[C@@H]2C[C@@H](O)CN2C(=O)[C@@H](NC(=O)CCCCCCNC(=O)CCN(C(=O)[C@@H]2CCCN2C(=O)[C@@H](NC(=O)c2cc3cc(C(F)(F)P(=O)(O)O)ccc3s2)C(C)(C)C)c2ccc(Br)cc2)C(C)(C)C)cc1] | ((2-(((S)-1-((S)-2-((4-bromophenyl)(3-((7-(((S)-1-((2S,4R)-4- hydroxy-2-((4-(5-methyl-3H-pyrrol-4- yl)benzyl)carbamoyl)pyrrolidin-1-yl)-3,3-dimethyl-1- oxobutan-2-yl)amino)-7-oxoheptyl)amino)-3- oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 400 | 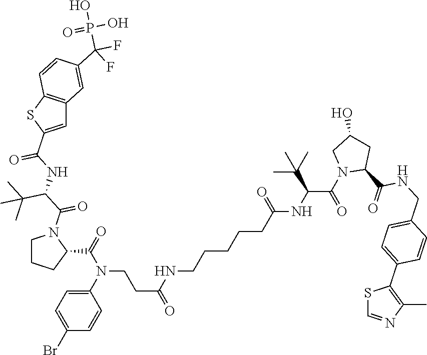 [SMILES: Cc1ncsc1-c1ccc(CNC(=O)[C@@H]2C[C@@H](O)CN2C(=O)[C@@H](NC(=O)CCCCCNC(=O)CCN(C(=O)[C@@H]2CCCN2C(=O)[C@@H](NC(=O)c2cc3cc(C(F)(F)P(=O)(O)O)ccc3s2)C(C)(C)C)c2ccc(Br)cc2)C(C)(C)C)cc1] | ((2-(((S)-1-((S)-2-((4-bromophenyl)(3-((6-(((S)-1-((2S,4R)-4- hydroxy-2-((4-(5-methyl-3H-pyrrol-4- yl)benzyl)carbamoyl)pyrrolidin-1-yl)-3,3-dimethyl-1- oxobutan-2-yl)amino)-6-oxohexyl)amino)-3- oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 401 | 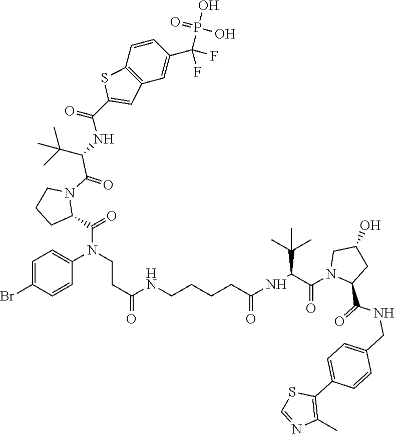 [SMILES: Cc1ncsc1-c1ccc(CNC(=O)[C@@H]2C[C@@H](O)CN2C(=O)[C@@H](NC(=O)CCCCNC(=O)CCN(C(=O)[C@@H]2CCCN2C(=O)[C@@H](NC(=O)c2cc3cc(C(F)(F)P(=O)(O)O)ccc3s2)C(C)(C)C)c2ccc(Br)cc2)C(C)(C)C)cc1] | ((2-(((S)-1-((S)-2-((4-bromophenyl)(3-((5-(((S)-1-((2S,4R)-4- hydroxy-2-((4-(5-methyl-3H-pyrrol-4- yl)benzyl)carbamoyl)pyrrolidin-1-yl)-3,3-dimethyl-1- oxobutan-2-yl)amino)-5-oxopentyl)amino)-3- oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 402 | 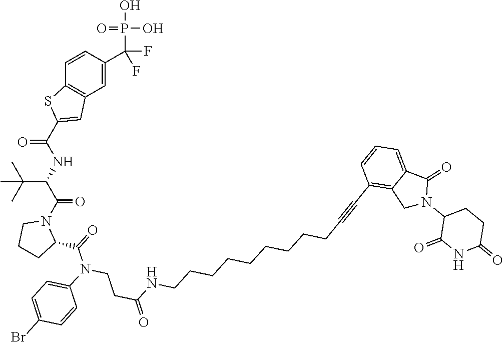 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCCCCCCCC#Cc1cccc2c1CN(C1CCC(=O)NC1=O)C2=O)c1ccc(Br)cc1] | ((2-(((2S)-1-((2S)-2-((4-bromophenyl)(3-((11-(2-(2,6- dioxopiperidin-3-yl)-1-oxoisoindolin-4-yl)undec-10-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 403 | 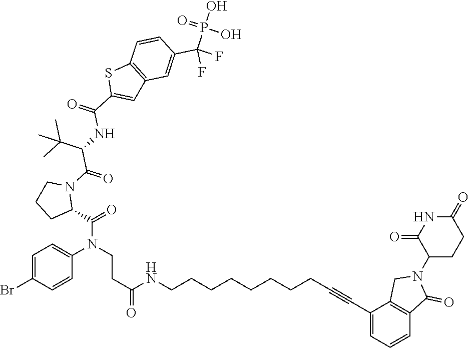 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCCCCCCC#Cc1cccc2c1CN(C1CCC(=O)NC1=O)C2=O)c1ccc(Br)cc1] | ((2-(((2S)-1-((2S)-2-((4-bromophenyl)(3-((10-(2-(2,6- dioxopiperidin-3-yl)-1-oxoisoindolin-4-yl)dec-9-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 404 | 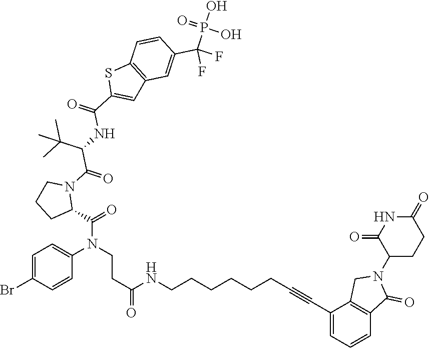 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCCCCC#Cc1cccc2c1CN(C1CCC(=O)NC1=O)C2=O)c1ccc(Br)cc1] | ((2-(((2S)-1-((2S)-2-((4-bromophenyl)(3-((8-(2-(2,6- dioxopiperidin-3-yl)-1-oxoisoindolin-4-yl)oct-7-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 405 | 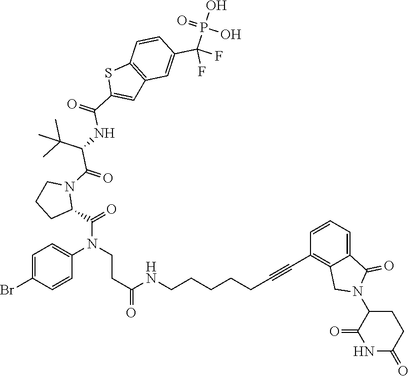 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCCCC#Cc1cccc2c1CN(C1CCC(=O)NC1=O)C2=O)c1ccc(Br)cc1] | ((2-(((2S)-1-((2S)-2-((4-bromophenyl)(3-((7-(2-(2,6- dioxopiperidin-3-yl)-1-oxoisoindolin-4-yl)hept-6-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 406 | 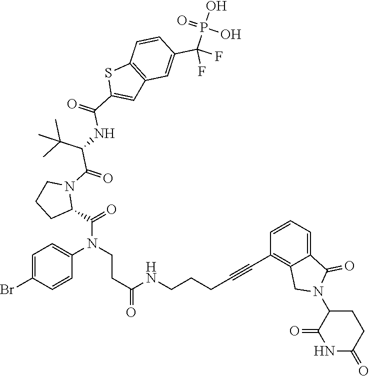 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(Br)cc1] | ((2-(((2S)-1-((2S)-2-((4-bromophenyl)(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 407 | 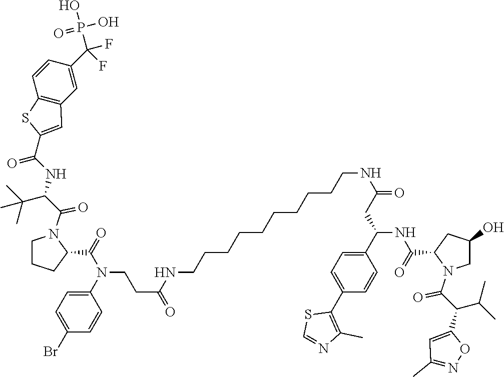 [SMILES: Cc1cc([C@H](C(=O)N2C[C@H](O)C[C@H]2C(=O)N[C@@H](CC(=O)NCCCCCCCCCCNC(=O)CCN(C(=O)[C@@H]2CCCN2C(=O)[C@@H](NC(=O)c2cc3cc(C(F)(F)P(=O)(O)O)ccc3s2)C(C)(C)C)c2ccc(Br)cc2)c2ccc(-c3scnc3C)cc2)C(C)C)on1] | ((2-(((S)-1-((S)-2-((4-bromophenyl)(3-((10-((S)-3-((2S,4R)-4- hydroxy-1-((R)-3-methyl-2-(3-methylisoxazol-5- yl)butanoyl)pyrrolidine-2-carboxamido)-3-(4-(4-methylthiazol- 5-yl)phenyl)propanamido)decyl)amino)-3- oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 408 | 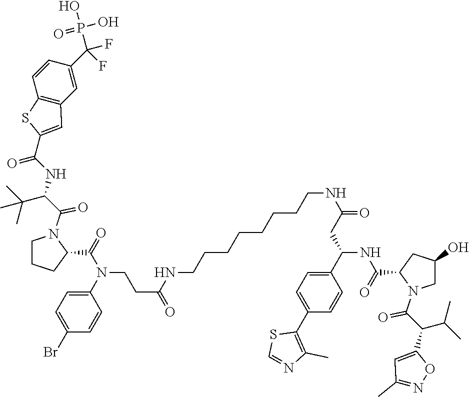 [SMILES: Cc1cc([C@H](C(=O)N2C[C@H](O)C[C@H]2C(=O)N[C@@H](CC(=O)NCCCCCCCCNC(=O)CCN(C(=O)[C@@H]2CCCN2C(=O)[C@@H](NC(=O)c2cc3cc(C(F)(F)P(=O)(O)O)ccc3s2)C(C)(C)C)c2ccc(Br)cc2)c2ccc(-c3scnc3C)cc2)C(C)C)on1] | ((2-(((S)-1-((S)-2-((4-bromophenyl)(3-((8-((S)-3-((2S,4R)-4- hydroxy-1-((R)-3-methyl-2-(3-methylisoxazol-5- yl)butanoyl)pyrrolidine-2-carboxamido)-3-(4-(4-methylthiazol- 5-yl)phenyl)propanamido)octyl)amino)-3- oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 409 | 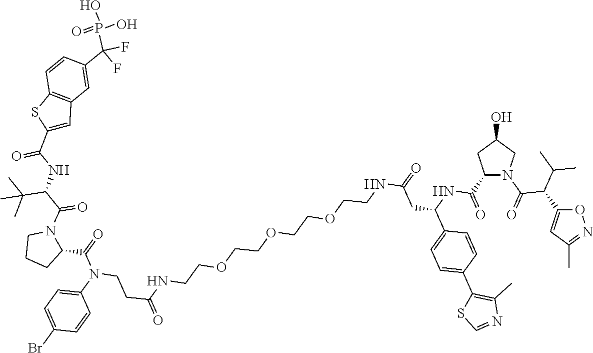 [SMILES: Cc1cc([C@H](C(=O)N2C[C@H](O)C[C@H]2C(=O)N[C@@H](CC(=O)NCCOCCOCCOCCNC(=O)CCN(C(=O)[C@@H]2CCCN2C(=O)[C@@H](NC(=O)c2cc3cc(C(F)(F)P(=O)(O)O)ccc3s2)C(C)(C)C)c2ccc(Br)cc2)c2ccc(-c3scnc3C)cc2)C(C)C)on1] | ((2-(((S)-1-((S)-2-((4-bromophenyl)((S)-1-((2S,4R)-4-hydroxy- 1-((R)-3-methyl-2-(3-methylisoxazol-5-yl)butanoyl)pyrrolidin- 2-yl)-3-(4-(4-methylthiazol-5-yl)phenyl)-1,5,19-trioxo-9,12,15- trioxa-2,6,18-triazahenicosan-21-yl)carbamoyl)pyrrolidin-1- yl)-3,3-dimethyl-1-oxobutan-2- yl)carbamoyl)benzo[b]thiophen-5- yl)difluoromethyl)phosphonic acid |
| 410 | 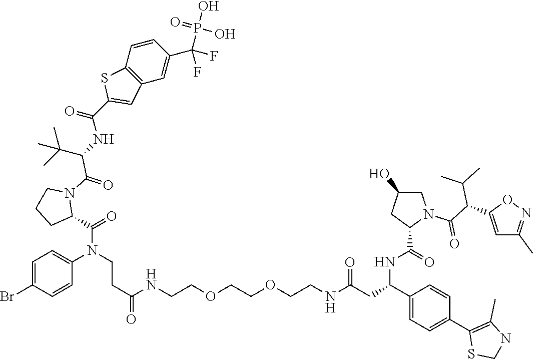 | ((2-(((S)-1-((S)-2-((4-bromophenyl)((S)-1-((2S,4R)-4-hydroxy- 1-((R)-3-methyl-2-(3-methylisoxazol-5-yl)butanoyl)pyrrolidin- 2-yl)-3-(4-(4-methylthiazol-5-yl)phenyl)-1,5,16-trioxo-9,12- dioxa-2,6,15-triazaoctadecan-18-yl)carbamoyl)pyrrolidin-1-yl)- 3,3-dimethyl-1-oxobutan-2-yl)carbamoyl)benzo[b]thiophen-5- yl)difluoromethyl)phosphonic acid |
| 411 | 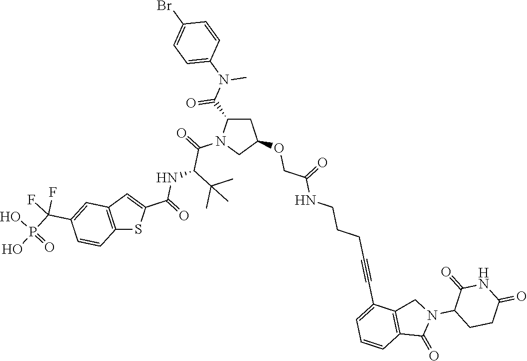 [SMILES: CN(C(=O)[C@@H]1C[C@@H](OCC(=O)NCCCC#Cc2cccc3c2CN(C2CCC(=O)NC2=O)C3=O)CN1C(=O)[C@@H](NC(=O)c1cc2cc(C(F)(F)P(=O)(O)O)ccc2s1)C(C)(C)C)c1ccc(Br)cc1] | ((2-(((2S)-1-((2S,4R)-2-((4-bromophenyl)(methyl)carbamoyl)- 4-(2-((5-(2-(2,6-dioxopiperidin-3-yl)-1-oxoisoindolin-4- yl)pent-4-yn-1-yl)amino)-2-oxoethoxy)pyrrolidin-1-yl)-3,3- dimethyl-1-oxobutan-2-yl)carbamoyl)benzo[b]thiophen-5- yl)difluoromethyl)phosphonic acid |
| 412 | 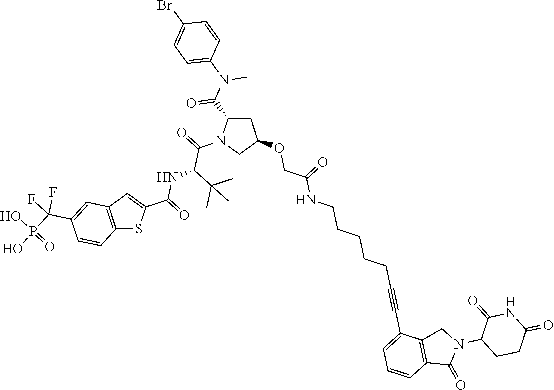 [SMILES: CN(C(=O)[C@@H]1C[C@@H](OCC(=O)NCCCCCC#Cc2cccc3c2CN(C2CCC(=O)NC2=O)C3=O)CN1C(=O)[C@@H](NC(=O)c1cc2cc(C(F)(F)P(=O)(O)O)ccc2s1)C(C)(C)C)c1ccc(Br)cc1] | ((2-(((2S)-1-((2S,4R)-2-((4-bromophenyl)(methyl)carbamoyl)- 4-(2-((7-(2-(2,6-dioxopiperidin-3-yl)-1-oxoisoindolin-4- yl)hept-6-yn-1-yl)amino)-2-oxoethoxy)pyrrolidin-1-yl)-3,3- dimethyl-1-oxobutan-2-yl)carbamoyl)benzo[b]thiophen-5- yl)difluoromethyl)phosphonic acid |
| 413 | 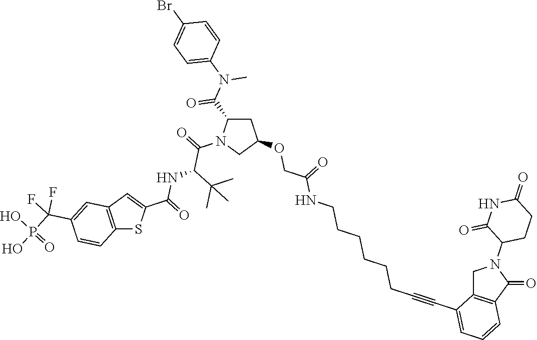 [SMILES: CN(C(=O)[C@@H]1C[C@@H](OCC(=O)NCCCCCCC#Cc2cccc3c2CN(C2CCC(=O)NC2=O)C3=O)CN1C(=O)[C@@H](NC(=O)c1cc2cc(C(F)(F)P(=O)(O)O)ccc2s1)C(C)(C)C)c1ccc(Br)cc1] | ((2-(((2S)-1-((2S,4R)-2-((4-bromophenyl)(methyl)carbamoyl)- 4-(2-((8-(2-(2,6-dioxopiperidin-3-yl)-1-oxoisoindolin-4-yl)oct- 7-yn-1-yl)amino)-2-oxoethoxy)pyrrolidin-1-yl)-3,3-dimethyl-1- oxobutan-2-yl)carbamoyl)benzo[b]thiophen-5- yl)difluoromethyl)phosphonic acid |
| 414 | 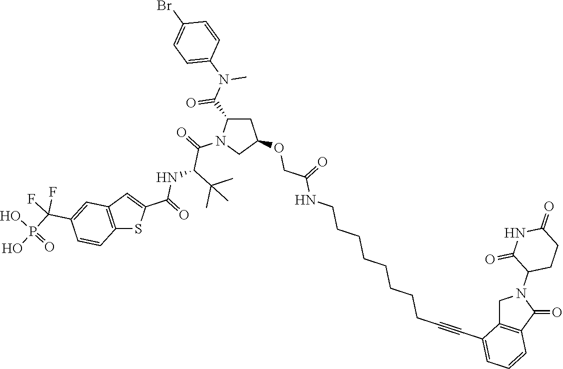 [SMILES: CN(C(=O)[C@@H]1C[C@@H](OCC(=O)NCCCCCCCCC#Cc2cccc3c2CN(C2CCC(=O)NC2=O)C3=O)CN1C(=O)[C@@H](NC(=O)c1cc2cc(C(F)(F)P(=O)(O)O)ccc2s1)C(C)(C)C)c1ccc(Br)cc1] | ((2-(((2S)-1-((2S,4R)-2-((4-bromophenyl)(methyl)carbamoyl)- 4-(2-((10-(2-(2,6-dioxopiperidin-3-yl)-1-oxoisoindolin-4- yl)dec-9-yn-1-yl)amino)-2-oxoethoxy)pyrrolidin-1-yl)-3,3- dimethyl-1-oxobutan-2-yl)carbamoyl)benzo[b]thiophen-5- yl)difluoromethyl)phosphonic acid |
| 415 | 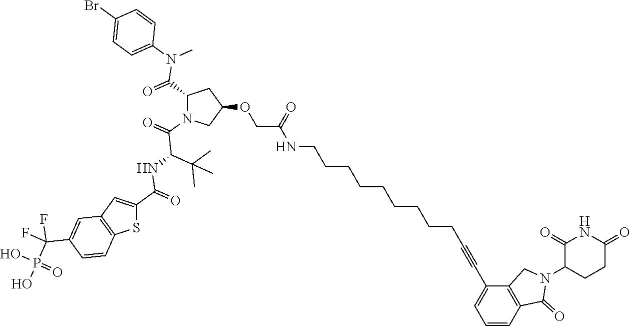 [SMILES: CN(C(=O)[C@@H]1C[C@@H](OCC(=O)NCCCCCCCCCC#Cc2cccc3c2CN(C2CCC(=O)NC2=O)C3=O)CN1C(=O)[C@@H](NC(=O)c1cc2cc(C(F)(F)P(=O)(O)O)ccc2s1)C(C)(C)C)c1ccc(Br)cc1] | ((2-(((2S)-1-((2S,4R)-2-((4-bromophenyl)(methyl)carbamoyl)- 4-(2-((11-(2-(2,6-dioxopiperidin-3-yl)-1-oxoisoindolin-4- yl)undec-10-yn-1-yl)amino)-2-oxoethoxy)pyrrolidin-1-yl)-3,3- dimethyl-1-oxobutan-2-yl)carbamoyl)benzo[b]thiophen-5- yl)difluoromethyl)phosphonic acid |
| 416 | 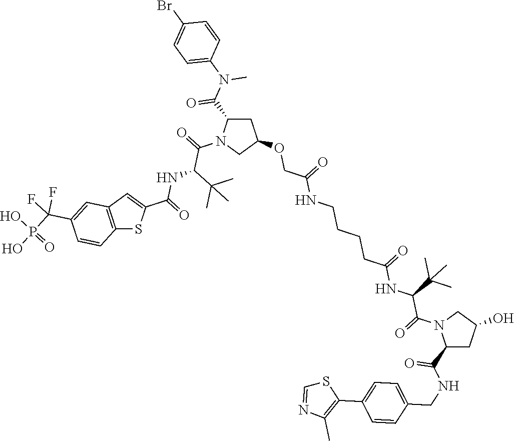 [SMILES: Cc1ncsc1-c1ccc(CNC(=O)[C@@H]2C[C@@H](O)CN2C(=O)[C@@H](NC(=O)CCCCNC(=O)CO[C@@H]2C[C@@H](C(=O)N(C)c3ccc(Br)cc3)N(C(=O)[C@@H](NC(=O)c3cc4cc(C(F)(F)P(=O)(O)O)ccc4s3)C(C)(C)C)C2)C(C)(C)C)cc1] | ((2-(((S)-1-((2S,4R)-2-((4-bromophenyl)(methyl)carbamoyl)-4- (2-((5-(((S)-1-((2S,4R)-4-hydroxy-2-((4-(4-methylthiazol-5- yl)benzyl)carbamoyl)pyrrolidin-1-yl)-3,3-dimethyl-1- oxobutan-2-yl)amino)-5-oxopentyl)amino)-2- oxoethoxy)pyrrolidin-1-yl)-3,3-dimethyl-1-oxobutan-2- yl)carbamoyl)benzo[b]thiophen-5- yl)difluoromethyl)phosphonic acid |
| 417 | 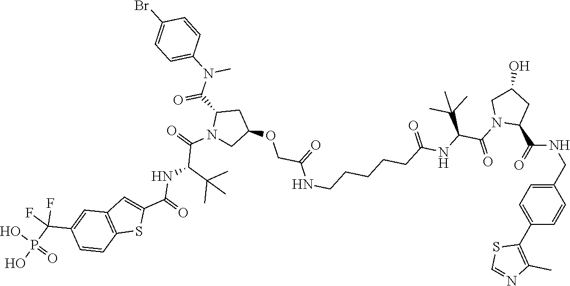 [SMILES: Cc1ncsc1-c1ccc(CNC(=O)[C@@H]2C[C@@H](O)CN2C(=O)[C@@H](NC(=O)CCCCCNC(=O)CO[C@@H]2C[C@@H](C(=O)N(C)c3ccc(Br)cc3)N(C(=O)[C@@H](NC(=O)c3cc4cc(C(F)(F)P(=O)(O)O)ccc4s3)C(C)(C)C)C2)C(C)(C)C)cc1] | ((2-(((S)-1-((2S,4R)-2-((4-bromophenyl)(methyl)carbamoyl)-4- (2-((6-(((S)-1-((2S,4R)-4-hydroxy-2-((4-(4-methylthiazol-5- yl)benzyl)carbamoyl)pyrrolidin-1-yl)-3,3-dimethyl-1- oxobutan-2-yl)amino)-6-oxohexyl)amino)-2- oxoethoxy)pyrrolidin-1-yl)-3,3-dimethyl-1-oxobutan-2- yl)carbamoyl)benzo[b]thiophen-5- yl)difluoromethyl)phosphonic acid |
| 418 | 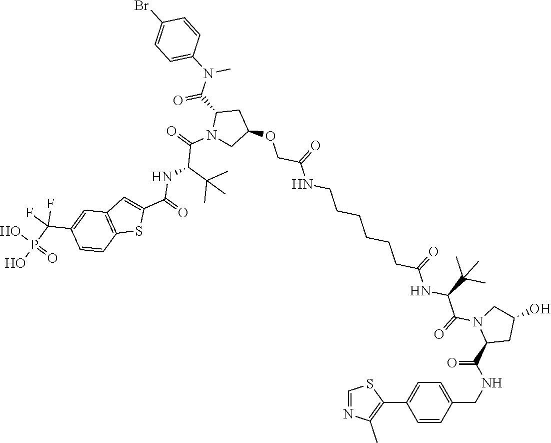 [SMILES: Cc1ncsc1-c1ccc(CNC(=O)[C@@H]2C[C@@H](O)CN2C(=O)[C@@H](NC(=O)CCCCCCNC(=O)CO[C@@H]2C[C@@H](C(=O)N(C)c3ccc(Br)cc3)N(C(=O)[C@@H](NC(=O)c3cc4cc(C(F)(F)P(=O)(O)O)ccc4s3)C(C)(C)C)C2)C(C)(C)C)cc1] | ((2-(((S)-1-((2S,4R)-2-((4-bromophenyl)(methyl)carbamoyl)-4- (2-((7-(((S)-1-((2S,4R)-4-hydroxy-2-((4-(4-methylthiazol-5- yl)benzyl)carbamoyl)pyrrolidin-1-yl)-3,3-dimethyl-1- oxobutan-2-yl)amino)-7-oxoheptyl)amino)-2- oxoethoxy)pyrrolidin-1-yl)-3,3-dimethyl-1-oxobutan-2- yl)carbamoyl)benzo[b]thiophen-5- yl)difluoromethyl)phosphonic acid |
| 419 | 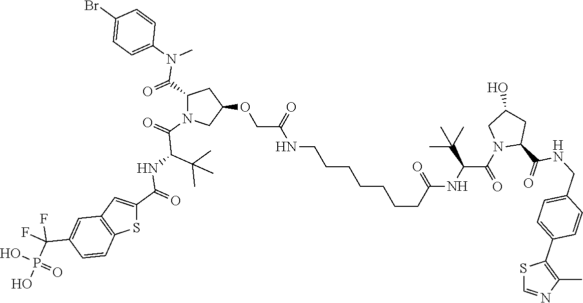 [SMILES: Cc1ncsc1-c1ccc(CNC(=O)[C@@H]2C[C@@H](O)CN2C(=O)[C@@H](NC(=O)CCCCCCCNC(=O)CO[C@@H]2C[C@@H](C(=O)N(C)c3ccc(Br)cc3)N(C(=O)[C@@H](NC(=O)c3cc4cc(C(F)(F)P(=O)(O)O)ccc4s3)C(C)(C)C)C2)C(C)(C)C)cc1] | ((2-(((S)-1-((2S,4R)-2-((4-bromophenyl)(methyl)carbamoyl)-4- (2-((8-(((S)-1-((2S,4R)-4-hydroxy-2-((4-(4-methylthiazol-5- yl)benzyl)carbamoyl)pyrrolidin-1-yl)-3,3-dimethyl-1- oxobutan-2-yl)amino)-8-oxooctyl)amino)-2- oxoethoxy)pyrrolidin-1-yl)-3,3-dimethyl-1-oxobutan-2- yl)carbamoyl)benzo[b]thiophen-5- yl)difluoromethyl)phosphonic acid |
| 420 | 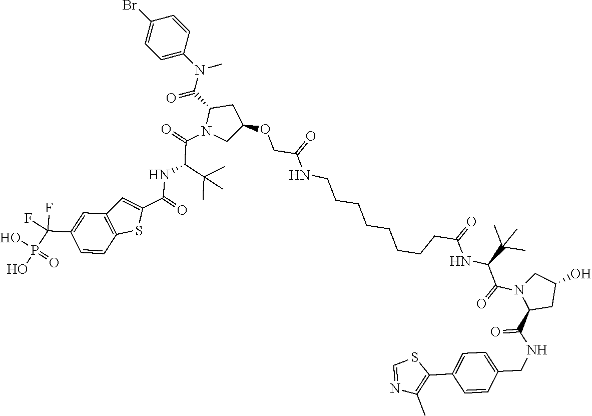 [SMILES: Cc1ncsc1-c1ccc(CNC(=O)[C@@H]2C[C@@H](O)CN2C(=O)[C@@H](NC(=O)CCCCCCCCNC(=O)CO[C@@H]2C[C@@H](C(=O)N(C)c3ccc(Br)cc3)N(C(=O)[C@@H](NC(=O)c3cc4cc(C(F)(F)P(=O)(O)O)ccc4s3)C(C)(C)C)C2)C(C)(C)C)cc1] | ((2-(((S)-1-((2S,4R)-2-((4-bromophenyl)(methyl)carbamoyl)-4- (2-((9-(((S)-1-((2S,4R)-4-hydroxy-2-((4-(4-methylthiazol-5- yl)benzyl)carbamoyl)pyrrolidin-1-yl)-3,3-dimethyl-1- oxobutan-2-yl)amino)-9-oxononyl)amino)-2- oxoethoxy)pyrrolidin-1-yl)-3,3-dimethyl-1-oxobutan-2- yl)carbamoyl)benzo[b]thiophen-5- yl)difluoromethyl)phosphonic acid |
| 421 | 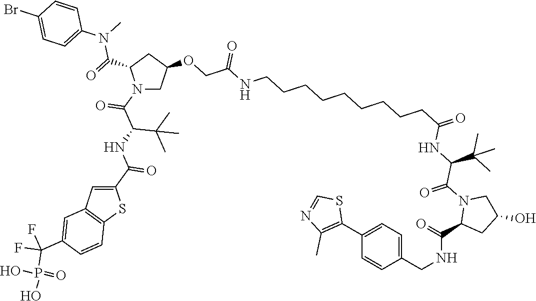 [SMILES: Cc1ncsc1-c1ccc(CNC(=O)[C@@H]2C[C@@H](O)CN2C(=O)[C@@H](NC(=O)CCCCCCCCCNC(=O)CO[C@@H]2C[C@@H](C(=O)N(C)c3ccc(Br)cc3)N(C(=O)[C@@H](NC(=O)c3cc4cc(C(F)(F)P(=O)(O)O)ccc4s3)C(C)(C)C)C2)C(C)(C)C)cc1] | ((2-(((S)-1-((2S,4R)-2-((4-bromophenyl)(methyl)carbamoyl)-4- (2-((10-(((S)-1-((2S,4R)-4-hydroxy-2-((4-(4-methylthiazol-5- yl)benzyl)carbamoyl)pyrrolidin-1-yl)-3,3-dimethyl-1- oxobutan-2-yl)amino)-10-oxodecyl)amino)-2- oxoethoxy)pyrrolidin-1-yl)-3,3-dimethyl-1-oxobutan-2- yl)carbamoyl)benzo[b]thiophen-5- yl)difluoromethyl)phosphonic acid |
| 422 | 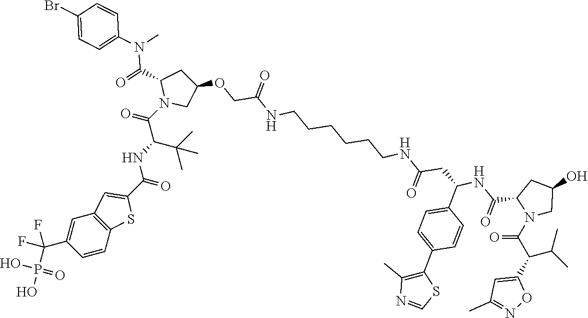 [SMILES: Cc1cc([C@H](C(=O)N2C[C@H](O)C[C@H]2C(=O)N[C@@H](CC(=O)NCCCCCCNC(=O)CO[C@@H]2C[C@@H](C(=O)N(C)c3ccc(Br)cc3)N(C(=O)[C@@H](NC(=O)c3cc4cc(C(F)(F)P(=O)(O)O)ccc4s3)C(C)(C)C)C2)c2ccc(-c3scnc3C)cc2)C(C)C)on1] | ((2-(((S)-1-((2S,4R)-2-((4-bromophenyl)(methyl)carbamoyl)-4- (2-((6-((S)-3-((2S,4R)-4-hydroxy-1-((R)-3-methyl-2-(3- methylisoxazol-5-yl)butanoyl)pyrrolidine-2-carboxamido)-3- (4-(4-methylthiazol-5-yl)phenyl)propanamido)hexyl)amino)-2- oxoethoxy)pyrrolidin-1-yl)-3,3-dimethyl-1-oxobutan-2- yl)carbamoyl)benzo[b]thiophen-5- yl)difluoromethyl)phosphonic acid |
| 423 | 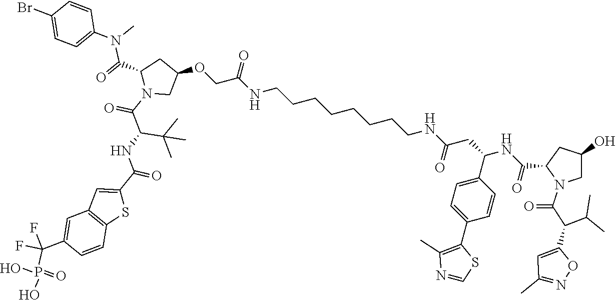 [SMILES: Cc1cc([C@H](C(=O)N2C[C@H](O)C[C@H]2C(=O)N[C@@H](CC(=O)NCCCCCCCCNC(=O)CO[C@@H]2C[C@@H](C(=O)N(C)c3ccc(Br)cc3)N(C(=O)[C@@H](NC(=O)c3cc4cc(C(F)(F)P(=O)(O)O)ccc4s3)C(C)(C)C)C2)c2ccc(-c3scnc3C)cc2)C(C)C)on1] | ((2-(((S)-1-((2S,4R)-2-((4-bromophenyl)(methyl)carbamoyl)-4- (2-((8-((S)-3-((2S,4R)-4-hydroxy-1-((R)-3-methyl-2-(3- methylisoxazol-5-yl)butanoyl)pyrrolidine-2-carboxamido)-3- (4-(4-methylthiazol-5-yl)phenyl)propanamido)octyl)amino)-2- oxoethoxy)pyrrolidin-1-yl)-3,3-dimethyl-1-oxobutan-2- yl)carbamoyl)benzo[b]thiophen-5- yl)difluoromethyl)phosphonic acid |
| 424 | 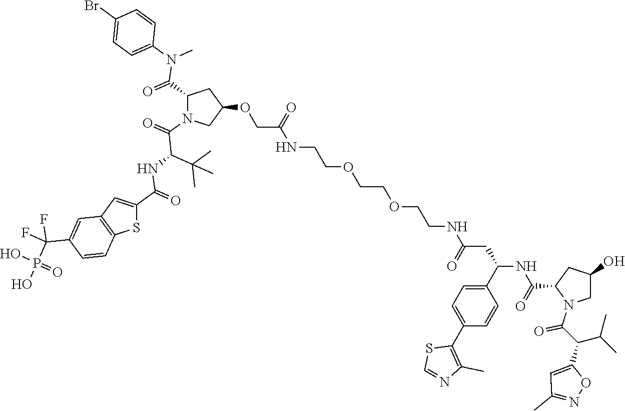 [SMILES: Cc1cc([C@H](C(=O)N2C[C@H](O)C[C@H]2C(=O)N[C@@H](CC(=O)NCCOCCOCCNC(=O)CO[C@@H]2C[C@@H](C(=O)N(C)c3ccc(Br)cc3)N(C(=O)[C@@H](NC(=O)c3cc4cc(C(F)(F)P(=O)(O)O)ccc4s3)C(C)(C)C)C2)c2ccc(-c3scnc3C)cc2)C(C)C)on1] | ((2-(((S)-1-((2S,4R)-2-((4-bromophenyl)(methyl)carbamoyl)-4- (((S)-1-((2S,4R)-4-hydroxy-1-((R)-3-methyl-2-(3- methylisoxazol-5-yl)butanoyl)pyrrolidin-2-yl)-3-(4-(4- methylthiazol-5-yl)phenyl)-1,5,16-trioxo-9,12-dioxa-2,6,15- triazaheptadecan-17-yl)oxy)pyrrolidin-1-yl)-3,3-dimethyl-1- oxobutan-2-yl)carbamoyl)benzo[b]thiophen-5- yl)difluoromethyl)phosphonic acid |
| 425 | 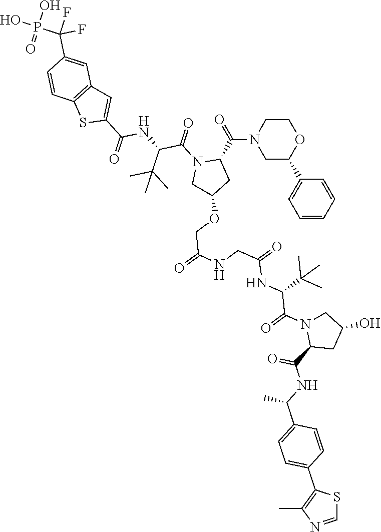 [SMILES: Cc1ncsc1-c1ccc([C@H](C)NC(=O)[C@@H]2C[C@@H](O)CN2C(=O)[C@H](NC(=O)CNC(=O)CO[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((2-(((R)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-2-oxoethyl)amino)-2-oxoethoxy)-2-((R)- 2-phenylmorpholine-4-carbonyl)pyrrolidin-1-yl)-3,3-dimethyl- 1-oxobutan-2-yl)carbamoyl)benzo[b]thiophen-5- yl)methyl)phosphonic acid |
| 426 | 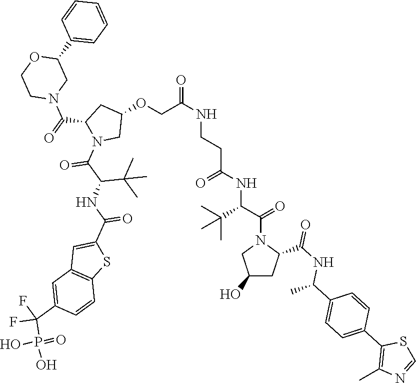 | (difluoro(2-(((S)-1-((2S,4S)-4-(2-((3-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-3-oxopropyl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)methyl)phosphonic acid |
| 427 | 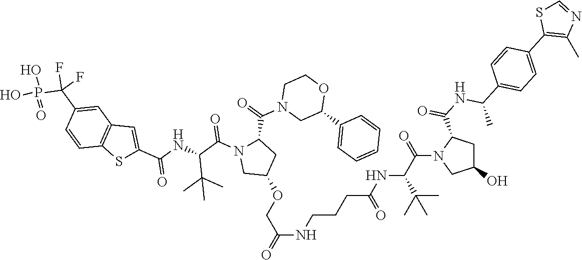 | (difluoro(2-(((S)-1-((2S,4S)-4-(2-((4-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-4-oxobutyl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)methyl)phosphonic acid |
| 428 | 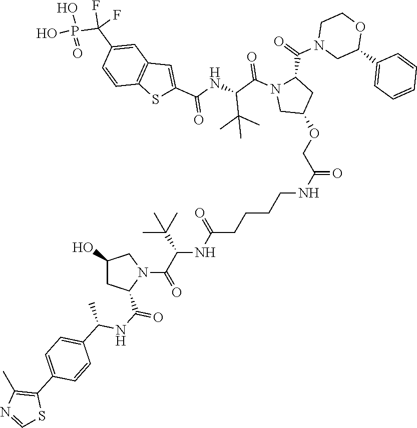 [SMILES: Cc1ncsc1-c1ccc([C@H](C)NC(=O)[C@@H]2C[C@@H](O)CN2C(=O)[C@@H](NC(=O)CCCCNC(=O)CO[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((5-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-5-oxopentyl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)methyl)phosphonic acid |
| 429 | 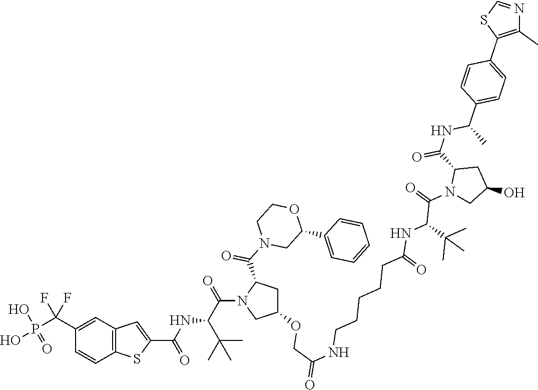 | (difluoro(2-(((S)-1-((2S,4S)-4-(2-((6-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-6-oxohexyl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)methyl)phosphonic acid |
| 430 | 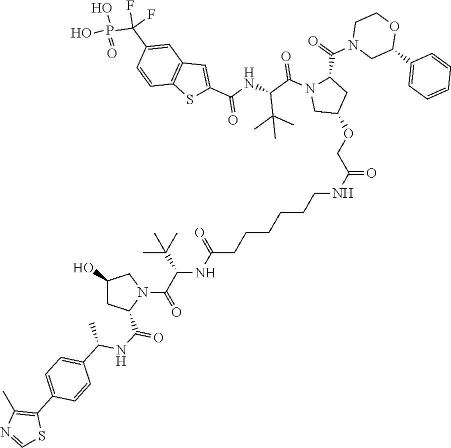 [SMILES: Cc1ncsc1-c1ccc([C@H](C)NC(=O)[C@@H]2C[C@@H](O)CN2C(=O)[C@@H](NC(=O)CCCCCCNC(=O)CO[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((7-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-7-oxoheptyl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)methyl)phosphonic acid |
| 431 | 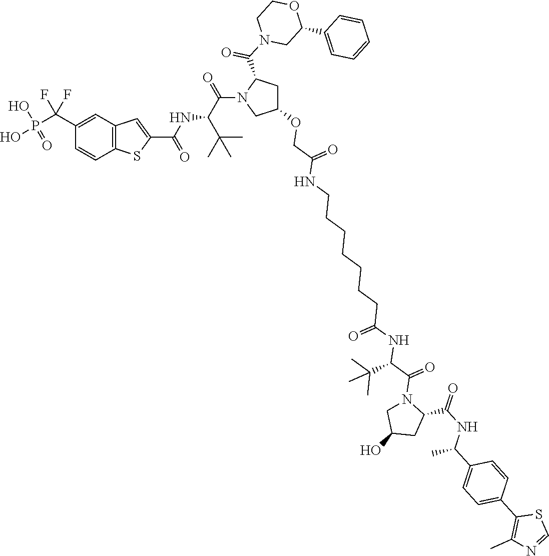 [SMILES: Cc1ncsc1-c1ccc([C@H](C)NC(=O)[C@@H]2C[C@@H](O)CN2C(=O)[C@@H](NC(=O)CCCCCCCNC(=O)CO[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((8-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-8-oxooctyl)amino)-2-oxoethoxy)-2-((R)- 2-phenylmorpholine-4-carbonyl)pyrrolidin-1-yl)-3,3-dimethyl- 1-oxobutan-2-yl)carbamoyl)benzo[b]thiophen-5- yl)methyl)phosphonic acid |
| 432 | 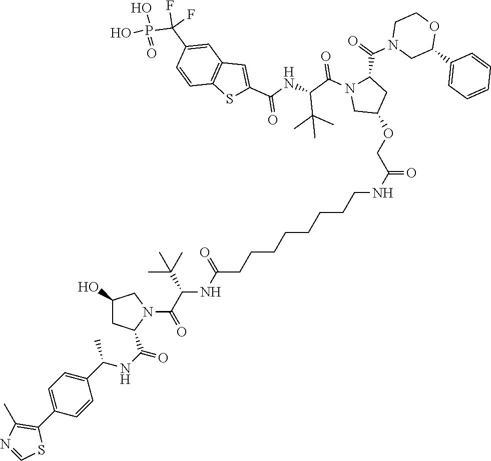 [SMILES: Cc1ncsc1-c1ccc([C@H](C)NC(=O)[C@@H]2C[C@@H](O)CN2C(=O)[C@@H](NC(=O)CCCCCCCCNC(=O)CO[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((9-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-9-oxononyl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)methyl)phosphonic acid |
| 433 | 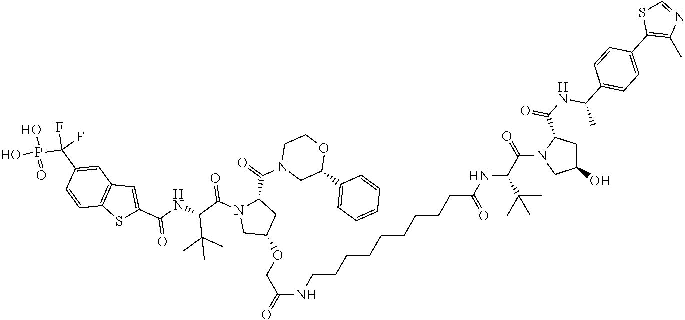 [SMILES: Cc1ncsc1-c1ccc([C@H](C)NC(=O)[C@@H]2C[C@@H](O)CN2C(=O)[C@@H](NC(=O)CCCCCCCCCNC(=O)CO[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((10-(((S)-1-((2S,4R)-4- hydroxy-2-(((S)-1-(4-(4-methylthiazol-5- yl)phenyl)ethyl)carbamoyl)pyrrolidin-1 -yl)-3,3-dimethyl-1- oxobutan-2-yl)amino)-10-oxodecyl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)methyl)phosphonic acid |
| 434 | 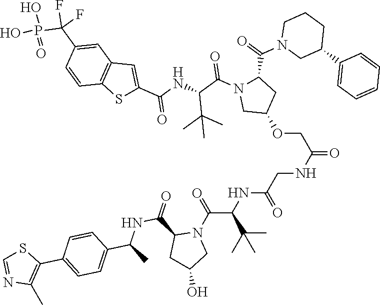 | (difluoro(2-(((S)-1-((2S,4S)-4-(2-((2-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-2-oxoethyl)amino)-2-oxoethoxy)-2-((R)- 3-phenylpiperidine-1-carbonyl)pyrrolidin-1-yl)-3,3-dimethyl-1- oxobutan-2-yl)carbamoyl)benzo[b]thiophen-5- yl)methyl)phosphonic acid |
| 435 | 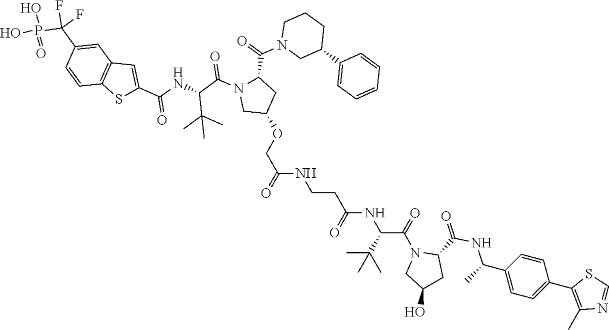 [SMILES: Cc1ncsc1-c1ccc([C@H](C)NC(=O)[C@@H]2C[C@@H](O)CN2C(=O)[C@@H](NC(=O)CCNC(=O)CO[C@H]2C[C@@H](C(=O)N3CCC[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((3-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-3-oxopropyl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)methyl)phosphonic acid |
| 436 | 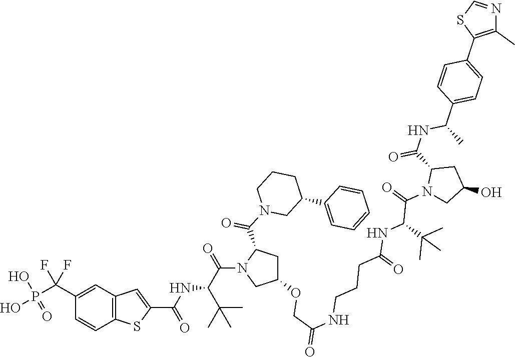 | (difluoro(2-(((S)-1-((2S,4S)-4-(2-((4-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-4-oxobutyl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)methyl)phosphonic acid |
| 437 | 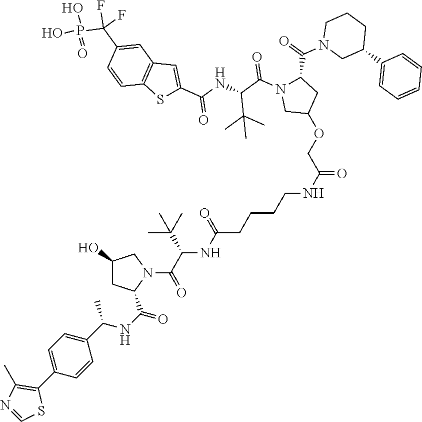 [SMILES: Cc1ncsc1-c1ccc([C@H](C)NC(=O)[C@@H]2C[C@@H](O)CN2C(=O)[C@@H](NC(=O)CCCCNC(=O)COC2C[C@@H](C(=O)N3CCC[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((5-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-5-oxopentyl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)methyl)phosphonic acid |
| 438 | 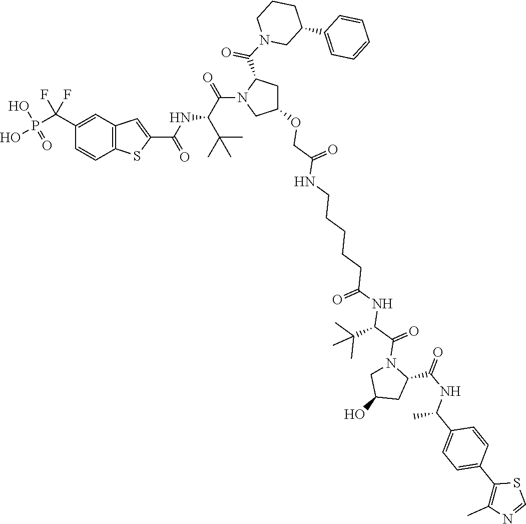 | (difluoro(2-(((S)-1-((2S,4S)-4-(2-((6-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-6-oxohexyl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)methyl)phosphonic acid |
| 439 | 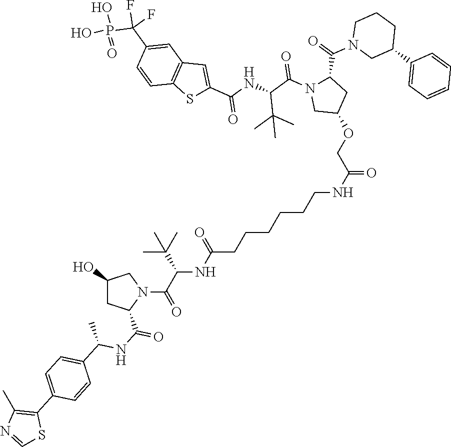 [SMILES: Cc1ncsc1-c1ccc([C@H](C)NC(=O)[C@@H]2C[C@@H](O)CN2C(=O)[C@@H](NC(=O)CCCCCCNC(=O)CO[C@H]2C[C@@H](C(=O)N3CCC[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((7-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-7-oxoheptyl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)methyl)phosphonic acid |
| 440 | 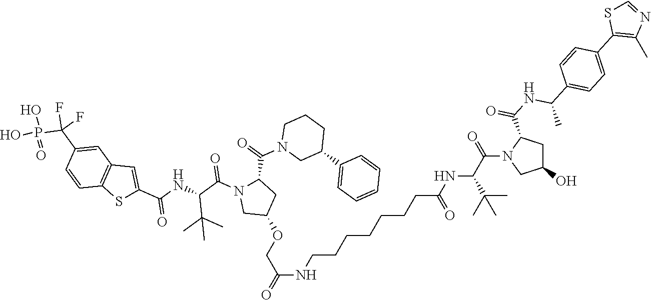 [SMILES: Cc1ncsc1-c1ccc([C@H](C)NC(=O)[C@@H]2C[C@@H](O)CN2C(=O)[C@@H](NC(=O)CCCCCCCNC(=O)CO[C@H]2C[C@@H](C(=O)N3CCC[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((8-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-8-oxooctyl)amino)-2-oxoethoxy)-2-((R)- 3-phenylpiperidine-1-carbonyl)pyrrolidin-1-yl)-3,3-dimethyl-1- oxobutan-2-yl)carbamoyl)benzo[b]thiophen-5- yl)methyl)phosphonic acid |
| 441 | 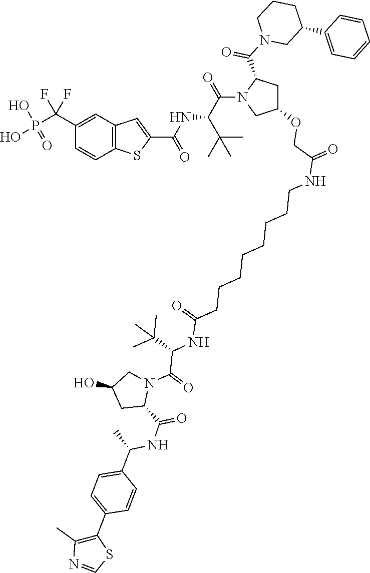 [SMILES: Cc1ncsc1-c1ccc([C@H](C)NC(=O)[C@@H]2C[C@@H](O)CN2C(=O)[C@@H](NC(=O)CCCCCCCCNC(=O)CO[C@H]2C[C@@H](C(=O)N3CCC[C@H](c4ccccc4)C3)N(C(=O)[C@@H](NC(=O)c3cc4cc(C(F)(F)P(=O)(O)O)ccc4s3)C(C)(C)C)C2)C(C)(C)C)cc1] | (difluoro(2-(((S)-1-((2S,4S)-4-(2-((9-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-9-oxononyl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)methyl)phosphonic acid |
| 442 | 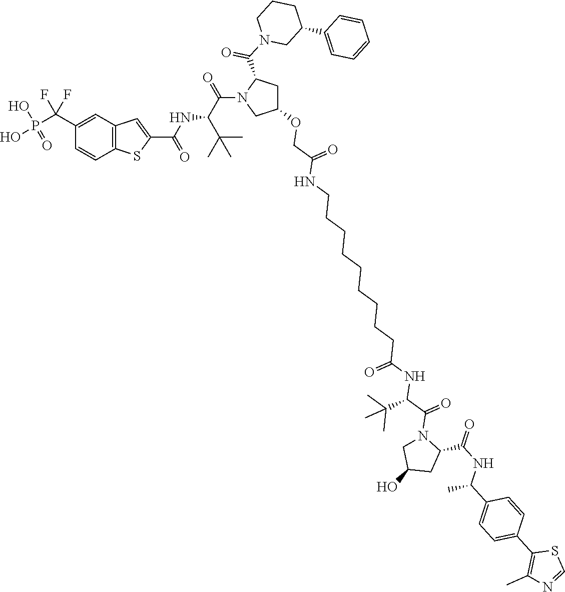 | (difluoro(2-(((S)-1-((2S,4S)-4-(2-((10-(((S)-1-((2S,4R)-4- hydroxy-2-(((S)-1-(4-(4-methylthiazol-5- yl)phenyl)ethyl)carbamoyl)pyrrolidin-1-yl)-3,3-dimethyl-1- oxobutan-2-yl)amino)-10-oxodecyl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)methyl)phosphonic acid |
| 443 | 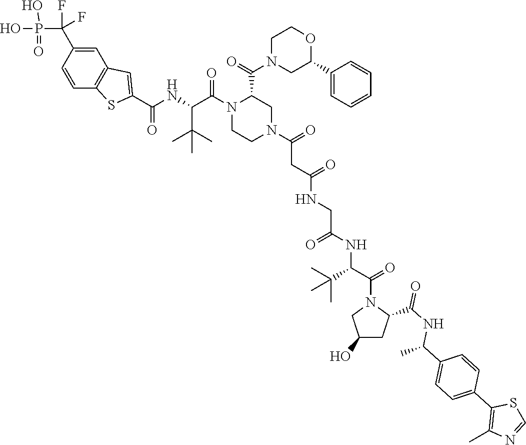 [SMILES: Cc1ncsc1-c1ccc([C@H](C)NC(=O)[C@@H]2C[C@@H](O)CN2C(=O)[C@@H](NC(=O)CNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCO[C@H](c4ccccc4)C3)C2)C(C)(C)C)cc1] | (difluoro(2-(((S)-1-((S)-4-(3-((2-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-2-oxoethyl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)methyl)phosphonic acid |
| 444 | 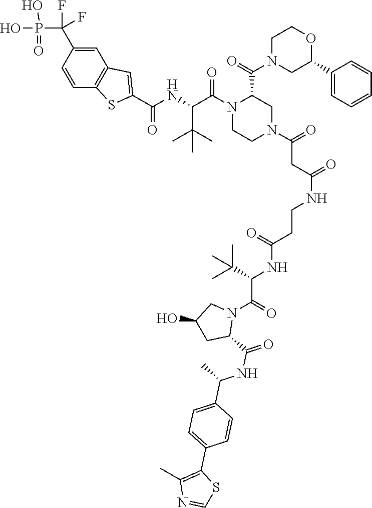 [SMILES: Cc1ncsc1-c1ccc([C@H](C)NC(=O)[C@@H]2C[C@@H](O)CN2C(=O)[C@@H](NC(=O)CCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCO[C@H](c4ccccc4)C3)C2)C(C)(C)C)cc1] | (difluoro(2-(((S)-1-((S)-4-(3-((3-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-3-oxopropyl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)methyl)phosphonic acid |
| 445 | 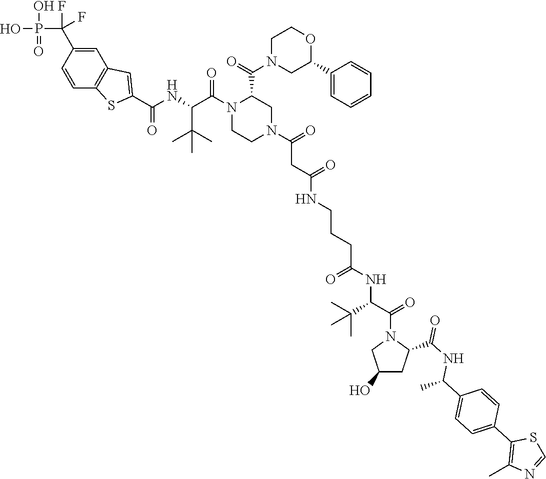 [SMILES: Cc1ncsc1-c1ccc([C@H](C)NC(=O)[C@@H]2C[C@@H](O)CN2C(=O)[C@@H](NC(=O)CCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCO[C@H](c4ccccc4)C3)C2)C(C)(C)C)cc1] | (difluoro(2-(((S)-1-((S)-4-(3-((4-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-4-oxobutyl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)methyl)phosphonic acid |
| 446 | 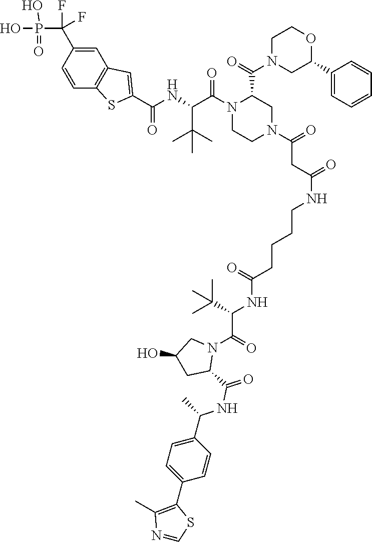 [SMILES: Cc1ncsc1-c1ccc([C@H](C)NC(=O)[C@@H]2C[C@@H](O)CN2C(=O)[C@@H](NC(=O)CCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCO[C@H](c4ccccc4)C3)C2)C(C)(C)C)cc1] | (difluoro(2-(((S)-1-((S)-4-(3-((5-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-5-oxopentyl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)methyl)phosphonic acid |
| 447 | 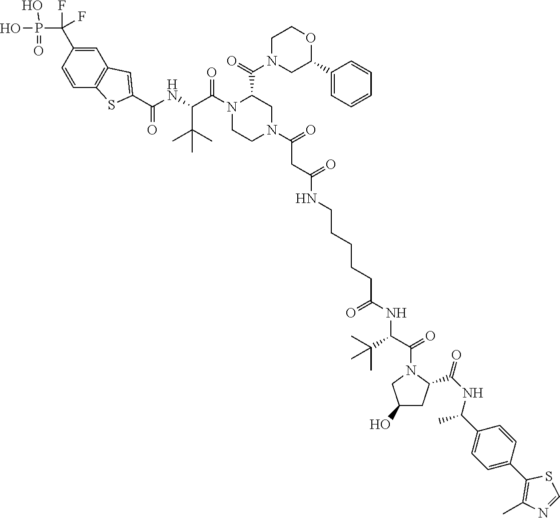 [SMILES: Cc1ncsc1-c1ccc([C@H](C)NC(=O)[C@@H]2C[C@@H](O)CN2C(=O)[C@@H](NC(=O)CCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCO[C@H](c4ccccc4)C3)C2)C(C)(C)C)cc1] | (difluoro(2-(((S)-1-((S)-4-(3-((6-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-6-oxohexyl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)methyl)phosphonic acid |
| 448 | 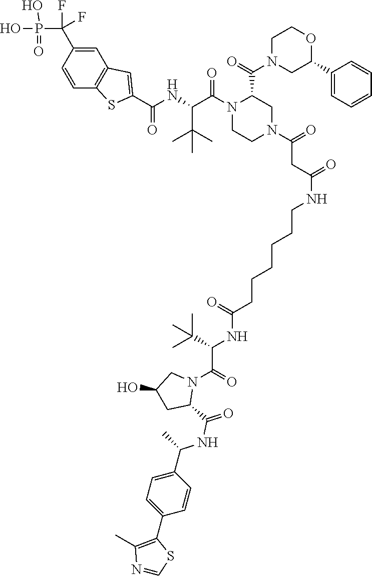 [SMILES: Cc1ncsc1-c1ccc([C@H](C)NC(=O)[C@@H]2C[C@@H](O)CN2C(=O)[C@@H](NC(=O)CCCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCO[C@H](c4ccccc4)C3)C2)C(C)(C)C)cc1] | (difluoro(2-(((S)-1-((S)-4-(3-((7-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-7-oxoheptyl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)methyl)phosphonic acid |
| 449 | 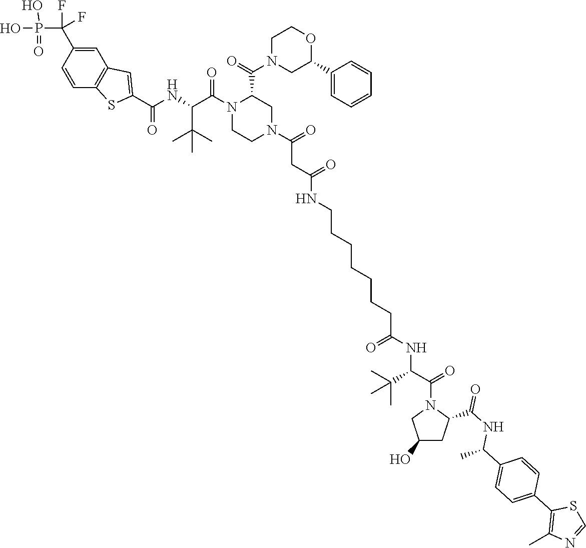 [SMILES: Cc1ncsc1-c1ccc([C@H](C)NC(=O)[C@@H]2C[C@@H](O)CN2C(=O)[C@@H](NC(=O)CCCCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCO[C@H](c4ccccc4)C3)C2)C(C)(C)C)cc1] | (difluoro(2-(((S)-1-((S)-4-(3-((8-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-8-oxooctyl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)methyl)phosphonic acid |
| 450 | 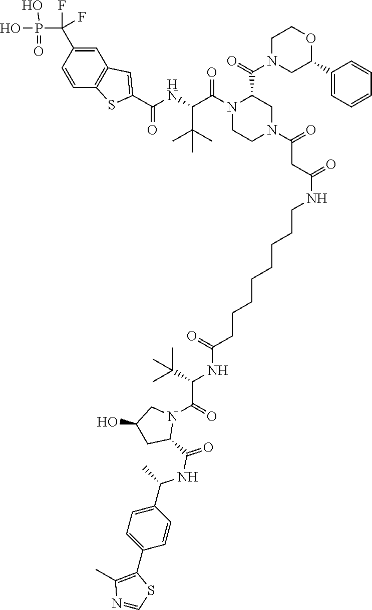 [SMILES: Cc1ncsc1-c1ccc([C@H](C)NC(=O)[C@@H]2C[C@@H](O)CN2C(=O)[C@@H](NC(=O)CCCCCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCO[C@H](c4ccccc4)C3)C2)C(C)(C)C)cc1] | (difluoro(2-(((S)-1-((S)-4-(3-((9-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-9-oxononyl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)methyl)phosphonic acid |
| 451 | 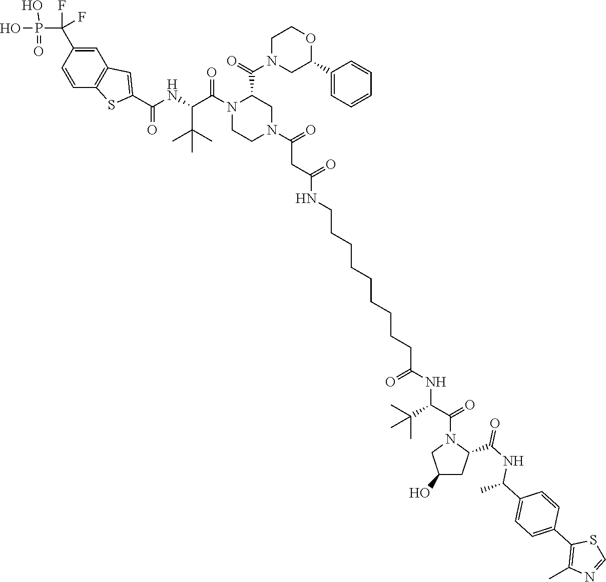 [SMILES: Cc1ncsc1-c1ccc([C@H](C)NC(=O)[C@@H]2C[C@@H](O)CN2C(=O)[C@@H](NC(=O)CCCCCCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCO[C@H](c4ccccc4)C3)C2)C(C)(C)C)cc1] | (difluoro(2-(((S)-1-((S)-4-(3-((10-(((S)-1-((2S,4R)-4-hydroxy- 2-(((S)-1-(4-(4-methylthiazol-5- yl)phenyl)ethyl)carbamoyl)pyrrolidin-1-yl)-3,3-dimethyl-1- oxobutan-2-yl)amino)-10-oxodecyl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)methyl)phosphonic acid |
| 452 | 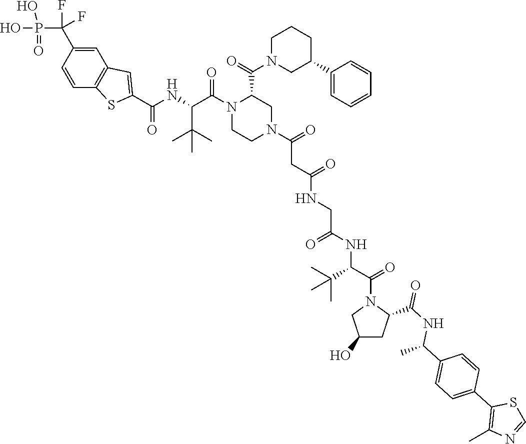 [SMILES: Cc1ncsc1-c1ccc([C@H](C)NC(=O)[C@@H]2C[C@@H](O)CN2C(=O)[C@@H](NC(=O)CNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCC[C@H](c4ccccc4)C3)C2)C(C)(C)C)cc1] | (difluoro(2-(((S)-1-((S)-4-(3-((2-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-2-oxoethyl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)methyl)phosphonic acid |
| 453 | 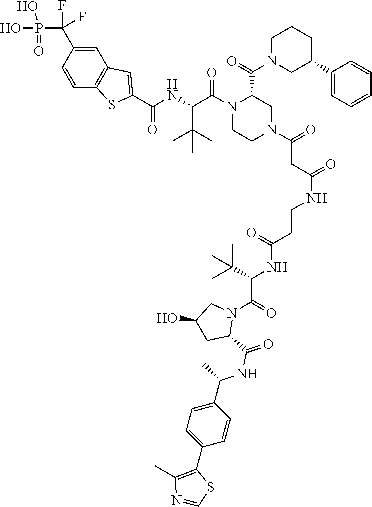 [SMILES: Cc1ncsc1-c1ccc([C@H](C)NC(=O)[C@@H]2C[C@@H](O)CN2C(=O)[C@@H](NC(=O)CCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCC[C@H](c4ccccc4)C3)C2)C(C)(C)C)cc1] | (difluoro(2-(((S)-1-((S)-4-(3-((3-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-3-oxopropyl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)methyl)phosphonic acid |
| 454 | 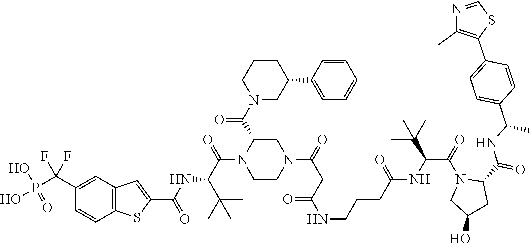 [SMILES: Cc1ncsc1-c1ccc([C@H](C)NC(=O)[C@@H]2C[C@@H](O)CN2C(=O)[C@@H](NC(=O)CCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCC[C@H](c4ccccc4)C3)C2)C(C)(C)C)cc1] | (difluoro(2-(((S)-1-((S)-4-(3-((4-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-4-oxobutyl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)methyl)phosphonic acid |
| 455 | 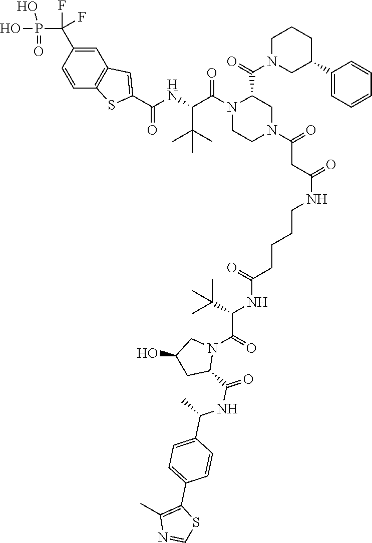 [SMILES: Cc1ncsc1-c1ccc([C@H](C)NC(=O)[C@@H]2C[C@@H](O)CN2C(=O)[C@@H](NC(=O)CCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCC[C@H](c4ccccc4)C3)C2)C(C)(C)C)cc1] | (difluoro(2-(((S)-1-((S)-4-(3-((5-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-5-oxopentyl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)methyl)phosphonic acid |
| 456 | 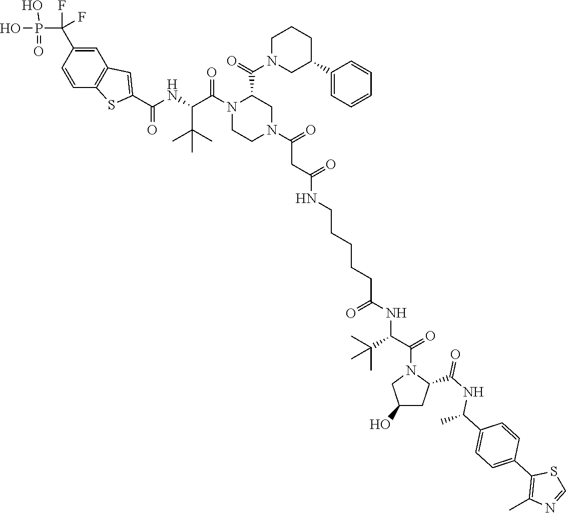 [SMILES: Cc1ncsc1-c1ccc([C@H](C)NC(=O)[C@@H]2C[C@@H](O)CN2C(=O)[C@@H](NC(=O)CCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCC[C@H](c4ccccc4)C3)C2)C(C)(C)C)cc1] | (difluoro(2-(((S)-1-((S)-4-(3-((6-(((S)-1-((2,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-6-oxohexyl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)methyl)phosphonic acid |
| 457 | 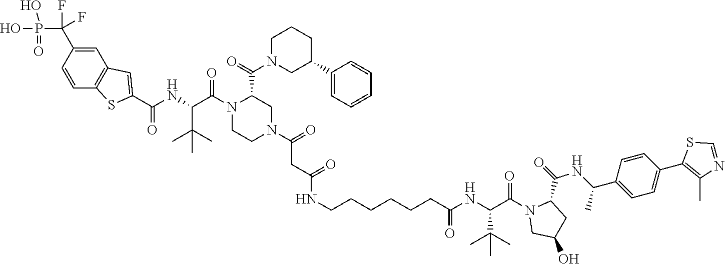 [SMILES: Cc1ncsc1-c1ccc([C@H](C)NC(=O)[C@@H]2C[C@@H](O)CN2C(=O)[C@@H](NC(=O)CCCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCC[C@H](c4ccccc4)C3)C2)C(C)(C)C)cc1] | (difluoro(2-(((S)-1-((S)-4-(3-((7-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-7-oxoheptyl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)methyl)phosphonic acid |
| 458 | 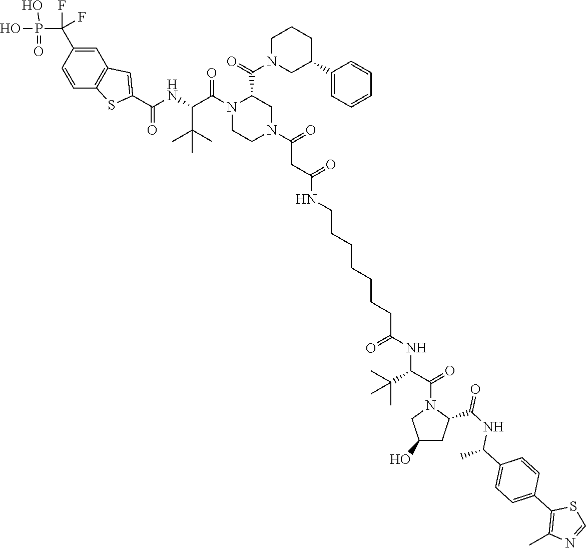 [SMILES: Cc1ncsc1-c1ccc([C@H](C)NC(=O)[C@@H]2C[C@@H](O)CN2C(=O)[C@@H](NC(=O)CCCCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCC[C@H](c4ccccc4)C3)C2)C(C)(C)C)cc1] | (difluoro(2-(((S)-1-((S)-4-(3-((8-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-8-oxooctyl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)methyl)phosphonic acid |
| 459 | 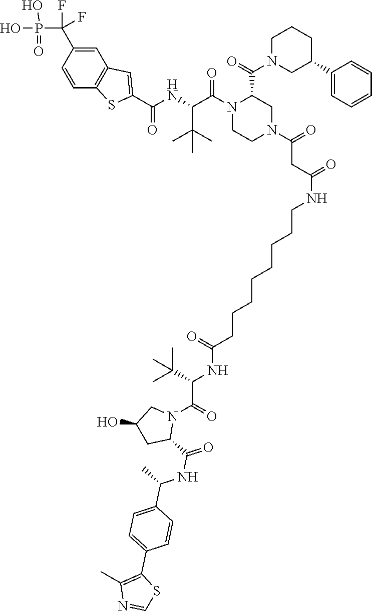 [SMILES: Cc1ncsc1-c1ccc([C@H](C)NC(=O)[C@@H]2C[C@@H](O)CN2C(=O)[C@@H](NC(=O)CCCCCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCC[C@H](c4ccccc4)C3)C2)C(C)(C)C)cc1] | (difluoro(2-(((S)-1-((S)-4-(3-((9-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-9-oxononyl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)methyl)phosphonic acid |
| 460 | 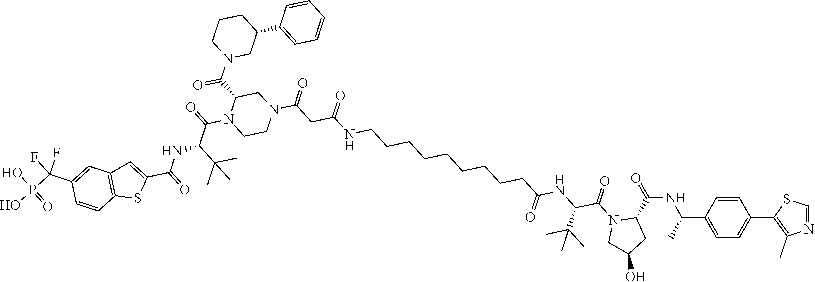 [SMILES: Cc1ncsc1-c1ccc([C@H](C)NC(=O)[C@@H]2C[C@@H](O)CN2C(=O)[C@@H](NC(=O)CCCCCCCCCNC(=O)CC(=O)N2CCN(C(=O)[C@@H](NC(=O)c3cc4cc(C(F)(F)P(=O)(O)O)ccc4s3)C(C)(C)C)[C@H](C(=O)N3CCC[C@H](c4ccccc4)C3)C2)C(C)(C)C)cc1] | (difluoro(2-(((S)-1-((S)-4-(3-((10-(((S)-1-((2S,4R)-4-hydroxy- 2-(((S)-1-(4-(4-methylthiazol-5- yl)phenyl)ethyl)carbamoyl)pyrrolidin-1-yl)-3,3-dimethyl-1- oxobutan-2-yl)amino)-10-oxodecyl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)methyl)phosphonic acid |
| 461 | 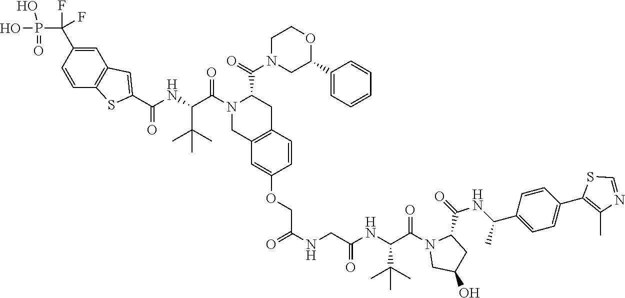 [SMILES: Cc1ncsc1-c1ccc([C@H](C)NC(=O)[C@@H]2C[C@@H](O)CN2C(=O)[C@@H](NC(=O)CNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCO[C@H](c4ccccc4)C2)C3)C(C)(C)C)cc1] | (difluoro(2-(((S)-1-((S)-7-(2-((2-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-2-oxoethyl)amino)-2-oxoethoxy)-3-((R)- 2-phenylmorpholine-4-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 462 | 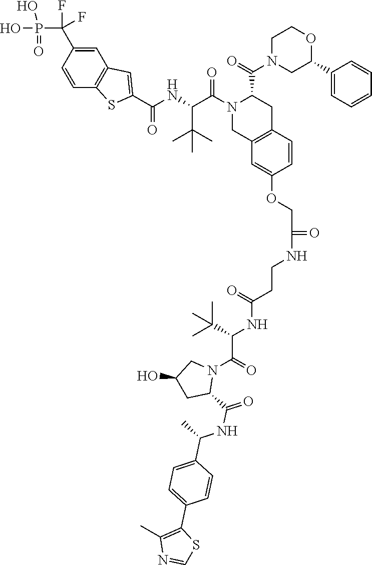 [SMILES: Cc1ncsc1-c1ccc([C@H](C)NC(=O)[C@@H]2C[C@@H](O)CN2C(=O)[C@@H](NC(=O)CCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCO[C@H](c4ccccc4)C2)C3)C(C)(C)C)cc1] | (difluoro(2-(((S)-1-((S)-7-(2-((3-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-3-oxopropyl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 463 | 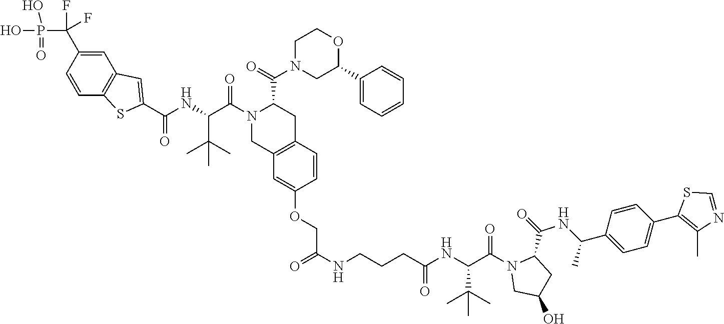 [SMILES: Cc1ncsc1-c1ccc([C@H](C)NC(=O)[C@@H]2C[C@@H](O)CN2C(=O)[C@@H](NC(=O)CCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCO[C@H](c4ccccc4)C2)C3)C(C)(C)C)cc1] | (difluoro(2-(((S)-1-((S)-7-(2-((4-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-4-oxobutyl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 464 | 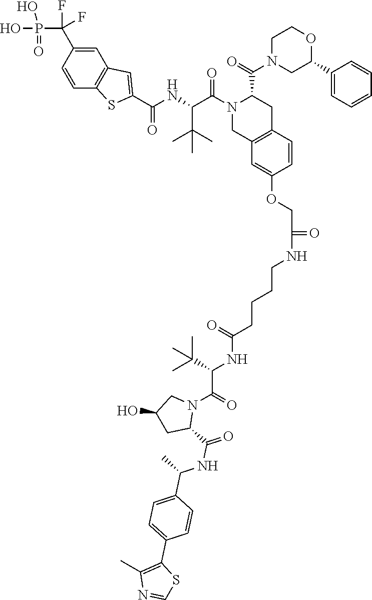 [SMILES: Cc1ncsc1-c1ccc([C@H](C)NC(=O)[C@@H]2C[C@@H](O)CN2C(=O)[C@@H](NC(=O)CCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCO[C@H](c4ccccc4)C2)C3)C(C)(C)C)cc1] | (difluoro(2-(((S)-1-((S)-7-(2-((5-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-5-oxopentyl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 465 | 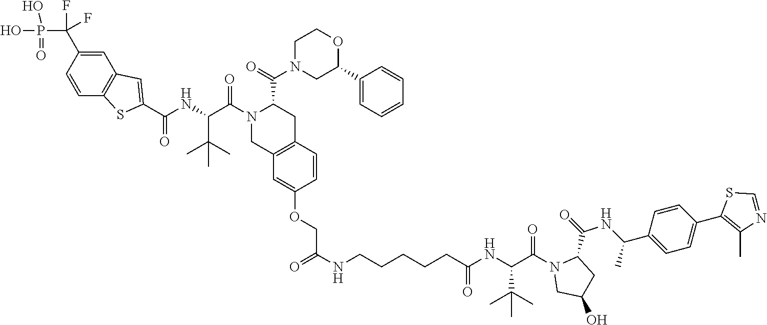 [SMILES: Cc1ncsc1-c1ccc([C@H](C)NC(=O)[C@@H]2C[C@@H](O)CN2C(=O)[C@@H](NC(=O)CCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCO[C@H](c4ccccc4)C2)C3)C(C)(C)C)cc1] | (difluoro(2-(((S)-1-((S)-7-(2-((6-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-6-oxohexyl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 466 | 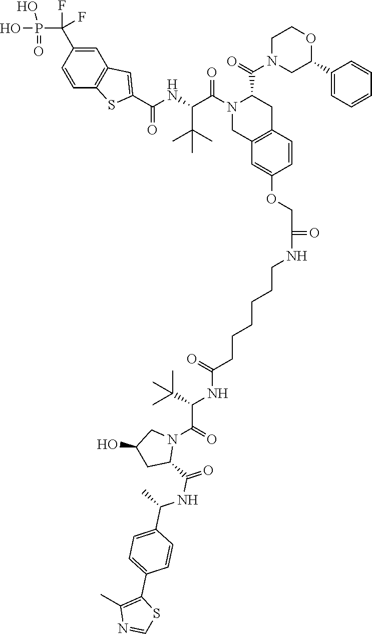 [SMILES: Cc1ncsc1-c1ccc([C@H](C)NC(=O)[C@@H]2C[C@@H](O)CN2C(=O)[C@@H](NC(=O)CCCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCO[C@H](c4ccccc4)C2)C3)C(C)(C)C)cc1] | (difluoro(2-(((S)-1-((S)-7-(2-((7-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-7-oxoheptyl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 467 | 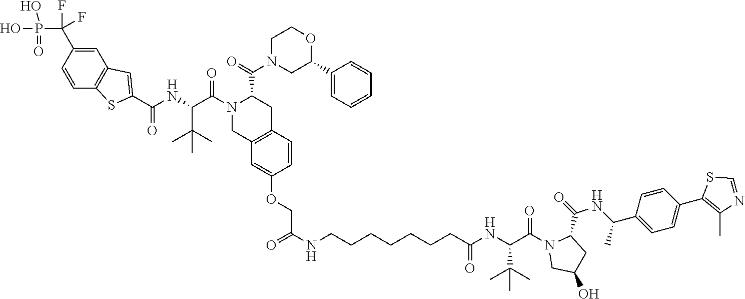 [SMILES: Cc1ncsc1-c1ccc([C@H](C)NC(=O)[C@@H]2C[C@@H](O)CN2C(=O)[C@@H](NC(=O)CCCCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCO[C@H](c4ccccc4)C2)C3)C(C)(C)C)cc1] | (difluoro(2-(((S)-1-((S)-7-(2-((8-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-8-oxooctyl)amino)-2-oxoethoxy)-3-((R)- 2-phenylmorpholine-4-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 468 | 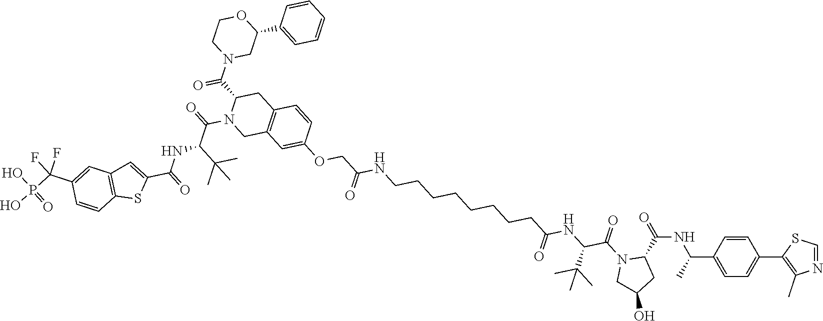 [SMILES: Cc1ncsc1-c1ccc([C@H](C)NC(=O)[C@@H]2C[C@@H](O)CN2C(=O)[C@@H](NC(=O)CCCCCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCO[C@H](c4ccccc4)C2)C3)C(C)(C)C)cc1] | (difluoro(2-(((S)-1-((S)-7-(2-((9-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-9-oxononyl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 469 | 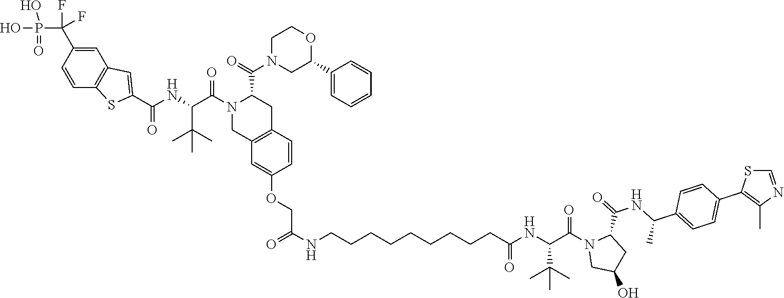 [SMILES: Cc1ncsc1-c1ccc([C@H](C)NC(=O)[C@@H]2C[C@@H](O)CN2C(=O)[C@@H](NC(=O)CCCCCCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCO[C@H](c4ccccc4)C2)C3)C(C)(C)C)cc1] | (difluoro(2-(((S)-1-((S)-7-(2-((10-(((S)-1-((2S,4R)-4-hydroxy- 2-(((S)-1-(4-(4-methylthiazol-5- yl)phenyl)ethyl)carbamoyl)pyrrolidin-1-yl)-3,3-dimethyl-1- oxobutan-2-yl)amino)-10-oxodecyl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 470 | 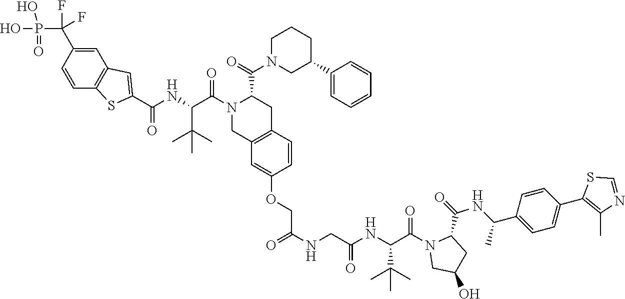 [SMILES: Cc1ncsc1-c1ccc([C@H](C)NC(=O)[C@@H]2C[C@@H](O)CN2C(=O)[C@@H](NC(=O)CNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCC[C@H](c4ccccc4)C2)C3)C(C)(C)C)cc1] | (difluoro(2-(((S)-1-((S)-7-(2-((2-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-2-oxoethyl)amino)-2-oxoethoxy)-3-((R)- 3-phenylpiperidine-1-carbonyl)-3,4-dihydroisoquinolin-2(1H)- yl)-3,3-dimethyl-1-oxobutan-2- yl)carbamoyl)benzo[b]thiophen-5-yl)methyl)phosphonic acid |
| 471 | 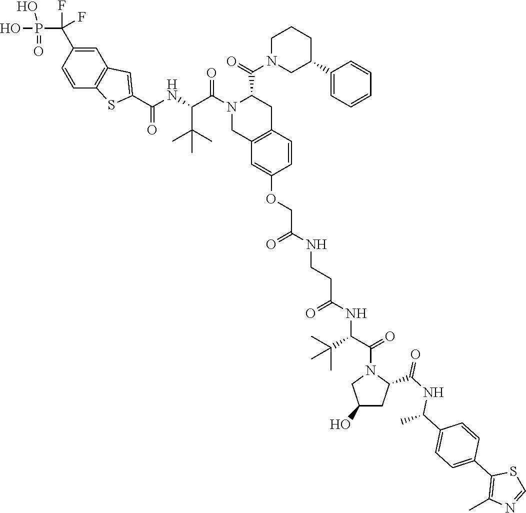 [SMILES: Cc1ncsc1-c1ccc([C@H](C)NC(=O)[C@@H]2C[C@@H](O)CN2C(=O)[C@@H](NC(=O)CCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCC[C@H](c4ccccc4)C2)C3)C(C)(C)C)cc1] | (difluoro(2-(((S)-1-((S)-7-(2-((3-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-3-oxopropyl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 472 | 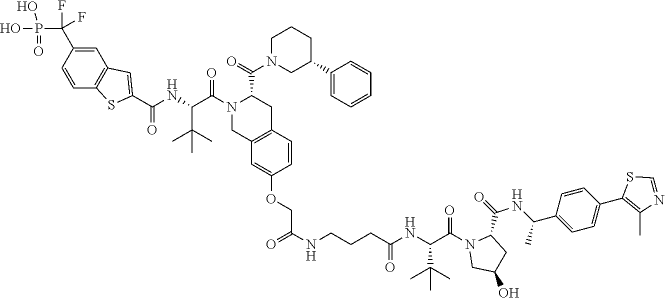 [SMILES: Cc1ncsc1-c1ccc([C@H](C)NC(=O)[C@@H]2C[C@@H](O)CN2C(=O)[C@@H](NC(=O)CCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCC[C@H](c4ccccc4)C2)C3)C(C)(C)C)cc1] | (difluoro(2-(((S)-1-((S)-7-(2-((4-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-4-oxobutyl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 473 | 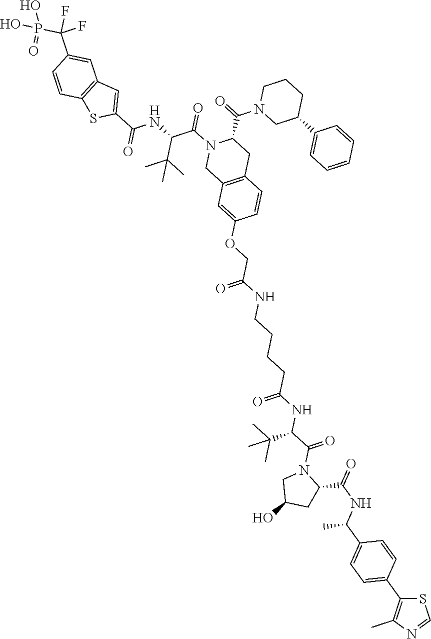 [SMILES: Cc1ncsc1-c1ccc([C@H](C)NC(=O)[C@@H]2C[C@@H](O)CN2C(=O)[C@@H](NC(=O)CCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCC[C@H](c4ccccc4)C2)C3)C(C)(C)C)cc1] | (difluoro(2-(((S)-1-((S)-7-(2-((5-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-5-oxopentyl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 474 | 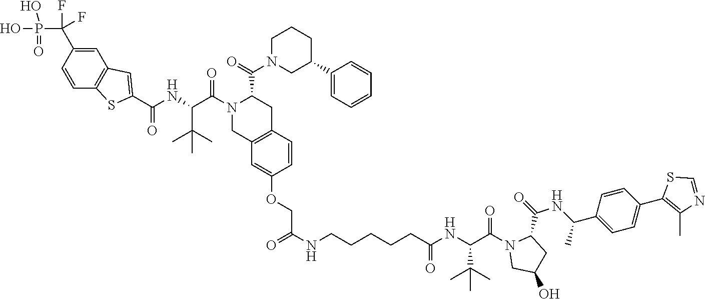 [SMILES: Cc1ncsc1-c1ccc([C@H](C)NC(=O)[C@@H]2C[C@@H](O)CN2C(=O)[C@@H](NC(=O)CCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCC[C@H](c4ccccc4)C2)C3)C(C)(C)C)cc1] | (difluoro(2-(((S)-1-((S)-7-(2-((6-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-6-oxohexyl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 475 | 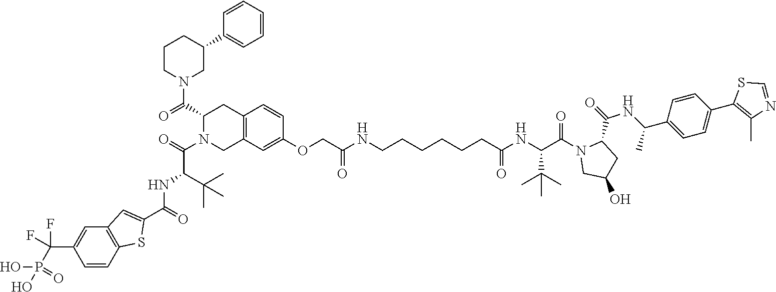 [SMILES: Cc1ncsc1-c1ccc([C@H](C)NC(=O)[C@@H]2C[C@@H](O)CN2C(=O)[C@@H](NC(=O)CCCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCC[C@H](c4ccccc4)C2)C3)C(C)(C)C)cc1] | (difluoro(2-(((S)-1-((S)-7-(2-((7-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-7-oxoheptyl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 476 | 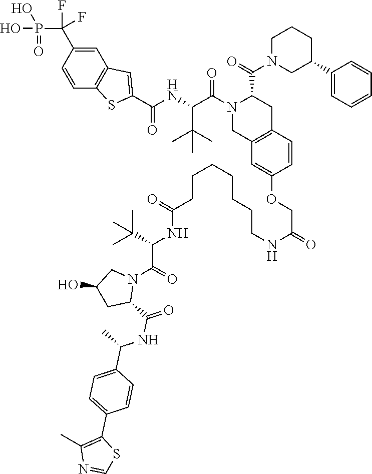 [SMILES: Cc1ncsc1-c1ccc([C@H](C)NC(=O)[C@@H]2C[C@@H](O)CN2C(=O)[C@@H](NC(=O)CCCCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCC[C@H](c4ccccc4)C2)C3)C(C)(C)C)cc1] | (difluoro(2-(((S)-1-((S)-7-(2-((8-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-8-oxooctyl)amino)-2-oxoethoxy)-3-((R)- 3-phenylpiperidine-1-carbonyl)-3,4-dihydroisoquinolin-2(1H)- yl)-3,3-dimethyl-1-oxobutan-2- yl)carbamoyl)benzo[b]thiophen-5-yl)methyl)phosphonic acid |
| 477 | 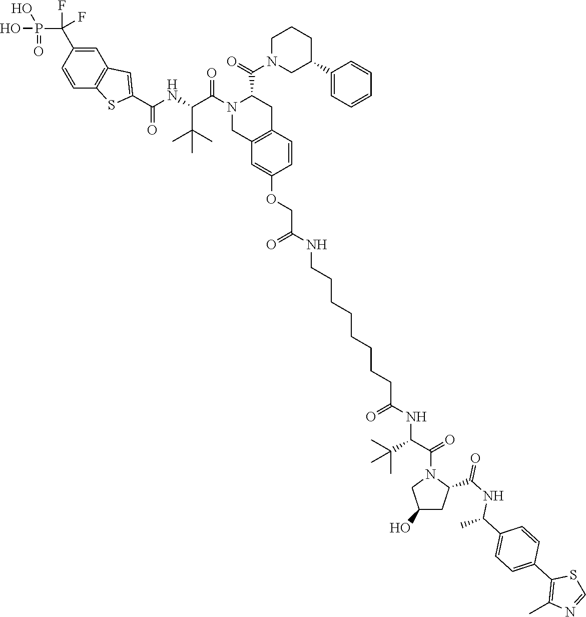 [SMILES: Cc1ncsc1-c1ccc([C@H](C)NC(=O)[C@@H]2C[C@@H](O)CN2C(=O)[C@@H](NC(=O)CCCCCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCC[C@H](c4ccccc4)C2)C3)C(C)(C)C)cc1] | (difluoro(2-(((S)-1-((S)-7-(2-((9-(((S)-1-((2S,4R)-4-hydroxy-2- (((S)-1-(4-(4-methylthiazol-5- yl)phenyl)ethyl)carbamoyl)pyrrolidin-1-yl)-3,3-dimethyl-1- oxobutan-2-yl)amino)-9-oxononyl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 478 | 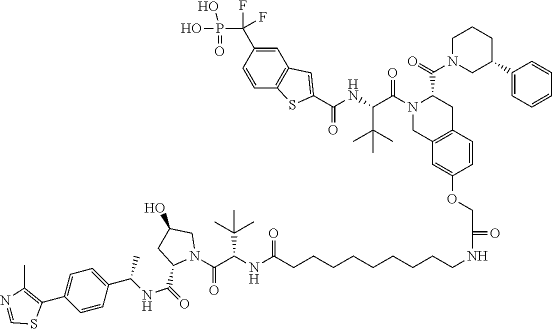 [SMILES: Cc1ncsc1-c1ccc([C@H](C)NC(=O)[C@@H]2C[C@@H](O)CN2C(=O)[C@@H](NC(=O)CCCCCCCCCNC(=O)COc2ccc3c(c2)CN(C(=O)[C@@H](NC(=O)c2cc4cc(C(F)(F)P(=O)(O)O)ccc4s2)C(C)(C)C)[C@H](C(=O)N2CCC[C@H](c4ccccc4)C2)C3)C(C)(C)C)cc1] | (difluoro(2-(((S)-1-((S)-7-(2-((10-(((S)-1-((2S,4R)-4-hydroxy- 2-(((S)-1-(4-(4-methylthiazol-5- yl)phenyl)ethyl)carbamoyl)pyrrolidin-1-yl)-3,3-dimethyl-1- oxobutan-2-yl)amino)-10-oxodecyl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5-yl)methyl)phosphonic acid |
| 479 | 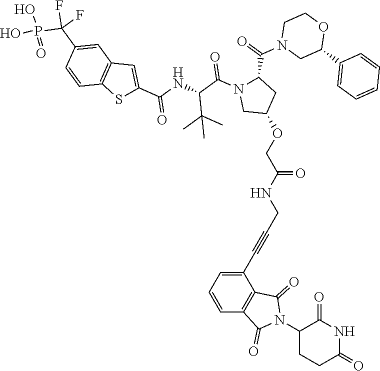 [SMILES: CC(C)(C)[C@H](NC(=O)c1cc2cc(C(F)(F)P(=O)(O)O)ccc2s1)C(=O)N1C[C@@H](OCC(=O)NCC#Cc2cccc3c2C(=O)N(C2CCC(=O)NC2=O)C3=O)C[C@H]1C(=O)N1CCO[C@H](c2ccccc2)C1] | ((2-(((2S)-1-((2S,4S)-4-(2-((3-(2-(2,6-dioxopiperidin-3-yl)-1,3- dioxoisoindolin-4-yl)prop-2-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 480 | 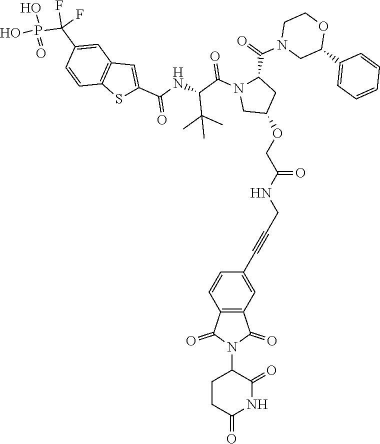 [SMILES: CC(C)(C)[C@H](NC(=O)c1cc2cc(C(F)(F)P(=O)(O)O)ccc2s1)C(=O)N1C[C@@H](OCC(=O)NCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S,4S)-4-(2-((3-(2-(2,6-dioxopiperidin-3-yl)-1,3- dioxoisoindolin-5-yl)prop-2-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 481 | 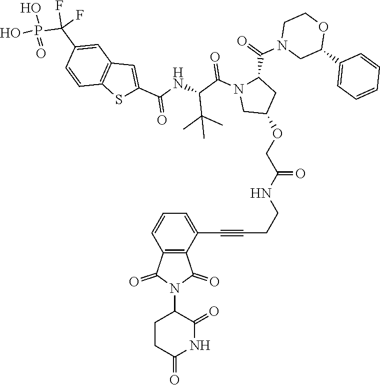 [SMILES: CC(C)(C)[C@H](NC(=O)c1cc2cc(C(F)(F)P(=O)(O)O)ccc2s1)C(=O)N1C[C@@H](OCC(=O)NCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S,4S)-4-(2-((4-(2-(2,6-dioxopiperidin-3-yl)-1,3- dioxoisoindolin-4-yl)but-3-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 482 | 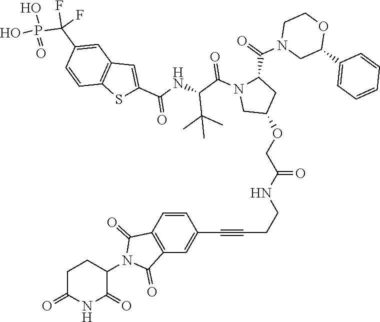 [SMILES: CC(C)(C)[C@H](NC(=O)c1cc2cc(C(F)(F)P(=O)(O)O)ccc2s1)C(=O)N1C[C@@H](OCC(=O)NCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S,4S)-4-(2-((4-(2-(2,6-dioxopiperidin-3-yl)-1,3- dioxoisoindolin-5-yl)but-3-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 483 | 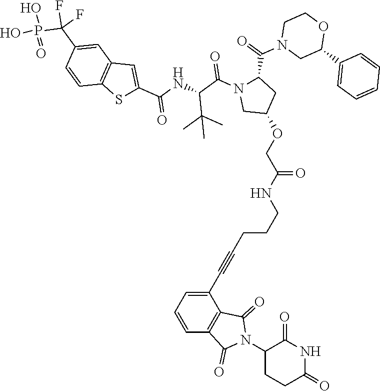 [SMILES: CC(C)(C)[C@H](NC(=O)c1cc2cc(C(F)(F)P(=O)(O)O)ccc2s1)C(=O)N1C[C@@H](OCC(=O)NCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S,4S)-4-(2-((5-(2-(2,6-dioxopiperidin-3-yl)-1,3- dioxoisoindolin-4-yl)pent-4-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 484 | 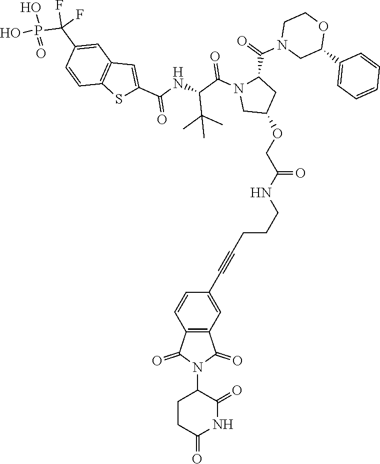 [SMILES: CC(C)(C)[C@H](NC(=O)c1cc2cc(C(F)(F)P(=O)(O)O)ccc2s1)C(=O)N1C[C@@H](OCC(=O)NCCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S,4S)-4-(2-((5-(2-(2,6-dioxopiperidin-3-yl)-1,3- dioxoisoindolin-5-yl)pent-4-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 485 | 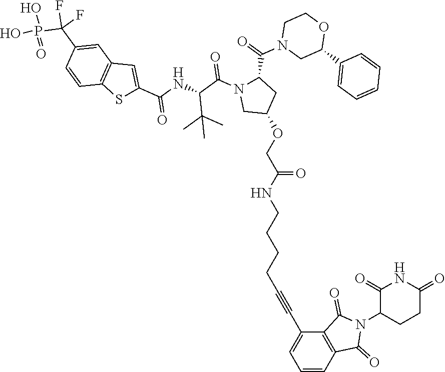 [SMILES: CC(C)(C)[C@H](NC(=O)c1cc2cc(C(F)(F)P(=O)(O)O)ccc2s1)C(=O)N1C[C@@H](OCC(=O)NCCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S,4S)-4-(2-((6-(2-(2,6-dioxopiperidin-3-yl)-1,3- dioxoisoindolin-4-yl)hex-5-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 486 | 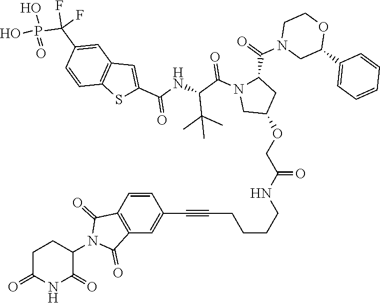 [SMILES: CC(C)(C)[C@H](NC(=O)c1cc2cc(C(F)(F)P(=O)(O)O)ccc2s1)C(=O)N1C[C@@H](OCC(=O)NCCCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S,4S)-4-(2-((6-(2-(2,6-dioxopiperidin-3-yl)-1,3- dioxoisoindolin-5-yl)hex-5-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 487 | 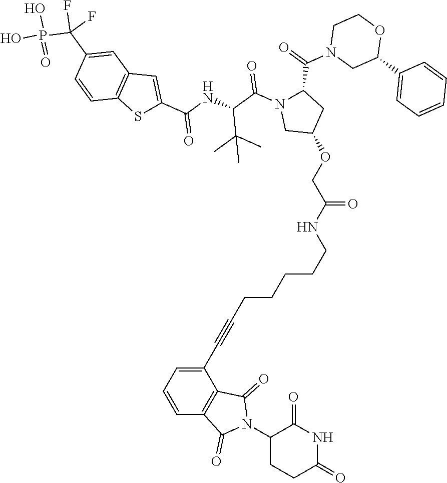 [SMILES: CC(C)(C)[C@H](NC(=O)c1cc2cc(C(F)(F)P(=O)(O)O)ccc2s1)C(=O)N1C[C@@H](OCC(=O)NCCCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S,4S)-4-(2-((7-(2-(2,6-dioxopiperidin-3-yl)-1,3- dioxoisoindolin-4-yl)hept-6-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 488 | 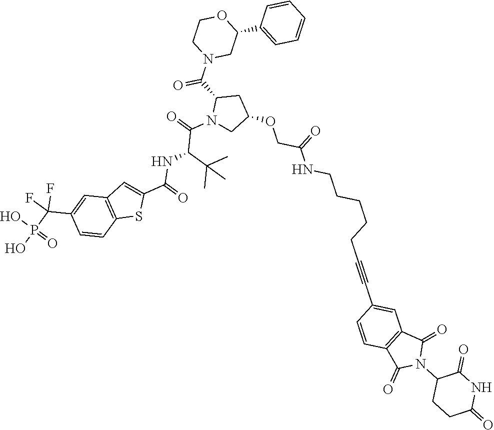 [SMILES: CC(C)(C)[C@H](NC(=O)c1cc2cc(C(F)(F)P(=O)(O)O)ccc2s1)C(=O)N1C[C@@H](OCC(=O)NCCCCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S,4S)-4-(2-((7-(2-(2,6-dioxopiperidin-3-yl)-1,3- dioxoisoindolin-5-yl)hept-6-yn-1-yl)amino)-2-oxoethoxy)-2- ((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 489 | 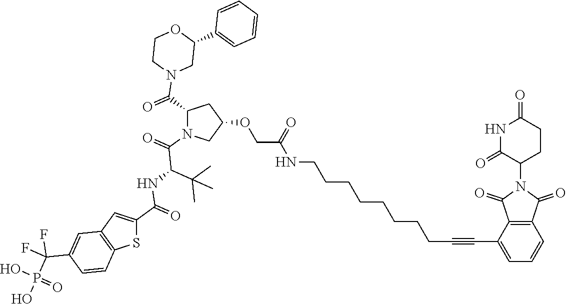 [SMILES: CC(C)(C)[C@H](NC(=O)c1cc2cc(C(F)(F)P(=O)(O)O)ccc2s1)C(=O)N1C[C@@H](OCC(=O)NCCCCCCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S,4S)-4-(2-((10-(2-(2,6-dioxopiperidin-3-yl)- 1,3-dioxoisoindolin-4-yl)dec-9-yn-1-yl)amino)-2-oxoethoxy)- 2-((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 490 | 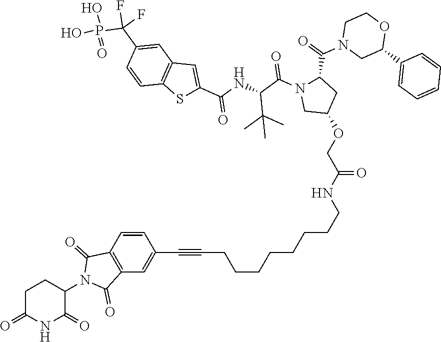 [SMILES: CC(C)(C)[C@H](NC(=O)c1cc2cc(C(F)(F)P(=O)(O)O)ccc2s1)C(=O)N1C[C@@H](OCC(=O)NCCCCCCCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S,4S)-4-(2-((10-(2-(2,6-dioxopiperidin-3-yl)- 1,3-dioxoisoindolin-5-yl)dec-9-yn-1-yl)amino)-2-oxoethoxy)- 2-((R)-2-phenylmorpholine-4-carbonyl)pyrrolidin-1-yl)-3,3- dimethyl-1-oxobutan-2-yl)carbamoyl)benzo[b]thiophen-5- yl)difluoromethyl)phosphonic acid |
| 491 | 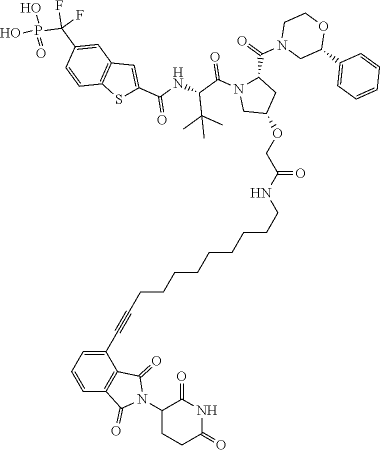 [SMILES: CC(C)(C)[C@H](NC(=O)c1cc2cc(C(F)(F)P(=O)(O)O)ccc2s1)C(=O)N1C[C@@H](OCC(=O)NCCCCCCCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S,4S)-4-(2-((11-(2-(2,6-dioxopiperidin-3-yl)- 1,3-dioxoisoindolin-4-yl)undec-10-yn-1-yl)amino)-2- oxoethoxy)-2-((R)-2-phenylmorpholine-4-carbonyl)pyrrolidin- 1-yl)-3,3-dimethyl-1-oxobutan-2- yl)carbamoyl)benzo[b]thiophen-5- yl)difluoromethyl)phosphonic acid |
| 492 | 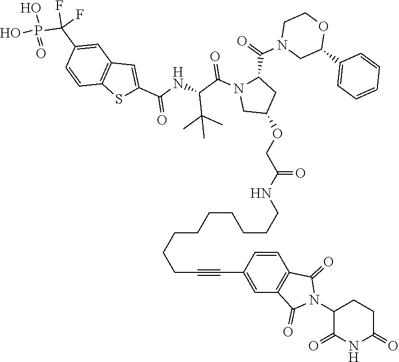 [SMILES: CC(C)(C)[C@H](NC(=O)c1cc2cc(C(F)(F)P(=O)(O)O)ccc2s1)C(=O)N1C[C@@H](OCC(=O)NCCCCCCCCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S,4S)-4-(2-((11-(2-(2,6-dioxopiperidin-3-yl)- 1,3-dioxoisoindolin-5-yl)undec-10-yn-1-yl)amino)-2- oxoethoxy)-2-((R)-2-phenylmorpholine-4-carbonyl)pyrrolidin- 1-yl)-3,3-dimethyl-1-oxobutan-2- yl)carbamoyl)benzo[b]thiophen-5- yl)difluoromethyl)phosphonic acid |
| 493 | 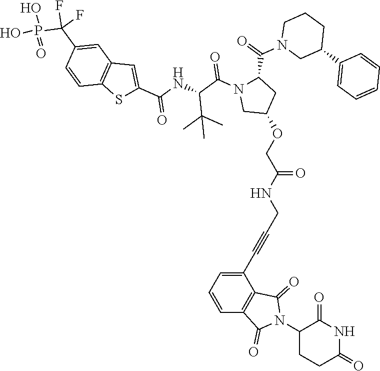 [SMILES: CC(C)(C)[C@H](NC(=O)c1cc2cc(C(F)(F)P(=O)(O)O)ccc2s1)C(=O)N1C[C@@H](OCC(=O)NCC#Cc2cccc3c2C(=O)N(C2CCC(=O)NC2=O)C3=O)C[C@H]1C(=O)N1CCC[C@H](c2ccccc2)C1] | ((2-(((2S)-1-((2S,4S)-4-(2-((3-(2-(2,6-dioxopiperidin-3-yl)-1,3- dioxoisoindolin-4-yl)prop-2-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 494 | 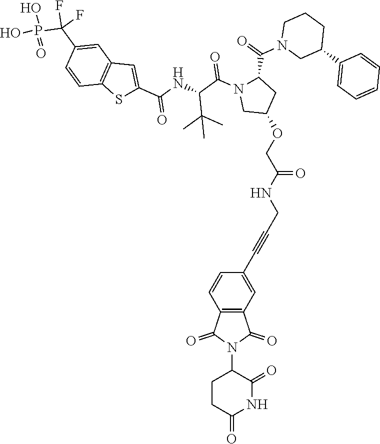 | ((2-(((2S)-1-((2S,4S)-4-(2-((3-(2-(2,6-dioxopiperidin-3-yl)-1,3- dioxoisoindolin-5-yl)prop-2-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 495 | 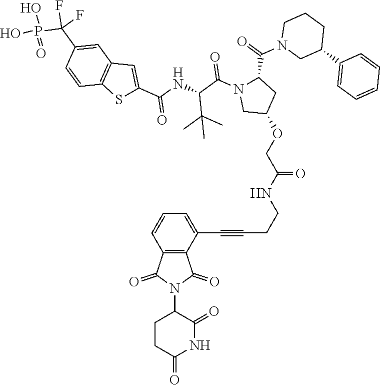 [SMILES: CC(C)(C)[C@H](NC(=O)c1cc2cc(C(F)(F)P(=O)(O)O)ccc2s1)C(=O)N1C[C@@H](OCC(=O)NCCC#Cc2cccc3c2C(=O)N(C2CCC(=O)NC2=O)C3=O)C[C@H]1C(=O)N1CCC[C@H](c2ccccc2)C1] | ((2-(((2S)-1-((2S,4S)-4-(2-((4-(2-(2,6-dioxopiperidin-3-yl)-1,3- dioxoisoindolin-4-yl)but-3-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 496 | 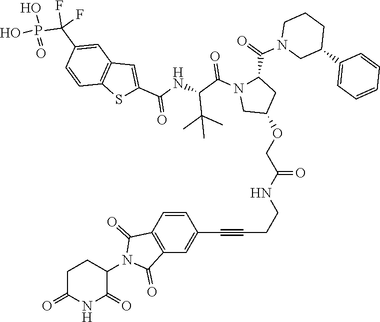 [SMILES: CC(C)(C)[C@H](NC(=O)c1cc2cc(C(F)(F)P(=O)(O)O)ccc2s1)C(=O)N1C[C@@H](OCC(=O)NCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S,4S)-4-(2-((4-(2-(2,6-dioxopiperidin-3-yl)-1,3- dioxoisoindolin-5-yl)but-3-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 497 | 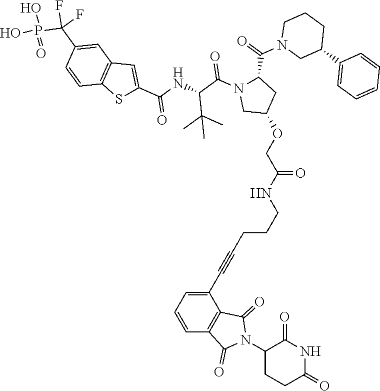 | ((2-(((2S)-1-((2S,4S)-4-(2-((5-(2-(2,6-dioxopiperidin-3-yl)-1,3- dioxoisoindolin-4-yl)pent-4-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 498 | 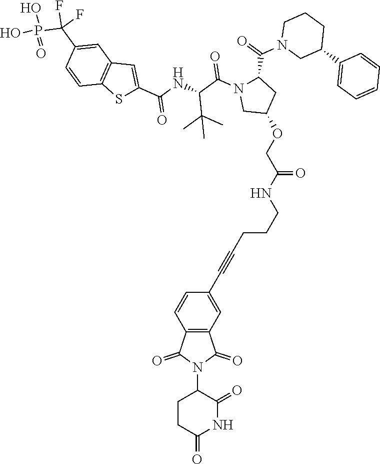 [SMILES: CC(C)(C)[C@H](NC(=O)c1cc2cc(C(F)(F)P(=O)(O)O)ccc2s1)C(=O)N1C[C@@H](OCC(=O)NCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S,4S)-4-(2-((5-(2-(2,6-dioxopiperidin-3-yl)-1,3- dioxoisoindolin-5-yl)pent-4-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 499 | 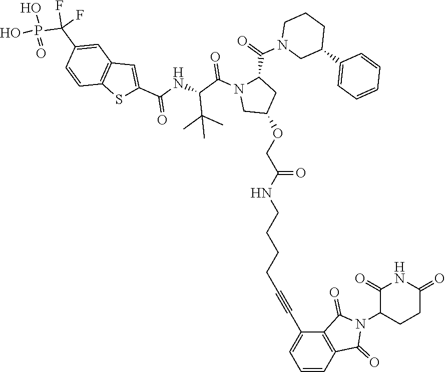 | ((2-(((2S)-1-((2S,4S)-4-(2-((6-(2-(2,6-dioxopiperidin-3-yl)-1,3- dioxoisoindolin-4-yl)hex-5-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 500 | 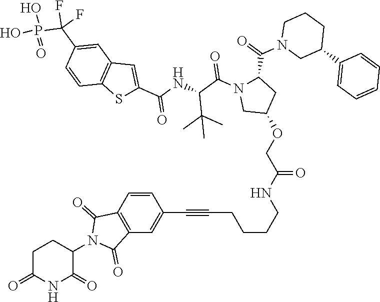 [SMILES: CC(C)(C)[C@H](NC(=O)c1cc2cc(C(F)(F)P(=O)(O)O)ccc2s1)C(=O)N1C[C@@H](OCC(=O)NCCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S,4S)-4-(2-((6-(2-(2,6-dioxopiperidin-3-yl)-1,3- dioxoisoindolin-5-yl)hex-5-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 501 | 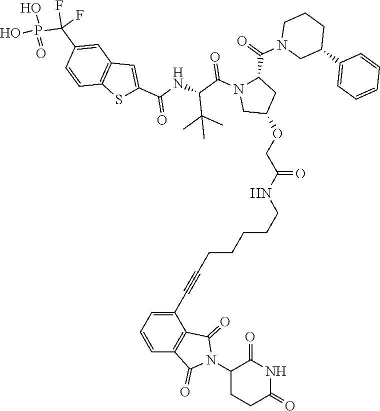 | ((2-(((2S)-1-((2S,4S)-4-(2-((7-(2-(2,6-dioxopiperidin-3-yl)-1,3- dioxoisoindolin-4-yl)hept-6-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 502 | 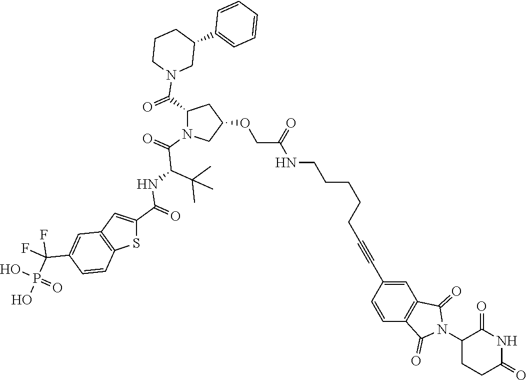 [SMILES: CC(C)(C)[C@H](NC(=O)c1cc2cc(C(F)(F)P(=O)(O)O)ccc2s1)C(=O)N1C[C@@H](OCC(=O)NCCCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S,4S)-4-(2-((7-(2-(2,6-dioxopiperidin-3-yl)-1,3- dioxoisoindolin-5-yl)hept-6-yn-1-yl)amino)-2-oxoethoxy)-2- ((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 503 | 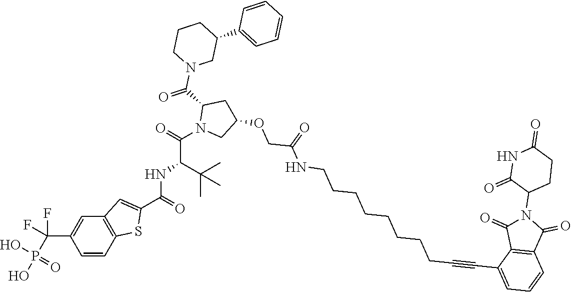 [SMILES: CC(C)(C)[C@H](NC(=O)c1cc2cc(C(F)(F)P(=O)(O)O)ccc2s1)C(=O)N1C[C@@H](OCC(=O)NCCCCCCCCC#Cc2cccc3c2C(=O)N(C2CCC(=O)NC2=O)C3=O)C[C@H]1C(=O)N1CCC[C@H](c2ccccc2)C1] | ((2-(((2S)-1-((2S,4S)-4-(2-((10-(2-(2,6-dioxopiperidin-3-yl)- 1,3-dioxoisoindolin-4-yl)dec-9-yn-1-yl)amino)-2-oxoethoxy)- 2-((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 504 | 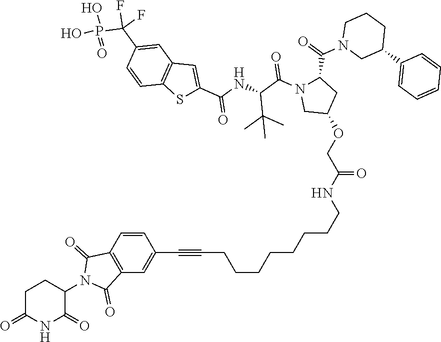 [SMILES: CC(C)(C)[C@H](NC(=O)c1cc2cc(C(F)(F)P(=O)(O)O)ccc2s1)C(=O)N1C[C@@H](OCC(=O)NCCCCCCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S,4S)-4-(2-((10-(2-(2,6-dioxopiperidin-3-yl)- 1,3-dioxoisoindolin-5-yl)dec-9-yn-1-yl)amino)-2-oxoethoxy)- 2-((R)-3-phenylpiperidine-1-carbonyl)pyrrolidin-1-yl)-3,3- dimethyl-1-oxobutan-2-yl)carbamoyl)benzo[b]thiophen-5- yl)difluoromethyl)phosphonic acid |
| 505 | 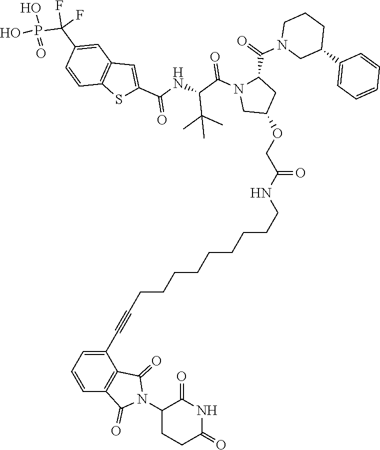 [SMILES: CC(C)(C)[C@H](NC(=O)c1cc2cc(C(F)(F)P(=O)(O)O)ccc2s1)C(=O)N1C[C@@H](OCC(=O)NCCCCCCCCCC#Cc2cccc3c2C(=O)N(C2CCC(=O)NC2=O)C3=O)C[C@H]1C(=O)N1CCC[C@H](c2ccccc2)C1] | ((2-(((2S)-1-((2S,4S)-4-(2-((11-(2-(2,6-dioxopiperidin-3-yl)- 1,3-dioxoisoindolin-4-yl)undec-10-yn-1-yl)amino)-2- oxoethoxy)-2-((R)-3-phenylpiperidine-1-carbonyl)pyrrolidin-1- yl)-3,3-dimethyl-1-oxobutan-2- yl)carbamoyl)benzo[b]thiophen-5- yl)difluoromethyl)phosphonic acid |
| 506 | 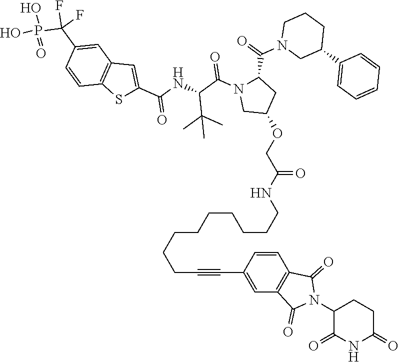 [SMILES: CC(C)(C)[C@H](NC(=O)c1cc2cc(C(F)(F)P(=O)(O)O)ccc2s1)C(=O)N1C[C@@H](OCC(=O)NCCCCCCCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S,4S)-4-(2-((11-(2-(2,6-dioxopiperidin-3-yl)- 1,3-dioxoisoindolin-5-yl)undec-10-yn-1-yl)amino)-2- oxoethoxy)-2-((R)-3-phenylpiperidine-1-carbonyl)pyrrolidin-1- yl)-3,3-dimethyl-1-oxobutan-2- yl)carbamoyl)benzo[b]thiophen-5- yl)difluoromethyl)phosphonic acid |
| 507 | 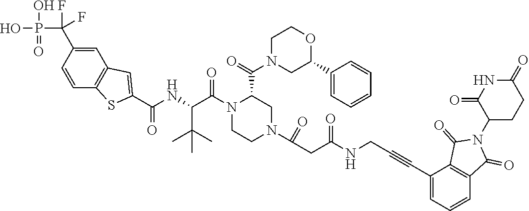 [SMILES: CC(C)(C)[C@H](NC(=O)c1cc2cc(C(F)(F)P(=O)(O)O)ccc2s1)C(=O)N1CCN(C(=O)CC(=O)NCC#Cc2cccc3c2C(=O)N(C2CCC(=O)NC2=O)C3=O)C[C@H]1C(=O)N1CCO[C@H](c2ccccc2)C1] | ((2-(((2S)-1-((2S)-4-(3-((3-(2-(2,6-dioxopiperidin-3-yl)-1,3- dioxoisoindolin-4-yl)prop-2-yn-1-yl)amino)-3-oxopropanoyl)- 2-((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 508 | 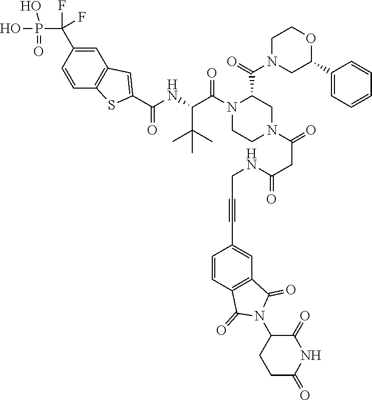 [SMILES: CC(C)(C)[C@H](NC(=O)c1cc2cc(C(F)(F)P(=O)(O)O)ccc2s1)C(=O)N1CCN(C(=O)CC(=O)NCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S)-4-(3-((3-(2-(2,6-dioxopiperidin-3-yl)-1,3- dioxoisoindolin-5-yl)prop-2-yn-1-yl)amino)-3-oxopropanoyl)- 2-((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 509 | 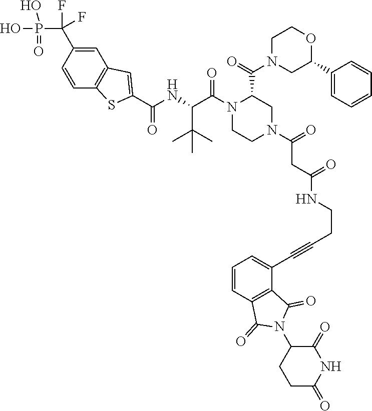 [SMILES: CC(C)(C)[C@H](NC(=O)c1cc2cc(C(F)(F)P(=O)(O)O)ccc2s1)C(=O)N1CCN(C(=O)CC(=O)NCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S)-4-(3-((4-(2-(2,6-dioxopiperidin-3-yl)-1,3- dioxoisoindolin-4-yl)but-3-yn-1-yl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 510 | 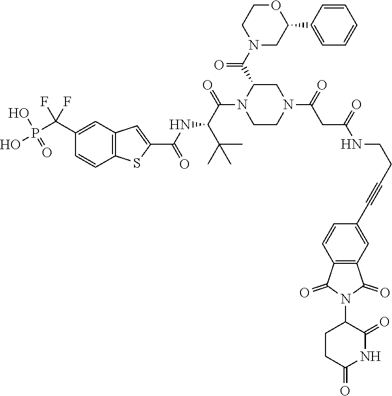 [SMILES: CC(C)(C)[C@H](NC(=O)c1cc2cc(C(F)(F)P(=O)(O)O)ccc2s1)C(=O)N1CCN(C(=O)CC(=O)NCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S)-4-(3-((4-(2-(2,6-dioxopiperidin-3-yl)-1,3- dioxoisoindolin-5-yl)but-3-yn-1-yl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 511 | 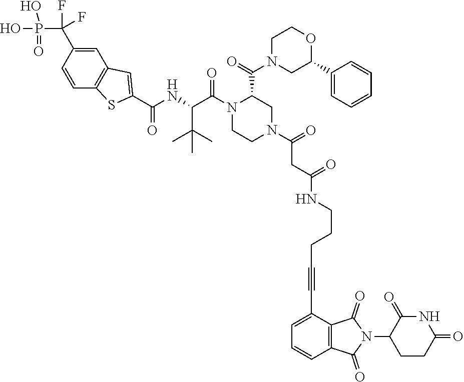 [SMILES: CC(C)(C)[C@H](NC(=O)c1cc2cc(C(F)(F)P(=O)(O)O)ccc2s1)C(=O)N1CCN(C(=O)CC(=O)NCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S)-4-(3-((5-(2-(2,6-dioxopiperidin-3-yl)-1,3- dioxoisoindolin-4-yl)pent-4-yn-1-yl)amino)-3-oxopropanoyl)- 2-((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 512 | 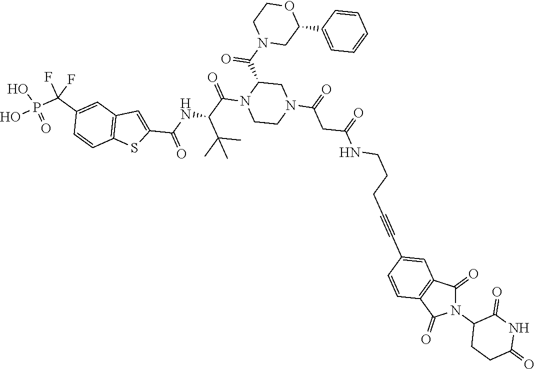 [SMILES: CC(C)(C)[C@H](NC(=O)c1cc2cc(C(F)(F)P(=O)(O)O)ccc2s1)C(=O)N1CCN(C(=O)CC(=O)NCCCC#Cc2ccc3c(c2)C(=O)N(C2CCC(=O)NC2=O)C3=O)C[C@H]1C(=O)N1CCO[C@H](c2ccccc2)C1] | ((2-(((25)-1-((2S)-4-(3-((5-(2-(2,6-dioxopiperidin-3-yl)-1,3- dioxoisoindolin-5-yl)pent-4-yn-1-yl)amino)-3-oxopropanoyl)- 2-((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 513 | 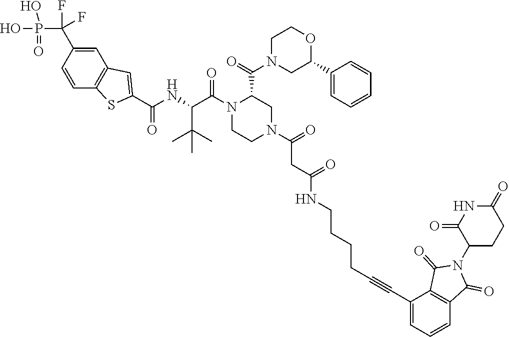 [SMILES: CC(C)(C)[C@H](NC(=O)c1cc2cc(C(F)(F)P(=O)(O)O)ccc2s1)C(=O)N1CCN(C(=O)CC(=O)NCCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S)-4-(3-((6-(2-(2,6-dioxopiperidin-3-yl)-1,3- dioxoisoindolin-4-yl)hex-5-yn-1-yl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 514 | 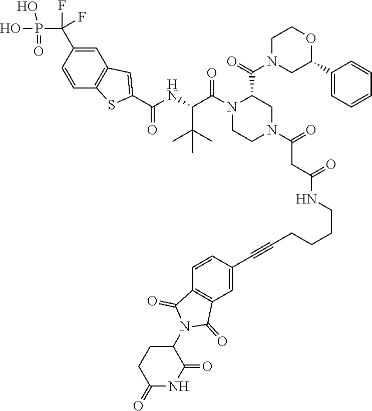 [SMILES: CC(C)(C)[C@H](NC(=O)c1cc2cc(C(F)(F)P(=O)(O)O)ccc2s1)C(=O)N1CCN(C(=O)CC(=O)NCCCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S)-4-(3-((6-(2-(2,6-dioxopiperidin-3-yl)-1,3- dioxoisoindolin-5-yl)hex-5-yn-1-yl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 515 | 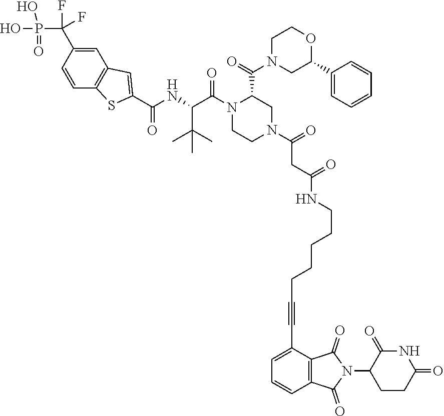 [SMILES: CC(C)(C)[C@H](NC(=O)c1cc2cc(C(F)(F)P(=O)(O)O)ccc2s1)C(=O)N1CCN(C(=O)CC(=O)NCCCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S)-4-(3-((7-(2-(2,6-dioxopiperidin-3-yl)-1,3- dioxoisoindolin-4-yl)hept-6-yn-1-yl)amino)-3-oxopropanoyl)- 2-((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 516 | 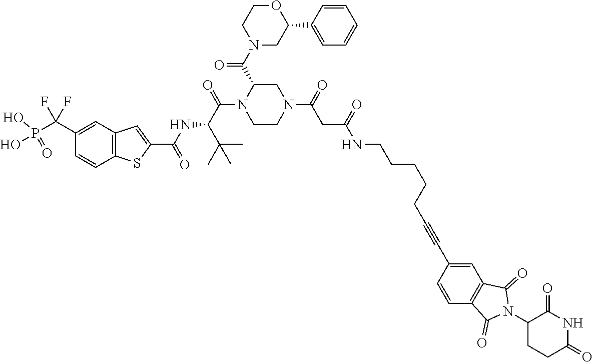 [SMILES: CC(C)(C)[C@H](NC(=O)c1cc2cc(C(F)(F)P(=O)(O)O)ccc2s1)C(=O)N1CCN(C(=O)CC(=O)NCCCCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S)-4-(3-((7-(2-(2,6-dioxopiperidin-3-yl)-1,3- dioxoisoindolin-5-yl)hept-6-yn-1-yl)amino)-3-oxopropanoyl)- 2-((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 517 | 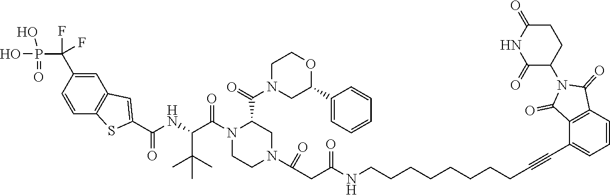 [SMILES: CC(C)(C)[C@H](NC(=O)c1cc2cc(C(F)(F)P(=O)(O)O)ccc2s1)C(=O)N1CCN(C(=O)CC(=O)NCCCCCCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S)-4-(3-((10-(2-(2,6-dioxopiperidin-3-yl)-1,3- dioxoisoindolin-4-yl)dec-9-yn-1-yl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 518 | 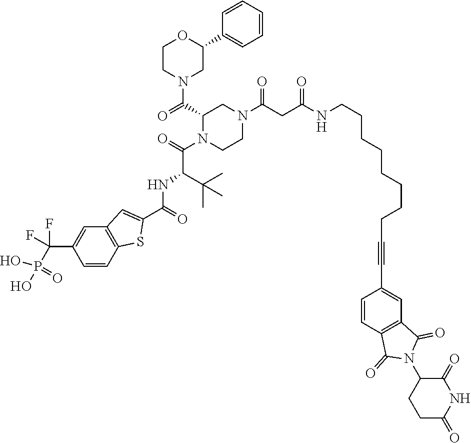 [SMILES: CC(C)(C)[C@H](NC(=O)c1cc2cc(C(F)(F)P(=O)(O)O)ccc2s1)C(=O)N1CCN(C(=O)CC(=O)NCCCCCCCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S)-4-(3-((10-(2-(2,6-dioxopiperidin-3-yl)-1,3- dioxoisoindolin-5-yl)dec-9-yn-1-yl)amino)-3-oxopropanoyl)-2- ((R)-2-phenylmorpholine-4-carbonyl)piperazin-1-yl)-3,3- dimethyl-1-oxobutan-2-yl)carbamoyl)benzo[b]thiophen-5- yl)difluoromethyl)phosphonic acid |
| 519 | 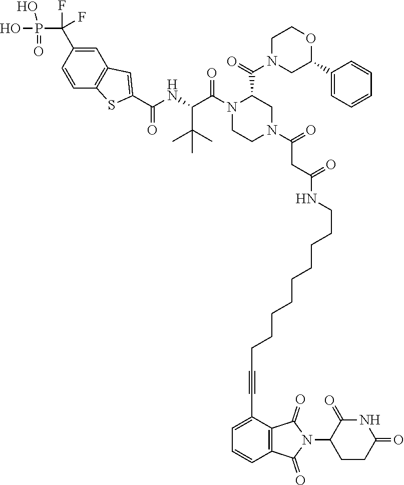 [SMILES: CC(C)(C)[C@H](NC(=O)c1cc2cc(C(F)(F)P(=O)(O)O)ccc2s1)C(=O)N1CCN(C(=O)CC(=O)NCCCCCCCCCC#Cc2cccc3c2C(=O)N(C2CCC(=O)NC2=O)C3=O)C[C@H]1C(=O)N1CCO[C@H](c2ccccc2)C1] | ((2-(((2S)-1-((2S)-4-(3-((11-(2-(2,6-dioxopiperidin-3-yl)-1,3- dioxoisoindolin-4-yl)undec-10-yn-1-yl)amino)-3- oxopropanoyl)-2-((R)-2-phenylmorpholine-4- carbonyl)piperazin-1-yl)-3,3-dimethyl-1-oxobutan-2- yl)carbamoyl)benzo[b]thiophen-5- yl)difluoromethyl)phosphonic acid |
| 520 | 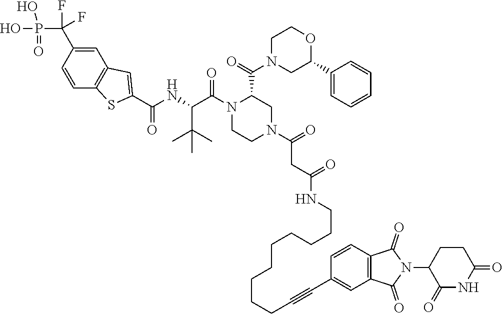 [SMILES: CC(C)(C)[C@H](NC(=O)c1cc2cc(C(F)(F)P(=O)(O)O)ccc2s1)C(=O)N1CCN(C(=O)CC(=O)NCCCCCCCCCC#Cc2ccc3c(c2)C(=O)N(C2CCC(=O)NC2=O)C3=O)C[C@H]1C(=O)N1CCO[C@H](c2ccccc2)C1] | ((2-(((2S)-1-((2S)-4-(3-((11-(2-(2,6-dioxopiperidin-3-yl)-1,3- dioxoisoindolin-5-yl)undec-10-yn-1-yl)amino)-3- oxopropanoyl)-2-((R)-2-phenylmorpholine-4- carbonyl)piperazin-1-yl)-3,3-dimethyl-1-oxobutan-2- yl)carbamoyl)benzo[b]thiophen-5- yl)difluoromethyl)phosphonic acid |
| 521 | 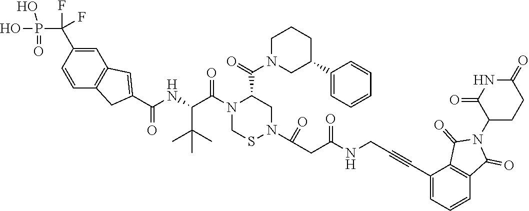 [SMILES: CC(C)(C)[C@H](NC(=O)C1=Cc2cc(C(F)(F)P(=O)(O)O)ccc2C1)C(=O)N1CSN(C(=O)CC(=O)NCC#Cc2cccc3c2C(=O)N(C2CCC(=O)NC2=O)C3=O)C[C@H]1C(=O)N1CCC[C@H](c2ccccc2)C1] | ((2-(((2S)-1-((4S)-2-(3-((3-(2-(2,6-dioxopiperidin-3-yl)-1,3- dioxoisoindolin-4-yl)prop-2-yn-1-yl)amino)-3-oxopropanoyl)- 4-((R)-3-phenylpiperidine-1-carbonyl)-1,2,5-thiadiazinan-5- yl)-3,3-dimethyl-1-oxobutan-2-yl)carbamoyl)-1H-inden-5- yl)difluoromethyl)phosphonic acid |
| 522 | 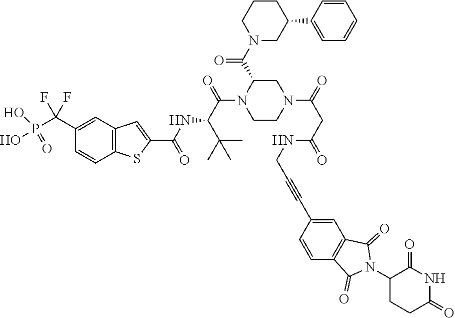 [SMILES: CC(C)(C)[C@H](NC(=O)c1cc2cc(C(F)(F)P(=O)(O)O)ccc2s1)C(=O)N1CCN(C(=O)CC(=O)NCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S)-4-(3-((3-(2-(2,6-dioxopiperidin-3-yl)-1,3- dioxoisoindolin-5-yl)prop-2-yn-1-yl)amino)-3-oxopropanoyl)- 2-((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 523 | 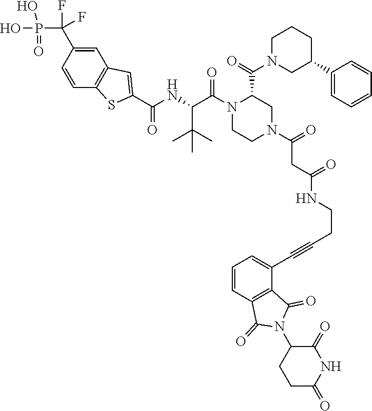 [SMILES: CC(C)(C)[C@H](NC(=O)c1cc2cc(C(F)(F)P(=O)(O)O)ccc2s1)C(=O)N1CCN(C(=O)CC(=O)NCCC#Cc2cccc3c2C(=O)N(C2CCC(=O)NC2=O)C3=O)C[C@H]1C(=O)N1CCC[C@H](c2ccccc2)C1] | ((2-(((2S)-1-((2S)-4-(3-((4-(2-(2,6-dioxopiperidin-3-yl)-1,3- dioxoisoindolin-4-yl)but-3-yn-1-yl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 524 | 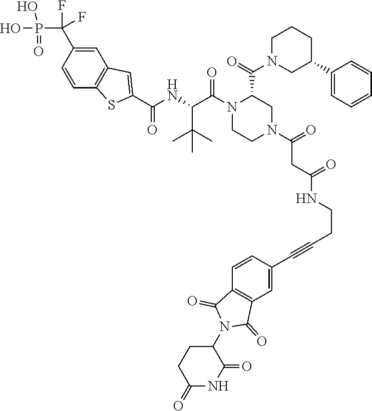 [SMILES: CC(C)(C)[C@H](NC(=O)c1cc2cc(C(F)(F)P(=O)(O)O)ccc2s1)C(=O)N1CCN(C(=O)CC(=O)NCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S)-4-(3-((4-(2-(2,6-dioxopiperidin-3-yl)-1,3- dioxoisoindolin-5-yl)but-3-yn-1-yl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 525 | 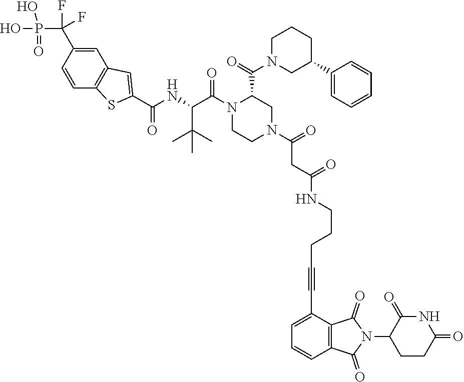 [SMILES: CC(C)(C)[C@H](NC(=O)c1cc2cc(C(F)(F)P(=O)(O)O)ccc2s1)C(=O)N1CCN(C(=O)CC(=O)NCCCC#Cc2cccc3c2C(=O)N(C2CCC(=O)NC2=O)C3=O)C[C@H]1C(=O)N1CCC[C@H](c2ccccc2)C1] | ((2-(((2S)-1-((2S)-4-(3-((5-(2-(2,6-dioxopiperidin-3-yl)-1,3- dioxoisoindolin-4-yl)pent-4-yn-1-yl)amino)-3-oxopropanoyl)- 2-((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 526 | 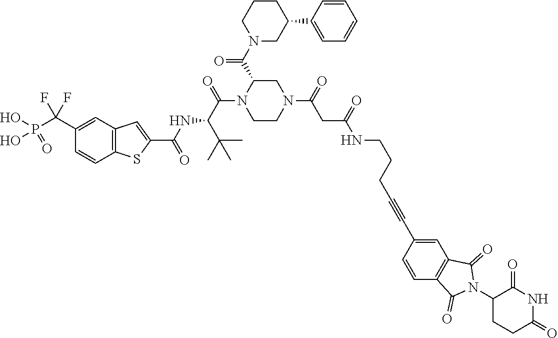 [SMILES: CC(C)(C)[C@H](NC(=O)c1cc2cc(C(F)(F)P(=O)(O)O)ccc2s1)C(=O)N1CCN(C(=O)CC(=O)NCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S)-4-(3-((5-(2-(2,6-dioxopiperidin-3-yl)-1,3- dioxoisoindolin-5-yl)pent-4-yn-1-yl)amino)-3-oxopropanoyl)- 2-((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 527 | 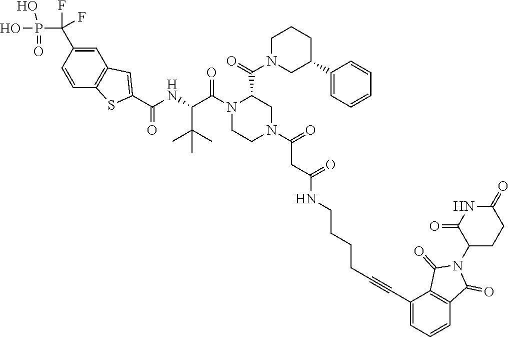 [SMILES: CC(C)(C)[C@H](NC(=O)c1cc2cc(C(F)(F)P(=O)(O)O)ccc2s1)C(=O)N1CCN(C(=O)CC(=O)NCCCCC#Cc2cccc3c2C(=O)N(C2CCC(=O)NC2=O)C3=O)C[C@H]1C(=O)N1CCC[C@H](c2ccccc2)C1] | ((2-(((2S)-1-((2S)-4-(3-((6-(2-(2,6-dioxopiperidin-3-yl)-1,3- dioxoisoindolin-4-yl)hex-5-yn-1-yl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 528 | 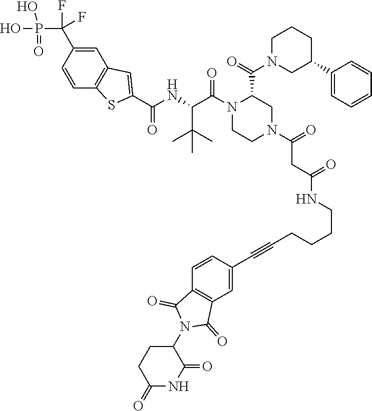 [SMILES: CC(C)(C)[C@H](NC(=O)c1cc2cc(C(F)(F)P(=O)(O)O)ccc2s1)C(=O)N1CCN(C(=O)CC(=O)NCCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S)-4-(3-((6-(2-(2,6-dioxopiperidin-3-yl)-1,3- dioxoisoindolin-5-yl)hex-5-yn-1-yl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 529 | 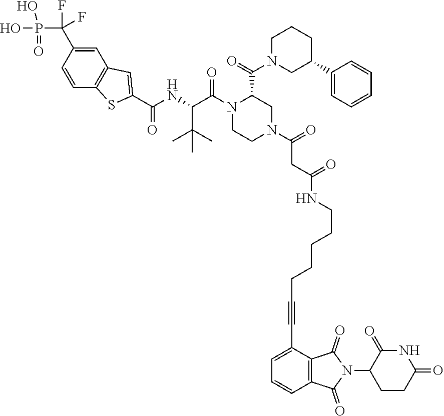 [SMILES: CC(C)(C)[C@H](NC(=O)c1cc2cc(C(F)(F)P(=O)(O)O)ccc2s1)C(=O)N1CCN(C(=O)CC(=O)NCCCCCC#Cc2cccc3c2C(=O)N(C2CCC(=O)NC2=O)C3=O)C[C@H]1C(=O)N1CCC[C@H](c2ccccc2)C1] | ((2-(((2S)-1-((2S)-4-(3-((7-(2-(2,6-dioxopiperidin-3-yl)-1,3- dioxoisoindolin-4-yl)hept-6-yn-1-yl)amino)-3-oxopropanoyl)- 2-((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 530 | 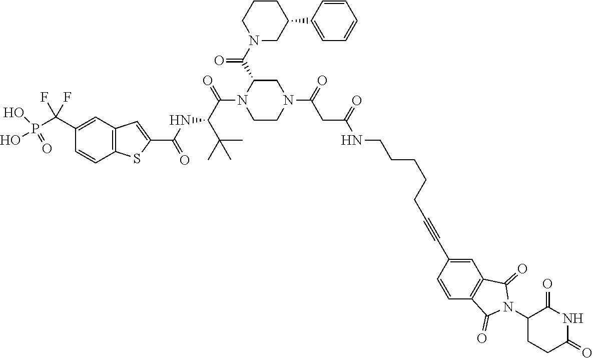 [SMILES: CC(C)(C)[C@H](NC(=O)c1cc2cc(C(F)(F)P(=O)(O)O)ccc2s1)C(=O)N1CCN(C(=O)CC(=O)NCCCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S)-4-(3-((7-(2-(2,6-dioxopiperidin-3-yl)-1,3- dioxoisoindolin-5-yl)hept-6-yn-1-yl)amino)-3-oxopropanoyl)- 2-((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 531 | 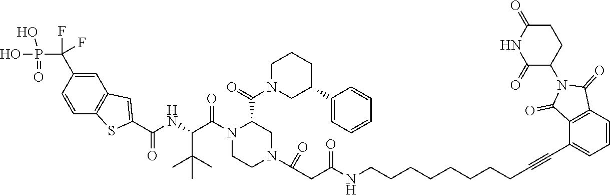 [SMILES: CC(C)(C)[C@H](NC(=O)c1cc2cc(C(F)(F)P(=O)(O)O)ccc2s1)C(=O)N1CCN(C(=O)CC(=O)NCCCCCCCCC#Cc2cccc3c2C(=O)N(C2CCC(=O)NC2=O)C3=O)C[C@H]1C(=O)N1CCC[C@H](c2ccccc2)C1] | ((2-(((2S)-1-((2S)-4-(3-((10-(2-(2,6-dioxopiperidin-3-yl)-1,3- dioxoisoindolin-4-yl)dec-9-yn-1-yl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 532 | 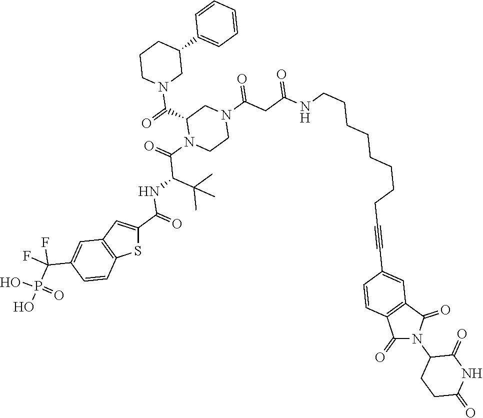 [SMILES: CC(C)(C)[C@H](NC(=O)c1cc2cc(C(F)(F)P(=O)(O)O)ccc2s1)C(=O)N1CCN(C(=O)CC(=O)NCCCCCCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S)-4-(3-((10-(2-(2,6-dioxopiperidin-3-yl)-1,3- dioxoisoindolin-5-yl)dec-9-yn-1-yl)amino)-3-oxopropanoyl)-2- ((R)-3-phenylpiperidine-1-carbonyl)piperazin-1-yl)-3,3- dimethyl-1-oxobutan-2-yl)carbamoyl)benzo[b]thiophen-5- yl)difluoromethyl)phosphonic acid |
| 533 | 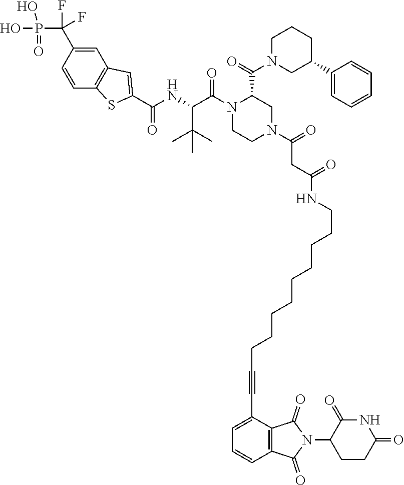 [SMILES: CC(C)(C)[C@H](NC(=O)c1cc2cc(C(F)(F)P(=O)(O)O)ccc2s1)C(=O)N1CCN(C(=O)CC(=O)NCCCCCCCCCC#Cc2cccc3c2C(=O)N(C2CCC(=O)NC2=O)C3=O)C[C@H]1C(=O)N1CCC[C@H](c2ccccc2)C1] | ((2-(((2S)-1-((2S)-4-(3-((11-(2-(2,6-dioxopiperidin-3-yl)-1,3- dioxoisoindolin-4-yl)undec-10-yn-1-yl)amino)-3- oxopropanoyl)-2-((R)-3-phenylpiperidine-1- carbonyl)piperazin-1-yl)-3,3-dimethyl-1-oxobutan-2- yl)carbamoyl)benzo[b]thiophen-5- yl)difluoromethyl)phosphonic acid |
| 534 | 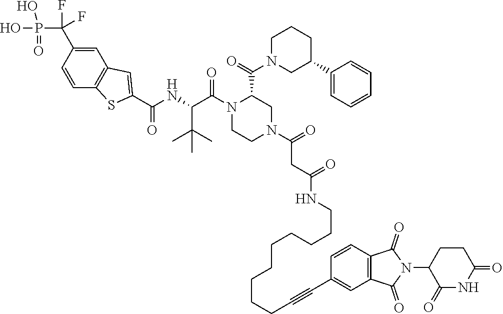 [SMILES: CC(C)(C)[C@H](NC(=O)c1cc2cc(C(F)(F)P(=O)(O)O)ccc2s1)C(=O)N1CCN(C(=O)CC(=O)NCCCCCCCCCC#Cc2ccc3c(c2)C(=O)N(C2CCC(=O)NC2=O)C3=O)C[C@H]1C(=O)N1CCC[C@H](c2ccccc2)C1] | ((2-(((2S)-1-((2S)-4-(3-((11-(2-(2,6-dioxopiperidin-3-yl)-1,3- dioxoisoindolin-5-yl)undec-10-yn-1-yl)amino)-3- oxopropanoyl)-2-((R)-3-phenylpiperidine-1- carbonyl)piperazin-1-yl)-3,3-dimethyl-1-oxobutan-2- yl)carbamoyl)benzo[b]thiophen-5- yl)difluoromethyl)phosphonic acid |
| 535 | 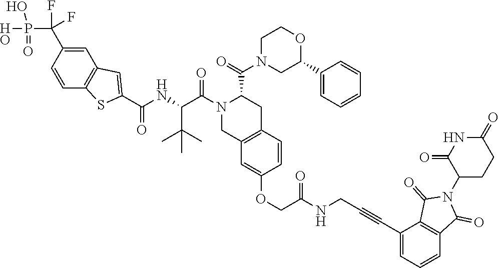 [SMILES: CC(C)(C)[C@H](NC(=O)c1cc2cc(C(F)(F)P(=O)(O)O)ccc2s1)C(=O)N1Cc2cc(OCC(=O)NCC#Cc3cccc4c3C(=O)N(C3CCC(=O)NC3=O)C4=O)ccc2C[C@H]1C(=O)N1CCO[C@H](c2ccccc2)C1] | ((2-(((2S)-1-((3S)-7-(2-((3-(2-(2,6-dioxopiperidin-3-yl)-1,3- dioxoisoindolin-4-yl)prop-2-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 536 | 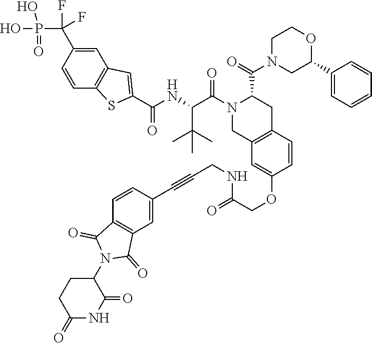 [SMILES: CC(C)(C)[C@H](NC(=O)c1cc2cc(C(F)(F)P(=O)(O)O)ccc2s1)C(=O)N1Cc2cc(OCC(=O)NCC#Cc3ccc4c(c3)C(=O)N(C3CCC(=O)NC3=O)C4=O)ccc2C[C@H]1C(=O)N1CCO[C@H](c2ccccc2)C1] | ((2-(((2S)-1-((3S)-7-(2-((3-(2-(2,6-dioxopiperidin-3-yl)-1,3- dioxoisoindolin-5-yl)prop-2-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 537 | 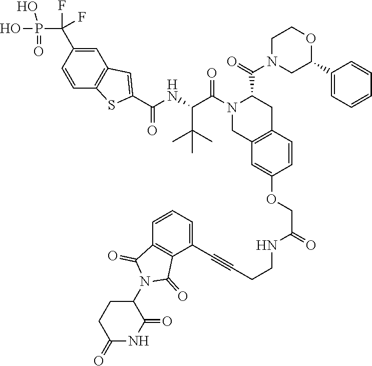 [SMILES: CC(C)(C)[C@H](NC(=O)c1cc2cc(C(F)(F)P(=O)(O)O)ccc2s1)C(=O)N1Cc2cc(OCC(=O)NCCC#Cc3cccc4c3C(=O)N(C3CCC(=O)NC3=O)C4=O)ccc2C[C@H]1C(=O)N1CCO[C@H](c2ccccc2)C1] | ((2-(((2S)-1-((3S)-7-(2-((4-(2-(2,6-dioxopiperidin-3-yl)-1,3- dioxoisoindolin-4-yl)but-3-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 538 | 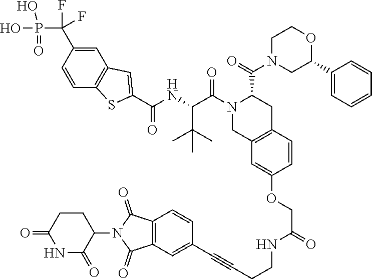 [SMILES: CC(C)(C)[C@H](NC(=O)c1cc2cc(C(F)(F)P(=O)(O)O)ccc2s1)C(=O)N1Cc2cc(OCC(=O)NCCC#Cc3ccc4c(c3)C(=O)N(C3CCC(=O)NC3=O)C4=O)ccc2C[C@H]1C(=O)N1CCO[C@H](c2ccccc2)C1] | ((2-(((2S)-1-((3S)-7-(2-((4-(2-(2,6-dioxopiperidin-3-yl)-1,3- dioxoisoindolin-5-yl)but-3-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 539 | 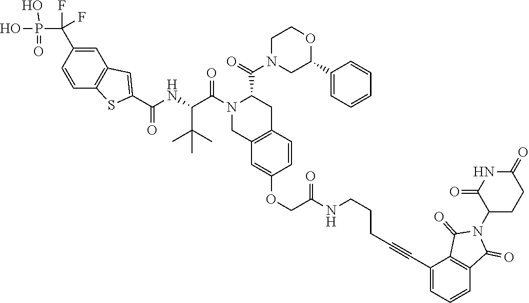 [SMILES: CC(C)(C)[C@H](NC(=O)c1cc2cc(C(F)(F)P(=O)(O)O)ccc2s1)C(=O)N1Cc2cc(OCC(=O)NCCCC#Cc3cccc4c3C(=O)N(C3CCC(=O)NC3=O)C4=O)ccc2C[C@H]1C(=O)N1CCO[C@H](c2ccccc2)C1] | ((2-(((2S)-1-((3S)-7-(2-((5-(2-(2,6-dioxopiperidin-3-yl)-1,3- dioxoisoindolin-4-yl)pent-4-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 540 | 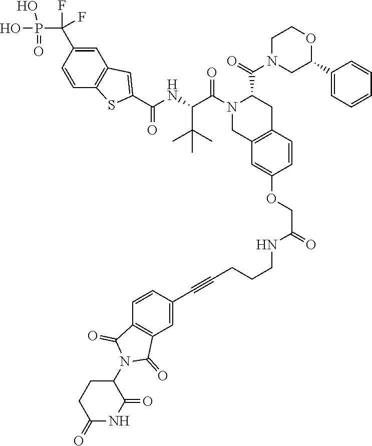 [SMILES: CC(C)(C)[C@H](NC(=O)c1cc2cc(C(F)(F)P(=O)(O)O)ccc2s1)C(=O)N1Cc2cc(OCC(=O)NCCCC#Cc3ccc4c(c3)C(=O)N(C3CCC(=O)NC3=O)C4=O)ccc2C[C@H]1C(=O)N1CCO[C@H](c2ccccc2)C1] | ((2-(((2S)-1-((3S)-7-(2-((5-(2-(2,6-dioxopiperidin-3-yl)-1,3- dioxoisoindolin-5-yl)pent-4-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 541 | 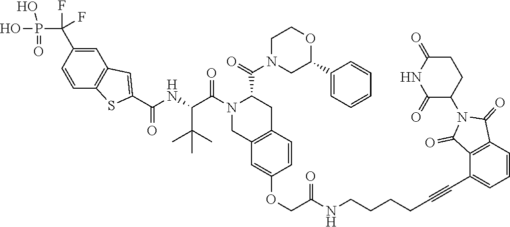 [SMILES: CC(C)(C)[C@H](NC(=O)c1cc2cc(C(F)(F)P(=O)(O)O)ccc2s1)C(=O)N1Cc2cc(OCC(=O)NCCCCC#Cc3cccc4c3C(=O)N(C3CCC(=O)NC3=O)C4=O)ccc2C[C@H]1C(=O)N1CCO[C@H](c2ccccc2)C1] | ((2-(((2S)-1-((3S)-7-(2-((6-(2-(2,6-dioxopiperidin-3-yl)-1,3- dioxoisoindolin-4-yl)hex-5-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 542 | 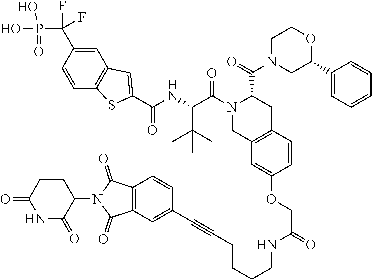 [SMILES: CC(C)(C)[C@H](NC(=O)c1cc2cc(C(F)(F)P(=O)(O)O)ccc2s1)C(=O)N1Cc2cc(OCC(=O)NCCCCC#Cc3ccc4c(c3)C(=O)N(C3CCC(=O)NC3=O)C4=O)ccc2C[C@H]1C(=O)N1CCO[C@H](c2ccccc2)C1] | ((2-(((2S)-1-((3S)-7-(2-((6-(2-(2,6-dioxopiperidin-3-yl)-1,3- dioxoisoindolin-5-yl)hex-5-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 543 | 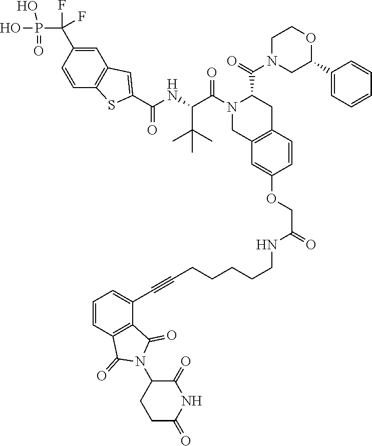 [SMILES: CC(C)(C)[C@H](NC(=O)c1cc2cc(C(F)(F)P(=O)(O)O)ccc2s1)C(=O)N1Cc2cc(OCC(=O)NCCCCCC#Cc3cccc4c3C(=O)N(C3CCC(=O)NC3=O)C4=O)ccc2C[C@H]1C(=O)N1CCO[C@H](c2ccccc2)C1] | ((2-(((2S)-1-((3S)-7-(2-((7-(2-(2,6-dioxopiperidin-3-yl)-1,3- dioxoisoindolin-4-yl)hept-6-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- y)difluoromethyl)phosphonic acid |
| 544 | 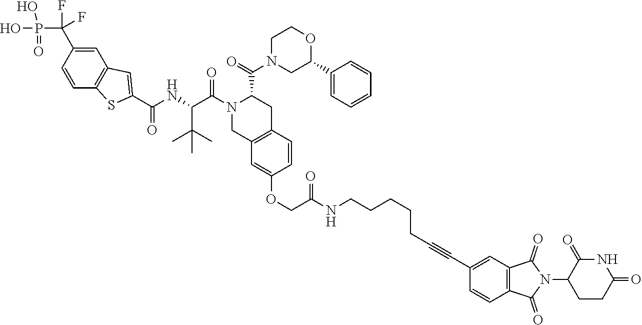 [SMILES: CC(C)(C)[C@H](NC(=O)c1cc2cc(C(F)(F)P(=O)(O)O)ccc2s1)C(=O)N1Cc2cc(OCC(=O)NCCCCCC#Cc3ccc4c(c3)C(=O)N(C3CCC(=O)NC3=O)C4=O)ccc2C[C@H]1C(=O)N1CCO[C@H](c2ccccc2)C1] | ((2-(((2S)-1-((3S)-7-(2-((7-(2-(2,6-dioxopiperidin-3-yl)-1,3- dioxoisoindolin-5-yl)hept-6-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 545 | 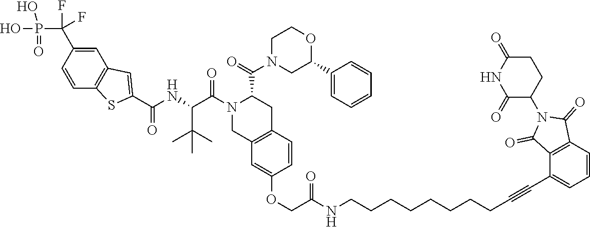 [SMILES: CC(C)(C)[C@H](NC(=O)c1cc2cc(C(F)(F)P(=O)(O)O)ccc2s1)C(=O)N1Cc2cc(OCC(=O)NCCCCCCCCC#Cc3cccc4c3C(=O)N(C3CCC(=O)NC3=O)C4=O)ccc2C[C@H]1C(=O)N1CCO[C@H](c2ccccc2)C1] | ((2-(((2S)-1-((3S)-7-(2-((10-(2-(2,6-dioxopiperidin-3-yl)-1,3- dioxoisoindolin-4-yl)dec-9-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 546 | 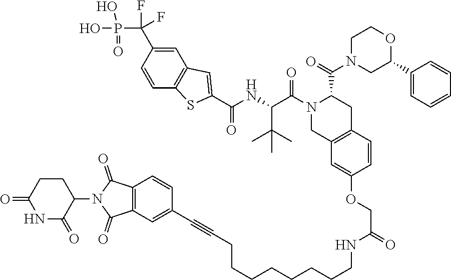 [SMILES: CC(C)(C)[C@H](NC(=O)c1cc2cc(C(F)(F)P(=O)(O)O)ccc2s1)C(=O)N1Cc2cc(OCC(=O)NCCCCCCCCC#Cc3ccc4c(c3)C(=O)N(C3CCC(=O)NC3=O)C4=O)ccc2C[C@H]1C(=O)N1CCO[C@H](c2ccccc2)C1] | ((2-(((2S)-1-((3S)-7-(2-((10-(2-(2,6-dioxopiperidin-3-yl)-1,3- dioxoisoindolin-5-yl)dec-9-yn-1-yl)amino)-2-oxoethoxy)-3- ((R)-2-phenylmorpholine-4-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 547 | 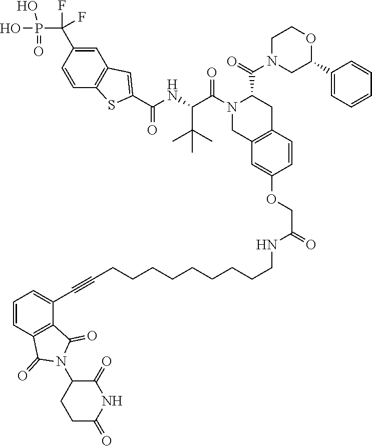 [SMILES: CC(C)(C)[C@H](NC(=O)c1cc2cc(C(F)(F)P(=O)(O)O)ccc2s1)C(=O)N1Cc2cc(OCC(=O)NCCCCCCCCCC#Cc3cccc4c3C(=O)N(C3CCC(=O)NC3=O)C4=O)ccc2C[C@H]1C(=O)N1CCO[C@H](c2ccccc2)C1] | ((2-(((2S)-1-((3S)-7-(2-((11-(2-(2,6-dioxopiperidin-3-yl)-1,3- dioxoisoindolin-4-yl)undec-10-yn-1-yl)amino)-2-oxoethoxy)- 3-((R)-2-phenylmorpholine-4-carbonyl)-3,4- dihydroisoquinolin-2(1H)-yl)-3,3-dimethyl-1-oxobutan-2- yl)carbamoyl)benzo[b]thiophen-5- yl)difluoromethyl)phosphonic acid |
| 548 | 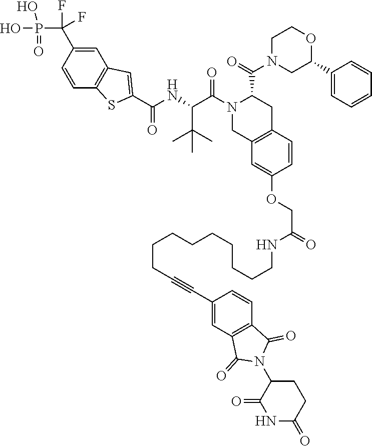 [SMILES: CC(C)(C)[C@H](NC(=O)c1cc2cc(C(F)(F)P(=O)(O)O)ccc2s1)C(=O)N1Cc2cc(OCC(=O)NCCCCCCCCCC#Cc3ccc4c(c3)C(=O)N(C3CCC(=O)NC3=O)C4=O)ccc2C[C@H]1C(=O)N1CCO[C@H](c2ccccc2)C1] | ((2-(((2S)-1-((3S)-7-(2-((11-(2-(2,6-dioxopiperidin-3-yl)-1,3- dioxoisoindolin-5-yl)undec-10-yn-1-yl)amino)-2-oxoethoxy)- 3-((R)-2-phenylmorpholine-4-carbonyl)-3,4- dihydroisoquinolin-2(1H)-yl)-3,3-dimethyl-1-oxobutan-2- yl)carbamoyl)benzo[b]thiophen-5- yl)difluoromethyl)phosphonic acid |
| 549 | 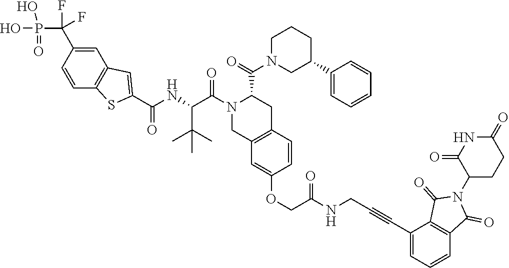 [SMILES: CC(C)(C)[C@H](NC(=O)c1cc2cc(C(F)(F)P(=O)(O)O)ccc2s1)C(=O)N1Cc2cc(OCC(=O)NCC#Cc3cccc4c3C(=O)N(C3CCC(=O)NC3=O)C4=O)ccc2C[C@H]1C(=O)N1CCC[C@H](c2ccccc2)C1] | ((2-(((2S)-1-((3S)-7-(2-((3-(2-(2,6-dioxopiperidin-3-yl)-1,3- dioxoisoindolin-4-yl)prop-2-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 550 | 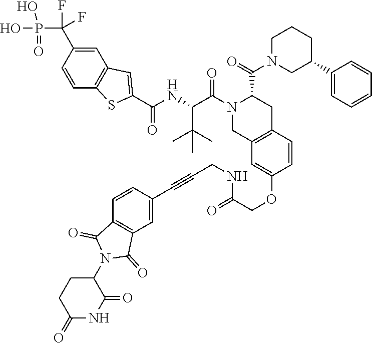 [SMILES: CC(C)(C)[C@H](NC(=O)c1cc2cc(C(F)(F)P(=O)(O)O)ccc2s1)C(=O)N1Cc2cc(OCC(=O)NCC#Cc3ccc4c(c3)C(=O)N(C3CCC(=O)NC3=O)C4=O)ccc2C[C@H]1C(=O)N1CCC[C@H](c2ccccc2)C1] | ((2-(((2S)-1-((3S)-7-(2-((3-(2-(2,6-dioxopiperidin-3-yl)-1,3- dioxoisoindolin-5-yl)prop-2-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 551 | 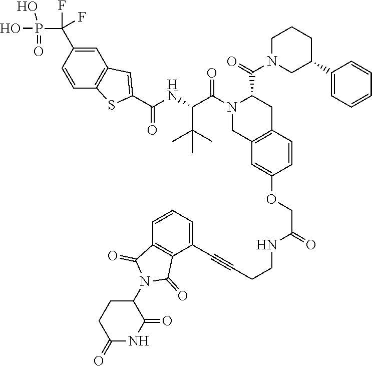 [SMILES: CC(C)(C)[C@H](NC(=O)c1cc2cc(C(F)(F)P(=O)(O)O)ccc2s1)C(=O)N1Cc2cc(OCC(=O)NCCC#Cc3cccc4c3C(=O)N(C3CCC(=O)NC3=O)C4=O)ccc2C[C@H]1C(=O)N1CCC[C@H](c2ccccc2)C1] | ((2-(((2S)-1-((3S)-7-(2-((4-(2-(2,6-dioxopiperidin-3-yl)-1,3- dioxoisoindolin-4-yl)but-3-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 552 | 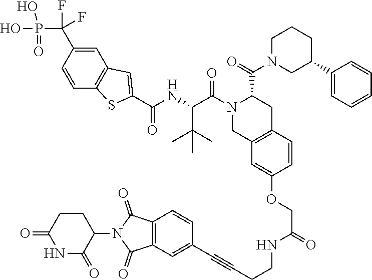 [SMILES: CC(C)(C)[C@H](NC(=O)c1cc2cc(C(F)(F)P(=O)(O)O)ccc2s1)C(=O)N1Cc2cc(OCC(=O)NCCC#Cc3ccc4c(c3)C(=O)N(C3CCC(=O)NC3=O)C4=O)ccc2C[C@H]1C(=O)N1CCC[C@H](c2ccccc2)C1] | ((2-(((2S)-1-((3S)-7-(2-((4-(2-(2,6-dioxopiperidin-3-yl)-1,3- dioxoisoindolin-5-yl)but-3-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 553 | 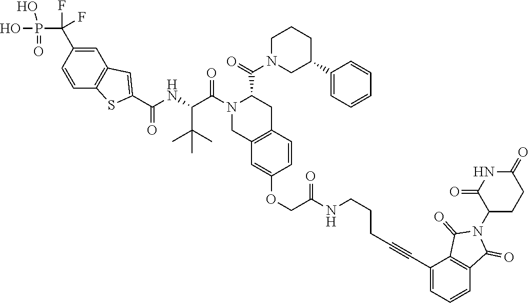 [SMILES: CC(C)(C)[C@H](NC(=O)c1cc2cc(C(F)(F)P(=O)(O)O)ccc2s1)C(=O)N1Cc2cc(OCC(=O)NCCCC#Cc3cccc4c3C(=O)N(C3CCC(=O)NC3=O)C4=O)ccc2C[C@H]1C(=O)N1CCC[C@H](c2ccccc2)C1] | ((2-(((2S)-1-((3S)-7-(2-((5-(2-(2,6-dioxopiperidin-3-yl)-1,3- dioxoisoindolin-4-yl)pent-4-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 554 | 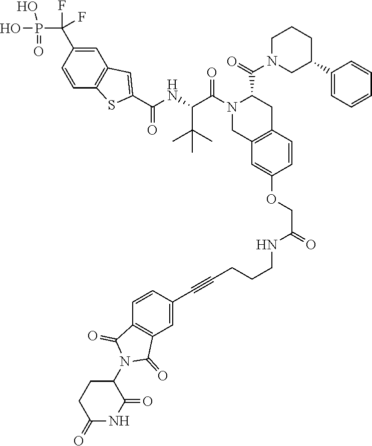 [SMILES: CC(C)(C)[C@H](NC(=O)c1cc2cc(C(F)(F)P(=O)(O)O)ccc2s1)C(=O)N1Cc2cc(OCC(=O)NCCCC#Cc3ccc4c(c3)C(=O)N(C3CCC(=O)NC3=O)C4=O)ccc2C[C@H]1C(=O)N1CCC[C@H](c2ccccc2)C1] | ((2-(((2S)-1-((3S)-7-(2-((5-(2-(2,6-dioxopiperidin-3-yl)-1,3- dioxoisoindolin-5-yl)pent-4-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 555 | 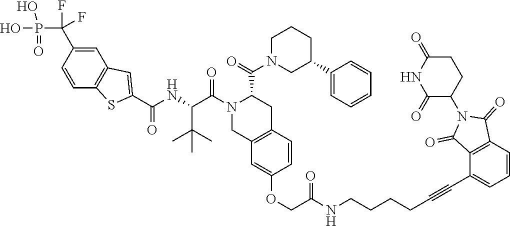 [SMILES: CC(C)(C)[C@H](NC(=O)c1cc2cc(C(F)(F)P(=O)(O)O)ccc2s1)C(=O)N1Cc2cc(OCC(=O)NCCCCC#Cc3cccc4c3C(=O)N(C3CCC(=O)NC3=O)C4=O)ccc2C[C@H]1C(=O)N1CCC[C@H](c2ccccc2)C1] | ((2-(((2S)-1-((3S)-7-(2-((6-(2-(2,6-dioxopiperidin-3-yl)-1,3- dioxoisoindolin-4-yl)hex-5-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 556 | 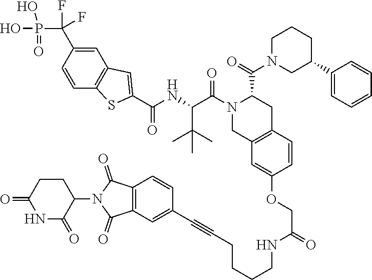 [SMILES: CC(C)(C)[C@H](NC(=O)c1cc2cc(C(F)(F)P(=O)(O)O)ccc2s1)C(=O)N1Cc2cc(OCC(=O)NCCCCC#Cc3ccc4c(c3)C(=O)N(C3CCC(=O)NC3=O)C4=O)ccc2C[C@H]1C(=O)N1CCC[C@H](c2ccccc2)C1] | ((2-(((2S)-1-((3S)-7-(2-((6-(2-(2,6-dioxopiperidin-3-yl)-1,3- dioxoisoindolin-5-yl)hex-5-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 557 | 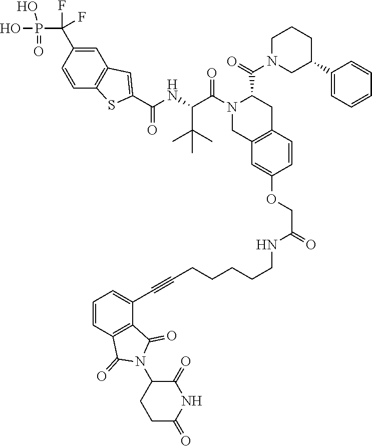 [SMILES: CC(C)(C)[C@H](NC(=O)c1cc2cc(C(F)(F)P(=O)(O)O)ccc2s1)C(=O)N1Cc2cc(OCC(=O)NCCCCCC#Cc3cccc4c3C(=O)N(C3CCC(=O)NC3=O)C4=O)ccc2C[C@H]1C(=O)N1CCC[C@H](c2ccccc2)C1] | ((2-(((2S)-1-((3S)-7-(2-((7-(2-(2,6-dioxopiperidin-3-yl)-1,3- dioxoisoindolin-4-yl)hept-6-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 558 | 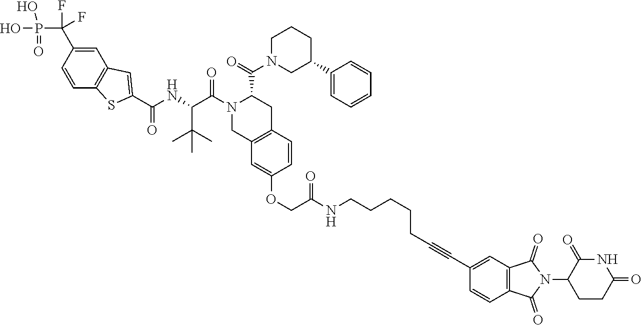 [SMILES: CC(C)(C)[C@H](NC(=O)c1cc2cc(C(F)(F)P(=O)(O)O)ccc2s1)C(=O)N1Cc2cc(OCC(=O)NCCCCCC#Cc3ccc4c(c3)C(=O)N(C3CCC(=O)NC3=O)C4=O)ccc2C[C@H]1C(=O)N1CCC[C@H](c2ccccc2)C1] | ((2-(((2S)-1-((3S)-7-(2-((7-(2-(2,6-dioxopiperidin-3-yl)-1,3- dioxoisoindolin-5-yl)hept-6-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 559 | 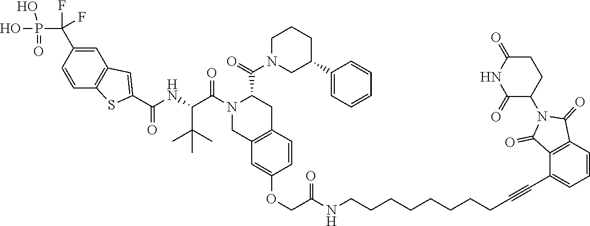 [SMILES: CC(C)(C)[C@H](NC(=O)c1cc2cc(C(F)(F)P(=O)(O)O)ccc2s1)C(=O)N1Cc2cc(OCC(=O)NCCCCCCCCC#Cc3cccc4c3C(=O)N(C3CCC(=O)NC3=O)C4=O)ccc2C[C@H]1C(=O)N1CCC[C@H](c2ccccc2)C1] | ((2-(((2S)-1-((3S)-7-(2-((10-(2-(2,6-dioxopiperidin-3-yl)-1,3- dioxoisoindolin-4-yl)dec-9-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 560 | 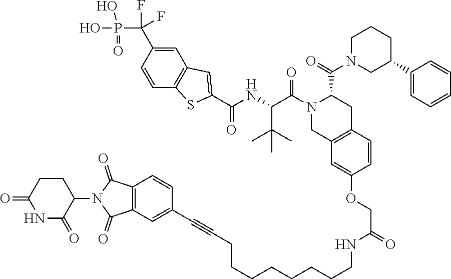 [SMILES: CC(C)(C)[C@H](NC(=O)c1cc2cc(C(F)(F)P(=O)(O)O)ccc2s1)C(=O)N1Cc2cc(OCC(=O)NCCCCCCCCC#Cc3ccc4c(c3)C(=O)N(C3CCC(=O)NC3=O)C4=O)ccc2C[C@H]1C(=O)N1CCC[C@H](c2ccccc2)C1] | ((2-(((2S)-1-((3S)-7-(2-((10-(2-(2,6-dioxopiperidin-3-yl)-1,3- dioxoisoindolin-5-yl)dec-9-yn-1-yl)amino)-2-oxoethoxy)-3- ((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 561 | 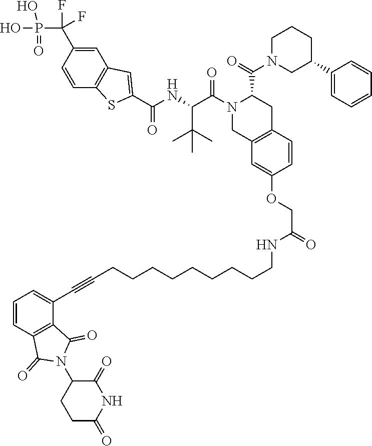 [SMILES: CC(C)(C)[C@H](NC(=O)c1cc2cc(C(F)(F)P(=O)(O)O)ccc2s1)C(=O)N1Cc2cc(OCC(=O)NCCCCCCCCCC#Cc3cccc4c3C(=O)N(C3CCC(=O)NC3=O)C4=O)ccc2C[C@H]1C(=O)N1CCC[C@H](c2ccccc2)C1] | ((2-(((2S)-1-((3S)-7-(2-((11-(2-(2,6-dioxopiperidin-3-yl)-1,3- dioxoisoindolin-4-yl)undec-10-yn-1-yl)amino)-2-oxoethoxy)- 3-((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 562 | 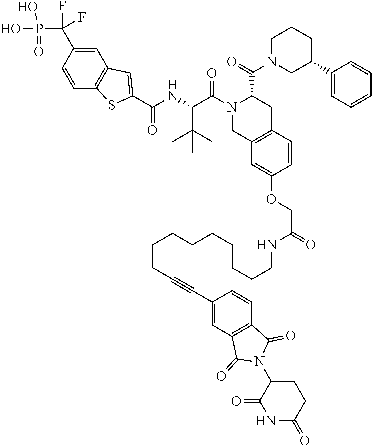 [SMILES: CC(C)(C)[C@H](NC(=O)c1cc2cc(C(F)(F)P(=O)(O)O)ccc2s1)C(=O)N1Cc2cc(OCC(=O)NCCCCCCCCCC#Cc3ccc4c(c3)C(=O)N(C3CCC(=O)NC3=O)C4=O)ccc2C[C@H]1C(=O)N1CCC[C@H](c2ccccc2)C1] | ((2-(((2S)-1-((3S)-7-(2-((11-(2-(2,6-dioxopiperidin-3-yl)-1,3- dioxoisoindolin-5-yl)undec-10-yn-1-yl)amino)-2-oxoethoxy)- 3-((R)-3-phenylpiperidine-1-carbonyl)-3,4-dihydroisoquinolin- 2(1H)-yl)-3,3-dimethyl-1-oxobutan-2- yl)carbamoyl)benzo[b]thiophen-5- yl)difluoromethyl)phosphonic acid |
| 563 | 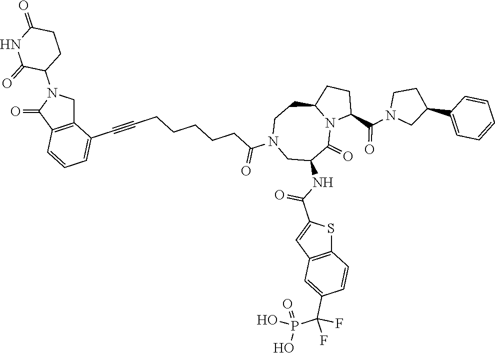 [SMILES: O=C1CCC(N2Cc3c(C#CCCCCCC(=O)N4CC[C@H]5CC[C@@H](C(=O)N6CC[C@@H](c7ccccc7)C6)N5C(=O)[C@@H](NC(=O)c5cc6cc(C(F)(F)P(=O)(O)O)ccc6s5)C4)cccc3C2=O)C(=O)N1] | ((2-(((5S,8S,10aR)-3-(8-(2-(2,6-dioxopiperidin-3-yl)-1- oxoisoindolin-4-yl)oct-7-ynoyl)-6-oxo-8-((S)-3- phenylpyrrolidine-1-carbonyl)decahydropyrrolo[1,2- a][1,5]diazocin-5-yl)carbamoyl)benzo[b]thiophen-5- yl)difluoromethyl)phosphonic acid |
| 564 | 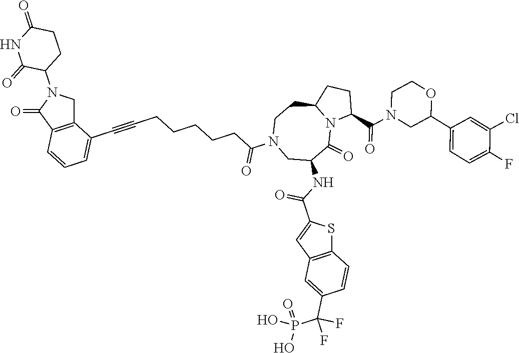 [SMILES: O=C1CCC(N2Cc3c(C#CCCCCCC(=O)N4CC[C@H]5CC[C@@H](C(=O)N6CCOC(c7ccc(F)c(Cl)c7)C6)N5C(=O)[C@@H](NC(=O)c5cc6cc(C(F)(F)P(=O)(O)O)ccc6s5)C4)cccc3C2=O)C(=O)N1] | ((2-(((5S,8S,10aR)-8-(2-(3-chloro-4-fluorophenyl)morpholine- 4-carbonyl)-3-(8-(2-(2,6-dioxopiperidin-3-yl)-1-oxoisoindolin- 4-yl)oct-7-ynoyl)-6-oxodecahydropyrrolo[1,2-a][1,5]diazocin- 5-yl)carbamoyl)benzo[b]thiophen-5- yl)difluoromethyl)phosphonic acid |
| 565 | 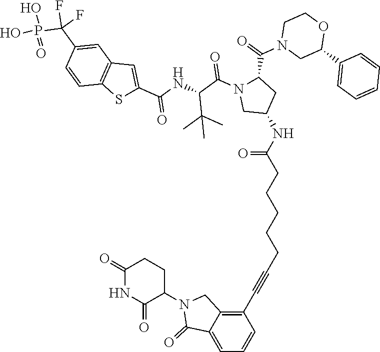 [SMILES: CC(C)(C)[C@H](NC(=O)c1cc2cc(C(F)(F)P(=O)(O)O)ccc2s1)C(=O)N1C[C@@H](NC(=O)CCCCCC#Cc2cccc3c2CN(C2CCC(=O)NC2=O)C3=O)C[C@H]1C(=O)N1CCO[C@H](c2ccccc2)C1] | ((2-(((2S)-1-((2S,4S)-4-(8-(2-(2,6-dioxopiperidin-3-yl)-1- oxoisoindolin-4-yl)oct-7-ynamido)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 566 | 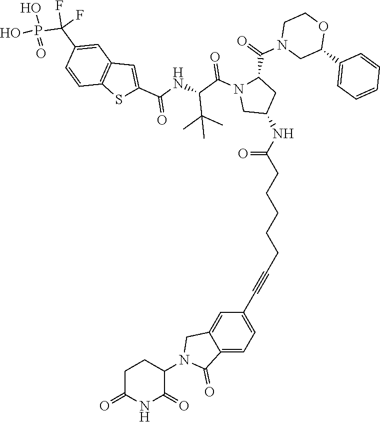 [SMILES: CC(C)(C)[C@H](NC(=O)c1cc2cc(C(F)(F)P(=O)(O)O)ccc2s1)C(=O)N1C[C@@H](NC(=O)CCCCCC#Cc2ccc3c(c2)CN(C2CCC(=O)NC2=O)C3=O)C[C@H]1C(=O)N1CCO[C@H](c2ccccc2)C1] | ((2-(((2S)-1-((2S,4S)-4-(8-(2-(2,6-dioxopiperidin-3-yl)-1- oxoisoindolin-5-yl)oct-7-ynamido)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 567 | 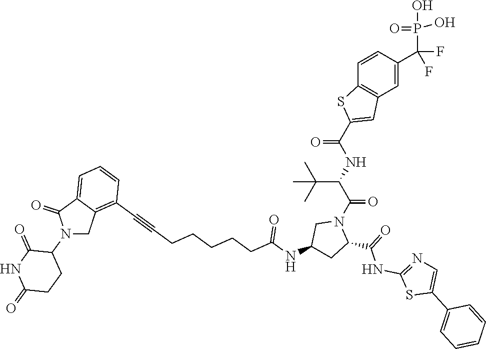 [SMILES: CC(C)(C)[C@H](NC(=O)c1cc2cc(C(F)(F)P(=O)(O)O)ccc2s1)C(=O)N1C[C@H](NC(=O)CCCCCC#Cc2cccc3c2CN(C2CCC(=O)NC2=O)C3=O)C[C@H]1C(=O)Nc1ncc(-c2ccccc2)s1] | ((2-(((2S)-1-((2S,4R)-4-(8-(2-(2,6-dioxopiperidin-3-yl)-1- oxoisoindolin-4-yl)oct-7-ynamido)-2-((5-phenylthiazol-2- yl)carbamoyl)pyrrolidin-1-yl)-3,3-dimethyl-1-oxobutan-2- yl)carbamoyl)benzo[b]thiophen-5- yl)difluoromethyl)phosphonic acid |
| 568 | 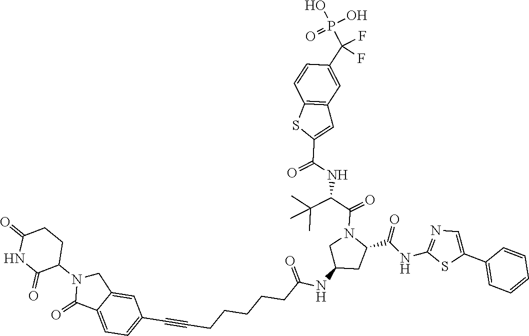 [SMILES: CC(C)(C)[C@H](NC(=O)c1cc2cc(C(F)(F)P(=O)(O)O)ccc2s1)C(=O)N1C[C@H](NC(=O)CCCCCC#Cc2ccc3c(c2)CN(C2CCC(=O)NC2=O)C3=O)C[C@H]1C(=O)Nc1ncc(-c2ccccc2)s1] | ((2-(((2S)-1-((2S,4R)-4-(8-(2-(2,6-dioxopiperidin-3-yl)-1- oxoisoindolin-5-yl)oct-7-ynamido)-2-((5-phenylthiazol-2- yl)carbamoyl)pyrrolidin-1-yl)-3,3-dimethyl-1-oxobutan-2- yl)carbamoyl)benzo[b]thiophen-5- yl)difluoromethyl)phosphonic acid |
| 569 | 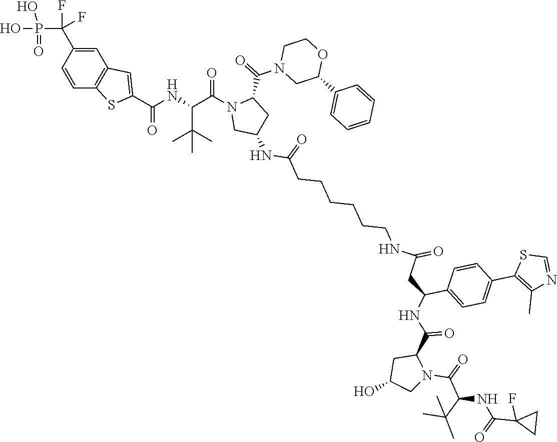 [SMILES: Cc1ncsc1-c1ccc([C@H](CC(=O)NCCCCCCC(=O)N[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4S)-4-(7-((S)-3-((2S,4R)-1-((S)-2-(1- fluorocyclopropane-1-carboxamido)-3,3-dimethylbutanoyl)-4- hydroxypyrrolidine-2-carboxamido)-3-(4-(4-methylthiazol-5- yl)phenyl)propanamido)heptanamido)-2-((R)-2- phenylmorpholine-4-carbonyl)pyrrolidin-1-yl)-3,3-dimethyl-1- oxobutan-2-yl)carbamoyl)benzo[b]thiophen-5- yl)methyl)phosphonic acid |
| 570 | 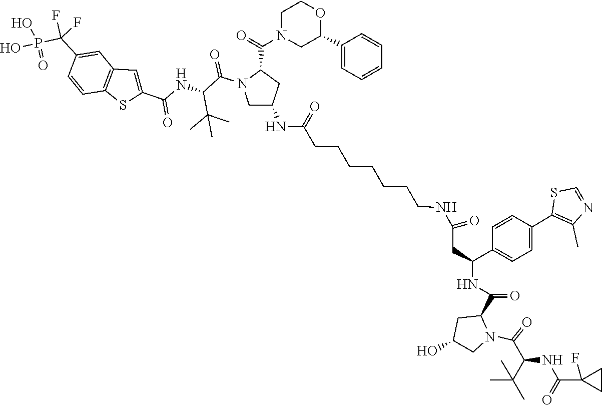 [SMILES: Cc1ncsc1-c1ccc([C@H](CC(=O)NCCCCCCCC(=O)N[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4S)-4-(8-((S)-3-((2S,4R)-1-((S)-2-(1- fluorocyclopropane-1-carboxamido)-3,3-dimethylbutanoyl)-4- hydroxypyrrolidine-2-carboxamido)-3-(4-(4-methylthiazol-5- yl)phenyl)propanamido)octanamido)-2-((R)-2- phenylmorpholine-4-carbonyl)pyrrolidin-1-yl)-3,3-dimethyl-1- oxobutan-2-yl)carbamoyl)benzo[b]thiophen-5- yl)methyl)phosphonic acid |
| 571 | 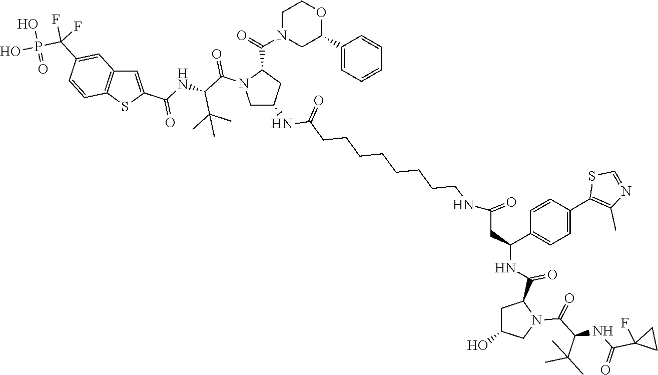 [SMILES: Cc1ncsc1-c1ccc([C@H](CC(=O)NCCCCCCCCC(=O)N[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4S)-4-(9-((S)-3-((2S,4R)-1-((S)-2-(1- fluorocyclopropane-1-carboxamido)-3,3-dimethylbutanoyl)-4- hydroxypyrrolidine-2-carboxamido)-3-(4-(4-methylthiazol-5- yl)phenyl)propanamido)nonanamido)-2-((R)-2- phenylmorpholine-4-carbonyl)pyrrolidin-1-yl)-3,3-dimethyl-1- oxobutan-2-yl)carbamoyl)benzo[b]thiophen-5- yl)methyl)phosphonic acid |
| 572 | 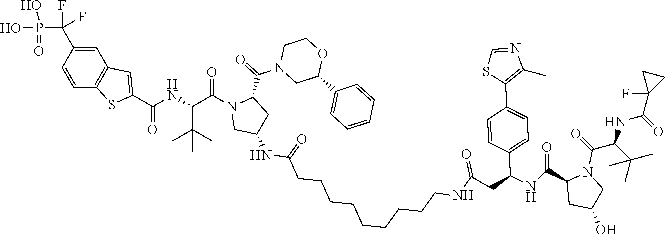 [SMILES: Cc1ncsc1-c1ccc([C@H](CC(=O)NCCCCCCCCCC(=O)N[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4S)-4-(10-((S)-3-((2S,4R)-1-((S)-2-(1- fluorocyclopropane-1-carboxamido)-3,3-dimethylbutanoyl)-4- hydroxypyrrolidine-2-carboxamido)-3-(4-(4-methylthiazol-5- yl)phenyl)propanamido)decanamido)-2-((R)-2- phenylmorpholine-4-carbonyl)pyrrolidin-1-yl)-3,3-dimethyl-1- oxobutan-2-yl)carbamoyl)benzo[b]thiophen-5- yl)methyl)phosphonic acid |
| 573 | 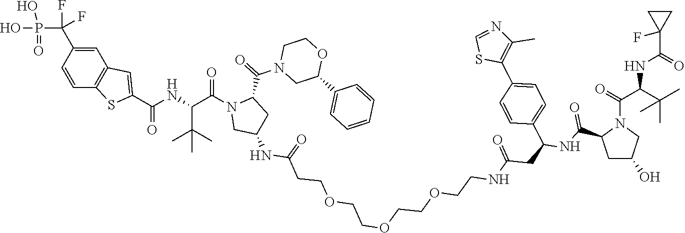 [SMILES: Cc1ncsc1-c1ccc([C@H](CC(=O)NCCOCCOCCOCCC(=O)N[C@H]2C[C@@H](C(=O)N3CCO[C@H](c4ccccc4)C3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4S)-4-((S)-1-((2S,4R)-1-((S)-2-(1- fluorocyclopropane-1-carboxamido)-3,3-dimethylbutanoyl)-4- hydroxypyrrolidin-2-yl)-3-(4-(4-methylthiazol-5-yl)phenyl)- 1,5-dioxo-9,12,15-trioxa-2,6-diazaoctadecan-18-amido)-2-((R)- 2-phenylmorpholine-4-carbonyl)pyrrolidin-1-yl)-3,3-dimethyl- 1-oxobutan-2-yl)carbamoyl)benzo[b]thiophen-5- yl)methyl)phosphonic acid |
| 574 | 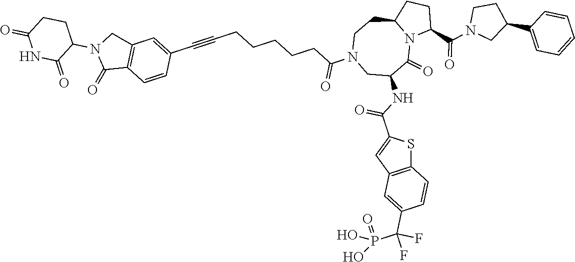 [SMILES: O=C1CCC(N2Cc3cc(C#CCCCCCC(=O)N4CC[C@H]5CC[C@@H](C(=O)N6CC[C@@H](c7ccccc7)C6)N5C(=O)[C@@H](NC(=O)c5cc6cc(C(F)(F)P(=O)(O)O)ccc6s5)C4)ccc3C2=O)C(=O)N1] | ((2-(((5S,8S,10aR)-3-(8-(2-(2,6-dioxopiperidin-3-yl)-1- oxoisoindolin-5-yl)oct-7-ynoyl)-6-oxo-8-((S)-3- phenylpyrrolidine-1-carbonyl)decahydropyrrolo[1,2- a][1,5]diazocin-5-yl)carbamoyl)benzo[b]thiophen-5- yl)difluoromethyl)phosphonic acid |
| 575 | 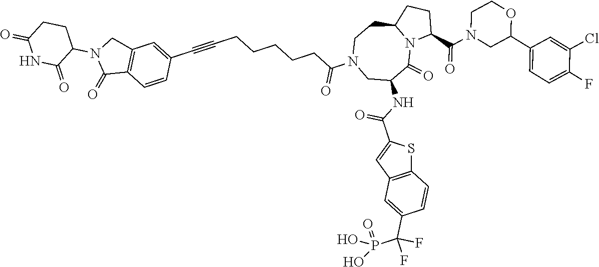 [SMILES: O=C1CCC(N2Cc3cc(C#CCCCCCC(=O)N4CC[C@H]5CC[C@@H](C(=O)N6CCOC(c7ccc(F)c(Cl)c7)C6)N5C(=O)[C@@H](NC(=O)c5cc6cc(C(F)(F)P(=O)(O)O)ccc6s5)C4)ccc3C2=O)C(=O)N1] | ((2-(((5S,8S,10aR)-8-(2-(3-chloro-4-fluorophenyl)morpholine- 4-carbonyl)-3-(8-(2-(2,6-dioxopiperidin-3-yl)-1-oxoisoindolin- 5-yl)oct-7-ynoyl)-6-oxodecahydropyrrolo[1,2-a][1,5]diazocin- 5-yl)carbamoyl)benzo[b]thiophen-5- yl)difluoromethyl)phosphonic acid |
| 576 | 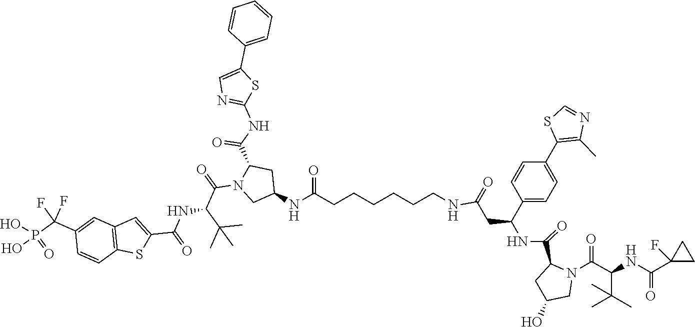 [SMILES: Cc1ncsc1-c1ccc([C@H](CC(=O)NCCCCCCC(=O)N[C@@H]2C[C@@H](C(=O)Nc3ncc(-c4ccccc4)s3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4R)-4-(7-((S)-3-((2S,4R)-1-((S)-2-(1- fluorocyclopropane-1-carboxamido)-3,3-dimethylbutanoyl)-4- hydroxypyrrolidine-2-carboxamido)-3-(4-(4-methylthiazol-5- yl)phenyl)propanamido)heptanamido)-2-((5-phenylthiazol-2- yl)carbamoyl)pyrrolidin-1-yl)-3,3-dimethyl-1-oxobutan-2- yl)carbamoyl)benzo[b]thiophen-5-yl)methyl)phosphonic acid |
| 577 | 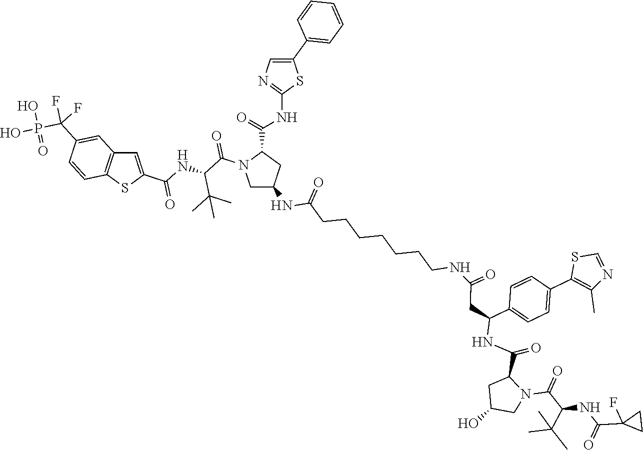 [SMILES: Cc1ncsc1-c1ccc([C@H](CC(=O)NCCCCCCCC(=O)N[C@@H]2C[C@@H](C(=O)Nc3ncc(-c4ccccc4)s3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4R)-4-(8-((S)-3-((2S,4R)-1-((S)-2-(1- fluorocyclopropane-1-carboxamido)-3,3-dimethylbutanoyl)-4- hydroxypyrrolidine-2-carboxamido)-3-(4-(4-methylthiazol-5- yl)phenyl)propanamido)octanamido)-2-((5-phenylthiazol-2- yl)carbamoyl)pyrrolidin-1-yl)-3,3-dimethyl-1-oxobutan-2- yl)carbamoyl)benzo[b]thiophen-5-yl)methyl)phosphonic acid |
| 578 | 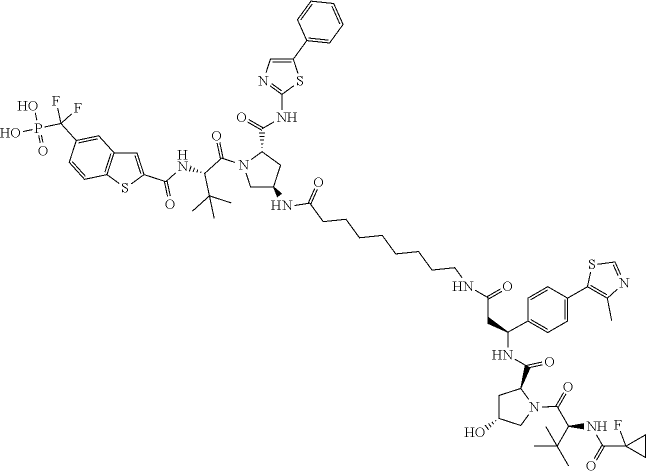 [SMILES: Cc1ncsc1-c1ccc([C@H](CC(=O)NCCCCCCCCC(=O)N[C@@H]2C[C@@H](C(=O)Nc3ncc(-c4ccccc4)s3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4R)-4-(9-((S)-3-((2S,4R)-1-((S)-2-(1- fluorocyclopropane-1-carboxamido)-3,3-dimethylbutanoyl)-4- hydroxypyrrolidine-2-carboxamido)-3-(4-(4-methylthiazol-5- yl)phenyl)propanamido)nonanamido)-2-((5-phenylthiazol-2- yl)carbamoyl)pyrrolidin-1-yl)-3,3-dimethyl-1-oxobutan-2- yl)carbamoyl)benzo[b]thiophen-5-yl)methyl)phosphonic acid |
| 579 | 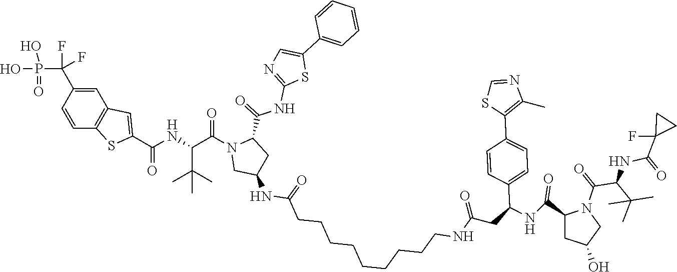 [SMILES: Cc1ncsc1-c1ccc([C@H](CC(=O)NCCCCCCCCCC(=O)N[C@@H]2C[C@@H](C(=O)Nc3ncc(-c4ccccc4)s3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4R)-4-(10-((S)-3-((2S,4R)-1-((S)-2-(1- fluorocyclopropane-1-carboxamido)-3,3-dimethylbutanoyl)-4- hydroxypyrrolidine-2-carboxamido)-3-(4-(4-methylthiazol-5- yl)phenyl)propanamido)decanamido)-2-((5-phenylthiazol-2- yl)carbamoyl)pyrrolidin-1-yl)-3,3-dimethyl-1-oxobutan-2- yl)carbamoyl)benzo[b]thiophen-5-yl)methyl)phosphonic acid |
| 580 | 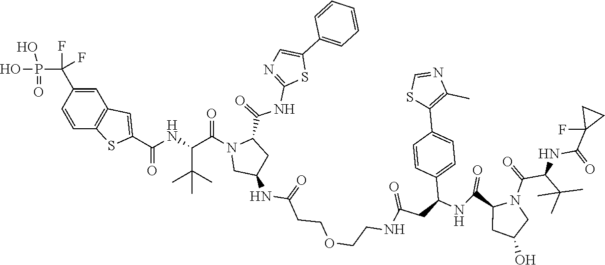 [SMILES: Cc1ncsc1-c1ccc([C@H](CC(=O)NCCOCCC(=O)N[C@@H]2C[C@@H](C(=O)Nc3ncc(-c4ccccc4)s3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4R)-4-(3-(2-((S)-3-((2S,4R)-1-((S)-2- (1-fluorocyclopropane-1-carboxamido)-3,3-dimethylbutanoyl)- 4-hydroxypyrrolidine-2-carboxamido)-3-(4-(4-methylthiazol-5- yl)phenyl)propanamido)ethoxy)propanamido)-2-((5- phenylthiazol-2-yl)carbamoyl)pyrrolidin-1-yl)-3,3-dimethyl-1- oxobutan-2-yl)carbamoyl)benzo[b]thiophen-5- yl)methyl)phosphonic acid |
| 581 | 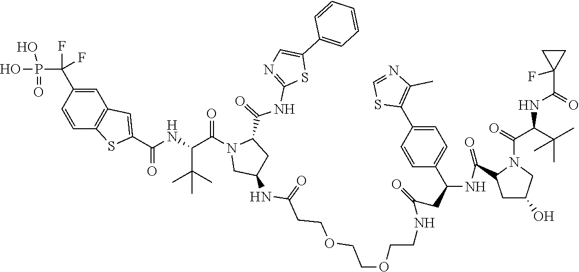 | (difluoro(2-(((S)-1-((2S,4R)-4-((S)-1-((2S,4R)-1-((S)-2-(1- fluorocyclopropane-1-carboxamido)-3,3-dimethylbutanoyl)-4- hydroxypyrrolidin-2-yl)-3-(4-(4-methylthiazol-5-yl)phenyl)- 1,5-dioxo-9,12-dioxa-2,6-diazapentadecan-15-amido)-2-((5- phenylthiazol-2-yl)carbamoyl)pyrrolidin-1-yl)-3,3-dimethyl-1- oxobutan-2-yl)carbamoyl)benzo[b]thiophen-5- yl)methyl)phosphonic acid |
| 582 | 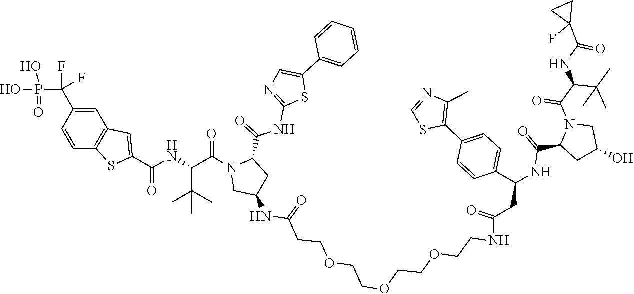 [SMILES: Cc1ncsc1-c1ccc([C@H](CC(=O)NCCOCCOCCOCCC(=O)N[C@@H]2C[C@@H](C(=O)Nc3ncc(-c4ccccc4)s3)N(C(=O)[C@@H](NC(=O)c3cc4cc(C(F)(F)P(=O)(O)O)ccc4s3)C(C)(C)C)C2)NC(=O)[C@@H]2C[C@@H](O)CN2C(=O)[C@@H](NC(=O)C2(F)CC2)C(C)(C)C)cc1] | (difluoro(2-(((S)-1-((2S,4R)-4-((S)-1-((2S,4R)-1-((S)-2-(1- fluorocyclopropane-1-carboxamido)-3,3-dimethylbutanoyl)-4- hydroxypyrrolidin-2-yl)-3-(4-(4-methylthiazol-5-yl)phenyl)- 1,5-dioxo-9,12,15-trioxa-2,6-diazaoctadecan-18-amido)-2-((5- phenylthiazol-2-yl)carbamoyl)pyrrolidin-1-yl)-3,3-dimethyl-1- oxobutan-2-yl)carbamoyl)benzo[b]thiophen-5- yl)methyl)phosphonic acid |
| 583 | 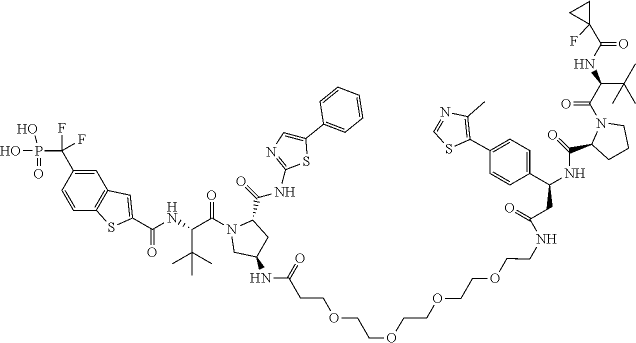 [SMILES: Cc1ncsc1-c1ccc([C@H](CC(=O)NCCOCCOCCOCCOCCC(=O)N[C@@H]2C[C@@H](C(=O)Nc3ncc(-c4ccccc4)s3)N(C(=O)[C@@H](NC(=O)c3cc4cc(C(F)(F)P(=O)(O)O)ccc4s3)C(C)(C)C)C2)NC(=O)[C@@H]2CCCN2C(=O)[C@@H](NC(=O)C2(F)CC2)C(C)(C)C)cc1] | (difluoro(2-(((S)-1-((2S,4R)-4-((S)-1-((2S,4R)-1-((S)-2-(1- fluorocyclopropane-1-carboxamido)-3,3-dimethylbutanoyl)-4- hydroxypyrrolidin-2-yl)-3-(4-(4-methylthiazol-5-yl)phenyl)- 1,5-dioxo-9,12,15,18-tetraoxa-2,6-diazahenicosan-21-amido)- 2-((5-phenylthiazol-2-yl)carbamoyl)pyrrolidin-1-yl)-3,3- dimethyl-1-oxobutan-2-yl)carbamoyl)benzo[b]thiophen-5- yl)methyl)phosphonic acid |
| 584 | 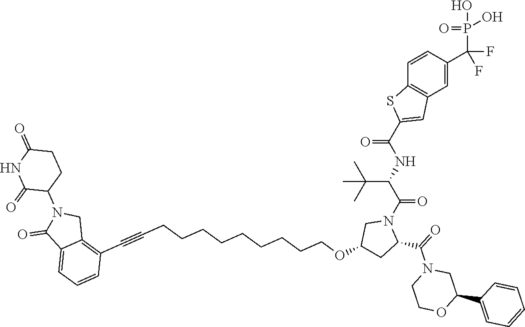 [SMILES: CC(C)(C)[C@H](NC(=O)c1cc2cc(C(F)(F)P(=O)(O)O)ccc2s1)C(=O)N1C[C@@H](OCCCCCCCCCC#Cc2cccc3c2CN(C2CCC(=O)NC2=O)C3=O)C[C@H]1C(=O)N1CCO[C@H](c2ccccc2)C1] | ((2-(((2S)-1-((2S,4S)-4-((11-(2-(2,6-dioxopiperidin-3-yl)-1- oxoisoindolin-4-yl)undec-10-yn-1-yl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 585 | 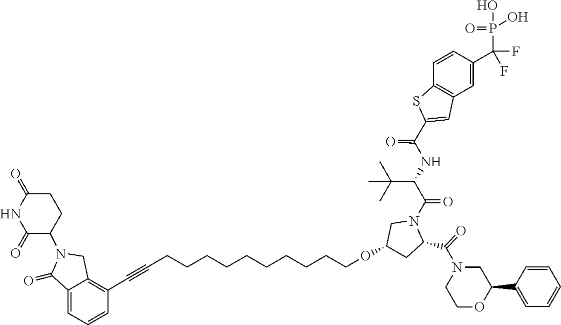 [SMILES: CC(C)(C)[C@H](NC(=O)c1cc2cc(C(F)(F)P(=O)(O)O)ccc2s1)C(=O)N1C[C@@H](OCCCCCCCCCCC#Cc2cccc3c2CN(C2CCC(=O)NC2=O)C3=O)C[C@H]1C(=O)N1CCO[C@H](c2ccccc2)C1] | ((2-(((2S)-1-((2S,4S)-4-((12-(2-(2,6-dioxopiperidin-3-yl)-1- oxoisoindolin-4-yl)dodec-11-yn-1-yl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 586 | 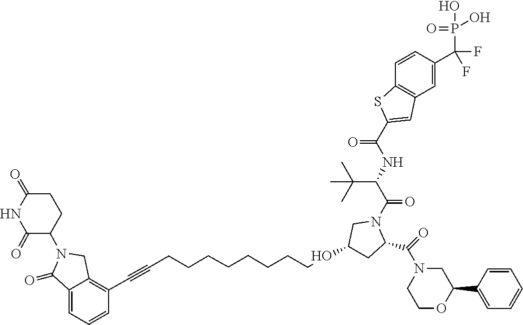 [SMILES: CC(C)(C)[C@H](NC(=O)c1cc2cc(C(F)(F)P(=O)(O)O)ccc2s1)C(=O)N1C[C@@H](OCCCCCCCCC#Cc2cccc3c2CN(C2CCC(=O)NC2=O)C3=O)C[C@H]1C(=O)N1CCO[C@H](c2ccccc2)C1] | ((2-(((2S)-1-((2S,4S)-4-((10-(2-(2,6-dioxopiperidin-3-yl)-1- oxoisoindolin-4-yl)dec-9-yn-1-yl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 587 | 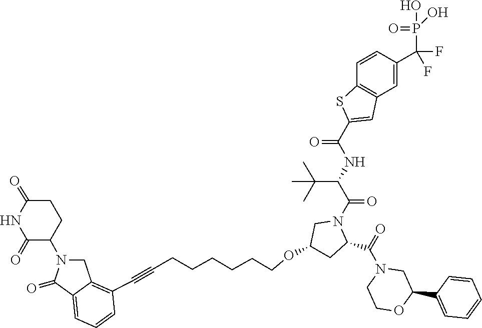 | ((2-(((2S)-1-((2S,4S)-4-((8-(2-(2,6-dioxopiperidin-3-yl)-1- oxoisoindolin-4-yl)oct-7-yn-1-yl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 588 | 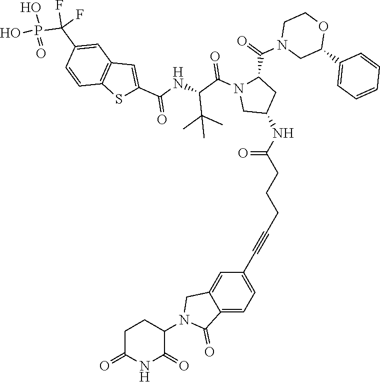 [SMILES: CC(C)(C)[C@H](NC(=O)c1cc2cc(C(F)(F)P(=O)(O)O)ccc2s1)C(=O)N1C[C@@H](NC(=O)CCCC#Cc2ccc3c(c2)CN(C2CCC(=O)NC2=O)C3=O)C[C@H]1C(=O)N1CCO[C@H](c2ccccc2)C1] | ((2-(((2S)-1-((2S,4S)-4-(6-(2-(2,6-dioxopiperidin-3-yl)-1- oxoisoindolin-5-yl)hex-5-ynamido)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 589 | 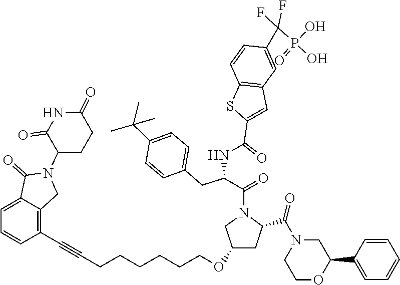 [SMILES: CC(C)(C)c1ccc(C[C@H](NC(=O)c2cc3cc(C(F)(F)P(=O)(O)O)ccc3s2)C(=O)N2C[C@@H](OCCCCCCC#Cc3cccc4c3CN(C3CCC(=O)NC3=O)C4=O)C[C@H]2C(=O)N2CCO[C@H](c3ccccc3)C2)cc1] | ((2-(((2S)-3-(4-(tert-butyl)phenyl)-1-((2S,4S)-4-((8-(2-(2,6- dioxopiperidin-3-yl)-1-oxoisoindolin-4-yl)oct-7-yn-1-yl)oxy)- 2-((R)-2-phenylmorpholine-4-carbonyl)pyrrolidin-1-yl)-1- oxopropan-2-yl)carbamoyl)benzo[b]thiophen-5- yl)difluoromethyl)phosphonic acid |
| 590 | 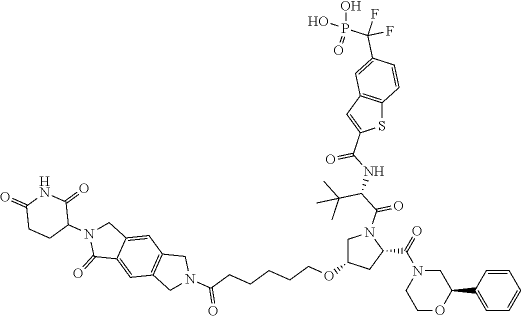 [SMILES: CC(C)(C)[C@H](NC(=O)c1cc2cc(C(F)(F)P(=O)(O)O)ccc2s1)C(=O)N1C[C@@H](OCCCCCC(=O)N2Cc3cc4c(cc3C2)C(=O)N(C2CCC(=O)NC2=O)C4)C[C@H]1C(=O)N1CCO[C@H](c2ccccc2)C1] | ((2-(((2S)-1-((2S,4S)-4-((6-(6-(2,6-dioxopiperidin-3-yl)-5-oxo- 3,5,6,7-tetrahydropyrrolo[3,4-f]isoindol-2(1H)-yl)-6- oxohexyl)oxy)-2-((R)-2-phenylmorpholine-4- carbonyl)pyrrolidin-1-yl)-3,3-dimethyl-1-oxobutan-2- yl)carbamoyl)benzo[b]thiophen-5- yl)difluoromethyl)phosphonic acid |
| 591 | 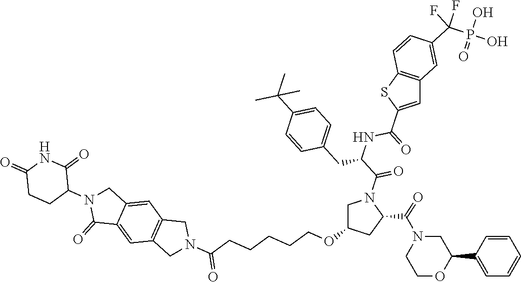 [SMILES: CC(C)(C)c1ccc(C[C@H](NC(=O)c2cc3cc(C(F)(F)P(=O)(O)O)ccc3s2)C(=O)N2C[C@@H](OCCCCCC(=O)N3Cc4cc5c(cc4C3)C(=O)N(C3CCC(=O)NC3=O)C5)C[C@H]2C(=O)N2CCO[C@H](c3ccccc3)C2)cc1] | ((2-(((2S)-3-(4-(tert-butyl)phenyl)-1-((2S,4S)-4-((6-(6-(2,6- dioxopiperidin-3-yl)-5-oxo-3,5,6,7-tetrahydropyrrolo[3,4- f]isoindol-2(1H)-yl)-6-oxohexyl)oxy)-2-((R)-2- phenylmorpholine-4-carbonyl)pyrrolidin-1-yl)-1-oxopropan-2- yl)carbamoyl)benzo[b]thiophen-5- yl)difluoromethyl)phosphonic acid |
| 592 | 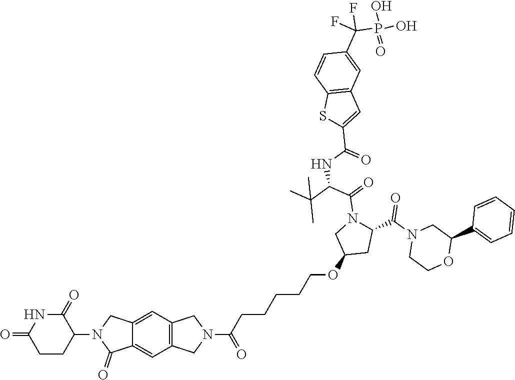 [SMILES: CC(C)(C)[C@H](NC(=O)c1cc2cc(C(F)(F)P(=O)(O)O)ccc2s1)C(=O)N1C[C@H](OCCCCCC(=O)N2Cc3cc4c(cc3C2)C(=O)N(C2CCC(=O)NC2=O)C4)C[C@H]1C(=O)N1CCO[C@H](c2ccccc2)C1] | ((2-(((2S)-1-((2S,4R)-4-((6-(6-(2,6-dioxopiperidin-3-yl)-5-oxo- 3,5,6,7-tetrahydropyrrolo[3,4-f]isoindol-2(1H)-yl)-6- oxohexyl)oxy)-2-((R)-2-phenylmorpholine-4- carbonyl)pyrrolidin-1-yl)-3,3-dimethyl-1-oxobutan-2- yl)carbamoyl)benzo[b]thiophen-5- yl)difluoromethyl)phosphonic acid |
| 593 | 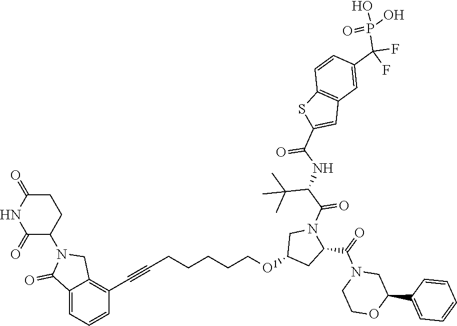 | ((2-(((2S)-1-((2S,4S)-4-((7-(2-(2,6-dioxopiperidin-3-yl)-1- oxoisoindolin-4-yl)hept-6-yn-1-yl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 594 | 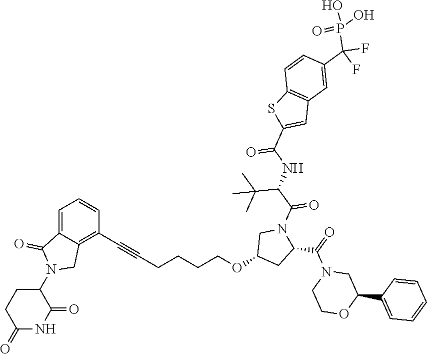 [SMILES: CC(C)(C)[C@H](NC(=O)c1cc2cc(C(F)(F)P(=O)(O)O)ccc2s1)C(=O)N1C[C@@H](OCCCCC#Cc2cccc3c2CN(C2CCC(=O)NC2=O)C3=O)C[C@H]1C(=O)N1CCO[C@H](c2ccccc2)C1] | ((2-(((2S)-1-((2S,4S)-4-((6-(2-(2,6-dioxopiperidin-3-yl)-1- oxoisoindolin-4-yl)hex-5-yn-1-yl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 595 | 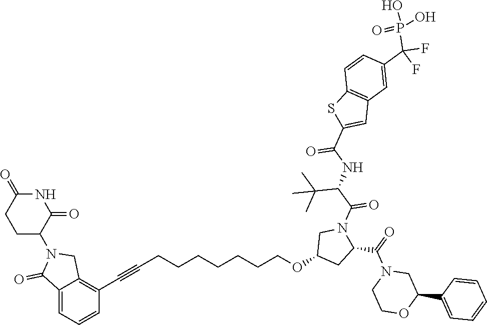 [SMILES: CC(C)(C)[C@H](NC(=O)c1cc2cc(C(F)(F)P(=O)(O)O)ccc2s1)C(=O)N1C[C@@H](OCCCCCCCC#Cc2cccc3c2CN(C2CCC(=O)NC2=O)C3=O)C[C@H]1C(=O)N1CCO[C@H](c2ccccc2)C1] | ((2-(((2S)-1-((2S,4S)-4-((9-(2-(2,6-dioxopiperidin-3-yl)-1- oxoisoindolin-4-yl)non-8-yn-1-yl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 596 | 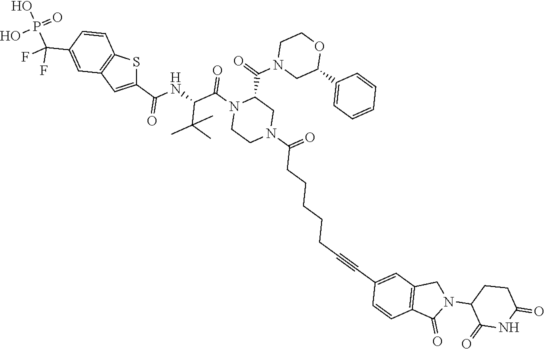 [SMILES: CC(C)(C)[C@H](NC(=O)c1cc2cc(C(F)(F)P(=O)(O)O)ccc2s1)C(=O)N1CCN(C(=O)CCCCCC#Cc2ccc3c(c2)CN(C2CCC(=O)NC2=O)C3=O)C[C@H]1C(=O)N1CCO[C@H](c2ccccc2)C1] | ((2-(((2S)-1-((2S)-4-(8-(2-(2,6-dioxopiperidin-3-yl)-1- oxoisoindolin-5-yl)oct-7-ynoyl)-2-((R)-2-phenylmorpholine-4- carbonyl)piperazin-1-yl)-3,3-dimethyl-1-oxobutan-2- yl)carbamoyl)benzo[b]thiophen-5- yl)difluoromethyl)phosphonic acid |
| 597 | 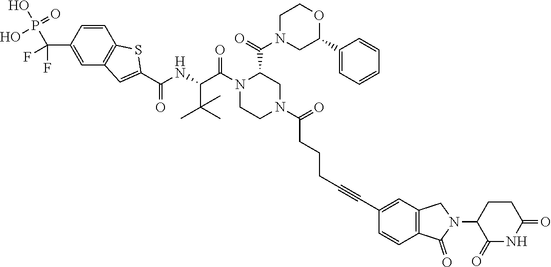 [SMILES: CC(C)(C)[C@H](NC(=O)c1cc2cc(C(F)(F)P(=O)(O)O)ccc2s1)C(=O)N1CCN(C(=O)CCCC#Cc2ccc3c(c2)CN(C2CCC(=O)NC2=O)C3=O)C[C@H]1C(=O)N1CCO[C@H](c2ccccc2)C1] | ((2-(((2S)-1-((2S)-4-(6-(2-(2,6-dioxopiperidin-3-yl)-1- oxoisoindolin-5-yl)hex-5-ynoyl)-2-((R)-2-phenylmorpholine-4- carbonyl)piperazin-1-yl)-3,3-dimethyl-1-oxobutan-2- yl)carbamoyl)benzo[b]thiophen-5- yl)difluoromethyl)phosphonic acid |
| 598 | 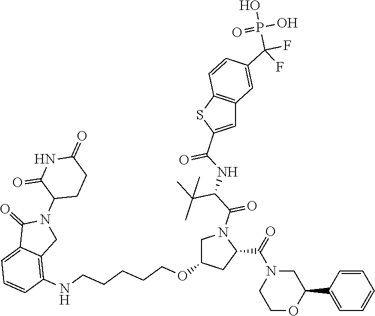 [SMILES: CC(C)(C)[C@H](NC(=O)c1cc2cc(C(F)(F)P(=O)(O)O)ccc2s1)C(=O)N1C[C@@H](OCCCCCNc2cccc3c2CN(C2CCC(=O)NC2=O)C3=O)C[C@H]1C(=O)N1CCO[C@H](c2ccccc2)C1] | ((2-(((2S)-1-((2S,4S)-4-((5-((2-(2,6-dioxopiperidin-3-yl)-1- oxoisoindolin-4-yl)amino)pentyl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 599 | 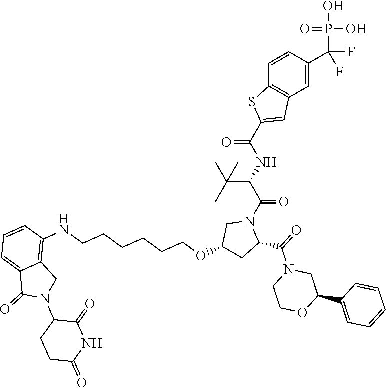 | ((2-(((2S)-1-((2S,4S)-4-((6-((2-(2,6-dioxopiperidin-3-yl)-1- oxoisoindolin-4-yl)amino)hexyl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 600 | 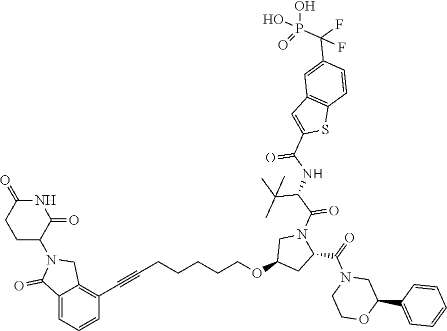 [SMILES: CC(C)(C)[C@H](NC(=O)c1cc2cc(C(F)(F)P(=O)(O)O)ccc2s1)C(=O)N1C[C@H](OCCCCCC#Cc2cccc3c2CN(C2CCC(=O)NC2=O)C3=O)C[C@H]1C(=O)N1CCO[C@H](c2ccccc2)C1] | ((2-(((2S)-1-((2S,4R)-4-((7-(2-(2,6-dioxopiperidin-3-yl)-1- oxoisoindolin-4-yl)hept-6-yn-1-yl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 601 | 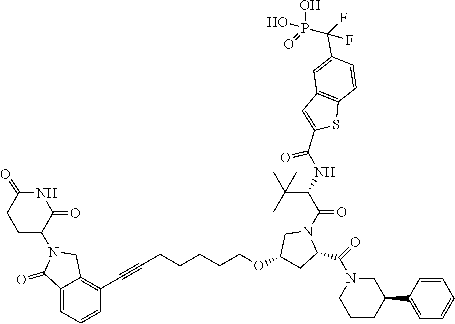 [SMILES: CC(C)(C)[C@H](NC(=O)c1cc2cc(C(F)(F)P(=O)(O)O)ccc2s1)C(=O)N1C[C@@H](OCCCCCC#Cc2cccc3c2CN(C2CCC(=O)NC2=O)C3=O)C[C@H]1C(=O)N1CCC[C@H](c2ccccc2)C1] | ((2-(((2S)-1-((2S,4S)-4-((7-(2-(2,6-dioxopiperidin-3-yl)-1- oxoisoindolin-4-yl)hept-6-yn-1-yl)oxy)-2-((R)-3- phenylpiperidine-1-carbonyl)pyrrolidin-1-yl)-3,3-dimethyl-1- oxobutan-2-yl)carbamoyl)benzo[b]thiophen-5- yl)difluoromethyl)phosphonic acid |
| 602 | 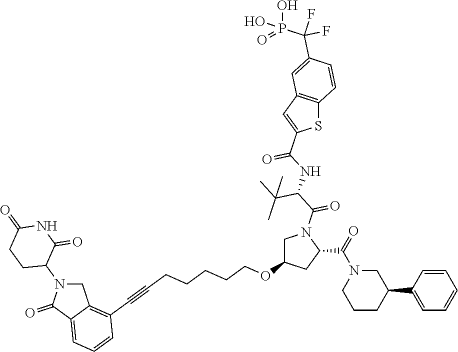 [SMILES: CC(C)(C)[C@H](NC(=O)c1cc2cc(C(F)(F)P(=O)(O)O)ccc2s1)C(=O)N1C[C@H](OCCCCCC#Cc2cccc3c2CN(C2CCC(=O)NC2=O)C3=O)C[C@H]1C(=O)N1CCC[C@H](c2ccccc2)C1] | ((2-(((2S)-1-((2S,4R)-4-((7-(2-(2,6-dioxopiperidin-3-yl)-1- oxoisoindolin-4-yl)hept-6-yn-1-yl)oxy)-2-((R)-3- phenylpiperidine-1-carbonyl)pyrrolidin-1-yl)-3,3-dimethyl-1- oxobutan-2-yl)carbamoyl)benzo[b]thiophen-5- yl)difluoromethyl)phosphonic acid |
| 603 | 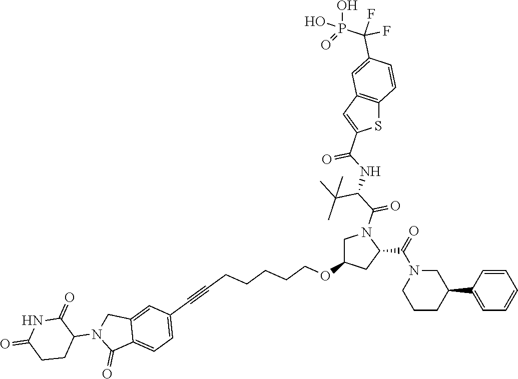 [SMILES: CC(C)(C)[C@H](NC(=O)c1cc2cc(C(F)(F)P(=O)(O)O)ccc2s1)C(=O)N1C[C@H](OCCCCCC#Cc2ccc3c(c2)CN(C2CCC(=O)NC2=O)C3=O)C[C@H]1C(=O)N1CCC[C@H](c2ccccc2)C1] | ((2-(((2S)-1-((2S,4R)-4-((7-(2-(2,6-dioxopiperidin-3-yl)-1- oxoisoindolin-5-yl)hept-6-yn-1-yl)oxy)-2-((R)-3- phenylpiperidine-1-carbonyl)pyrrolidin-1-yl)-3,3-dimethyl-1- oxobutan-2-yl)carbamoyl)benzo[b]thiophen-5- yl)difluoromethyl)phosphonic acid |
| 604 | 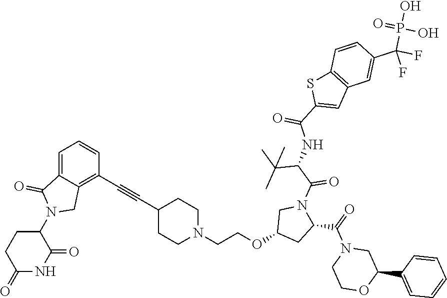 [SMILES: CC(C)(C)[C@H](NC(=O)c1cc2cc(C(F)(F)P(=O)(O)O)ccc2s1)C(=O)N1C[C@@H](OCCN2CCC(C#Cc3cccc4c3CN(C3CCC(=O)NC3=O)C4=O)CC2)C[C@H]1C(=O)N1CCO[C@H](c2ccccc2)C1] | ((2-(((2S)-1-((2S,4S)-4-(2-(4-((2-(2,6-dioxopiperidin-3-yl)-1- oxoisoindolin-4-yl)ethynyl)piperidin-1-yl)ethoxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 605 | 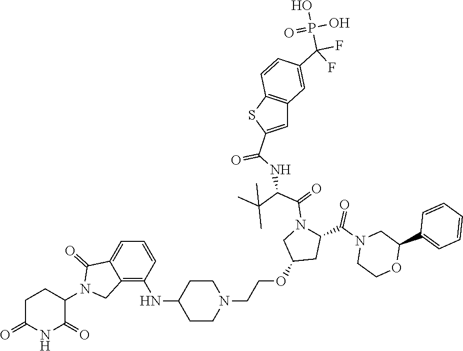 [SMILES: CC(C)(C)[C@H](NC(=O)c1cc2cc(C(F)(F)P(=O)(O)O)ccc2s1)C(=O)N1C[C@@H](OCCN2CCC(Nc3cccc4c3CN(C3CCC(=O)NC3=O)C4=O)CC2)C[C@H]1C(=O)N1CCO[C@H](c2ccccc2)C1] | ((2-(((2S)-1-((2S,4S)-4-(2-(4-((2-(2,6-dioxopiperidin-3-yl)-1- oxoisoindolin-4-yl)amino)piperidin-1-yl)ethoxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)phosphonic acid |
| 606 | 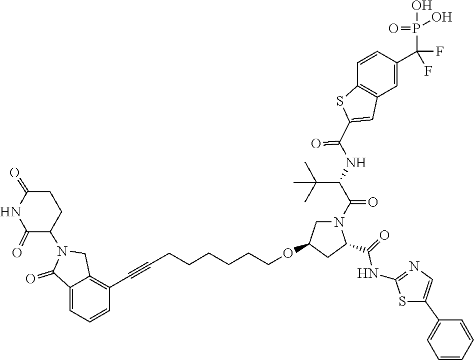 [SMILES: CC(C)(C)[C@H](NC(=O)c1cc2cc(C(F)(F)P(=O)(O)O)ccc2s1)C(=O)N1C[C@H](OCCCCCCC#Cc2cccc3c2CN(C2CCC(=O)NC2=O)C3=O)C[C@H]1C(=O)Nc1ncc(-c2ccccc2)s1] | ((2-(((2S)-1-((2S,4R)-4-((8-(2-(2,6-dioxopiperidin-3-yl)-1- oxoisoindolin-4-yl)oct-7-yn-1-yl)oxy)-2-((5-phenylthiazol-2- yl)carbamoyl)pyrrolidin-1-yl)-3,3-dimethyl-1-oxobutan-2- yl)carbamoyl)benzo[b]thiophen-5- yl)difluoromethyl)phosphonic acid |
| 607 | 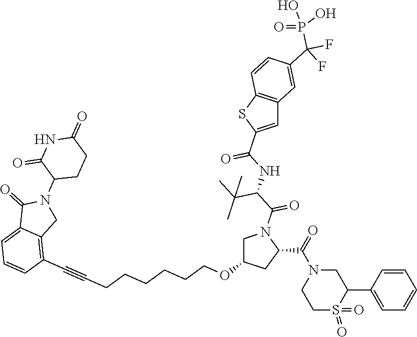 | ((2-(((2S)-1-((2S,4S)-2-(1,1-dioxido-2-phenylthiomorpholine- 4-carbonyl)-4-((8-(2-(2,6-dioxopiperidin-3-yl)-1-oxoisoindolin- 4-yl)oct-7-yn-1-yl)oxy)pyrrolidin-1-yl)-3,3-dimethyl-1- oxobutan-2-yl)carbamoyl)benzo[b]thiophen-5- yl)difluoromethyl)phosphonic acid |
| 608 | 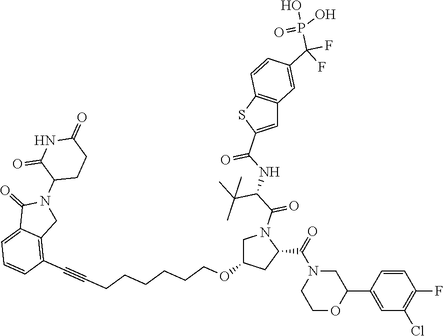 [SMILES: CC(C)(C)[C@H](NC(=O)c1cc2cc(C(F)(F)P(=O)(O)O)ccc2s1)C(=O)N1C[C@@H](OCCCCCCC#Cc2cccc3c2CN(C2CCC(=O)NC2=O)C3=O)C[C@H]1C(=O)N1CCOC(c2ccc(F)c(Cl)c2)C1] | ((2-(((2S)-1-((2S,4S)-2-(2-(3-chloro-4- fluorophenyl)morpholine-4-carbonyl)-4-((8-(2-(2,6- dioxopiperidin-3-yl)-1-oxoisoindolin-4-yl)oct-7-yn-1- yl)oxy)pyrrolidin-1-yl)-3,3-dimethyl-1-oxobutan-2- yl)carbamoyl)benzo[b]thiophen-5- yl)difluoromethyl)phosphonic acid |
| 609 | 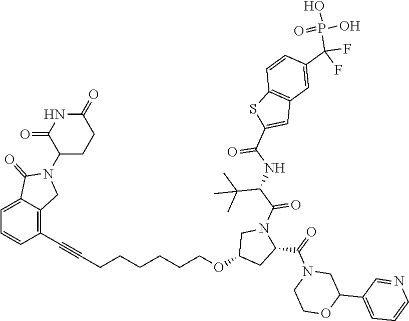 [SMILES: CC(C)(C)[C@H](NC(=O)c1cc2cc(C(F)(F)P(=O)(O)O)ccc2s1)C(=O)N1C[C@@H](OCCCCCCC#Cc2cccc3c2CN(C2CCC(=O)NC2=O)C3=O)C[C@H]1C(=O)N1CCOC(c2cccnc2)C1] | ((2-(((2S)-1-((2S,4S)-4-((8-(2-(2,6-dioxopiperidin-3-yl)-1- oxoisoindolin-4-yl)oct-7-yn-1-yl)oxy)-2-(2-(pyridin-3- yl)morpholine-4-carbonyl)pyrrolidin-1-yl)-3,3-dimethyl-1- oxobutan-2-yl)carbamoyl)-1H-inden-5- yl)difluoromethyl)phosphonic acid |
| 610 | 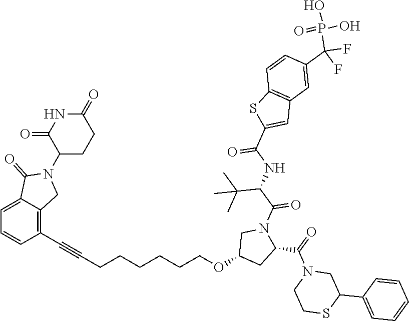 [SMILES: CC(C)(C)[C@H](NC(=O)c1cc2cc(C(F)(F)P(=O)(O)O)ccc2s1)C(=O)N1C[C@@H](OCCCCCCC#Cc2cccc3c2CN(C2CCC(=O)NC2=O)C3=O)C[C@H]1C(=O)N1CCSC(c2ccccc2)C1] | ((2-(((2S)-1-((2S,4S)-4-((8-(2-(2,6-dioxopiperidin-3-yl)-1- oxoisoindolin-4-yl)oct-7-yn-1-yl)oxy)-2-(3-phenylpiperidine-1- carbonyl)pyrrolidin-1-yl)-3,3-dimethyl-1-oxobutan-2- yl)carbamoyl)-1H-inden-5-yl)difluoromethyl)phosphonic acid |
| 611 | 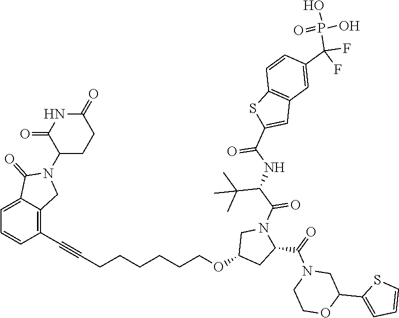 [SMILES: CC(C)(C)[C@H](NC(=O)c1cc2cc(C(F)(F)P(=O)(O)O)ccc2s1)C(=O)N1C[C@@H](OCCCCCCC#Cc2cccc3c2CN(C2CCC(=O)NC2=O)C3=O)C[C@H]1C(=O)N1CCOC(c2cccs2)C1] | ((2-(((2S)-1-((2S,4S)-2-(2-(cyclopenta-1,3-dien-1- yl)morpholine-4-carbonyl)-4-((8-(2-(2,6-dioxopiperidin-3-yl)- 1-oxoisoindolin-4-yl)oct-7-yn-1-yl)oxy)pyrrolidin-1-yl)-3,3- dimethyl-1-oxobutan-2-yl)carbamoyl)-1H-inden-5- yl)difluoromethyl)phosphonic acid |
| 612 | 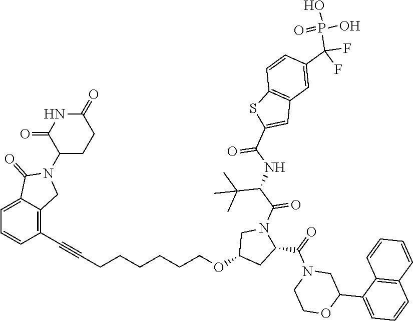 [SMILES: CC(C)(C)[C@H](NC(=O)c1cc2cc(C(F)(F)P(=O)(O)O)ccc2s1)C(=O)N1C[C@@H](OCCCCCCC#Cc2cccc3c2CN(C2CCC(=O)NC2=O)C3=O)C[C@H]1C(=O)N1CCOC(c2cccc3ccccc23)C1] | ((2-(((2S)-1-((2S,4S)-4-((8-(2-(2,6-dioxopiperidin-3-yl)-1- oxoisoindolin-4-yl)oct-7-yn-1-yl)oxy)-2-(2-(naphthalen-1- yl)morpholine-4-carbonyl)pyrrolidin-1-yl)-3,3-dimethyl-1- oxobutan-2-yl)carbamoyl)-1H-inden-5- yl)difluoromethyl)phosphonic acid |
| 613 | 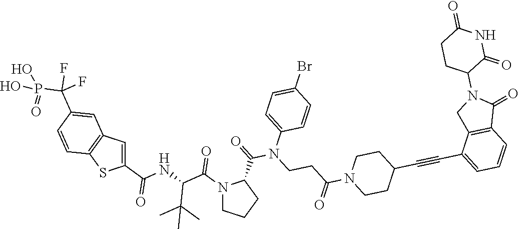 [SMILES: CC(C)(C)[C@H](NC(=O)c1cc2cc(C(F)(F)P(=O)(O)O)ccc2s1)C(=O)N1CCC[C@H]1C(=O)N(CCC(=O)N1CCC(C#Cc2cccc3c2CN(C2CCC(=O)NC2=O)C3=O)CC1)c1ccc(Br)cc1] | ((2-(((2S)-1-((2S)-2-((4-bromophenyl)(3-(4-((2-(2,6- dioxopiperidin-3-yl)-1-oxoisoindolin-4-yl)ethynyl)piperidin-1- yl)-3-oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 614 | 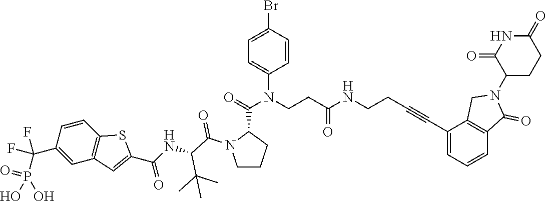 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCC#Cc1cccc2c1CN(C1CCC(=O)NC1=O)C2=O)c1ccc(Br)cc1] | ((2-(((2S)-1-((2S)-2-((4-bromophenyl)(3-((4-(2-(2,6- dioxopiperidin-3-yl)-1-oxoisoindolin-4-yl)but-3-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 615 | 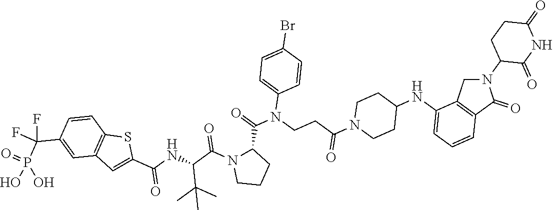 [SMILES: CC(C)(C)[C@H](NC(=O)c1cc2cc(C(F)(F)P(=O)(O)O)ccc2s1)C(=O)N1CCC[C@H]1C(=O)N(CCC(=O)N1CCC(Nc2cccc3c2CN(C2CCC(=O)NC2=O)C3=O)CC1)c1ccc(Br)cc1] | ((2-(((2S)-1-((2S)-2-((4-bromophenyl)(3-(4-((2-(2,6- dioxopiperidin-3-yl)-1-oxoisoindolin-4-yl)amino)piperidin-1- yl)-3-oxopropyl)carbamoyl)pyrrolidin-1-yl)-3,3-dimethyl-1- oxobutan-2-yl)carbamoyl)benzo[b]thiophen-5- yl)difluoromethyl)phosphonic acid |
| 616 | 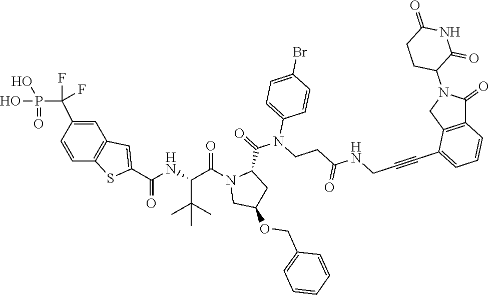 [SMILES: CC(C)(C)[C@H](NC(=O)c1cc2cc(C(F)(F)P(=O)(O)O)ccc2s1)C(=O)N1C[C@H](OCc2ccccc2)C[C@H]1C(=O)N(CCC(=O)NCC#Cc1cccc2c1CN(C1CCC(=O)NC1=O)C2=O)c1ccc(Br)cc1] | ((2-(((2S)-1-((2S,4R)-4-(benzyloxy)-2-((4-bromophenyl)(3-((3- (2-(2,6-dioxopiperidin-3-yl)-1-oxoisoindolin-4-yl)prop-2-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 617 | 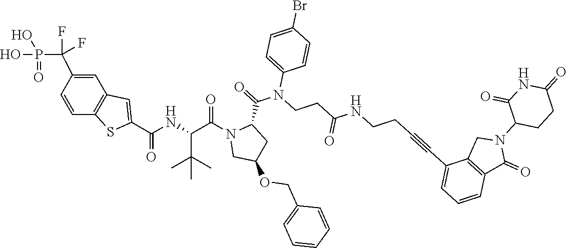 [SMILES: CC(C)(C)[C@H](NC(=O)c1cc2cc(C(F)(F)P(=O)(O)O)ccc2s1)C(=O)N1C[C@H](OCc2ccccc2)C[C@H]1C(=O)N(CCC(=O)NCCC#Cc1cccc2c1CN(C1CCC(=O)NC1=O)C2=O)c1ccc(Br)cc1] | ((2-(((2S)-1-((2S,4R)-4-(benzyloxy)-2-((4-bromophenyl)(3-((4- (2-(2,6-dioxopiperidin-3-yl)-1-oxoisoindolin-4-yl)but-3-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 618 | 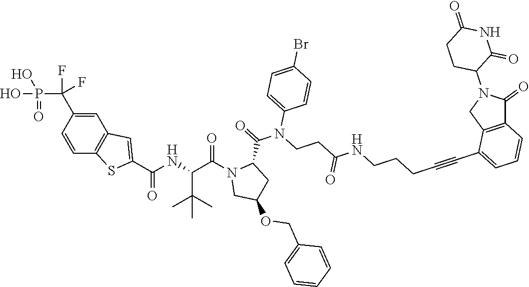 [SMILES: CC(C)(C)[C@H](NC(=O)c1cc2cc(C(F)(F)P(=O)(O)O)ccc2s1)C(=O)N1C[C@H](OCc2ccccc2)C[C@H]1C(=O)N(CCC(=O)NCCCC#Cc1cccc2c1CN(C1CCC(=O)NC1=O)C2=O)c1ccc(Br)cc1] | ((2-(((2S)-1-((2S,4R)-4-(benzyloxy)-2-((4-bromophenyl)(3-((5- (2-(2,6-dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)-1H-inden-5- yl)difluoromethyl)phosphonic acid |
| 619 | 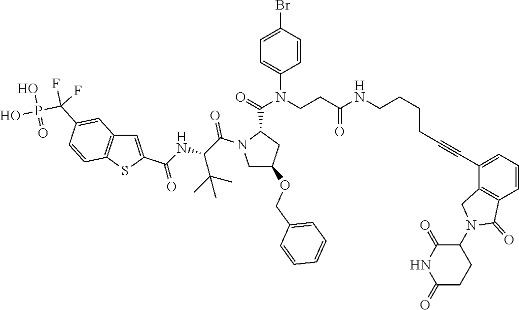 [SMILES: CC(C)(C)[C@H](NC(=O)c1cc2cc(C(F)(F)P(=O)(O)O)ccc2s1)C(=O)N1C[C@H](OCc2ccccc2)C[C@H]1C(=O)N(CCC(=O)NCCCCC#Cc1cccc2c1CN(C1CCC(=O)NC1=O)C2=O)c1ccc(Br)cc1] | ((2-(((2S)-1-((2S,4R)-4-(benzyloxy)-2-((4-bromophenyl)(3-((6- (2-(2,6-dioxopiperidin-3-yl)-1-oxoisoindolin-4-yl)hex-5-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 620 | 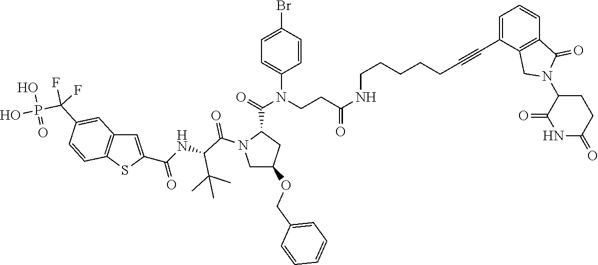 [SMILES: CC(C)(C)[C@H](NC(=O)c1cc2cc(C(F)(F)P(=O)(O)O)ccc2s1)C(=O)N1C[C@H](OCc2ccccc2)C[C@H]1C(=O)N(CCC(=O)NCCCCCC#Cc1cccc2c1CN(C1CCC(=O)NC1=O)C2=O)c1ccc(Br)cc1] | ((2-(((2S)-1-((2S,4R)-4-(benzyloxy)-2-((4-bromophenyl)(3-((7- (2-(2,6-dioxopiperidin-3-yl)-1-oxoisoindolin-4-yl)hept-6-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 621 | 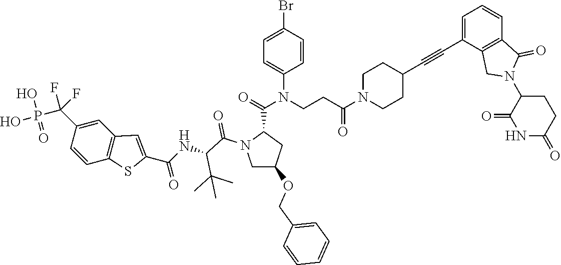 [SMILES: CC(C)(C)[C@H](NC(=O)c1cc2cc(C(F)(F)P(=O)(O)O)ccc2s1)C(=O)N1C[C@H](OCc2ccccc2)C[C@H]1C(=O)N(CCC(=O)N1CCC(C#Cc2cccc3c2CN(C2CCC(=O)NC2=O)C3=O)CC1)c1ccc(Br)cc1] | ((2-(((2S)-1-((2S,4R)-4-(benzyloxy)-2-((4-bromophenyl)(3-(4- ((2-(2,6-dioxopiperidin-3-yl)-1-oxoisoindolin-4- yl)ethynyl)piperidin-1-yl)-3-oxopropyl)carbamoyl)pyrrolidin- 1-yl)-3,3-dimethyl-1-oxobutan-2- yl)carbamoyl)benzo[b]thiophen-5- yl)difluoromethyl)phosphonic acid |
| 622 | 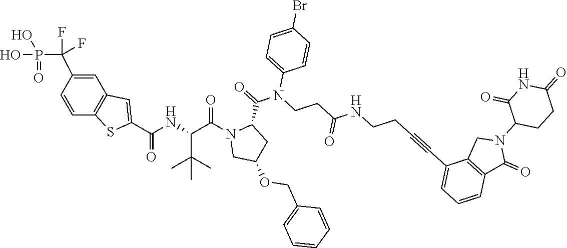 [SMILES: CC(C)(C)[C@H](NC(=O)c1cc2cc(C(F)(F)P(=O)(O)O)ccc2s1)C(=O)N1C[C@@H](OCc2ccccc2)C[C@H]1C(=O)N(CCC(=O)NCCC#Cc1cccc2c1CN(C1CCC(=O)NC1=O)C2=O)c1ccc(Br)cc1] | ((2-(((2S)-1-((2S,4S)-4-(benzyloxy)-2-((4-bromophenyl)(3-((4- (2-(2,6-dioxopiperidin-3-yl)-1-oxoisoindolin-4-yl)but-3-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 623 | 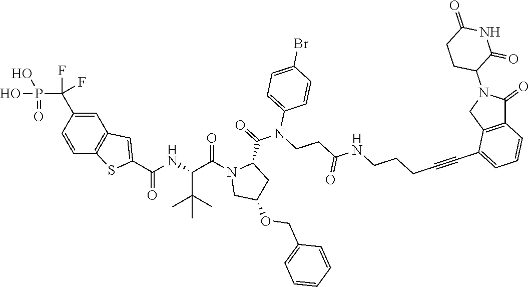 [SMILES: CC(C)(C)[C@H](NC(=O)c1cc2cc(C(F)(F)P(=O)(O)O)ccc2s1)C(=O)N1C[C@@H](OCc2ccccc2)C[C@H]1C(=O)N(CCC(=O)NCCCC#Cc1cccc2c1CN(C1CCC(=O)NC1=O)C2=O)c1ccc(Br)cc1] | ((2-(((2S)-1-((2S,4S)-4-(benzyloxy)-2-((4-bromophenyl)(3-((5- (2-(2,6-dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 624 | 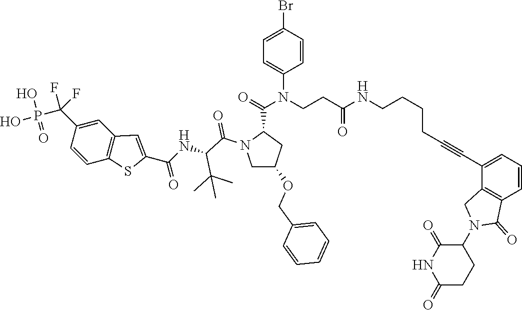 | ((2-(((2S)-1-((2S,4S)-4-(benzyloxy)-2-((4-bromophenyl)(3-((6- (2-(2,6-dioxopiperidin-3-yl)-1-oxoisoindolin-4-yl)hex-5-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 625 | 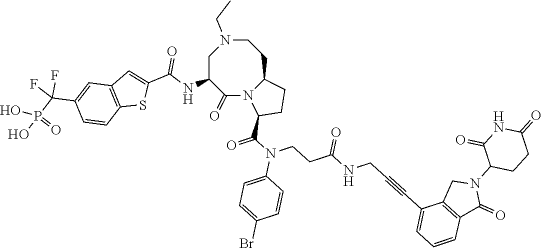 [SMILES: CCN1CC[C@H]2CC[C@@H](C(=O)N(CCC(=O)NCC#Cc3cccc4c3CN(C3CCC(=O)NC3=O)C4=O)c3ccc(Br)cc3)N2C(=O)[C@@H](NC(=O)c2cc3cc(C(F)(F)P(=O)(O)O)ccc3s2)C1] | ((2-(((5S,8S,10aR)-8-((4-bromophenyl)(3-((3-(2-(2,6- dioxopiperidin-3-yl)-1-oxoisoindolin-4-yl)prop-2-yn-1- yl)amino)-3-oxopropyl)carbamoyl)-3-ethyl-6- oxodecahydropyrrolo[1,2-a][1,5]diazocin-5- yl)carbamoyl)benzo[b]thiophen-5- yl)difluoromethyl)phosphonic acid |
| 626 | 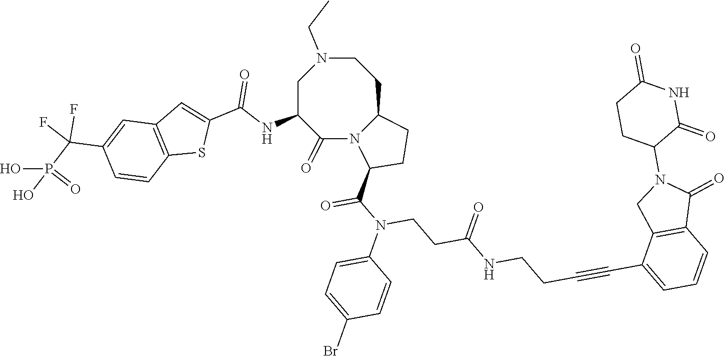 [SMILES: CCN1CC[C@H]2CC[C@@H](C(=O)N(CCC(=O)NCCC#Cc3cccc4c3CN(C3CCC(=O)NC3=O)C4=O)c3ccc(Br)cc3)N2C(=O)[C@@H](NC(=O)c2cc3cc(C(F)(F)P(=O)(O)O)ccc3s2)C1] | ((2-(((5S,8S,10aR)-8-((4-bromophenyl)(3-((4-(2-(2,6- dioxopiperidin-3-yl)-1-oxoisoindolin-4-yl)but-3-yn-1- yl)amino)-3-oxopropyl)carbamoyl)-3-ethyl-6- oxodecahydropyrrolo[1,2-a][1,5]diazocin-5- yl)carbamoyl)benzo[b]thiophen-5- yl)difluoromethyl)phosphonic acid |
| 627 | 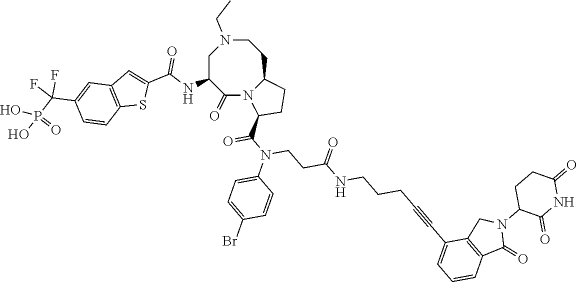 [SMILES: CCN1CC[C@H]2CC[C@@H](C(=O)N(CCC(=O)NCCCC#Cc3cccc4c3CN(C3CCC(=O)NC3=O)C4=O)c3ccc(Br)cc3)N2C(=O)[C@@H](NC(=O)c2cc3cc(C(F)(F)P(=O)(O)O)ccc3s2)C1] | ((2-(((5S,8S,10aR)-8-((4-bromophenyl)(3-((5-(2-(2,6- dioxopiperidin-3-yl)-1-oxoisoindolin-4-yl)pent-4-yn-1- yl)amino)-3-oxopropyl)carbamoyl)-3-ethyl-6- oxodecahydropyrrolo[1,2-a][1,5]diazocin-5- yl)carbamoyl)benzo[b]thiophen-5- yl)difluoromethyl)phosphonic acid |
| 628 | 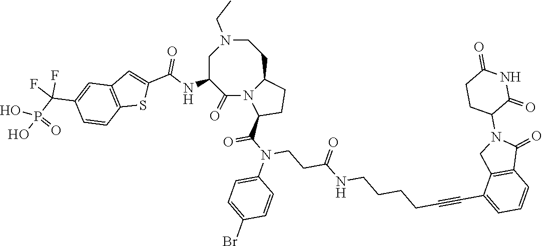 [SMILES: CCN1CC[C@H]2CC[C@@H](C(=O)N(CCC(=O)NCCCCC#Cc3cccc4c3CN(C3CCC(=O)NC3=O)C4=O)c3ccc(Br)cc3)N2C(=O)[C@@H](NC(=O)c2cc3cc(C(F)(F)P(=O)(O)O)ccc3s2)C1] | ((2-(((5S,8S,10aR)-8-((4-bromophenyl)(3-((6-(2-(2,6- dioxopiperidin-3-yl)-1-oxoisoindolin-4-yl)hex-5-yn-1- yl)amino)-3-oxopropyl)carbamoyl)-3-ethyl-6- oxodecahydropyrrolo[1,2-a][1,5]diazocin-5- yl)carbamoyl)benzo[b]thiophen-5- yl)difluoromethyl)phosphonic acid |
| 629 | 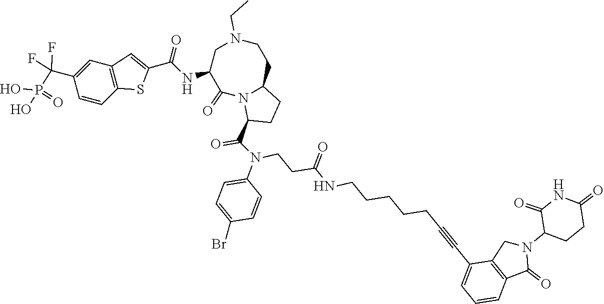 [SMILES: CCN1CC[C@H]2CC[C@@H](C(=O)N(CCC(=O)NCCCCCC#Cc3cccc4c3CN(C3CCC(=O)NC3=O)C4=O)c3ccc(Br)cc3)N2C(=O)[C@@H](NC(=O)c2cc3cc(C(F)(F)P(=O)(O)O)ccc3s2)C1] | ((2-(((5S,8S,10aR)-8-((4-bromophenyl)(3-((7-(2-(2,6- dioxopiperidin-3-yl)-1-oxoisoindolin-4-yl)hept-6-yn-1- yl)amino)-3-oxopropyl)carbamoyl)-3-ethyl-6- oxodecahydropyrrolo[1,2-a][1,5]diazocin-5- yl)carbamoyl)benzo[b]thiophen-5- yl)difluoromethyl)phosphonic acid |
| 630 | 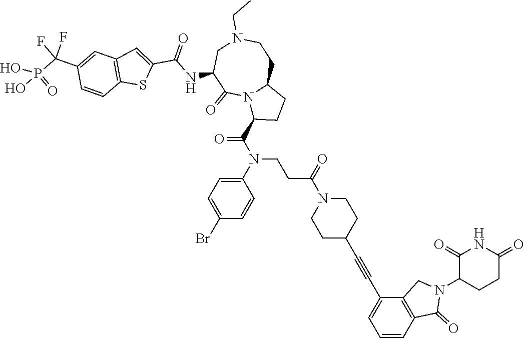 [SMILES: CCN1CC[C@H]2CC[C@@H](C(=O)N(CCC(=O)N3CCC(C#Cc4cccc5c4CN(C4CCC(=O)NC4=O)C5=O)CC3)c3ccc(Br)cc3)N2C(=O)[C@@H](NC(=O)c2cc3cc(C(F)(F)P(=O)(O)O)ccc3s2)C1] | ((2-(((5S,8S,10aR)-8-((4-bromophenyl)(3-(4-((2-(2,6- dioxopiperidin-3-yl)-1-oxoisoindolin-4-yl)ethynyl)piperidin-1- yl)-3-oxopropyl)carbamoyl)-3-ethyl-6- oxodecahydropyrrolo[1,2-a][1,5]diazocin-5- yl)carbamoyl)benzo[b]thiophen-5- yl)difluoromethyl)phosphonic acid |
| 631 | 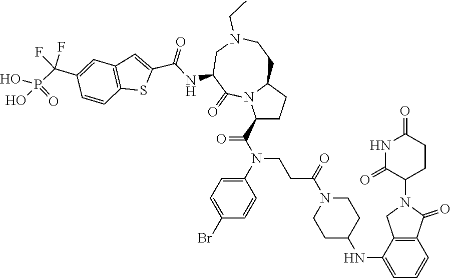 [SMILES: CCN1CC[C@H]2CC[C@@H](C(=O)N(CCC(=O)N3CCC(Nc4cccc5c4CN(C4CCC(=O)NC4=O)C5=O)CC3)c3ccc(Br)cc3)N2C(=O)[C@@H](NC(=O)c2cc3cc(C(F)(F)P(=O)(O)O)ccc3s2)C1] | ((2-(((5S,8S,10aR)-8-((4-bromophenyl)(3-(4-((2-(2,6- dioxopiperidin-3-yl)-1-oxoisoindolin-4-yl)amino)piperidin-1- yl)-3-oxopropyl)carbamoyl)-3-ethyl-6- oxodecahydropyrrolo[1,2-a][1,5]diazocin-5- yl)carbamoyl)benzo[b]thiophen-5- yl)difluoromethyl)phosphonic acid |
| 632 | 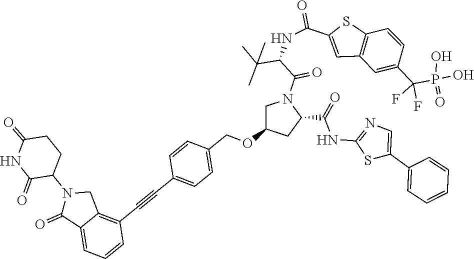 [SMILES: CC(C)(C)[C@H](NC(=O)c1cc2cc(C(F)(F)P(=O)(O)O)ccc2s1)C(=O)N1C[C@H](OCc2ccc(C#Cc3cccc4c3CN(C3CCC(=O)NC3=O)C4=O)cc2)C[C@H]1C(=O)Nc1ncc(-c2ccccc2)s1] | ((2-(((2S)-1-((2S,4R)-4-((4-((2-(2,6-dioxopiperidin-3-yl)-1- oxoisoindolin-4-yl)ethynyl)benzyl)oxy)-2-((5-phenylthiazol-2- yl)carbamoyl)pyrrolidin-1-yl)-3,3-dimethyl-1-oxobutan-2- yl)carbamoyl)benzo[b]thiophen-5- yl)difluoromethyl)phosphonic acid |
| 633 | 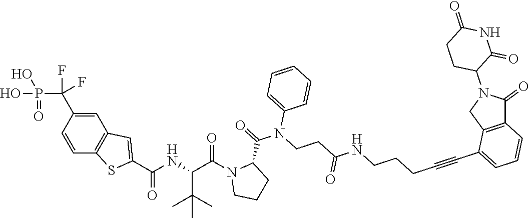 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccccc1] | ((2-(((2S)-1-((2S)-2-((3-((5-(2-(2,6-dioxopiperidin-3-yl)-1- oxoisoindolin-4-yl)pent-4-yn-1-yl)amino)-3- oxopropyl)(phenyl)carbamoyl)pyrrolidin-1-yl)-3,3-dimethyl-1- oxobutan-2-yl)carbamoyl)benzo[b]thiophen-5- yl)difluoromethyl)phosphonic acid |
| 634 | 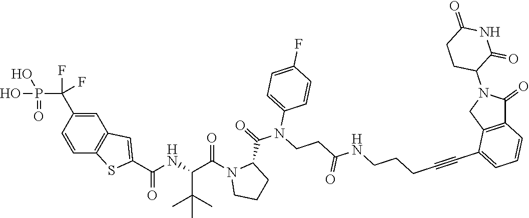 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(F)cc1] | ((2-(((2S)-1-((2S)-2-((3-((5-(2-(2,6-dioxopiperidin-3-yl)-1- oxoisoindolin-4-yl)pent-4-yn-1-yl)amino)-3-oxopropyl)(4- fluorophenyl)carbamoyl)pyrrolidin-1-yl)-3,3-dimethyl-1- oxobutan-2-yl)carbamoyl)benzo[b]thiophen-5- yl)difluoromethyl)phosphonic acid |
| 635 | 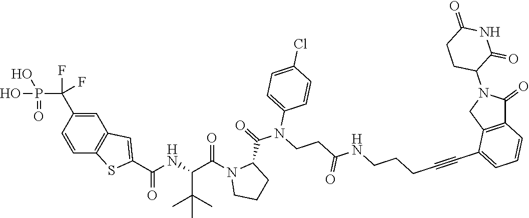 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(Cl)cc1] | ((2-(((2S)-1-((2S)-2-((4-chlorophenyl)(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 636 | 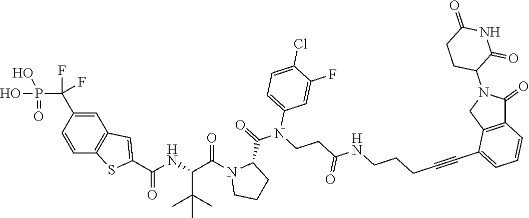 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(Cl)c(F)c1] | ((2-(((2S)-1-((2S)-2-((4-chloro-3-fluorophenyl)(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 637 | 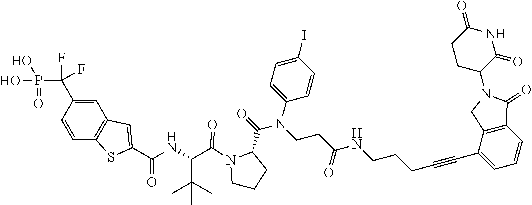 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(I)cc1] | ((2-(((2S)-1-((2S)-2-((3-((5-(2-(2,6-dioxopiperidin-3-yl)-1- oxoisoindolin-4-yl)pent-4-yn-1-yl)amino)-3-oxopropyl)(4- iodophenyl)carbamoyl)pyrrolidin-1-yl)-3,3-dimethyl-1- oxobutan-2-yl)carbamoyl)benzo[b]thiophen-5- yl)difluoromethyl)phosphonic acid |
| 638 | 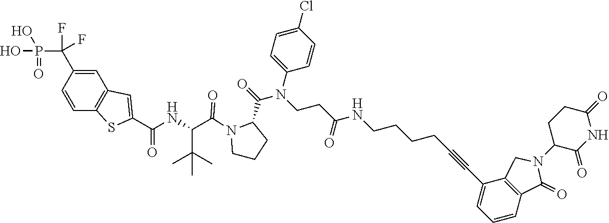 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCCC#Cc1cccc2c1CN(C1CCC(=O)NC1=O)C2=O)c1ccc(Cl)cc1] | ((2-(((2S)-1-((2S)-2-((4-chlorophenyl)(3-((6-(2-(2,6- dioxopiperidin-3-yl)-1-oxoisoindolin-4-yl)hex-5-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 639 | 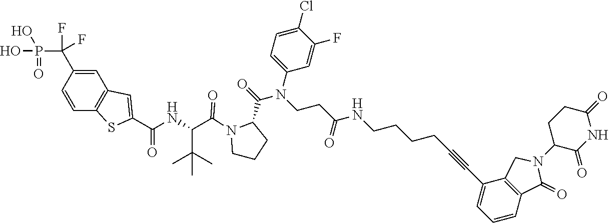 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCCC#Cc1cccc2c1CN(C1CCC(=O)NC1=O)C2=O)c1ccc(Cl)c(F)c1] | ((2-(((2S)-1-((2S)-2-((4-chloro-3-fluorophenyl)(3-((6-(2-(2,6- dioxopiperidin-3-yl)-1-oxoisoindolin-4-yl)hex-5-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 640 | 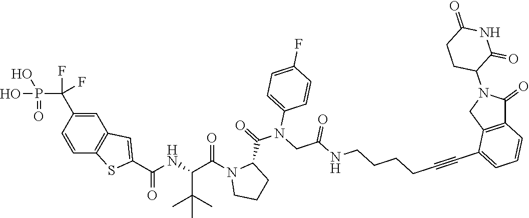 [SMILES: CC(C)(C)[C@H](NC(=O)c1cc2cc(C(F)(F)P(=O)(O)O)ccc2s1)C(=O)N1CCC[C@H]1C(=O)N(CC(=O)NCCCCC#Cc1cccc2c1CN(C1CCC(=O)NC1=O)C2=O)c1ccc(F)cc1] | ((2-(((2S)-1-((2S)-2-((2-((6-(2-(2,6-dioxopiperidin-3-yl)-1- oxoisoindolin-4-yl)hex-5-yn-1-yl)amino)-2-oxoethyl)(4- fluorophenyl)carbamoyl)pyrrolidin-1-yl)-3,3-dimethyl-1- oxobutan-2-yl)carbamoyl)benzo[b]thiophen-5- yl)difluoromethyl)phosphonic acid |
| 641 | 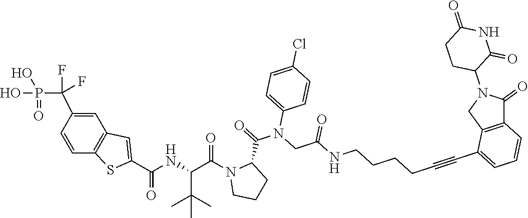 [SMILES: CC(C)(C)[C@H](NC(=O)c1cc2cc(C(F)(F)P(=O)(O)O)ccc2s1)C(=O)N1CCC[C@H]1C(=O)N(CC(=O)NCCCCC#Cc1cccc2c1CN(C1CCC(=O)NC1=O)C2=O)c1ccc(Cl)cc1] | ((2-(((2S)-1-((2S)-2-((4-chlorophenyl)(2-((6-(2-(2,6- dioxopiperidin-3-yl)-1-oxoisoindolin-4-yl)hex-5-yn-1- yl)amino)-2-oxoethyl)carbamoyl)pyrrolidin-1-yl)-3,3-dimethyl- 1-oxobutan-2-yl)carbamoyl)benzo[b]thiophen-5- yl)difluoromethyl)phosphonic acid |
| 642 | 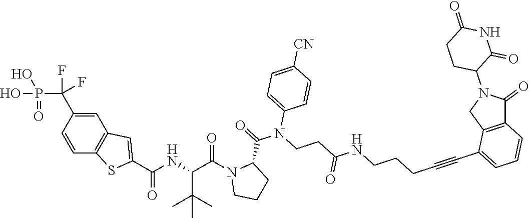 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(C#N)cc1] | ((2-(((2S)-1-((2S)-2-((4-cyanophenyl)(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 643 | 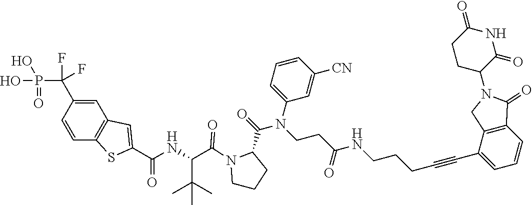 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1cccc(C#N)c1] | ((2-(((2S)-1-((2S)-2-((3-cyanophenyl)(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 644 | 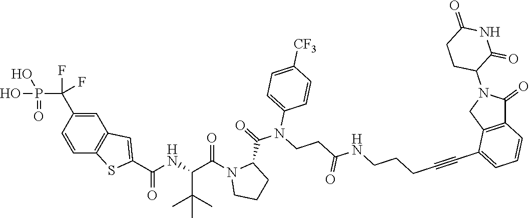 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(C(F)(F)F)cc1] | ((2-(((2S)-1-((2S)-2-((3-((5-(2-(2,6-dioxopiperidin-3-yl)-1- oxoisoindolin-4-yl)pent-4-yn-1-yl)amino)-3-oxopropyl)(4- (trifluoromethyl)phenyl)carbamoyl)pyrrolidin-1-yl)-3,3- dimethyl-1-oxobutan-2-yl)carbamoyl)benzo[b]thiophen-5- yl)difluoromethyl)phosphonic acid |
| 645 | 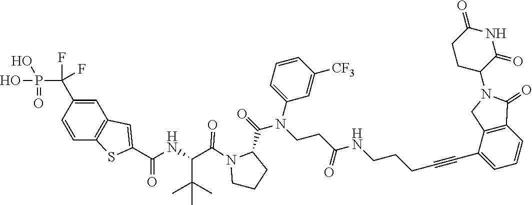 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1cccc(C(F)(F)F)c1] | ((2-(((2S)-1-((2S)-2-((3-((5-(2-(2,6-dioxopiperidin-3-yl)-1- oxoisoindolin-4-yl)pent-4-yn-1-yl)amino)-3-oxopropyl)(3- (trifluoromethyl)phenyl)carbamoyl)pyrrolidin-1-yl)-3,3- dimethyl-1-oxobutan-2-yl)carbamoyl)benzo[b]thiophen-5- yl)difluoromethyl)phosphonic acid |
| 646 | 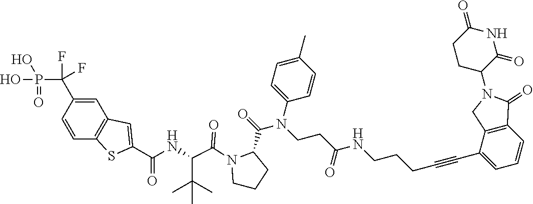 [SMILES: Cc1ccc(N(CCC(=O)NCCCC#Cc2cccc3c2CN(C2CCC(=O)NC2=O)C3=O)C(=O)[C@@H]2CCCN2C(=O)[C@@H](NC(=O)c2cc3cc(C(F)(F)P(=O)(O)O)ccc3s2)C(C)(C)C)cc1] | ((2-(((2S)-1-((2S)-2-((3-((5-(2-(2,6-dioxopiperidin-3-yl)-1- oxoisoindolin-4-yl)pent-4-yn-1-yl)amino)-3-oxopropyl)(p- tolyl)carbamoyl)pyrrolidin-1-yl)-3,3-dimethyl-1-oxobutan-2- yl)carbamoyl)benzo[b]thiophen-5- yl)difluoromethyl)phosphonic acid |
| 647 | 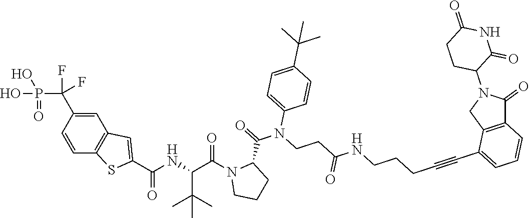 [SMILES: CC(C)(C)c1ccc(N(CCC(=O)NCCCC#Cc2cccc3c2CN(C2CCC(=O)NC2=O)C3=O)C(=O)[C@@H]2CCCN2C(=O)[C@@H](NC(=O)c2cc3cc(C(F)(F)P(=O)(O)O)ccc3s2)C(C)(C)C)cc1] | ((2-(((2S)-1-((2S)-2-((4-(tert-butyl)phenyl)(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 648 | 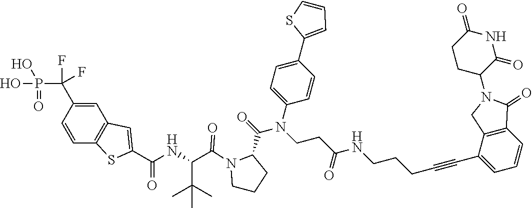 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(-c2cccs2)cc1] | ((2-(((2S)-1-((2S)-2-((3-((5-(2-(2,6-dioxopiperidin-3-yl)-1- oxoisoindolin-4-yl)pent-4-yn-1-yl)amino)-3-oxopropyl)(4- (thiophen-2-yl)phenyl)carbamoyl)pyrrolidin-1-yl)-3,3- dimethyl-1-oxobutan-2-yl)carbamoyl)benzo[b]thiophen-5- yl)difluoromethyl)phosphonic acid |
| 649 | 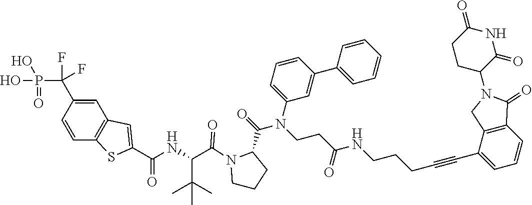 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1cccc(-c2ccccc2)c1] | ((2-(((2S)-1-((2S)-2-([1,1′-biphenyl]-3-yl(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 650 | 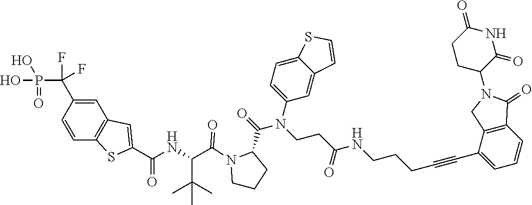 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc2sccc2c1] | ((2-(((2S)-1-((2S)-2-(benzo[b]thiophen-5-yl(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 651 | 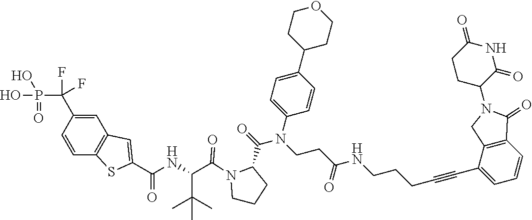 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(C2CCOCC2)cc1] | ((2-(((2S)-1-((2S)-2-((3-((5-(2-(2,6-dioxopiperidin-3-yl)-1- oxoisoindolin-4-yl)pent-4-yn-1-yl)amino)-3-oxopropyl)(4- (tetrahydro-2H-pyran-4-yl)phenyl)carbamoyl)pyrrolidin-1-yl)- 3,3-dimethyl-1-oxobutan-2-yl)carbamoyl)benzo[b]thiophen-5- yl)difluoromethyl)phosphonic acid |
| 652 | 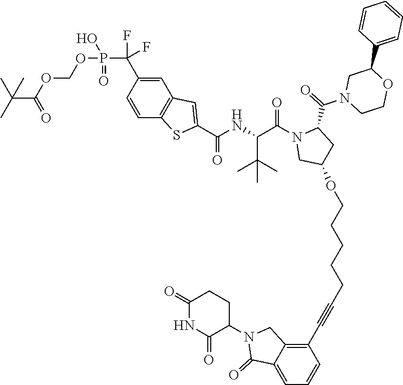 [SMILES: CC(C)(C)C(=O)OCOP(=O)(O)C(F)(F)c1ccc2sc(C(=O)N[C@H](C(=O)N3C[C@@H](OCCCCCC#Cc4cccc5c4CN(C4CCC(=O)NC4=O)C5=O)C[C@H]3C(=O)N3CCO[C@H](c4ccccc4)C3)C(C)(C)C)cc2c1] | ((((2-(((2S)-1-((2S,4S)-4-((7-(2-(2,6-dioxopiperidin-3-yl)-1- oxoisoindolin-4-yl)hept-6-yn-1-yl)oxy)-2-((R)-2- phenylmorpholine-4-carbonyl)pyrrolidin-1-yl)-3,3-dimethyl-1- oxobutan-2-yl)carbamoyl)benzo[b]thiophen-5- yl)difluoromethyl)(hydroxy)phosphoryl)oxy)methyl pivalate |
| 653 | 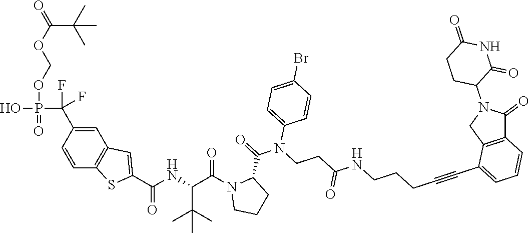 [SMILES: CC(C)(C)C(=O)OCOP(=O)(O)C(F)(F)c1ccc2sc(C(=O)N[C@H](C(=O)N3CCC[C@H]3C(=O)N(CCC(=O)NCCCC#Cc3cccc4c3CN(C3CCC(=O)NC3=O)C4=O)c3ccc(Br)cc3)C(C)(C)C)cc2c1] | ((((2-(((2S)-1-((2S)-2-((4-bromophenyl)(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)(hydroxy)phosphoryl)oxy)methyl pivalate |
| 654 | 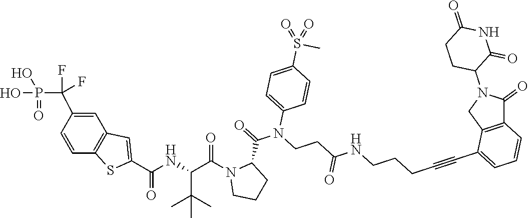 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(S(C)(=O)=O)cc1] | ((2-(((2S)-1-((2S)-2-((3-((5-(2-(2,6-dioxopiperidin-3-yl)-1- oxoisoindolin-4-yl)pent-4-yn-1-yl)amino)-3-oxopropyl)(4- (methylsulfonyl)phenyl)carbamoyl)pyrrolidin-1-yl)-3,3- dimethyl-1-oxobutan-2-yl)carbamoyl)benzo[b]thiophen-5- yl)difluoromethyl)phosphonic acid |
| 655 | 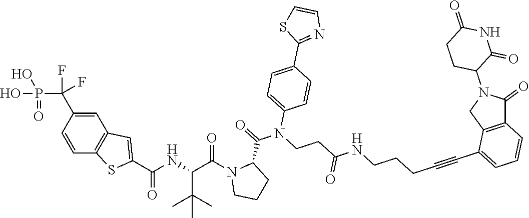 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(-c2nccs2)cc1] | ((2-(((2S)-1-((2S)-2-((3-((5-(2-(2,6-dioxopiperidin-3-yl)-1- oxoisoindolin-4-yl)pent-4-yn-1-yl)amino)-3-oxopropyl)(4- (thiazol-2-yl)phenyl)carbamoyl)pyrrolidin-1-yl)-3,3-dimethyl- 1-oxobutan-2-yl)carbamoyl)benzo[b]thiophen-5- yl)difluoromethyl)phosphonic acid |
| 656 | 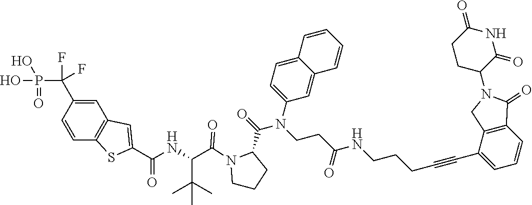 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc2ccccc2c1] | ((2-(((2S)-1-((2S)-2-((3-((5-(2-(2,6-dioxopiperidin-3-yl)-1- oxoisoindolin-4-yl)pent-4-yn-1-yl)amino)-3- oxopropyl)(naphthalen-2-yl)carbamoyl)pyrrolidin-1-yl)-3,3- dimethyl-1-oxobutan-2-yl)carbamoyl)benzo[b]thiophen-5- yl)difluoromethyl)phosphonic acid |
| 657 | 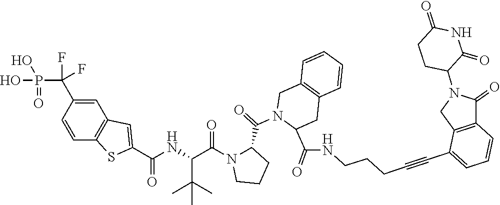 [SMILES: CC(C)(C)[C@H](NC(=O)c1cc2cc(C(F)(F)P(=O)(O)O)ccc2s1)C(=O)N1CCC[C@H]1C(=O)N1Cc2ccccc2CC1C(=O)NCCCC#Cc1cccc2c1CN(C1CCC(=O)NC1=O)C2=O] | ((2-(((2S)-1-((2S)-2-(3-((5-(2-(2,6-dioxopiperidin-3-yl)-1- oxoisoindolin-4-yl)pent-4-yn-1-yl)carbamoyl)-1,2,3,4- tetrahydroisoquinoline-2-carbonyl)pyrrolidin-1-yl)-3,3- dimethyl-1-oxobutan-2-yl)carbamoyl)benzo[b]thiophen-5- yl)difluoromethyl)phosphonic acid |
| 658 | 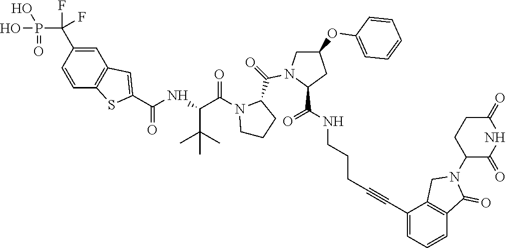 [SMILES: CC(C)(C)[C@H](NC(=O)c1cc2cc(C(F)(F)P(=O)(O)O)ccc2s1)C(=O)N1CCC[C@H]1C(=O)N1C[C@@H](Oc2ccccc2)C[C@H]1C(=O)NCCCC#Cc1cccc2c1CN(C1CCC(=O)NC1=O)C2=O] | ((2-(((2S)-1-((2S)-2-((2S,4S)-2-((5-(2-(2,6-dioxopiperidin-3- yl)-1-oxoisoindolin-4-yl)pent-4-yn-1-yl)carbamoyl)-4- phenoxypyrrolidine-1-carbonyl)pyrrolidin-1-yl)-3,3-dimethyl- 1-oxobutan-2-yl)carbamoyl)benzo[b]thiophen-5- yl)difluoromethyl)phosphonic acid |
| 659 | 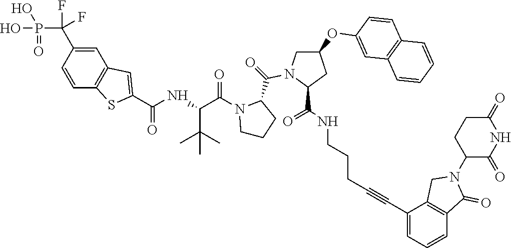 [SMILES: CC(C)(C)[C@H](NC(=O)c1cc2cc(C(F)(F)P(=O)(O)O)ccc2s1)C(=O)N1CCC[C@H]1C(=O)N1C[C@@H](Oc2ccc3ccccc3c2)C[C@H]1C(=O)NCCCC#Cc1cccc2c1CN(C1CCC(=O)NC1=O)C2=O] | ((2-(((2S)-1-((2S)-2-((2S,4S)-2-((5-(2-(2,6-dioxopiperidin-3- yl)-1-oxoisoindolin-4-yl)pent-4-yn-1-yl)carbamoyl)-4- (naphthalen-2-yloxy)pyrrolidine-1-carbonyl)pyrrolidin-1-yl)- 3,3-dimethyl-1-oxobutan-2-yl)carbamoyl)benzo[b]thiophen-5- yl)difluoromethyl)phosphonic acid |
| 660 | 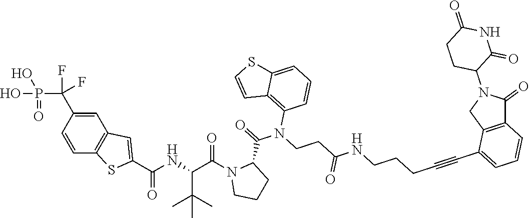 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1cccc2sccc12] | ((2-(((2S)-1-((2S)-2-(benzo[b]thiophen-4-yl(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 661 | 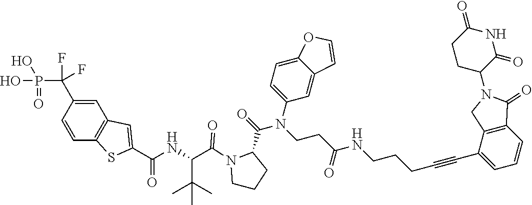 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc2occc2c1] | ((2-(((2S)-1-((2S)-2-(benzofuran-5-yl(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 662 | 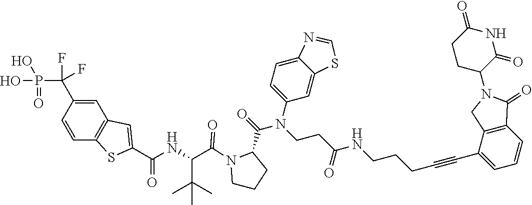 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc2ncsc2c1] | ((2-(((2S)-1-((2S)-2-(benzo[d]thiazol-6-yl(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 663 | 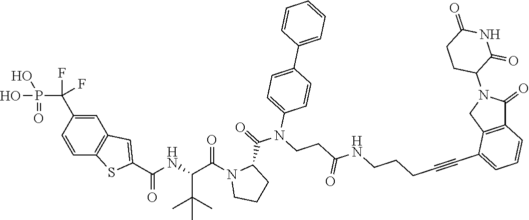 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc(-c2ccccc2)cc1] | ((2-(((2S)-1-((2S)-2-([1,1′-biphenyl]-4-yl(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 664 | 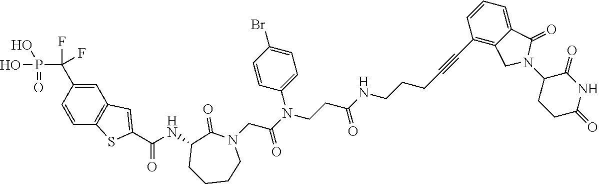 [SMILES: O=C(CCN(C(=O)CN1CCCC[C@H](NC(=O)c2cc3cc(C(F)(F)P(=O)(O)O)ccc3s2)C1=O)c1ccc(Br)cc1)NCCCC#Cc1cccc2c1CN(C1CCC(=O)NC1=O)C2=O] | ((2-(((3S)-1-(2-((4-bromophenyl)(3-((5-(2-(2,6-dioxopiperidin- 3-yl)-1-oxoisoindolin-4-yl)pent-4-yn-1-yl)amino)-3- oxopropyl)amino)-2-oxoethyl)-2-oxoazepan-3- yl)carbamoyl)benzo[b]thiophen-5- yl)difluoromethyl)phosphonic acid |
| 665 | 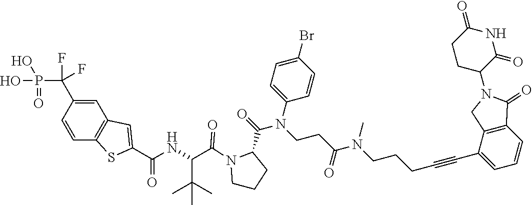 | ((2-(((2S)-1-((2S)-2-((4-bromophenyl)(3-((5-(2-(2,6- dioxopiperidin-3-yl)-1-oxoisoindolin-4-yl)pent-4-yn-1- yl)(methyl)amino)-3-oxopropyl)carbamoyl)pyrrolidin-1-yl)- 3,3-dimethyl-1-oxobutan-2-yl)carbamoyl)benzo[b]thiophen-5- yl)difluoromethyl)phosphonic acid |
| 666 | 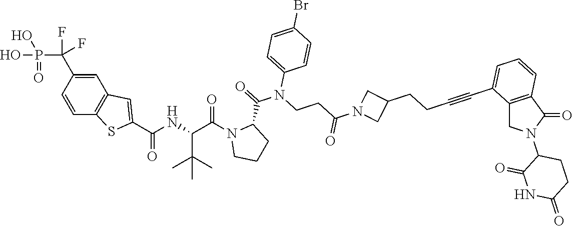 [SMILES: CC(C)(C)[C@H](NC(=O)c1cc2cc(C(F)(F)P(=O)(O)O)ccc2s1)C(=O)N1CCC[C@H]1C(=O)N(CCC(=O)N1CC(CCC#Cc2cccc3c2CN(C2CCC(=O)NC2=O)C3=O)C1)c1ccc(Br)cc1] | ((2-(((2S)-1-((2S)-2-((4-bromophenyl)(3-(3-(4-(2-(2,6- dioxopiperidin-3-yl)-1-oxoisoindolin-4-yl)but-3-yn-1- yl)azetidin-1-yl)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 667 | 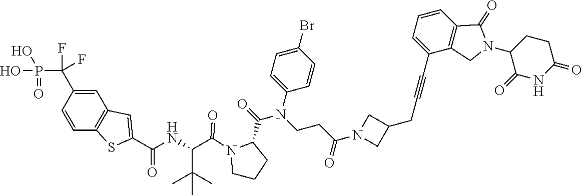 [SMILES: CC(C)(C)[C@H](NC(=O)c1cc2cc(C(F)(F)P(=O)(O)O)ccc2s1)C(=O)N1CCC[C@H]1C(=O)N(CCC(=O)N1CC(CC#Cc2cccc3c2CN(C2CCC(=O)NC2=O)C3=O)C1)c1ccc(Br)cc1] | ((2-(((2S)-1-((2S)-2-((4-bromophenyl)(3-(3-(3-(2-(2,6- dioxopiperidin-3-yl)-1-oxoisoindolin-4-yl)prop-2-yn-1- yl)azetidin-1-yl)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 668 | 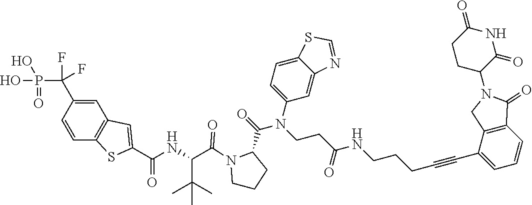 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCC#Cc1cccc2c1CN(C1CCC(=O)NC1=O)C2=O)c1ccc2scnc2c1] | ((2-(((2S)-1-((2S)-2-(benzo[d]thiazol-5-yl(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 669 | 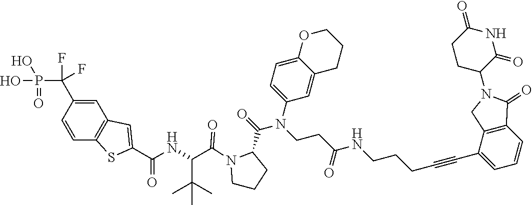 | ((2-(((2S)-1-((2S)-2-(chroman-6-yl(3-((5-(2-(2,6- dioxopiperidin-3-yl)-1-oxoisoindolin-4-yl)pent-4-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |
| 670 | 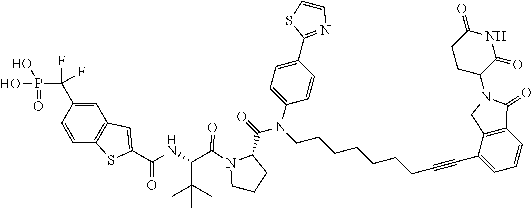 [SMILES: CC(C)(C)[C@H](NC(=O)c1cc2cc(C(F)(F)P(=O)(O)O)ccc2s1)C(=O)N1CCC[C@H]1C(=O)N(CCCCCCCC#Cc1cccc2c1CN(C1CCC(=O)NC1=O)C2=O)c1ccc(-c2nccs2)cc1] | ((2-(((2S)-1-((2S)-2-((9-(2-(2,6-dioxopiperidin-3-yl)-1- oxoisoindolin-4-yl)non-8-yn-1-yl)(4-(thiazol-2- yl)phenyl)carbamoyl)pyrrolidin-1-yl)-3,3-dimethyl-1- oxobutan-2-yl)carbamoyl)benzo[b]thiophen-5- yl)difluoromethyl)phosphonic acid |
| 671 | 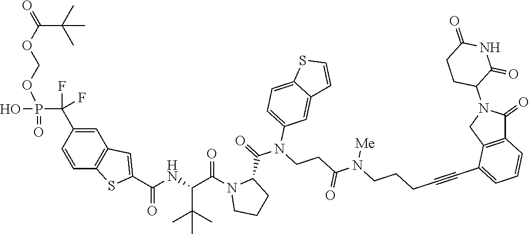 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)OCOC(=O)C(C)(C)C)ccc2s1)C(C)(C)C)c1ccc2sccc2c1] | ((((2-(((2S)-1-((2S)-2-(benzo[b]thiophen-5-yl(3-((5-(2-(2,6- dioxopiperidin-3-yl)-1-oxoisoindolin-4-yl)pent-4-yn-1- yl)(methyl)amino)-3-oxopropyl)carbamoyl)pyrrolidin-1-yl)- 3,3-dimethyl-1-oxobutan-2-yl)carbamoyl)benzo[b]thiophen-5- yl)difluoromethyl)(hydroxy)phosphoryl)oxy)methyl pivalate |
| 672 | 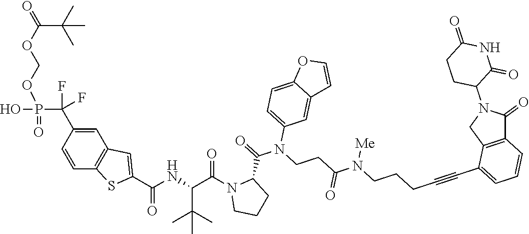 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)OCOC(=O)C(C)(C)C)ccc2s1)C(C)(C)C)c1ccc2occc2c1] | ((((2-(((2S)-1-((2S)-2-(benzofuran-5-yl(3-((5-(2-(2,6- dioxopiperidin-3-yl)-1-oxoisoindolin-4-yl)pent-4-yn-1- yl)(methyl)amino)-3-oxopropyl)carbamoyl)pyrrolidin-1-yl)- 3,3-dimethyl-1-oxobutan-2-yl)carbamoyl)benzo[b]thiophen-5- yl)difluoromethyl)(hydroxy)phosphoryl)oxy)methyl pivalate |
| 673 | 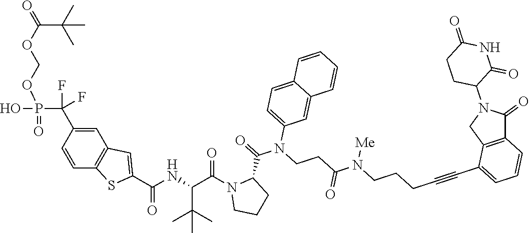 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)OCOC(=O)C(C)(C)C)ccc2s1)C(C)(C)C)c1ccc2ccccc2c1] | ((((2-(((2S)-1-((2S)-2-((3-((5-(2-(2,6-dioxopiperidin-3-yl)-1- oxoisoindolin-4-yl)pent-4-yn-1-yl)(methyl)amino)-3- oxopropyl)(naphthalen-2-yl)carbamoyl)pyrrolidin-1-yl)-3,3- dimethyl-1-oxobutan-2-yl)carbamoyl)benzo[b]thiophen-5- yl)difluoromethyl)(hydroxy)phosphoryl)oxy)methyl pivalate |
| 674 | 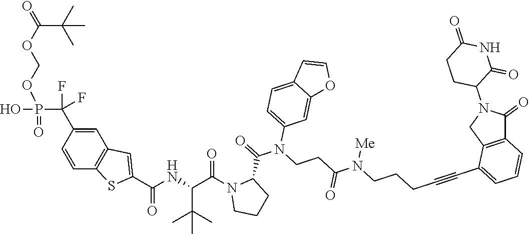 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)OCOC(=O)C(C)(C)C)ccc2s1)C(C)(C)C)c1ccc2ccoc2c1] | ((((2-(((2S)-1-((2S)-2-(benzofuran-6-yl(3-((5-(2-(2,6- dioxopiperidin-3-yl)-1-oxoisoindolin-4-yl)pent-4-yn-1- yl)(methyl)amino)-3-oxopropyl)carbamoyl)pyrrolidin-1-yl)- 3,3-dimethyl-1-oxobutan-2-yl)carbamoyl)benzo[b]thiophen-5- yl)difluoromethyl)(hydroxy)phosphoryl)oxy)methyl pivalate |
| 675 | 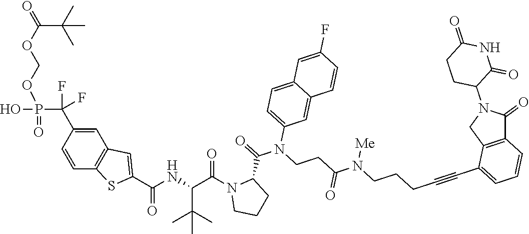 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)OCOC(=O)C(C)(C)C)ccc2s1)C(C)(C)C)c1ccc2cc(F)ccc2c1] | ((((2-(((2S)-1-((2S)-2-((3-((5-(2-(2,6-dioxopiperidin-3-yl)-1- oxoisoindolin-4-yl)pent-4-yn-1-yl)(methyl)amino)-3- oxopropyl)(6-fluoronaphthalen-2-yl)carbamoyl)pyrrolidin-1- yl)-3,3-dimethyl-1-oxobutan-2- yl)carbamoyl)benzo[b]thiophen-5- yl)difluoromethyl)(hydroxy)phosphoryl)oxy)methyl pivalate |
| 676 | 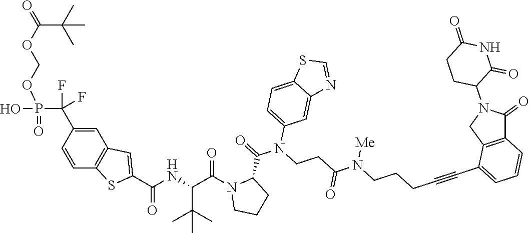 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)OCOC(=O)C(C)(C)C)ccc2s1)C(C)(C)C)c1ccc2scnc2c1] | ((((2-(((2S)-1-((2S)-2-(benzo[d]thiazol-5-yl(3-((5-(2-(2,6- dioxopiperidin-3-yl)-1-oxoisoindolin-4-yl)pent-4-yn-1- yl)(methyl)amino)-3-oxopropyl)carbamoyl)pyrrolidin-1-yl)- 3,3-dimethyl-1-oxobutan-2-yl)carbamoyl)benzo[b]thiophen-5- yl)difluoromethyl)(hydroxy)phosphoryl)oxy)methyl pivalate |
| 677 | 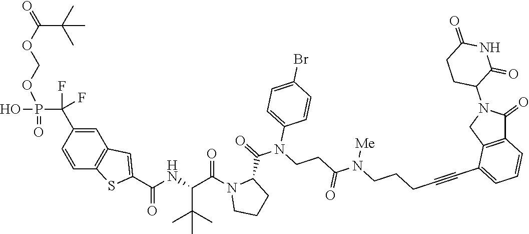 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)OCOC(=O)C(C)(C)C)ccc2s1)C(C)(C)C)c1ccc(Br)cc1] | ((((2-(((2S)-1-((2S)-2-((4-bromophenyl)(3-((5-(2-(2,6- dioxopiperidin-3-yl)-1-oxoisoindolin-4-yl)pent-4-yn-1- yl)(methyl)amino)-3-oxopropyl)carbamoyl)pyrrolidin-1-yl)- 3,3-dimethyl-1-oxobutan-2-yl)carbamoyl)benzo[b]thiophen-5- yl)difluoromethyl)(hydroxy)phosphoryl)oxy)methyl pivalate |
| 678 | 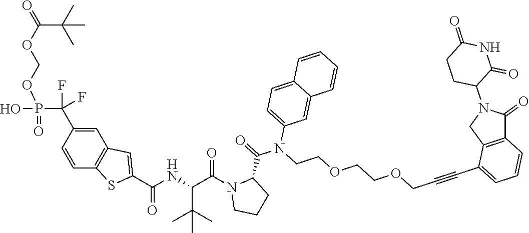 [SMILES: CC(C)(C)C(=O)OCOP(=O)(O)C(F)(F)c1ccc2sc(C(=O)N[C@H](C(=O)N3CCC[C@H]3C(=O)N(CCOCCOCC#Cc3cccc4c3CN(C3CCC(=O)NC3=O)C4=O)c3ccc4ccccc4c3)C(C)(C)C)cc2c1] | ((((2-(((2S)-1-((2S)-2-((2-(2-((3-(2-(2,6-dioxopiperidin-3-yl)-1- oxoisoindolin-4-yl)prop-2-yn-1- yl)oxy)ethoxy)ethyl)(naphthalen-2-yl)carbamoyl)pyrrolidin-1- yl)-3,3-dimethyl-1-oxobutan-2- yl)carbamoyl)benzo[b]thiophen-5- yl)difluoromethyl)(hydroxy)phosphoryl)oxy)methyl pivalate |
| 679 | 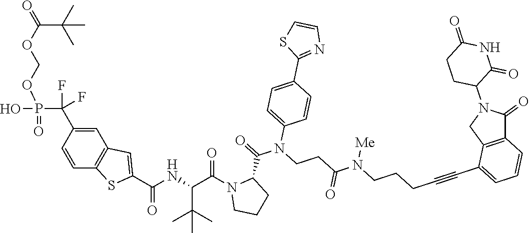 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)OCOC(=O)C(C)(C)C)ccc2s1)C(C)(C)C)c1ccc(-c2nccs2)cc1] | ((((2-(((2S)-1-((2S)-2-((3-((5-(2-(2,6-dioxopiperidin-3-yl)-1- oxoisoindolin-4-yl)pent-4-yn-1-yl)(methyl)amino)-3- oxopropyl)(4-(thiazol-2-yl)phenyl)carbamoyl)pyrrolidin-1-yl)- 3,3-dimethyl-1-oxobutan-2-yl)carbamoyl)benzo[b]thiophen-5- yl)difluoromethyl)(hydroxy)phosphoryl)oxy)methyl pivalate |
| 680 | 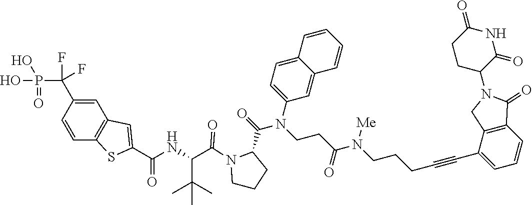 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc2ccccc2c1] | ((2-(((2S)-1-((2S)-2-((3-((5-(2-(2,6-dioxopiperidin-3-yl)-1- oxoisoindolin-4-yl)pent-4-yn-1-yl)(methyl)amino)-3- oxopropyl)(naphthalen-2-yl)carbamoyl)pyrrolidin-1-yl)-3,3- dimethyl-1-oxobutan-2-yl)carbamoyl)benzo[b]thiophen-5- yl)difluoromethyl)phosphonic acid |
| 681 | 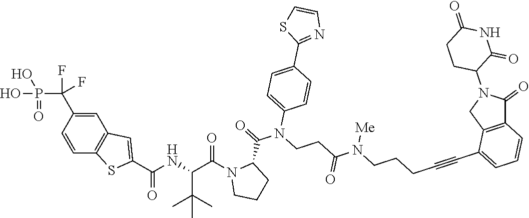 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc(-c2nccs2)cc1] | ((2-(((2S)-1-((2S)-2-((3-((5-(2-(2,6-dioxopiperidin-3-yl)-1- oxoisoindolin-4-yl)pent-4-yn-1-yl)(methyl)amino)-3- oxopropyl)(4-(thiazol-2-yl)phenyl)carbamoyl)pyrrolidin-1-yl)- 3,3-dimethyl-1-oxobutan-2-yl)carbamoyl)benzo[b]thiophen-5- yl)difluoromethyl)phosphonic acid |
| 682 | 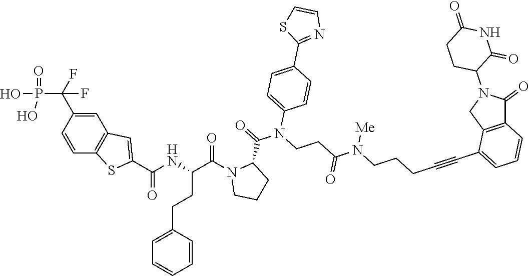 [SMILES: CN(CCCC#Cc1cccc2c1CN(C1CCC(=O)NC1=O)C2=O)C(=O)CCN(C(=O)[C@@H]1CCCN1C(=O)[C@H](CCc1ccccc1)NC(=O)c1cc2cc(C(F)(F)P(=O)(O)O)ccc2s1)c1ccc(-c2nccs2)cc1] | ((2-(((2S)-1-((2S)-2-((3-((5-(2-(2,6-dioxopiperidin-3-yl)-1- oxoisoindolin-4-yl)pent-4-yn-1-yl)(methyl)amino)-3- oxopropyl)(4-(thiazol-2-yl)phenyl)carbamoyl)pyrrolidin-1-yl)- 1-oxo-4-phenylbutan-2-yl)carbamoyl)benzo[b]thiophen-5- yl)difluoromethyl)phosphonic acid |
| 683 | 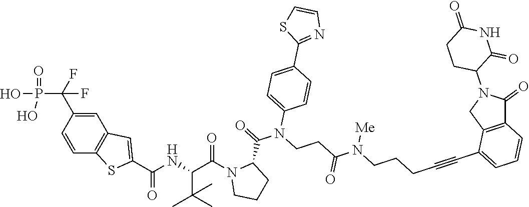 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc(-c2nccs2)cc1] | ((2-(((2S)-1-((2S)-2-(benzofuran-5-yl(3-((5-(2-(2,6- dioxopiperidin-3-yl)-1-oxoisoindolin-4-yl)pent-4-yn-1- yl)(methyl)amino)-3-oxopropyl)carbamoyl)pyrrolidin-1-yl)- 3,3-dimethyl-1-oxobutan-2-yl)carbamoyl)benzo[b]thiophen-5- yl)difluoromethyl)phosphonic acid |
| 684 | 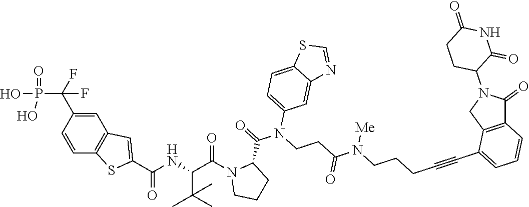 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc2scnc2c1] | ((2-(((2S)-1-((2S)-2-(benzo[d]thiazol-5-yl(3-((5-(2-(2,6- dioxopiperidin-3-yl)-1-oxoisoindolin-4-yl)pent-4-yn-1- yl)(methyl)amino)-3-oxopropyl)carbamoyl)pyrrolidin-1-yl)- 3,3-dimethyl-1-oxobutan-2-yl)carbamoyl)benzo[b]thiophen-5- yl)difluoromethyl)phosphonic acid |
| 685 | 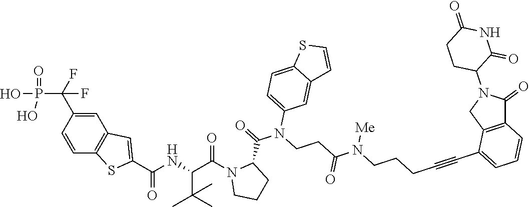 [SMILES: CN(CCCC#Cc1cccc2c1CN(C1CCC(=O)NC1=O)C2=O)C(=O)CCN(C(=O)[C@@H]1CCCN1C(=O)[C@@H](NC(=O)c1cc2cc(C(F)(F)P(=O)(O)O)ccc2s1)C(C)(C)C)c1ccc2sccc2c1] | ((2-(((2S)-1-((2S)-2-(benzo[b]thiophen-5-yl(3-((5-(2-(2,6- dioxopiperidin-3-yl)-1-oxoisoindolin-4-yl)pent-4-yn-1- yl)(methyl)amino)-3-oxopropyl)carbamoyl)pyrrolidin-1-yl)- 3,3-dimethyl-1-oxobutan-2-yl)carbamoyl)benzo[b]thiophen-5- yl)difluoromethyl)phosphonic acid |
| 686 | 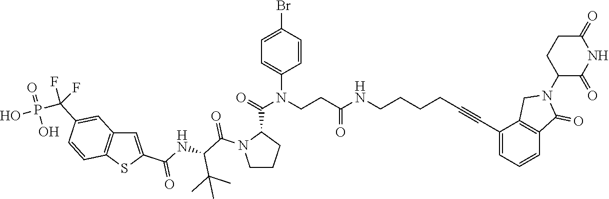 [SMILES: CC(C)(C)[C@H](NC(=O)c1cc2cc(C(F)(F)P(=O)(O)O)ccc2s1)C(=O)N1CCC[C@H]1C(=O)N(CCC(=O)NCCCCC#Cc1cccc2c1CN(C1CCC(=O)NC1=O)C2=O)c1ccc(Br)cc1] | ((2-(((2S)-1-((2S)-2-((4-bromophenyl)(3-((6-(2-(2,6- dioxopiperidin-3-yl)-1-oxoisoindolin-4-yl)hex-5-yn-1- yl)amino)-3-oxopropyl)carbamoyl)pyrrolidin-1-yl)-3,3- dimethyl-1-oxobutan-2-yl)carbamoyl)benzo[b]thiophen-5- yl)difluoromethyl)phosphonic acid |

### Further Forms of Compounds Disclosed Herein

### Pharmaceutically Acceptable Salts

In certain embodiments, the compounds disclosed herein exist as their pharmaceutically acceptable salts. In certain embodiments, the methods disclosed herein include methods of treating diseases by administering such pharmaceutically acceptable salts. In certain embodiments, the methods disclosed herein include methods of treating diseases by administering such pharmaceutically acceptable salts as pharmaceutical compositions.

In certain embodiments, the compounds described herein possess acidic or basic groups and therefor react with any of a number of inorganic or organic bases, and inorganic and organic acids, to form a pharmaceutically acceptable salt. In certain embodiments, these salts are prepared in situ during the final isolation and purification of the compounds disclosed herein, or by separately reacting a purified compound in its free form with a suitable acid or base, and isolating the salt thus formed.

Examples of pharmaceutically acceptable salts include those salts prepared by reaction of the compounds described herein with a mineral, organic acid, or inorganic base, such salts including acetate, acrylate, adipate, alginate, aspartate, benzoate, benzenesulfonate, bisulfate, bisulfite, bromide, butyrate, butyn-1,4-dioate, camphorate, camphorsulfonate, caproate, caprylate, chlorobenzoate, chloride, citrate, cyclopentanepropionate, decanoate, digluconate, dihydrogenphosphate, dinitrobenzoate, dodecylsulfate, ethanesulfonate, formate, fumarate, glucoheptanoate, glycerophosphate, glycolate, hemisulfate, heptanoate, hexanoate, hexyne-1,6-dioate, hydroxybenzoate, 7-hydroxybutyrate, hydrochloride, hydrobromide, hydroiodide, 2-hydroxyethanesulfonate, iodide, isobutyrate, lactate, maleate, malonate, methanesulfonate, mandelate metaphosphate, methanesulfonate, methoxybenzoate, methylbenzoate, monohydrogenphosphate, 1-napthalenesulfonate, 2-napthalenesulfonate, nicotinate, nitrate, palmoate, pectinate, persulfate, 3-phenylpropionate, phosphate, picrate, pivalate, propionate, pyrosulfate, pyrophosphate, propiolate, phthalate, phenylacetate, phenylbutyrate, propanesulfonate, salicylate, succinate, sulfate, sulfite, succinate, suberate, sebacate, sulfonate, tartrate, thiocyanate, tosylateundeconate, and xylenesulfonate.

Further, the compounds described herein can be prepared as pharmaceutically acceptable salts formed by reacting the free base form of the compound with a pharmaceutically acceptable inorganic or organic acid, including, but not limited to, inorganic acids such as hydrochloric acid, hydrobromic acid, sulfuric acid, nitric acid, phosphoric acid metaphosphoric acid, and the like; and organic acids such as acetic acid, propionic acid, hexanoic acid, cyclopentanepropionic acid, glycolic acid, pyruvic acid, lactic acid, malonic acid, succinic acid, malic acid, maleic acid, fumaric acid, p-toluenesulfonic acid, tartaric acid, trifluoroacetic acid, citric acid, benzoic acid, 3-(4-hydroxybenzoyl)benzoic acid, cinnamic acid, mandelic acid, arylsulfonic acid, methanesulfonic acid, ethanesulfonic acid, 1,2-ethanedisulfonic acid, 2-hydroxyethanesulfonic acid, benzenesulfonic acid, 2-naphthalenesulfonic acid, 4-methylbicyclo-[2.2.2]oct-2-ene-1-carboxylic acid, glucoheptonic acid, 4,4′-methylenebis-(3-hydroxy-2-ene-1-carboxylic acid), 3-phenylpropionic acid, trimethylacetic acid, tertiary butylacetic acid, lauryl sulfuric acid, gluconic acid, glutamic acid, hydroxynaphthoic acid, salicylic acid, stearic acid, and muconic acid.

In certain embodiments, those compounds described herein which comprise a free acid group react with a suitable base, such as the hydroxide, carbonate, bicarbonate, or sulfate of a pharmaceutically acceptable metal cation, with ammonia, or with a pharmaceutically acceptable organic primary, secondary, tertiary, or quaternary amine. Representative salts include the alkali or alkaline earth salts, like lithium, sodium, potassium, calcium, and magnesium, and aluminum salts and the like. Illustrative examples of bases include sodium hydroxide, potassium hydroxide, choline hydroxide, sodium carbonate, N⁺(C₁₋₄ alkyl)₄, and the like.

Representative organic amines useful for the formation of base addition salts include ethylamine, diethylamine, ethylenediamine, ethanolamine, diethanolamine, piperazine, and the like. It should be understood that the compounds described herein also include the quaternization of any basic nitrogen-containing groups they contain. In certain embodiments, water or oil-soluble or dispersible products are obtained by such quaternization.

### Solvates

Those skilled in the art of organic chemistry will appreciate that many organic compounds can form complexes with solvents in which they are reacted or from which they are precipitated or crystallized. These complexes are known as “solvates”. For example, a complex with water is known as a “hydrate”. Solvates are within the scope of the invention.

It will also be appreciated by those skilled in organic chemistry that many organic compounds can exist in more than one crystalline form. For example, crystalline form may vary from solvate to solvate. Thus, all crystalline forms or the pharmaceutically acceptable solvates thereof are contemplated and are within the scope of the present invention.

In certain embodiments, the compounds described herein exist as solvates. The present disclosure provides for methods of treating diseases by administering such solvates. The present disclosure further provides for methods of treating diseases by administering such solvates as pharmaceutical compositions.

Solvates contain either stoichiometric or non-stoichiometric amounts of a solvent, such as water, ethanol, and the like. Hydrates are formed when the solvent is water, or alcoholates are formed when the solvent is alcohol. Solvates of the compounds described herein can be conveniently prepared or formed during the processes described herein. In addition, the compounds provided herein can exist in unsolvated as well as solvated forms. In general, the solvated forms are considered equivalent to the unsolvated forms for the purposes of the compounds and methods provided herein.

### Isomers/Stereoisomers

It is also to be understood that compounds that have the same molecular formula but differ in the nature or sequence of bonding of their atoms or the arrangement of their atoms in space are termed “isomers.” Isomers that differ in the arrangement of their atoms in space are termed “stereoisomers.”

In certain embodiments, the compounds described herein exist as geometric isomers. In certain embodiments, the compounds described herein possess one or more double bonds. The compounds disclosed herein include all cis, trans, syn, anti, entgegen (E), and zusammen (Z) isomers as well as the corresponding mixtures thereof. All geometric forms of the compounds disclosed herein are contemplated and are within the scope of the invention.

In certain embodiments, the compounds disclosed herein possess one or more chiral centers and each center exists in the R configuration or S configuration. The compounds disclosed herein include all diastereomeric, enantiomeric, and epimeric forms as well as the corresponding mixtures thereof. All diastereomeric, enantiomeric, and epimeric forms of the compounds disclosed herein are contemplated and are within the scope of the invention.

In additional embodiments of the compounds and methods provided herein, mixtures of enantiomers and/or diastereoisomers, resulting from a single preparative step, combination, or interconversion are useful for the applications described herein. In certain embodiments, the compounds described herein are prepared as their individual stereoisomers by reacting a racemic mixture of the compound with an optically active resolving agent to form a pair of diastereoisomeric compounds, separating the diastereomers, and recovering the optically pure enantiomers. In certain embodiments, dissociable complexes are preferred. In certain embodiments, the diastereomers have distinct physical properties (e.g., melting points, boiling points, solubilities, reactivity, etc.) and are separated by taking advantage of these dissimilarities. In certain embodiments, the diastereomers are separated by chiral chromatography, or preferably, by separation/resolution techniques based upon differences in solubility. In certain embodiments, the optically pure enantiomer is then recovered, along with the resolving agent.

### Tautomers

In certain embodiments, compounds described herein exist as tautomers. The compounds described herein include all possible tautomers within the formulas described herein.

Tautomers are compounds that are interconvertible by migration of a hydrogen atom, accompanied by a switch of a single bond and an adjacent double bond. In bonding arrangements where tautomerization is possible, a chemical equilibrium of the tautomers will exist. All tautomeric forms of the compounds disclosed herein are contemplated and are within the scope of the invention. The exact ratio of the tautomers depends on several factors, including temperature, solvent, and pH.

### Pharmaceutical Compositions

In certain embodiments, the compound described herein is administered as a pure chemical. In some embodiments, the compound described herein is combined with a pharmaceutically suitable or acceptable carrier (also referred to herein as a pharmaceutically suitable (or acceptable) excipient, physiologically suitable (or acceptable) excipient, or physiologically suitable (or acceptable) carrier) selected on the basis of a chosen route of administration and standard pharmaceutical practice as described, for example, in Remington: The Science and Practice of Pharmacy (Gennaro, 21^{st} Ed. Mack Pub. Co., Easton, PA (2005)).

Accordingly, the present disclosure provides pharmaceutical compositions comprising a compound described herein, or a pharmaceutically acceptable salt, solvate, or stereoisomer thereof, and a pharmaceutically acceptable excipient.

In certain embodiments, the compound provided herein is substantially pure, in that it contains less than about 5%, less than about 1%, or less than about 0.1% of other organic small molecules, such as unreacted intermediates or synthesis by-products that are created, for example, in one or more of the steps of a synthesis method.

Pharmaceutical compositions are administered in a manner appropriate to the disease to be treated (or prevented). An appropriate dose and a suitable duration and frequency of administration will be determined by such factors as the condition of the patient, the type and severity of the patient's disease, the particular form of the active ingredient, and the method of administration. In general, an appropriate dose and treatment regimen provides the composition(s) in an amount sufficient to provide therapeutic and/or prophylactic benefit (e.g., an improved clinical outcome, such as more frequent complete or partial remissions, or longer disease-free and/or overall survival, or a lessening of symptom severity. Optimal doses are generally determined using experimental models and/or clinical trials. The optimal dose depends upon the body mass, weight, or blood volume of the patient.

In some embodiments, the pharmaceutical composition is formulated for oral, topical (including buccal and sublingual), rectal, vaginal, transdermal, parenteral, intrapulmonary, intradermal, intrathecal and epidural and intranasal administration. Parenteral administration includes intramuscular, intravenous, intraarterial, intraperitoneal, or subcutaneous administration. In some embodiments, the pharmaceutical composition is formulated for intravenous injection, oral administration, inhalation, nasal administration, topical administration, or ophthalmic administration. In some embodiments, the pharmaceutical composition is formulated for oral administration. In some embodiments, the pharmaceutical composition is formulated for intravenous injection. In some embodiments, the pharmaceutical composition is formulated as a tablet, a pill, a capsule, a liquid, an inhalant, a nasal spray solution, a suppository, a suspension, a gel, a colloid, a dispersion, a suspension, a solution, an emulsion, an ointment, a lotion, an eye drop, or an ear drop. In some embodiments, the pharmaceutical composition is formulated as a tablet.

### Preparation, Characterization, and Biological Assay of the Compounds

The compounds of the present disclosure may be prepared by a variety of methods, including standard chemistry. In certain embodiments, the compounds of the present disclosure may be prepared by following the general synthetic routes depicted in the schemes given below:

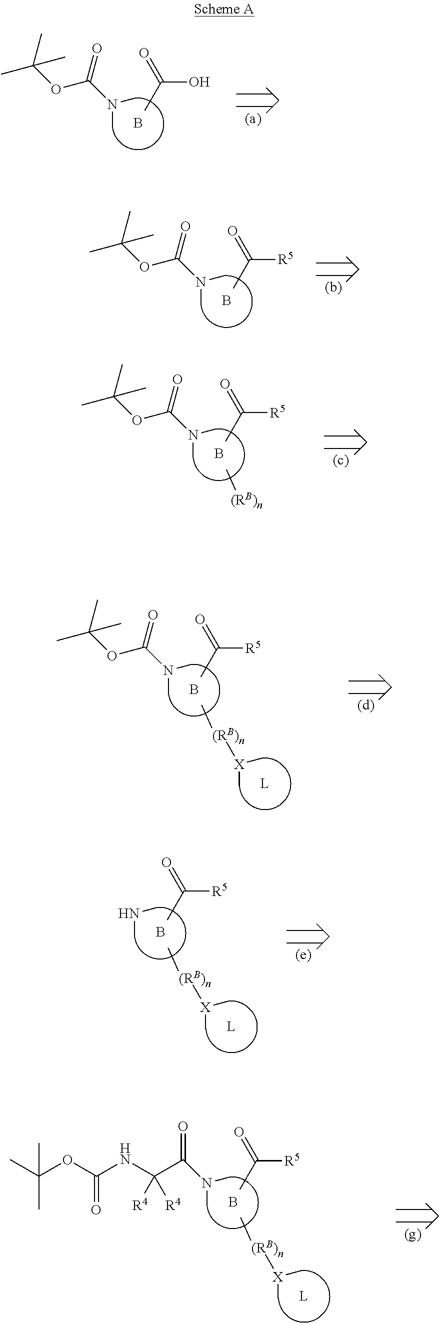

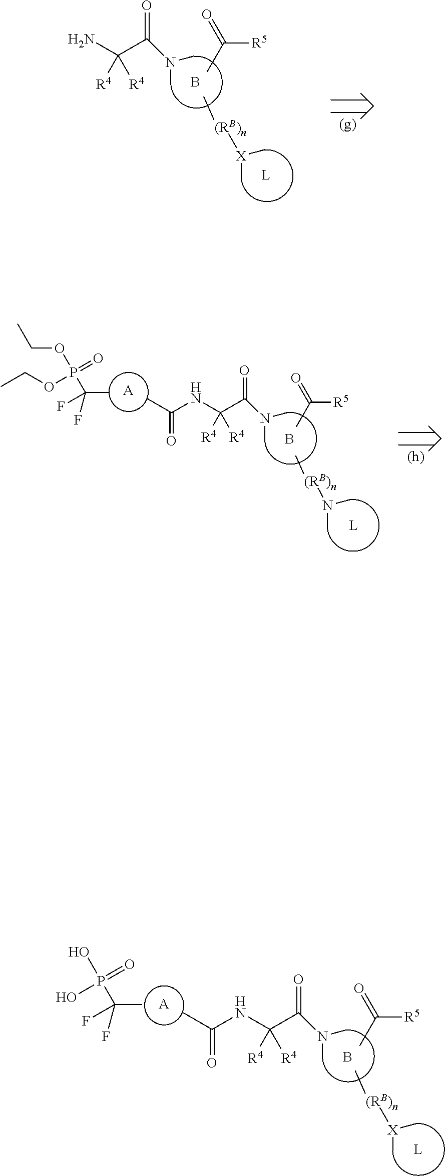

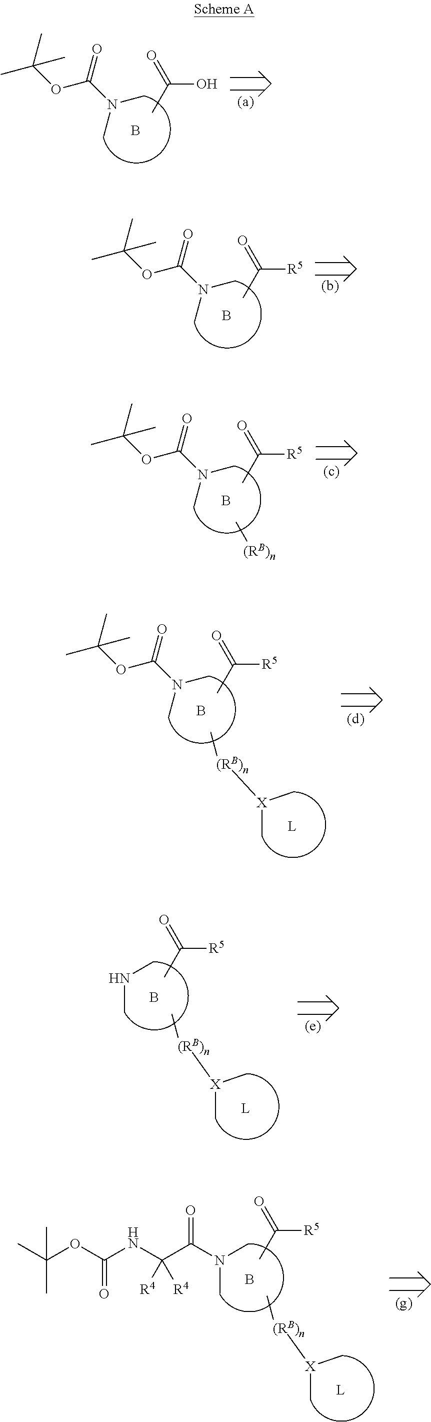

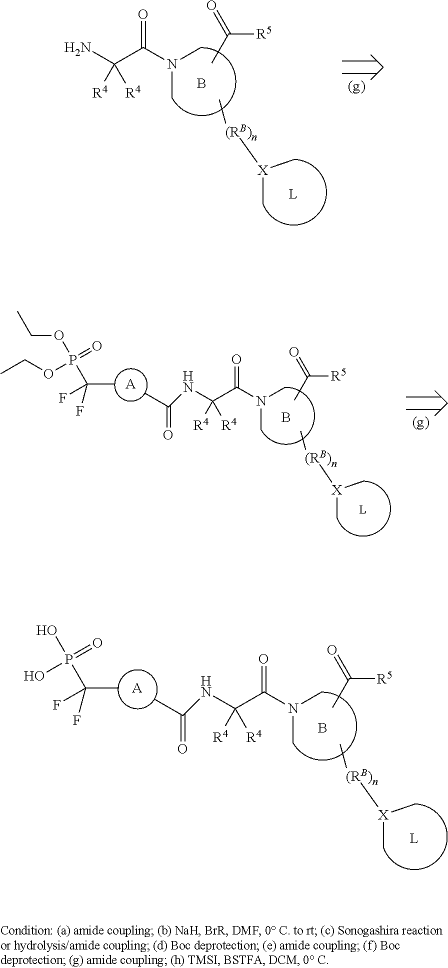

The compounds used in the reactions described herein are prepared according to organic synthesis techniques known to those skilled in this art, starting from commercially available chemicals and/or from compounds described in the chemical literature. “Commercially available chemicals” are obtained from standard commercial sources including Acros Organics (Pittsburgh, PA), Aldrich Chemical (Milwaukee, WI, including Sigma Chemical and Fluka), Apin Chemicals Ltd. (Milton Park, UK), Avocado Research (Lancashire, U.K.), BDH, Inc. (Toronto, Canada), Bionet (Cornwall, U.K.), Chem Service Inc. (West Chester, PA), Crescent Chemical Co. (Hauppauge, NY), Eastman Organic Chemicals, Eastman Kodak Company (Rochester, NY), Fisher Scientific Co. (Pittsburgh, PA), Fisons Chemicals (Leicestershire, UK), Frontier Scientific (Logan, UT), ICN Biomedicals, Inc. (Costa Mesa, CA), Key Organics (Cornwall, U.K.), Lancaster Synthesis (Windham, NH), Maybridge Chemical Co. Ltd. (Cornwall, U.K.), Parish Chemical Co. (Orem, UT), Pfaltz & Bauer, Inc. (Waterbury, CN), Polyorganix (Houston, TX), Pierce Chemical Co. (Rockford, IL), Riedel de Haen AG (Hanover, Germany), Spectrum Quality Product, Inc. (New Brunswick, NJ), TCI America (Portland, OR), Trans World Chemicals, Inc. (Rockville, MD), and Wako Chemicals USA, Inc. (Richmond, VA).

Suitable reference books and treatises that detail the synthesis of reactants useful in the preparation of compounds described herein, or provide references to articles that describe the preparation, include for example, “Synthetic Organic Chemistry”, John Wiley & Sons, Inc., New York; S. R. Sandler et al., “Organic Functional Group Preparations,” 2nd Ed., Academic Press, New York, 1983; H. O. House, “Modern Synthetic Reactions”, 2nd Ed., W. A. Benjamin, Inc. Menlo Park, Calif. 1972; T. L. Gilchrist, “Heterocyclic Chemistry”, 2nd Ed., John Wiley & Sons, New York, 1992; J. March, “Advanced Organic Chemistry: Reactions, Mechanisms and Structure”, 4th Ed., Wiley-Interscience, New York, 1992. Additional suitable reference books and treatises that detail the synthesis of reactants useful in the preparation of compounds described herein, or provide references to articles that describe the preparation, include for example, Fuhrhop, J. and Penzlin G. “Organic Synthesis: Concepts, Methods, Starting Materials”, Second, Revised and Enlarged Edition (1994) John Wiley & Sons ISBN: 3-527-29074-5; Hoffman, R. V. “Organic Chemistry, An Intermediate Text” (1996) Oxford University Press, ISBN 0-19-509618-5; Larock, R. C. “Comprehensive Organic Transformations: A Guide to Functional Group Preparations” 2nd Edition (1999) Wiley-VCH, ISBN: 0-471-19031-4; March, J. “Advanced Organic Chemistry: Reactions, Mechanisms, and Structure” 4th Edition (1992) John Wiley & Sons, ISBN: 0-471-60180-2; Otera, J. (editor) “Modern Carbonyl Chemistry” (2000) Wiley-VCH, ISBN: 3-527-29871-1; Patai, S. “Patai's 1992 Guide to the Chemistry of Functional Groups” (1992) Interscience ISBN: 0-471-93022-9; Solomons, T. W. G. “Organic Chemistry” 7th Edition (2000) John Wiley & Sons, ISBN: 0-471-19095-0; Stowell, J. C., “Intermediate Organic Chemistry” 2nd Edition (1993) Wiley-Interscience, ISBN: 0-471-57456-2; “Industrial Organic Chemicals: Starting Materials and Intermediates: An Ullmann's Encyclopedia” (1999) John Wiley & Sons, ISBN: 3-527-29645-X, in 8 volumes; “Organic Reactions” (1942-2000) John Wiley & Sons, in over 55 volumes; and “Chemistry of Functional Groups” John Wiley & Sons, in 73 volumes.

Specific and analogous reactants are optionally identified through the indices of known chemicals prepared by the Chemical Abstract Service of the American Chemical Society, which are available in most public and university libraries, as well as through on-line. Chemicals that are known but not commercially available in catalogs are optionally prepared by custom chemical synthesis houses, where many of the standard chemical supply houses (e.g., those listed above) provide custom synthesis services. A reference for the preparation and selection of pharmaceutical salts of the compounds described herein is P. H. Stahl & C. G. Wermuth “Handbook of Pharmaceutical Salts”, Verlag Helvetica Chimica Acta, Zurich, 2002.

### Analytical Methods, Materials, and Instrumentation

Unless otherwise noted, reagents and solvents were used as received from commercial suppliers. Proton nuclear magnetic resonance (NMR) spectra were obtained on either Bruker or Varian spectrometers at 400 MHz. Spectra are given in ppm (δ) and coupling constants, J, are reported in Hertz. Tetramethylsilane (TMS) was used as an internal standard. Liquid chromatography-mass spectrometry (LC/MS) were collected using a SHIMADZU LCMS-2020EV or Agilent 1260-6125B LCMS. Purity and low-resolution mass spectral data were measured using Agilent 1260-6125B LCMS system (with Diode Array Detector, and Agilent G6125BA Mass spectrometer) or using Waters Acquity UPLC system (with Diode Array Detector, and Waters 3100 Mass Detector). The purity was characterized by UV wavelength 214 nm, 220 nm, 254 nm and ESI. Column: poroshell 120 EC-C18 2.7 μm 4.6×100 mm; Flow rate 0.8 mL/min; Solvent A (100/0.1 water/formic acid), Solvent B (100 acetonitrile); gradient: hold 5% B to 0.3 min, 5-95% B from 0.3 to 2 min, hold 95% B to 4.8 min, 95-5% B from 4.8 to 5.4 min, then hold 5% B to 6.5 min. Or, column: Acquity UPLC BEH C18 1.7 μm 2.1×50 mm; Flow rate 0.5 mL/min; Solvent A (0.1% formic acid water), Solvent B (acetonitrile); gradient: hold 5% B for 0.2 min, 5-95% B from 0.2 to 2.0 min, hold 95% B to 3.1 min, then 5% B at 3.5 min.

### Biological Assays

The biological activities of the compounds of the present application can be assessed with methods and assays known in the art.

Evaluation of the degradation efficiency of degraders may be accomplished by immunoblotting analysis. The representative general protocol is the following:

Immunoblotting.

Cells are maintained in the appropriate culture medium with 10% FBS at 37° C. and an atmosphere of 5% CO₂. Cell lines are used within three months of thawing fresh vials. Cells are lysed 1× Cell Lysis Buffer (Cell Signaling Technology, #9803), resolved by SDS-PAGE NuPAGE gel (Thermo Fisher Scientific), and transferred to a PVDF membrane (Millipore). Membranes are blocked using Odyssey TBS Blocker Buffer (LI-COR). IRDye 680RD and 800CW Dye-labeled secondary antibodies (LI-COR) are used. The washed membranes are scanned using Odyssey CLx imager (LI-COR). The intensity of Western blot signaling is quantitated using the Odyssey software. Primary antibodies used are: STAT5 Rabbit mAb (Cell Signaling Technology, #94205), STAT6 Rabbit mAb (Cell Signaling Technology, #5397) and GAPDH mouse monoclonal antibody (Santa Cruz Biotechnology, sc-47724).

### Methods of Use

In certain aspects, the present disclosure provides methods of degrading a STAT5 and/or STAT6 protein in a subject or biological sample, comprising administering a compound disclosed herein to the subject or contacting a compound disclosed herein with the biological sample (e.g., in a therapeutically effective amount).

In certain aspects, the present disclosure provides methods of degrading a STAT5 protein in a subject or biological sample, comprising administering a compound disclosed herein to the subject or contacting a compound disclosed herein with the biological sample (e.g., in a therapeutically effective amount).

In certain aspects, the present disclosure provides methods of degrading a STAT6 protein in a subject or biological sample, comprising administering a compound disclosed herein to the subject or contacting a compound disclosed herein with the biological sample (e.g., in a therapeutically effective amount).

In certain aspects, the present disclosure provides uses of a compound disclosed herein in the manufacture of a medicament for degrading a STAT5 and/or STAT6 protein in a subject or biological sample.

In certain aspects, the present disclosure provides uses of a compound disclosed herein in the manufacture of a medicament for degrading a STAT5 protein in a subject or biological sample.

In certain aspects, the present disclosure provides uses of a compound disclosed herein in the manufacture of a medicament for degrading a STAT6 protein in a subject or biological sample.

In certain aspects, the present disclosure provides compounds disclosed herein for use in degrading a STAT5 and/or STAT6 protein in a subject or biological sample.

In certain aspects, the present disclosure provides compounds disclosed herein for use in degrading a STAT5 protein in a subject or biological sample.

In certain aspects, the present disclosure provides compounds disclosed herein for use in degrading a STAT6 protein in a subject or biological sample.

In certain aspects, the present disclosure provides methods of treating or preventing a disease or disorder in a subject, comprising administering a compound disclosed herein to the subject (e.g., in a therapeutically effective amount).

In certain aspects, the present disclosure provides uses of a compound disclosed herein in the manufacture of a medicament for treating or preventing a disease or disorder.

In certain aspects, the present disclosure provides compounds disclosed herein for use in treating or preventing a disease or disorder.

In certain aspects, the present disclosure provides methods of treating a disease or disorder in a patient, comprising administering a compound disclosed herein to the subject (e.g., in a therapeutically effective amount).

In certain aspects, the present disclosure provides uses of a compound disclosed herein in the manufacture of a medicament for treating a disease or disorder.

In certain aspects, the present disclosure provides compounds disclosed herein for use in treating a disease or disorder.

In some embodiments, the disease or disorder is mediated by a STAT5 and/or STAT6 protein. In some embodiments, the disease or disorder is cancer.

In some embodiments, the disease or disorder is mediated by a STAT5 protein. In some embodiments, the disease or disorder is cancer.

In some embodiments, the disease or disorder is mediated by a STAT6 protein. In some embodiments, the disease or disorder is cancer.

In certain embodiments, the disease or disorder is breast cancer, colorectal cancer, lung cancer, prostate cancer, liver cancer, hematological malignancies, T-cell lymphoma, acute leukemia and chronic myeloid leukemia, solitary fibrous tumor, solid tumors, asthma, atopic dermatitis, eosinophilic esophagitis or food allergies.

In certain embodiments, the subject is a mammal.

In certain embodiments, the subject is a human.

### Definitions

As used in the specification and appended claims, unless specified to the contrary, the following terms have the meaning indicated below.

### Chemical Definitions

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Thomas Sorrell, Organic Chemistry, University Science Books, Sausalito, 1999; Smith and March, March's Advanced Organic Chemistry, 5^{th} Edition, John Wiley &amp; Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

Compounds described herein can comprise one or more asymmetric centers, and thus can exist in various isomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPFC) and the formation and crystallization of chiral salts; or preferred isomers can be prepared by asymmetric syntheses. See, for example, Jacques et al., Enantiomers, Racemates and Resolutions (Wiley Interscience, New York, 1981); Wilen et al., Tetrahedron 33:2725 (1977); Eliel, Stereochemistry of Carbon Compounds (McGraw-Hill, N Y, 1962); and Wilen, Tables of Resolving Agents and Optical Resolutions p. 268 (E. F. Eliel, Ed., Univ. of Notre Dame Press, Notre Dame, IN 1972).

The invention additionally encompasses compounds described herein as individual isomers substantially free of other isomers, and alternatively, as mixtures of various isomers.

When a range of values is listed, it is intended to encompass each value and sub-range within the range. For example, “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The following terms are intended to have the meanings presented therewith below and are useful in understanding the description and intended scope of the present invention. When describing the invention, which may include compounds, pharmaceutical compositions containing such compounds and methods of using such compounds and compositions, the following terms, if present, have the following meanings unless otherwise indicated. It should also be understood that when described herein any of the moieties defined forth below may be substituted with a variety of substituents, and that the respective definitions are intended to include such substituted moieties within their scope as set out below. Unless otherwise stated, the term “substituted” is to be defined as set out below. It should be further understood that the terms “groups” and “radicals” can be considered interchangeable when used herein. The articles “a” and “an” may be used herein to refer to one or to more than one (i.e., at least one) of the grammatical objects of the article. By way of example “an analogue” means one analogue or more than one analogue.

“Alkyl” as used herein, refers to a radical of a straight-chain or branched saturated hydrocarbon group having from 1 to 20 carbon atoms (“C₁₋₂₀ alkyl”). In certain embodiments, an alkyl group has 1 to 12 carbon atoms (“C₁₋₁₂ alkyl”). In certain embodiments, an alkyl group has 1 to 10 carbon atoms (“C₁₋₁₀ alkyl”). In certain embodiments, an alkyl group has 1 to 9 carbon atoms (“C₁₋₉ alkyl”). In certain embodiments, an alkyl group has 1 to 8 carbon atoms (“C₁₋₈ alkyl”). In certain embodiments, an alkyl group has 1 to 7 carbon atoms (“C₁₋₇ alkyl”). In certain embodiments, an alkyl group has 1 to 6 carbon atoms (“C₁₋₆ alkyl”, which is also referred to herein as “lower alkyl”). In certain embodiments, an alkyl group has 1 to 5 carbon atoms (“C₁₋₅ alkyl”). In certain embodiments, an alkyl group has 1 to 4 carbon atoms (“C₁₋₄ alkyl”). In certain embodiments, an alkyl group has 1 to 3 carbon atoms (“C₁₋₃ alkyl”). In certain embodiments, an alkyl group has 1 to 2 carbon atoms (“C₁₋₂ alkyl”). In certain embodiments, an alkyl group has 1 carbon atom (“C₁ alkyl”). Examples of C₁₋₆ alkyl groups include methyl (C₁), ethyl (C₂), n-propyl (C₃), isopropyl (C₃), n-butyl (C₄), tert-butyl (C₄), sec-butyl (C₄), isobutyl (C₄), n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (C₈) and the like. Unless otherwise specified, each instance of an alkyl group is independently optionally substituted, i.e., unsubstituted (an “unsubstituted alkyl”) or substituted (a “substituted alkyl”) with one or more substituents; e.g., for instance from 1 to 5 substituents, 1 to 3 substituents, or 1 substituent. In certain embodiments, the alkyl group is unsubstituted C₁₋₁₀ alkyl (e.g., —CH₃). In certain embodiments, the alkyl group is substituted C₁-10 alkyl. Common alkyl abbreviations include Me (—CH₃), Et (—CH₂CH₃), i-Pr (—CH(CH₃)₂), n-Pr (—CH₂CH₂CH₃), n-Bu (—CH₂CH₂CH₂CH₃), or i-Bu (—CH₂CH(CH₃)₂).

“Alkylene” as used herein, refers to an alkyl group wherein two hydrogens are removed to provide a divalent radical. When a range or number of carbons is provided for a particular “alkylene” group, it is understood that the range or number refers to the range or number of carbons in the linear carbon divalent chain. An “alkelene” group may be substituted or unsubstituted with one or more substituents as described herein. Exemplary unsubstituted divalent alkylene groups include, but are not limited to, methylene (—CH₂—), ethylene (—CH₂CH₂—), propylene (—CH₂CH₂CH₂—), butylene (—CH₂CH₂CH₂CH₂—), pentylene (—CH₂CH₂CH₂CH₂CH₂—), hexylene (—CH₂CH₂CH₂CH₂CH₂CH₂—), and the like. Exemplary substituted divalent alkylene groups, e.g., substituted with one or more alkyl (methyl) groups, include but are not limited to, substituted methylene (—CH(CH₃)—, (—C(CH₃)₂—), substituted ethylene (—CH(CH₃)CH₂—, —CH₂CH(CH₃)—, —C(CH₃)₂CH₂—, —CH₂C(CH₃)₂—), substituted propylene (—CH(CH₃)CH₂CH₂—, —CH₂CH(CH₃)CH₂—, —CH₂CH₂CH(CH₃)—, —C(CH₃)₂CH₂CH₂—, —CH₂C(CH₃)₂CH₂—, —CH₂CH₂C(CH₃)₂—), and the like.

“Alkenyl” as used herein, refers to a radical of a straight-chain or branched hydrocarbon group having from 2 to 20 carbon atoms, one or more carbon-carbon double bonds (e.g., 1, 2, 3, or 4 carbon-carbon double bonds), and optionally one or more carbon-carbon triple bonds (e.g., 1, 2, 3, or 4 carbon-carbon triple bonds) (“C₂₋₂₀ alkenyl”). In certain embodiments, alkenyl does not contain any triple bonds. In certain embodiments, an alkenyl group has 2 to 10 carbon atoms (“C₂₋₁₀ alkenyl”). In certain embodiments, an alkenyl group has 2 to 9 carbon atoms (“C₂₋₉ alkenyl”). In certain embodiments, an alkenyl group has 2 to 8 carbon atoms (“C₂₋₈ alkenyl”). In certain embodiments, an alkenyl group has 2 to 7 carbon atoms (“C₂₋₇ alkenyl”). In certain embodiments, an alkenyl group has 2 to 6 carbon atoms (“C₂₋₆ alkenyl”). In certain embodiments, an alkenyl group has 2 to 5 carbon atoms (“C₂₋₅ alkenyl”). In certain embodiments, an alkenyl group has 2 to 4 carbon atoms (“C₂₋₄ alkenyl”). In certain embodiments, an alkenyl group has 2 to 3 carbon atoms (“C₂₋₃ alkenyl”). In certain embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently optionally substituted, i.e., unsubstituted (an “unsubstituted alkenyl”) or substituted (a “substituted alkenyl”) with one or more substituents e.g., for instance from 1 to 5 substituents, 1 to 3 substituents, or 1 substituent. In certain embodiments, the alkenyl group is unsubstituted C₂₋₁₀ alkenyl. In certain embodiments, the alkenyl group is substituted C₂₋₁₀ alkenyl.

“Alkenylene” as used herein, refers to an alkenyl group wherein two hydrogens are removed to provide a divalent radical. When a range or number of carbons is provided for a particular “alkenylene” group, it is understood that the range or number refers to the range or number of carbons in the linear carbon divalent chain. An “alkenylene” group may be substituted or unsubstituted with one or more substituents as described herein. Exemplary unsubstituted divalent alkenylene groups include, but are not limited to, ethenylene (—CH═CH—) and propenylene (e.g., —CH═CHCH₂—, —CH₂—CH═CH—). Exemplary substituted divalent alkenylene groups, e.g., substituted with one or more alkyl (methyl) groups, include but are not limited to, substituted ethylene (—C(CH₃)═CH—, —CH═C(CH₃)—), substituted propylene (e.g., —C(CH₃)═CHCH₂—, —CH═C(CH₃)CH₂—, —CH═CHCH(CH₃)—, —CH═CHC(CH₃)₂—, —CH(CH₃)—CH═CH—, —C(CH₃)₂—CH═CH—, —CH₂—C(CH₃)═CH—, —CH₂—CH═C(CH₃)—), and the like.

“Alkynyl” as used herein, refers to a radical of a straight-chain or branched hydrocarbon group having from 2 to 20 carbon atoms, one or more carbon-carbon triple bonds (e.g., 1, 2, 3, or 4 carbon-carbon triple bonds), and optionally one or more carbon-carbon double bonds (e.g., 1, 2, 3, or 4 carbon-carbon double bonds) (“C₂-20 alkynyl”). In certain embodiments, alkynyl does not contain any double bonds. In certain embodiments, an alkynyl group has 2 to 10 carbon atoms (“C₂₋₁₀ alkynyl”). In certain embodiments, an alkynyl group has 2 to 9 carbon atoms (“C₂₋₉ alkynyl”). In certain embodiments, an alkynyl group has 2 to 8 carbon atoms (“C₂₋₈ alkynyl”). In certain embodiments, an alkynyl group has 2 to 7 carbon atoms (“C₂₋₇ alkynyl”).

In certain embodiments, an alkynyl group has 2 to 6 carbon atoms (“C₂₋₆ alkynyl”). In certain embodiments, an alkynyl group has 2 to 5 carbon atoms (“C₂₋₅ alkynyl”). In certain embodiments, an alkynyl group has 2 to 4 carbon atoms (“C₂₋₄ alkynyl”). In certain embodiments, an alkynyl group has 2 to 3 carbon atoms (“C₂₋₃ alkynyl”). In certain embodiments, an alkynyl group has 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently optionally substituted, i.e., unsubstituted (an “unsubstituted alkynyl”) or substituted (a “substituted alkynyl”) with one or more substituents; e.g., for instance from 1 to 5 substituents, 1 to 3 substituents, or 1 substituent. In certain embodiments, the alkynyl group is unsubstituted C₂₋₁₀ alkynyl. In certain embodiments, the alkynyl group is substituted C₂₋₁₀ alkynyl.

“Alkynylene” as used herein, refers to a linear alkynyl group wherein two hydrogens are removed to provide a divalent radical. When a range or number of carbons is provided for a particular “alkynylene” group, it is understood that the range or number refers to the range or number of carbons in the linear carbon divalent chain. An “alkynylene” group may be substituted or unsubstituted with one or more substituents as described herein. Exemplary divalent alkynylene groups include, but are not limited to, substituted or unsubstituted ethynylene, substituted or unsubstituted propynylene, and the like.

The term “heteroalkyl,” as used herein, refers to an alkyl group, as defined herein, which further comprises 1 or more (e.g., 1, 2, 3, or 4) heteroatoms (e.g., oxygen, sulfur, nitrogen, boron, silicon, phosphorus) within the parent chain, wherein the one or more heteroatoms is inserted between adjacent carbon atoms within the parent carbon chain and/or one or more heteroatoms is inserted between a carbon atom and the parent molecule, i.e., between the point of attachment. In certain embodiments, a heteroalkyl group refers to a saturated group having from 1 to 10 carbon atoms and 1, 2, 3, or 4 heteroatoms (“heteroC₁₋₁₀ alkyl”). In certain embodiments, a heteroalkyl group is a saturated group having 1 to 9 carbon atoms and 1, 2, 3, or 4 heteroatoms (“heteroC₁₋₉ alkyl”). In certain embodiments, a heteroalkyl group is a saturated group having 1 to 8 carbon atoms and 1, 2, 3, or 4 heteroatoms (“heteroC₁₋₈ alkyl”). In certain embodiments, a heteroalkyl group is a saturated group having 1 to 7 carbon atoms and 1, 2, 3, or 4 heteroatoms (“heteroC₁₋₇ alkyl”). In certain embodiments, a heteroalkyl group is a group having 1 to 6 carbon atoms and 1, 2, or 3 heteroatoms (“heteroC₁₋₆ alkyl”). In certain embodiments, a heteroalkyl group is a saturated group having 1 to 5 carbon atoms and 1 or 2 heteroatoms (“heteroC₁₋₅ alkyl”). In certain embodiments, a heteroalkyl group is a saturated group having 1 to 4 carbon atoms and/or 2 heteroatoms (“heteroC₁₋₄ alkyl”). In certain embodiments, a heteroalkyl group is a saturated group having 1 to 3 carbon atoms and 1 heteroatom (“heteroC₁₋₃ alkyl”). In certain embodiments, a heteroalkyl group is a saturated group having 1 to 2 carbon atoms and 1 heteroatom (“heteroC₁₋₂ alkyl”). In certain embodiments, a heteroalkyl group is a saturated group having 1 carbon atom and 1 heteroatom (“heteroC₁ alkyl”). In certain embodiments, a heteroalkyl group is a saturated group having 2 to 6 carbon atoms and 1 or 2 heteroatoms (“heteroC₂₋₆ alkyl”). Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₁₀ alkyl. In certain embodiments, the heteroalkyl group is a substituted heteroC₁₋₁₀ alkyl.

The term “heteroalkenyl,” as used herein, refers to an alkenyl group, as defined herein, which further comprises one or more (e.g., 1, 2, 3, or 4) heteroatoms (e.g., oxygen, sulfur, nitrogen, boron, silicon, phosphorus) wherein the one or more heteroatoms is inserted between adjacent carbon atoms within the parent carbon chain and/or one or more heteroatoms is inserted between a carbon atom and the parent molecule, i.e., between the point of attachment. In certain embodiments, a heteroalkenyl group refers to a group having from 2 to 10 carbon atoms, at least one double bond, and 1, 2, 3, or 4 heteroatoms (“heteroC₂₋₁₀ alkenyl”). In certain embodiments, a heteroalkenyl group has 2 to 9 carbon atoms at least one double bond, and 1, 2, 3, or 4 heteroatoms (“heteroC₂₋₉ alkenyl”). In certain embodiments, a heteroalkenyl group has 2 to 8 carbon atoms, at least one double bond, and 1, 2, 3, or 4 heteroatoms (“heteroC₂₋₈ alkenyl”). In certain embodiments, a heteroalkenyl group has 2 to 7 carbon atoms, at least one double bond, and 1, 2, 3, or 4 heteroatoms (“heteroC₂₋₇ alkenyl”). In certain embodiments, a heteroalkenyl group has 2 to 6 carbon atoms, at least one double bond, and 1, 2, or 3 heteroatoms (“heteroC₂₋₆ alkenyl”). In certain embodiments, a heteroalkenyl group has 2 to 5 carbon atoms, at least one double bond, and 1 or 2 heteroatoms (“heteroC₂₋₅ alkenyl”). In certain embodiments, a heteroalkenyl group has 2 to 4 carbon atoms, at least one double bond, and 1 or 2 heteroatoms (“heteroC₂₋₄ alkenyl”). In certain embodiments, a heteroalkenyl group has 2 to 3 carbon atoms, at least one double bond, and 1 heteroatom (“heteroC₂₋₃ alkenyl”). In certain embodiments, a heteroalkenyl group has 2 to 6 carbon atoms, at least one double bond, and 1 or 2 heteroatoms (“heteroC₂₋₆ alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀ alkenyl. In certain embodiments, the heteroalkenyl group is a substituted heteroC₂₋₁₀ alkenyl.

The term “heteroalkynyl,” as used herein, refers to an alkynyl group, as defined herein, which further comprises one or more (e.g., 1, 2, 3, or 4) heteroatoms (e.g., oxygen, sulfur, nitrogen, boron, silicon, phosphorus) wherein the one or more heteroatoms is inserted between adjacent carbon atoms within the parent carbon chain and/or one or more heteroatoms are inserted between a carbon atom and the parent molecule, i.e., between the point of attachment. In certain embodiments, a heteroalkynyl group refers to a group having from 2 to 10 carbon atoms, at least one triple bond, and 1, 2, 3, or 4 heteroatoms (“heteroC₂₋₁₀ alkynyl”). In certain embodiments, a heteroalkynyl group has 2 to 9 carbon atoms, at least one triple bond, and 1, 2, 3, or 4 heteroatoms (“heteroC₂₋₉ alkynyl”). In certain embodiments, a heteroalkynyl group has 2 to 8 carbon atoms, at least one triple bond, and 1, 2, 3, or 4 heteroatoms (“heteroC₂₋₈ alkynyl”). In certain embodiments, a heteroalkynyl group has 2 to 7 carbon atoms, at least one triple bond, and 1, 2, 3, or 4 heteroatoms (“heteroC₂₋₇ alkynyl”). In certain embodiments, a heteroalkynyl group has 2 to 6 carbon atoms, at least one triple bond, and 1, 2, or 3 heteroatoms (“heteroC₂₋₆ alkynyl”). In certain embodiments, a heteroalkynyl group has 2 to 5 carbon atoms, at least one triple bond, and 1 or 2 heteroatoms (“heteroC₂₋₅ alkynyl”). In certain embodiments, a heteroalkynyl group has 2 to 4 carbon atoms, at least one triple bond, and 1 or 2 heteroatoms (“heteroC₂₋₄ alkynyl”). In certain embodiments, a heteroalkynyl group has 2 to 3 carbon atoms, at least one triple bond, and 1 heteroatom (“heteroC₂₋₃ alkynyl”). In certain embodiments, a heteroalkynyl group has 2 to 6 carbon atoms, at least one triple bond, and 1 or 2 heteroatoms (“heteroC₂₋₆ alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀ alkynyl. In certain embodiments, the heteroalkynyl group is a substituted heteroC₂₋₁₀ alkynyl.

Analogous to “alkylene,” “alkenylene,” and “alkynylene” as defined above, “heteroalkylene,” “heteroalkenylene,” and “heteroalkynylene,” as used herein, refer to a divalent radical of heteroalkyl, heteroalkenyl, and heteroalkynyl group respectively. When a range or number of carbons is provided for a particular “heteroalkylene,” “heteroalkenylene,” or “heteroalkynylene,” group, it is understood that the range or number refers to the range or number of carbons in the linear divalent chain. “Heteroalkylene,” “heteroalkenylene,” and “heteroalkynylene” groups may be substituted or unsubstituted with one or more substituents as described herein.

“Aryl” refers to a radical of a monocyclic or polycyclic (e.g., bicyclic or tricyclic) 4n+2 aromatic ring system (e.g., having 6, 10, or 14π electrons shared in a cyclic array) having 6-14 ring carbon atoms and zero heteroatoms provided in the aromatic ring system (“C₆₋₁₄ aryl”). In some embodiments, an aryl group has six ring carbon atoms (“C₆ aryl”; e.g., phenyl). In some embodiments, an aryl group has ten ring carbon atoms (“C₁₀ aryl”; e.g., naphthyl such as 1-naphthyl and 2-naphthyl). In some embodiments, an aryl group has fourteen ring carbon atoms (“C₁₄ aryl”; e.g., anthracyl).

Typical aryl groups include, but are not limited to, groups derived from aceanthrylene, acenaphthylene, acephenanthrylene, anthracene, azulene, benzene, chrysene, coronene, fluoranthene, fluorene, hexacene, hexaphene, hexalene, as-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, and trinaphthalene. Particular aryl groups include phenyl, naphthyl, indenyl, and tetrahydronaphthyl. Unless otherwise specified, each instance of an aryl group is independently optionally substituted, i.e., unsubstituted (an “unsubstituted aryl”) or substituted (a “substituted aryl”) with one or more substituents. In certain embodiments, the aryl group is unsubstituted C₆₋₁₄ aryl. In certain embodiments, the aryl group is substituted C₆₋₁₄ aryl.

“Arylene” as used herein, refers to an aryl group wherein two hydrogens are removed to provide a divalent radical. When a range or number of carbons is provided for a particular “arylene” group, it is understood that the range or number refers to the range or number of carbons in the aryl group. An “arylene” group may be substituted or unsubstituted with one or more substituents as described herein.

“Heteroaryl” refers to a radical of a 5- to 14-membered monocyclic or polycyclic 4n+2 aromatic ring system (e.g., having 6, 10, or 14 π electrons shared in a cyclic array) having ring carbon atoms and 1-8 ring heteroatoms provided in the aromatic ring system, wherein each heteroatom is independently selected from nitrogen, oxygen and sulfur (“5- to 14-membered heteroaryl”). In heteroaryl groups that contain one or more nitrogen atoms, the point of attachment can be a carbon or nitrogen atom, as valency permits. Heteroaryl bicyclic ring systems can include one or more heteroatoms in one or both rings.

“Heteroaryl” also includes ring systems wherein the heteroaryl group, as defined above, is fused with one or more aryl groups wherein the point of attachment is either on the heteroaryl or the one or more aryl groups, and in such instances, the number of ring members designates the total number of ring members in the fused (aryl/heteroaryl) ring system. When substitution is indicated in such instances, unless otherwise specified, substitution can occur on either the heteroaryl or the one or more aryl groups. Bicyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

In certain embodiments, a heteroaryl is a 5- to 10-membered aromatic ring system having ring carbon atoms and 1-4 ring heteroatoms provided in the aromatic ring system, wherein each heteroatom is independently selected from nitrogen, oxygen, and sulfur (“5- to 10-membered heteroaryl”). In certain embodiments, a heteroaryl is a 5- to 9-membered aromatic ring system having ring carbon atoms and 1-4 ring heteroatoms provided in the aromatic ring system, wherein each heteroatom is independently selected from nitrogen, oxygen, and sulfur (“5- to 9-membered heteroaryl”). In certain embodiments, a heteroaryl is a 5- to 8-membered aromatic ring system having ring carbon atoms and 1-4 ring heteroatoms provided in the aromatic ring system, wherein each heteroatom is independently selected from nitrogen, oxygen, and sulfur (“5- to 8-membered heteroaryl”). In certain embodiments, a heteroaryl group is a 5- to 6-membered aromatic ring system having ring carbon atoms and 1-4 ring heteroatoms provided in the aromatic ring system, wherein each heteroatom is independently selected from nitrogen, oxygen, and sulfur (“5- to 6-membered heteroaryl”). In certain embodiments, the 5- to 6-membered heteroaryl has 1-3 ring heteroatoms independently selected from nitrogen, oxygen, and sulfur. In certain embodiments, the 5- to 6-membered heteroaryl has 1-2 ring heteroatoms independently selected from nitrogen, oxygen, and sulfur. In certain embodiments, the 5- to 6-membered heteroaryl has 1 ring heteroatom selected from nitrogen, oxygen, and sulfur. Unless otherwise specified, each instance of a heteroaryl group is independently optionally substituted, i.e., unsubstituted (an “unsubstituted heteroaryl”) or substituted (a “substituted heteroaryl”) with one or more substituents. In certain embodiments, the heteroaryl group is unsubstituted 5- to 14-membered heteroaryl. In certain embodiments, the heteroaryl group is substituted 5- to 14-membered heteroaryl.

Exemplary 5-membered heteroaryl containing one heteroatom include, without limitation, pyrrolyl, furanyl and thiophenyl. Exemplary 5-membered heteroaryl containing two heteroatoms include, without limitation, imidazolyl, pyrazolyl, oxazolyl, isoxazolyl, thiazolyl, and isothiazolyl. Exemplary 5-membered heteroaryl containing three heteroatoms include, without limitation, triazolyl, oxadiazolyl, and thiadiazolyl. Exemplary 5-membered heteroaryl containing four heteroatoms include, without limitation, tetrazolyl. Exemplary 6-membered heteroaryl containing one heteroatom include, without limitation, pyridinyl. Exemplary 6-membered heteroaryl containing two heteroatoms include, without limitation, pyridazinyl, pyrimidinyl, and pyrazinyl. Exemplary 6-membered heteroaryl containing three or four heteroatoms include, without limitation, triazinyl and tetrazinyl, respectively. Exemplary 7-membered heteroaryl containing one heteroatom include, without limitation, azepinyl, oxepinyl, and thiepinyl. Exemplary 5,6-bicyclic heteroaryl include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl include, without limitation, naphthyridinyl, pteridinyl, quinolinyl, isoquinolinyl, cinnolinyl, quinoxalinyl, phthalazinyl, and quinazolinyl.

“Heteroarylene” as used herein, refers to a heteroaryl group wherein two hydrogens are removed to provide a divalent radical. When a range or number of ring members is provided for a particular “heteroarylene” group, it is understood that the range or number refers to the number of ring members in the heteroaryl group. A “heteroarylene” group may be substituted or unsubstituted with one or more substituents as described herein.

“Carbocyclyl” refers to a radical of a non-aromatic cyclic hydrocarbon group having from 3 to 12 ring carbon atoms (“C₃₋₁₂ carbocyclyl”) and zero heteroatoms in the nonaromatic ring system. In certain embodiments, a carbocyclyl group has 3 to 10 ring carbon atoms (“C₃₋₁₀ carbocyclyl”). In certain embodiments, a carbocyclyl group has 3 to 8 ring carbon atoms (“C₃₋₈ carbocyclyl”). In certain embodiments, a carbocyclyl group has 3 to 6 ring carbon atoms (“C₃₋₆ carbocyclyl”). In certain embodiments, a carbocyclyl group has 5 to 12 ring carbon atoms (“C₅₋₁₂ carbocyclyl”). In certain embodiments, a carbocyclyl group has 5 to 10 ring carbon atoms (“C₅₋₁₀ carbocyclyl”). In certain embodiments, a carbocyclyl group has 5 to 8 ring carbon atoms (“C₅₋₈ carbocyclyl”). In certain embodiments, a carbocyclyl group has 5 or 6 ring carbon atoms (“C₅₋₆ carbocyclyl”). Exemplary C₃₋₆ carbocyclyl include, without limitation, cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like. Exemplary C₃₋₈ carbocyclyl include, without limitation, the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl include, without limitation, the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like.

In certain embodiments, “carbocyclyl” is a monocyclic, saturated carbocyclyl group having from 3 to 12 ring carbon atoms (“C₃₋₁₂ carbocyclyl”). In certain embodiments, “carbocyclyl” is a monocyclic, saturated carbocyclyl group having from 3 to 10 ring carbon atoms (“C₃₋₁₀ carbocyclyl”). In certain embodiments, “carbocyclyl” is a monocyclic, saturated carbocyclyl group having from 3 to 8 ring carbon atoms (“C₃₋₈ carbocyclyl”). In certain embodiments, “carbocyclyl” is a monocyclic, saturated carbocyclyl group having from 3 to 6 ring carbon atoms (“C₃₋₆ carbocyclyl”). In certain embodiments, “carbocyclyl” is a monocyclic, saturated carbocyclyl group having from 5 to 12 ring carbon atoms (“C₅₋₁₂ carbocyclyl”). In certain embodiments, a carbocyclyl group has 5 to 10 ring carbon atoms (“C₅₋₁₀ carbocyclyl”). In certain embodiments, a carbocyclyl group has 5 to 8 ring carbon atoms (“C₅₋₈ carbocyclyl”). In certain embodiments, “carbocyclyl” is a monocyclic, saturated carbocyclyl group having 5 or 6 ring carbon atoms (“C₅₋₆ carbocyclyl”). Examples of C₅₋₆ carbocyclyl include cyclopentyl (C₅) and cyclohexyl (C₅). Examples of C₃₋₆ carbocyclyl include the aforementioned C₅₋₆ carbocyclyl groups as well as cyclopropyl (C₃) and cyclobutyl (C₄). Examples of C₃₋₈ carbocyclyl include the aforementioned C₃₋₆ carbocyclyl groups as well as cycloheptyl (C₇) and cyclooctyl (C₈). Unless otherwise specified, each instance of a carbocyclyl group is independently unsubstituted (an “unsubstituted carbocyclyl”) or substituted (a “substituted carbocyclyl”) with one or more substituents. In certain embodiments, the carbocyclyl group is unsubstituted C₃₋₁₂ carbocyclyl. In certain embodiments, the carbocyclyl group is substituted C₃₋₁₂ carbocyclyl.

As the foregoing examples illustrate, in certain embodiments, the carbocyclyl group is either monocyclic (“monocyclic carbocyclyl”) or polycyclic (“polycyclic carbocyclyl”) that contains a fused, bridged or spiro ring system and can be saturated or can be partially unsaturated. Unless otherwise specified, each instance of a carbocyclyl group is independently optionally substituted, i.e., unsubstituted (an “unsubstituted carbocyclyl”) or substituted (a “substituted carbocyclyl”) with one or more substituents. In certain embodiments, the carbocyclyl group is unsubstituted C₃₋₁₂ carbocyclyl. In certain embodiments, the carbocyclyl group is a substituted C₃₋₁₂ carbocyclyl.

“Fused carbocyclyl” or “fused carbocycle” refers to ring systems wherein the carbocyclyl group, as defined above, is fused with, i.e., share two common atoms (as such, share one common bond), one or more carbocyclyl groups, as defined above, wherein the point of attachment is on any of the fused rings. In such instances, the number of carbons designates the total number of carbons in the fused ring system. When substitution is indicated, unless otherwise specified, substitution can occur on any of the fused rings.

“Spiro carbocyclyl” or “spiro carbocycle” refers to ring systems wherein the carbocyclyl group, as defined above, form spiro structure with, i.e., share one common atom with, one or more carbocyclyl groups, as defined above, wherein the point of attachment is on the carbocyclyl rings in which the spiro structure is embedded. In such instances, the number of carbons designates the total number of carbons of the carbocyclyl rings in which the spiro structure is embedded. When substitution is indicated, unless otherwise specified, substitution can occur on the carbocyclyl rings in which the spiro structure is embedded.

“Bridged carbocyclyl” or “bridged carbocycle” refers to ring systems wherein the carbocyclyl group, as defined above, form bridged structure with, i.e., share more than two atoms (as such, share more than one bonds) with, one or more carbocyclyl groups, as defined above, wherein the point of attachment is on any of the carbocyclyl rings in which the bridged structure is embedded. In such instances, the number of carbons designates the total number of carbons of the carbocyclyl rings in which the bridged structure is embedded. When substitution is indicated, unless otherwise specified, substitution can occur on any of the carbocyclyl rings in which the bridged structure is embedded.

“Carbocyclylene” as used herein, refers to a carbocyclyl group wherein two hydrogens are removed to provide a divalent radical. The divalent radical may be present on different atoms or the same atom of the carbocyclylene group. When a range or number of carbons is provided for a particular “carbocyclyl” group, it is understood that the range or number refers to the range or number of carbons in the carbocyclyl group. A “carbocyclyl” group may be substituted or unsubstituted with one or more substituents as described herein.

“Heterocyclyl” refers to a radical of a 3- to 12-membered non-aromatic ring system having ring carbon atoms and 1 to 4 ring heteroatoms, wherein each heteroatom is independently selected from nitrogen, oxygen, sulfur, boron, phosphorus, and silicon (“3- to 12-membered heterocyclyl”). In heterocyclyl groups that contain one or more nitrogen atoms, the point of attachment can be a carbon or nitrogen atom, as valency permits. Exemplary 3-membered heterocyclyl groups containing one heteroatom include, without limitation, azirdinyl, oxiranyl, thiorenyl. Exemplary 4-membered heterocyclyl groups containing one heteroatom include, without limitation, azetidinyl, oxetanyl and thietanyl. Exemplary 5 membered heterocyclyl groups containing one heteroatom include, without limitation, tetrahydrofuranyl, dihydrofuranyl, tetrahydrothiophenyl, dihydrothiophenyl, pyrrolidinyl, dihydropyrrolyl and pyrrolyl-2,5-dione. Exemplary 5-membered heterocyclyl groups containing two heteroatoms include, without limitation, dioxolanyl, oxasulfuranyl, disulfuranyl, and oxazolidin-2-one. Exemplary 5-membered heterocyclyl groups containing three heteroatoms include, without limitation, triazolinyl, oxadiazolinyl, and thiadiazolinyl. Exemplary 6-membered heterocyclyl groups containing one heteroatom include, without limitation, piperidinyl, tetrahydropyranyl, dihydropyridinyl, and thianyl. Exemplary 6-membered heterocyclyl groups containing two heteroatoms include, without limitation, piperazinyl, morpholinyl, dithianyl, dioxanyl. Exemplary 6-membered heterocyclyl groups containing two heteroatoms include, without limitation, triazinanyl. Exemplary 7-membered heterocyclyl groups containing one heteroatom include, without limitation, azepanyl, oxepanyl and thiepanyl. Exemplary 8-membered heterocyclyl groups containing one heteroatom include, without limitation, azocanyl, oxecanyl and thiocanyl. Exemplary 5-membered heterocyclyl groups fused to a C₆ aryl ring (also referred to herein as a 5,6-bicyclic heterocyclic ring) include, without limitation, indolinyl, isoindolinyl, dihydrobenzofuranyl, dihydrobenzothienyl, benzoxazolinonyl, and the like. Exemplary 6-membered heterocyclyl groups fused to an aryl ring (also referred to herein as a 6,6-bicyclic heterocyclic ring) include, without limitation, tetrahydroquinolinyl, tetrahydroisoquinolinyl, and the like.

In certain embodiments, a heterocyclyl group is a 5- to 12-membered non-aromatic ring system having ring carbon atoms and 1-4 ring heteroatoms, wherein each heteroatom is independently selected from nitrogen, oxygen, sulfur, boron, phosphorus, and silicon (“5- to 12-membered heterocyclyl”). In certain embodiments, a heterocyclyl group is a 5- to 10-membered non-aromatic ring system having ring carbon atoms and 1-4 ring heteroatoms, wherein each heteroatom is independently selected from nitrogen, oxygen, sulfur, boron, phosphorus, and silicon (“5- to 10-membered heterocyclyl”). In certain embodiments, a heterocyclyl group is a 5- to 8-membered non-aromatic ring system having ring carbon atoms and 1-4 ring heteroatoms, wherein each heteroatom is independently selected from nitrogen, oxygen, and sulfur (“5- to 8-membered heterocyclyl”). In certain embodiments, a heterocyclyl group is a 5- to 6-membered non-aromatic ring system having ring carbon atoms and 1-4 ring heteroatoms, wherein each heteroatom is independently selected from nitrogen, oxygen, and sulfur (“5- to 6-membered heterocyclyl”). In certain embodiments, the 5- to 6-membered heterocyclyl has 1-3 ring heteroatoms selected from nitrogen, oxygen, and sulfur. In certain embodiments, the 5- to 6-membered heterocyclyl has 1-2 ring heteroatoms selected from nitrogen, oxygen, and sulfur. In certain embodiments, the 5- to 6-membered heterocyclyl has one ring heteroatom selected from nitrogen, oxygen, and sulfur.

As the foregoing examples illustrate, in certain embodiments, a heterocyclyl group can either be monocyclic (“monocyclic heterocyclyl”) or polycyclic (“polycyclic heterocyclyl”) that contains a fused, bridged or spiro ring system, and can be saturated or can be partially unsaturated. Heterocyclyl polycyclic ring systems can include one or more heteroatoms in one or both rings. “Heterocyclyl” also includes ring systems wherein the heterocyclyl group, as defined above, is fused with one or more carbocyclyl groups wherein the point of attachment is either on the carbocyclyl or heterocyclyl ring, and in such instances, the number of ring members designates the total number of ring members in the entire ring system. When substitution is indicated in such instances, unless otherwise specified, substitution can occur on either the heterocyclyl or the one or more carbocyclyl groups. Unless otherwise specified, each instance of heterocyclyl is independently optionally substituted, i.e., unsubstituted (an “unsubstituted heterocyclyl”) or substituted (a “substituted heterocyclyl”) with one or more substituents. In certain embodiments, the heterocyclyl group is unsubstituted 3- to 12-membered heterocyclyl. In certain embodiments, the heterocyclyl group is substituted 3- to 12-membered heterocyclyl.

“Fused heterocyclyl” or “fused heterocycle” refers to ring systems wherein the heterocyclyl group, as defined above, is fused with, i.e., share two common atoms (as such, share one common bond) with, one or more heterocyclyl or carbocyclyl groups, as defined above, wherein the point of attachment is on any of the fused rings. In such instances, the number of ring members designates the total number of ring members in the fused ring system. When substitution is indicated, unless otherwise specified, substitution can occur on any of the fused rings.

“Spiro heterocyclyl” or “spiro heterocycle” refers to ring systems wherein the heterocyclyl group, as defined above, form spiro structure with, i.e., share one common atom with, one or more heterocyclyl or carbocyclyl groups, as defined above, wherein the point of attachment is on the heterocyclyl or carbocyclyl rings in which the spiro structure is embedded. In such instances, the number of ring members designates the total number of ring members of the heterocyclyl or carbocyclyl rings in which the spiro structure is embedded. When substitution is indicated, unless otherwise specified, substitution can occur on any of the heterocyclyl or carbocyclyl rings in which the spiro structure is embedded.

“Bridged heterocyclyl” or “bridged heterocycle” refers to ring systems wherein the heterocyclyl group, as defined above, form bridged structure with, i.e., share more than two atoms (as such, share more than one bonds) with, one or more heterocyclyl or carbocyclyl groups, as defined above, wherein the point of attachment is on the heterocyclyl or carbocyclyl rings in which the bridged structure is embedded. In such instances, the number of ring members designates the total number of ring members of the heterocyclyl or carbocyclyl rings in which the bridged structure is embedded. When substitution is indicated, unless otherwise specified, substitution can occur on any of the heterocyclyl or carbocyclyl rings in which the bridged structure is embedded.

“Heterocyclylene” as used herein, refers to a heterocyclyl group wherein two hydrogens are removed to provide a divalent radical. The divalent radical may be present on different atoms or the same atom of the heterocyclylene group. When a range or number of ring members is provided for a particular “heterocyclylene” group, it is understood that the range or number refers to the number of ring members in the heterocyclylene group. A “heterocyclylene” group may be substituted or unsubstituted with one or more substituents as described herein.

“Alkoxy” as used herein, refers to the group —OR, wherein R is alkyl as defined herein. C₁₋₆ alkoxy refers to the group —OR, wherein each R is C₁₋₆ alkyl, as defined herein. Exemplary C₁₋₆ alkyl is set forth above.

“Alkylamino” as used herein, refers to the group —NHR or —NR₂, wherein each R is independently alkyl, as defined herein. C₁₋₆ alkylamino refers to the group —NHR or —NR₂, wherein each R is independently C₁₋₆ alkyl, as defined herein. Exemplary C₁₋₆ alkyl is set forth above.

“Oxo” refers to ═O. When a group other than aryl and heteroaryl or an atom is substituted with an oxo, it is meant to indicate that two geminal radicals on that group or atom form a double bond with an oxygen radical. When a heteroaryl is substituted with an oxo, it is meant to indicate that a resonance structure/tautomer involving a heteroatom provides a carbon atom that is able to form two geminal radicals, which form a double bond with an oxygen radical.

“Halo” or “halogen” refers to fluoro (F), chloro (Cl), bromo (Br), and iodo (I). In certain embodiments, the halo group is either fluoro or chloro.

“Protecting group” as used herein is art-recognized and refers to a chemical moiety introduced into a molecule by chemical modification of a functional group (e.g., hydroxyl, amino, thio, and carboxylic acid) to obtain chemoselectivity in a subsequent chemical reaction, during which the unmodified functional group may not survive or may interfere with the chemical reaction. Common functional groups that need to be protected include but not limited to hydroxyl amino, thiol, and carboxylic acid. Accordingly, the projecting groups are termed hydroxyl-protecting groups, amino-protecting groups, thiol-protecting groups, and carboxylic acid-protecting groups, respectively.

Common types of hydroxyl-protecting groups include but not limited to ethers (e.g., methoxymethyl (MOM), β-Methoxyethoxymethyl (MEM), tetrahydropyranyl (THP), p-methoxyphenyl (PMP), t-butyl, triphenylmethyl (Trityl), allyl, and benzyl ether (Bn)), silyl ethers (e.g., t-butyldiphenylsilyl (TBDPS), trimethylsilyl (TMS), triisopropylsilyl (TIPS), tri-iso-propylsilyloxymethyl (TOM), and t-butyldimethylsilyl (TBDMS)), and esters (e.g., pivalic acid ester (Piv) and benzoic acid ester (benzoate; Bz)).

Common types of amino-protecting groups include but not limited to carbamates (e.g., t-butyloxycarbonyl (Boc), 9-fluorenylmethyloxycarbonyl (Fmoc), p-methoxybenzyl carbonyl (Moz or MeOZ), 2,2,2-trichloroehtoxycarbonyl (Troc), and benzyl carbamate (Cbz)), esters (e.g., acetyl (Ac); benzoyl (Bz), trifluoroacetyl, and phthalimide), amines (e.g, benzyl (Bn), p-methoxybenzyl (PMB), p-methoxyphenyl (PMP), and triphenylmethyl (trityl)), and sulfonamides (e.g., tosyl (Ts), A-alkyl nitrobenzenesulfonamides (Nosyl), and 2-nitrophenylsulfenyl (Nps)).

Common types of thiol-protecting groups include but not limited to sulfide (e.g, p-methylbenzyl (Meb), t-butyl, acetamidomethyl (Acm), and triphenylmethyl (Trityl)).

Common types of carboxylic acid-protecting groups include but not limited to esters (e.g., methyl ester, triphenylmethyl (Trityl), t-butyl ester, benzyl ester (Bn), S-t-butyl ester, silyl esters, and orthoesters) and oxazoline.

These and other exemplary substituents are described in more detail in the Detailed Description, Examples, and claims. The invention is not intended to be limited in any manner by the above exemplary listing of substituents.

### Other Definitions

“Pharmaceutically acceptable” means approved or approvable by a regulatory agency of the Federal or a state government or the corresponding agency in countries other than the United States, or that is listed in the U.S. Pharmacopoeia or other generally recognized pharmacopoeia for use in animals, and more particularly, in humans.

“Pharmaceutically acceptable salt” refers to a salt of a compound of the invention that is pharmaceutically acceptable and that possesses the desired pharmacological activity of the parent compound. In particular, such salts are non-toxic may be inorganic or organic acid addition salts and base addition salts. Specifically, such salts include: (1) acid addition salts, formed with inorganic acids such as hydrochloric acid, hydrobromic acid, sulfuric acid, nitric acid, phosphoric acid, and the like; or formed with organic acids such as acetic acid, propionic acid, hexanoic acid, cyclopentanepropionic acid, glycolic acid, pyruvic acid, lactic acid, malonic acid, succinic acid, malic acid, maleic acid, fumaric acid, tartaric acid, citric acid, benzoic acid, 3-(4-hydroxybenzoyl)benzoic acid, cinnamic acid, mandelic acid, methanesulfonic acid, ethanesulfonic acid, 1,2-ethane-disulfonic acid, 2-hydroxyethanesulfonic acid, benzenesulfonic acid, chlorobenzenesulfonic acid, 2-naphthalenesulfonic acid, 4-toluenesulfonic acid, camphorsulfonic acid, 4-methylbicyclo [2.2.2]-oct-2-ene-1-carboxylic acid, glucoheptonic acid, 3-phenylpropionic acid, trimethylacetic acid, tertiary butylacetic acid, lauryl sulfuric acid, gluconic acid, glutamic acid, hydroxynaphthoic acid, salicylic acid, stearic acid, muconic acid, and the like; or (2) salts formed when an acidic proton present in the parent compound either is replaced by a metal ion, e.g., an alkali metal ion, an alkaline earth ion, or an aluminum ion; or coordinates with an organic base such as ethanolamine, diethanolamine, triethanolamine, N-methylglucamine and the like. Salts further include, by way of example only, sodium potassium, calcium, magnesium, ammonium, tetraalkylammonium, and the like; and when the compound contains a basic functionality, salts of nontoxic organic or inorganic acids, such as hydrochloride, hydrobromide, tartrate, mesylate, acetate, maleate, oxalate and the like.

The term “pharmaceutically acceptable cation” refers to an acceptable cationic counterion of an acidic functional group. Such cations are exemplified by sodium, potassium, calcium, magnesium, ammonium, tetraalkylammonium cations, and the like (see, e.g., Berge, et al., J. Pharm. Sci. 66 (1):1-79 (January 77).

“Pharmaceutically acceptable vehicle” refers to a diluent, adjuvant, excipient or carrier with which a compound of the invention is administered.

“Pharmaceutically acceptable metabolically cleavable group” refers to a group which is cleaved in vivo to yield the parent molecule of the structural formula indicated herein. Examples of metabolically cleavable groups include —COR, —COOR, —CONR₂ and —CH₂OR radicals, where R is selected independently at each occurrence from alkyl, trialkylsilyl, carbocyclic aryl or carbocyclic aryl substituted with one or more of alkyl, halogen, hydroxy or alkoxy. Specific examples of representative metabolically cleavable groups include acetyl, methoxycarbonyl, benzoyl, methoxymethyl and trimethylsilyl groups.

“Solvate” refers to forms of the compound that are associated with a solvent or water (also referred to as “hydrate”), usually by a solvolysis reaction. This physical association includes hydrogen bonding. Conventional solvents include water, ethanol, acetic acid and the like. The compounds of the invention may be prepared e.g., in crystalline form and may be solvated or hydrated. Suitable solvates include pharmaceutically acceptable solvates, such as hydrates, and further include both stoichiometric solvates and non-stoichiometric solvates. In certain instances, the solvate will be capable of isolation, for example when one or more solvent molecules are incorporated in the crystal lattice of the crystalline solid. “Solvate” encompasses both solution-phase and isolable solvates. Representative solvates include hydrates, ethanolates and methanolates.

A “subject” to which administration is contemplated includes, but is not limited to, humans (i.e., a male or female of any age group, e.g., a pediatric subject (e.g., infant, child, adolescent) or an adult subject (e.g., young adult, middle aged adult or senior adult) and/or a non-human animal, e.g., a mammal such as primates (e.g., cynomolgus monkeys, rhesus monkeys), cattle, pigs, horses, sheep, goats, rodents, cats, and/or dogs. In certain embodiments, the subject is a human. In certain embodiments, the subject is a non-human animal. The terms “human,” “patient,” and “subject” are used interchangeably herein.

An “effective amount” means the amount of a compound that, when administered to a subject for treating or preventing a disease, is sufficient to affect such treatment or prevention. The “effective amount” can vary depending on the compound, the disease and its severity, and the age, weight, etc., of the subject to be treated. A “therapeutically effective amount” refers to the effective amount for therapeutic treatment. A “prophylactically effective amount” refers to the effective amount for prophylactic treatment.

“Preventing”, “prevention” or “prophylactic treatment” refers to a reduction in risk of acquiring or developing a disease or disorder (i.e., causing at least one of the clinical symptoms of the disease not to develop in a subject not yet exposed to a disease-causing agent, or predisposed to the disease in advance of disease onset.

The term “prophylaxis” is related to “prevention,” and refers to a measure or procedure the purpose of which is to prevent, rather than to treat or cure a disease. Non limiting examples of prophylactic measures may include the administration of vaccines; the administration of low molecular weight heparin to hospital patients at risk for thrombosis due, for example, to immobilization, and the administration of an anti-malarial agent such as chloroquine, in advance of a visit to a geographical region where malaria is endemic, or the risk of contracting malaria is high.

“Treating” or “treatment” or “therapeutic treatment” of any disease or disorder refers, in one embodiment, to ameliorating the disease or disorder (i.e., arresting the disease or reducing the manifestation, extent or severity of at least one of the clinical symptoms thereof). In another embodiment, “treating” or “treatment” refers to ameliorating at least one physical parameter, which may not be discernible by the subject. In yet another embodiment, “treating” or “treatment” refers to modulating the disease or disorder, either physically, (e.g., stabilization of a discernible symptom), physiologically, (e.g., stabilization of a physical parameter), or both. In a further embodiment, “treating” or “treatment” relates to slowing the progression of the disease.

It is also to be understood that compounds that have the same molecular formula but differ in the nature or sequence of bonding of their atoms or the arrangement of their atoms in space are termed “isomers.” Isomers that differ in the arrangement of their atoms in space are termed “stereoisomers.”

Stereoisomers that are not mirror images of one another are termed “diastereomers” and those that are non-superimposable mirror images of each other are termed “enantiomers.” When a compound has an asymmetric center, for example, it is bonded to four different groups, a pair of enantiomers is possible. An enantiomer can be characterized by the absolute configuration of its asymmetric center and is described by the R - and S-sequencing rules of Cahn and Prelog, or by the manner in which the molecule rotates the plane of polarized light and designated as dextrorotatory or levorotatory (i.e., as (+)- or (−)-isomers respectively). A chiral compound can exist as either individual enantiomer or as a mixture thereof. A mixture containing equal proportions of the enantiomers is called a “racemic mixture”.

“Tautomers” refer to compounds that are interchangeable forms of a particular compound structure, and that vary in the displacement of hydrogen atoms and electrons. Thus, two structures may be in equilibrium through the movement of its electrons and an atom (usually H). For example, enols and ketones are tautomers because they are rapidly interconverted by treatment with either acid or base. Another example of tautomerism is the aci- and nitro-forms of phenylnitromethane, that are likewise formed by treatment with acid or base. Tautomeric forms may be relevant to the attainment of the optimal chemical reactivity and biological activity of a compound of interest.

As used herein a pure enantiomeric compound is substantially free from other enantiomers or stereoisomers of the compound (i.e., in enantiomeric excess). In other words, an “S” form of the compound is substantially free from the “R” form of the compound and is, thus, in enantiomeric excess of the “R” form. The term “enantiomerically pure” or “pure enantiomer” denotes that the compound comprises more than 95% by weight, more than 96% by weight, more than 97% by weight, more than 98% by weight, more than 98.5% by weight, more than 99% by weight, more than 99.2% by weight, more than 99.5% by weight, more than 99.6% by weight, more than 99.7% by weight, more than 99.8% by weight or more than 99.9% by weight, of the enantiomer. In certain embodiments, the weights are based upon total weight of all enantiomers or stereoisomers of the compound.

As used herein and unless otherwise indicated, the term “enantiomerically pure (R)-compound” refers to at least about 95% by weight (R)-compound and at most about 5% by weight (S)-compound, at least about 99% by weight (R)-compound and at most about 1% by weight (S)-compound, or at least about 99.9% by weight (R)-compound and at most about 0.1% by weight (S)-compound. In certain embodiments, the weights are based upon total weight of compound.

As used herein and unless otherwise indicated, the term “enantiomerically pure (S)-compound” or “(S)-compound” refers to at least about 95% by weight (S)-compound and at most about 5% by weight (R)-compound, at least about 99% by weight (S)-compound and at most about 1% by weight (R)-compound or at least about 99.9% by weight (S)-compound and at most about 0.1% by weight (R)-compound. In certain embodiments, the weights are based upon total weight of compound.

In the compositions provided herein, an enantiomerically pure compound or a pharmaceutically acceptable salt, solvate, hydrate or prodrug thereof can be present with other active or inactive ingredients. For example, a pharmaceutical composition comprising enantiomerically pure (R)-compound can comprise, for example, about 90% excipient and about 10% enantiomerically pure (R)-compound. In certain embodiments, the enantiomerically pure (R)-compound in such compositions can, for example, comprise, at least about 95% by weight (R)-compound and at most about 5% by weight (S)-compound, by total weight of the compound. For example, a pharmaceutical composition comprising enantiomerically pure (S)-compound can comprise, for example, about 90% excipient and about 10% enantiomerically pure (S)-compound. In certain embodiments, the enantiomerically pure (S)-compound in such compositions can, for example, comprise, at least about 95% by weight (S)-compound and at most about 5% by weight (R)-compound, by total weight of the compound. In certain embodiments, the active ingredient can be formulated with little or no excipient or carrier.

The compounds of this invention may possess one or more asymmetric centers; such compounds can therefore be produced as individual (R)- or (S)-stereoisomers or as mixtures thereof.

Unless indicated otherwise, the description or naming of a particular compound in the specification and claims is intended to include both individual enantiomers and mixtures, racemic or otherwise, thereof. The methods for the determination of stereochemistry and the separation of stereoisomers are well-known in the art.

The term “about” when referring to a number or a numerical range means that the number or numerical range referred to is an approximation within experimental variability (or within statistical experimental error), and thus the number or numerical range, in some instances, will vary between 1% and 15% of the stated number or numerical range.

The term “comprising” (and related terms such as “comprise” or “comprises” or “having” or “including”) is not intended to exclude that in other certain embodiments, for example, an embodiment of any composition of matter, composition, method, or process, or the like, described herein, “consist of” or “consist essentially of” the described features.

### EXAMPLES

In order that the invention described herein may be more fully understood, the following examples are set forth. The examples described in this application are offered to illustrate the compounds, pharmaceutical compositions, and methods provided herein and are not to be construed in any way as limiting their scope. Compounds of the disclosure were synthesized according to Schemes 1-28.

### Example 1: Scheme 1 to Scheme 28

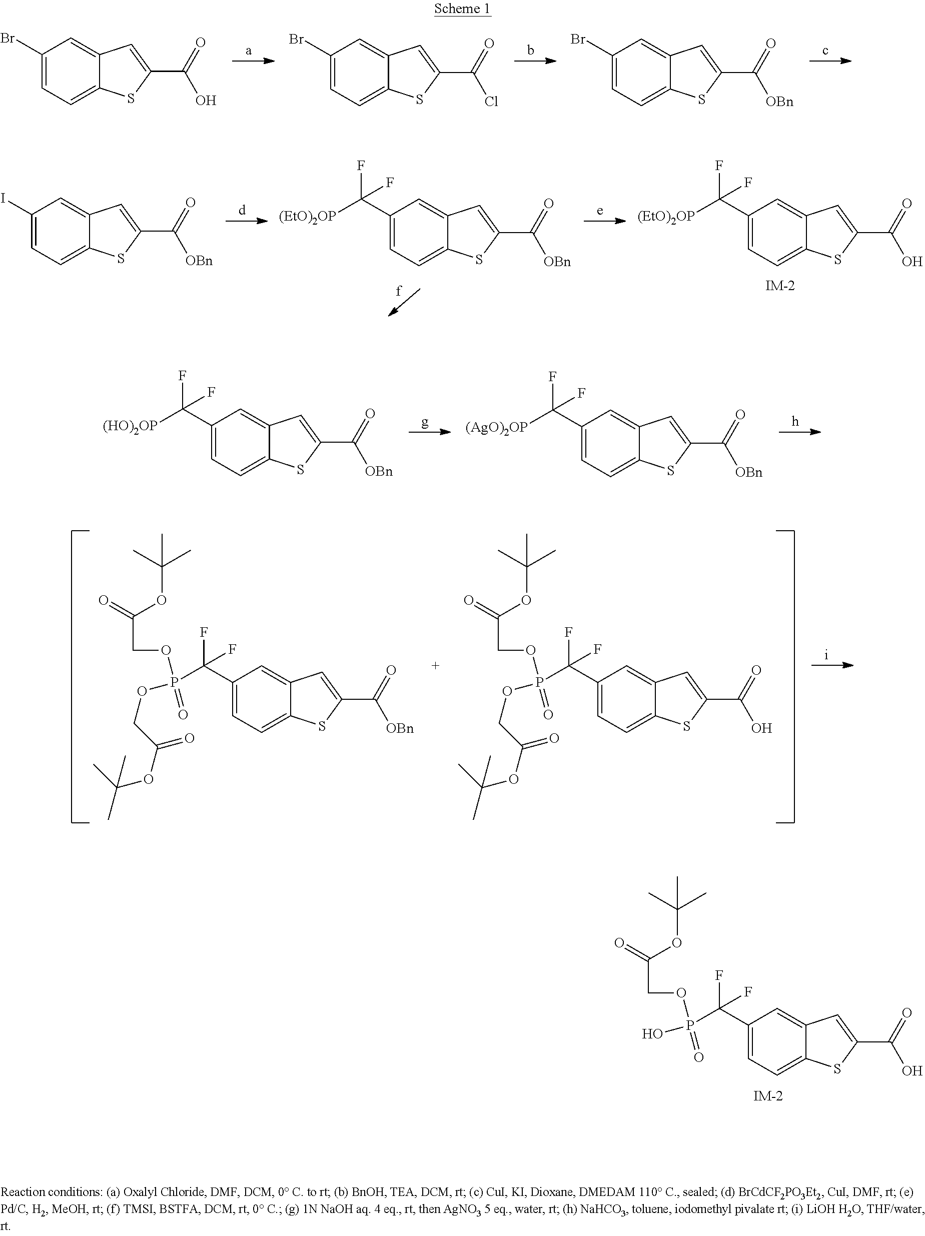

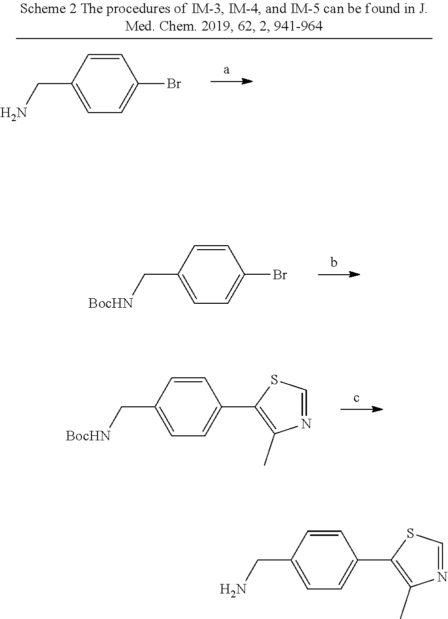 [SMILES: NCc1ccc(Br)cc1 ; CC(C)(C)OC(=O)NCc1ccc(Br)cc1 ; Cc1ncsc1-c1ccc(CNC(=O)OC(C)(C)C)cc1 ; Cc1ncsc1-c1ccc(CN)cc1]

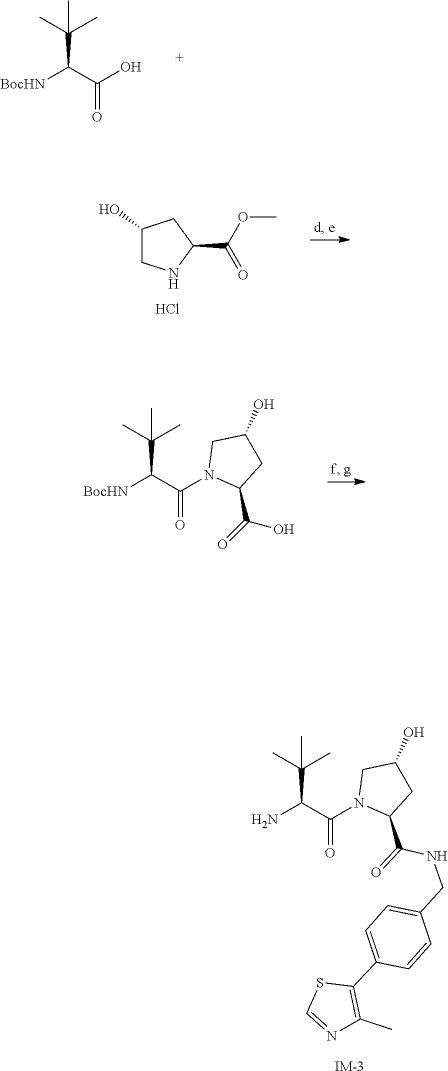

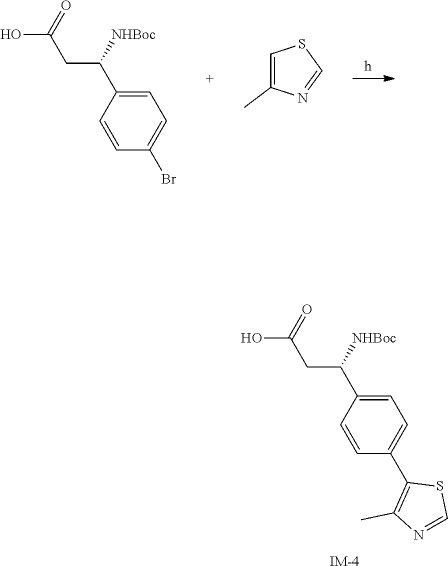

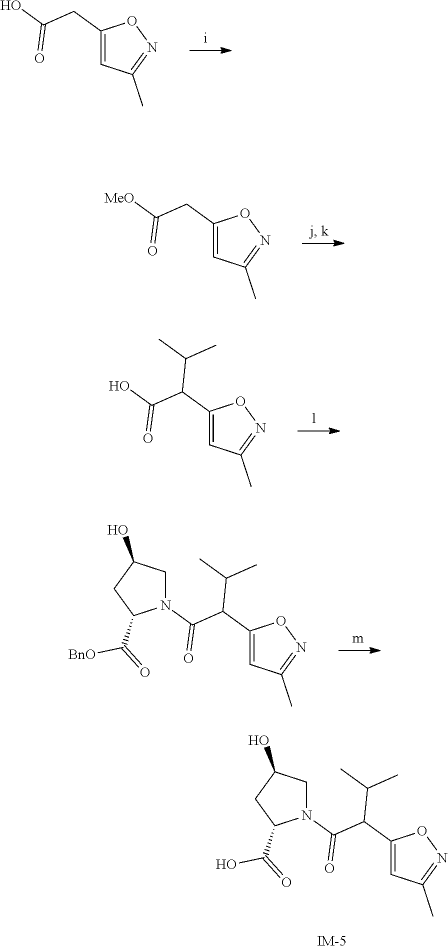

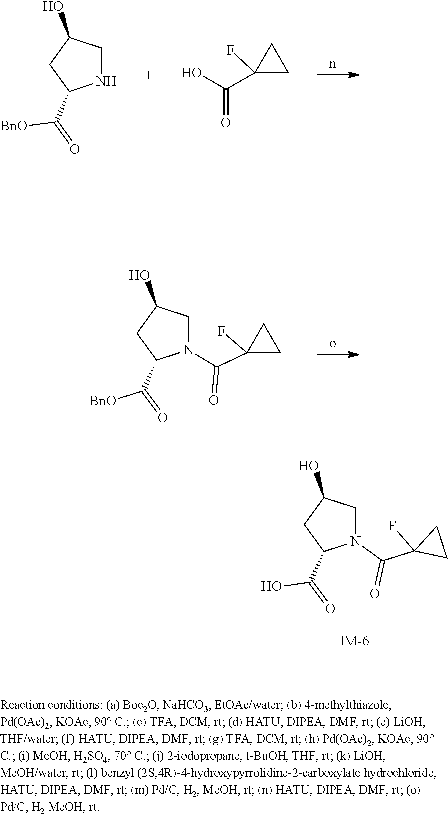

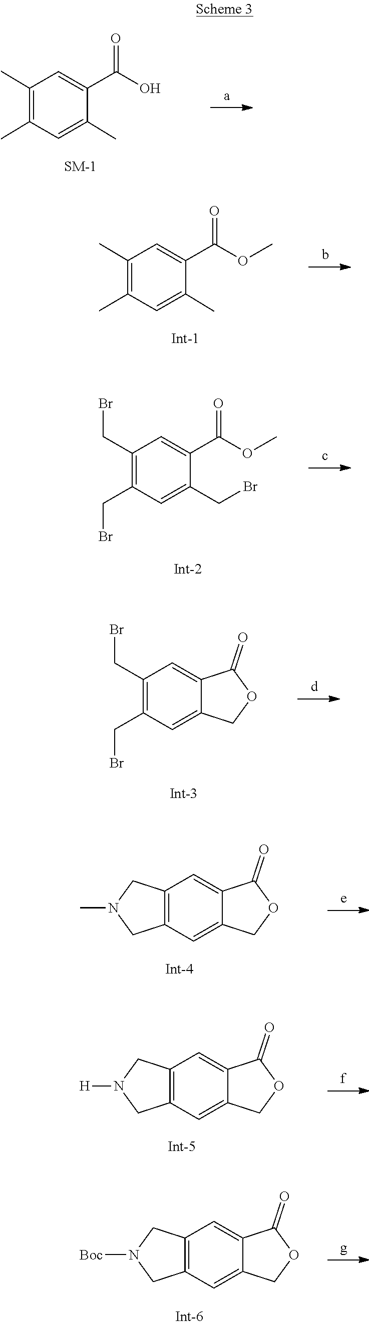

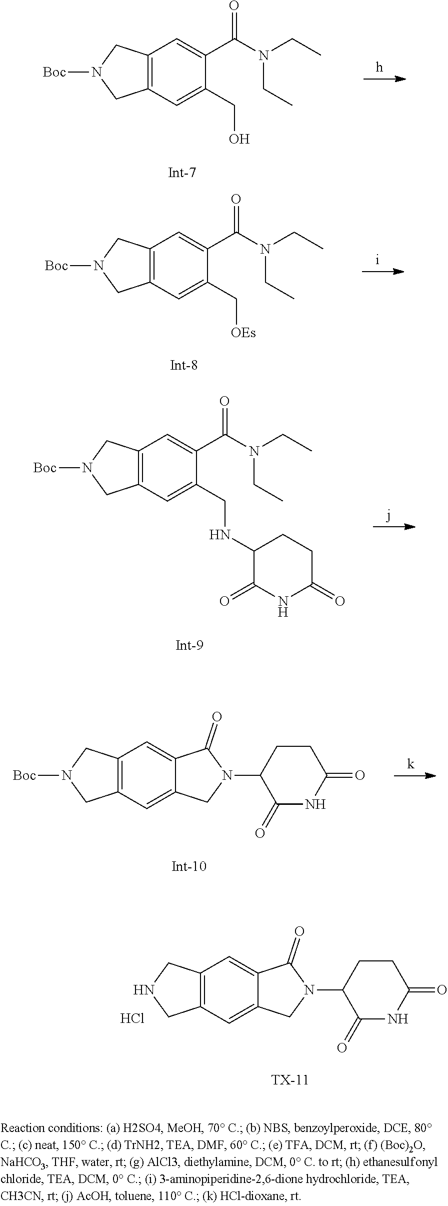

### Procedure for the Synthesis of TX11

### Step 1. The Synthesis of Int-1

To 20 L reactor, SM-1 (660.0 g, 4.02 mol, 1.0 eq.) and 6.6 L methanol were added. The reaction mixture was charged by concentrated sulfuric acid (239 mL, 2.4 mol, 0.6 eq.) and was stirred at 75° C. for 10 h. TLC (PE:EA=8:1, Rf=0.7) checked that SM-1 was consumed. After ⅔ of methanol was evaporated under reduced pressure, then 3.0 L of water and 2.0 L of ethyl acetate were added. The organic phase was washed twice with saturated sodium bicarbonate solution (1.0 L×2), and then washed twice with saturated salt water (1.0 L×2). The organic phase was dried with anhydrous sodium sulfate and concentrated to give 680 g Int-1 (95% yield) as yellow oily liquid.

### Step 2. The Synthesis of Int-2

Int-1 (143 g, 0.8 mol, 1.0 eq.) and N-bromosuccinimide (457 g, 2.57 mol, 3.2 eq.) were dissolved in 1.4 L 1,2-dichloroethane, the reaction mixture was heated to 80° C. and benzoyl peroxide (3.9 g, 0.016 mol, 0.02 eq.) was added in one portion. Heating continued for 8 h. TLC (PE:EA=1:1, Rf=0.2) checked that Int-1 was consumed. The reaction mixture was cooled to ambient temperature, then filtered and the filtrates were concentrated. The residue was purified by silica gel chromatography to give 170 g Int-2 (51% yield) as a white solid.

### Step 3. The Synthesis of Int-3

In a 1 L one-necked flask equipped with a magnetic stir bar, neat tribromoester Int-2 (170 g, 0.4 mol, 1.0 eq.) was heated to 150° C. and stirred for 4 h. TLC (PE:EA=5:1, Rf=0.2) checked that Int-2 was consumed. The reaction mixture was cooled to 50° C., 200 mL DCM was added to dilute the reaction mixture, then the solvent was evaporated under reduced pressure. The obtained residue was purified by silica gel chromatography to give 120 g Int-3 (92% yield) as white solid.

### Step 4. The Synthesis of Int-4

To a solution of Int-3 (120 g, 0.38 mol, 1.0 eq.) in 1.0 L DMF, N,N-Diisopropylethylamine (120 g, 0.94 mol, 2.5 eq.) and tritylamine (88.4 g, 0.34 mol, 0.9 eq) were added. The reaction mixture was heated to 60° C. and stirred for 4 h. TLC (PE:EA=5:1, Rf=0.2) checked that Int-3 was consumed. The reaction mixture was cooled to ambient temperature and poured into 2.0 L of ice water, extracted with 1.0 L ethyl acetate. The organic phase was washed with 500 mL brine, dried over anhydrous MgSO₄, and concentrated under reduced pressure to give 140 g Int-4 (89% yield) as a light yellow solid which was used for next step without further purification.

### Step 5. The Synthesis of Int-5

To a stirred solution of Int-4 (140 g, 0.34 mol, 1.0 eq.) in 700 mL DCM, TFA (56 mL) was added dropwise at 0° C. and then the reaction mixture was stirred at 25° C. for 2 h. TLC checked that Int-4 was consumed. The reaction mixture was concentrated under reduced pressure to remove TFA, followed by adding 500 mL TBME and large amounts of yellowish solid were precipitated. The mixture was stirred at 30° C. for 1 h and then filtered to give 100 g Int-5 (101% yield) as a dark brown solid which was used for next step without further purification.

### Step 6. The Synthesis of Int-6

To 2 L three-necked flask, Int-5 (100 g, 0.35 mol, 1.0 eq.), Sodium bicarbonate (87.2 g, 1.04 mol, 3.0 eq.), THF (800 mL) and H₂O (400 mL) were added. The mixture was cooled to 0° C., followed by charging di-tert-butyl dicarbonate (49.5 g, 0.23 mol, 1.5 eq.). The mixture was stirred at 25° C. for 24 h. TLC (PE:EA=1:1, Rf=0.3) checked that Int-5 was consumed. The reaction mixture was extracted with 500 mL ethyl acetate, and the organic layer was washed with bride, dried over anhydrous MgSO₄ and concentrated in vacuum. The obtained residue was purified by silica gel chromatography to give 27 g Int-6 (17% yield) as reddish brown solid.

### Step 7. The Synthesis of Int-7

To a suspension of aluminium trichloride (20 g, 0.15 mol, 1.3 eq.) in 300 mL DCM, diethylamine (21.3 g, 0.29 mol, 2.5 eq.) was added at 0° C. and the mixture was stirred for additional 30 min. A solution of Int-6 (32 g, 0.12 mol, 1.0 eq.) in 100 mL DCM was added and the resulting mixture was stirred at 25° C. for 1 h. TLC (PE:EA=1:4, Rf=0.2) checked that Int-6 was consumed. The reaction mixture was poured into 300 mL saturated aqueous NH₄Cl. The organic layers were combined and washed with 200 mL saturated aqueous NH₄Cl, dried over anhydrous MgSO₄, and concentrated in vacuum. The obtained residue was purified by silica gel chromatography to give 34.4 g Int-7 (85% yield) as reddish brown oily liquid.

### Step 8. The Synthesis of Int-8

To a solution of Int-7 (32.4 g, 93 mmol, 1.0 eq.) in 300 mL DCM, triethylamine (14.1 g, 0.14 mol, 1.5 eq.) and ethanesulfonyl chloride (14.4 g, 0.11 mol, 1.2 eq.) was added. The reaction mixture was stirred at 0° C. for 30 min. TLC (PE:EA=1:1, Rf=0.2) checked that Int-7 was consumed and 150 mL ice water was added. The organic layers were combined and washed with 100 mL brine, dried over anhydrous MgSO₄, and concentrated in vacuum to give 40.9 g Int-8 (100% yield) as reddish brown oily liquid which was used for next step without further purification.

### Step 9. The Synthesis of Int-9

To 1 L three-necked flask, Int-8 (40.9 g, 93 mol, 1.0 eq.), 3-aminopiperidine-2,6-dione hydrochloride (15.3 g, 93 mol, 3.2 eq.), triethylamine (23.5 g, 0.23 mol, 2.5 eq.) and acetonitrile (400 mL) were added at 0° C. The reaction mixture was warmed to 25° C. and stirred overnight. TLC (PE:EA=1:3, Rf=0.2) checked that Int-8. The reaction mixture was concentrated and re-dissolved in 300 mL ethyl acetate and 200 mL ice water. The organic phases was washed with 100 mL saturated aqueous NaCl, dried over anhydrous MgSO₄, and concentrated in vacuum to give 36.3 g Int-9 (85% yield) as reddish brown oily liquid which was used for next step without further purification.

### Step 10. The Synthesis of Int-10

To 500 mL three-necked flask, Int-9 (36.3 g, 079 mmol, 1.0 eq.), acetic acid (61.8 g, 1.0 mol, 13.0 eq.) and toluene (300 mL) were added. The reaction mixture was heated to 110° C. and stirred for 4 h. TLC (PE:EA=1:3, Rf=0.2) checked that Int-9 was consumed and the reaction mixture was concentrated in vacuum. The obtained residue was purified by silica gel chromatography to give 12.6 g Int-10 (39.3% yield) as brown thick oily liquid which was used for next step without further purification.

### Step 11. The Synthesis of Int-11

A solution of Int-10 (12 g, 31 mmol, 1.0 eq.) in 3.5 M HCl-dioxane (72 mL) was stirred at 25° C. for 2 h. TLC checked that Int-10 was consumed and the mixture was concentrated in vacuum. The residue was beated with 50 mL ethyl acetate, filtered and dried to provide 9.9 g TX-11 (98.8% yield) as off-white solid.

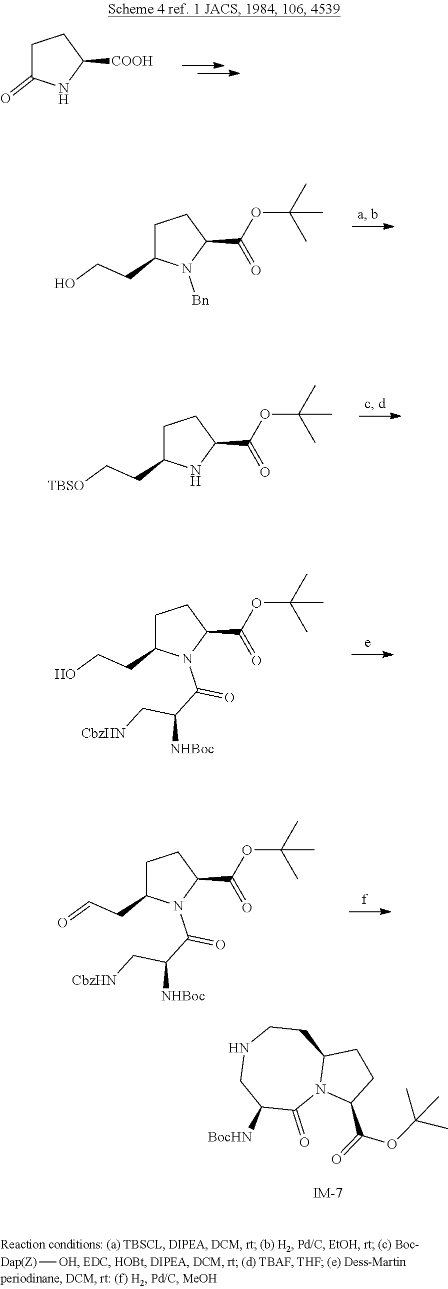

Synthesis detail for IM-7 can be found the following publication: Peng, Y., Sun, H. and Wang, S., 2006. Design and synthesis of a 1, 5-diazabicyclo [6, 3, 0] dodecane amino acid derivative as a novel dipeptide reverse-turn mimetic. Tetrahedron letters, 47(27), pp. 4769-4770.

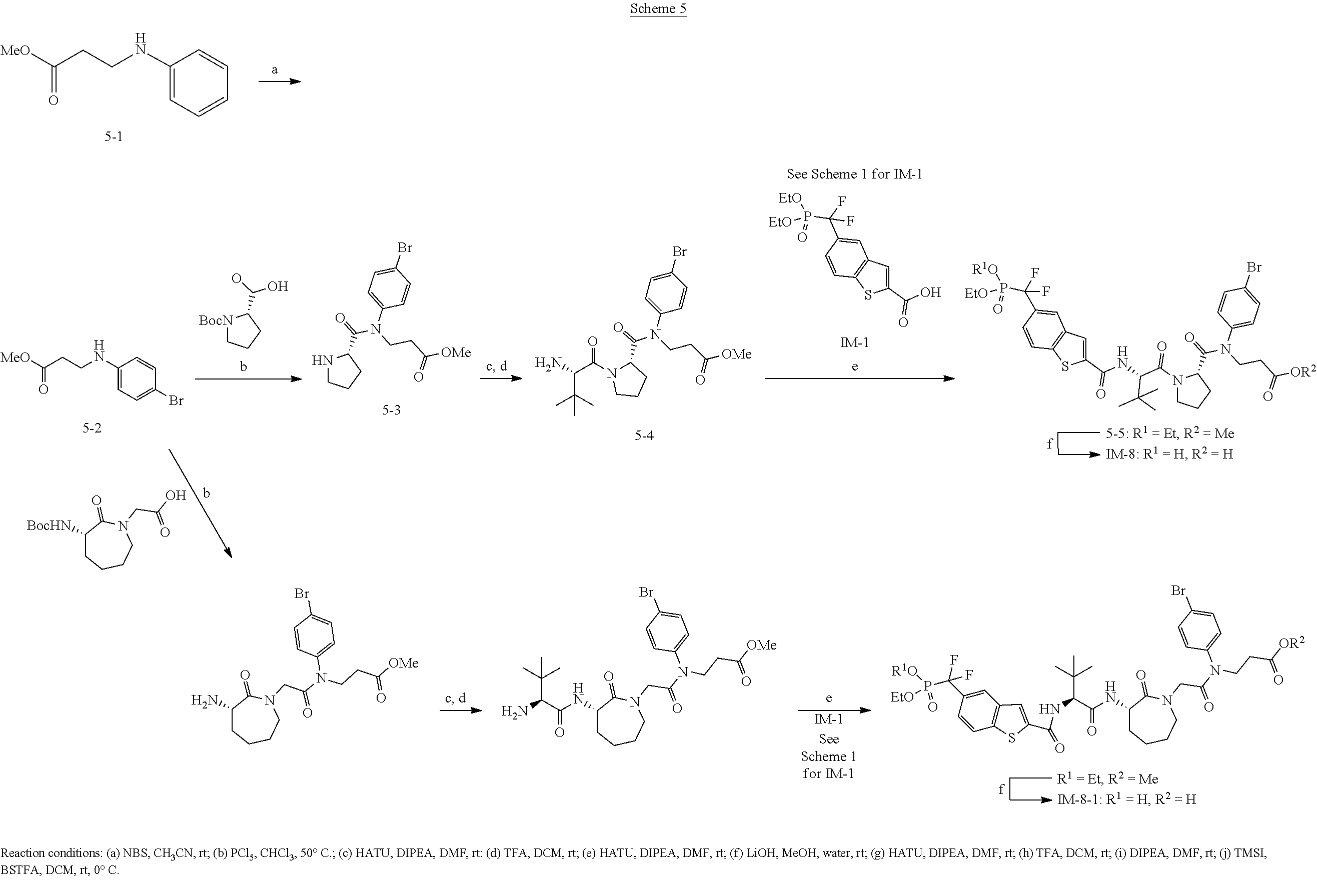

### Synthesis of 3-((2S)—N-(4-bromophenyl)-1-((2S)-2-(5-((ethoxy(hydroxy)phosphoryl)difluoromethyl)benzo[b]thiophene-2-carboxamido)-3,3-dimethylbutanoyl)pyrrolidine-2-carboxamido)propanoic acid (IM-8)

To a round bottom flask were added 5-1 (520 mg, 2.9 mmol, 1 equiv.), CH₃CN (5 ml) and NBS (520 mg, 1 equiv.). The solution was stirred at room temperature for 10 min. The volatile components were removed under vacuum. To the residue were added water and ethylacetate and normal workup was performed. After the volatile components were removed under vacuum, 5-2 was obtained as white solid in 80% (598 mg). ¹H NMR (400 MHz, DMSO) δ 7.19 (d, J=8.8 Hz, 2H), 6.52 (d, J=8.9 Hz, 2H), 5.86 (t, J=5.8 Hz, 1H), 3.60 (s, 3H), 3.28-3.23 (m, 2H), 2.56 (t, J=6.7 Hz, 2H). ESI-MS calculated for C₁₀H₁₂BrNO₂⁺ 258.12, found [M+H]⁺ 258.21, 260.12.

Boc-L-proline (1.6 g, 5 equiv.) was dissolved in CHCl₃ (10 ml). At room temperature, PCl₅ (1.5 g, 5 equiv.) was slowly added over a period of 10 min. After the addition, the mixture was stirred for 10 min at room temperature. To this mixture was added 5-2 (390 mg, 1.5 mmol) and the mixture was stirred at 50° C. for 20 min. The volatile components were removed on a rotary evaporator. The obtained crude oil was purified by HPLC to yield 5-3 as TFA salt in 60% (420 mg). ¹H NMR (400 MHz, DMSO) δ 7.81-7.68 (m, 2H), 7.41-7.35 (m, 2H), 4.02-3.78 (m, 3H), 3.53 (s, 3H), 3.22-3.13 (m, 1H), 3.08-3.02 (m, 1H), 2.56-2.53 (m, 1H), 2.45-2.40 (m, 1H), 1.80-1.70 (m, 5H). ESI-MS calculated for C₁₅H₁₉BrN₂O₃⁺ 355.23, found [M+H]⁺ 355.17, 357.17.

To 5-3 TFA salt (230 mg, 0.49 mmol), CH₃CN (5 ml), triethylamine (0.45 ml, 5 equiv.), Boc-L-tert-leucine (170 mg, 1.5 equiv.), and HATU (230 mg, 1.2 equiv.) were added. The mixture was stirred at room temperature for 30 min. The yellow solution was concentrated in vacuum and the crude was purified by flash column chromatography to yield Boc-protected 5-4. Boc protection was removed by DCM/TFA at room temperature for 30 min. The volatile components were removed in vacuum to yield 5-4 as a TFA salt in 85% (240 mg). ¹H NMR (400 MHz, DMSO) δ 7.98 (s, 2H), 7.80-7.59 (m, 2H), 7.48-7.26 (m, 2H), 4.09-4.03 (m, 1H), 4.00-3.88 (m, 1H), 3.80-3.60 (m, 5H), 3.57-3.37 (m, 2H), 2.45-2.40 (m, 2H), 2.02-1.47 (m, 4H), 1.05 (s, 9H). ESI-MS calculated for C₂₁H₃₀BrN₃O₄⁺ 468.39, found [M+H]⁺ 468.32, 470.31.

To 5-4 TFA salt (110 mg, 0.19 mmol), CH₃CN (5 ml), triethylamine (0.13 ml, 5 equiv.), IM-6 (70 mg, 1.1 equiv.), and HATU (75 mg, 1.1 equiv.) were added. The mixture was stirred at room temperature for 30 min. The yellow solution was concentrated in vacuum and the crude was purified by flash column chromatography to yield 5-5 in 75% (116 mg). ¹H NMR (400 MHz, DMSO) δ 8.54 (s, 1H), 8.47 (dd, J=9.0, 2.1 Hz, 1H), 8.19 (d, J=8.5 Hz, 1H), 8.10 (s, 1H), 7.75-7.57 (m, 3H), 7.37 (dd, J=8.6, 2.2 Hz, 2H), 4.75 (d, J=8.9 Hz, 1H), 4.29-4.06 (m, 6H), 3.91-3.71 (m, 3H), 3.66-3.62 (m, 1H), 3.52 (s, 32H), 2.46-2.33 (m, 1H), 2.00-1.95 (m, 1H), 1.91-1.62 (m, 3H), 1.25-1.20 (m, 6H), 1.08 (s, 9H). ESI-MS calculated for C₃₅H₄₃BrF₂N₃O₈PS⁺ 814.68, found [M+H]⁺ 814.19, 816.16.

5-5 (150 mg, 0.18 mmol) was dissolved in MeOH (5 ml) and water (1 ml) and the mixture was placed in an ice bath. LiOH monohydrate (60 mg, 8 equiv.) was added to the mixture and then it was stirred for 1 h at room temperature. The mixture was placed in an ice bath again and neutralized by slowly adding TFA. The volatile components were removed on a rotary evaporator and the residue was purified by flash column chromatography to yield IM-8 in 70% (100 mg). ¹H NMR (400 MHz, DMSO) δ 8.52 (s, 1H), 8.42 (d, J=8.9 Hz, 1H), 8.12 (d, J=8.5 Hz, 1H), 8.05 (s, 1H), 7.76-7.55 (m, 3H), 7.44-7.30 (m, 2H), 4.75 (d, J=9.0 Hz, 1H), 4.09 (t, J=7.1 Hz, 1H), 4.02-3.97 (m, 2H), 3.78 (t, J=7.4 Hz, 3H), 3.66-3.62 (m, 1H), 2.46-2.35 (m, 2H), 1.99-1.95 (m, 1H), 1.89-1.67 (m, 3H), 1.18 (t, J=7.1 Hz, 3H), 1.08 (s, 9H). ESI-MS calculated for C₃₂H₃₇BrF₂N₃O₈PS⁺ 772.60, found [M+H]⁺ 771.32, 773.53.

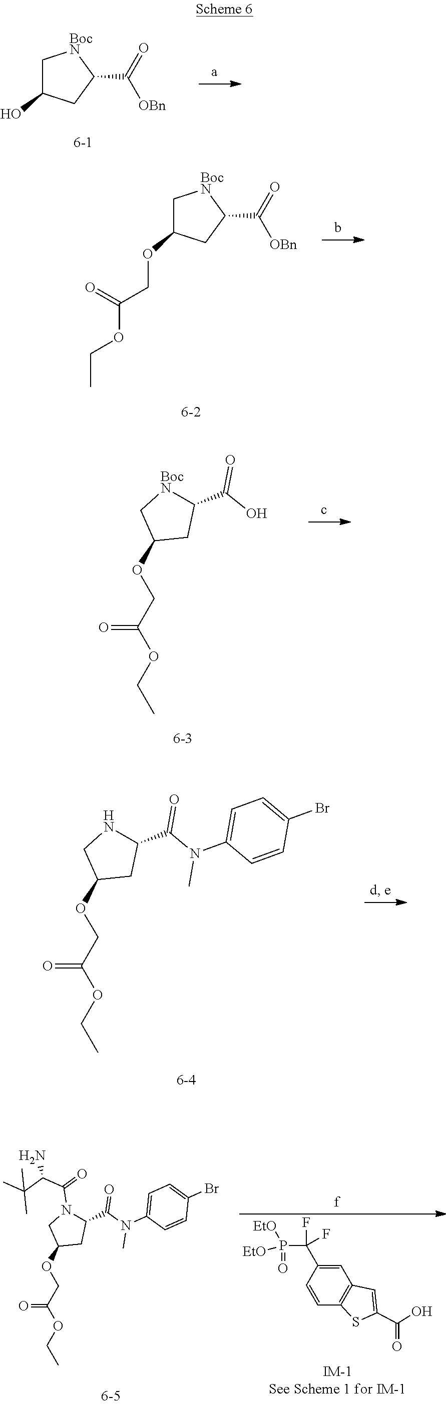 [SMILES: CC(C)(C)OC(=O)N1C[C@H](O)C[C@H]1C(=O)OCc1ccccc1 ; CCOC(=O)CO[C@@H]1C[C@@H](C(=O)OCc2ccccc2)N(C(=O)OC(C)(C)C)C1 ; CCOC(=O)CO[C@@H]1C[C@@H](C(=O)O)N(C(=O)OC(C)(C)C)C1 ; CCOC(=O)CO[C@H]1CN[C@H](C(=O)N(C)c2ccc(Br)cc2)C1 ; CCOC(=O)CO[C@@H]1C[C@@H](C(=O)N(C)c2ccc(Br)cc2)N(C(=O)[C@@H](N)C(C)(C)C)C1 ; CCOP(=O)(OCC)C(F)(F)c1ccc2sc(C(=O)O)cc2c1]

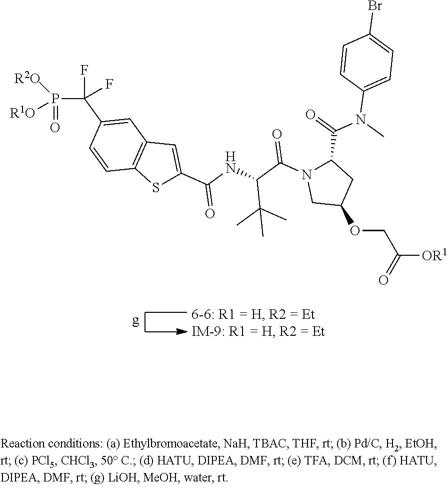

### 2-(((3R,5S)-5-((4-bromophenyl)(methyl)carbamoyl)-1-((2S)-2-(5-((ethoxy(hydroxy)phosphoryl)difluoromethyl)benzo[b]thiophene-2-carboxamido)-3,3-dimethylbutanoyl)pyrrolidin-3-yl)oxy)acetic acid (IM-9)

To a round bottom flask equipped with a magnetic stirring bar were added 6-1 (1 g, 3.1 mmol), THF (7 ml), and tetra-butylammonium chloride (100 mg, 0.1 equiv.). NaH (170 mg, 1.2 equiv., 60% in oil) was slowly added to the reaction mixture in ice bath. Then ethylbromoacetate (400 μl, 1.2 equiv.) was added and the mixture was stirred at room temperature for 2 hours. The reaction was quenched by slowly adding ice in ice bath. The reaction was neutralized by slowly adding TFA. The solvent was removed on a rotary evaporator. The residual crude product was purified by flash column chromatography to yield 6-2 in 39% yield (500 mg). ¹H NMR (400 MHz, DMSO) δ 7.46-7.22 (m, 5H), 5.15 (s, 2H), 4.26-4.22 (m, 1H), 4.18-4.05 (m, 4H), 3.55-3.38 (m, 3H), 2.00-1.94 (m, 2H), 1.26 (s, 9H), 1.19 (t, J=7.1 Hz, 3H). ESI-MS calculated for C₂₁H₂₉NO₇⁺ 407.46, found [M+H]⁺ 408.81.

6-2 was treated with 10% Pd/C and hydrogen in ethanol (10 ml) at room temperature for 1 h, followed by the filtration and concentration, to yield 6-3 in quantitative yield (380 mg). ¹H NMR (400 MHz, DMSO) δ 4.22-4.00 (m, 5H), 3.54-3.09 (m, 3H), 2.42-2.24 (m, 1H), 2.01-1.86 (m, 1H), 1.34 (s, 9H), 1.20 (t, J=7.1 Hz, 3H). ESI-MS calculated for C₁₄H₂₃NO₇⁺ 317.34, found [M+H]⁺ 318.25.

6-3 (100 mg, 0.31 mmol, 1 equiv.) was dissolved in CHCl₃ (3 ml). At room temperature, PCl₅ (20 mg, 3 equiv.) was added. After the addition, the mixture was stirred for 10 min at room temperature. To this mixture was added 4-bromo-N-methylaniline (300 mg, 5 equiv.) and the mixture was stirred at reflux for 4 hours. The volatile components were removed on a rotary evaporator. The obtained crude oil was purified by HPLC to yield 13. The resulting colorless oil 6-4 was dissolved in CH₃CN (5 ml). To the solution were added CH₃CN (5 ml), triethylamine (0.22 ml, 5 equiv.), Boc-L-tert-leucine (80 mg, 1.1 equiv.), and HATU (140 mg, 1.2 equiv.). The mixture was stirred at room temperature for 30 min. The yellow solution was concentrated in vacuum and the crude was purified by flash column chromatography to yield Boc-protected 6-5. Boc protection was removed by DCM/TFA at room temperature for 30 min. The volatile components were removed in vacuum to yield 6-5 as a TFA salt. To 6-5, CH₃CN (5 ml), triethylamine (0.22 ml, 5 equiv.), IM-1 (130 mg, 1.1 equiv.), and HATU (130 mg, 1.1 equiv.) were added. The mixture was stirred at room temperature for 30 min. The yellow solution was concentrated in vacuum and the crude was purified by flash column chromatography to yield 6-6 in 40% (4 steps, 104 mg). ¹H NMR (400 MHz, DMSO) δ 8.53 (d, J=0.8 Hz, 1H), 8.42 (d, J=8.7 Hz, 1H), 8.20 (d, J=8.6 Hz, 1H), 8.11 (d, J=1.9 Hz, 1H), 7.72-7.56 (m, 3H), 7.36 (d, J=8.2 Hz, 2H), 4.70 (d, J=8.8 Hz, 1H), 4.23-4.05 (m, 9H), 3.40-3.30 (m, 3H), 3.15 (s, 3H), 2.30-2.20 (m, 1H), 1.70-1.60 (m, 1H), 1.36-1.14 (m, 9H), 1.09 (s, 9H). ESI-MS calculated for C₃₆H₄₅BrF₂N₃O₉PS⁺ 844.70, found [M+Na]⁺ 866.26, 868.26.

6-6 (285 mg, 0.33 mmol) was dissolved in MeOH (5 ml) and water (1 ml) and the mixture was placed in an ice bath. LiOH monohydrate (90 mg, 6 equiv.) was added to the mixture and then it was stirred for 3 hours at room temperature. The mixture was placed in an ice bath again and neutralized by slowly adding TFA. The volatile components were removed on a rotary evaporator and the residue was purified by flash column chromatography to yield IM-9 in 70% (182 mg). ¹H NMR (400 MHz, DMSO) δ 8.51 (s, 1H), 8.37 (d, J=8.8 Hz, 1H), 8.13 (d, J=8.6 Hz, 1H), 8.06 (s, 1H), 7.75-7.55 (m, 3H), 7.36 (d, J=8.2 Hz, 2H), 4.70 (d, J=8.8 Hz, 1H), 4.34-3.84 (m, 7H), 3.40 (t, J=9.1 Hz, 1H), 3.12 (s3H), 2.32-2.25 (m, 1H), 1.70-1.65 (m, 1H), 1.18 (t, J=7.1 Hz, 3H), 1.09 (s, 9H). ESI-MS calculated for C₃₂H₃₇BrF₂N₃O₉PS⁺ 1087.16, found [M+H]⁺ 1084.08.

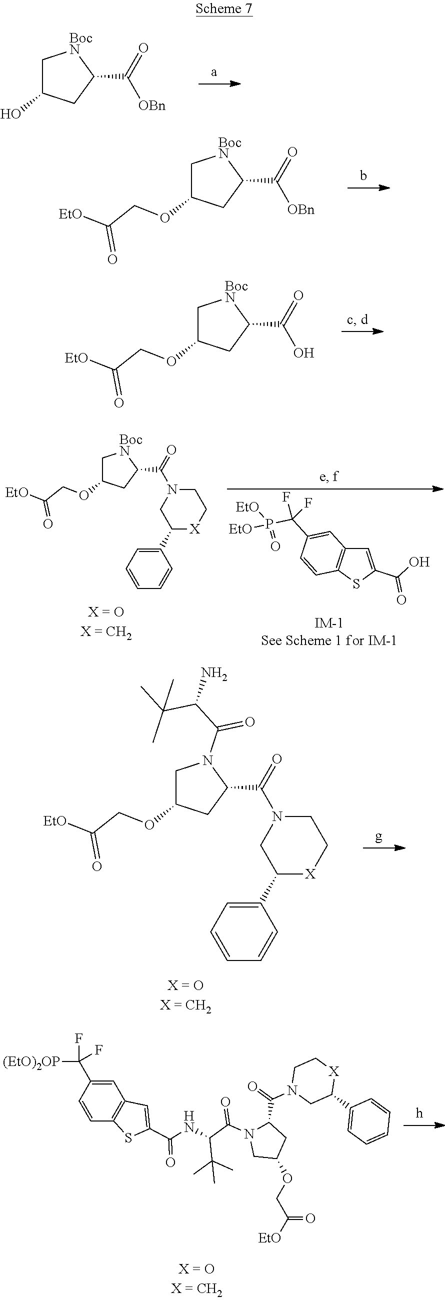

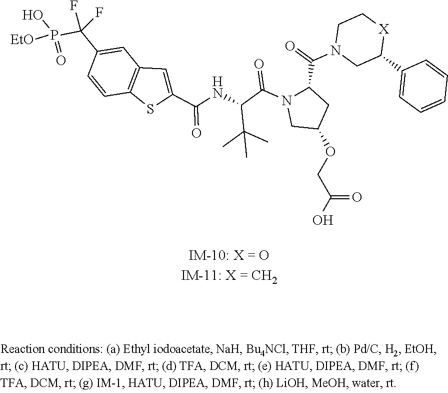

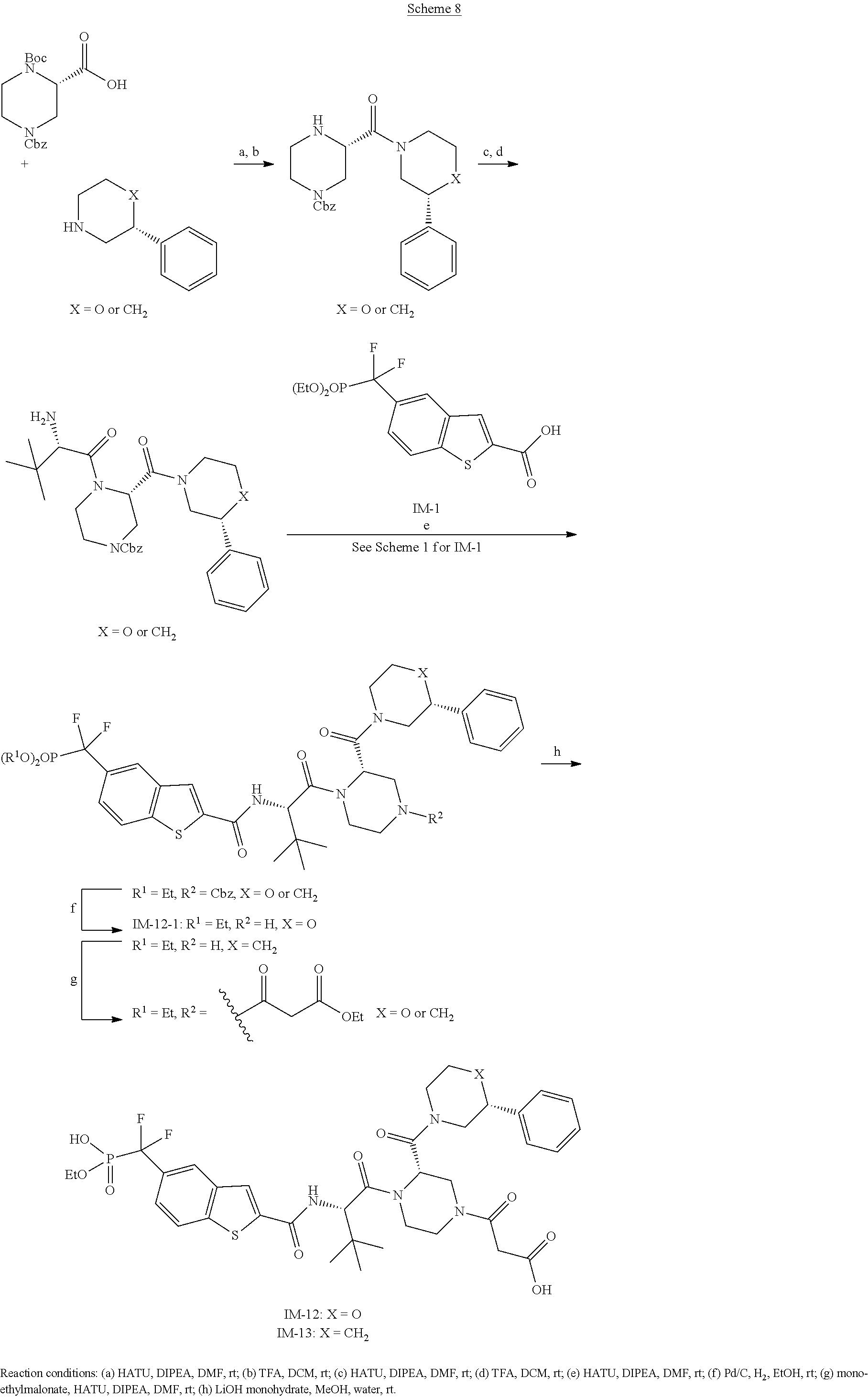

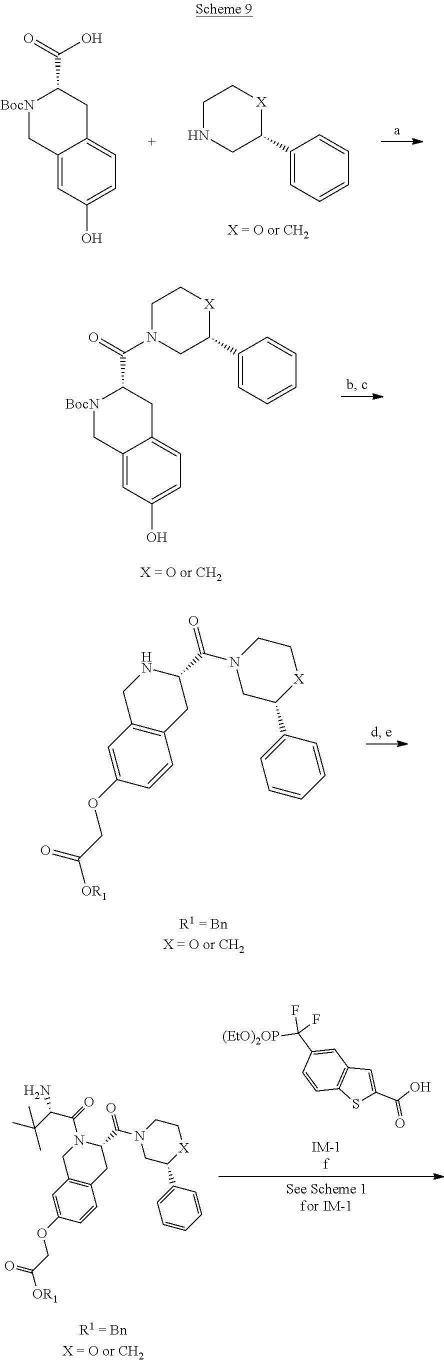

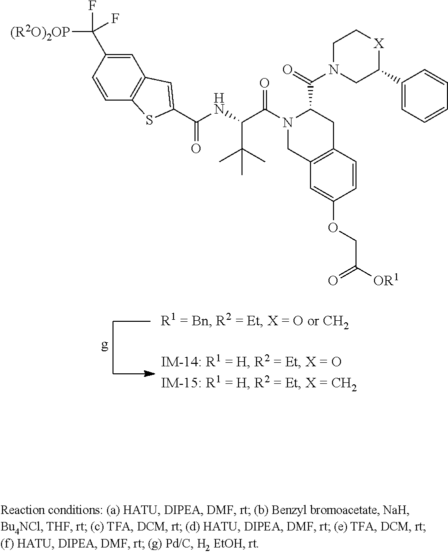

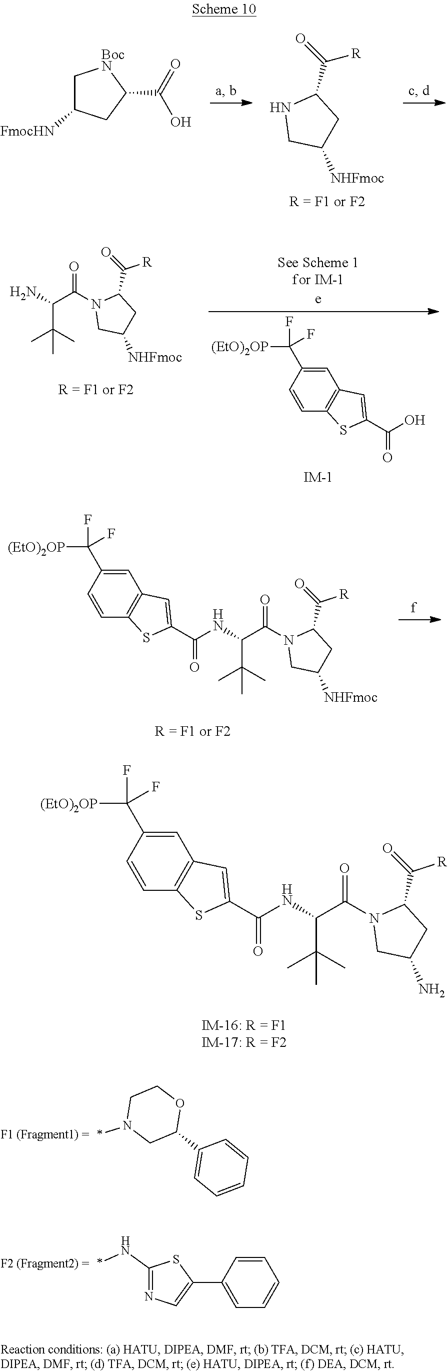

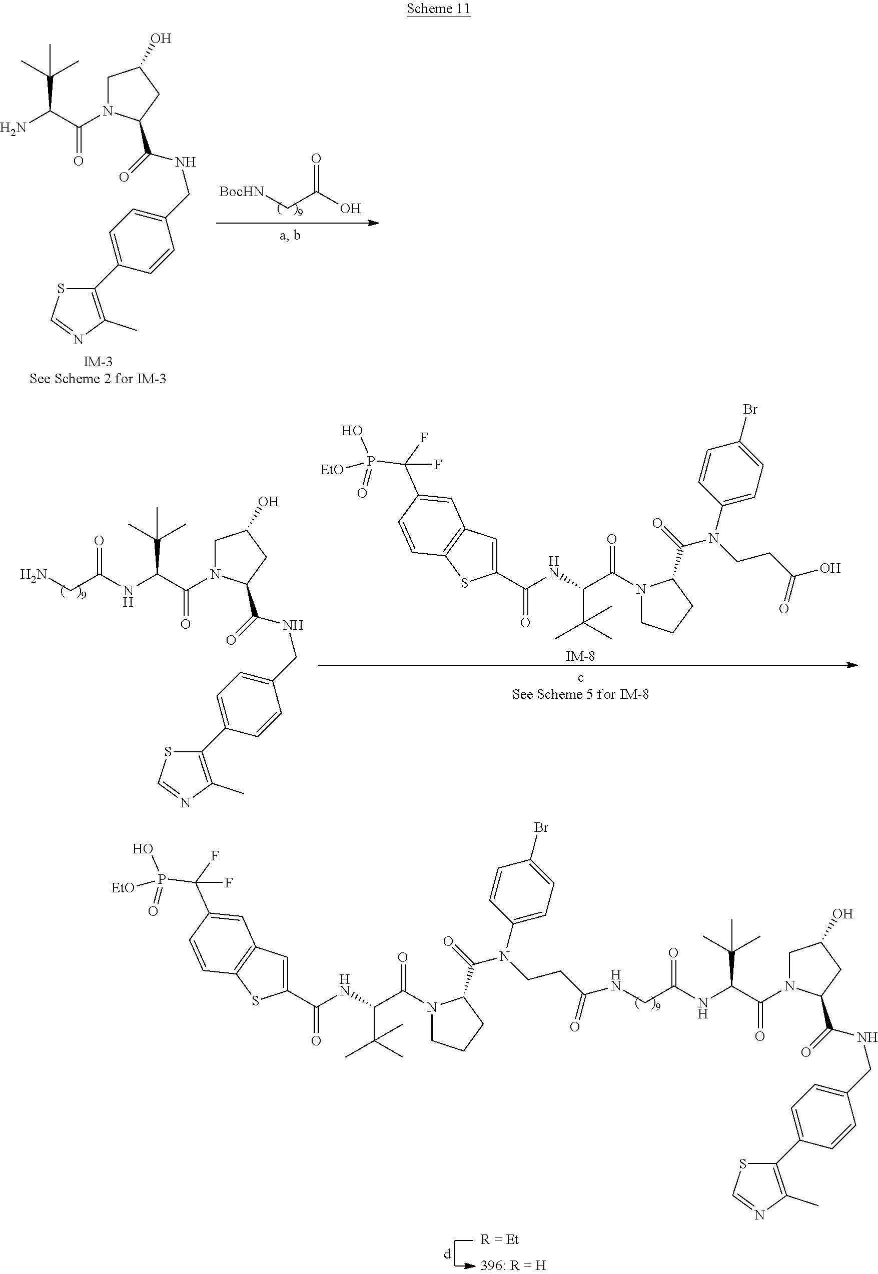

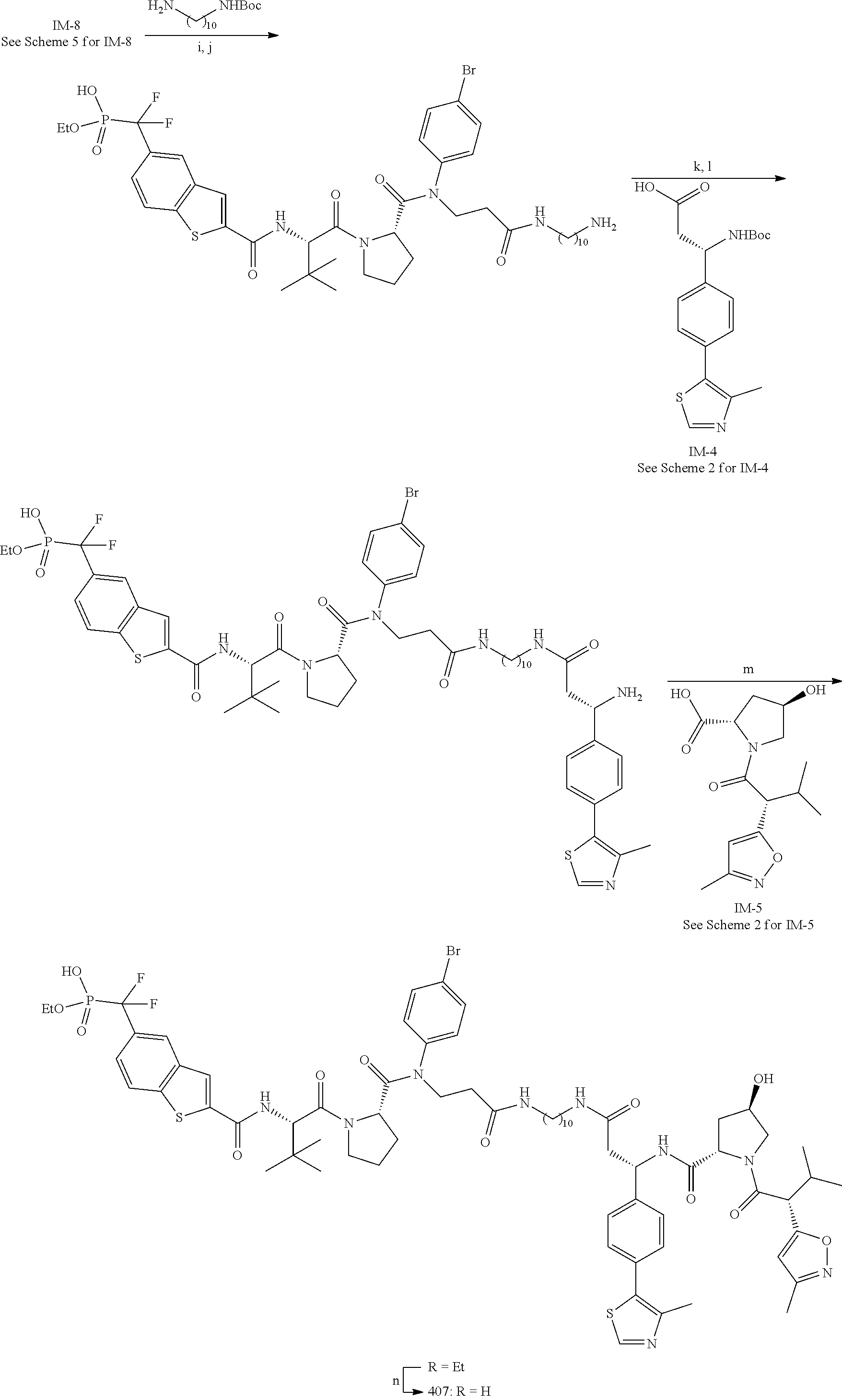

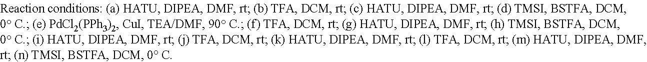

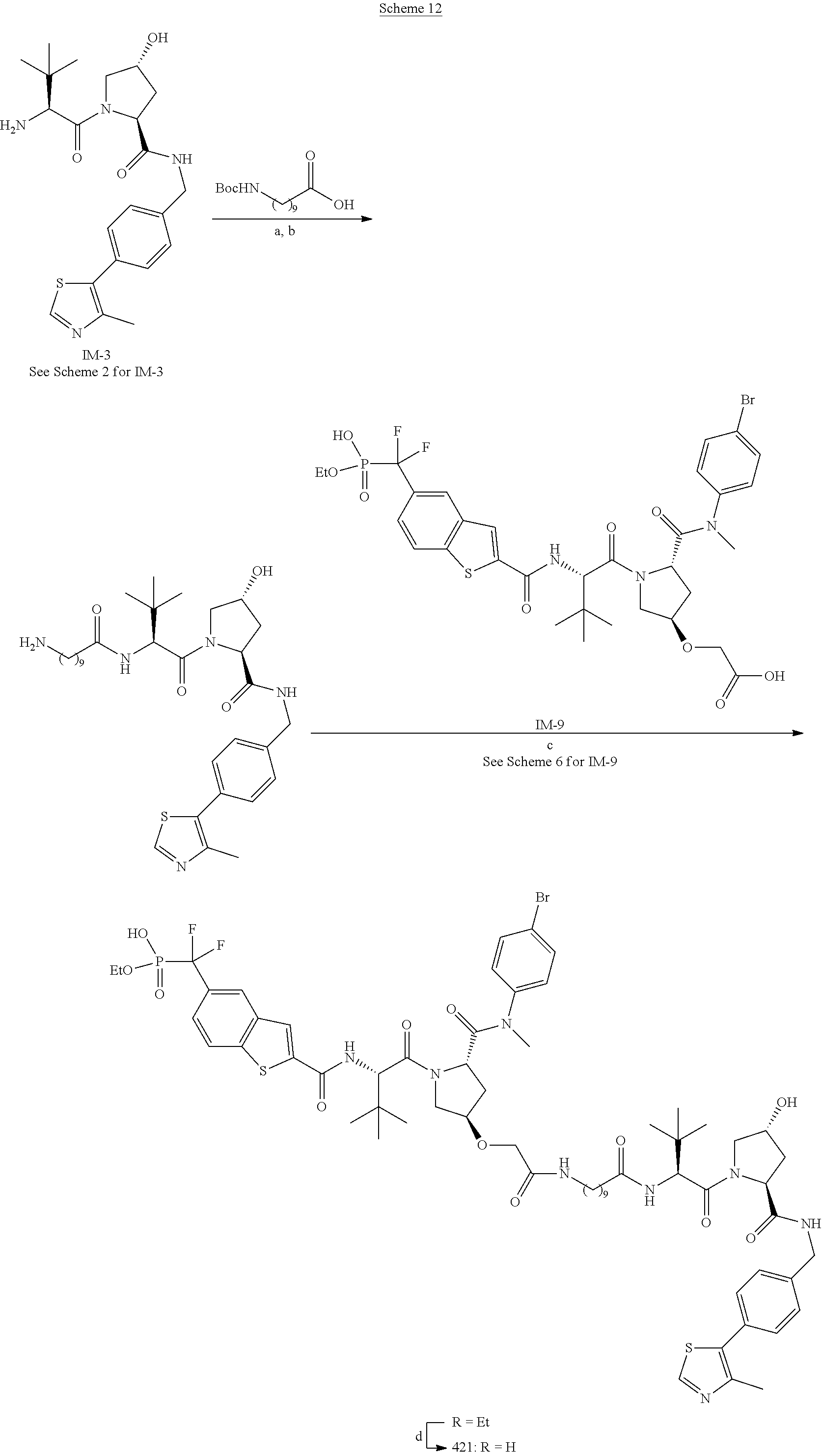

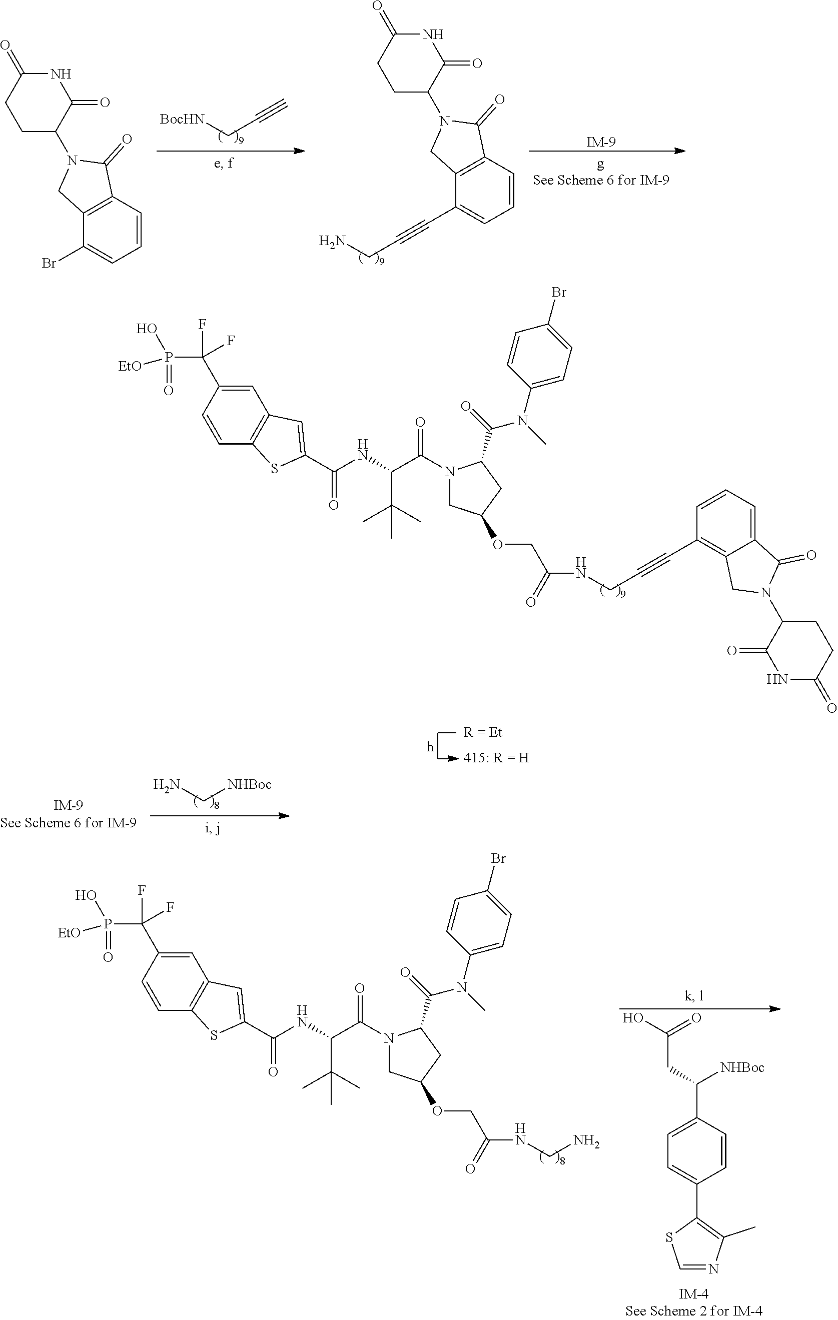

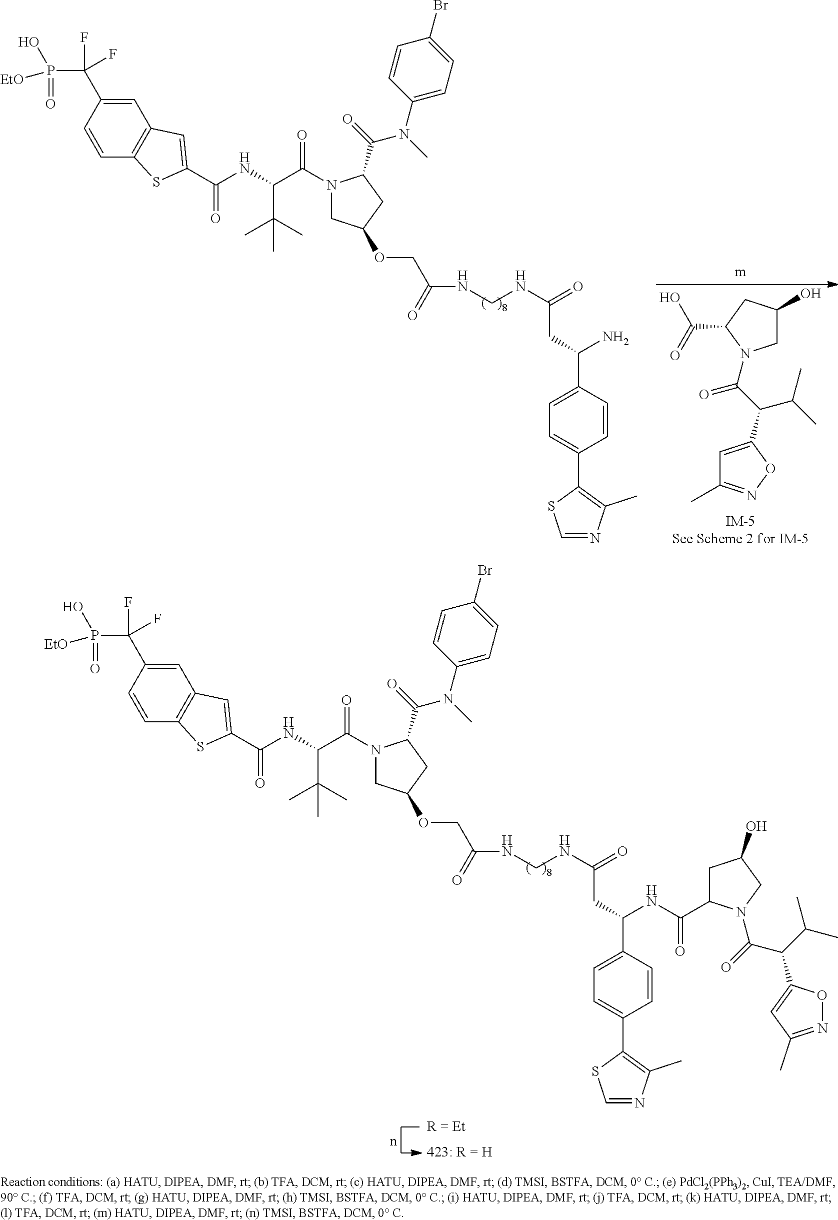

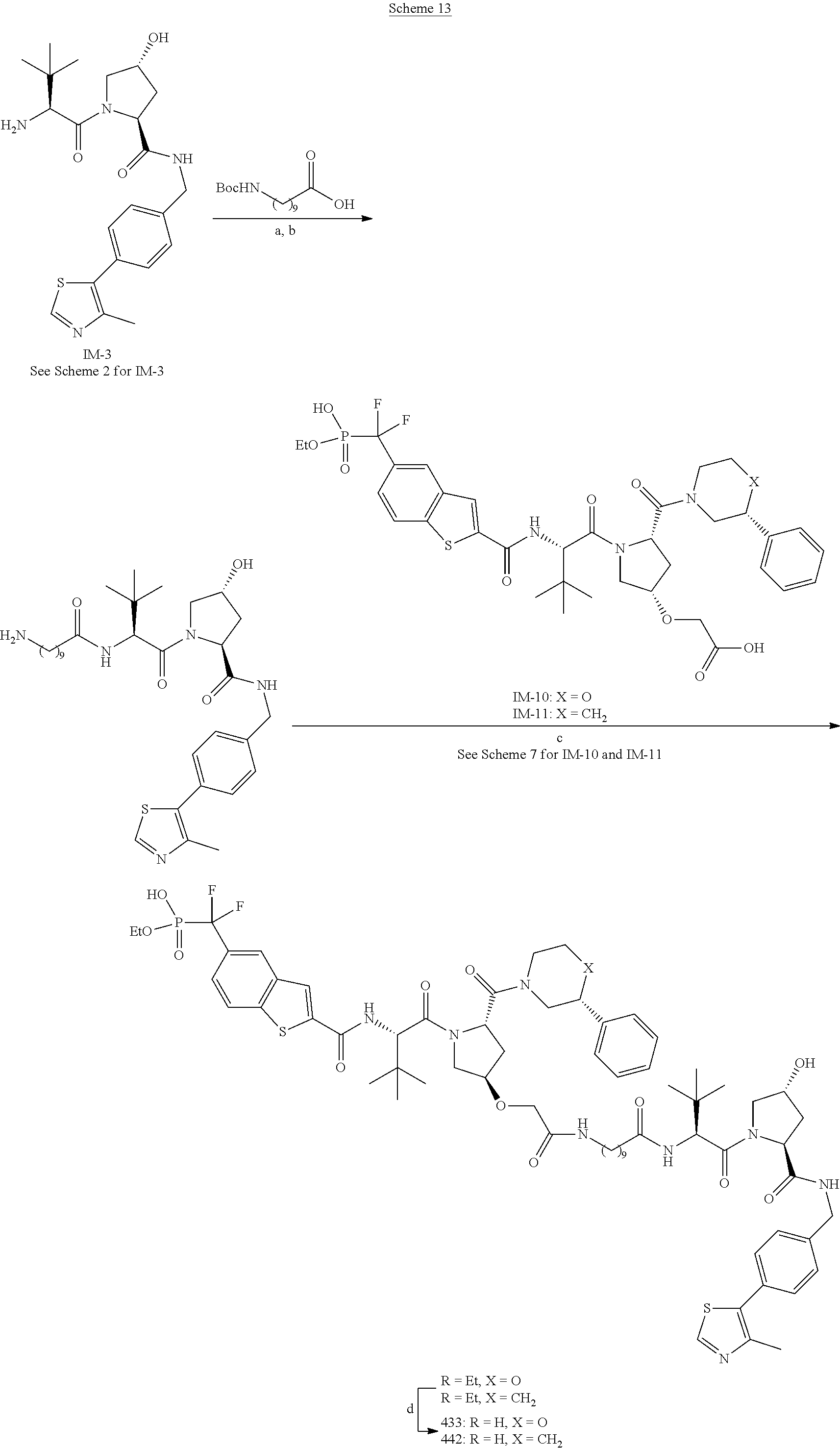

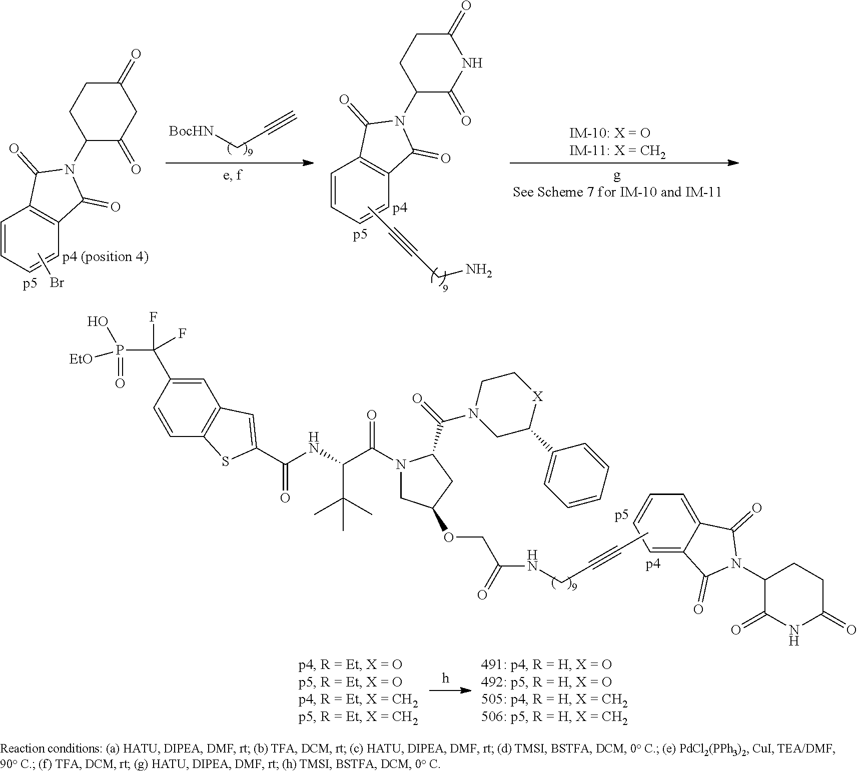

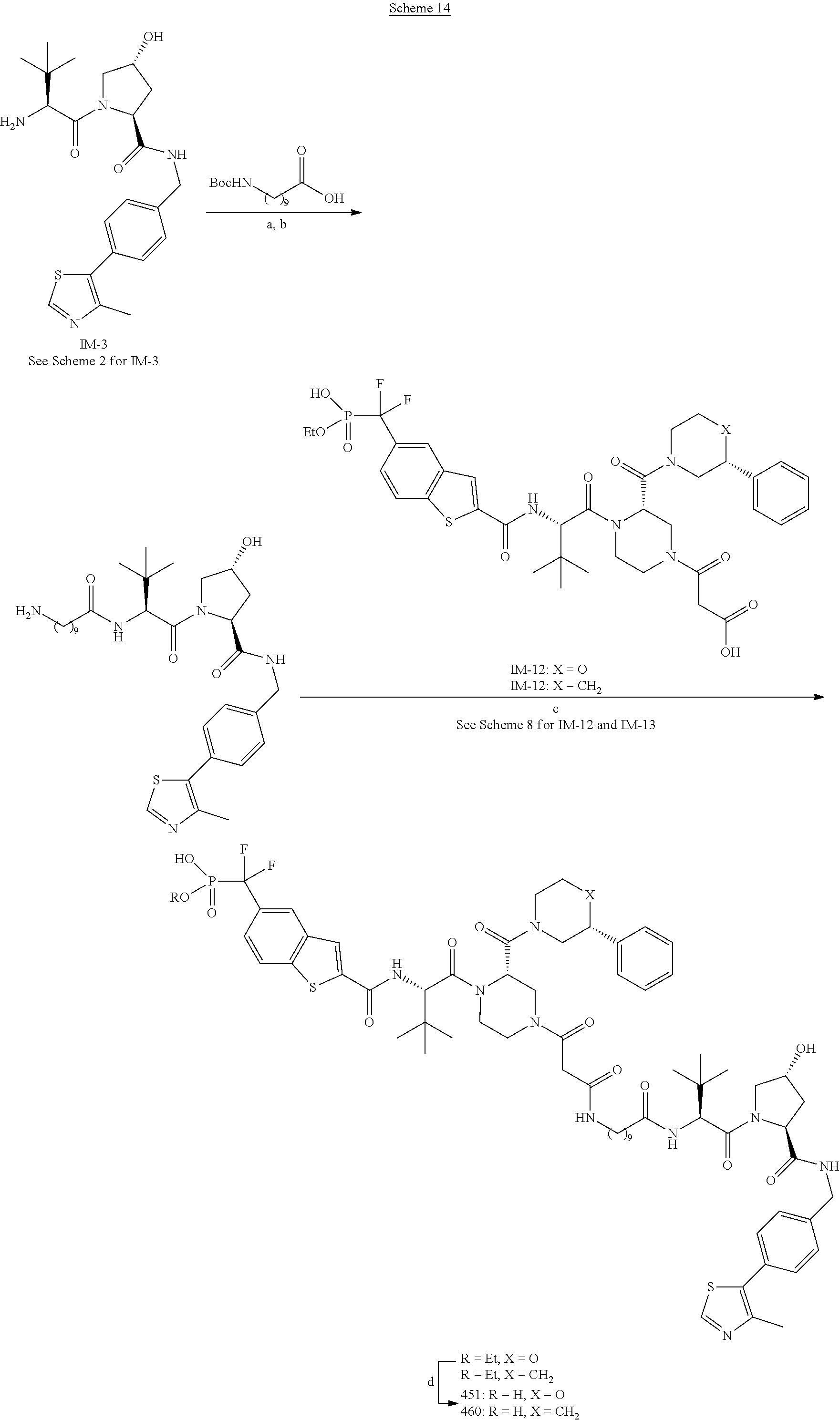

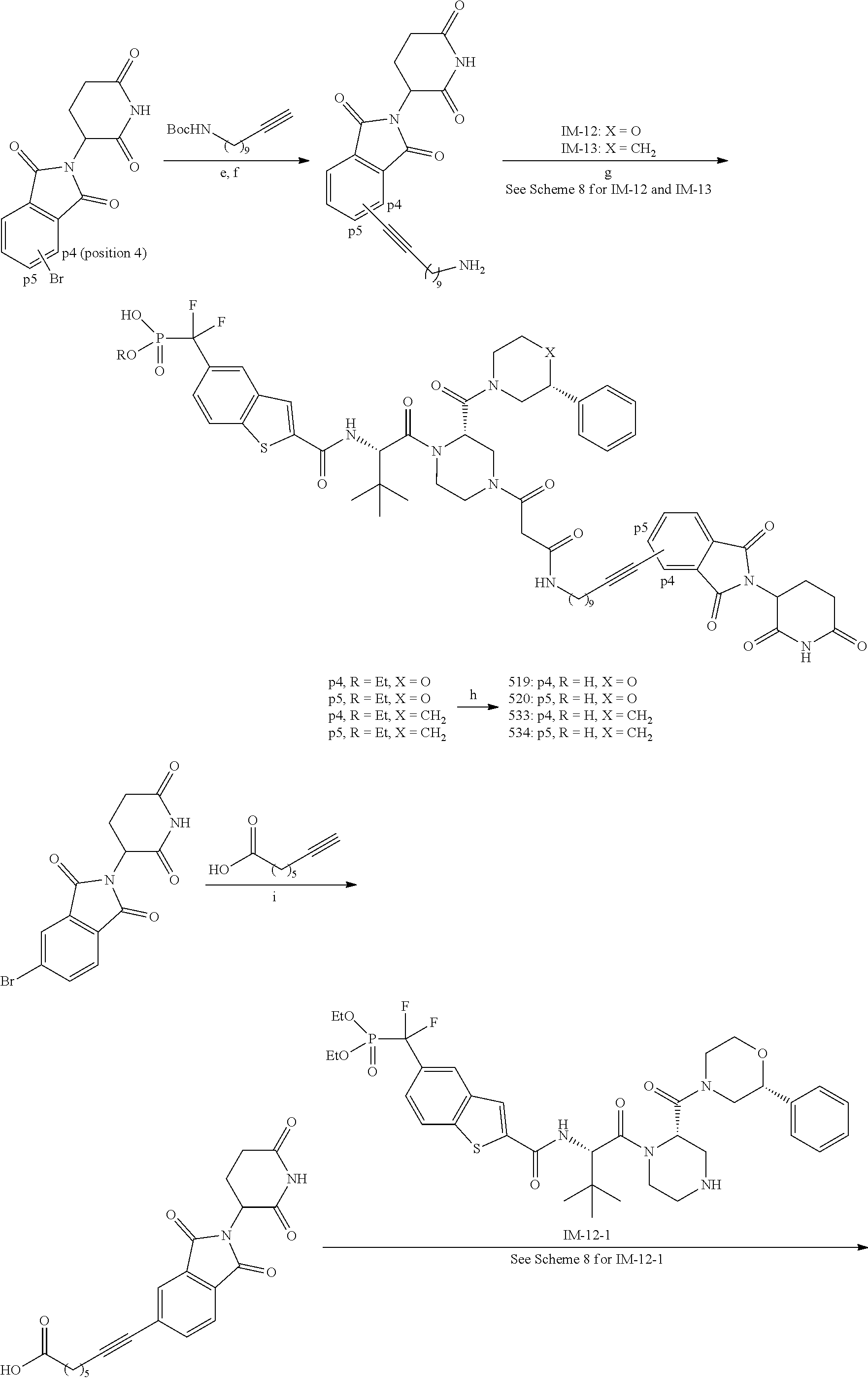

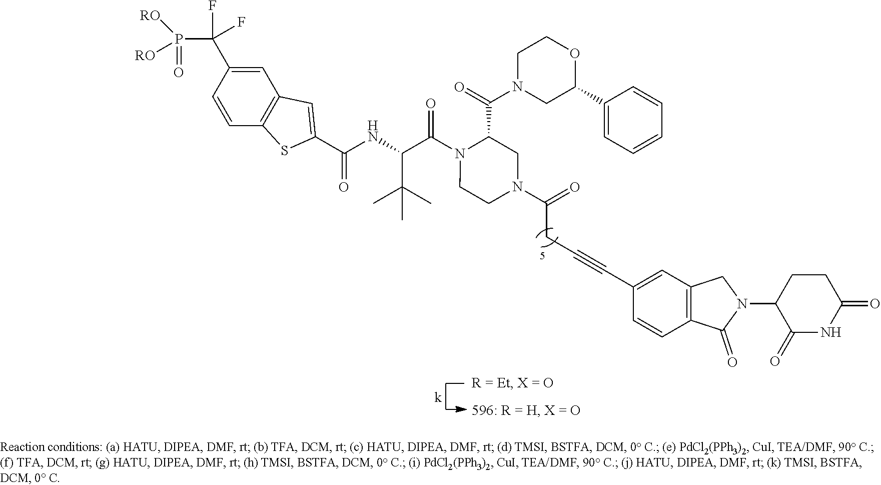

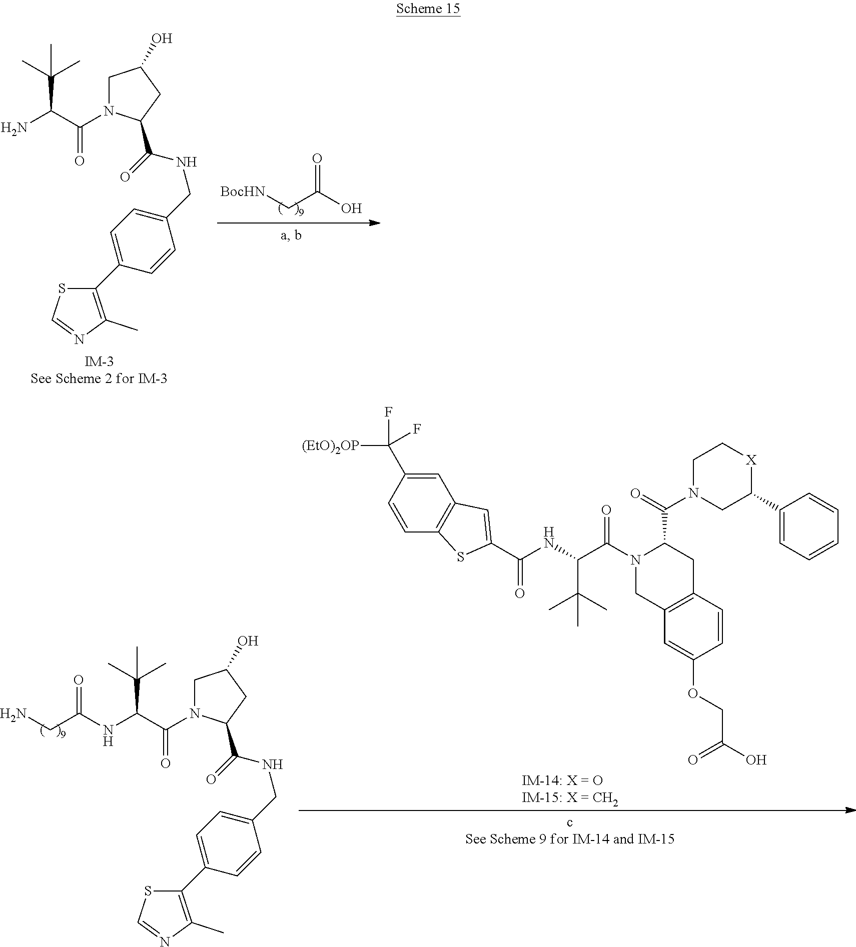

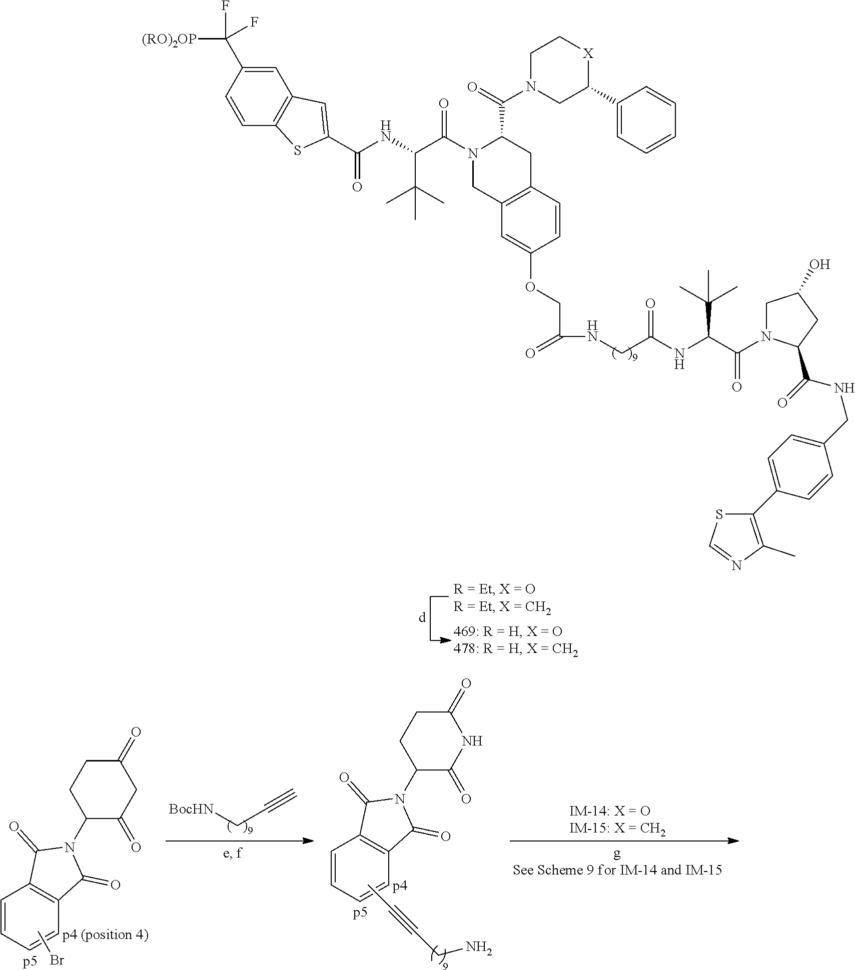

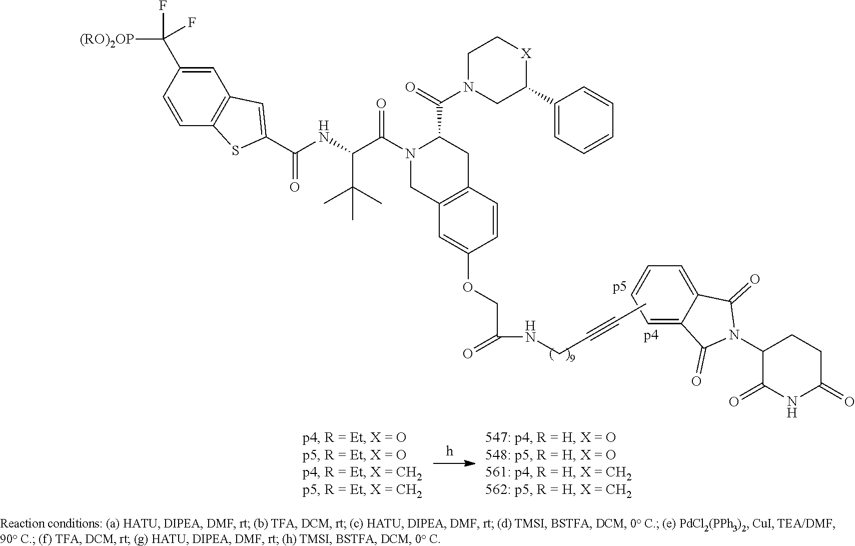

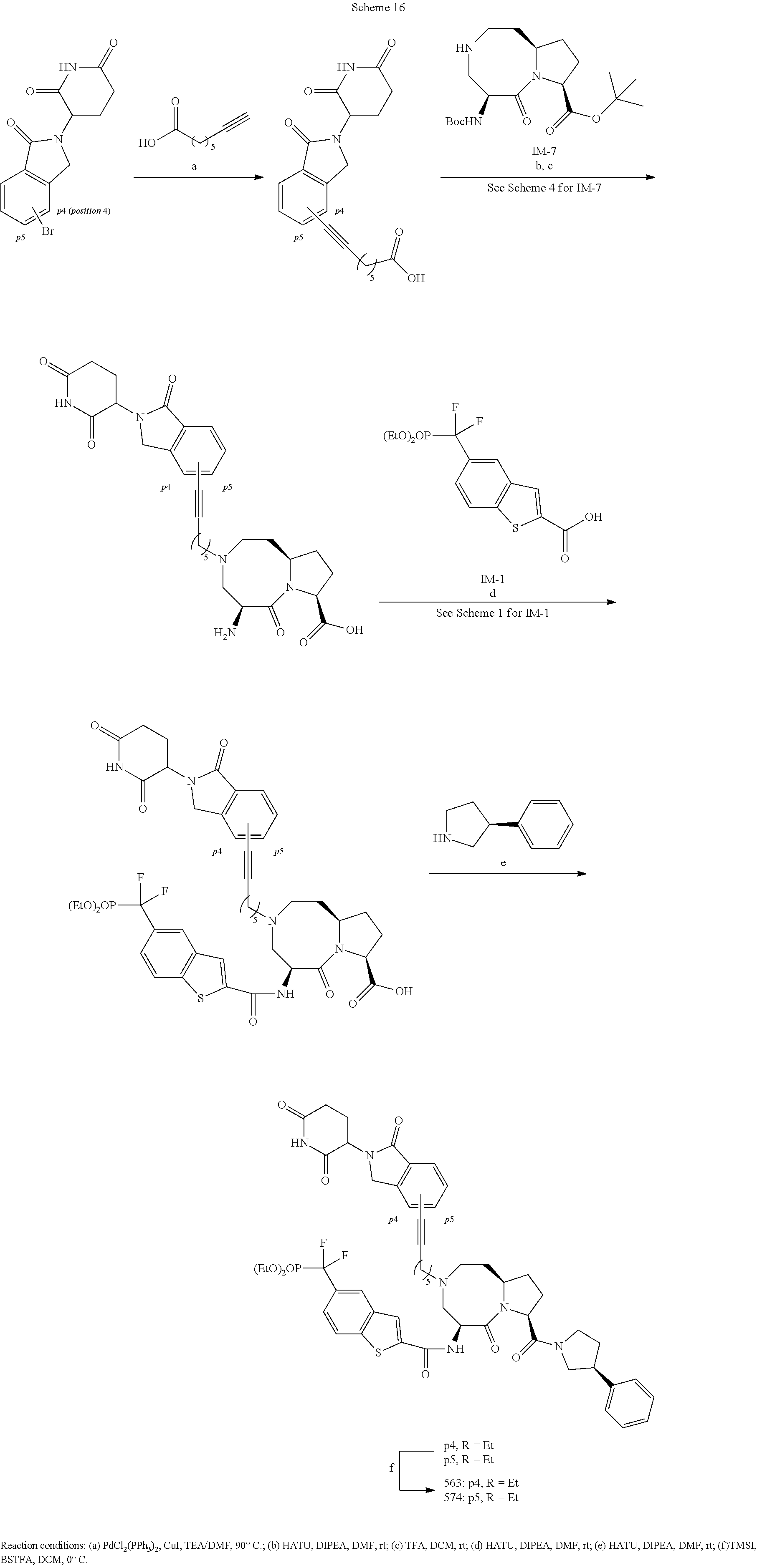

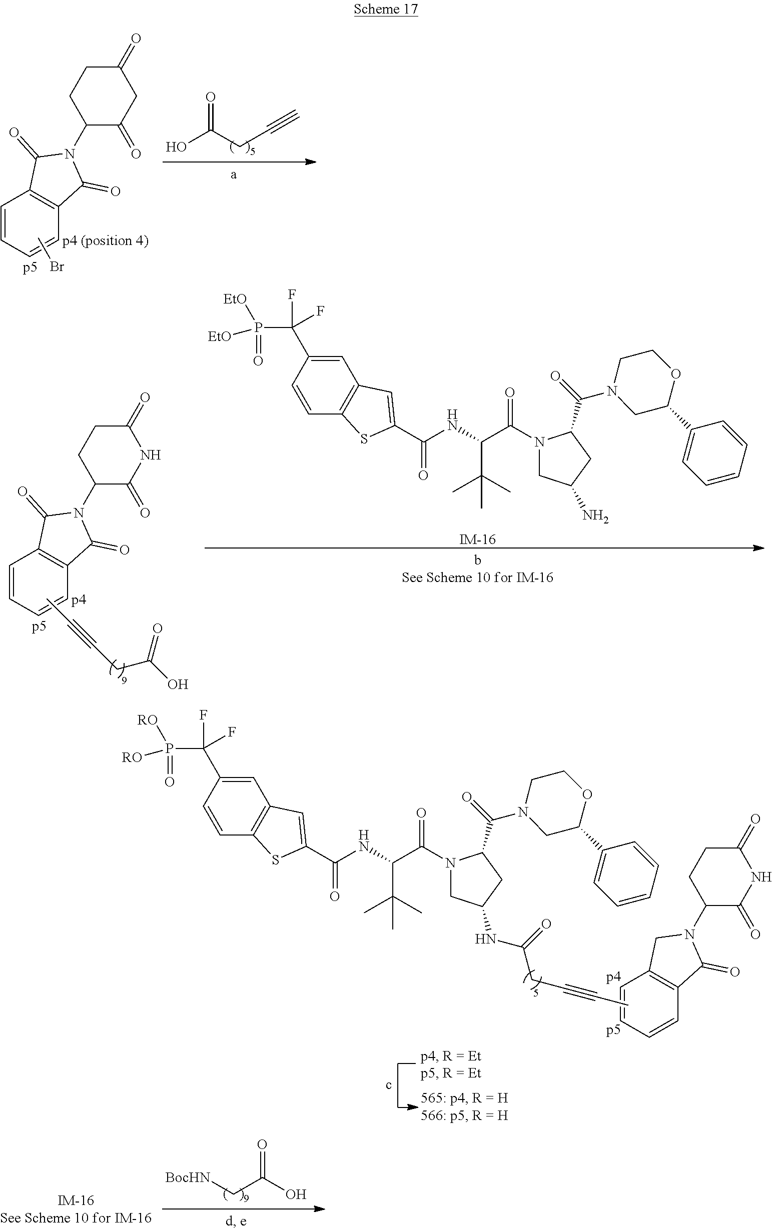

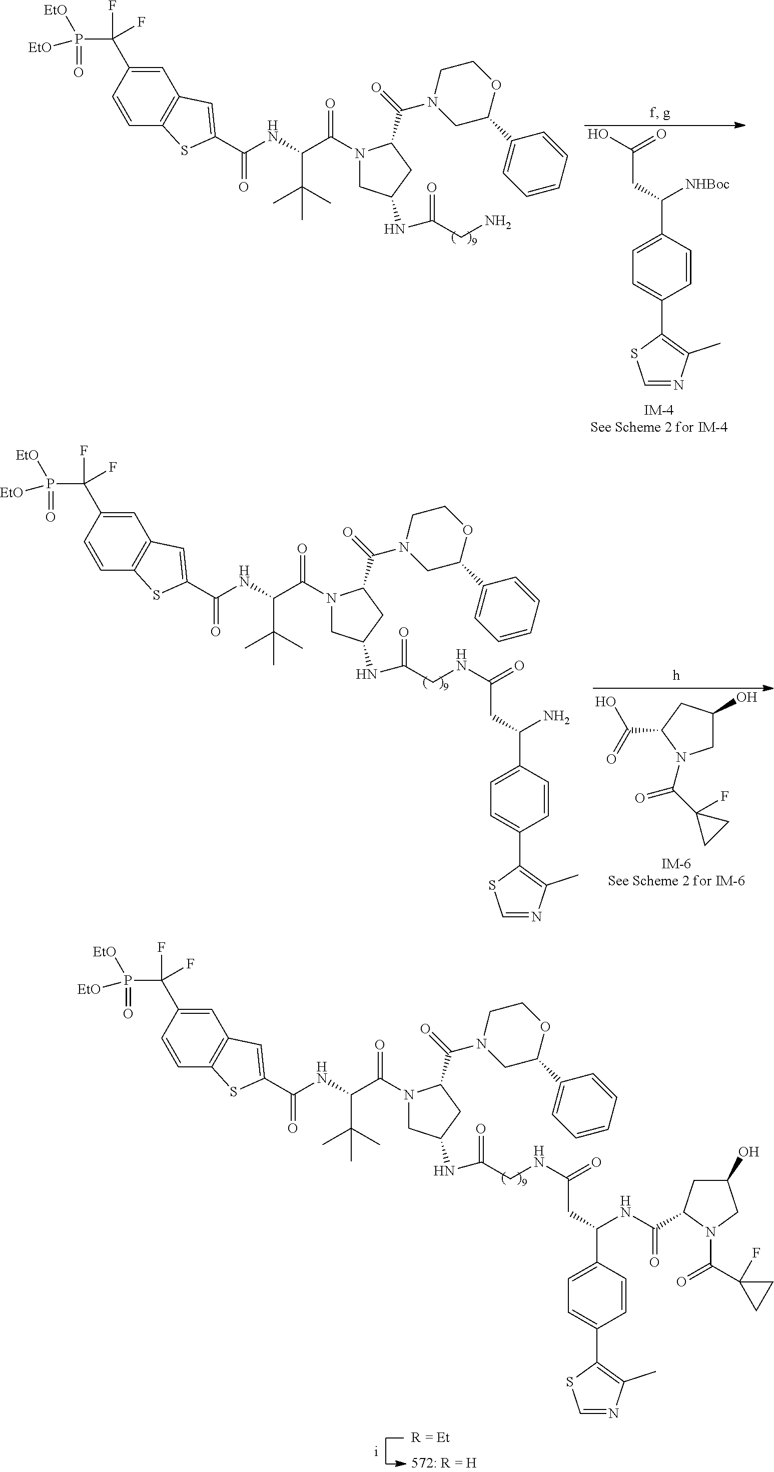

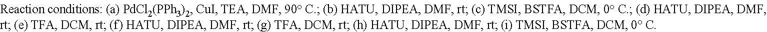

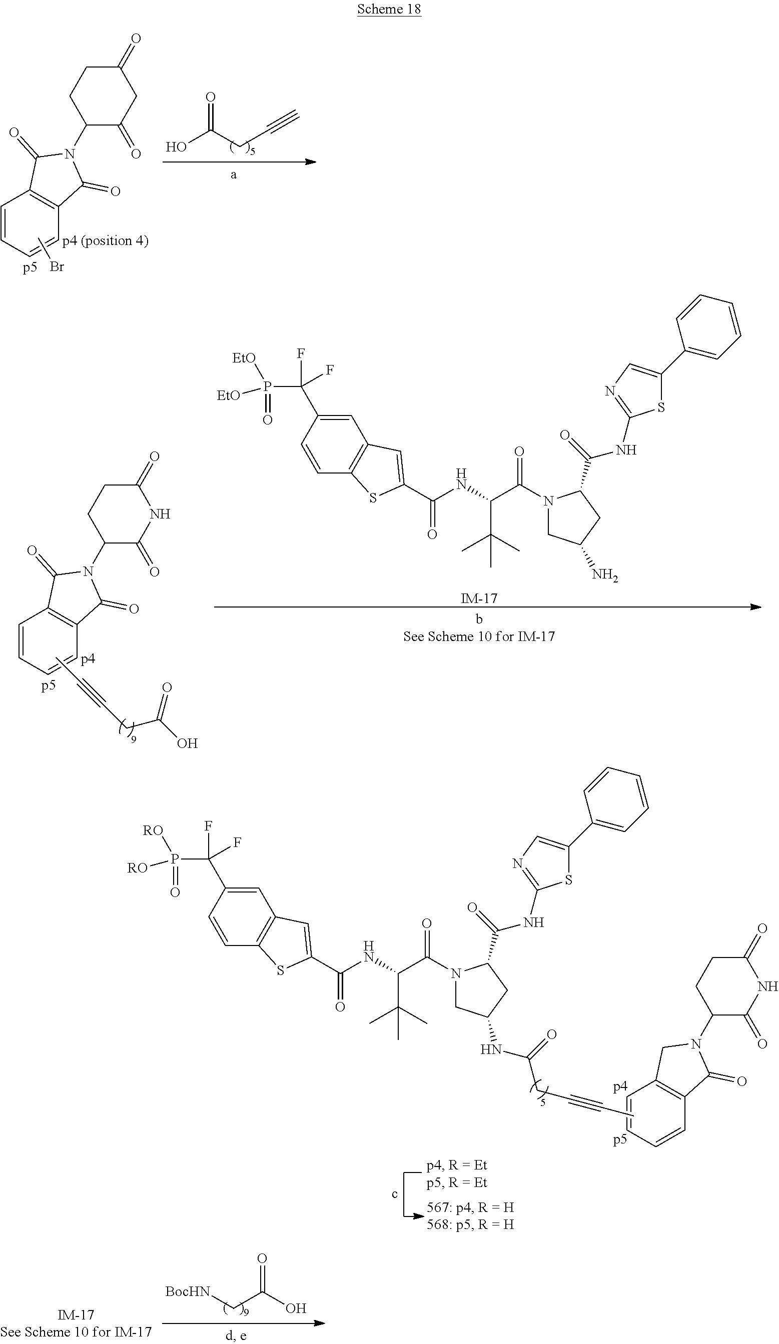

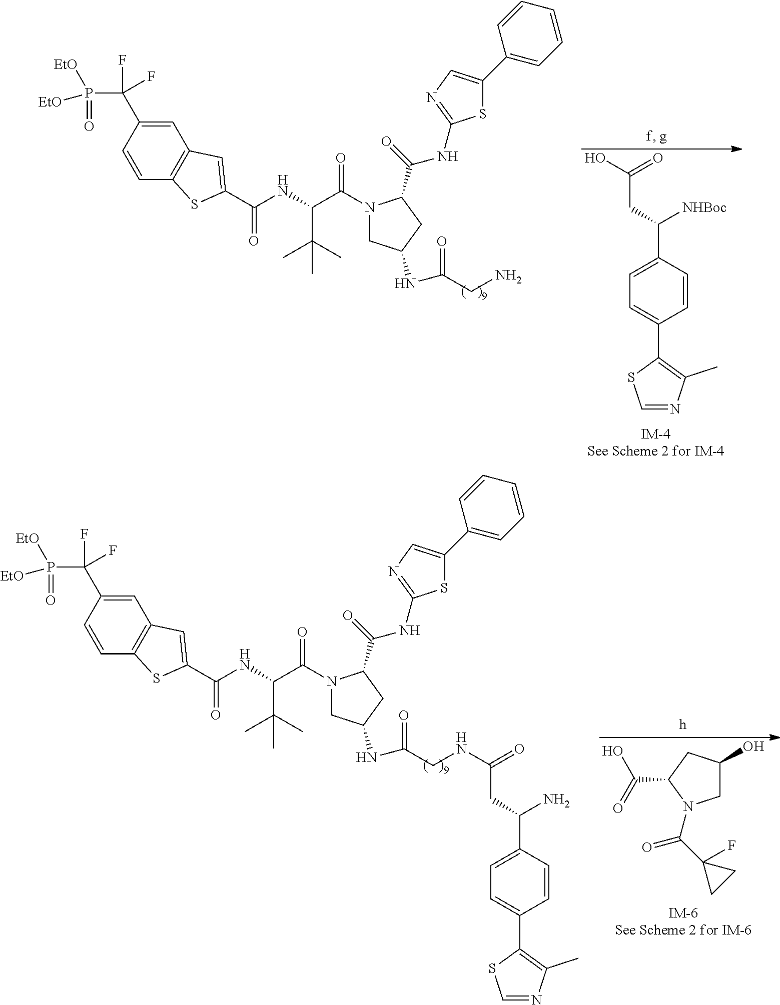

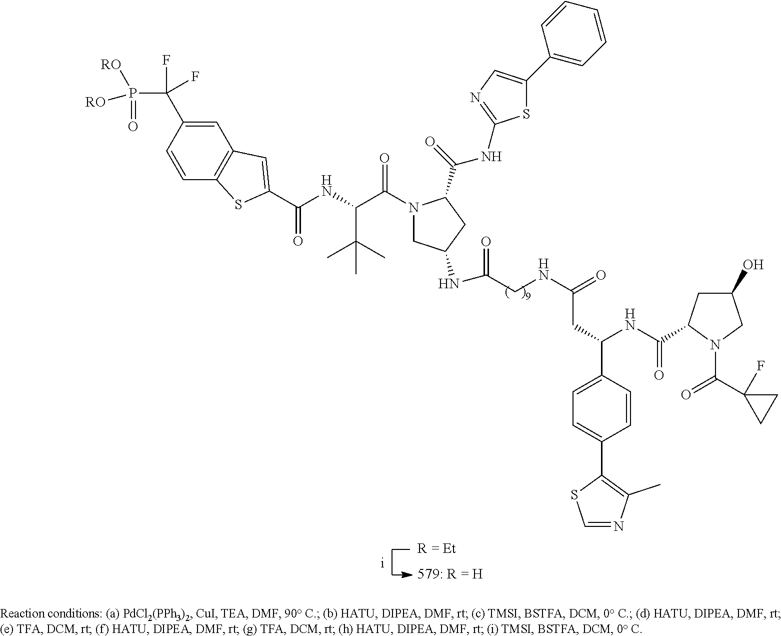

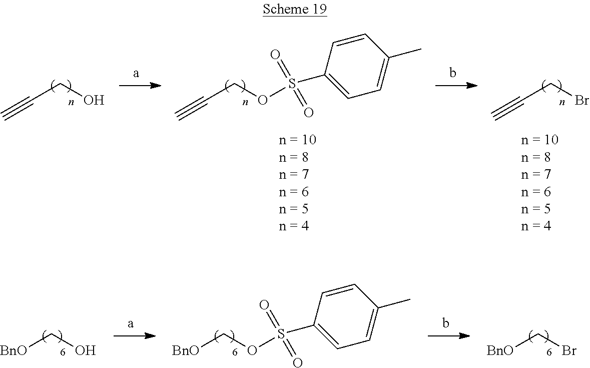

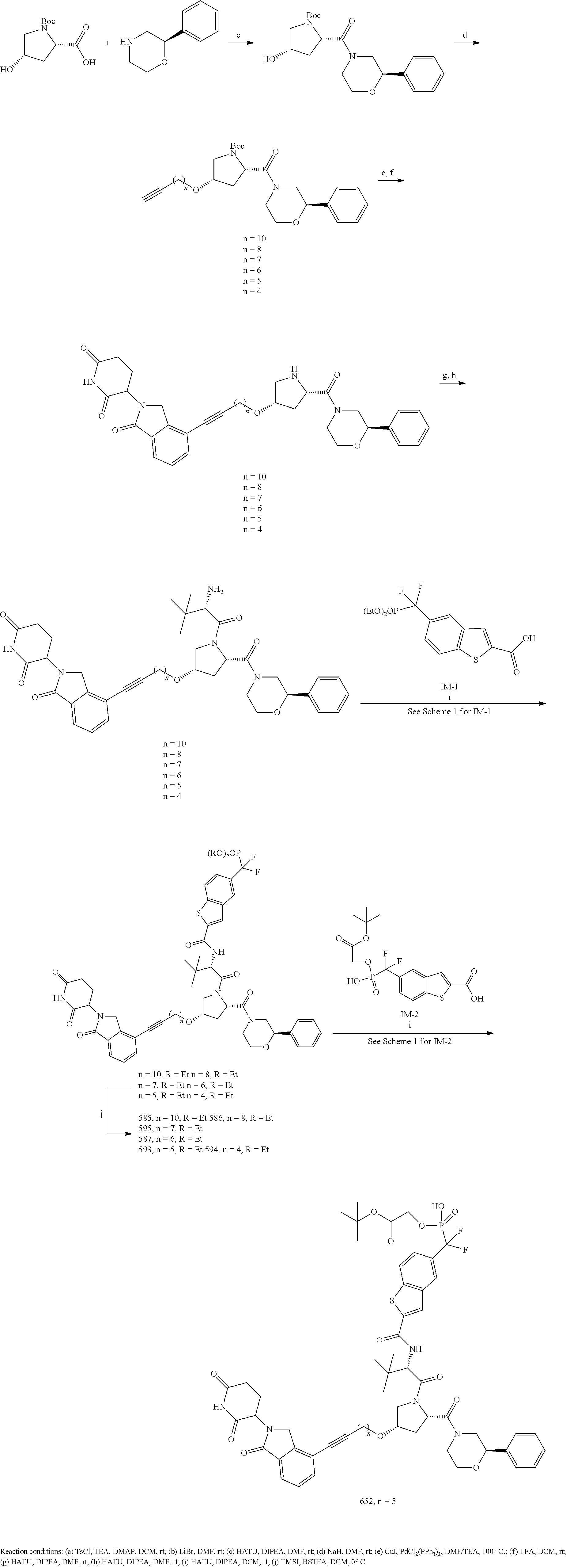

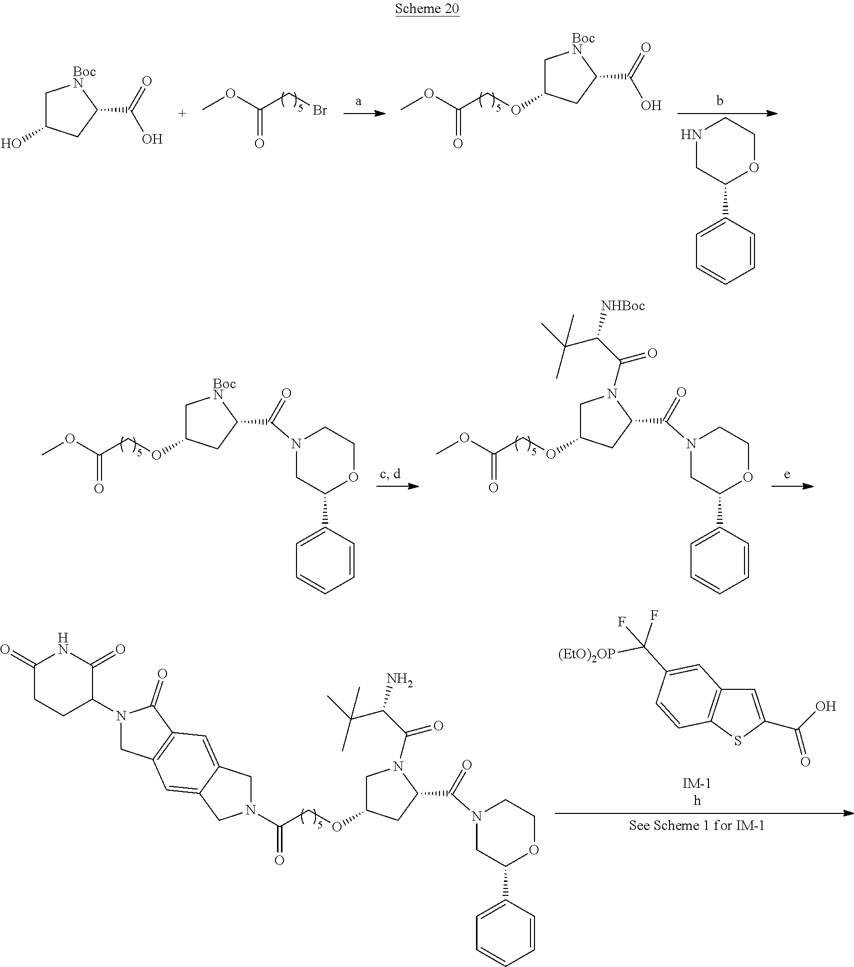

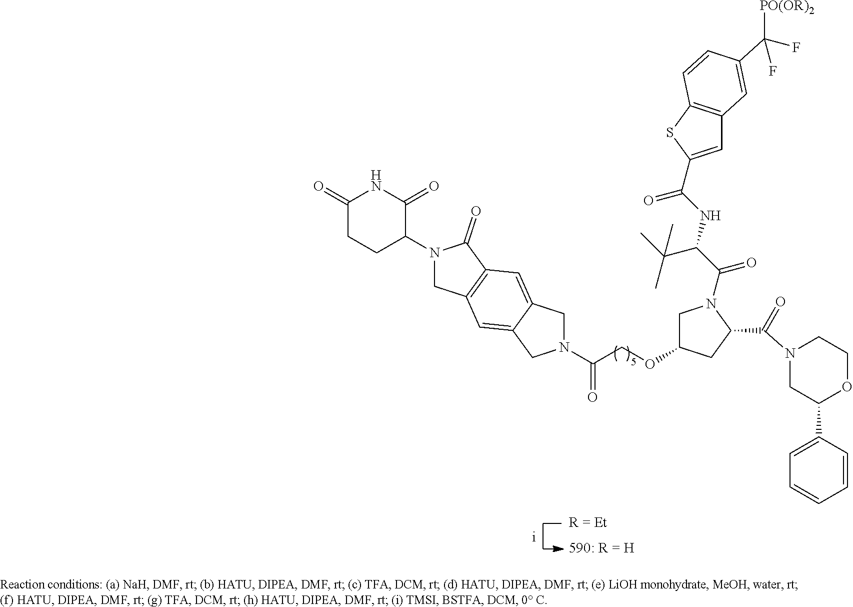

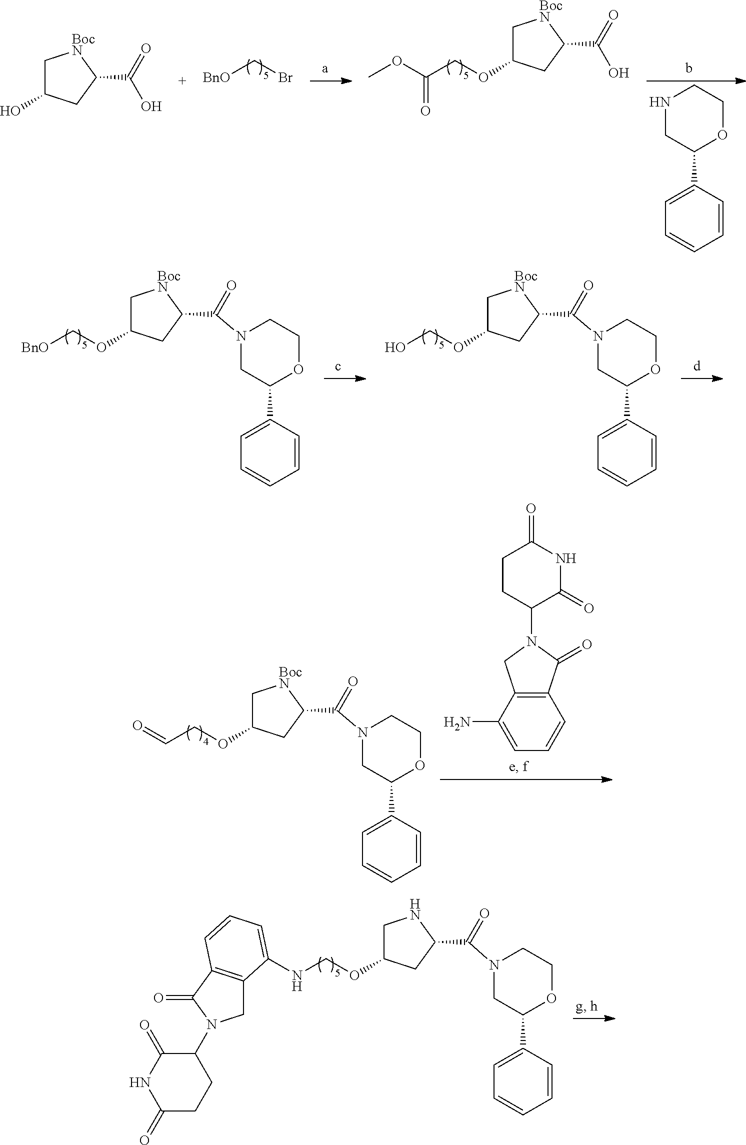

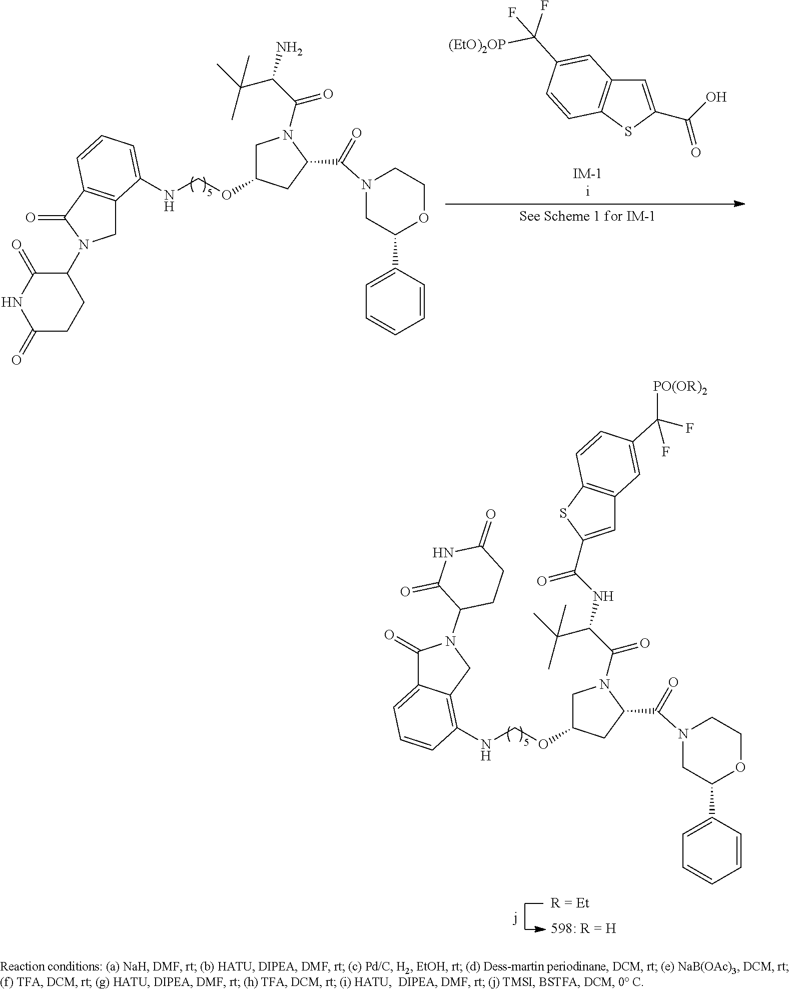

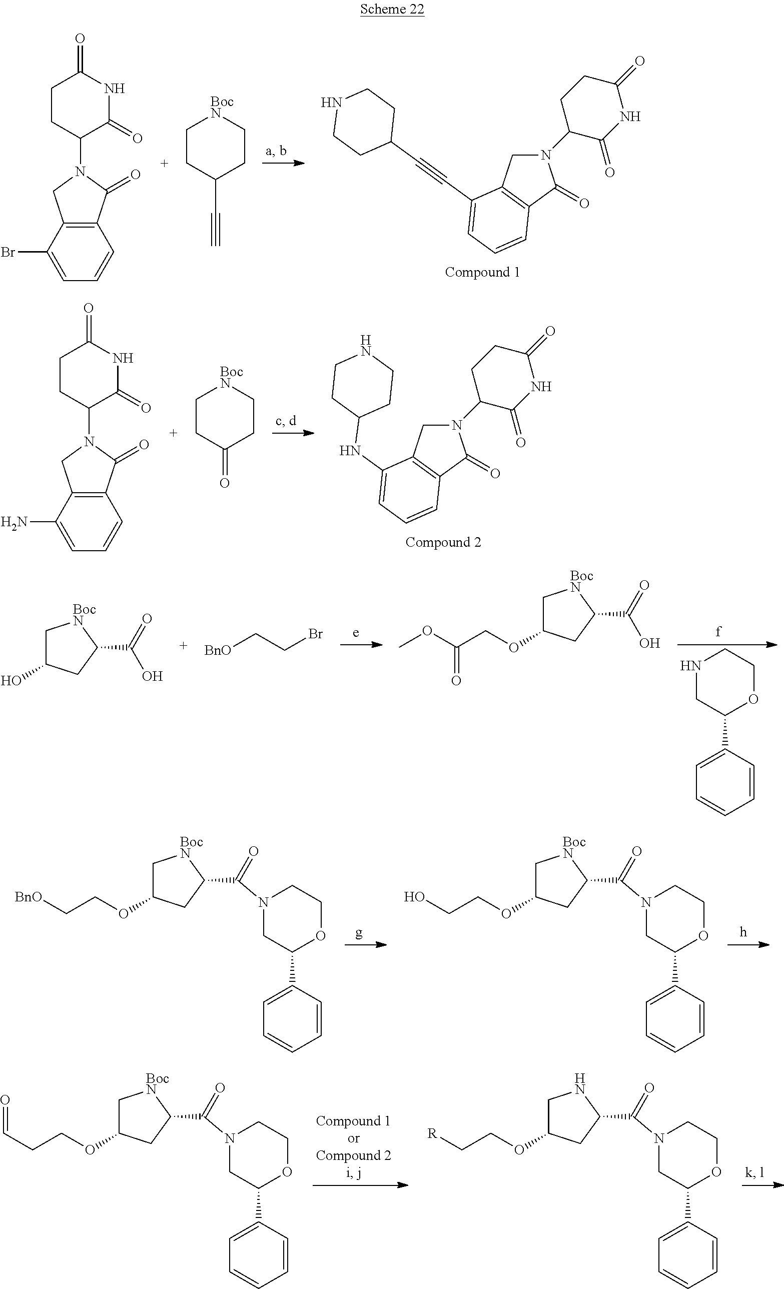

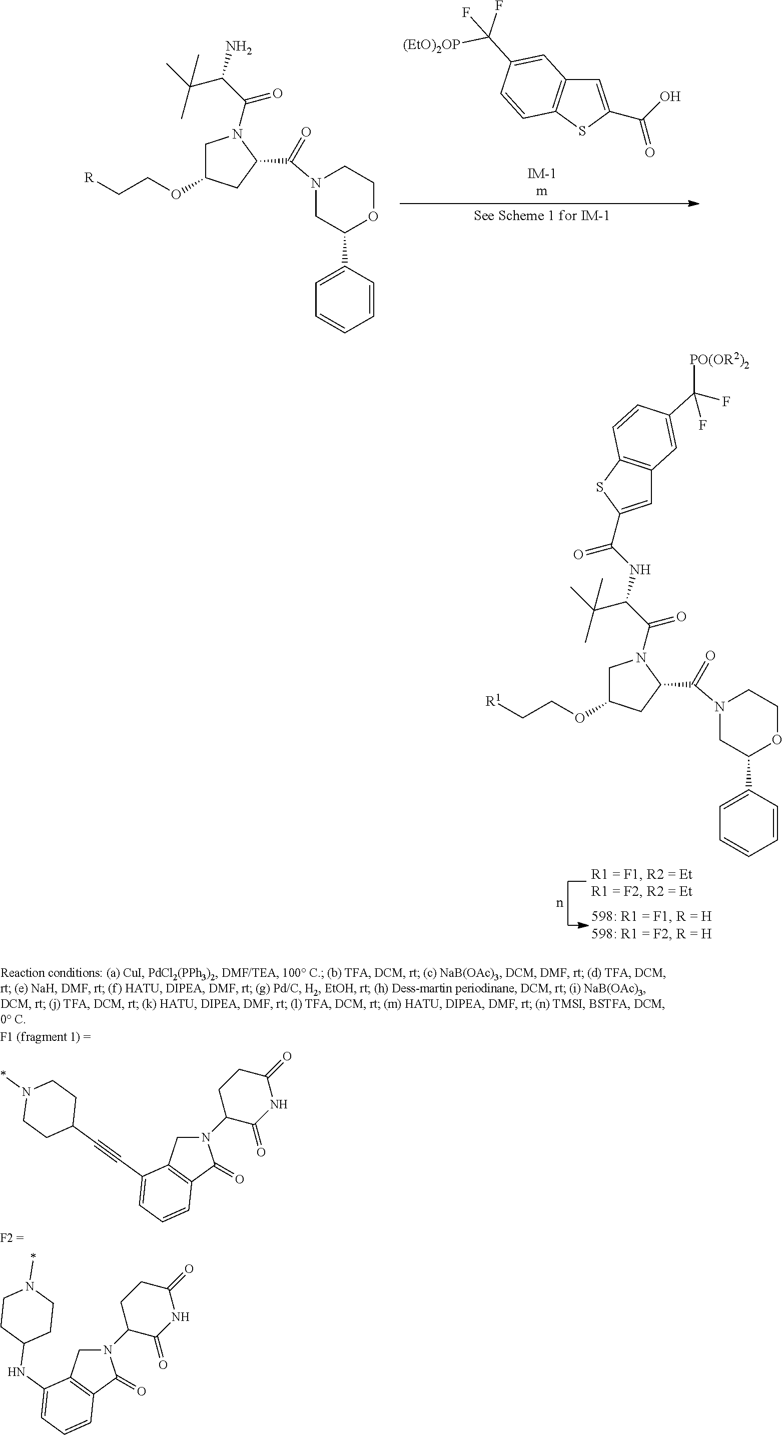

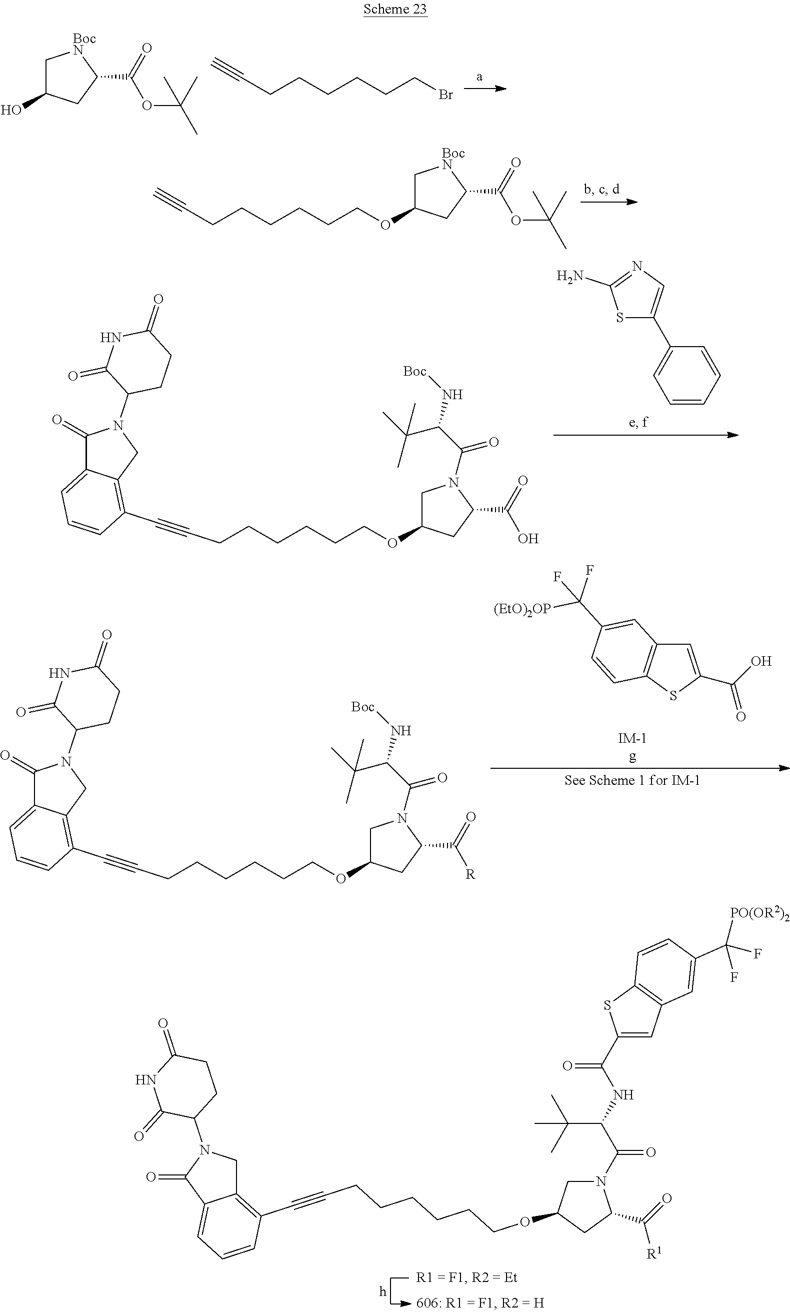

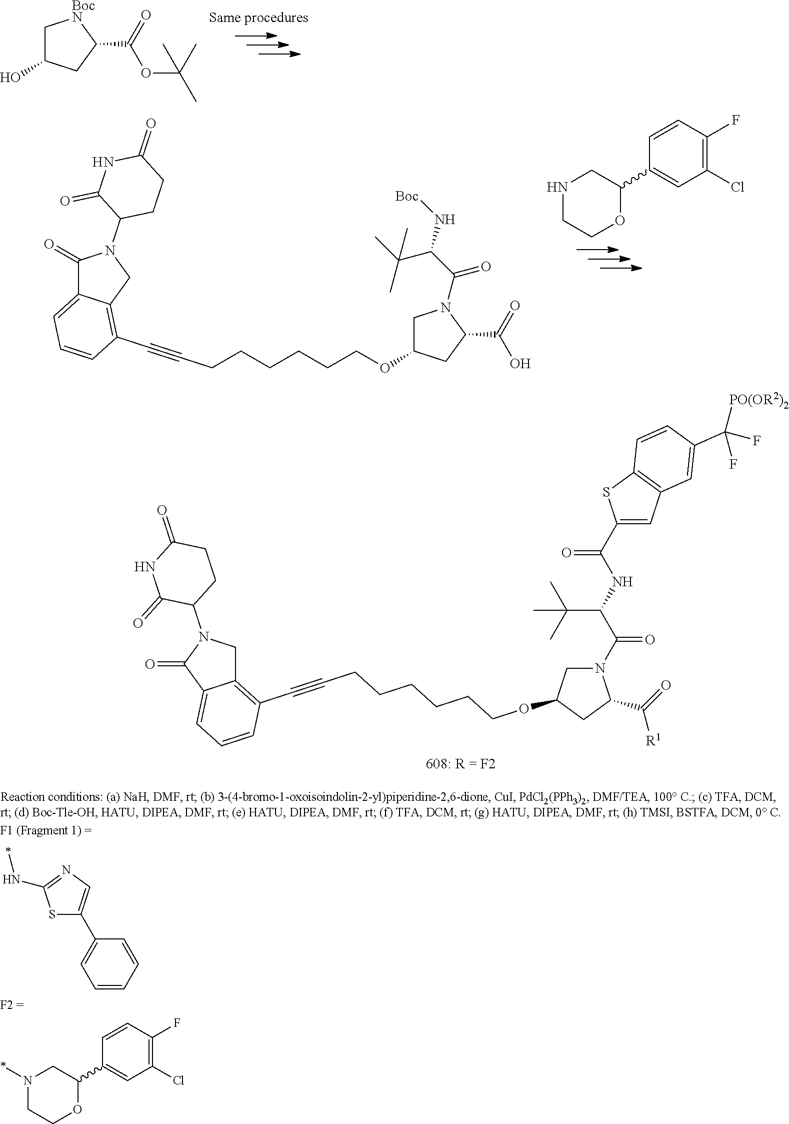

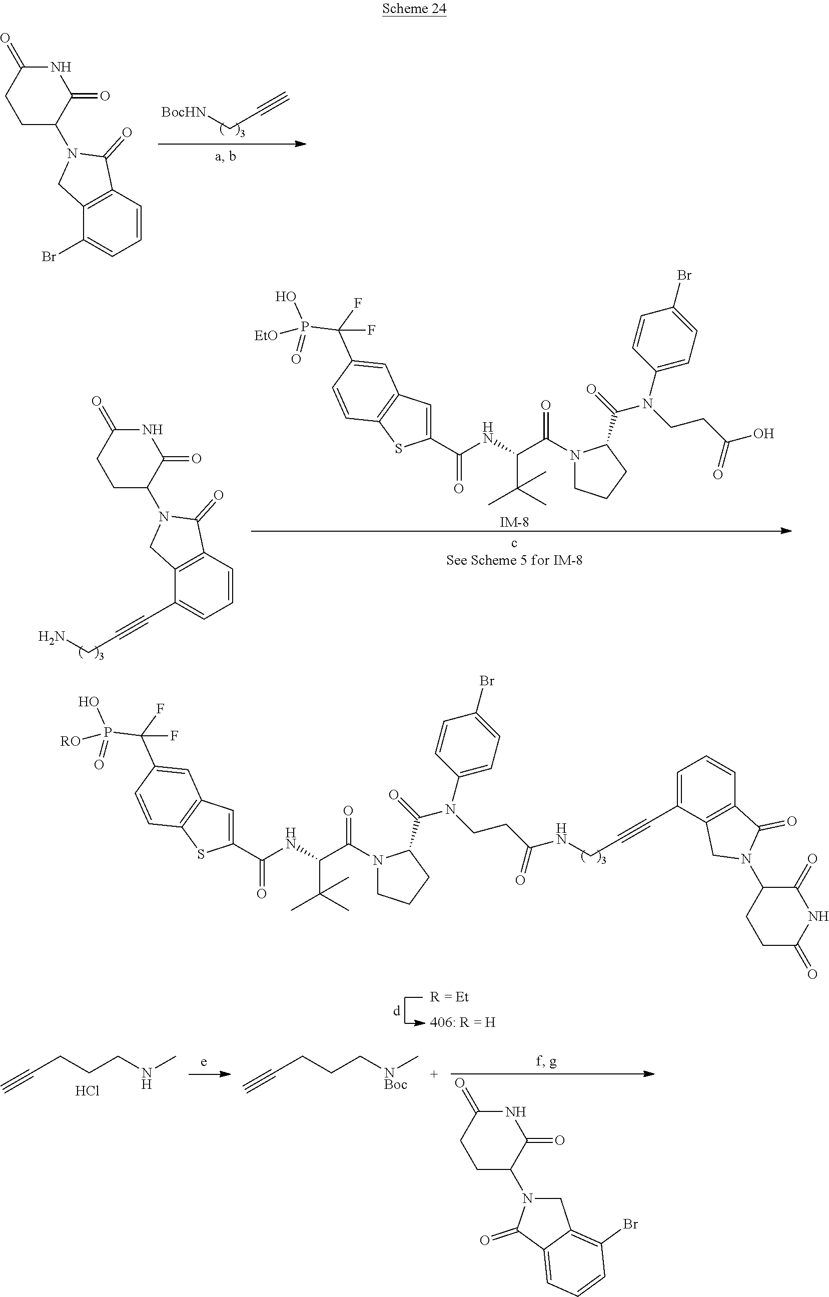

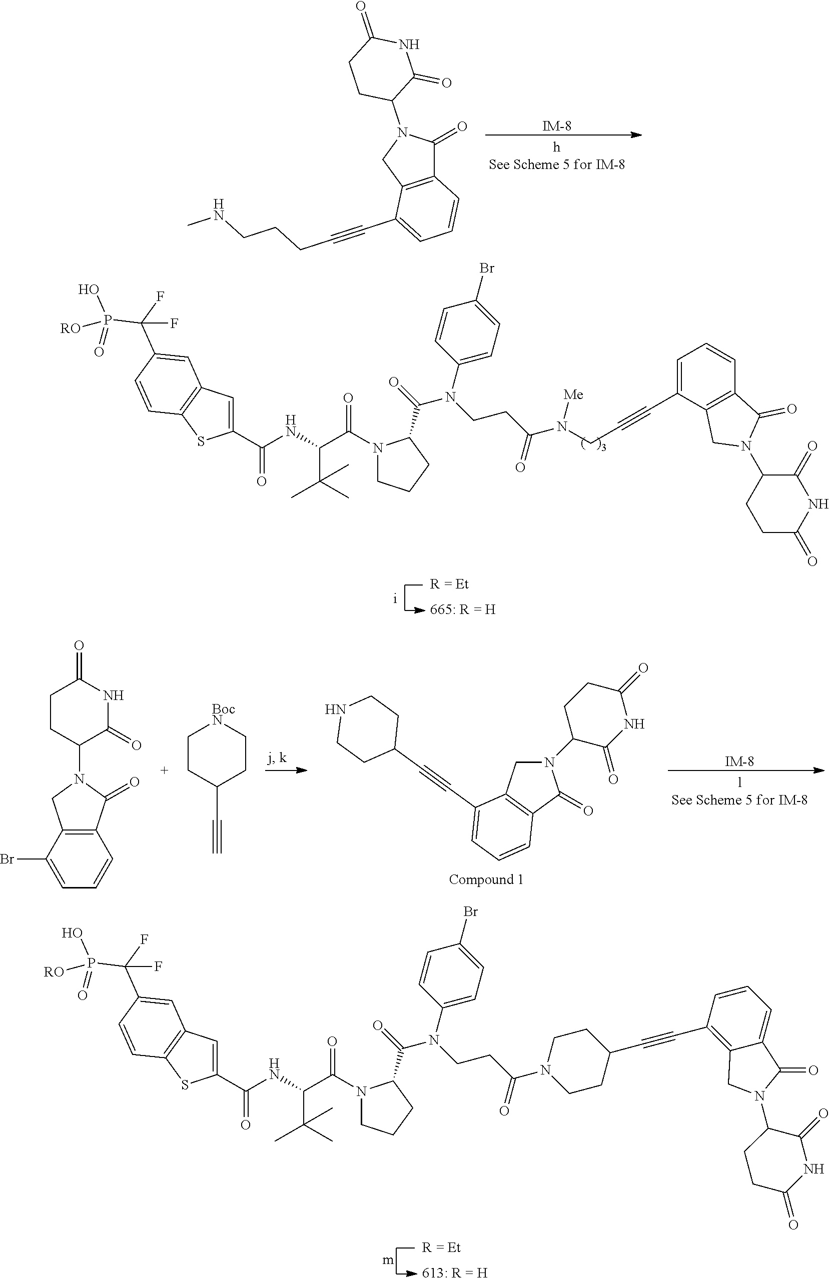

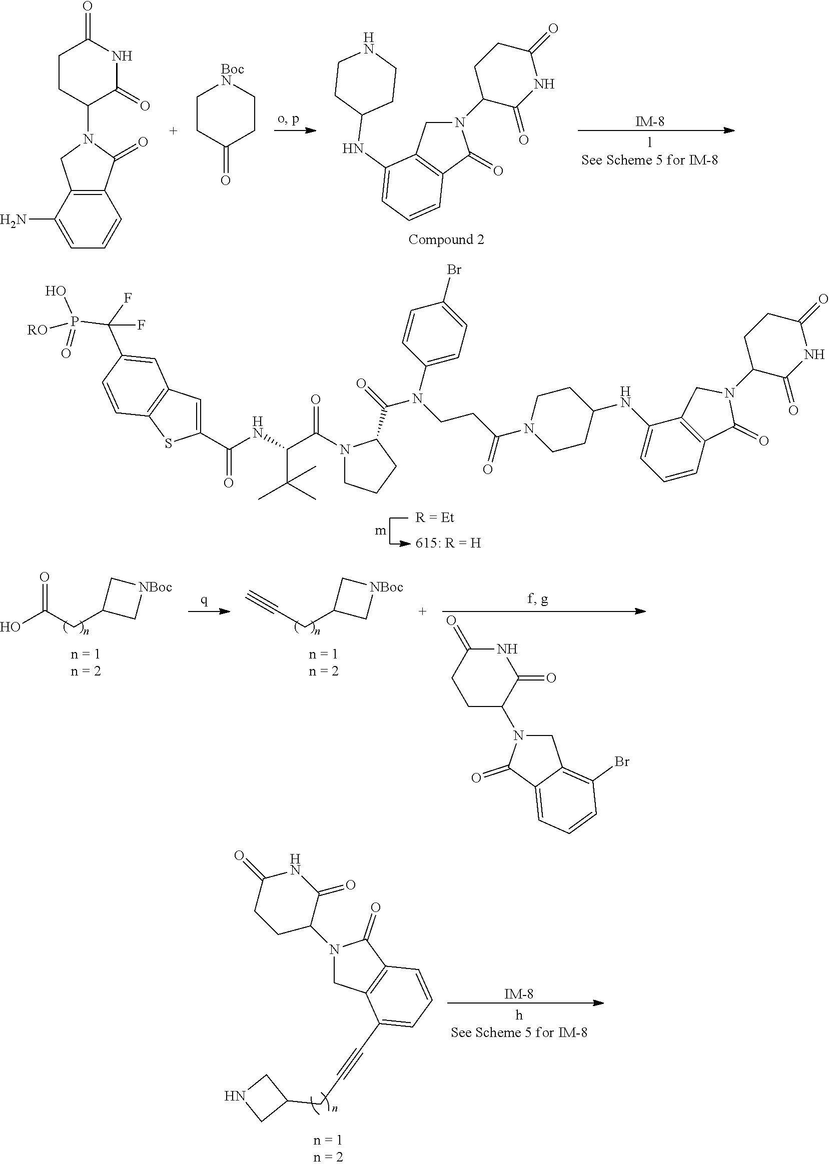

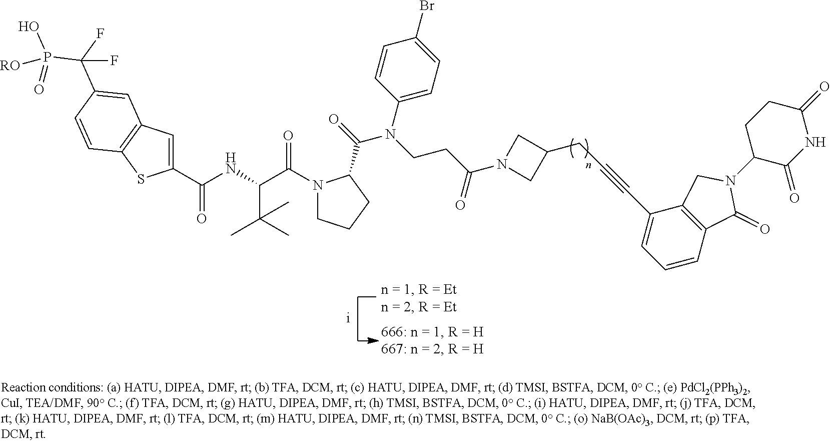

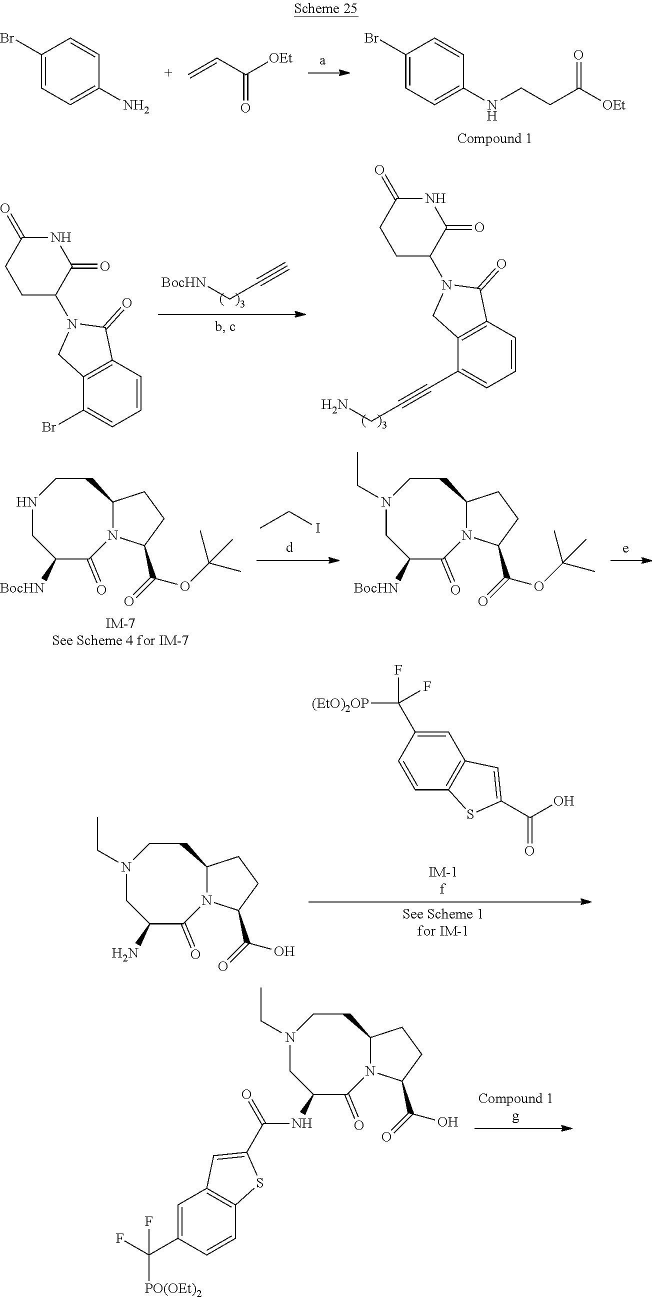

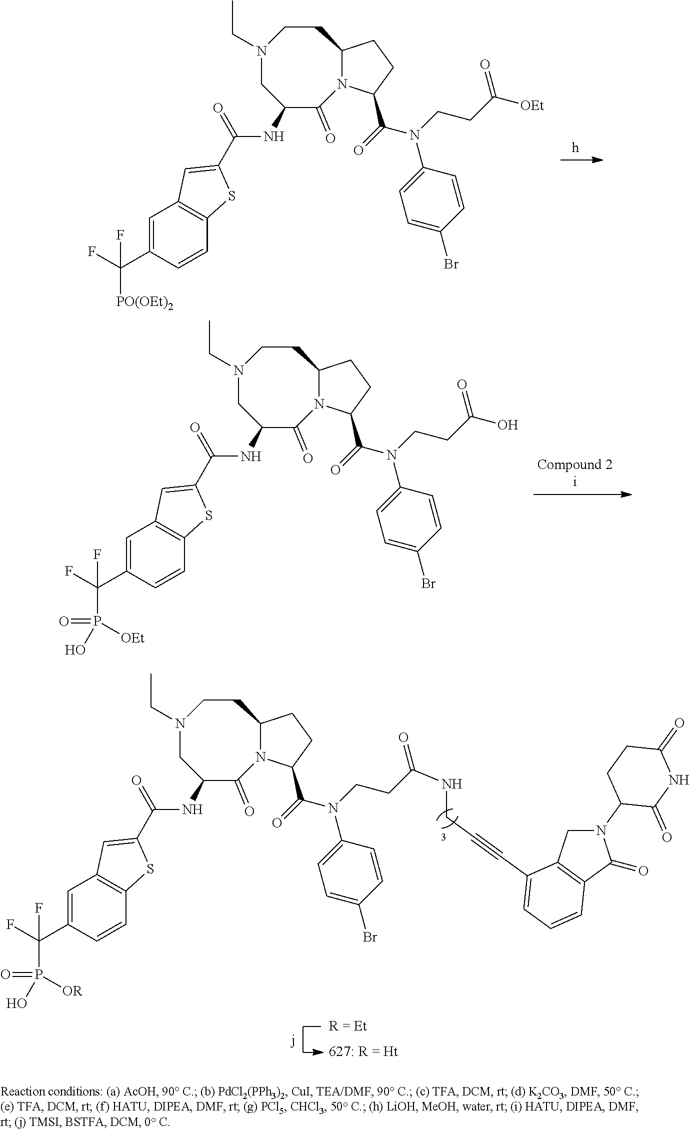

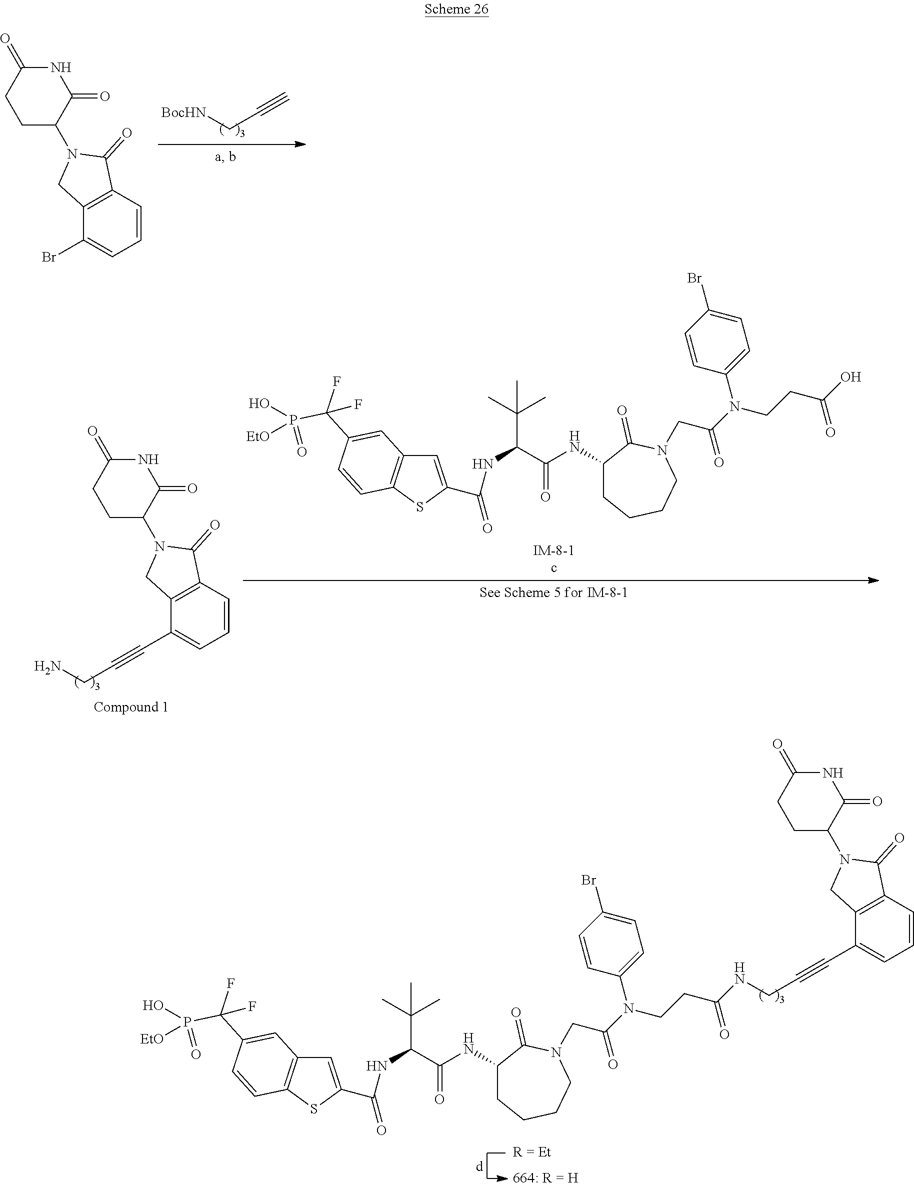

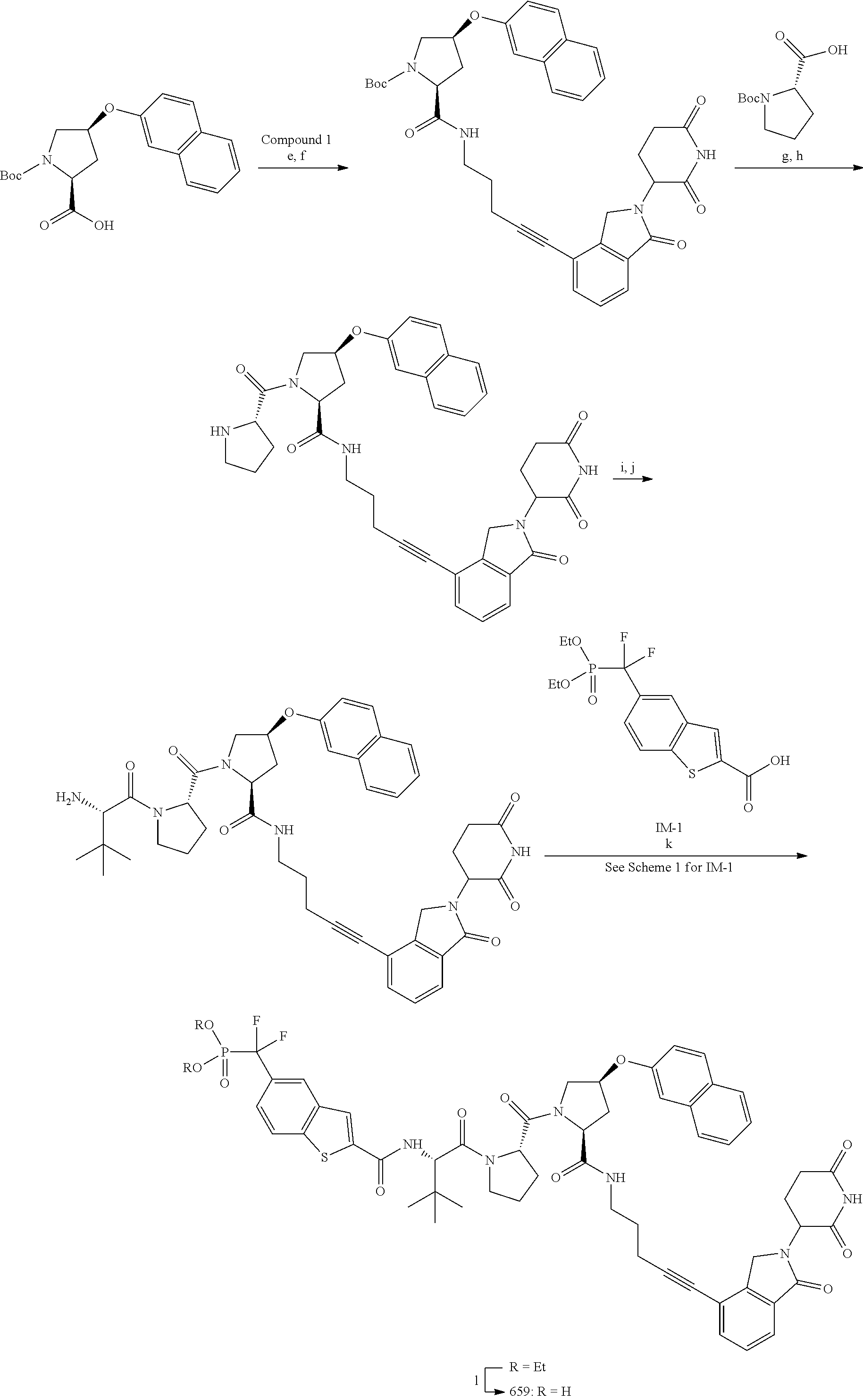

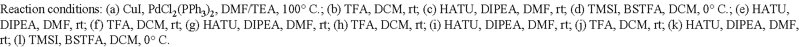

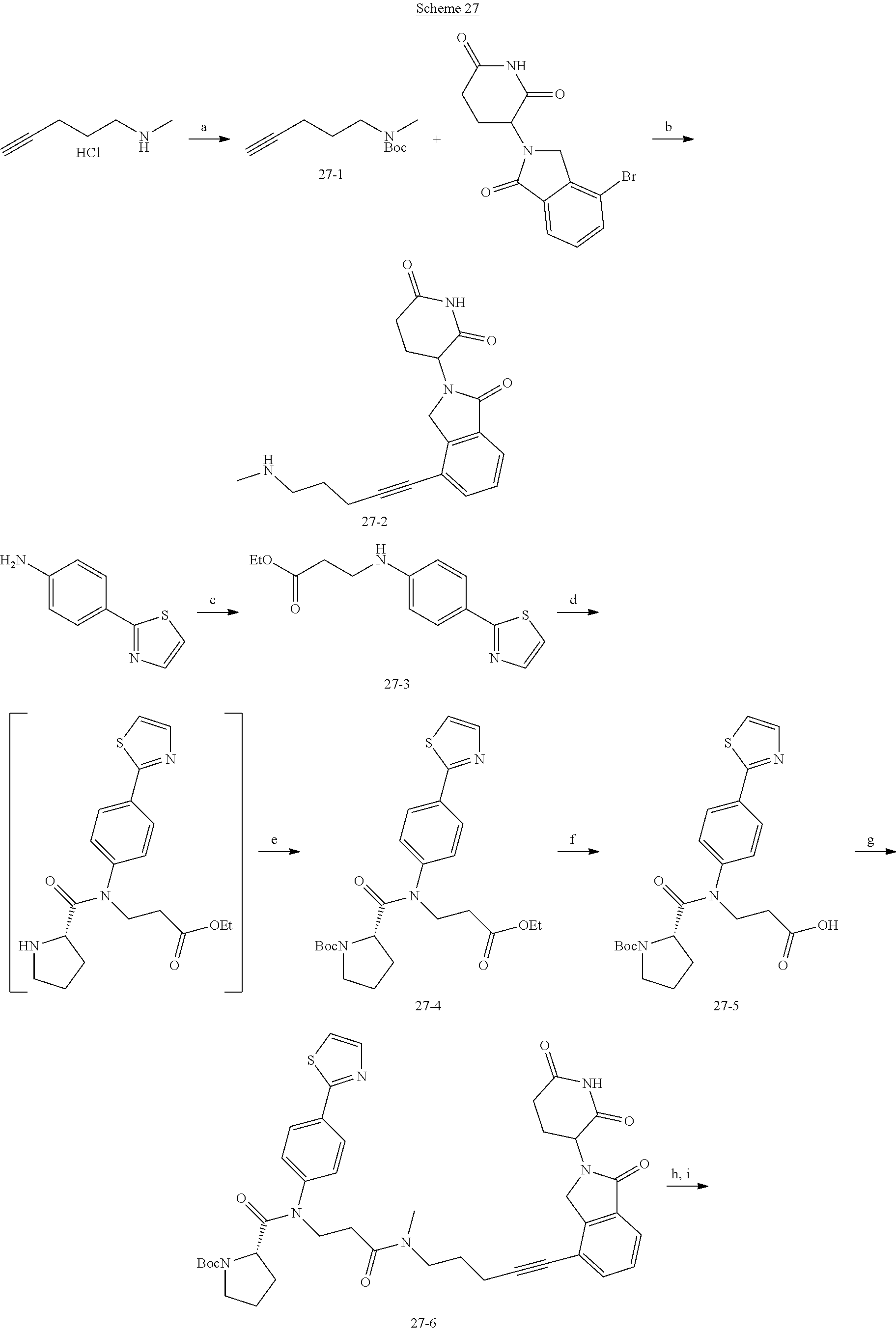

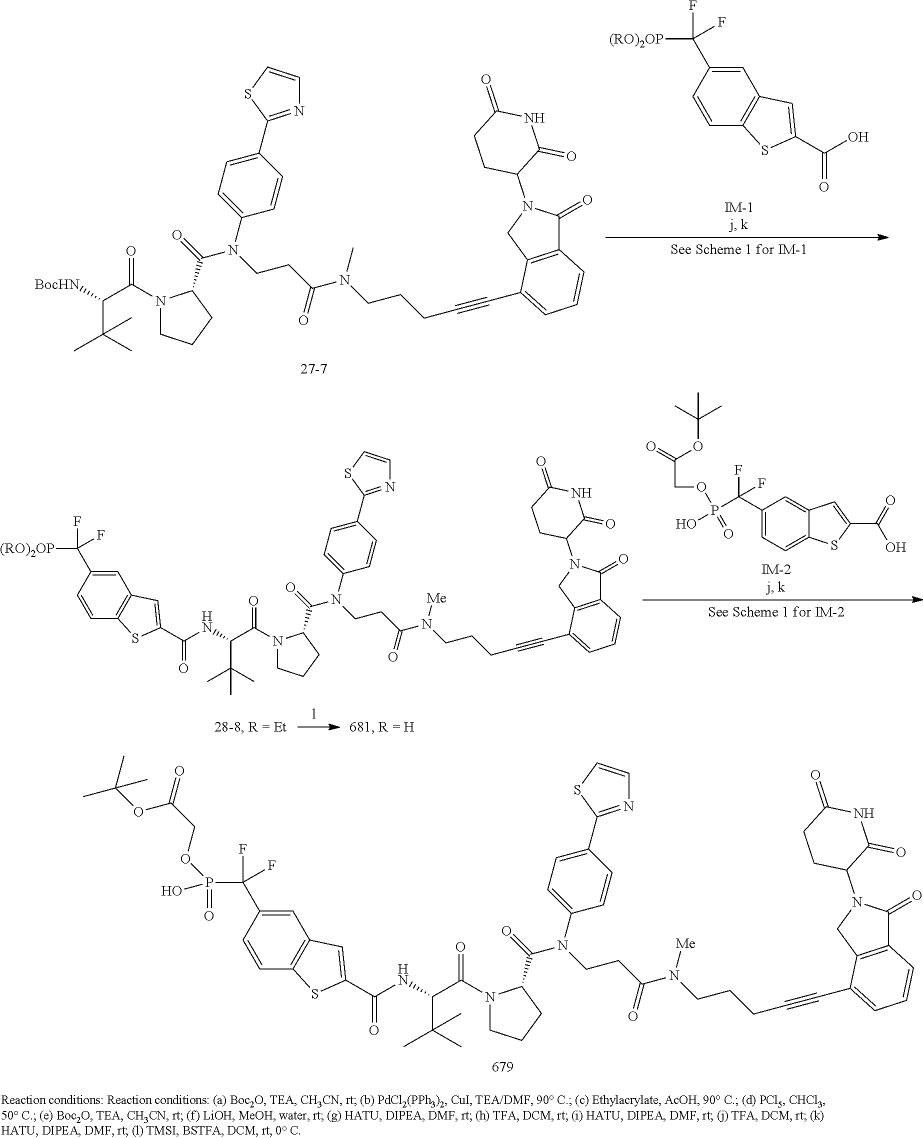

### 3-(4-(5-(Methylamino)pent-1-yn-1-yl)-1-oxoisoindolin-2-yl)piperidine-2,6-dione TFA salt (27-2)

Triethylamine (1.5 ml) was added to a mixture of compound X (323 mg, 1 mmol, 1 equiv.), 27-1 (300 mg, 1.5 mmol, 1.5 eq), CuI (40 mg, 0.2 mmol, 0.2 equiv.), and Pd(PPh₃)₂Cl₂ (70 mg, 0.1 mmol, 0.1 equiv.) in DMF (1.5 ml). The resulting mixture was purged and refilled with argon three times and stirred at 90° C. for 1.5 hours under argon. The reaction mixture was cooled to room temperature. The mixture was filtered through celite and evaporated to remove most of the solvent. The residue was purified by HPLC to yield Boc-protected AK20202170. The Boc-protected 27-2 was dissolved in DCM (5 ml), and TFA (2 ml) was added to remove Boc protection. The mixture was stirred at room temperature for 10 min. Most of the volatile components were removed in vacuum. The sample was dried by lyophilizer, 270 mg of 27-2 was obtained in 60%. ¹H NMR (400 MHz, DMSO) δ 11.00 (s, 1H), 8.73 (s, 2H), 7.73 (dd, J=7.6, 1.1 Hz, 1H), 7.66 (dd, J=7.6, 1.1 Hz, 1H), 7.53 (t, J=7.6 Hz, 1H), 5.15 (dd, J=13.3, 5.1 Hz, 1H), 4.48 (d, J=17.7 Hz, 1H), 4.33 (d, J=17.7 Hz, 1H), 3.81 (s, 3H), 2.93 (m, 1H), 2.42 (m, 1H), 2.03 (m, 1H), 1.89 (m, 2H). ¹³C NMR (400 MHz, DMSO) δ 172.88, 170.99, 167.65, 143.86, 134.18, 132.00, 128.62, 122.87, 118.49, 94.53, 77.12, 51.65, 47.39, 46.93, 32.52, 31.21, 24.53, 22.42, 16.16. ESI-MS calculated for C₁₉H₂₁N₃O₃ [M+H]⁺: 197.28, found 142.02.

### Ethyl 3-((4-(thiazol-2-yl)phenyl)amino)propanoate (27-3)

To a round bottom flask equipped with a magnetic stirring bar was added 4-(thiazol-2-yl)aniline (2.5 g, 14.2 mmol), acetic acid (8 ml), and ethylacrylate (1.3 ml, 0.9 equiv.). The suspension was stirred at 90° C. for 5 hours. The reaction mixture was cooled to room temperature and the solvent was removed on a rotary evaporator. The residual crude product was purified by flash column chromatography to yield 27-3 in 52% yield (2.0 g). ¹H NMR (400 MHz, DMSO) δ 7.79 (d, J=3.4 Hz, 1H), 7.70 (d, J=8.7 Hz, 2H), 7.56 (d, J=3.4 Hz, 1H), 7.32 (s, 1H), 6.66 (d, J=8.7 Hz, 2H), 4.08 (q, J=7.1 Hz, 2H), 3.35 (t, J=6.7 Hz, 2H), 2.59 (t, J=6.7 Hz, 2H), 1.18 (t, J=7.1 Hz, 3H). ¹³C NMR (400 MHz, DMSO) δ 171.46, 168.52, 150.44, 142.03, 127.77, 120.35, 117.74, 112.06, 60.00, 38.43, 33.51, 14.07. ESI-MS calculated for C₉H₈N₂S [M+H]⁺: 276.35, found 276.89.

### tert-Butyl (S)-2-((3-ethoxy-3-oxopropyl)(4-(thiazol-2-yl)phenyl)carbamoyl)pyrrolidine-1-carboxylate (27-4)

Boc-L-proline (5.8 g, 5 equiv.) was dissolved in CHCl₃ (50 ml). At room temperature, PCl₅ (5.6 g, 5 equiv.) was slowly added over 10 min. After the addition, the mixture was stirred for 10 min at room temperature. To the mixture was added 27-3 (1.5 g, 5.4 mmol) and the mixture was allowed to stir at 50° C. for 20 min. The volatile components were removed on a rotary evaporator. The obtained crude oil was purified by reverse phase semi-preparative HPLC. The resulting colorless oil was dissolved in CH₃CN (20 ml). To the solution was added triethylamine (3 ml, 3.8 equiv.), followed by Boc₂O (1.75 g, 1.5 equiv.). The colorless mixture was allowed to stir for 2 hours at room temperature. The volatile components were removed by vacuum and the crude was purified by flash column chromatography to yield 27-4 in 39% (1.0 g, 2 steps yield).

¹H NMR (400 MHz, DMSO) δ 8.05 (d, J=8.5 Hz, 2H), 7.94 (d, J=3.3 Hz, 1H), 7.77 (d, J=3.3 Hz, 1H), 7.58-7.08 (m, 2H), 4.12 (m, 1H), 4.10-3.75 (m, 4H), 3.43-3.23 (m, 2H), 2.55 (m, 2H), 1.86 (s, 3H), 1.70 (m, 1H), 1.42 (s, 9H), 1.14 (t, J=7.1 Hz, 3H). ¹³C NMR (400 MHz, DMSO) δ 171.34, 170.35, 165.75, 153.27, 143.64, 132.39, 128.88, 127.10, 120.49, 77.07, 59.61, 56.69, 46.48, 44.92, 32.39, 30.55, 29.63, 27.93, 22.42, 13.52. ESI-MS calculated for C₂₄H₃₁N₃O₅S [M+H]⁺: 473.59, found 374.06.

### (S)-3-(1-(tert-Butoxycarbonyl)-N-(4-(thiazol-2-yl)phenyl)pyrrolidine-2-carboxamido)propanoic acid (27-5)

27-4 (450 mg, 0.95 mmol) was dissolved in MeOH (5 ml) and water (1 ml) and the mixture was placed in ice bath. LiOH monohydrate (200 mg, 5 equiv.) was added to the mixture and the mixture was stirred for 30 min at room temperature. The mixture was placed in ice bath again and neutralized by slowly adding TFA. The volatile components were removed on a rotary evaporator and the residue was purified by flash column chromatography to yield 27-5 in 73% (310 mg).

¹H NMR (400 MHz, DMSO) δ 12.00 (s, 1H), 8.05 (d, J=8.0 Hz, 3H), 7.95 (d, J=3.3 Hz, 1H), 7.78 (d, J=3.3 Hz, 1H), 7.44 (s, 2H), 4.11 (m, 1H), 3.99-3.69 (m, 2H), 3.39-3.26 (m, 2H), 3.13 (s, 2H), 1.85 (m, 4H). ¹³C NMR (400 MHz, DMSO) δ 171.78, 171.30, 165.79, 143.65, 132.34, 128.87, 127.10, 120.47, 78.39, 56.69, 46.50, 45.01, 32.31, 30.56, 29.38, 27.96, 23.04, 22.57. ESI-MS calculated for C₂₂H₇₇N₃O₅S [M+H]⁺: 445.53, found 346.20.

### tert-Butyl (2S)-2-((3-((5-(2-(2,6-dioxopiperidin-3-yl)-1-oxoisoindolin-4-yl)pent-4-yn-1-yl)(methyl)amino)-3-oxopropyl)(4-(thiazol-2-yl)phenyl)carbamoyl)pyrrolidine-1-carboxylate (27-6)

HATU (280 mg, 0.74 mmol, 1.1 equiv.) was added to a solution of 27-5 (300 mg, 0.67 mmol, 1 equiv.), AK20202170 (300 mg, 0.67 mmol, 1 equiv.), and triethylamine (0.46 ml, 3.35 mmol, 5 equiv.) in CH₃CN (5 ml). The mixture was stirred at room temperature for 30 min. The yellow solution was concentrated in vacuum and the crude was purified by flash column chromatography to yield 27-6 in 74% (385 mg).

¹H NMR (400 MHz, DMSO) δ 10.76 (s, 1H), 8.03 (s, 2H), 7.93 (d, J=3.3 Hz, 1H), 7.76 (d, J=3.3 Hz, 1H), 7.69 (d, J=7.6 Hz, 1H), 7.60 (d, J=7.6 Hz, 1H), 7.53-7.43 (m, 2H), 5.10 (m, 1H), 4.48 (m, 1H), 4.36 (m, 1H), 4.10 (m, 1H), 3.87 (m, 2H), 3.46-3.27 (m, 4H), 3.11 (s, 3H), 2.98-2.79 (m, 4H), 2.62 (m, 3H), 2.46 (m, 2H), 2.05 (m, 1H), 1.78 (m, 5H), 1.41 (s, 9H). ¹³C NMR (400 MHz, DMSO) δ 172.82, 171.56, 170.93, 170.00, 167.65, 153.70, 152.48, 150.94, 144.03, 133.85, 132.57, 131.92, 129.32, 128.53, 127.45, 122.59, 121.07, 120.71, 118.71, 95.74, 78.69, 78.49, 77.24, 74.25, 56.92, 51.57, 46.79, 45.77, 38.21, 35.71, 31.18, 28.21, 25.81, 22.82, 22.30, 16.39, 8.61. ESI-MS calculated for C₄₁H₄₆N₆O₇S [M+H]⁺: 766.91, found 767.19.

### tert-Butyl ((2S)-1-((2S)-2-((3-((5-(2-(2,6-dioxopiperidin-3-yl)-1-oxoisoindolin-4-yl)pent-4-yn-1-yl)(methyl)amino)-3-oxopropyl)(4-(thiazol-2-yl)phenyl)carbamoyl)pyrrolidin-1-yl)-3,3-dimethyl-1-oxobutan-2-yl)carbamate (27-7)

27-6 (380 mg, 0.5 mmol, 1 equiv.) was dissolved in DCM (5 ml), and TFA (2 ml) was added to remove Boc protection. The mixture was stirred at room temperature for 10 min. Most of the volatile components were removed in vacuum. To the residue, CH₃CN (5 ml), triethylamine (0.35 ml, 2.5 mmol, 5 equiv.), Boc-L-tert-leucine (175 mg, 0.75 mmol, 1.5 equiv.), and HATU (230 mg, 0.6 mmol, 1.2 equiv.) were added. The mixture was stirred at room temperature for 30 min. The yellow solution was concentrated in vacuum and the crude was purified by flash column chromatography to yield 27-7 in 70% (354 mg).

¹H NMR (400 MHz, DMSO) δ 10.99 (m, 1H), 8.07-7.88 (m, 3H), 7.86-7.77 (m, 1H), 7.77-7.63 (m, 2H), 7.62-7.47 (m, 3H), 5.14 (m, 1H), 4.47 (m, 1H), 4.39-4.23 (m, 1H), 4.15 (m, 2H), 3.93-3.74 (m, 2H), 3.43-3.25 (m, 2H), 2.99-2.85 (m, 3H), 2.79 (m, 1H), 2.67-2.41 (m, 7H), 2.13-1.60 (m, 8H), 1.36 (s, 9H), 0.97 (s, 9H). ¹³C NMR (400 MHz, DMSO) δ 172.84, 170.95, 169.95, 169.67, 169.29, 167.67, 166.10, 155.39, 144.01, 133.86, 132.45, 131.94, 129.22, 128.53, 127.28, 122.60, 120.94, 118.74, 95.76, 95.13, 78.04, 76.69, 76.53, 58.44, 57.29, 51.59, 48.00, 46.99, 45.93, 45.74, 35.10, 34.91, 31.21, 28.93, 28.11, 26.33, 25.88, 24.88, 22.33, 16.41, 8.59. ESI-MS calculated for C₄₇H₅₇N₇O₈S [M+H]⁺: 880.07, found 880.24.

### Diethyl ((2-(((2S)-1-((2S)-2-((3-((5-(2-(2,6-dioxopiperidin-3-yl)-1-oxoisoindolin-4-yl)pent-4-yn-1-yl)(methyl)amino)-3-oxopropyl)(4-(thiazol-2-yl)phenyl)carbamoyl)pyrrolidin-1-yl)-3,3-dimethyl-1-oxobutan-2-yl)carbamoyl)benzo[b]thiophen-5-yl)difluoromethyl)phosphonate (27-8)

27-7 (230 mg, 0.26 mmol, 1 equiv.) was dissolved in DCM (3 ml), and TFA (1.5 ml) was added to remove Boc protection. The mixture was stirred at room temperature for 10 min. Most of the volatile components were removed in vacuum. To the residue, CH₃CN (5 ml), triethylamine (0.18 ml, 1.3 mmol, 5 equiv.), benzothiophene head IM-1 (115 mg, 0.31 mmol, 1.2 equiv.), and HATU (118 mg, 0.31 mmol, 1.2 equiv.) were added. The mixture was stirred at room temperature for 30 min. The yellow solution was concentrated in vacuum and the crude was purified by flash column chromatography to yield 27-8 in 68% (200 mg).

¹H NMR (400 MHz, DMSO) δ 11.08-10.86 (m, 1H), 8.60-8.39 (m, 2H), 8.18 (m, 1H), 8.09 (s, 1H), 8.04-7.92 (m, 2H), 7.91 (m, 1H), 7.78 (d, J=3.3 Hz, 1H), 7.74-7.64 (m, 1H), 7.63-7.40 (m, 5H), 5.15 (m, 1H), 4.75 (m, 1H), 4.48 (m, 1H), 4.33 (m, 1H), 4.23-4.00 (m, 5H), 3.87-3.73 (m, 3H), 3.46-3.35 (m, 2H), 2.99-2.83 (m, 3H), 2.72-2.53 (m, 3H), 2.47 (m, 3H), 2.44 (m, 2H), 2.04-1.93 (m, 2H), 1.89-1.57 (m, 5H), 1.22 (m, 6H), 1.09 (m, 9H). ¹³C NMR (400 MHz, DMSO) δ 172.85, 170.97, 169.92, 168.44, 167.68, 167.64, 166.06, 161.36, 143.98, 142.63, 140.92, 138.90, 133.87, 132.48, 131.95, 129.15, 128.54, 127.31, 126.04, 123.40, 122.62, 120.94, 118.74, 118.62, 117.05, 95.76, 95.12, 76.72, 76.56, 64.76, 64.69, 57.46, 51.59, 48.19, 47.00, 45.96, 45.78, 35.42, 35.36, 34.89, 33.13, 31.22, 29.01, 26.57, 26.27, 25.87, 24.87, 22.33, 16.42, 16.20, 16.15, 8.62. ESI-MS calculated for C₅₆H₆₂F₂N₇O₁₀PS₂ [M+H]⁺: 1126.24, found 1126.31.

### ((2-(((2S)-1-((2S)-2-((3-((5-(2-(2,6-Dioxopiperidin-3-yl)-1-oxoisoindolin-4-yl)pent-4-yn-1-yl)(methyl)amino)-3-oxopropyl)(4-(thiazol-2-yl)phenyl)carbamoyl)pyrrolidin-1-yl)-3,3-dimethyl-1-oxobutan-2-yl)carbamoyl)benzo[b]thiophen-5-yl)difluoromethyl)phosphonic acid (681)

To a round bottom flask were added 27-8 (200 mg, 0.17 mmol, 1 equiv.), DCM (2 ml) and CF₃CON(TMS)₂ (0.27 ml, 1.0 mmol, 6 equiv.). The solution was cooled in ice bath. To the ice cooled reaction mixture, 1M of TMS-I in DCM (0.85 ml, 0.85 mmol, 5 equiv.) was added dropwise and the mixture was stirred for 10 min in ice bath. The volatile components were removed under vacuum at below 5° C. The residue was dissolved in a mixed solvent of CH₃CN (3 ml) and water (1 ml). The resulting solution was purified by HPLC to yield 681 in 82% (150 mg).

¹H NMR (400 MHz, DMSO) δ 10.99 (s, 1H), 8.53 (m, 1H), 8.40 (m, 1H), 8.12-8.04 (m, 2H), 8.00 (m, 2H), 7.90 (m, 1H), 7.75 (m, 1H), 7.70 (m, 1H), 7.59 (m, 3H), 7.49 (m, 2H), 5.23-5.05 (m, 1H), 4.77 (m, 1H), 4.46 (m, 1H), 4.40-4.25 (m, 1H), 4.20 (m, 1H), 4.00-3.70 (m, 3H), 3.64 (m, 1H), 3.50-3.28 (m, 2H), 2.95 (m, 3H), 2.80 (m, 1H), 2.61 (m, 3H), 2.43 (m, 2H), 2.00 (m, 2H), 1.77 (m, 5H), 1.10 (s, 9H). ¹³C NMR (400 MHz, DMSO) δ 172.97, 171.09, 170.08, 169.80, 168.63, 167.84, 166.22, 161.57, 159.11, 158.72, 158.34, 157.96, 144.03, 142.03, 140.54, 138.89, 133.97, 132.59, 132.12, 132.08, 129.26, 128.62, 127.45, 126.19, 123.84, 122.87, 121.01, 119.47, 118.89, 116.60, 113.74, 110.87, 95.86, 95.21, 76.68, 57.59, 51.74, 48.33, 47.14, 46.09, 35.54, 35.01, 34.98, 32.97, 31.35, 29.14, 26.68, 25.98, 25.00, 22.48, 16.54. ESI-MS calculated for C₅₂H₅₄F₂N₇O₁₀PS₂ [M+H]⁺: 1070.13, found 1070.40.

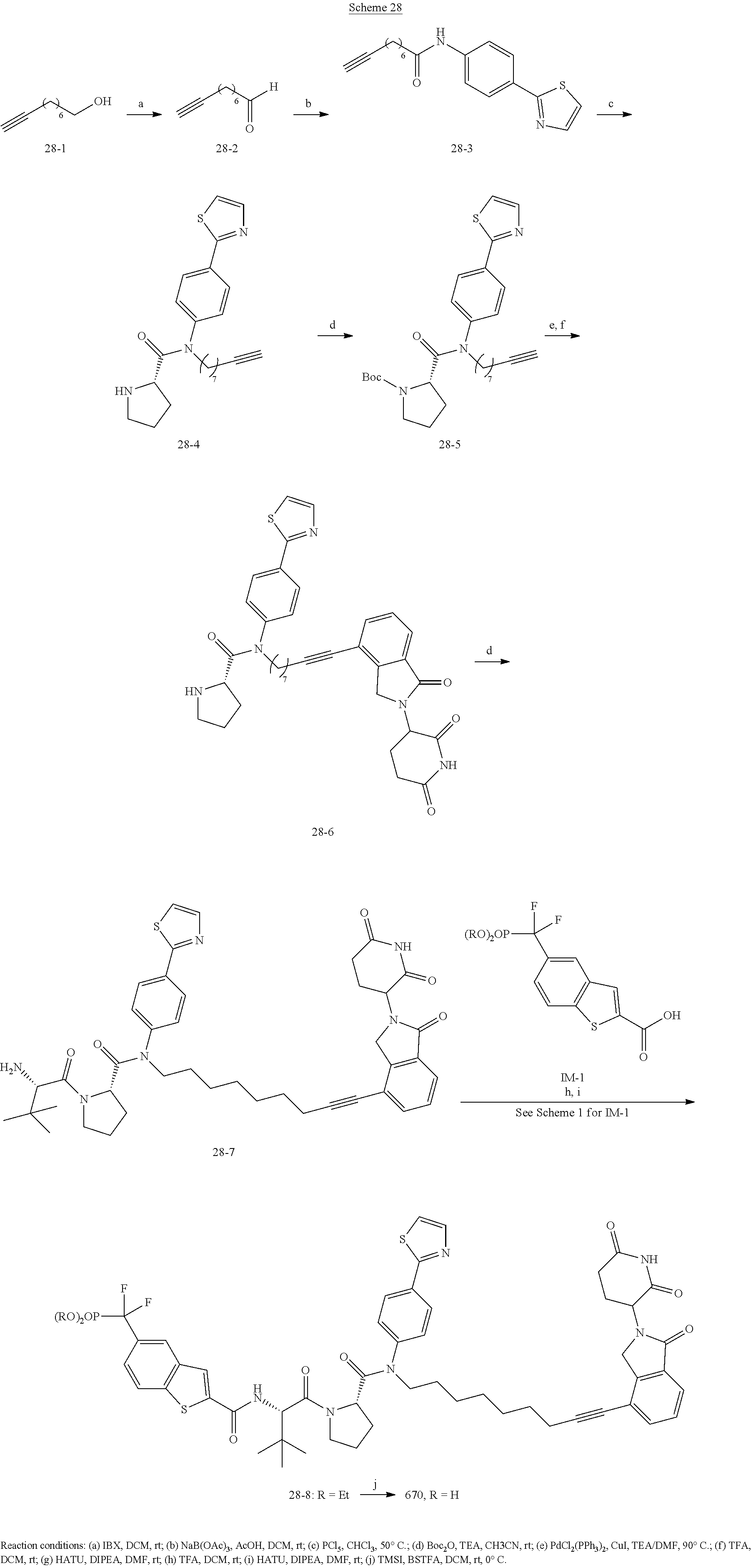

### ((2-(((2S)-1-((2S)-2-((9-(2-(2,6-dioxopiperidin-3-yl)-1-oxoisoindolin-4-yl)non-8-yn-1-yl)(4-(thiazol-2-yl)phenyl)carbamoyl)pyrrolidin-1-yl)-3,3-dimethyl-1-oxobutan-2-yl)carbamoyl)benzo[b]thiophen-5-yl)difluoromethyl)phosphonic acid (670)

To 28-1 (1 g, 7.13 mmol) in DCM (20 ml), Dess-martin periodinane (3 g, 1 equiv.) was added. The mixture was stirred at room temperature for 30 min. White precipitates were formed. Celite was added to the reaction mixture and the mixture was concentrated in vacuum. Then, after the purification by flash column chromatography, 28-2 was obtained as colorless oil in 70% yield (700 mg). ¹H NMR (400 MHz, DMSO) δ 9.66 (s, 1H), 2.76-2.69 (m, 1H), 2.24-2.05 (m, 4H), 1.52-1.21 (m, 8H). ESI-MS calculated for C₉H₁₄O⁺ 138.21, found [M+H]⁺ 139.31.

To 28-2 (200 mg, 1.4 mmol) in DCM (5 ml), 4-(thiazol-2-yl)aniline (1 equiv.), NaB(OAc)3 (2 equiv.), and AcOH (1 equiv.) were added and the mixture was stirred for 30 minutes at room temperature. Water and ethanol were added to the mixture and the mixture was concentrated in vacuum. The purification by HPLC gave 28-3 in 92% (400 mg). ¹H NMR (400 MHz, DMSO) δ 7.75 (d, J=3.3 Hz, 1H), 7.70-7.61 (m, 2H), 7.53 (d, J=3.3 Hz, 1H), 6.64 (d, J=8.8 Hz, 2H), 3.06 (t, J=7.0 Hz, 2H), 2.73 (t, J=2.7 Hz, 1H), 2.15 (td, J=6.9, 2.7 Hz, 2H), 1.55 (t, J=6.9 Hz, 2H), 1.48-1.10 (m, 8H). ESI-MS calculated for C₁₈H₂₂N₂S⁺ 298.45, found [M+H]⁺ 299.01.

Boc-L-proline (1.8 g, 5 equiv.) was dissolved in CHCl₃ (20 ml). At room temperature, PCl₅ (1.7 g, 5 equiv.) was slowly added over a period of 10 min. After the addition, the mixture was stirred for 10 min at room temperature. To this mixture was added 28-3 (400 mg, 1.3 mmol) and the mixture was stirred at 50° C. for 20 min. The volatile components were removed on a rotary evaporator. The obtained crude oil was purified by reverse phase semi-preparative HPLC to give 28-4 as TFA salt in 60% (420 mg). ¹H NMR (400 MHz, DMSO) δ 8.10 (d, J=8.5 Hz, 2H), 7.99 (d, J=3.2 Hz, 1H), 7.87 (d, J=3.2 Hz, 1H), 7.53 (d, J=8.5 Hz, 2H), 4.06 (t, J=7.6 Hz, 1H), 3.86-3.80 (m, 1H), 3.66-3.58 (m, 1H), 3.23-3.18 (m, 2H), 3.13-3.02 (m, 1H), 2.15-2.07 (m, 2H), 1.98-1.93 (m, 1H), 1.87-1.61 (m, 4H), 1.57-1.37 (m, 4H), 1.35-1.20 (d, J=18.1 Hz, 5H). ESI-MS calculated for C₂₃H₂₉N₃OS⁺ 395.57, found [M+H]⁺ 396.25.

28-4 (420 mg, 0.82 mmol) was dissolved in CH₃CN (8 ml). To the solution was added triethylamine (350 μl, 3 equiv.), followed by Boc₂O (260 mg, 1.5 equiv.). The colorless mixture was stirred for 2 hours at room temperature. The volatile components were then removed by vacuum and the crude was purified by flash column chromatography to yield 28-5 in 56% (230 mg). ¹H NMR (400 MHz, DMSO) δ 8.08 (d, J=8.5 Hz, 2H), 7.98-7.94 (m, 1H), 7.86-7.82 (m, 1H), 7.41 (d, J=8.5 Hz, 2H), 4.04 (dd, J=7.3, 5.1 Hz, 1H), 3.86-3.72 (m, 1H), 3.72-3.62 (m, 1H), 3.61-3.46 (m, 1H), 3.38-3.34 (m, 1H), 2.71-2.69 (m, 1H), 2.14-2.10 (m, 2H), 1.91-1.71 (m, 3H), 1.66-1.62 (m, 1H), 1.45-1.39 (m, 13H), 1.30-1.08 (m, 6H). ESI-MS calculated for C₂₈H₃₇N₃O₃S⁺ 495.68, found [M+H]⁺ 396.10.

Triethylamine (1.5 ml) was added to a mixture of 16 (323 mg, 1 mmol, 1 equiv.), 28-5 (230 mg, 0.46 mmol, 1 equiv.), CuI (35 mg, 0.4 equiv.), and Pd(PPh₃)₂Cl₂ (65 mg, 0.2 equiv.) in DMF (1.5 ml). The resulting mixture was purged and refilled with argon three times and stirred at 90° C. for 1.5 hours under argon. The reaction mixture was cooled to room temperature. The mixture was filtered through celite and evaporated to remove most of the solvent. The residue was purified by HPLC to yield Boc-protected 28-6. The Boc-protected 28-6 was dissolved in DCM (5 ml), and TFA (5 ml) was added to remove Boc protection. The mixture was stirred at room temperature for 10 min. Most of the volatile components were removed in vacuum and the residue was purified by HPLC to yield 28-6 as TFA salt in 43% (150 mg). ¹H NMR (400 MHz, DMSO) δ 10.98 (s, 1H), 8.19-8.04 (m, 2H), 8.56-8.49 (m, 1H), 8.11-8.04 (m, 1H), 7.98 (d, J=3.2 Hz, 1H), 7.87 (d, J=3.2 Hz, 1H), 7.70 (d, J=7.6 Hz, 1H), 7.61 (d, J=7.6 Hz, 1H), 7.55-7.36 (m, 3H), 5.18-5.12 (m, 1H), 4.43 (d, J=17.6 Hz, 1H), 4.29 (d, J=17.7 Hz, 1H), 4.08-4.04 (m, 1H), 3.90-3.71 (m, 2H), 3.65-3.58 (m, 1H), 3.23-3.17 (m, 2H), 3.11-3.07 (m, 1H), 2.95-2.78 (m, 1H), 2.45-2.36 (m, 2H), 2.11-1.90 (m, 2H), 1.86-1.62 (m, 4H), 1.60-0.95 (m, 10H). ESI-MS calculated for C₃₆H₃₉N₅O₄S⁺ 637.80, found [M+H]⁺ 638.25.

To 28-6 (75 mg, 0.1 mmol, 1 equiv.), CH₃CN (5 ml), triethylamine (70 μl, 5 equiv.), Boc-L-tert-leucine (45 mg, 2 equiv.), and HATU (80 mg, 2 equiv.) were added. The mixture was stirred at room temperature for 30 min. The yellow solution was concentrated in vacuum and the crude was purified by flash column chromatography to yield Boc-protected 28-7. Boc protection was removed by DCM/TFA at room temperature for 30 min. The volatile components were removed in vacuum to yield 28-7 as a TFA salt in 57% (50 mg).

To 28-7 (25 mg, 0.03 mmol), DMF (3 ml), triethylamine (70 μl), benzothiophene head IM-1 (13 mg, 1.2 equiv.), and HATU (15 mg, 1.2 equiv.) were added. The mixture was stirred at room temperature for 30 min. The yellow solution was purified by HPLC to yield 28-8 in 93% (30 mg)

To a round bottom flask were added 28-8 (30 mg, 0.027 mmol, 1 equiv.), DCM (2 ml) and CF₃CON(TMS)₂ (45 μl, 6 equiv.). The solution was cooled in an ice bath. To the ice cooled reaction mixture, 1M of TMS-J in DCM (0.14 ml, 5 equiv.) was added dropwise and the mixture was stirred for 10 min in an ice bath. The volatile components were removed under vacuum at below 5° C. The residue was dissolved in a mixed solvent of CH₃CN (3 ml) and water (1 ml). The resulting solution was purified by HPLC to yield 670 in 83% (23 mg). ¹H NMR (400 MHz, DMSO) δ 10.99 (s, 1H), 8.53 (s, 1H), 8.41 (d, J=9.0 Hz, 1H), 8.11 (d, J=8.5 Hz, 1H), 8.06-7.97 (m, 3H), 7.92 (d, J=3.2 Hz, 1H), 7.79 (d, J=3.2 Hz, 1H), 7.70-7.48 (m, 6H), 5.14 (m, 1H), 4.75 (m, 1H), 4.51-4.36 (m, 2H), 4.30 (m, 1H), 4.20 (m, 1H), 3.94-3.72 (m, 2H), 3.64 (m, 1H), 3.48 (m, 1H), 2.90 (m, 1H), 2.59 (m, 1H), 2.26 (m, 1H), 2.09-1.92 (m, 2H), 1.86 (m, 1H), 1.81-1.64 (m, 2H), 1.70-1.50 (m, 2H), 1.40-1.25 (m, 8H), 1.08 (s, 9H). ESI-MS calculated for C₅₂H₅₅F₂N₆O₉PS₂⁺ 1041.14, found [M+H]⁺ 1041.33.

### Example 2. Characterization of Compounds

TABLE 3
Characterization data

| Compound | Synthetic Scheme | LC-MS+ |
|---|---|---|
| 396 | 11 | 664.13 |
| 397 | 11 | 657.03 |
| 398 | 11 | 650.11 |
| 399 | 11 | 643.22 |
| 400 | 11 | 635.67 |
| 401 | 11 | 628.86 |
| 402 | 24 | 1137.23 |
| 403 | 24 | 1123.25 |
| 404 | 24 | 1095.15 |
| 405 | 24 | 1081.13 |
| 406 | 24 | 1051.23 |
| 407 | 11 | 711.47 |
| 408 | 11 | 697.57 |
| 409 | 11 | 721.63 |
| 410 | 11 | 699.51 |
| 411 | 12 | 1067.12 |
| | | 1069.13 |
| 412 | 12 | 1095.20 |
| | | 1096.85 |
| 413 | 12 | 1110.56 |
| | | 1111.47 |
| 414 | 12 | 1138.97 |
| 415 | 12 | 1153.17 |
| 416 | 12 | 637.11 |
| 417 | 12 | 644.25 |
| 418 | 12 | 650.95 |
| 419 | 12 | 657.96 |
| 420 | 12 | 665.30 |
| 421 | 12 | 671.56 |
| 422 | 12 | 691.42 |
| 423 | 12 | 705.45 |
| 424 | 12 | 721.53 |
| 425 | 13 | 611.13 |
| 426 | 13 | 618.12 |
| 427 | 13 | 625.35 |
| 428 | 13 | 632.51 |
| 429 | 13 | 639.31 |
| 430 | 13 | 646.11 |
| 431 | 13 | 653.51 |
| 432 | 13 | 660.18 |
| 433 | 13 | 667.21 |
| 434 | 13 | 610.11 |
| 435 | 13 | 617.15 |
| 436 | 13 | 624.13 |
| 437 | 13 | 631.25 |
| 438 | 13 | 638.30 |
| 439 | 13 | 645.31 |
| 440 | 13 | 652.40 |
| 441 | 13 | 659.31 |
| 442 | 13 | 666.12 |
| 443 | 14 | 625.11 |
| 444 | 14 | 632.56 |
| 445 | 14 | 639.20 |
| 446 | 14 | 646.20 |
| 447 | 14 | 653.11 |
| 448 | 14 | 660.13 |
| 449 | 14 | 667.52 |
| 450 | 14 | 674.12 |
| 451 | 14 | 681.14 |
| 452 | 14 | 624.40 |
| 453 | 14 | 631.11 |
| 454 | 14 | 638.44 |
| 455 | 14 | 645.12 |
| 456 | 14 | 652.50 |
| 457 | 14 | 659.13 |
| 458 | 14 | 666.14 |
| 459 | 14 | 673.15 |
| 460 | 14 | 680.31 |
| 461 | 15 | 642.35 |
| 462 | 15 | 649.36 |
| 463 | 15 | 656.32 |
| 464 | 15 | 663.37 |
| 465 | 15 | 670.38 |
| 466 | 15 | 677.35 |
| 467 | 15 | 684.18 |
| 468 | 15 | 691.30 |
| 469 | 15 | 698.50 |
| 470 | 15 | 641.36 |
| 471 | 15 | 648.20 |
| 472 | 15 | 655.32 |
| 473 | 15 | 662.31 |
| 474 | 15 | 669.38 |
| 475 | 15 | 676.49 |
| 476 | 15 | 683.10 |
| 477 | 15 | 690.12 |
| 478 | 15 | 697.31 |
| 479 | 13 | 1031.13 |
| 480 | 13 | 1031.14 |
| 481 | 13 | 1046.31 |
| 482 | 13 | 1045.91 |
| 483 | 13 | 1059.88 |
| 484 | 13 | 1059.95 |
| 485 | 13 | 1073.91 |
| 486 | 13 | 1074.01 |
| 487 | 13 | 1088.09 |
| 488 | 13 | 1088.30 |
| 489 | 13 | 1029.95 |
| 490 | 13 | 1029.95 |
| 491 | 13 | 1044.12 |
| 492 | 13 | 1044.19 |
| 493 | 13 | 1029.95 |
| 494 | 13 | 1030.09 |
| 495 | 13 | 1043.89 |
| 496 | 13 | 1043.88 |
| 497 | 13 | 1058.15 |
| 498 | 13 | 1058.16 |
| 499 | 13 | 1071.95 |
| 500 | 13 | 1071.99 |
| 501 | 13 | 1085.98 |
| 502 | 13 | 1085.89 |
| 503 | 13 | 1128.09 |
| 504 | 13 | 1128.10 |
| 505 | 13 | 1141.95 |
| 506 | 13 | 1141.98 |
| 507 | 14 | 1058.89 |
| 508 | 14 | 1059.10 |
| 509 | 14 | 1073.05 |
| 510 | 14 | 1073.21 |
| 511 | 14 | 1086.89 |
| 512 | 14 | 1086.90 |
| 513 | 14 | 1101.31 |
| 514 | 14 | 1101.32 |
| 515 | 14 | 1115.31 |
| 516 | 14 | 1115.35 |
| 517 | 14 | 1157.19 |
| 518 | 14 | 1157.25 |
| 519 | 14 | 1171.31 |
| 520 | 14 | 1171.39 |
| 521 | 14 | 1157.05 |
| 522 | 14 | 1157.05 |
| 523 | 14 | 1071.36 |
| 524 | 14 | 1071.32 |
| 525 | 14 | 1085.25 |
| 526 | 14 | 1085.21 |
| 527 | 14 | 1099.15 |
| 528 | 14 | 1099.18 |
| 529 | 14 | 1113.32 |
| 530 | 14 | 1123.31 |
| 531 | 14 | 1155.25 |
| 532 | 14 | 1155.35 |
| 533 | 14 | 1169.25 |
| 534 | 14 | 1169.21 |
| 535 | 15 | 1094.40 |
| 536 | 15 | 1094.45 |
| 537 | 15 | 1108.36 |
| 538 | 15 | 1108.42 |
| 539 | 15 | 1122.15 |
| 540 | 15 | 1122.13 |
| 541 | 15 | 1136.31 |
| 542 | 15 | 1136.25 |
| 543 | 15 | 1150.60 |
| 544 | 15 | 1150.65 |
| 545 | 15 | 1192.25 |
| 446 | 15 | 1192.35 |
| 547 | 15 | 1206.31 |
| 548 | 15 | 1206.35 |
| 549 | 15 | 1092.28 |
| 550 | 15 | 1092.30 |
| 551 | 15 | 1106.31 |
| 552 | 15 | 1106.28 |
| 553 | 15 | 1120.15 |
| 554 | 15 | 1134.15 |
| 555 | 15 | 1134.21 |
| 556 | 15 | 1134.25 |
| 557 | 15 | 1148.25 |
| 558 | 15 | 1148.35 |
| 559 | 15 | 1190.28 |
| 560 | 15 | 1190.31 |
| 561 | 15 | 1204.28 |
| 562 | 15 | 1204.21 |
| 563 | 16 | 1011.18 |
| 564 | 16 | 1079.48 |
| 565 | 17 | 1065.99 |
| 566 | 17 | 1043.10 |
| 567 | 18 | 1056.03 |
| 568 | 18 | 1056.03 |
| 569 | 17 | 681.81 |
| 570 | 17 | 689.05 |
| 571 | 17 | 696.53 |
| 572 | 17 | 703.90 |
| 573 | 17 | 719.77 |
| 574 | 16 | 1012.28 |
| 575 | 16 | 1079.38 |
| 576 | 18 | 688.35 |
| 577 | 18 | 695.21 |
| 578 | 18 | 702.12 |
| 579 | 18 | 709.19 |
| 580 | 18 | 682.32 |
| 581 | 18 | 704.18 |
| 582 | 18 | 726.27 |
| 583 | 18 | 748.67 |
| 584 | 19 | 1094.01 |
| 585 | 19 | 1108.39 |
| 586 | 19 | 1080.07 |
| 587 | 19 | 1052.05 |
| 588 | 17 | 1043.10 |
| 589 | 19 | 1121.31 |
| 590 | 20 | 1083.18 |
| 591 | 20 | 1173.97 |
| 592 | 20 | 1160.93 |
| 593 | 19 | 1038.24 |
| 594 | 19 | 1024.26 |
| 595 | 19 | 1066.24 |
| 596 | 14 | 1043.21 |
| 597 | 14 | 1015.18 |
| 598 | 21 | 1007.21 |
| 599 | 21 | 1021.85 |
| 600 | 19 | 1016.13 |
| 601 | 19 | 1014.84 |
| 602 | 19 | 1014.43 |
| 603 | 19 | 1014.13 |
| 604 | 22 | 1058.21 |
| 605 | 22 | 1048.36 |
| 606 | 23 | 1043.12 |
| 607 | 23 | 1078.32 |
| 608 | 23 | 1082.34 |
| 609 | 23 | 1031.52 |
| 610 | 23 | 1068.22 |
| 611 | 23 | 1036.36 |
| 612 | 23 | 1080.40 |
| 613 | 24 | 1077.24 |
| | | 1079.15 |
| 614 | 24 | 1037.00 |
| | | 1039.43 |
| 615 | 24 | 1068.23 |
| | | 1070.19 |
| 616 | 24 | 1158.00 |
| | | 1159.99 |
| 617 | 24 | 1143.21 |
| | | 1145.34 |
| 618 | 24 | 1158.96 |
| 619 | 24 | 1171.98 |
| | | 1172.99 |
| 620 | 24 | 1185.22 |
| | | 1187.05 |
| 621 | 24 | 1183.20 |
| | | 1185.70 |
| 622 | 24 | 1143.25 |
| | | 1145.00 |
| 623 | 24 | 1158.91 |
| | | 1157.38 |
| 624 | 24 | 1171.20 |
| | | 1173.10 |
| 625 | 25 | 1051.33 |
| | | 1053.27 |
| 626 | 25 | 1064.21 |
| | | 1066.31 |
| 627 | 25 | 1078.00 |
| | | 1079.31 |
| 628 | 25 | 1092.00 |
| | | 1093.81 |
| 629 | 25 | 1106.00 |
| | | 1107.65 |
| 630 | 25 | 1104.00 |
| | | 1106.01 |
| 631 | 25 | 1094.99 |
| | | 1097.01 |
| 632 | 23 | 1049.07 |
| | | 1050.34 |
| 633 | 27 | 972.95 |
| 634 | 27 | 991.10 |
| 635 | 27 | 1006.85 |
| 636 | 27 | 1024.91 |
| 637 | 27 | 1099.14 |
| 638 | 27 | 1020.93 |
| 639 | 27 | 1039.26 |
| 640 | 27 | 991.10 |
| 641 | 27 | 1007.25 |
| 642 | 27 | 998.00 |
| 643 | 27 | 998.16 |
| 644 | 27 | 1040.99 |
| 645 | 27 | 1040.98 |
| 646 | 27 | 987.07 |
| 647 | 27 | 1029.30 |
| 648 | 27 | 1054.99 |
| 649 | 27 | 1049.14 |
| 650 | 27 | 1029.26 |
| 651 | 27 | 1057.33 |
| 652 | 27 | 1130.30 |
| 653 | 27 | 1165.01 |
| | | 1166.95 |
| 654 | 27 | 1051.83 |
| 655 | 27 | 1056.88 |
| 656 | 27 | 1023.00 |
| 657 | 26 | 986.31 |
| 658 | 26 | 1016.32 |
| 659 | 26 | 1066.23 |
| 660 | 27 | 1030.00 |
| 661 | 27 | 1013.03 |
| 662 | 27 | 1029.02 |
| 663 | 27 | 1049.08 |
| 664 | 26 | 1008.92 |
| | | 1010.88 |
| 665 | 24 | 1064.94 |
| | | 1066.79 |
| 666 | 24 | 1076.97 |
| | | 1078.83 |
| 667 | 24 | 1062.93 |
| | | 1064.34 |
| 668 | 27 | 1030.00 |
| 669 | 27 | 1029.11 |
| 670 | 28 | 1041.33 |
| 671 | 27 | 1157.26 |
| 672 | 27 | 1141.29 |
| 673 | 27 | 1151.31 |
| 674 | 27 | 1141.39 |
| 675 | 27 | 1169.51 |
| 676 | 27 | 1158.32 |
| 677 | 27 | 1181.13 |
| 678 | 28 | 1126.31 |
| 679 | 27 | 1184.17 |
| 680 | 27 | 1037.40 |
| 681 | 27 | 1070.40 |
| 682 | 27 | 1118.29 |
| 683 | 27 | 1027.33 |
| 684 | 27 | 1044.32 |
| 685 | 27 | 1043.32 |
| 686 | 24 | 1066.16 |

### Example 3. Biological Assay

To evaluate the degradation efficiency of degraders, immunoblotting analysis was performed. The general protocol is the following.

### Immunoblotting

About 1 million cells for each data point were treated with compounds at indicated concentrations and durations. Untreated and treated cells in cell culture medium were transferred into tubes, followed by centrifugation at 3,000 rpm and 4° C. for 6 min Supernatants were removed from tubes and radioimmunoprecipitation assay (RIPA) lysis buffer supplemented with 1% protease inhibitor cocktail (Fisher Scientific cat. PI87786) and phosphatase inhibitor (Roche cat. 04906837001) were added to tubes containing the remaining cell pellets. The tubes were then left on ice for 30 min and placed in a −80° C. freezer. Subsequently they were thawed in 37° C. water, then centrifuged at 14,000 rpm for 15 min and the cell lysates transferred to new tubes. The concentration of total proteins in each tube was calculated using the Pierce BCA protein Assay kit (cat. 23225). Based on the calculated protein concentration, cell lysates containing approximately the same amount of proteins were transferred to new tubes, then distilled water and 4× Protein Sample Loading Buffer for Western Blots (LI-COR cat. 928-40004) supplemented with 20% of mercaptoethanol (Sigma Aldrich cat. M6250) were added on ice. The cell lysates were then reduced and denatured at 95° C. for 5 min. From the tubes containing cell lysates an equal amount of protein samples (20-40 μg) was loaded into precast 8%, 10%, 4%-12%, or 4%-20% Tris-glycine gels (Novex) filled with Tris-glycine SDS running buffer. After the proteins were resolved, they were transferred onto Immobile-FL PVDF Membrane (Millipore Sigma cat. IPFL00010), using Mini Trans-Blot Electrophoretic Transfer Cell (Bio-Rad 1703930). The membranes were blocked with Intercept Blocking Buffer (LI-COR cat. 927-70001) in LI-COR Western Blot boxes for 1 h at rt. The membranes were washed with 1× Tris-buffered saline-Tween-20 (TBST, 1× solution was made from 20×TBST solution, ThermoFisher Scientific cat. 28360) for 5 min 4 times. The membranes were incubated overnight at 4° C. in Intercept Blocking Buffer supplemented with primary antibodies (normally antibody:buffer 1:1000) and Tween-20. The membranes were washed with TBST for 5 min 4 times and were incubated with Intercept Blocking Buffer supplemented with IRDye 800CE Secondary Antibodies, IRDye 680RD Secondary Antibodies (LI-COR biosciences), Tween-20, and 10% SDS solution, for 1 h at rt. The membranes were then washed with TBST for 5 min 4 times and rinsed with deionized water before drying and scanning with Odyssey Dlx Amazing System (LI-COR). The immunoblots were finally quantified by the software.

Results of immunoblotting assay are summarized in Table 4:

TABLE 4
Biological Data

| | DC50 (μM) | | | | | | | |
|---|---|---|---|---|---|---|---|---|
| Cpd. | MOLM-16 | | KU-812 | | SKNO1 | | MB231 | L1236 |
| No. | S6 | S5 | S6 | S5 | S6 | S5 | S6 | S6 |
| 396 | | | | | | | D | |
| 397 | | | | | | | D | |
| 398 | | | | | | | D | |
| 399 | | | | | | | D | |
| 400 | | | | | | | D | |
| 401 | | | | | | | D | |
| 402 | | | | | | | D | |
| 403 | D | C | | D | | | D | |
| 404 | D | B | | B | | C | D | |
| 405 | D | B | | B | | B | D | |
| 406 | D | A | D | B | D | B | D | |
| 407 | | | | | | | D | |
| 408 | | | | | | | D | |
| 409 | | | | | | | D | |
| 410 | | | | | | | D | |
| 411 | | | | | | D | D | D |
| 412 | | | | | | D | D | D |
| 413 | | | | | | D | D | D |
| 414 | | | | | | D | D | D |
| 415 | | | | | | D | D | D |
| 416 | | | | | | | D | D |
| 417 | | | | | | | D | D |
| 418 | | | | | | | D | D |
| 419 | | | | | | | D | D |
| 420 | | | | | | | D | D |
| 421 | | | | | | | D | D |
| 422 | D | | | | | | | |
| 423 | D | | | | | | | |
| 424 | D | | | | | | | |
| 425 | D | | | | | | | D |
| 426 | D | | | | | | | D |
| 427 | D | | | | | | | D |
| 428 | D | | | | | | | D |
| 429 | D | | | | | | | D |
| 430 | D | | | | | | | D |
| 431 | D | | | | | | | D |
| 432 | D | | | | | | | D |
| 433 | D | | | | | | | D |
| 434 | D | | | | | | | D |
| 435 | D | | | | | | | D |
| 436 | D | | | | | | | D |
| 437 | D | | | | | | | D |
| 438 | D | | | | | | | D |
| 439 | D | | | | | | | D |
| 440 | D | | | | | | | D |
| 441 | D | | | | | | | D |
| 442 | D | | | | | | | D |
| 443 | D | | | | | | | D |
| 444 | D | | | | | | | D |
| 445 | D | | | | | | | D |
| 446 | D | | | | | | | D |
| 447 | D | | | | | | | D |
| 448 | D | | | | | | | D |
| 449 | D | | | | | | | D |
| 450 | D | | | | | | | D |
| 451 | D | | | | | | | D |
| 452 | D | | | | | | | D |
| 453 | D | | | | | | | D |
| 454 | D | | | | | | | D |
| 455 | D | | | | | | | D |
| 456 | D | | | | | | | D |
| 457 | D | | | | | | | D |
| 458 | D | | | | | | | D |
| 459 | D | | | | | | | D |
| 460 | D | | | | | | | D |
| 461 | D | | | | | | | D |
| 462 | D | | | | | | | D |
| 463 | D | | | | | | | D |
| 464 | D | | | | | | | D |
| 465 | D | | | | | | | D |
| 466 | D | | | | | | | D |
| 467 | D | | | | | | | D |
| 468 | D | | | | | | | D |
| 469 | D | | | | | | | D |
| 470 | D | | | | | | | |
| 471 | D | | | | | | | |
| 472 | D | | | | | | | |
| 473 | D | | | | | | | |
| 474 | D | | | | | | | |
| 475 | D | | | | | | | |
| 476 | D | | | | | | | |
| 477 | D | | | | | | | |
| 478 | D | | | | | | | |
| 479 | D | | | | | | | |
| 480 | D | | | | | | | |
| 481 | D | | | | | | | |
| 482 | D | | | | | | | |
| 483 | C | | | | | | | |
| 484 | C | | | | | | | |
| 485 | D | | | | | | | |
| 486 | D | | | | | | | |
| 487 | D | | | | | | | |
| 488 | D | | | | | | | |
| 489 | D | | | | | | | |
| 490 | D | | | | | | | |
| 491 | D | | | | | | | |
| 492 | D | | | | | | | |
| 493 | D | | | | | | | |
| 494 | D | | | | | | | |
| 495 | D | | | | | | | |
| 496 | D | | | | | | | |
| 497 | D | | | | | | | |
| 498 | D | | | | | | | |
| 499 | D | | | | | | | |
| 500 | D | | | | | | | |
| 501 | D | | | | | | | |
| 502 | D | | | | | | | |
| 503 | D | | | | | | | |
| 504 | D | | | | | | | |
| 505 | D | | | | | | | |
| 506 | D | | | | | | | |
| 507 | D | | | | | | | |
| 508 | D | | | | | | | |
| 509 | D | | | | | | | |
| 510 | D | | | | | | | |
| 511 | C | | | | | | | |
| 512 | B | | | | | | | |
| 513 | D | | | | | | | |
| 514 | D | | | | | | | |
| 515 | D | | | | | | | |
| 516 | D | | | | | | | |
| 517 | D | | | | | | | |
| 518 | D | | | | | | | |
| 519 | D | | | | | | | |
| 520 | D | | | | | | | |
| 521 | D | | | | | | | |
| 522 | D | | | | | | | |
| 523 | D | | | | | | | |
| 524 | D | | | | | | | |
| 525 | D | | | | | | | |
| 526 | D | | | | | | | |
| 527 | D | | | | | | | |
| 528 | D | | | | | | | |
| 529 | D | | | | | | | |
| 530 | D | | | | | | | |
| 531 | D | | | | | | | |
| 532 | D | | | | | | | |
| 533 | D | | | | | | | |
| 534 | D | | | | | | | |
| 535 | B | | | | | | | |
| 536 | C | | | | | | | |
| 537 | D | | | | | | | |
| 538 | D | | | | | | | |
| 539 | D | | | | | | | |
| 540 | D | | | | | | | |
| 541 | D | | | | | | | |
| 542 | D | | | | | | | |
| 543 | D | | | | | | | |
| 544 | D | | | | | | | |
| 545 | D | | | | | | | |
| 446 | D | | | | | | | |
| 547 | D | | | | | | | |
| 548 | D | | | | | | | |
| 549 | D | | | | | | | |
| 550 | D | | | | | | | |
| 551 | D | | | | | | | |
| 552 | D | | | | | | | |
| 553 | D | | | | | | | |
| 554 | D | | | | | | | |
| 555 | D | | | | | | | |
| 556 | D | | | | | | | |
| 557 | D | | | | | | | |
| 558 | D | | | | | | | |
| 559 | D | | | | | | | |
| 560 | D | | | | | | | |
| 561 | D | | | | | | | |
| 562 | D | | | | | | | |
| 563 | D | | | | | | | D |
| 564 | D | | | | | | | D |
| 565 | D | | | | | | | D |
| 566 | D | | | | | | | D |
| 567 | >0.3 | >0.3 | | | | | | |
| 568 | >0.3 | >0.3 | | | | | | |
| 569 | D | | | | | | | |
| 570 | D | | | | | | | |
| 571 | D | | | | | | | |
| 572 | D | | | | | | | |
| 573 | D | | | | | | | |
| 574 | D | | | | | | | D |
| 575 | D | | | | | | | D |
| 576 | >0.3 | >0.3 | | | | | | |
| 577 | >0.3 | >0.3 | | | | | | |
| 578 | >0.3 | >0.3 | | | | | | |
| 579 | >0.3 | >0.3 | | | | | | |
| 580 | >0.3 | >0.3 | | | | | | |
| 581 | >0.3 | >0.3 | | | | | | |
| 582 | >0.3 | >0.3 | | | | | | |
| 583 | >0.3 | >0.3 | | | | | | |
| 584 | B | | | | | | | D |
| 585 | >0.3 | | | | | | | D |
| 586 | A | | | | | | | C |
| 587 | A | | | | | | | B |
| 588 | D | | | | | | | D |
| 589 | C | | | | | | | |
| 590 | C | | | | | | | |
| 591 | D | | | | | | | |
| 592 | C | | | | | | | |
| 593 | A | D | | | | | | |
| 594 | A | | | | | | | |
| 595 | A | | | | | | | |
| 596 | >0.3 | | | | | | | |
| 597 | >0.3 | | | | | | | |
| 598 | >0.3 | | | | | | | |
| 599 | >0.3 | | | | | | | |
| 600 | >0.3 | | | | | | | |
| 601 | >0.3 | | | | | | | |
| 602 | >0.3 | | | | | | | |
| 603 | >0.3 | | | | | | | |
| 604 | >0.3 | | | | | | | |
| 605 | >0.3 | | | | | | | |
| 606 | >0.3 | >0.3 | | | | | | |
| 607 | A | | | | | | | |
| 608 | >0.3 | | | | | | | |
| 609 | >0.3 | | | | | | | |
| 610 | >0.3 | | | | | | | |
| 611 | >0.3 | | | | | | | |
| 612 | >0.3 | | | | | | | |
| 613 | | >0.3 | | D | | D | | |
| 614 | D | >0.3 | | D | | D | | |
| 615 | | >0.3 | | D | | | | |
| 616 | | >0.3 | | | | | | |
| 617 | | >0.3 | | | | | | |
| 618 | | >0.3 | | | | | | |
| 619 | | >0.3 | | | | | | |
| 620 | | >0.3 | | | | | | |
| 621 | | >0.3 | | | | | | |
| 622 | | >0.3 | | | | | | |
| 623 | | >0.3 | | | | | | |
| 624 | | >0.3 | | | | | | |
| 625 | | >0.3 | | | | | | |
| 626 | | >0.3 | | | | | | |
| 627 | | >0.3 | | | | | | |
| 628 | | >0.3 | | | | | | |
| 629 | | >0.3 | | | | | | |
| 630 | | >0.3 | | | | | | |
| 631 | | >0.3 | | | | | | |
| 632 | | >0.3 | | | | | | |
| 633 | | >0.3 | | D | | C | | |
| 634 | | >0.3 | | | | D | | |
| 635 | | >0.3 | | C | | C | | |
| 636 | | >0.3 | | | | D | | |
| 637 | | >0.3 | | | | B | | |
| 638 | | B | | | | | | |
| 639 | | >0.3 | | | | D | | |
| 640 | | >0.3 | | | | | | |
| 641 | | >0.3 | | | | D | | |
| 642 | | >0.3 | | | | D | | |
| 643 | | >0.3 | | | | D | | |
| 644 | | >0.3 | | | | C | | |
| 645 | | >0.3 | | | | D | | |
| 646 | | >0.3 | | | | B | | |
| 647 | | >0.3 | | | | C | | |
| 648 | | A | | B | | B | | |
| 649 | | >0.3 | | | | C | | |
| 650 | >0.3 | A | | B | | B | | |
| 651 | | >0.3 | | | | D | | |
| 652 | A | D | | | | | | |
| 653 | A | >0.3 | | | | | | |
| 654 | >0.3 | >0.3 | | | | D | | |
| 655 | >0.3 | A | | B | | B | | |
| 656 | >0.3 | A | | B | | B | | |
| 657 | >0.3 | >0.3 | | | | | | |
| 658 | >0.3 | >0.3 | | | | | | |
| 659 | >0.3 | >0.3 | | | | | | |
| 660 | >0.3 | >0.3 | | | | C | | |
| 661 | >0.3 | A | | B | | B | | |
| 662 | >0.3 | >0.3 | | D | | D | | |
| 663 | >0.3 | >0.3 | | C | | C | | |
| 664 | >0.3 | >0.3 | | | | | | |
| 665 | >0.3 | A | | B | | B | | |
| 666 | >0.3 | >0.3 | | C | | C | | |
| 667 | >0.3 | >0.3 | | D | | D | | |
| 668 | >0.3 | A | | B | | B | | |
| 669 | >0.3 | >0.3 | | | | D | | |
| 670 | >0.3 | >0.3 | | | | D | | |
| 671 | >0.3 | A | | | | | | |
| 672 | >0.3 | A | | | | | | |
| 673 | >0.3 | A | | | | | | |
| 674 | >0.3 | A | | | | | | |
| 675 | >0.3 | B | | | | | | |
| 676 | >0.3 | A | | | | | | |
| 677 | >0.3 | A | | | | | | |
| 678 | >0.3 | >0.3 | | | | | | |
| 679 | D | A | | B | | | | |
| 680 | D | A | | B | | B | | |
| 681 | D | A | D | B | D | B | | |
| 682 | | | | B | | B | | |
| 683 | | | | B | | B | | |
| 684 | | | | B | | B | | |
| 685 | | | | B | | B | | |
| 686 | | | D | B | | | | |

“A”: <0.1 μM;
“B”: 0.1-1 μM;
“C”: 1-10 μM;
“D”: >10 μM.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

As used herein and in the appended claims, the singular forms “a,” “an,” and “the” include plural referents unless the context clearly dictates otherwise. Thus, for example, reference to “an agent” includes a plurality of such agents, and reference to “the cell” includes reference to one or more cells (or to a plurality of cells) and equivalents thereof known to those skilled in the art, and so forth.

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

What is claimed is:

1. A compound of Formula I: 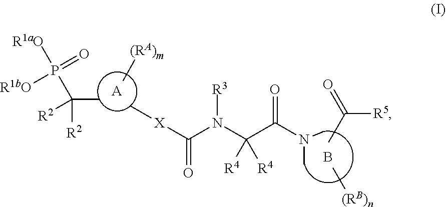
or a pharmaceutically acceptable salt, solvate, or stereoisomer thereof, wherein:
R^{1a} and R^{1b} are independently hydrogen, C₁₋₆ alkyl, or a hydroxyl protecting group;
each R² is independently hydrogen or halogen; or
Ring A is C₆₋₁₀ aryl or 5- to 10-membered heteroaryl;
each R^{A} is independently halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};
m is an integer selected from 0 to 6;
Ring B is 3- to 12-membered heterocyclyl;
each R^{B} is independently 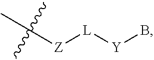
oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{B-1}; or
two vicinal R^{B}, together with atoms to which they are bonded, form C₆ aryl or 5- to 6-membered heteroaryl, wherein the aryl or heteroaryl is optionally substituted with one or more R^{B-1};
each R^{B-1} is independently 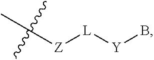
oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};
n is an integer selected from 0 to 6;
X is —CR^{X}═CR^{X}— or absent;
each R^{X} is independently hydrogen, halogen, or C₁₋₆ alkyl;
R³ is hydrogen, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, or 3- to 12-membered heterocyclyl, wherein the alkyl, alkoxy, alkylamino, alkenyl, alkynyl, aryl, heteroaryl, carbocyclyl, or heterocyclyl is optionally substituted with one or more R^{u};
each R⁴ independently is hydrogen, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{4a}; or
R⁴ and R^{B}, together with the intervening atoms, form 3- to 12-membered heterocyclyl optionally substituted with one or more R^{4b}; or
two R⁴, together with the carbon atom to which they are attached, form C₃₋₆ carbocyclyl or 3- to 6-membered heterocyclyl, wherein the carbocyclyl or heterocyclyl is optionally substituted with one or more R^{u};
each R^{4a} is independently halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};
each R⁴ is independently 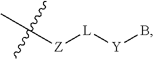
oxo, halogen, —CN, —NO₂, —OH, —NH₂, —B(OH)₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}; 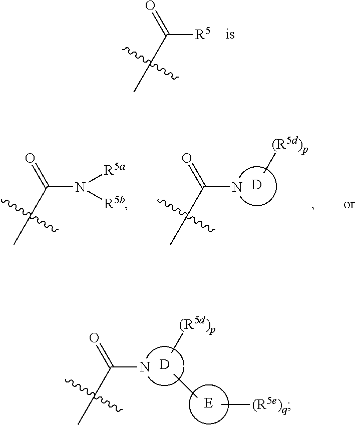
each R^{5a} and R^{5b} are independently 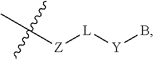
hydrogen, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), or —(C₁₋₆ alkyl)-(3- to 12-membered heterocyclyl), wherein the alkyl, alkoxy, alkylamino, alkenyl, alkynyl, aryl, heteroaryl, carbocyclyl, or heterocyclyl is optionally substituted with one or more R^{5c};
each R^{5c} is independently halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), or —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};
Ring D is 3- to 12-membered heterocyclyl;
Ring E is C₆₋₁₀ aryl, 5- to 10-membered heteroaryl, C₃₋₁₂ carbocyclyl, or 3- to 12-membered heterocyclyl;
each R^{5d} and R^{5e} is independently 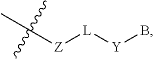
oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u}; and
p and q independently are integers selected from 0 to 6;
provided that:
one of R^{B}, R^{B-1}, R^{4b}, R^{5a}, R^{5b}, and R^{5d}, and R^{5e} is 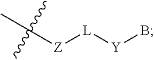
wherein:
Z is —CH₂—, —O—, —N(R^{Z0})—, —OC(═O)—, —C(═O)NR^{Z1}—, —C(═O)—, —CH₂C(═O)NR^{Z2}—, —CH₂CH₂C(═O)NR^{Z3}—, —CH₂CH₂(C═O)N(CH₂)₂CH—, —OCH₂C(═O)NR^{Z4}—, or —C(═O)CH₂C(═O)NR^{Z5}—;
each occurrence of R^{Z0}, R^{Z1}, R^{Z2}, R^{Z3}, R^{Z4}, and R^{Z5} is independently hydrogen or C₁₋₆ alkyl;
L is C₁₋₁₈ alkylene or C₁₋₁₂ heteroalkylene, wherein the alkylene or heteroalkylene is optionally substituted with one or more R^{u}; or
L is -A-(CH₂)_{m′}—W—(CH₂)_{n′}— or —(CH₂)_{r′}—W—(CH₂)_{u′}—O—(CH₂)_{v′}—;
A is absent; or
A is 5- to 10-membered heteroarylene optionally substituted with one or more R^{u};
W is phenylene, 5- to 10-membered heteroarylene, 3- to 12-membered heterocyclylene, or C₃₋₁₂ carbocyclylene; wherein the phenylene, heteroarylene, heterocyclylene, or carbocyclylene is optionally substituted with one or more R^{u};
m′ is an integer from 0 to 7;
n′ is an integer from 0 to 8;
r′ is an integer from 0 to 3;
u′ is an integer from 0 to 3; and
v′ is an integer from 1 to 4;
Y is —C≡C—, —CH═CH—, —CH₂—, —O—, —N(R^{Y1})—, —C(═O)—, —C(═O)N(R^{Y2})—, —N(R^{Y3})C(═O)CH₂O—, or —N(R^{Y3})C(═O)CH₂N(R^{Y4})—; or
Y is absent;
each occurrence of R^{Y1}, R^{Y2}, R^{Y3}, and R^{Y4} is independently hydrogen or C₁₋₆ alkyl; and
B is 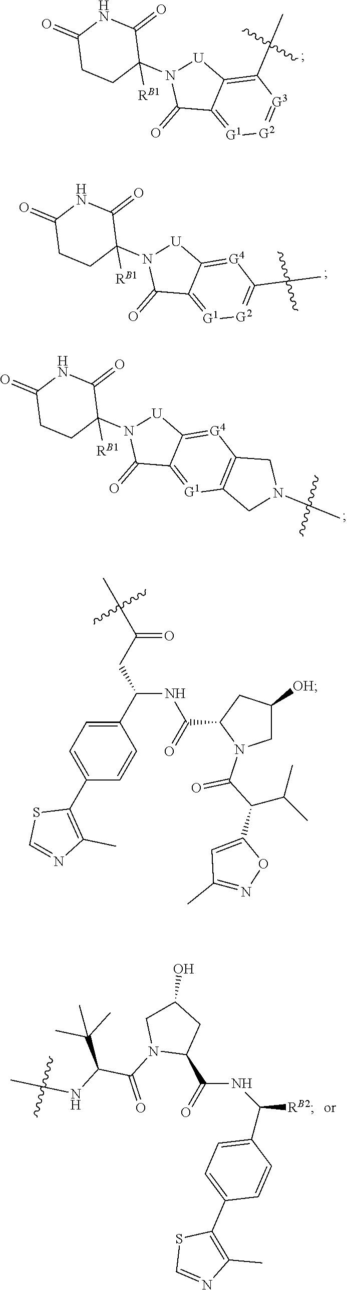 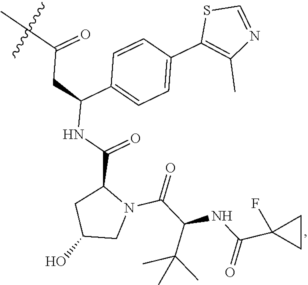
wherein:
G¹, G², G³, and G⁴ are independently —C(R^{G})═ or —N═;
U is —CH₂— or —C(═O)—;
R^{B1} is hydrogen, deuterium, methyl, or fluoro;
R^{B2} is hydrogen or methyl; and
each R^{G} is independently hydrogen, halo, or C₁₋₄ alkyl,
wherein:
each R^{u} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}; wherein the alkyl, alkoxy, alkylamino, alkenyl, alkynyl, carbocyclyl, heterocyclyl, aryl, or heteroaryl is optionally substituted with one or more substituents selected from oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, and 3- to 6-membered heterocyclyl; or
two R^{u}, together with the one or more intervening atoms, form C₃₋₆ carbocyclyl, 3- to 6-membered heterocyclyl, C₆ aryl, or 5- to 6-membered heteroaryl, wherein the carbocyclyl, heterocyclyl, aryl, or heteroaryl is optionally substituted with one or more R^{z};
each R^{a} is independently C₁₋₆ alkyl, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl;
each R^{b} is independently hydrogen, C₁₋₆ alkyl, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl; and
R^{c} and R^{d} are independently hydrogen, C₁₋₆ alkyl, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl; or
R^{c} and R^{d}, together with the nitrogen atom to which they are attached, form 3- to 12-membered heterocyclyl, wherein the heterocyclyl is optionally substituted with one or more R^{z},
wherein each occurrence of R^{a}, R^{b}, R^{c}, and R^{d} is independently and optionally substituted with one or more R^{z}; and
each R^{z} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl.

2. The compound of claim 1, wherein when one of R^{5a} and R^{5b} is hydrogen, then the other one of R^{5a} and R^{5b} is not: 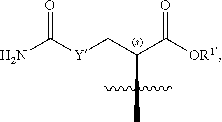
wherein:
Y′ is —O—, —NH—, or —CH₂—; and
R^{1′} is H or benzyl.

3. The compound of claim 1 or 2, wherein Ring A is 5- to 10-membered heteroaryl.

4. The compound of claim 1 or 2, wherein Ring A is

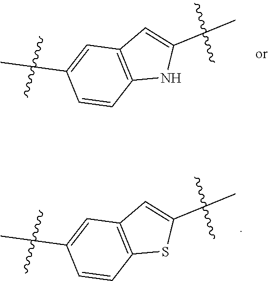 [SMILES: *c1ccc2[nH]c(*)cc2c1 ; *c1ccc2sc(*)cc2c1]

5. The compound of claim 1, wherein the compound is a compound of Formula I-a or I-b: 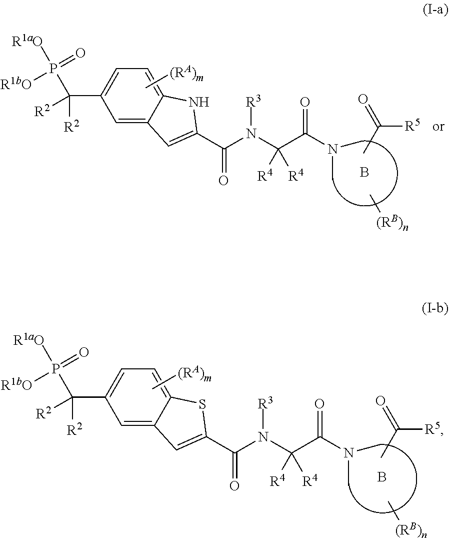
or a pharmaceutically acceptable salt, solvate, or stereoisomer thereof.

6. The compound of any one of claims 1-5, wherein Ring B is 5- to 8-membered heterocyclyl.

7. The compound of claim 1, wherein the compound is a compound of Formula I-a-i to I-b-iii 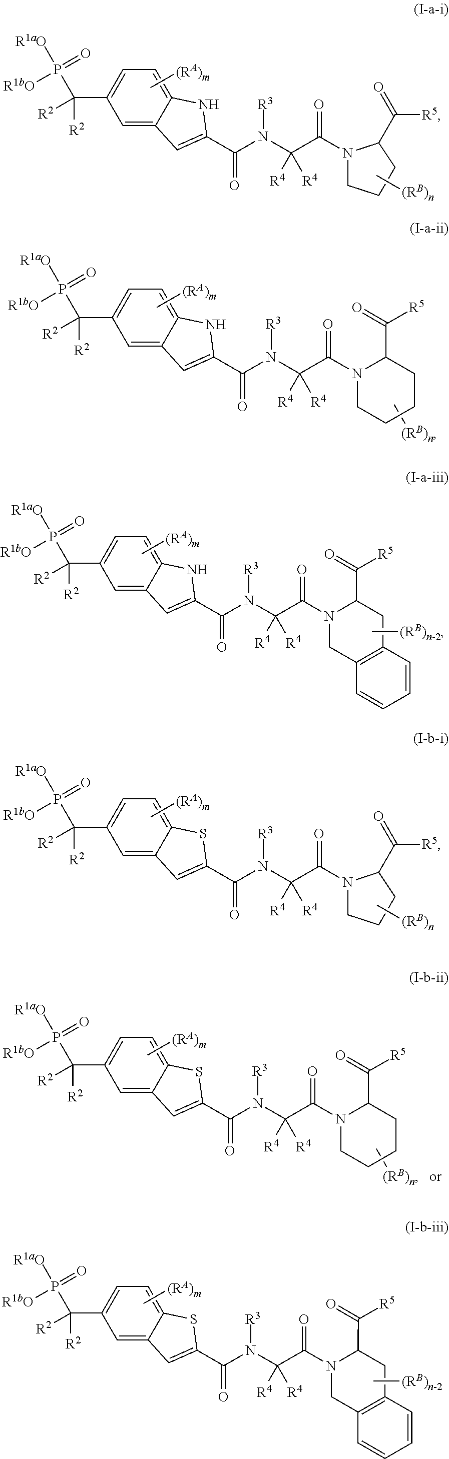
or a pharmaceutically acceptable salt, solvate, or stereoisomer thereof.

8. The compound of claim 1, wherein the compound is a compound of Formula I-a-iv, I-a-v, I-b-iv, or I-b-v 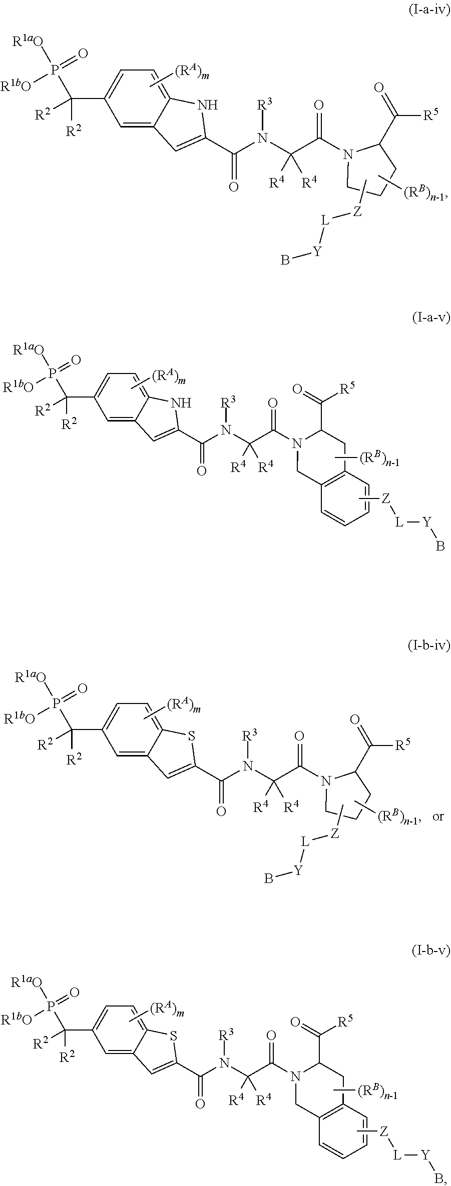
or a pharmaceutically acceptable salt, solvate, or stereoisomer thereof.

9. The compound of any one of claims 1-8, wherein each R⁴ is independently C₁₋₆ alkyl, C₆₋₁₀ aryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(3- to 12-membered heterocyclyl), wherein the alkyl, carbocyclyl, heterocyclyl, or aryl, is optionally substituted with one or more R^{4a}.

10. The compound of claim 9, wherein each R^{4a} is independently halogen, —CN, —NO₂, —OH, —NH₂, —B(OH)₂, C₁₋₆ alkyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(C₃₋₁₂ carbocyclyl), —NR^{b}C(═O)R^{a}, —OR^{b}, —C(═O)R^{a}, or —C(═O)NR^{c}R^{d}, wherein the alkyl, alkynyl, carbocyclyl, heterocyclyl, aryl, or heteroaryl is optionally substituted with one or more R^{u}.

11. The compound of any one of claims 1-8, wherein one R⁴ and one R^{B}, together with the intervening atoms, form 3- to 12-membered heterocyclyl optionally substituted with one or more R^{4b}.

12. The compound of claim 1, wherein the compound is a compound of Formula I-a-i-1, I-a-i-2, I-b-i-1, or I-b-i-2 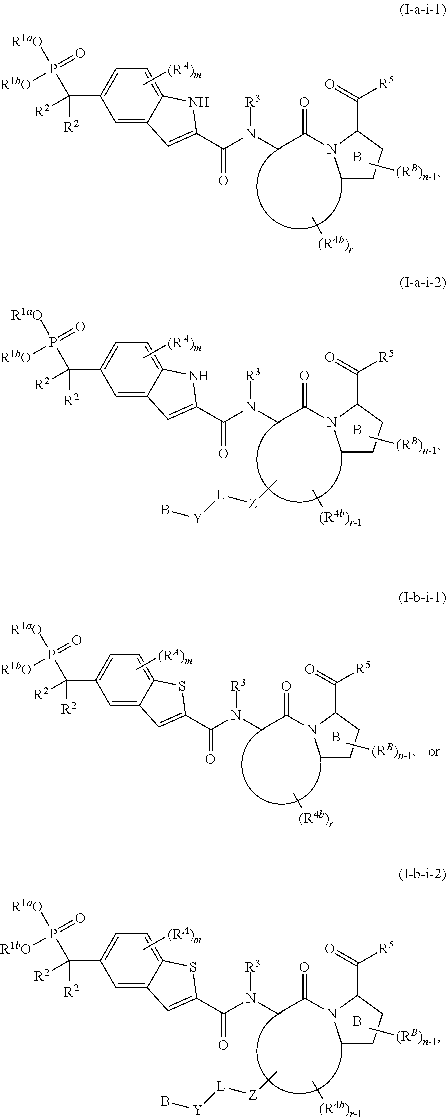
or a pharmaceutically acceptable salt, solvate, or stereoisomer thereof,
wherein r is an integer from 0 to 10, as valency permits.

13. The compound of claim 12, wherein the compound is a compound of Formula I-a-i-3, I-a-i-4, I-b-i-3, or I-b-i-4, 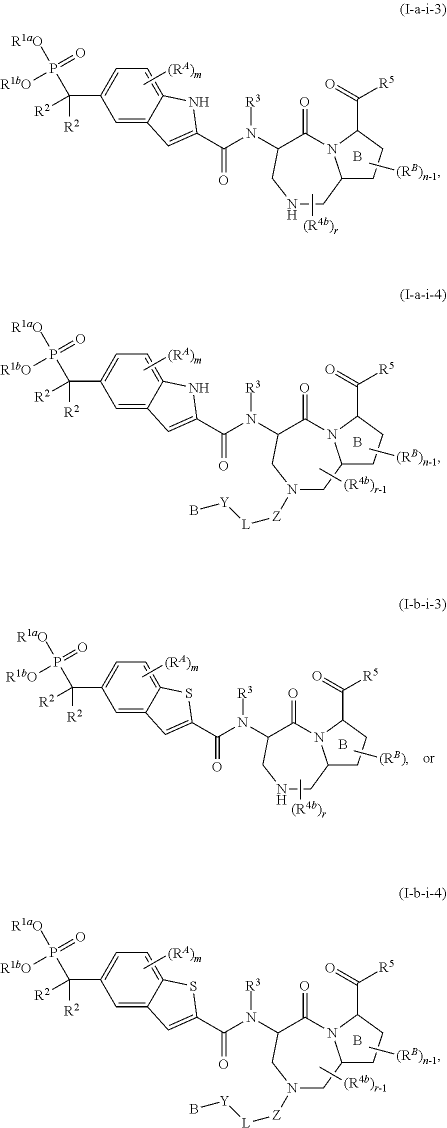
or a pharmaceutically acceptable salt, solvate, or stereoisomer thereof.

14. The compound of any one of claims 1-13, wherein each R^{4b} is independently oxo, halogen, —CN, —NO₂, —OH, —NH₂, C₁₋₆ alkyl, C₁₋₆ alkoxy, C₁₋₆ alkylamino, C₃₋₆ carbocyclyl, 3- to 6-membered heterocyclyl, or —C(═O)R^{a}, wherein the alkyl, alkoxy, alkylamino, carbocyclyl, or heterocyclyl, is optionally substituted with one or more R^{u}.

15. The compound of any one of claims 12-14, wherein r is 0 or 1.

16. The compound of any one of claims 1-15, wherein R^{1a} and R^{1b} are both hydrogen.

17. The compound of any one of claims 1-16, wherein each R² is independently halogen.

18. The compound of claim 17, wherein each R² is fluoride.

19. The compound of any one of claims 1-18, wherein each R^{A} is independently halogen, —CN, —NO₂, —OH, —NH₂, C₁₋₆ alkyl, C₁₋₆ alkoxy, C₁₋₆ alkylamino, C₃₋₆ carbocyclyl, or 3- to 6-membered heterocyclyl, wherein the alkyl, alkoxy, alkylamino, carbocyclyl, or heterocyclyl is optionally substituted with one or more R^{u}.

20. The compound of any one of claims 1-19, wherein m is 0.

21. The compound of any one of claims 1-20, wherein R³ is hydrogen, C₁₋₆ alkyl, C₃₋₆ carbocyclyl, or 3- to 6-membered heterocyclyl.

22. The compound of any one of claims 1-21, wherein each R^{B} is independently 5- to 10-membered heteroaryl, —NR^{c}R^{d}, —OR^{b}, —C(═O)R^{a}, or —C(═O)OR^{b}, wherein the heteroaryl is optionally substituted with one or more R^{B-1}.

23. The compound of claim 22, wherein each R^{B-1} is independently C₁₋₆ alkyl, —C(═O)OR^{b}, or —C(═O)NR^{c}R^{d}.

24. The compound of any one of claims 1-23, wherein n is 0 or 1.

25. The compound of any one of claims 1-24, wherein

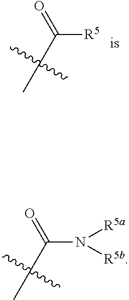

26. The compound of claim 25, wherein R^{5a} and R^{5b} are independently hydrogen, C₁₋₆ alkyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), wherein the alkyl, aryl, heteroaryl, carbocyclyl, or heterocyclyl is optionally substituted with one or more R^{5c}.

27. The compound of claim 26, wherein each R^{5c} is independently halogen, —CN, C₁₋₆ alkyl, C₁₋₆ haloalkyl, C₁₋₆ hydroxyalkyl, C₆₋₁₀ aryl, 5- to 10-membered heteroaryl, C₃₋₁₂ carbocyclyl, 3- to 12-membered heterocyclyl, —(C₁₋₆ alkyl)-(5- to 10-membered heteroaryl), —S(═O)₂R^{a}, —C(═O)OR^{b}, or —C(═O)NR^{c}R^{d}, wherein the alkyl, haloalkyl, hydroxyalkyl, carbocyclyl, heterocyclyl, aryl, or heteroaryl is optionally substituted with one or more R^{u}.

28. The compound of claim 25, wherein one of R^{5a} and R^{5b} is hydrogen, and the other one of R^{5a} and R^{5b} is 5- to 10-membered heteroaryl substituted with C₆₋₁₀ aryl, wherein the aryl is optionally substituted with one or more R^{u}.

29. The compound of any one of claims 1-24, wherein

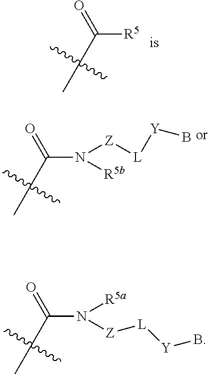

30. The compound of any one of claims 1-24, wherein

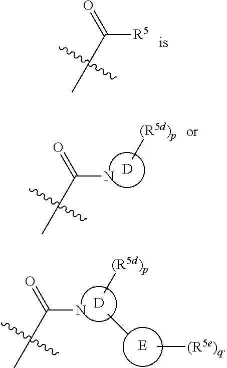

31. The compound of claim 30, wherein Ring D is 5- or 6-membered heterocyclyl.

32. The compound of claim 30 or 31, wherein each R^{5d} is independently oxo, halogen, C₁₋₆ alkyl, C₁₋₆ haloalkyl, C₆₋₁₀ aryl, 5- to 10-membered heteroaryl, C₃₋₁₂ carbocyclyl, —S(═O)₂R^{a}, —OR^{b}, —C(═O)R^{a}, —C(═O)OR^{b}, or —C(═O)NR^{c}R^{d}, wherein the alkyl, haloalkyl, carbocyclyl, aryl, or heteroaryl is optionally substituted with one or more R^{u}.

33. The compound of claim 32, wherein p is 0.

34. The compound of any one of claims 30-33, wherein Ring E is C₆₋₁₀ aryl or C₃₋₁₂ carbocyclyl.

35. The compound of any one of claims 30-34, wherein each R^{5c} is independently halogen, C₁₋₆ alkyl, C₆₋₁₀ aryl, 5- to 10-membered heteroaryl, wherein the alkyl, aryl, or heteroaryl is optionally substituted with one or more R^{u}.

36. The compound of claim 35, wherein q is 0.

37. The compound of any one of claims 1-24, wherein

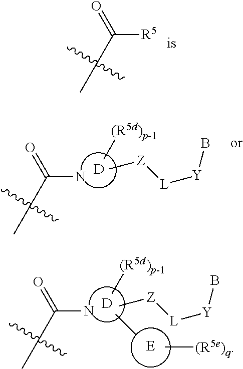

38. The compound of any one of claims 1-37, wherein Z is —CH₂—, —O—, —C(═O)NR^{Z1}—, —C(═O)—, —CH₂C(═O)NR^{Z2}—, —CH₂CH₂C(═O)NR^{Z3}—, —CH₂CH₂(C═O)N(CH₂)₂CH—, —OCH₂C(═O)NR^{Z4}—, or —C(═O)CH₂C(═O)NR^{Z5}—.

39. The compound of any one of claims 1-37, wherein L is C₁₋₁₈ alkylene or C₁₋₁₂ heteroalkylene.

40. The compound of any one of claims 1-37, wherein L is -A-(CH₂)_{m′}—W—(CH₂)_{n′}—.

41. The compound of any one of claims 1-37, wherein W is phenylene or 3- to 12-membered heterocyclylene.

42. The compound of any one of claims 1-37, wherein Y is —C≡C—, —N(R^{Y1})—, or —C(═O)—.

43. The compound of claim 1, wherein the compound is a compound of Formula (II): 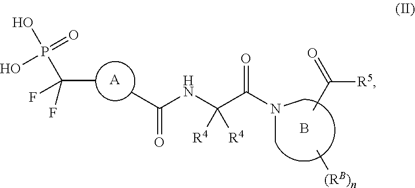
or a pharmaceutically acceptable salt, solvate, or stereoisomer thereof, wherein:
Ring A is 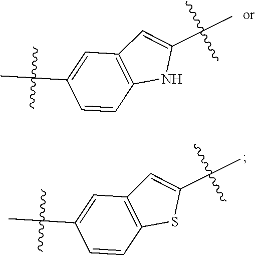 [SMILES: *c1ccc2[nH]c(*)cc2c1 ; *c1ccc2sc(*)cc2c1]
Ring B is 5- or 6-membered heterocyclyl;
each R^{B} is independently 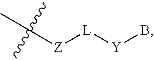
oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{B-1};
each R^{B-1} is independently 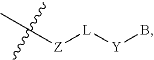
oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)₂R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}, wherein the alkyl, alkoxy, alkylamino, alkenyl, alkynyl, carbocyclyl, heterocyclyl, aryl, or heteroaryl is optionally substituted with one or more R^{u};
n is an integer from 0 to 6;
each R⁴ independently is C₁₋₆ alkyl, C₁₋₆ hydroxyalkyl, C₁₋₆ aminoalkyl, C₆₋₁₀ aryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(3- to 12-membered heterocyclyl), wherein the alkyl, hydroxyalkyl, aminoalkyl, carbocyclyl, heterocyclyl, or aryl is optionally substituted with one or more R^{4a}; or, R⁴ and R^{B}, together the intervening atoms, form a 3- to 12-membered heterocyclyl, wherein the heterocyclyl is optionally substituted with one or more R^{4b}; or
two R⁴, together with the carbon atom to which they are attached, form C₃₋₁₂ carbocyclyl or 3- to 12-membered heterocyclyl, wherein the carbocyclyl or heterocyclyl is optionally substituted with one or more R^{u};
each R^{4a} is independently halogen, —CN, —NO₂, —OH, —NH₂, —B(OH)₂, C₁₋₆ alkyl, C₁₋₆ haloalkyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(C₃₋₁₂ carbocyclyl), —NR^{b}C(═O)R^{a}, —OR^{b}, —C(═O)R^{a}, or —C(═O)NR^{c}R^{d}, wherein the alkyl, haloalkyl, alkynyl, carbocyclyl, heterocyclyl, aryl, or heteroaryl is optionally substituted with one or more R^{u};
each R^{4b} is independently 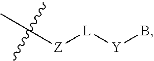
C₁₋₆ alkyl or —C(═O)R^{a}, wherein the alkyl, alkoxy, alkylamino, alkenyl, alkynyl, carbocyclyl, heterocyclyl, aryl, or heteroaryl is optionally substituted with one or more R^{u}; 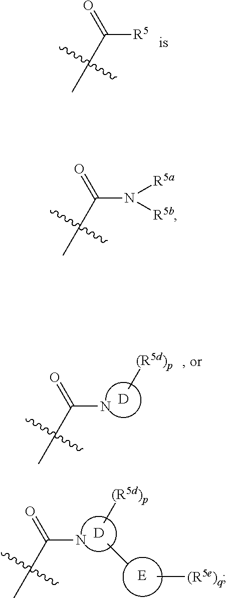
R^{5a} and R^{5b} are independently 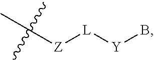
hydrogen, C₁₋₆ alkyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), wherein the alkyl, aryl, heteroaryl, carbocyclyl, or heterocyclyl is optionally substituted with one or more R^{5c};
each R^{5c} is independently halogen, —CN, C₁₋₆ alkyl, C₁₋₆haloalkyl, C₁₋₆ hydroxyalkyl, C₆₋₁₀ aryl, 5- to 10-membered heteroaryl, C₃₋₁₂ carbocyclyl, 3- to 12-membered heterocyclyl, —(C₁₋₆ alkyl)-(5- to 10-membered heteroaryl), —S(═O)₂R^{a}, —C(═O)OR^{b}, or —C(═O)NR^{c}R^{d}, wherein the alkyl, haloalkyl, hydroxyalkyl, carbocyclyl, heterocyclyl, aryl, or heteroaryl is optionally substituted with one or more R^{u};
Ring D is 5- or 6-membered heterocyclyl;
p is 0;
Ring E is C₆₋₁₀ aryl, 5- to 10-membered heteroaryl, C₃₋₁₂ carbocyclyl, or 3- to 12-membered heterocyclyl;
each R^{5c} is independently 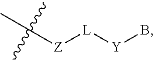
halogen, C₁₋₆ alkyl, C₆₋₁₀ aryl, 5- to 10-membered heteroaryl, wherein the alkyl, aryl, or heteroaryl is optionally substituted with one or more R^{u}; and
q is an integer from 0 to 6;
provided that:
one of R^{B}, R^{B-1}, R^{4b}, R^{5a}, R^{5b}, and R^{5d}, and R^{5e} is 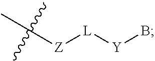
wherein:
Z is —CH₂—, —O—, —N(R^{Z0})—, —OC(═O)—, —C(═O)NR^{Z1}—, —C(═O)—, —CH₂C(═O)NR^{Z2}—, —CH₂CH₂C(═O)NR^{Z3}—, —CH₂CH₂(C═O)N(CH₂)₂CH—, —OCH₂C(═O)NR^{Z4}—, or —C(═O)CH₂C(═O)NR^{Z5}—;
each occurrence of R^{Z0}, R^{Z1}, R^{Z2}, R^{Z3}, R^{Z4}, and R^{Z5} is independently hydrogen or C₁₋₆ alkyl;
L is C₁₋₁₈ alkylene or C₁₋₁₂ heteroalkylene, wherein the alkylene or heteroalkylene is optionally substituted with one or more R^{u}; or
L is -A-(CH₂)_{m′}—W—(CH₂)_{n′}— or —(CH₂)_{r′}—W—(CH₂)_{u′}—O—(CH₂)_{v′};
A is absent; or
A is 5- to 10-membered heteroarylene; wherein the heteroarylene is optionally substituted with one or more R^{u};
W is phenylene, 5- to 10-membered heteroarylene, 3- to 12-membered heterocyclylene, or C₃₋₁₂ carbocyclylene; wherein the phenylene, heteroarylene, heterocyclylene, or carbocyclylene is optionally substituted with one or more R^{u};
m′ is an integer from 0 to 7;
n′ is an integer from 0 to 8;
r′ is an integer from 0 to 3;
u′ is an integer from 0 to 3; and
v′ is an integer from 1 to 4;
Y is —C≡C—, —CH═CH—, —CH₂—, —O—, —N(R^{Y1})—, —C(═O)—, —C(═O)N(R^{Y2})—, —N(R^{Y3})C(═O)CH₂O—, or —N(R^{Y3})C(═O)CH₂N(R^{Y4})—; or
Y is absent;
each occurrence of R^{Y1}, R^{Y2}, R^{Y3}, and R^{Y4} is independently hydrogen or C₁₋₆ alkyl; and
B is 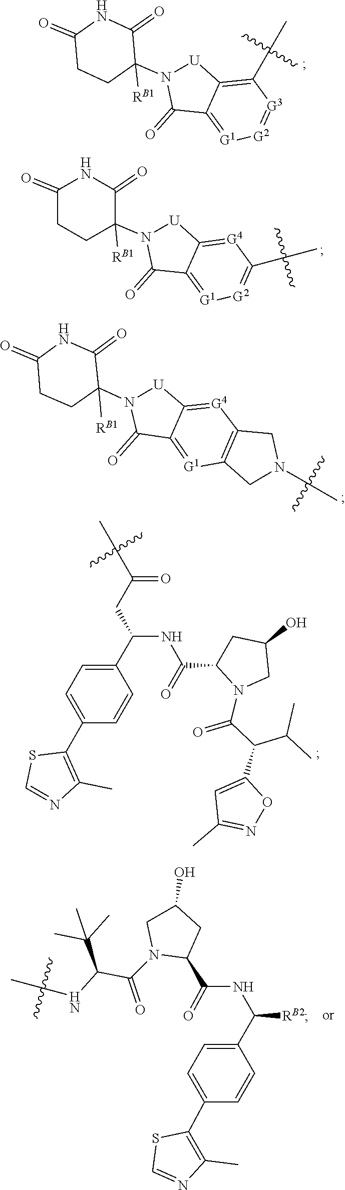 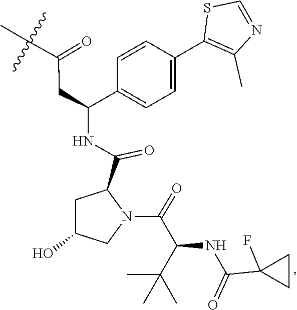
wherein:
G¹, G², G³, and G⁴ are independently —C(R^{G})═ or —N═;
U is —CH₂— or —C(═O)—;
R^{B1} is hydrogen, deuterium, methyl, or fluoro;
R^{B2} is hydrogen or methyl; and
each R^{G} is independently hydrogen, halo, or C₁₋₄ alkyl,
wherein:
each R^{u} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₆₋₁₀ aryl, 5- to 10-membered heteroaryl, C₃₋₁₂ carbocyclyl, 3- to 12-membered heterocyclyl, —(C₁₋₆ alkyl)-(C₆₋₁₀ aryl), —(C₁₋₆ alkyl)-(5- to 10-membered heteroaryl), —(C₁₋₆ alkyl)-(C₃₋₁₂ carbocyclyl), —(C₁₋₆ alkyl)-(3- to 12-membered heterocyclyl), —SR^{b}, —S(═O)R^{a}, —S(═O)₂R^{a}, —S(═O)₂OR^{b}, —S(═O)₂NR^{c}R^{d}, —NR^{c}S(═O)₂R^{a}, —NR^{c}S(═O)R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}; wherein the alkyl, alkoxy, alkylamino, alkenyl, alkynyl, carbocyclyl, heterocyclyl, aryl, or heteroaryl is optionally substituted with one or more substituents selected from oxo, halogen, —CN, —N₀₂, —OH, —NH₂, C₁₋₆ alkyl, C₁₋₆ alkoxy, C₁₋₆ alkylamino, C₂₋₆ alkenyl, C₂₋₆ alkynyl, C₃₋₁₂ carbocyclyl, and 3- to 6-membered heterocyclyl; or
two R^{u}, together with the one or more intervening atoms, form C₃₋₆ carbocyclyl, 3- to 6-membered heterocyclyl, C₆ aryl, or 5- to 6-membered heteroaryl, wherein the carbocyclyl, heterocyclyl, aryl, or heteroaryl is optionally substituted with one or more R^{z};
each R^{a} is independently C₁₋₆ alkyl, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl;
each R^{b} is independently hydrogen, C₁₋₆ alkyl, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl; and
R^{c} and R^{d} are independently hydrogen, C₁₋₆ alkyl, C₂₋₆ alkenyl, C₂₋₆ alkynyl, C₃₋₁₂ carbocyclyl, 3- to 12-membered heterocyclyl, C₆₋₁₀ aryl, or 5- to 10-membered heteroaryl; or
R^{c} and R^{d}, together with the nitrogen atom to which they are attached, form 3- to 12-membered heterocyclyl, wherein the heterocyclyl is optionally substituted with one or more R^{z},
wherein each occurrence of R^{a}, R^{b}, R^{c}, and R^{d} is independently and optionally substituted with one or more R^{z}; and
each R^{z} is independently oxo, halogen, —CN, —NO₂, —OH, —NH₂, C₁₋₆ alkyl, C₁₋₆ alkoxy, C₁₋₆ alkylamino, C₂₋₆ alkenyl, C₂₋₆ alkynyl, C₃₋₆ carbocyclyl, or 3- to 6-membered heterocyclyl.

44. The compound of claim 60, wherein when one of R^{5a} and R^{5b} is hydrogen, then the other one of R^{5a} and R^{5b} is not: 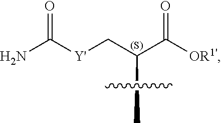
wherein:
Y′ is —O—, —NH—, or —CH₂—; and
R^{1′} is H or benzyl.

45. The compound of claim 1, wherein the compound is selected from compounds described in Table 2 and pharmaceutically acceptable salts thereof.

46. A pharmaceutical composition comprising the compound of any one of claims 1-45, and a pharmaceutically acceptable excipient.

47. A method of degrading a STAT5 protein in a patient or biological sample comprising contacting said patient or biological sample with a compound of any one of claims 1-45.

48. A method of degrading a STAT6 protein in a patient or biological sample comprising contacting said patient or biological sample with a compound of any one of claims 1-45.

49. Use of a compound of any one of claims 1-45 in the manufacture of a medicament for degrading a STAT5 protein in a patient or biological sample.

50. Use of a compound of any one of claims 1-45 in the manufacture of a medicament for degrading a STAT6 protein in a patient or biological sample.

51. A compound of any one of claims 1-45 for use in degrading a STAT5 protein in a patient or biological sample.

52. A compound of any one of claims 1-45 for use in degrading a STAT6 protein in a patient or biological sample.

53. A method of treating a STAT5-mediated disease or disorder comprising administering to a patient in need thereof a compound of any one of claims 1-45.

54. A method of treating a STAT6-mediated disease or disorder comprising administering to a patient in need thereof a compound of any one of claims 1-45.

55. Use of a compound of any one of claims 1-45 in the manufacture of a medicament for treating a STAT5-mediated disease or disorder.

56. Use of a compound of any one of claims 1-45 in the manufacture of a medicament for treating a STAT6-mediated disease or disorder.

57. A compound of any one of claims 1-45 for use in treating a STAT5-mediated disease or disorder.

58. A compound of any one of claims 1-45 for use in treating a STAT6-mediated disease or disorder.

59. The method, use, or compound for use of any one of claims 53-58, wherein the disease or disorder is breast cancer, colorectal cancer, lung cancer, prostate cancer, liver cancer, hematological malignancies, T-cell lymphoma, acute leukemia and chronic myeloid leukemia, solitary fibrous tumor, solid tumors, asthma, atopic dermatitis, eosinophilic esophagitis or food allergies.
